(19) United States
(12) Patent Application Publication
(10) Pub. No.: US 2024/0406304 A1
(43) Pub. Date: Dec. 5, 2024

(54) Devices, Methods, and Graphical User Interfaces for Activating, Configuring, and Interacting with Different Operational Modes

(71) Applicant: Apple Inc., Cupertino, CA (US)

(72) Inventors: Christopher P. Foss, San Francisco, CA (US); Arian Behzadi, San Francisco, CA (US); Seyit Yilmaz, Santa Clara, CA (US); Caelan G. Stack, Belmont, CA (US); Thomas S. Hulbert, Sunnyvale, CA (US); Gemma A. Roper, San Francisco, CA (US); Zaid A. AbuKhalaf, Sunnyvale, CA (US); Eric Lance Wilson, San Jose, CA (US); William M. Tyler, San Francisco, CA (US); Chanaka G. Karunamuni, San Jose, CA (US); Bryant A. Jow, San Mateo, CA (US); Patrick L. Coffman, San Francisco, CA (US); Diogo J. Da Silva Valente Soares, Moss Beach, CA (US); Elizabeth A. Ottens, San Francisco, CA (US); Michael J. Elzinga, Woodinville, WA (US); Jonathan B. Koch, Wessenberg (DE); Benjamin Guild, Covina, CA (US)

(21) Appl. No.: 18/656,538

(22) Filed: May 6, 2024

Related U.S. Application Data
(60) Provisional application No. 63/607,056, filed on Dec. 6, 2023.
(60) Provisional application No. 63/605,507, filed on Dec. 2, 2023.
(60) Provisional application No. 63/470,966, filed on Jun. 4, 2023.
(60) Provisional application No. 63/465,238, filed on May 9, 2023.

(51) Int. Cl. H04M 1/72454; G06F 3/0481; H04M 1/72463

(52) U.S. Cl. CPC H04M 1/72454; G06F 3/0481; H04M 1/724634

(57) ABSTRACT

A computer system detects a first event. In response to detecting the first event: if first criteria are met as a result of the first event, wherein the first criteria require that the orientation of the display generation component is a first orientation, and that the computer system is charging, in order for the first criteria to be met, the computer system displays a first customizable user interface that was not displayed prior to detecting the first event; and, if the first criteria are not met as a result of the first event, the computer system forgoes displaying the first customizable user interface.

### RELATED APPLICATIONS

This application claims priority to U.S. Provisional Patent Application No. 63/607,056, filed Dec. 6, 2023, U.S. Provisional Patent Application No. 63/605,507, filed Dec. 2, 2023, U.S. Provisional Patent Application No. 63/470,966, filed Jun. 4, 2023, and U.S. Provisional Patent Application No. 63/465,238, filed May 9, 2023, each of which is hereby incorporated by reference in its entirety.

### TECHNICAL FIELD

This relates generally to electronic devices with touch-sensitive surfaces, including but not limited to electronic devices with touch-sensitive surfaces.

### BACKGROUND

The use of touch-sensitive surfaces as input devices for computers and other electronic computing devices has increased significantly in recent years. Example touch-sensitive surfaces include touchpads and touch-screen displays. Such surfaces are widely used to manipulate user interfaces and objects therein on a display. Example user interface objects include digital images, video, text, icons, and control elements such as buttons and other graphics.

Example manipulations include adjusting the position and/or size of one or more user interface objects or activating buttons or opening files/applications represented by user interface objects, as well as associating metadata with one or more user interface objects or otherwise manipulating user interfaces. Example user interface objects include digital images, video, text, icons, control elements such as buttons and other graphics. A user will, in some circumstances, need to perform such manipulations on user interface objects in a file management program (e.g., Finder from Apple Inc. of Cupertino, California), an image management application (e.g., Aperture, iPhoto, Photos from Apple Inc. of Cupertino, California), a digital content (e.g., videos and music) management application (e.g., iTunes from Apple Inc. of Cupertino, California), a drawing application, a presentation application (e.g., Keynote from Apple Inc. of Cupertino, California), a word processing application (e.g., Pages from Apple Inc. of Cupertino, California), or a spreadsheet application (e.g., Numbers from Apple Inc. of Cupertino, California).

While touch-sensitive displays are frequently leveraged while their associated devices are in use, these displays are rarely leveraged when the device is not in use. Even when a device is not in use, the device can still provide access to functions and/or application of the device, and can also provide status information for events and/or applications.

### SUMMARY

Accordingly, there is a need for electronic devices that can provide improved functionality and information to users when certain criteria are met (e.g., so that the device does not unnecessarily sacrifice battery power and/or provide such functionality in contexts when it is unneeded or inaccessible to a user). Such methods and interfaces reduce the number, extent, and/or nature of the inputs from a user and produce a more efficient human-machine interface. For battery-operated devices, such methods and interfaces conserve power and increase the time between battery charges.

The above deficiencies and other problems associated with user interfaces for electronic devices (or more generally, computer systems) with touch-sensitive surfaces are reduced or eliminated by the disclosed devices. In some embodiments, the device is a desktop computer. In some embodiments, the device is portable (e.g., a notebook computer, tablet computer, or handheld device). In some embodiments, the device is a personal electronic device (e.g., a wearable electronic device, such as a watch). In some embodiments, the device has a touchpad. In some embodiments, the device has a touch-sensitive display (also known as a “touch screen” or “touch-screen display”). In some embodiments, the device has a graphical user interface (GUI), one or more processors, memory and one or more modules, programs or sets of instructions stored in the memory for performing multiple functions. In some embodiments, the user interacts with the GUI primarily through stylus and/or finger contacts and gestures on the touch-sensitive surface. In some embodiments, the functions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a non-transitory computer readable storage medium or other computer program product configured for execution by one or more processors.

In accordance with some embodiments, a method is performed at a computer system that is in communication with a display generation component and one or more sensors. The method includes detecting a first event. The method includes, in response to detecting the first event: in accordance with a determination that first criteria are met as a result of the first event, wherein the first criteria require that the orientation of the display generation component is a first orientation, and that the computer system is charging, in order for the first criteria to be met, displaying a first customizable user interface that was not displayed prior to detecting the first event; and, in accordance with a determination that the first criteria are not met as a result of the first event, forgoing displaying the first customizable user interface.

In accordance with some embodiments, a method is performed at a computer system that is in communication with a display generation component and one or more input devices. The method includes displaying, via the display generation component, a first user interface that is selected from a first set of user interfaces, wherein the first user interface displays a first type of content in accordance with a first set of configuration options. The method includes, while displaying the first user interface, detecting a first user input that is directed to the first user interface. The method includes, in response to detecting the first user input that is directed to the first user interface: in accordance with a determination that the first user input meets first directional criteria, wherein the first directional criteria require that the first user input includes movement in a first direction in order for the first directional criteria to be met, replacing display of the first user interface with display of a second user interface, wherein the second user interface is selected from the first set of user interfaces, and wherein the second user interface displays a second type of content different from the first type of content; and, in accordance with a determination that the first user input meets second directional criteria, wherein the second directional criteria require that the first user input includes movement in a second direction, different from the first direction, in order for the second directional criteria to be met, replacing display of the first user interface with display of the first type of content in accordance with a second set of configuration options, different from the first set of configuration options. The method includes, after detecting the first user input, while displaying a respective user interface from the first set of user interfaces, detecting a second user input that is directed to the respective user interface. The method includes, in response to detecting the second user input: in accordance with a determination that the second user input meets the first directional criteria, wherein the first directional criteria require that the second user input includes movement in the first direction in order for the first directional criteria to be met, replacing display of the respective user interface with display of a third user interface that is selected from the first set of user interfaces, wherein the third user interface displays a third type of content that is different from the first type of content and the second type of content.

In accordance with some embodiments, a method is performed at a computer system that is in communication with a display generation component and one or more input devices. The method includes displaying a first user interface that corresponds to a restricted state of the computer system, including concurrently displaying, in the first user interface, a first widget of a first group of widgets at a first placement location and a second widget of a second group of widgets at a second placement location. The first placement location is configured to accommodate a respective widget of the first group of widgets, and the second placement location is configured to accommodate a respective widget of the second group of widgets. The method includes, while concurrently displaying, in the first user interface, the first widget of the first group of widgets at the first placement location and the second widget of the second group of widgets at the second placement location, detecting a first user input that is directed to the first user interface. The method includes, in response to detecting the first user input that is directed to the first user interface: in accordance with a determination that the first user input is directed to the first placement location within the first user interface and that the first user input meets first switching criteria, replacing display of the first widget with a different widget from the first group of widgets at the first placement location; and, in accordance with a determination that the first user input is directed to the second placement location within the first user interface and that the first user input meets the first switching criteria, replacing display of the second widget with a different widget from the second group of widgets at the second placement location.

In accordance with some embodiments, a method is performed at a computer system that is in communication with a display generation component and one or more sensors. The method includes, while displaying a first user interface, detecting that one or more conditions for displaying a respective user interface object of a first object type are met. The respective user interface object of the first type of user interface object corresponds to a respective application and provides status information that is updated over time in the respective user interface object without requiring display of the respective application. The method includes, in response to detecting that the one or more conditions for displaying the respective user interface object of the first object type are met, displaying the respective user interface object. The method includes, while displaying respective user interface object, detecting a first user input that corresponds to a request to dismiss the respective user interface object. The method includes, in response to detecting the first user input that corresponds to a request to dismiss the respective user interface object: in accordance with a determination that the first user interface is a first type of user interface, ceasing to display the respective user interface object and redisplaying the first user interface; and, in accordance with a determination that the first user interface is a second type of user interface, different from the first type of user interface, ceasing to display the respective user interface object and displaying a second user interface that is different from the first user interface at a location that was previously occupied by the first user interface.

In accordance with some embodiments, a method is performed at a computer system that is in communication with a display generation component and one or more sensors. The method includes detecting a disconnection of the computer system from a charging source. The method includes, in response to detecting the disconnection of the computer system from the charging source: in accordance with a determination that the disconnection of the computer system from the charging source occurred while the computer system was in a first mode of operation, wherein the computer system displays, via the display generation component, a clock user interface for at least a portion of a duration that the computer system is operating in the first mode of operation, activating a flashlight function of the computer system.

In accordance with some embodiments, a method is performed at a computer system including a display generation component and one or more sensors. The method includes, while the computer system is operating in a first mode, wherein the computer system operates in the first mode while first criteria are met, detecting, via the one or more sensors, a presence of a person in proximity to the computer system without detecting contact of the person with the computer system. The method includes, in response to detecting the presence of the person in proximity to the computer system without detecting contact of the person with the computer system, updating displayed content that is displayed via the display generation component of the computer system, while remaining in the first mode.

In some embodiments, a method is performed at a computer system in communication with a display generation component and one or more sensors for detecting user inputs. The method includes detecting a first event. The method includes, in response to detecting the first event, and in accordance with a determination that first criteria are met as a result of the first event, displaying a respective customizable user interface that was not displayed prior to detecting the first event. Displaying the respective customizable user interface includes, in accordance with a determination that one or more power transfer signals received from the charging source include first identifying data representing a first identity of the charging source and that the first identity of the charging source is stored at the computer system in association with a first set of customization parameters, displaying a first customizable user interface that is configured in accordance with the first set of customization parameters corresponding to the first identity of the charging source.

In some embodiments, a computer system comprises a display generation component, one or more sensors for detecting user inputs, a power transfer coil adapted to receive power transfer signals from a charging source, a rectifier adapted to charge a battery of the computer system using the power transfer signals received from the charging source by the power transfer coil, communication circuitry adapted to obtain identifying data representing a respective identity of the charging source from at least one of the power transfer signals received from the charging source, and one or more processors. The computer system comprises memory storing instructions that, when executed by the one or more processors, cause the processors to perform operations comprising: detecting a first event; in response to detecting the first event: in accordance with a determination that first criteria are met as a result of the first event displaying a respective customizable user interface that was not displayed prior to detecting the first event.

In accordance with some embodiments, an electronic device (or computer system more generally) includes a display, a touch-sensitive surface, optionally one or more sensors to detect intensities of contacts with the touch-sensitive surface, optionally one or more tactile output generators, one or more processors, and memory storing one or more programs; the one or more programs are configured to be executed by the one or more processors and the one or more programs include instructions for performing or causing performance of the operations of any of the methods described herein. In accordance with some embodiments, a computer readable storage medium has stored therein instructions that, when executed by an electronic device with a display, a touch-sensitive surface, optionally one or more sensors to detect intensities of contacts with the touch-sensitive surface, and optionally one or more tactile output generators, cause the device to perform or cause performance of the operations of any of the methods described herein. In accordance with some embodiments, a graphical user interface on an electronic device with a display, a touch-sensitive surface, optionally one or more sensors to detect intensities of contacts with the touch-sensitive surface, optionally one or more tactile output generators, a memory, and one or more processors to execute one or more programs stored in the memory includes one or more of the elements displayed in any of the methods described herein, which are updated in response to inputs, as described in any of the methods described herein. In accordance with some embodiments, an electronic device includes: a display, a touch-sensitive surface, optionally one or more sensors to detect intensities of contacts with the touch-sensitive surface, and optionally one or more tactile output generators; and means for performing or causing performance of the operations of any of the methods described herein. In accordance with some embodiments, an information processing apparatus, for use in an electronic device with a display, a touch-sensitive surface, optionally one or more sensors to detect intensities of contacts with the touch-sensitive surface, and optionally one or more tactile output generators, includes means for performing or causing performance of the operations of any of the methods described herein.

Thus, electronic devices and other computer systems with displays, touch-sensitive surfaces, optionally one or more sensors to detect intensities of contacts with the touch-sensitive surface, optionally one or more tactile output generators, optionally one or more device orientation sensors, and optionally an audio system, are provided with improved methods and interfaces for activating, configuring, and interacting with different operational modes (e.g., which provides access to different functionality and/or information), thereby increasing the effectiveness, efficiency, and user satisfaction with such devices. Such methods and interfaces may complement or replace conventional methods for activating, configuring, and interacting with (existing) operational modes.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating example components for event handling in accordance with some embodiments.

FIG. 2 illustrates a portable multifunction device having a touch screen in accordance with some embodiments.

FIG. 3 is a block diagram of an example multifunction device with a display and a touch-sensitive surface in accordance with some embodiments.

FIG. 4A illustrates an example user interface for a menu of applications on a portable multifunction device in accordance with some embodiments.

FIG. 4B illustrates an example user interface for a multifunction device with a touch-sensitive surface that is separate from the display in accordance with some embodiments.

FIGS. 4C1-4C2 illustrate an example state diagram of navigation between various user interfaces of the multifunction devices in accordance with some embodiments.

FIGS. 5A-5AT illustrate example user interfaces for automatically displaying a customizable user interface when specific criteria are met, in accordance with some embodiments.

FIGS. 6A-6AN illustrate example user interfaces for switching between, interacting with, and configuring different operational modes (e.g., ambient modes), in accordance with some embodiments.

FIGS. 7A-7V illustrate example user interfaces for interacting with and configuring a customizable user interface, in accordance with some embodiments.

FIGS. 8A-8K illustrate example user interfaces for interacting with different user interfaces of, and switching between, different operational modes (e.g., ambient modes), in accordance with some embodiments.

FIGS. 9A-9AA illustrate example user interfaces for automatically activating a flashlight function of the computer system 100 (e.g., a portable multifunction device, a display generation component associated with a computing device, or other device) when specific criteria are met, in accordance with some embodiments.

FIGS. 10A-10L are flow diagrams of a process for automatically displaying a customizable user interface when specific criteria are met, in accordance with some embodiments.

FIGS. 11A-11G are flow diagrams of a process for switching between, interacting with, and configuring different operational modes (e.g., ambient modes), in accordance with some embodiments.

FIGS. 12A-12D are flow diagrams of a process for interacting with and configuring a customizable user interface, in accordance with some embodiments.

FIGS. 13A-13J are flow diagrams of a process for interacting with different user interfaces of, and switching between, different operational modes (e.g., ambient modes), in accordance with some embodiments.

FIGS. 14A-14G are flow diagrams of a process for automatically activating a flashlight function of the computer system 100 (e.g., a portable multifunction device, a display generation component associated with a computing device, or other device) when specific criteria are met, in accordance with some embodiments.

FIGS. 15A-15Q illustrate example user interfaces for updating displayed content when presence criteria are met, in accordance with some embodiments.

FIGS. 16A-16F are flow diagrams of a process for updating displayed content when presence criteria are met, in accordance with some embodiments.

FIGS. 17A-17C are flow diagrams of a process for displaying a customized user interface that is configured in accordance with customization parameters corresponding to a received identity of a charging source, in accordance with some embodiments.

### DESCRIPTION OF EMBODIMENTS

While portable electronic devices, such as smartphones and tablets, have become increasingly commonplace, little attention has been given to leveraging such devices when those devices are not actively in use. Such devices can be used to provide useful information to a user, even when not actively in use. For example, a device can be configured to operate in a particular operational mode that provides time information (e.g., by serving as a clock and/or displaying a clock face), and/or offer quick access to useful utilities or time-sensitive information (e.g., via widgets and/or by displaying user interfaces that display status information that changes or updates over time (e.g., in real time)). Further, the operational mode(s) can be configured to be active when specific criteria are met (e.g., the device is charging, and/or in a particular orientation), which can be tailored to scenarios where the device is not in use, and scenarios where operating in the operational mode(s) will not have a detrimental impact on the device (e.g., the device's battery life, when not connected to a charging source). Such operational modes offer efficient access to useful functionality and information, even when the device is not actively in use.

The processes described below enhance the operability of the devices and make the user-device interfaces more efficient (e.g., by helping the user to provide proper inputs and reducing user mistakes when operating/interacting with the device) through various techniques, including by providing improved visual, audio, and/or tactile feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

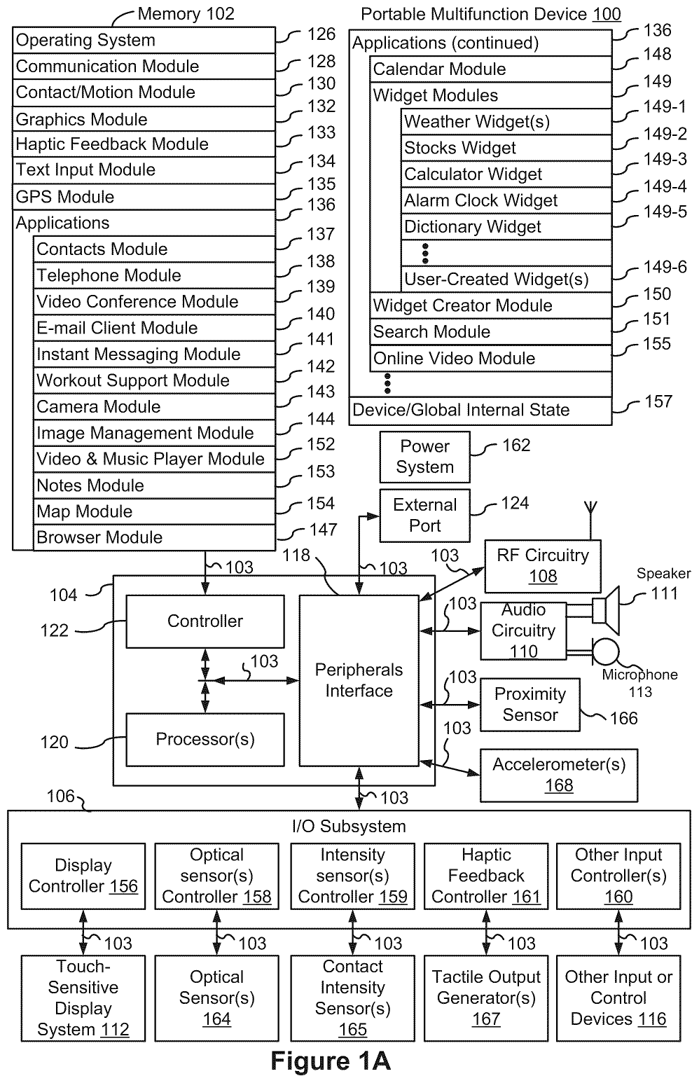

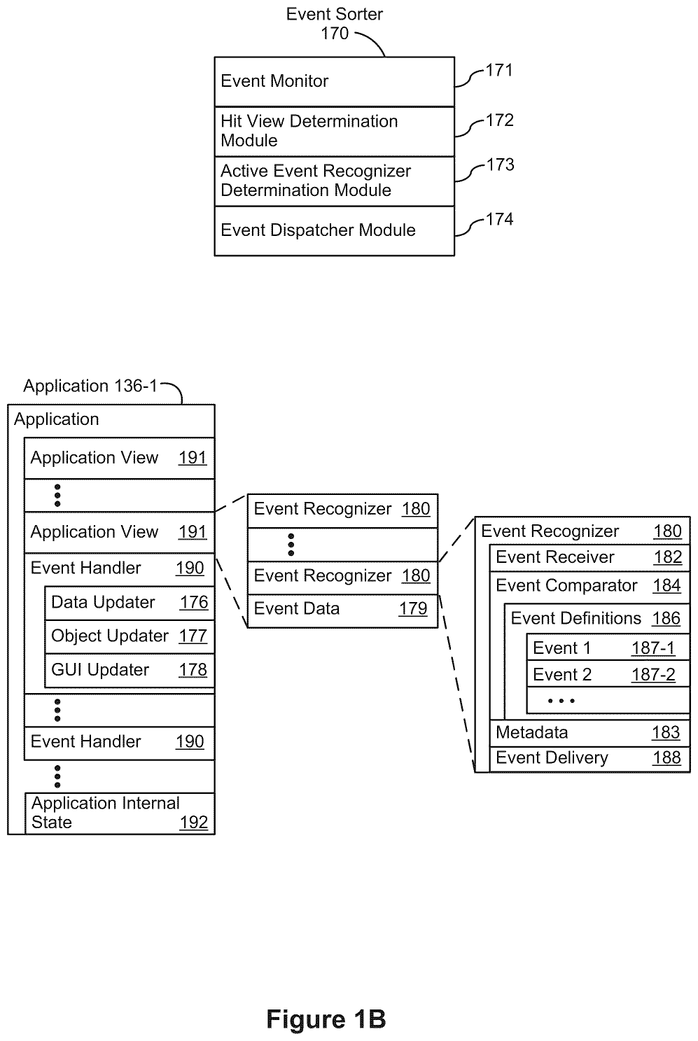

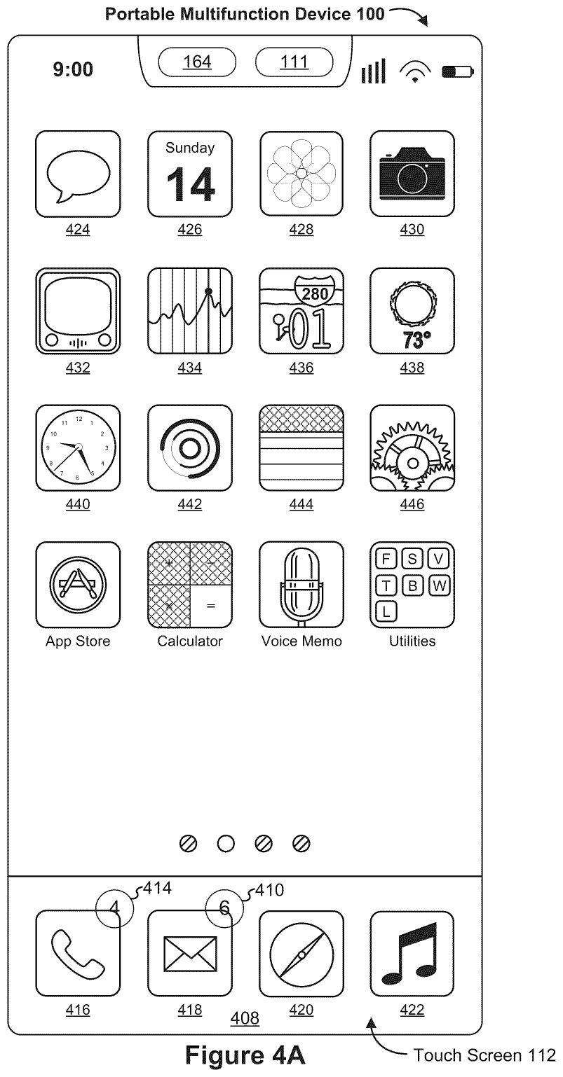

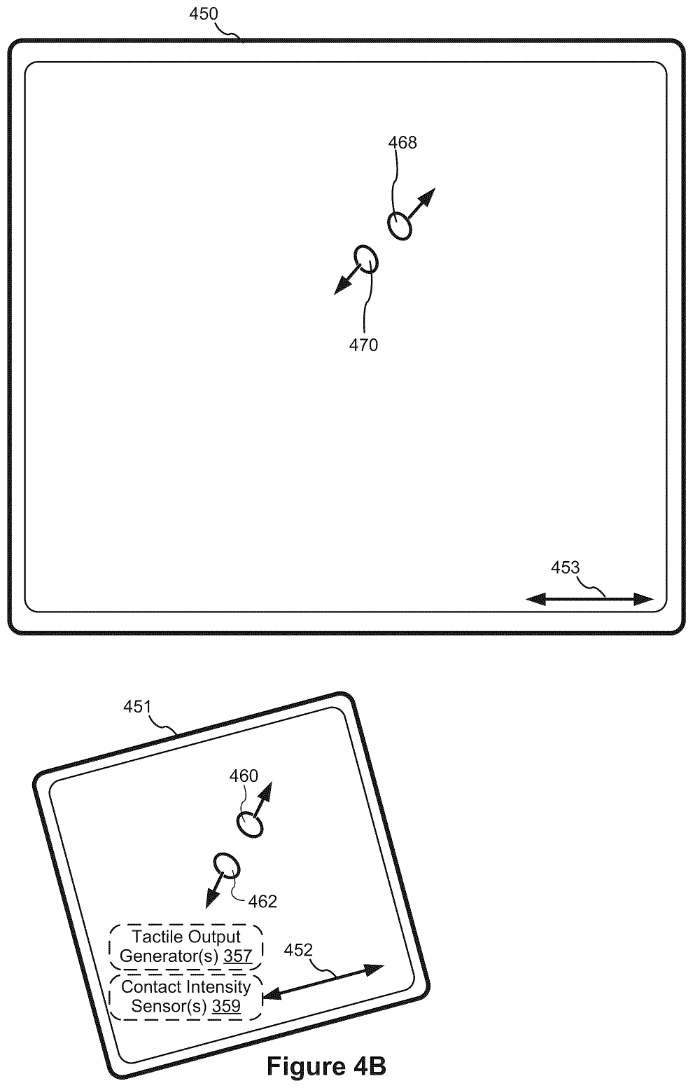

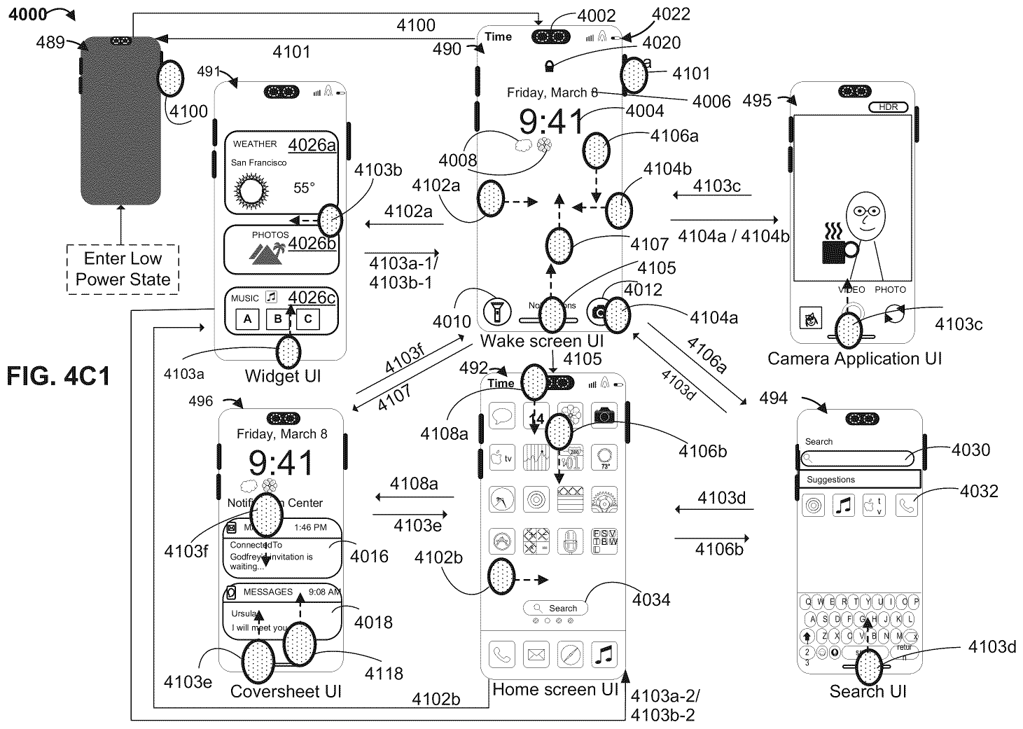

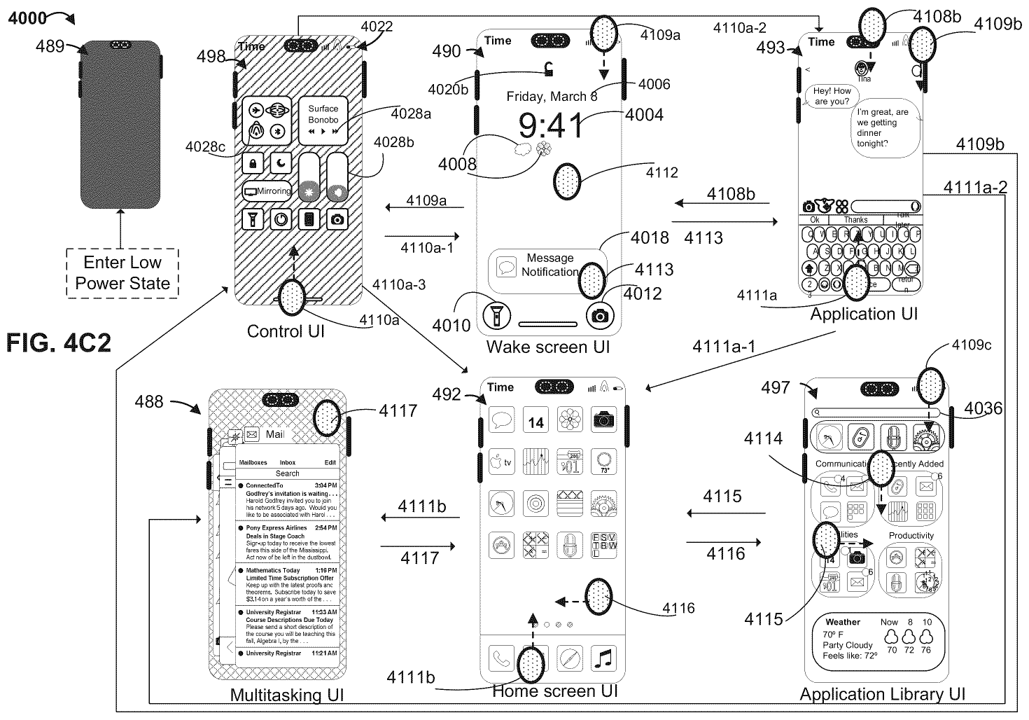

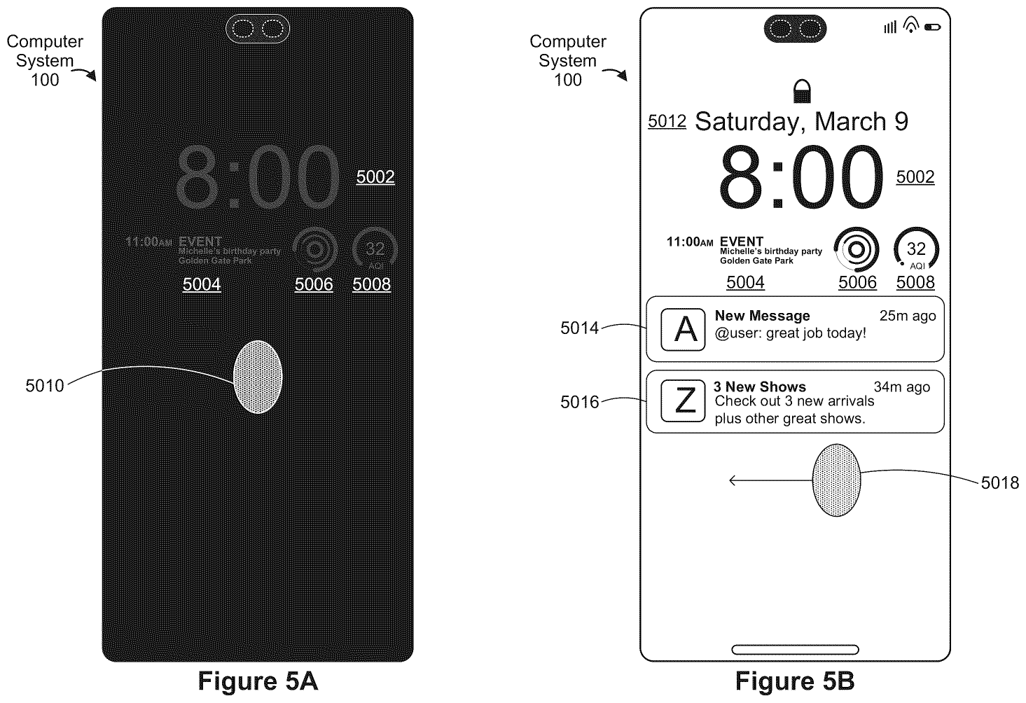

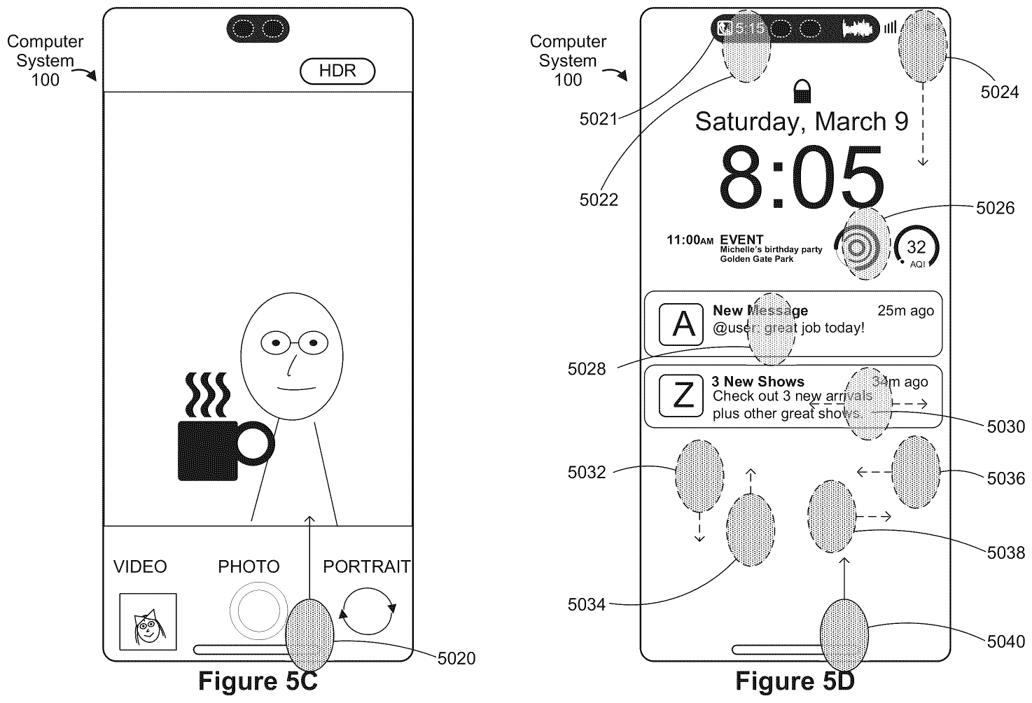

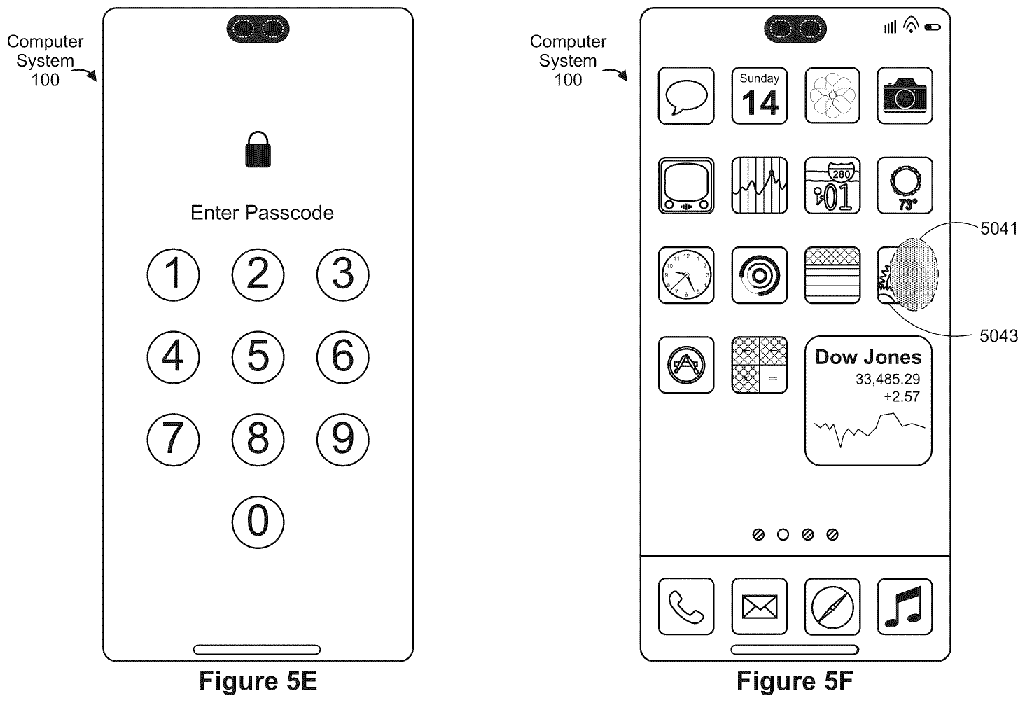

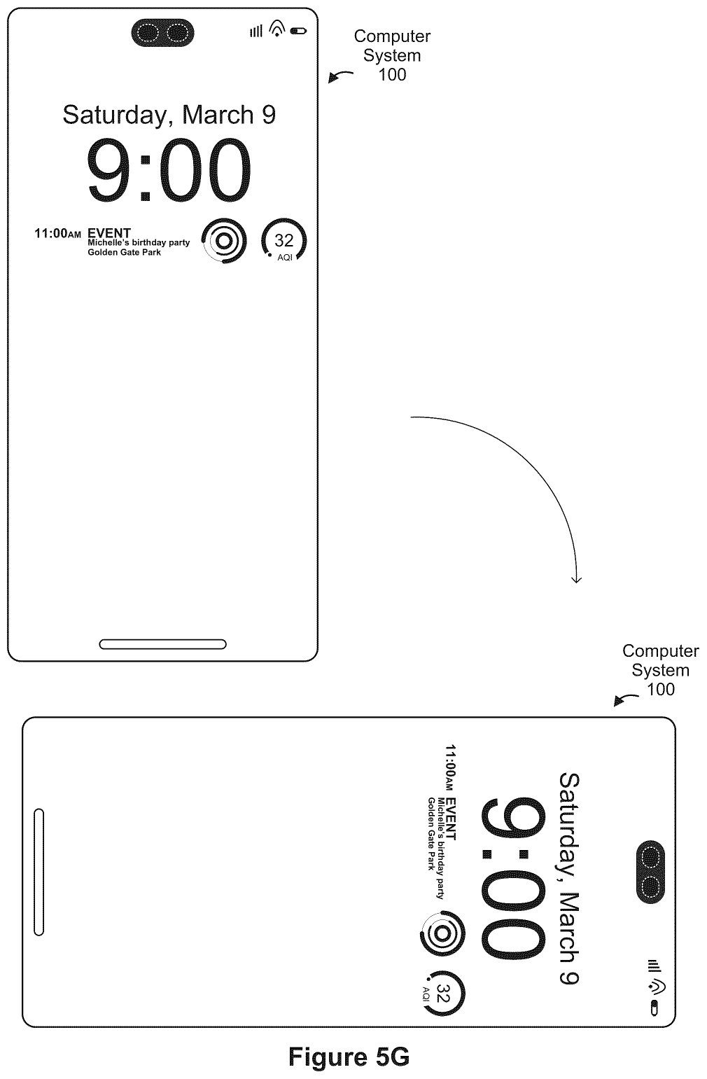

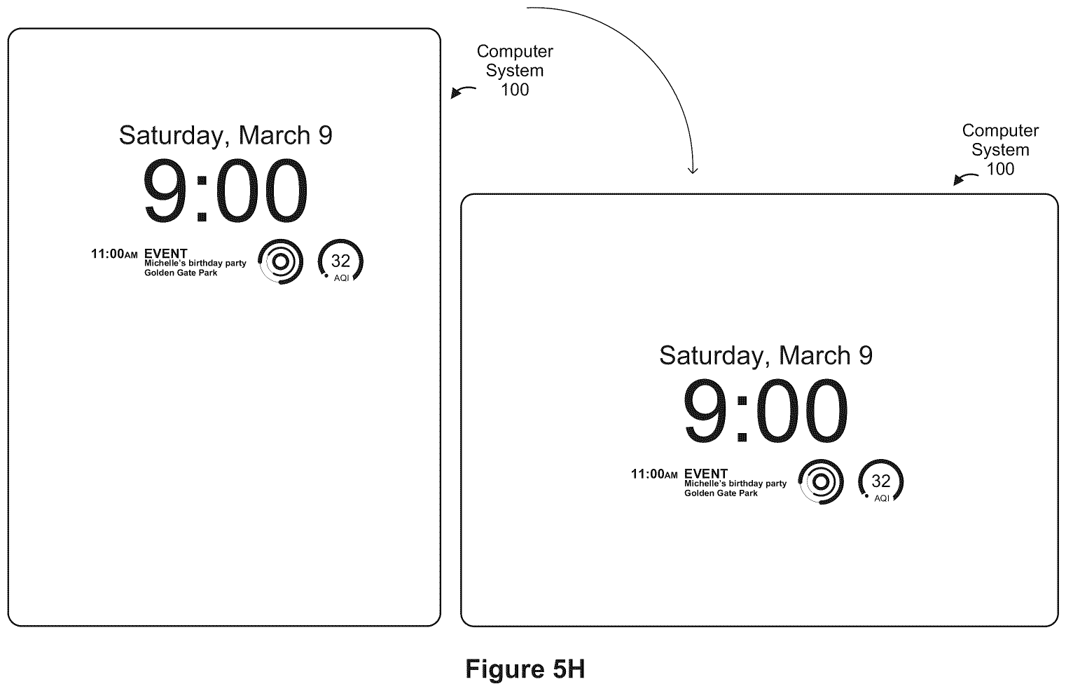

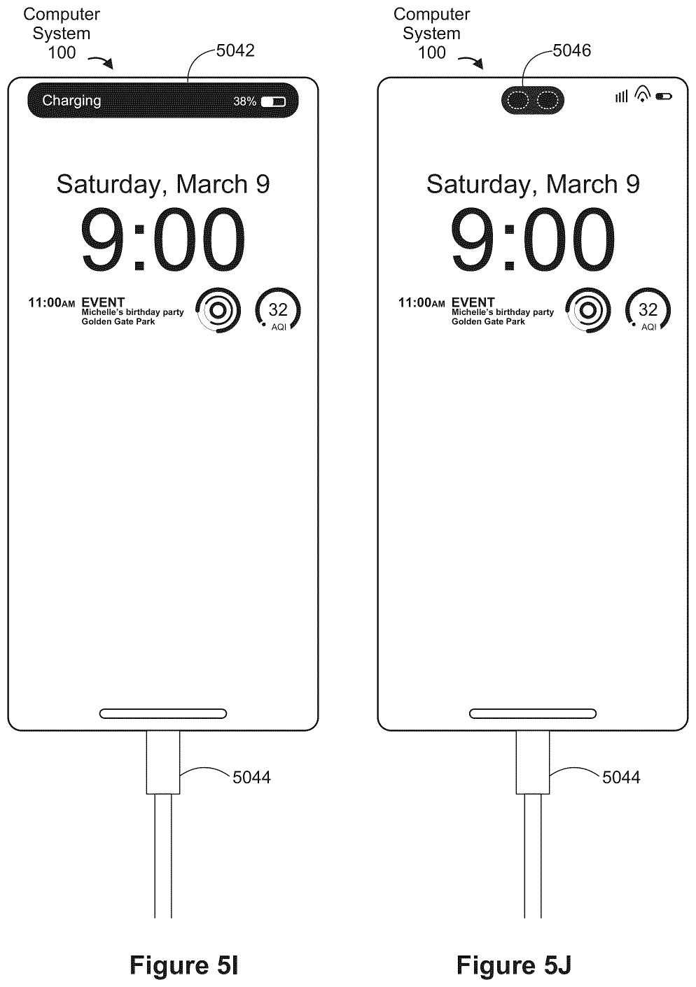

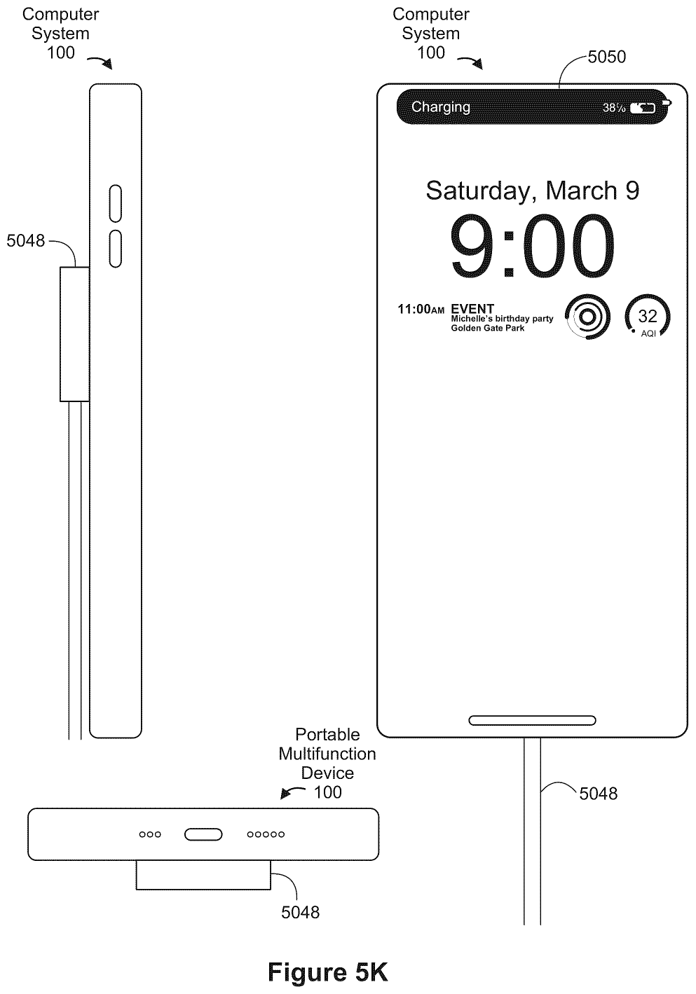

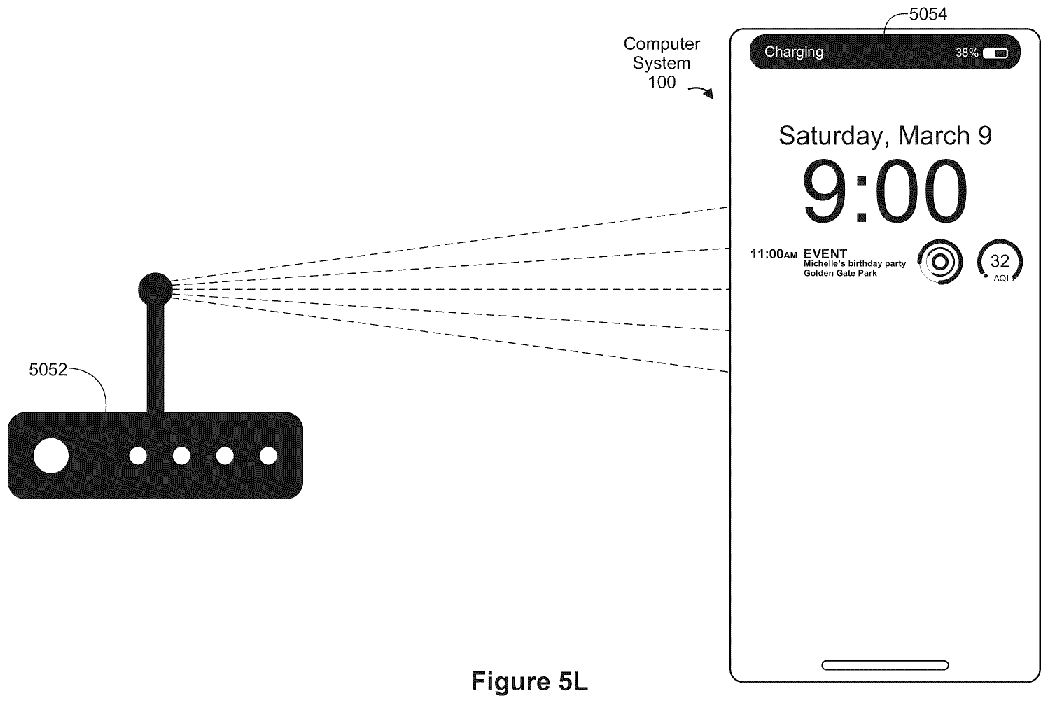

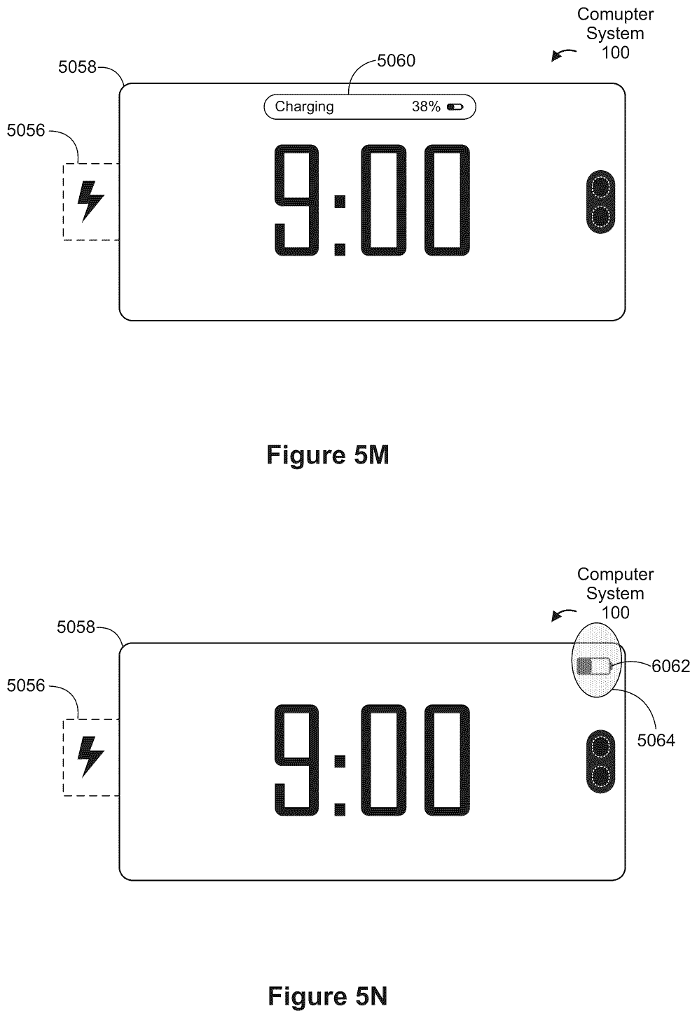

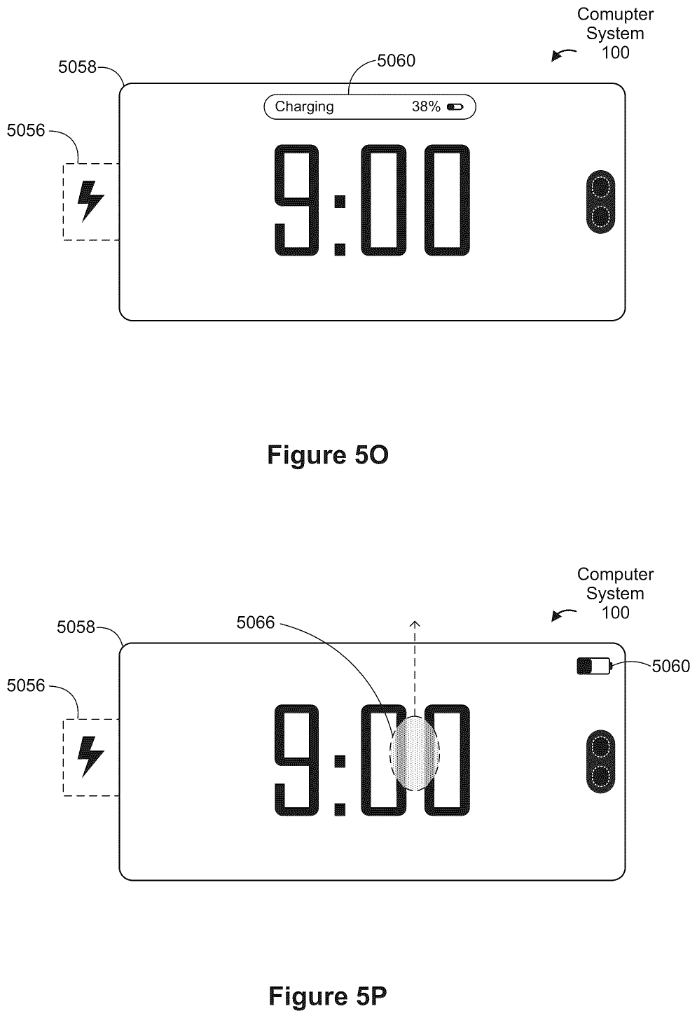

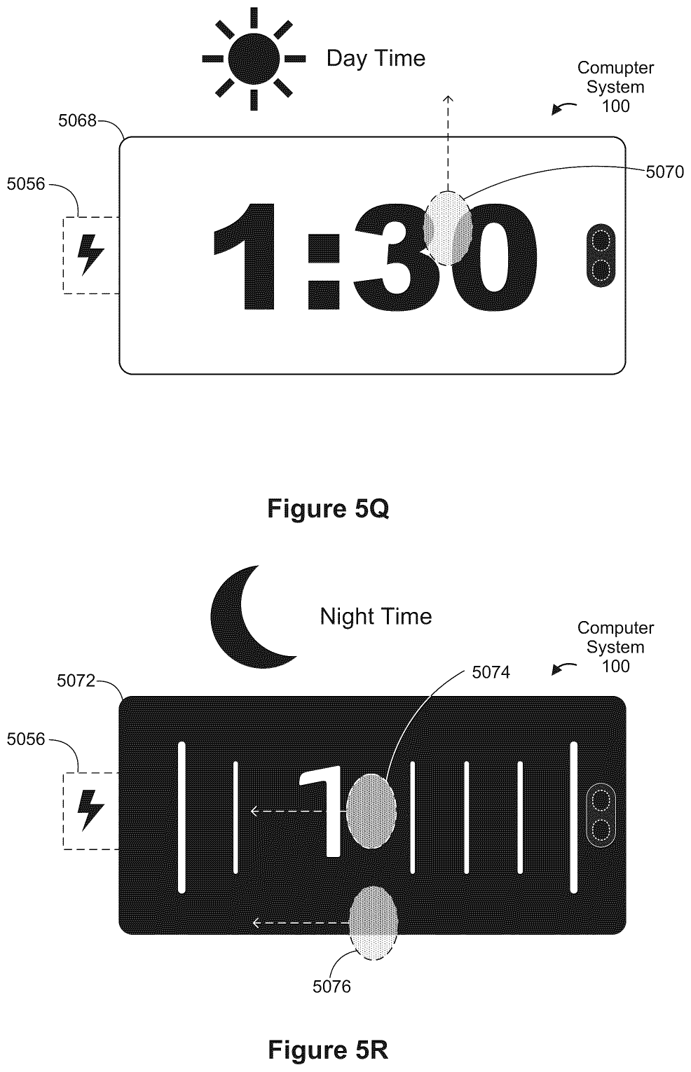

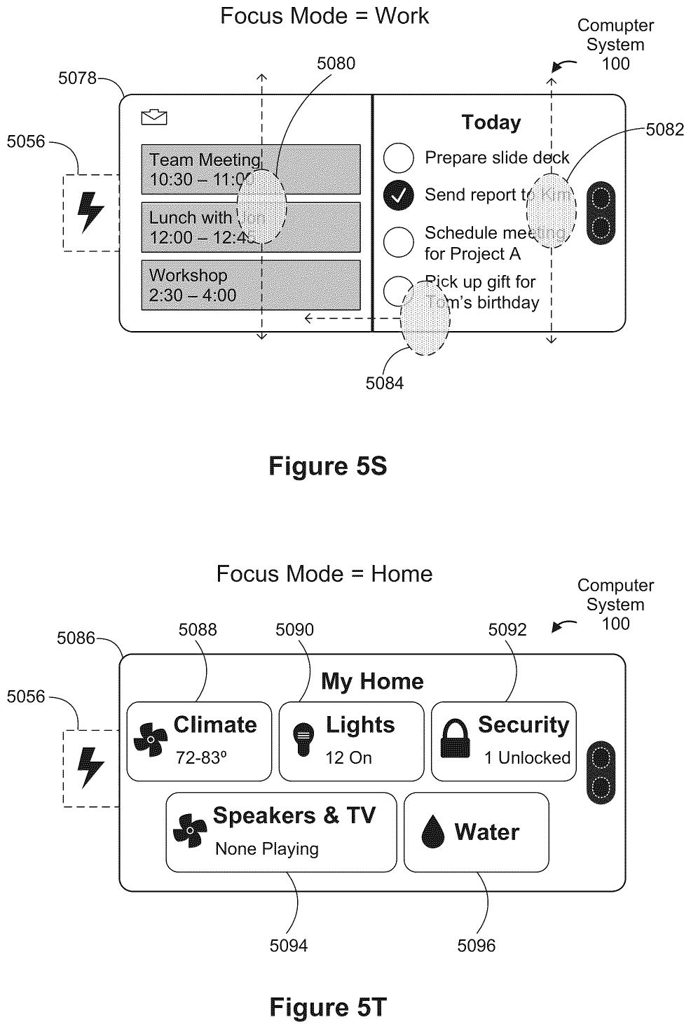

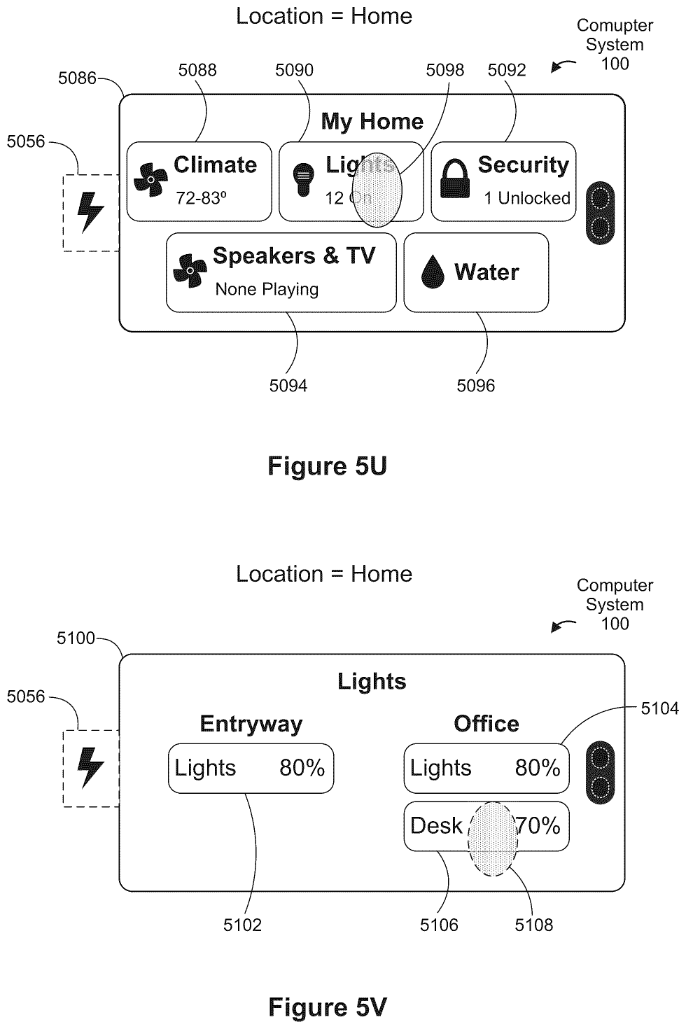

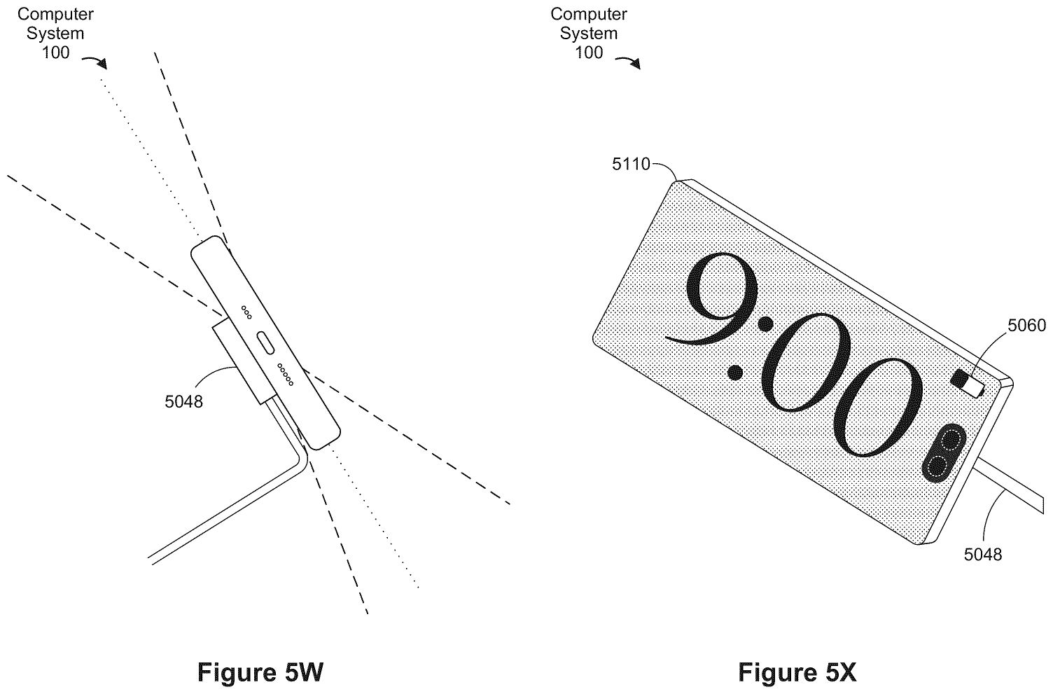

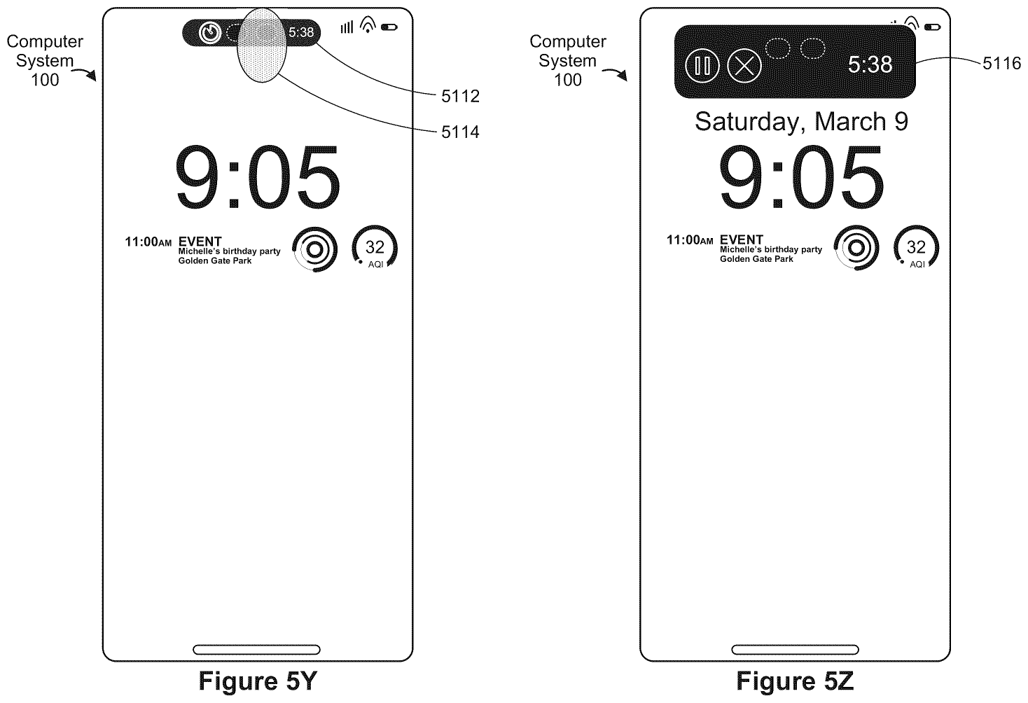

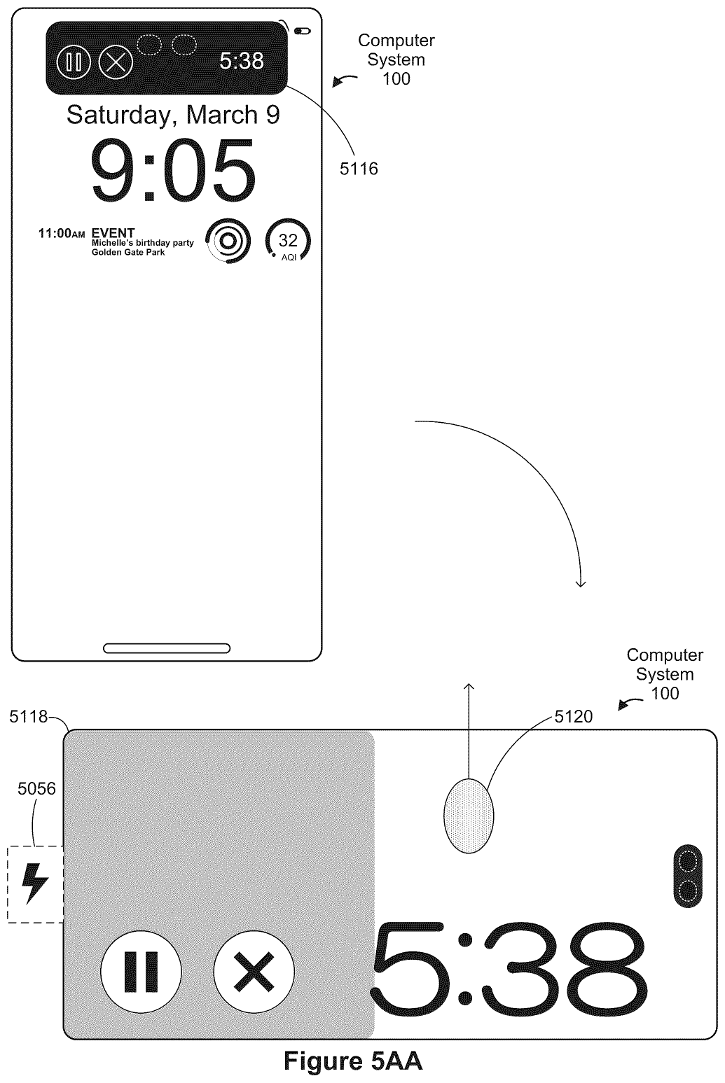

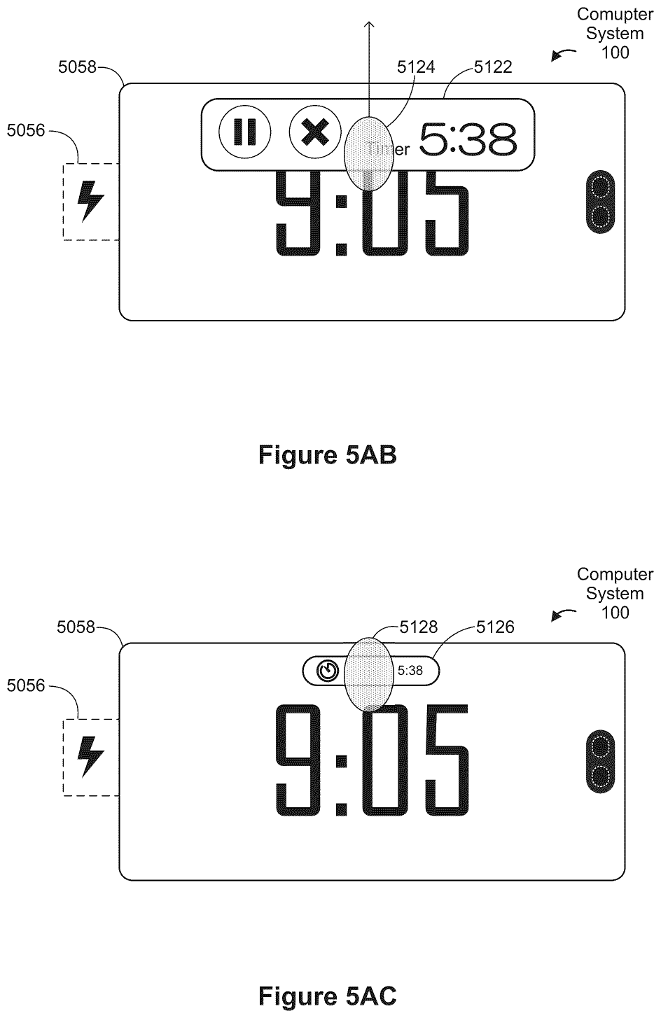

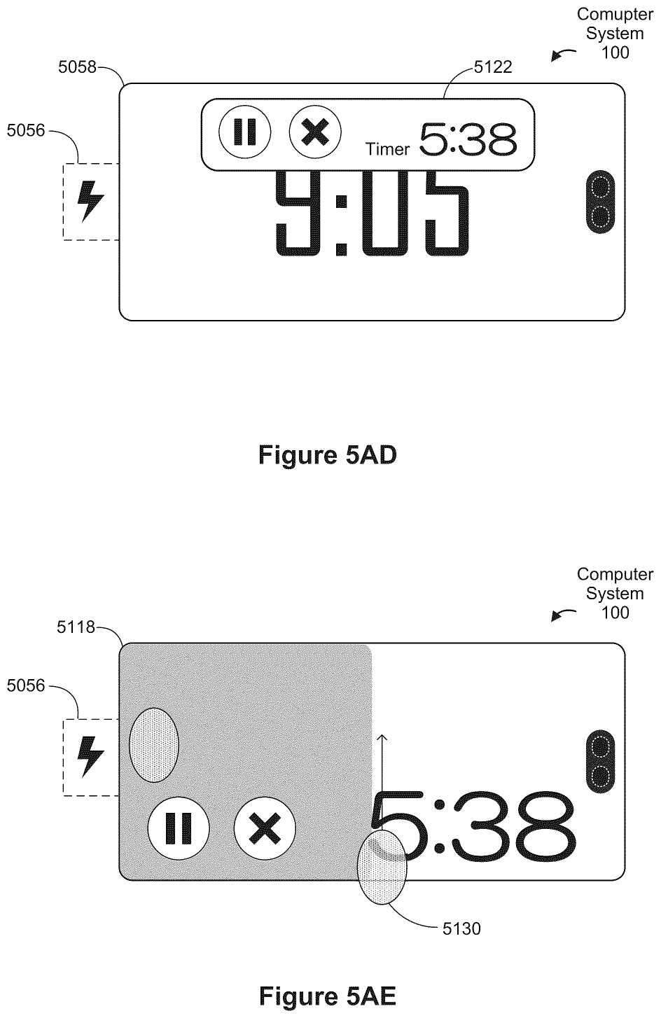

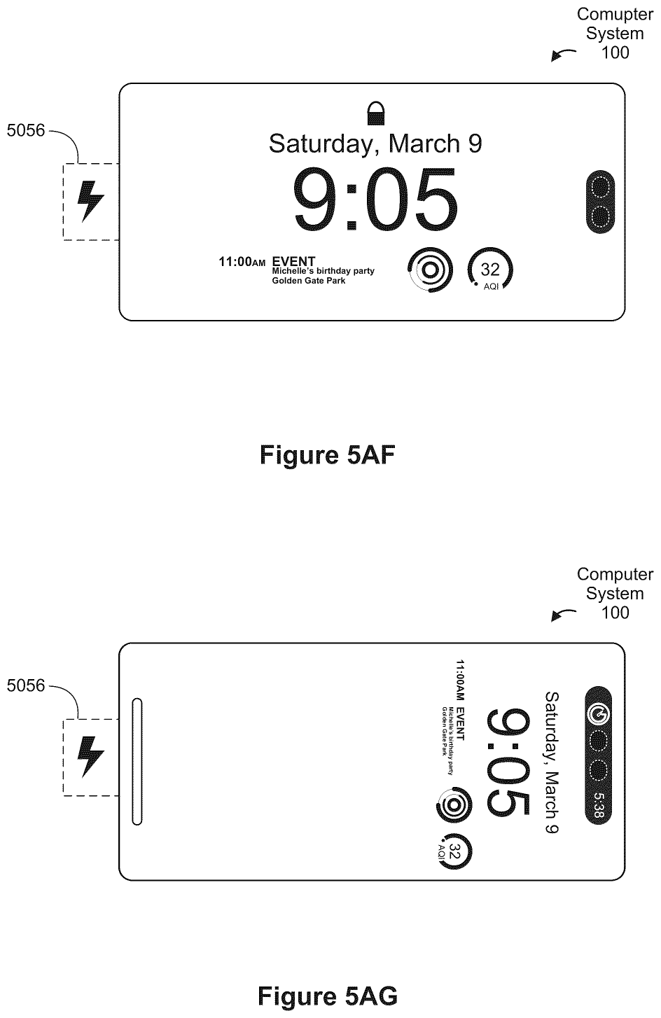

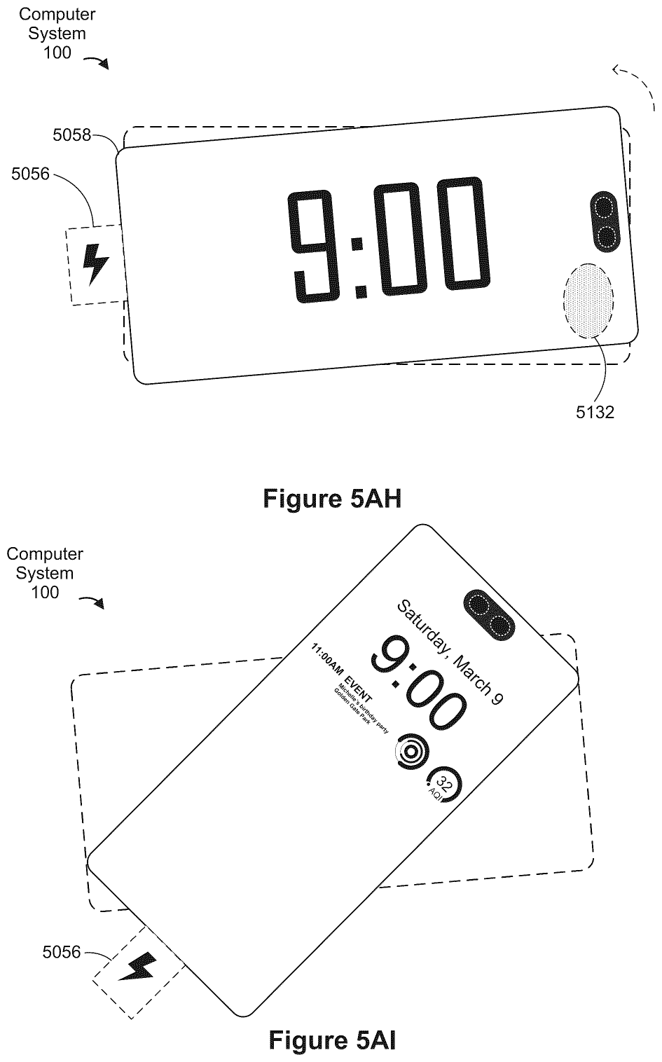

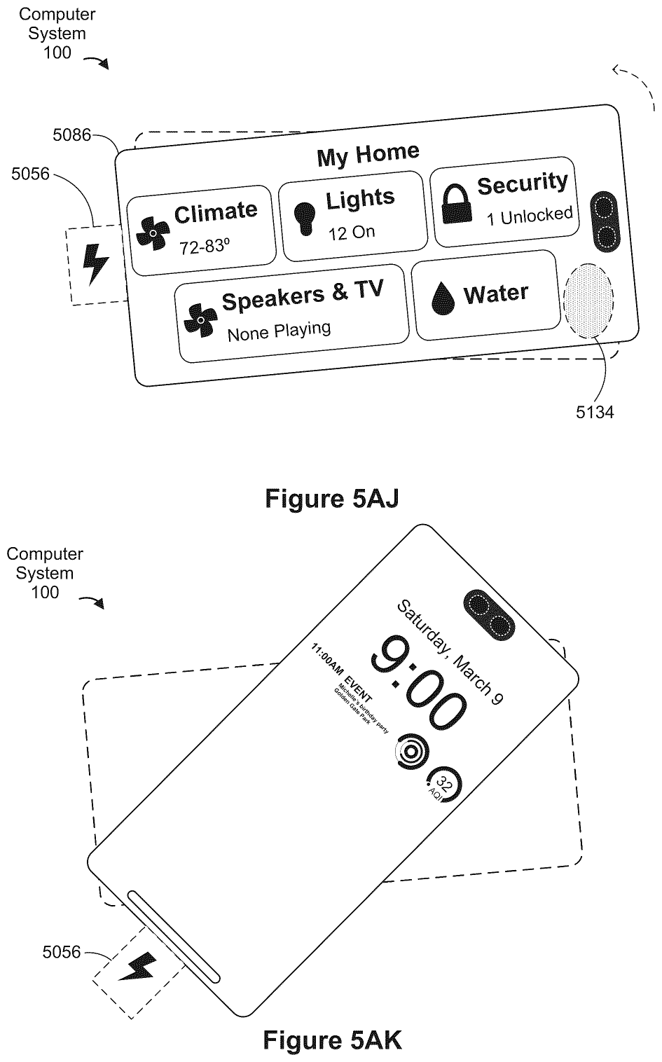

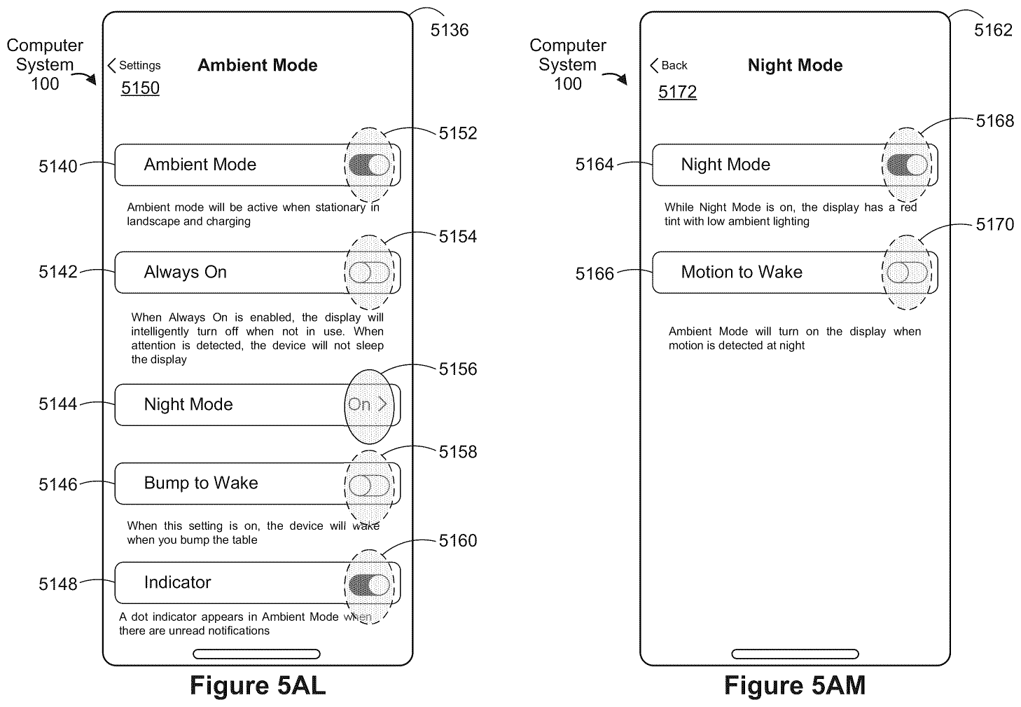

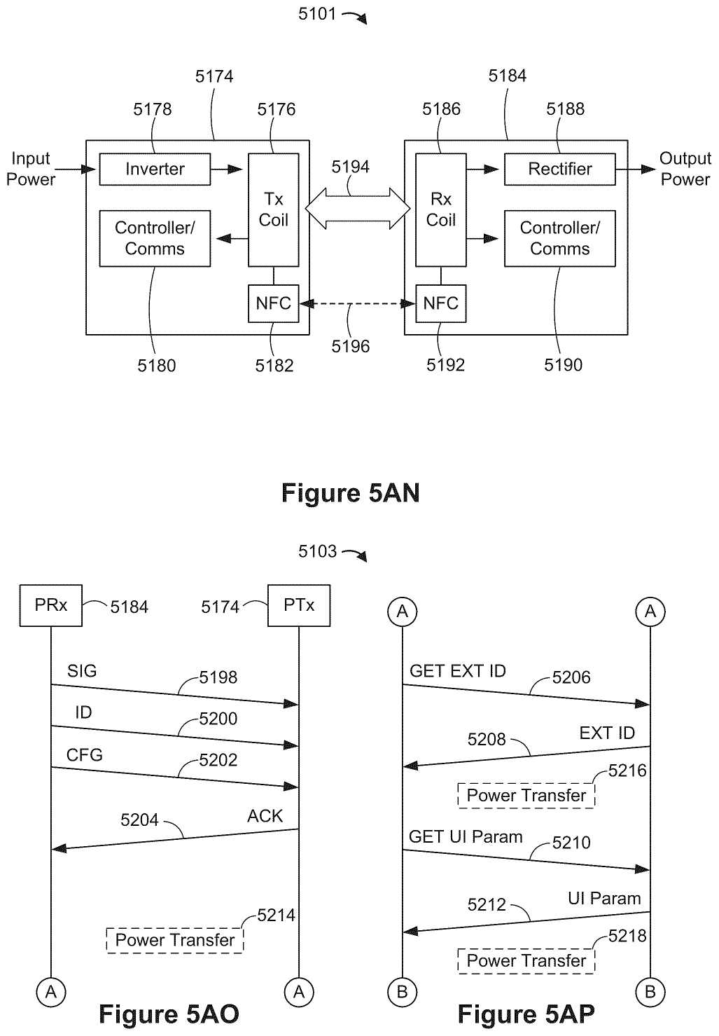

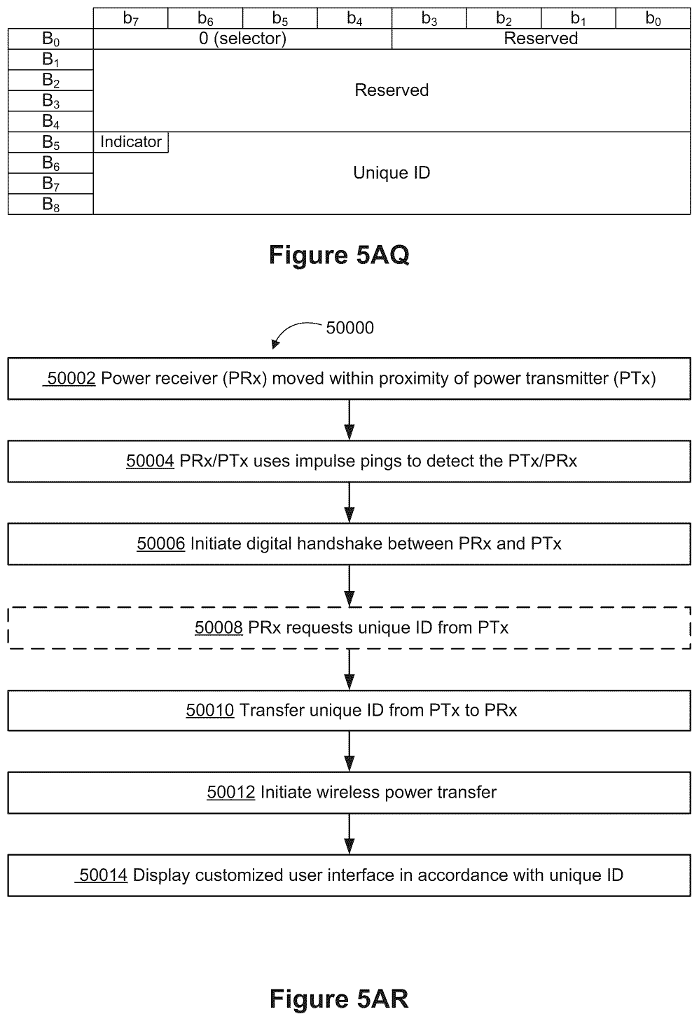

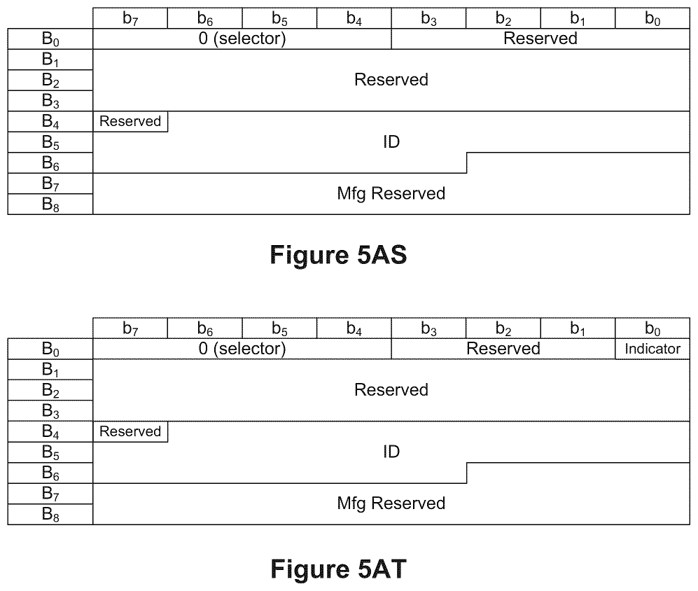

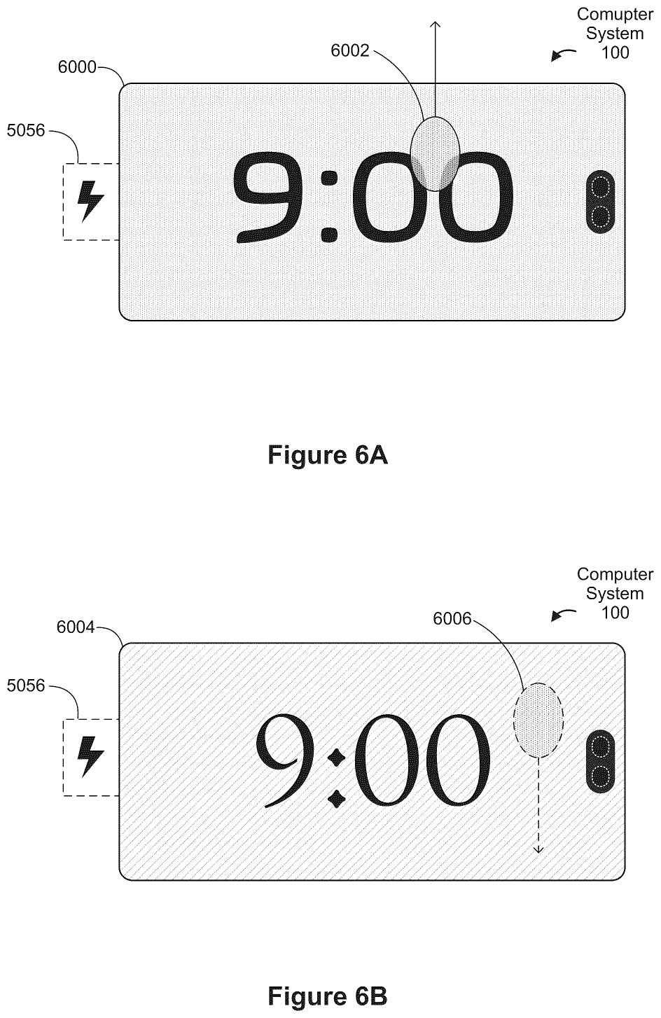

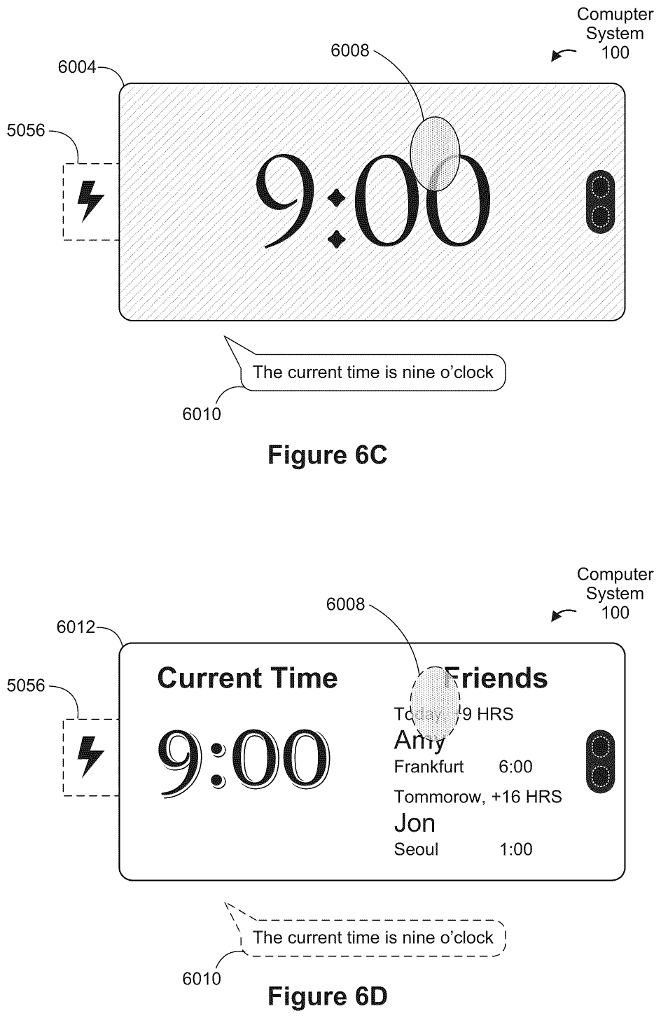

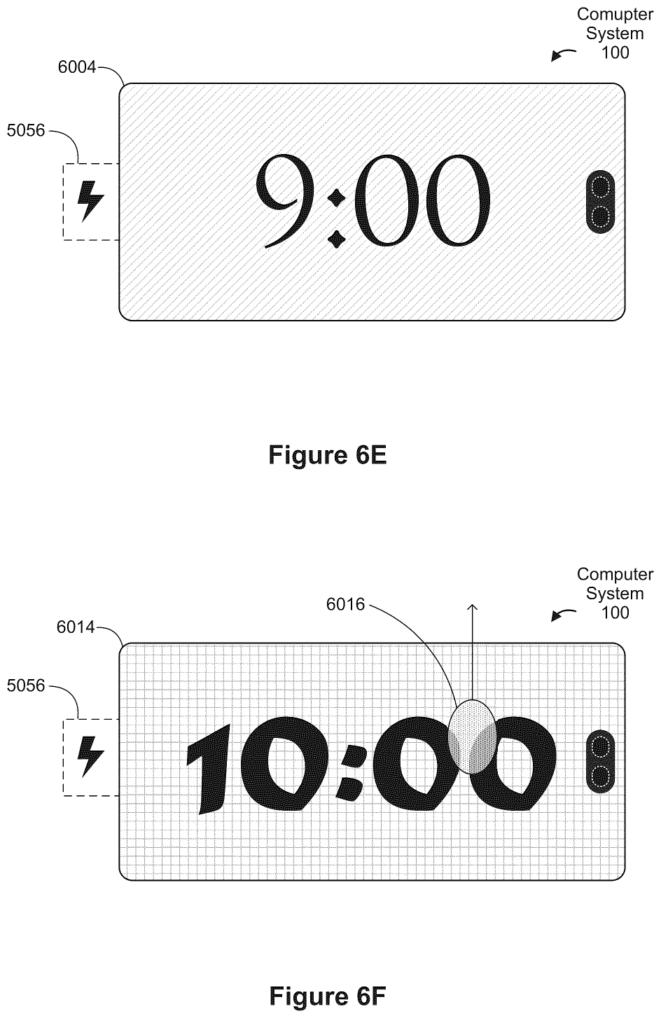

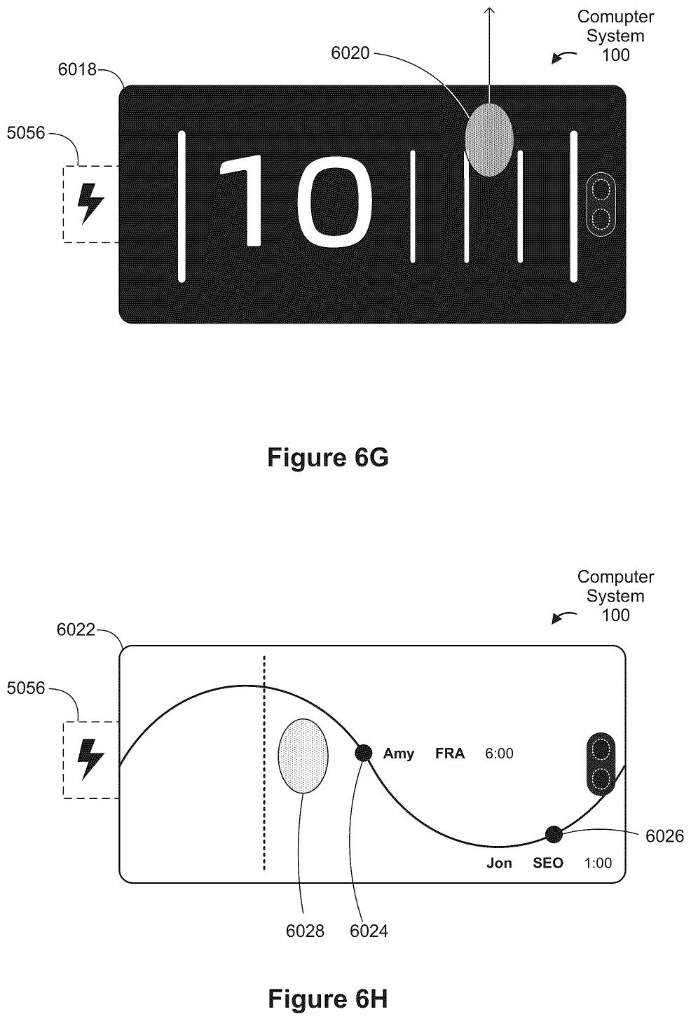

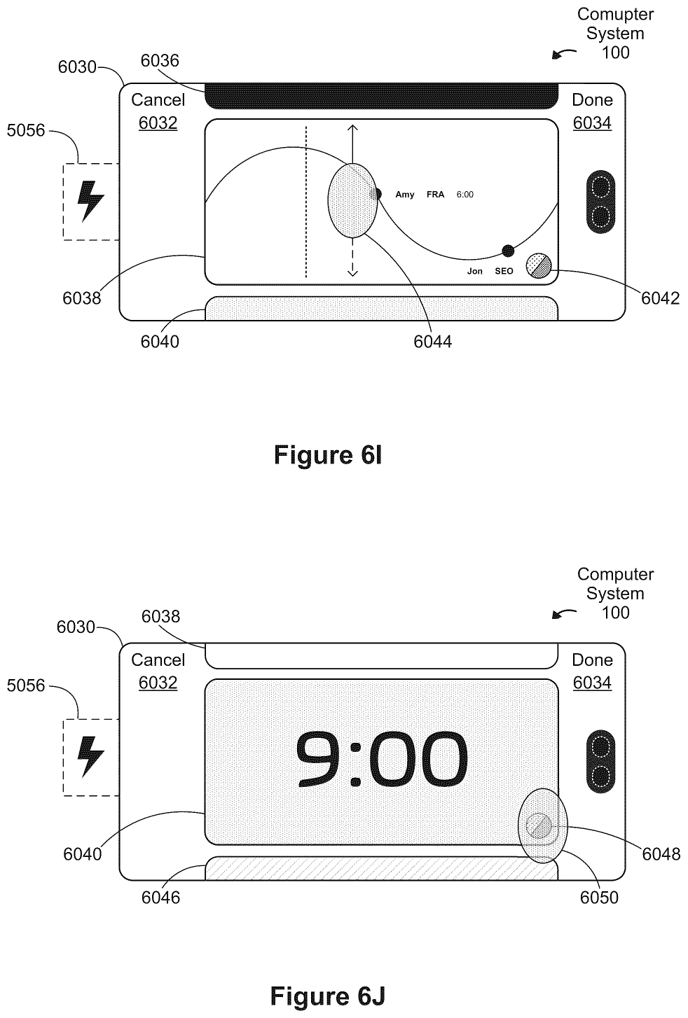

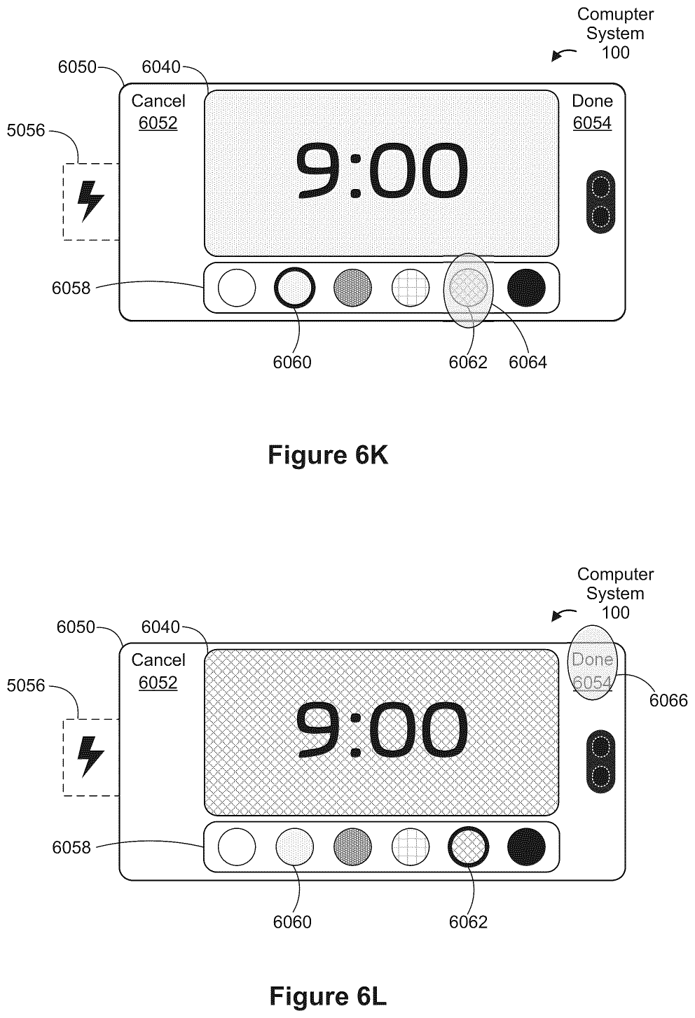

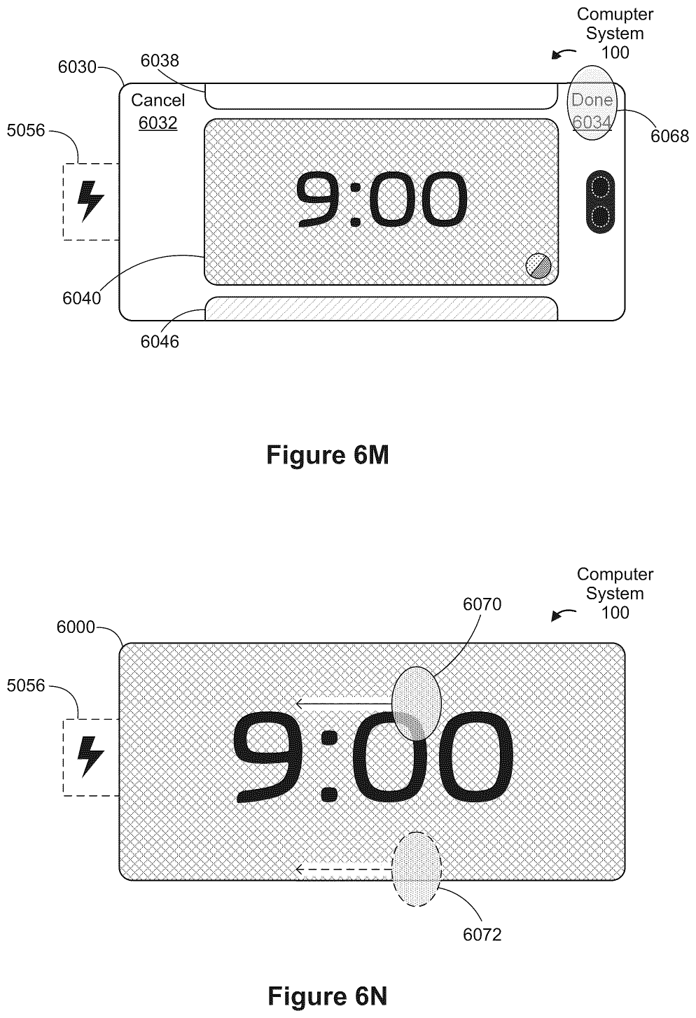

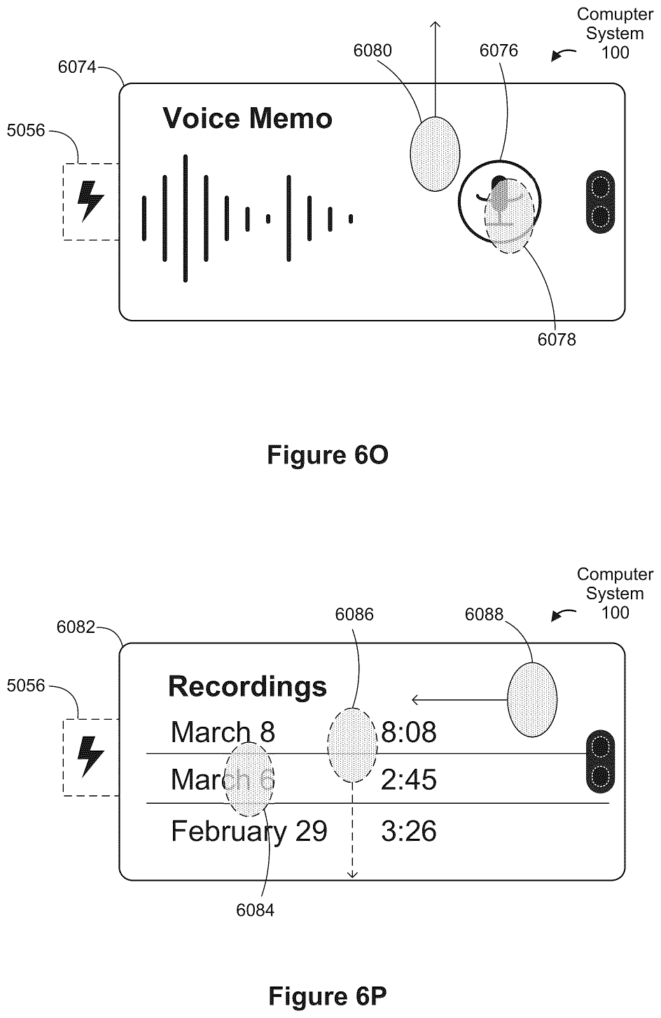

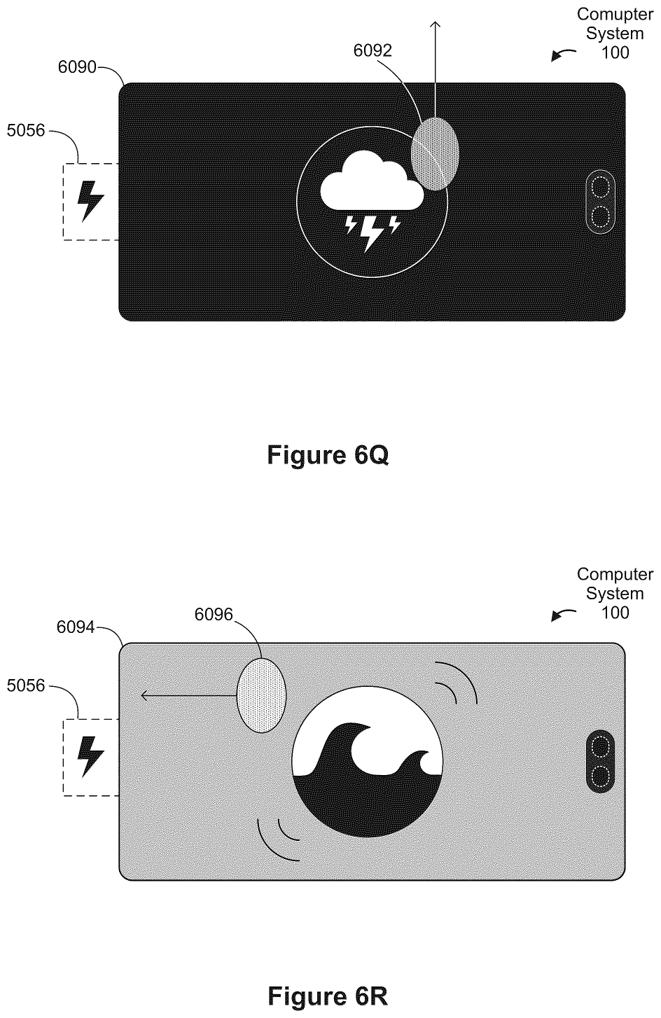

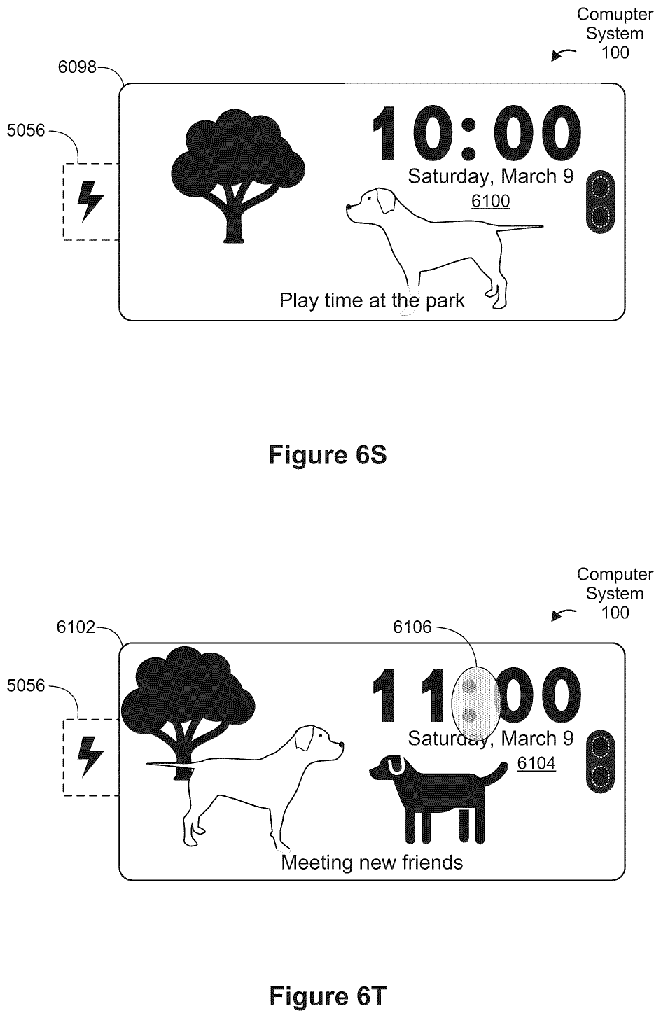

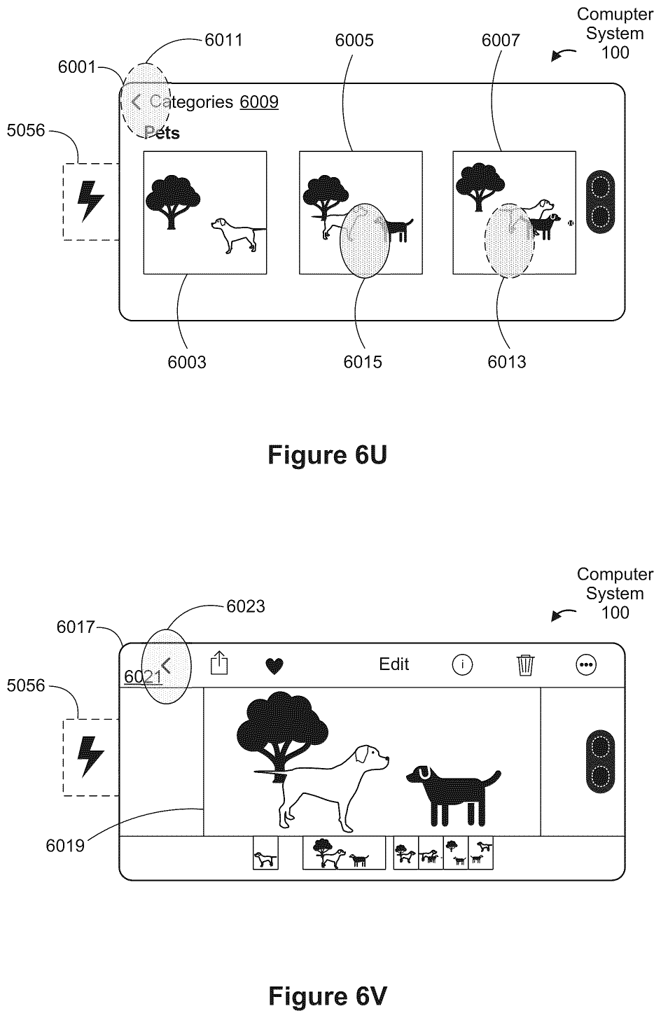

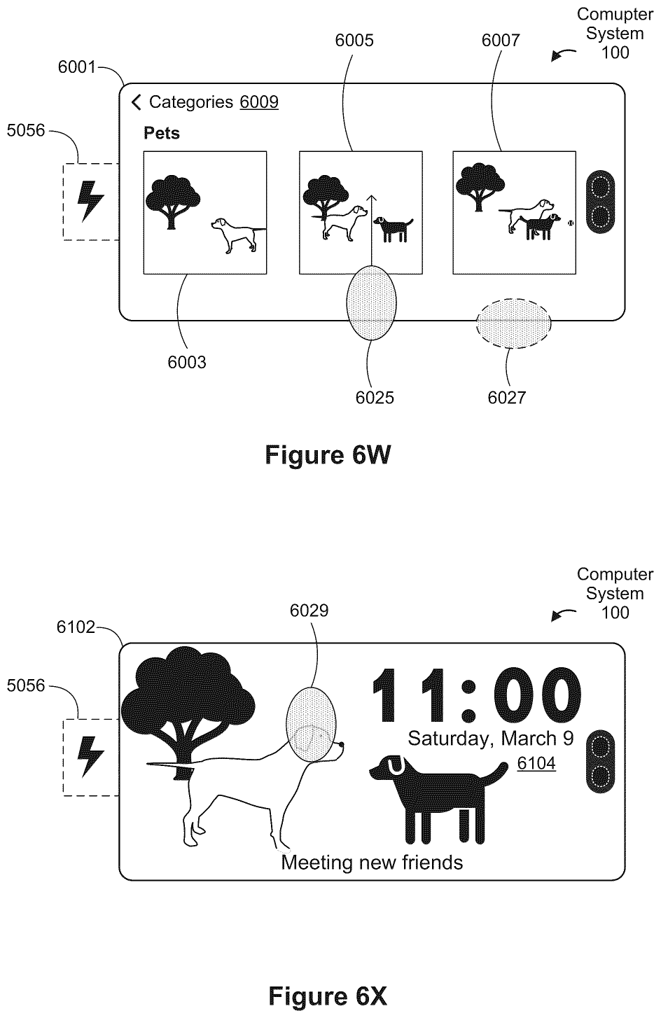

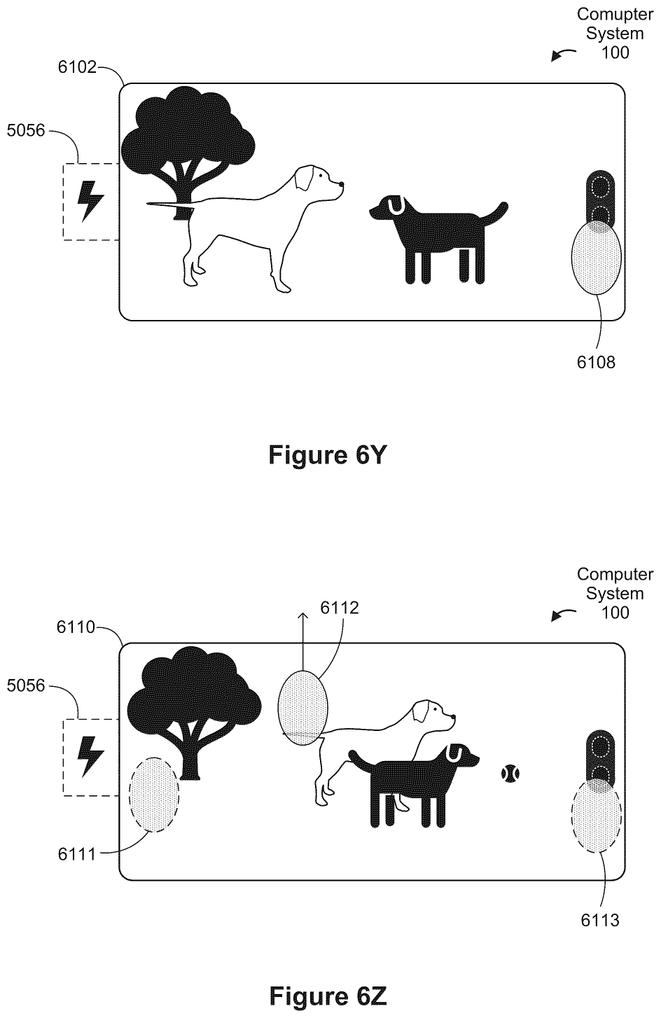

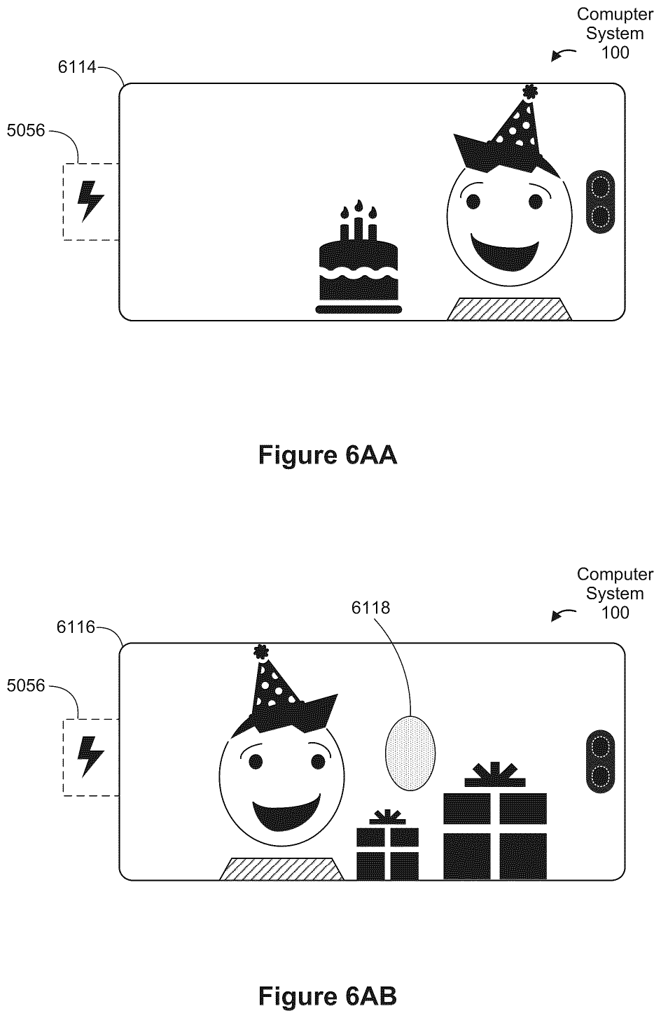

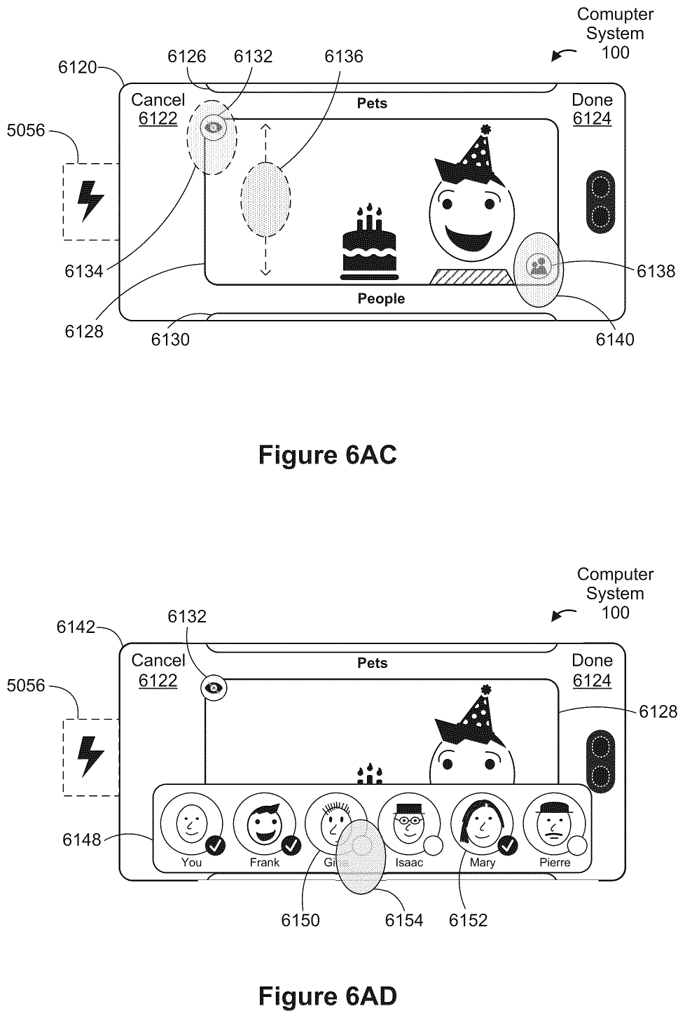

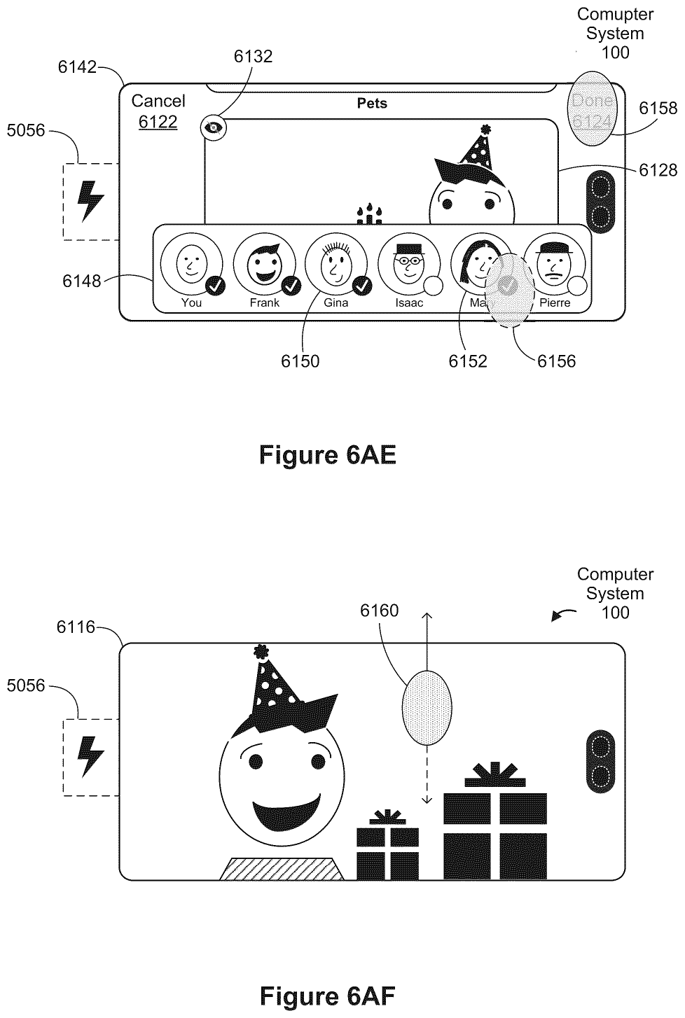

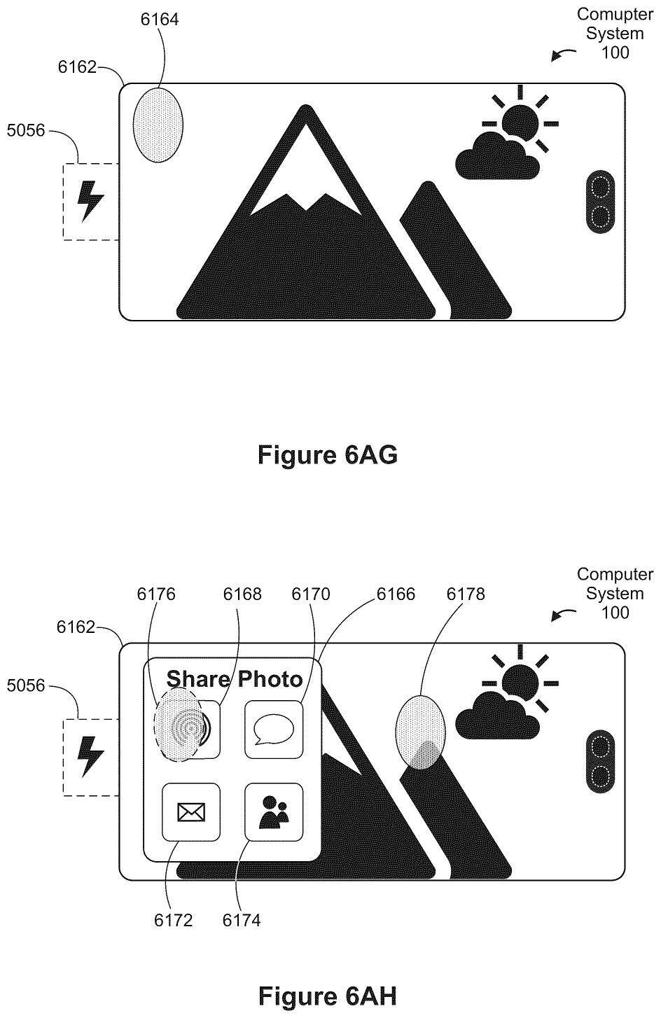

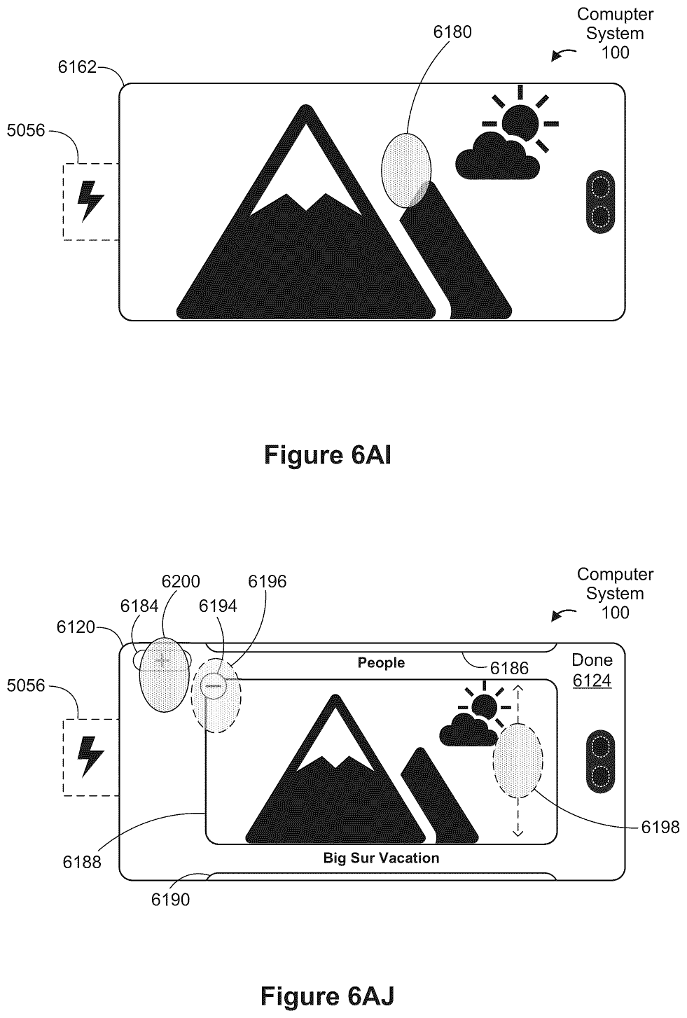

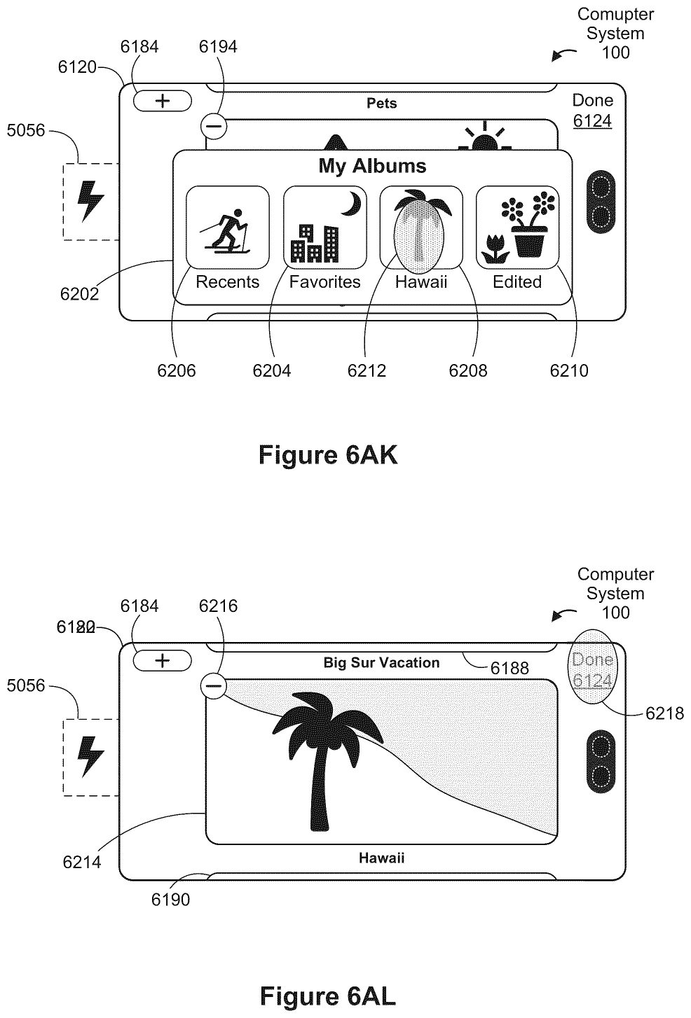

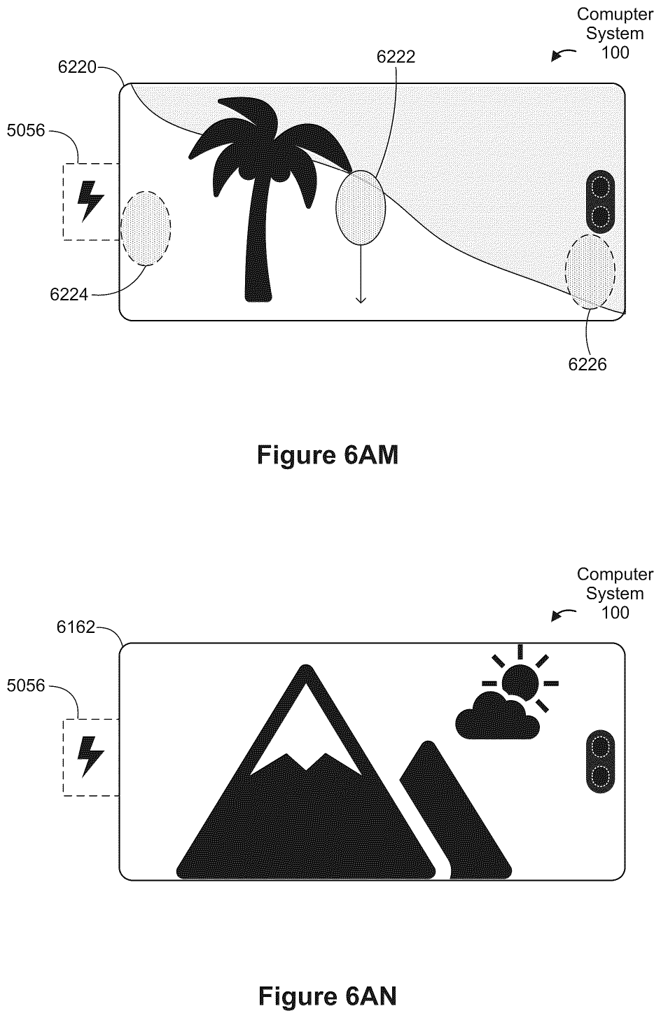

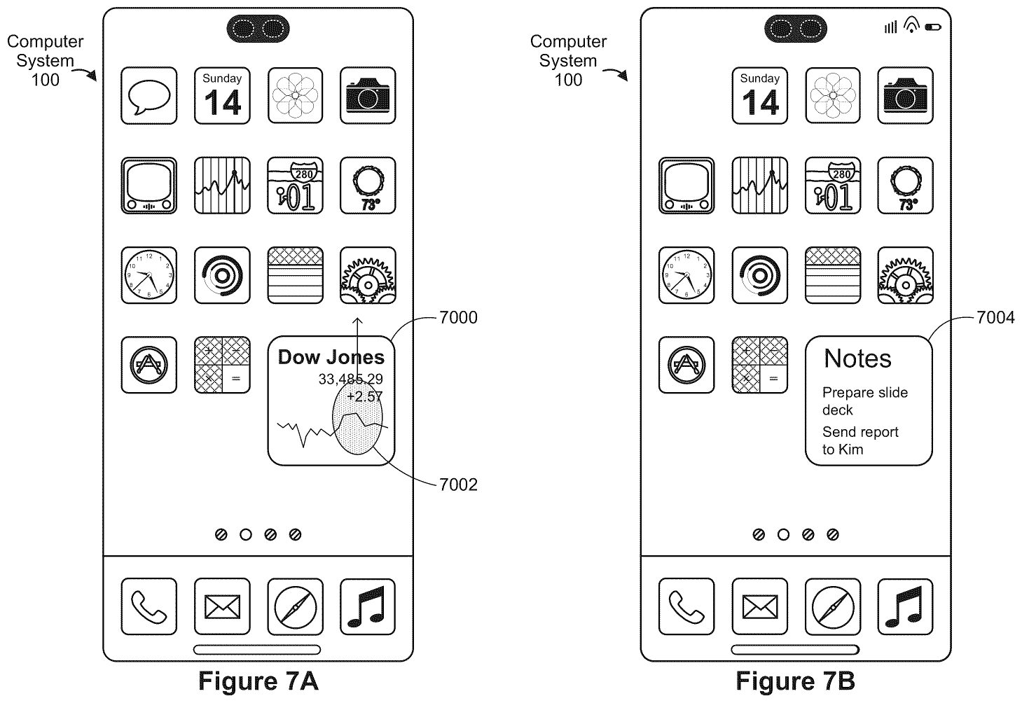

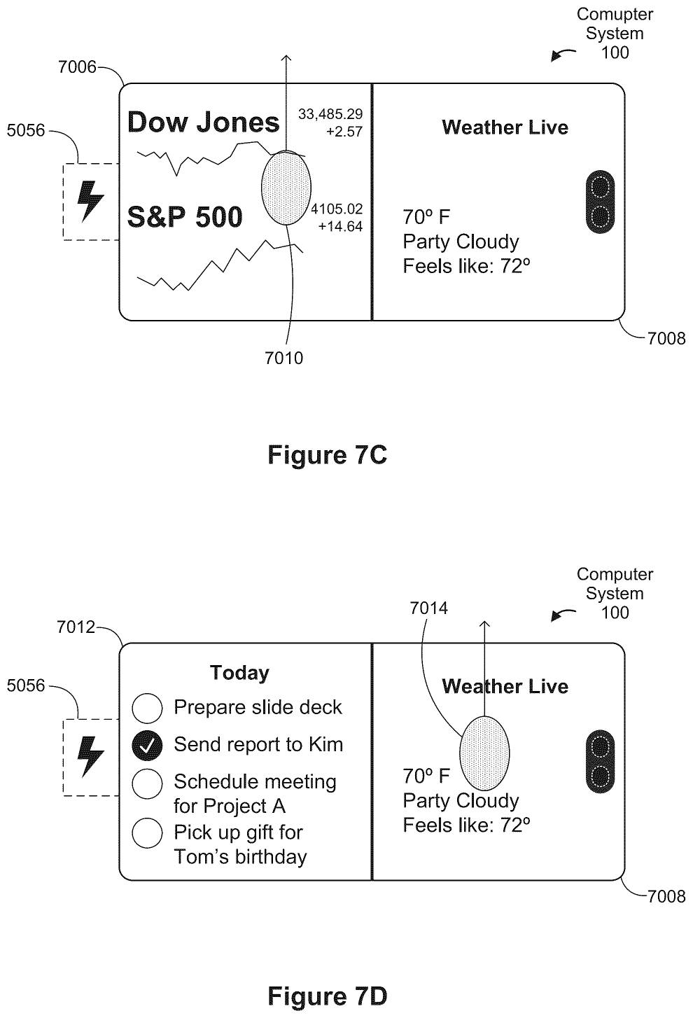

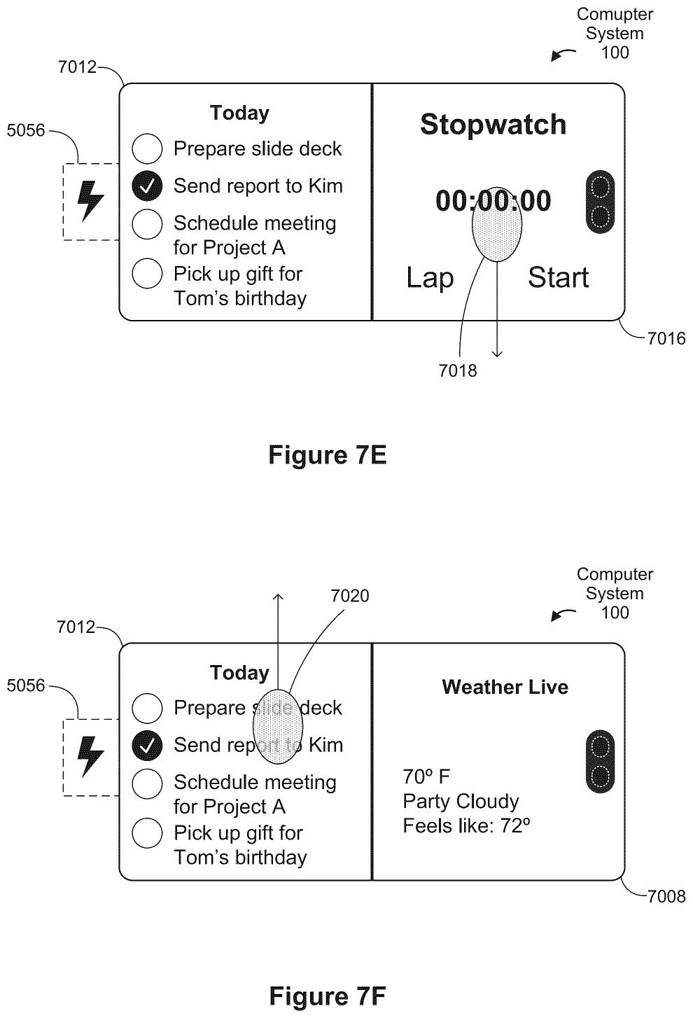

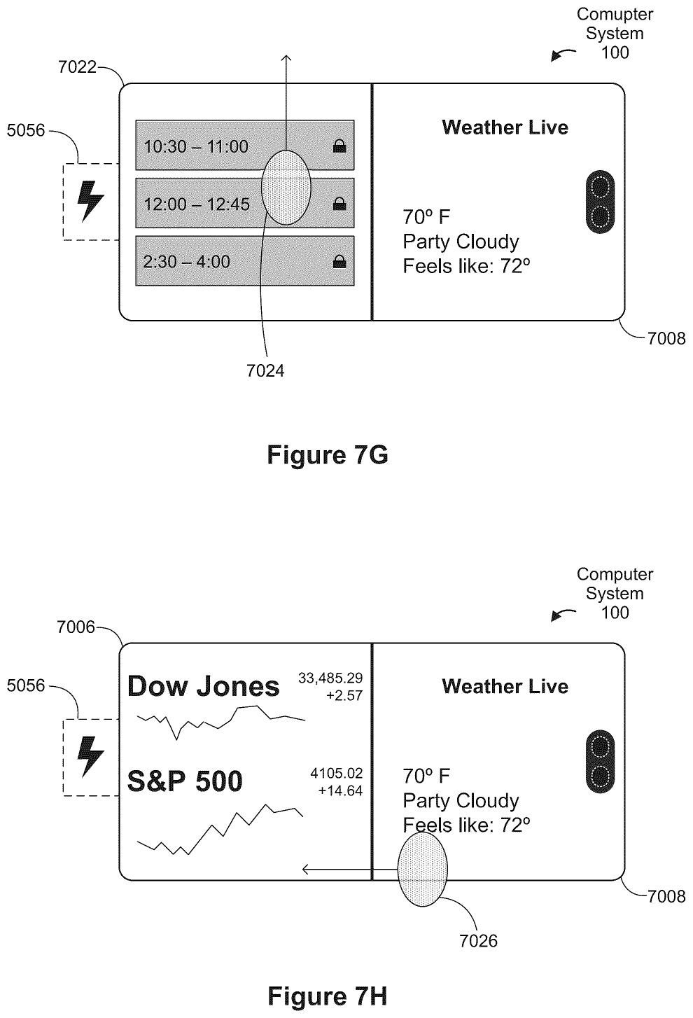

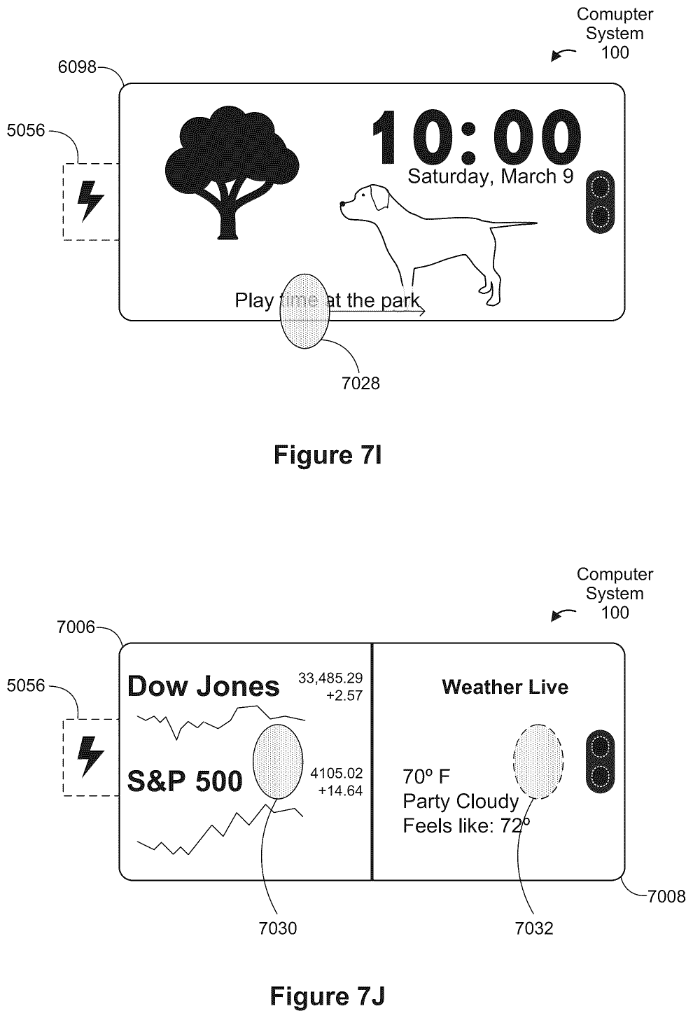

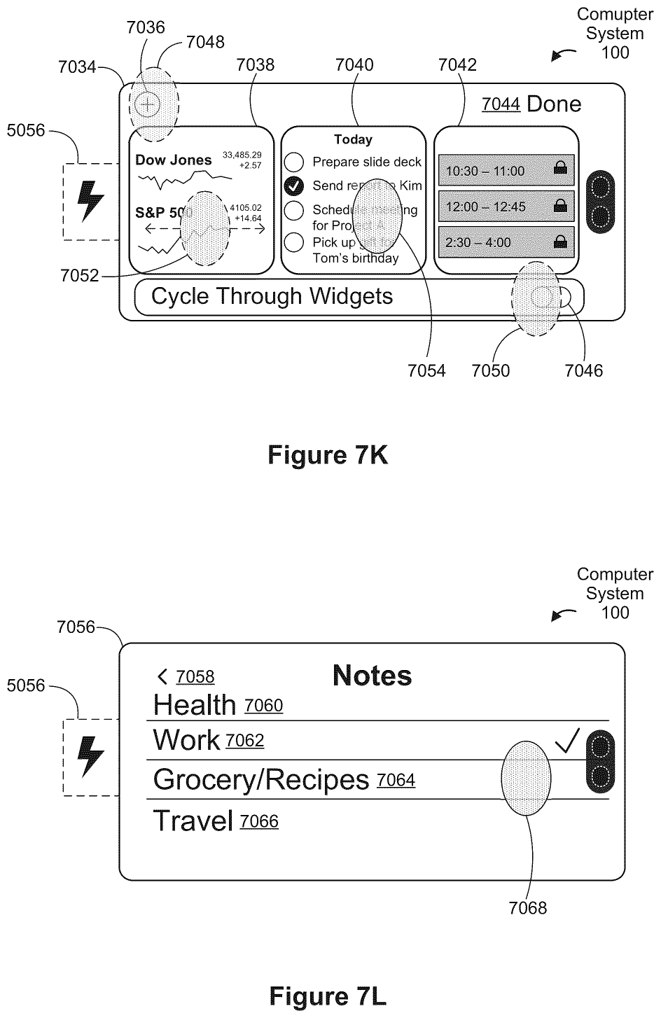

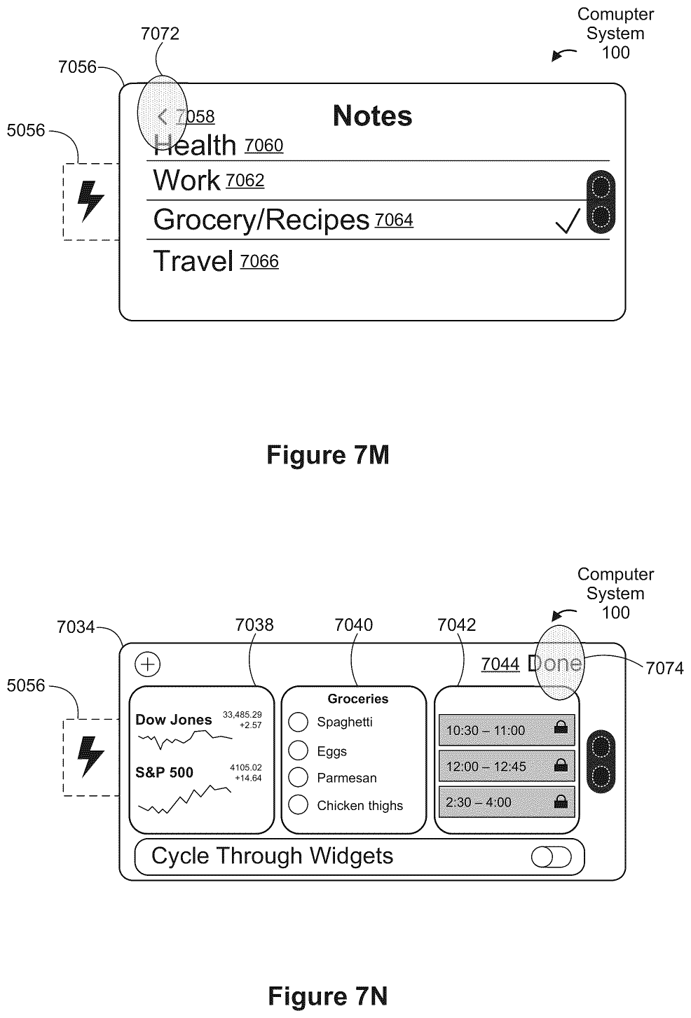

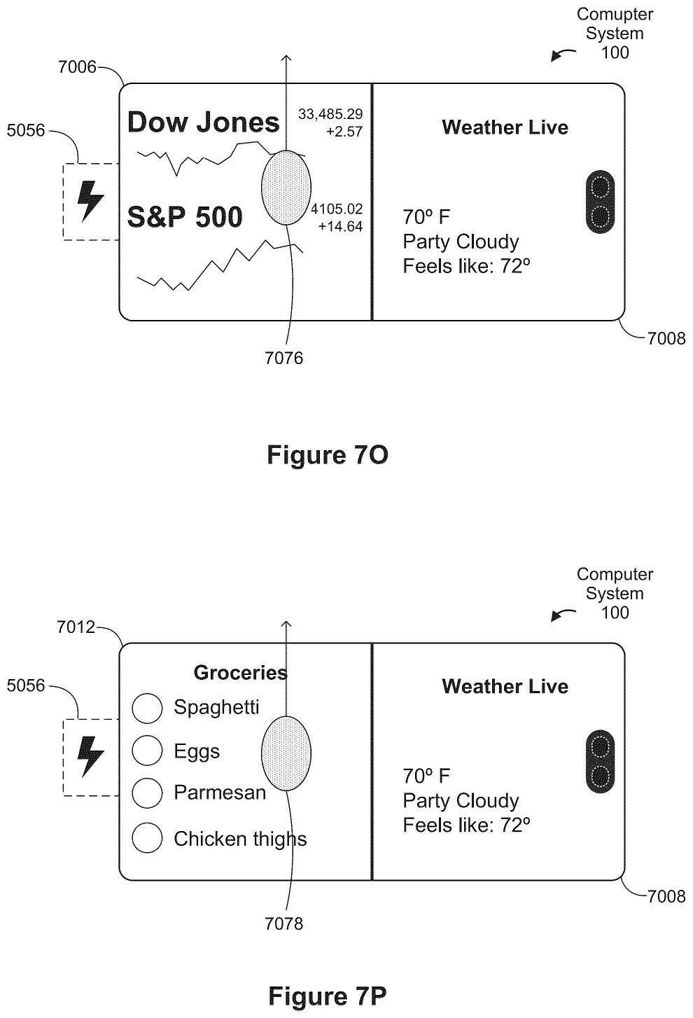

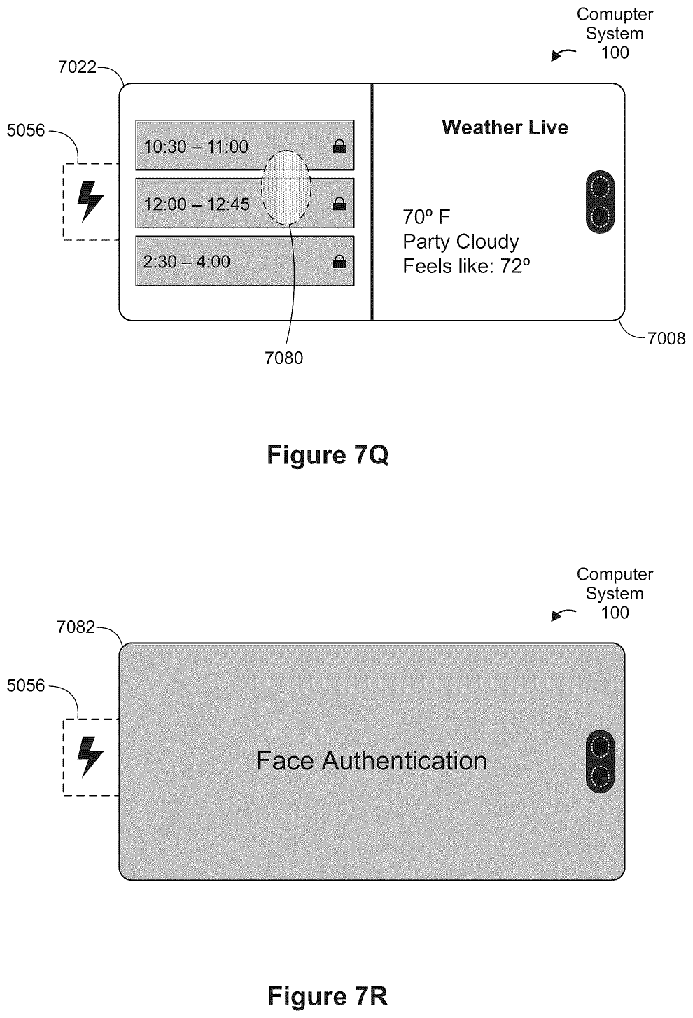

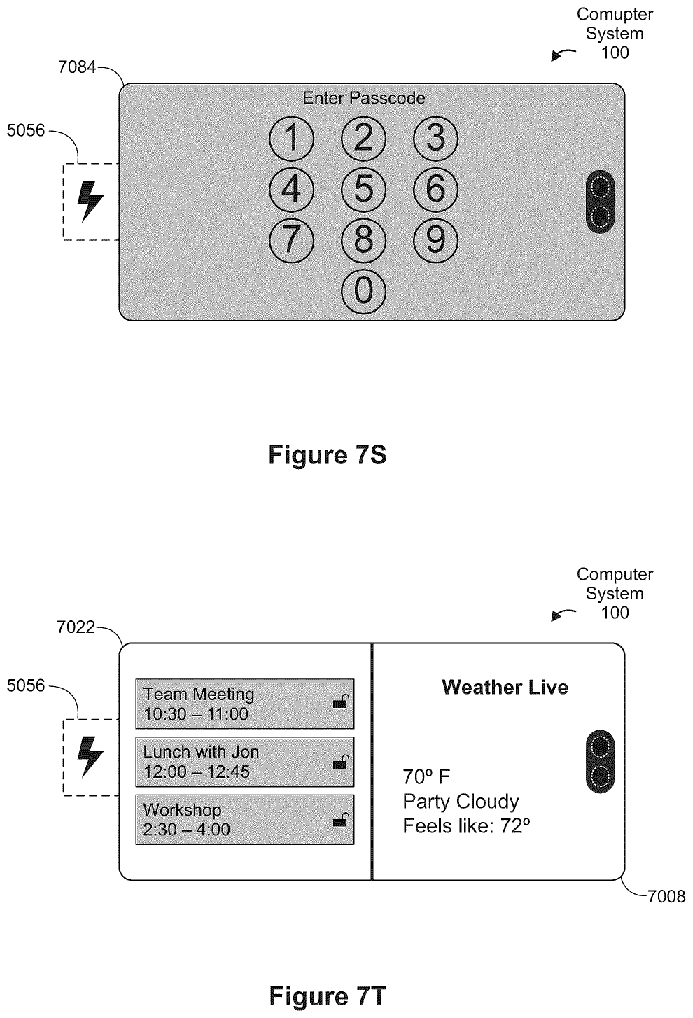

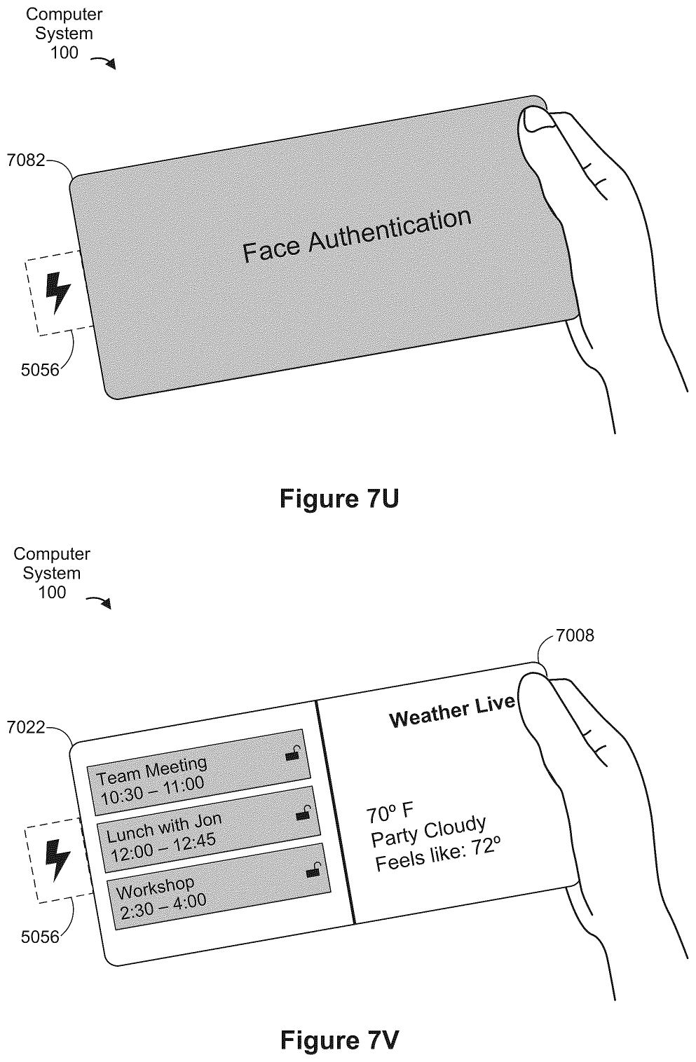

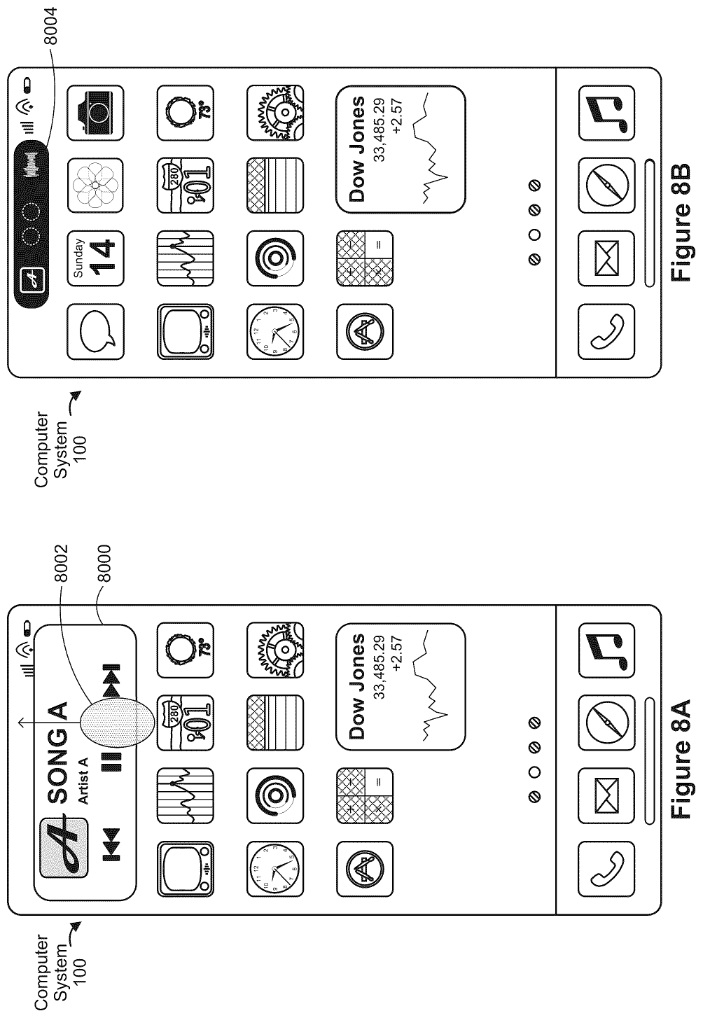

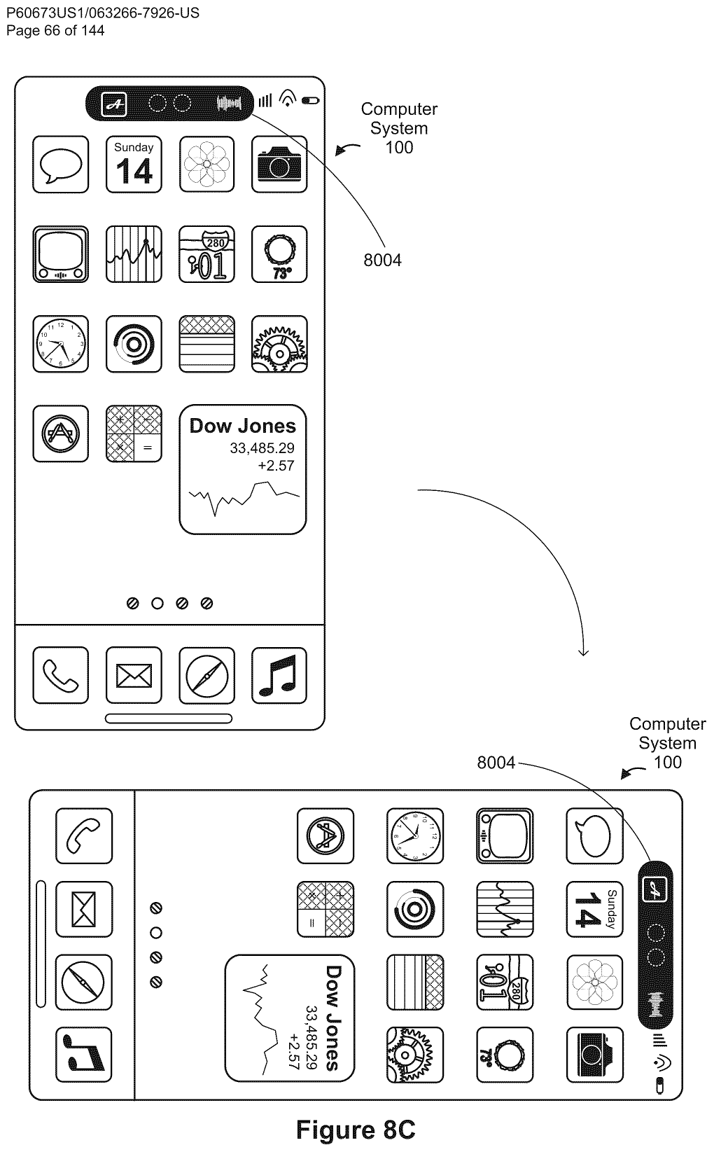

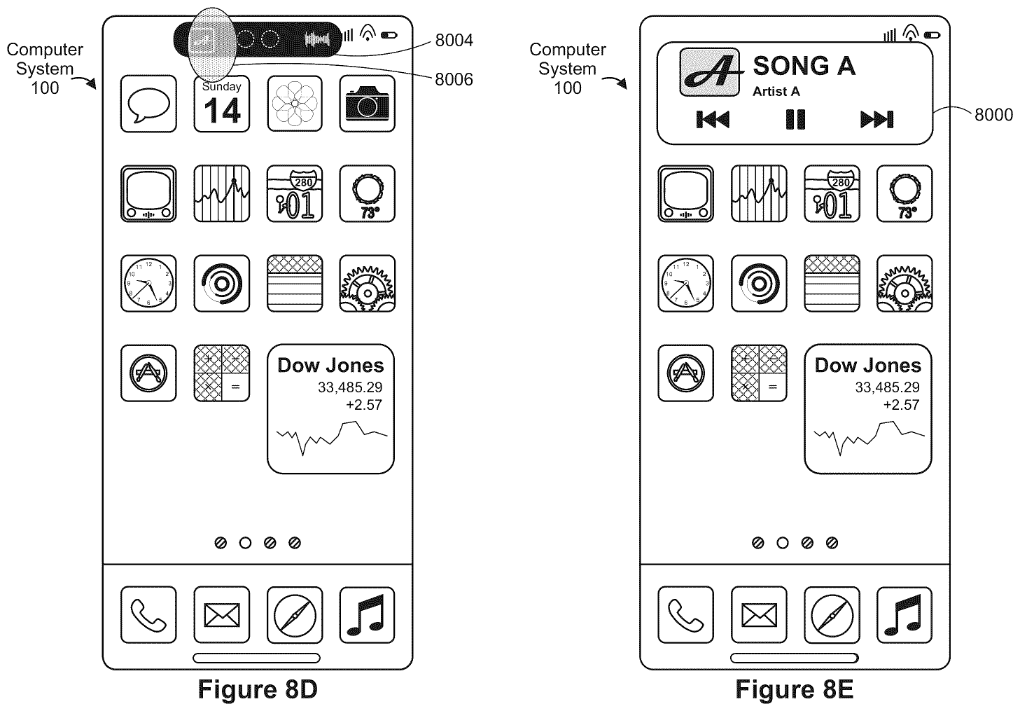

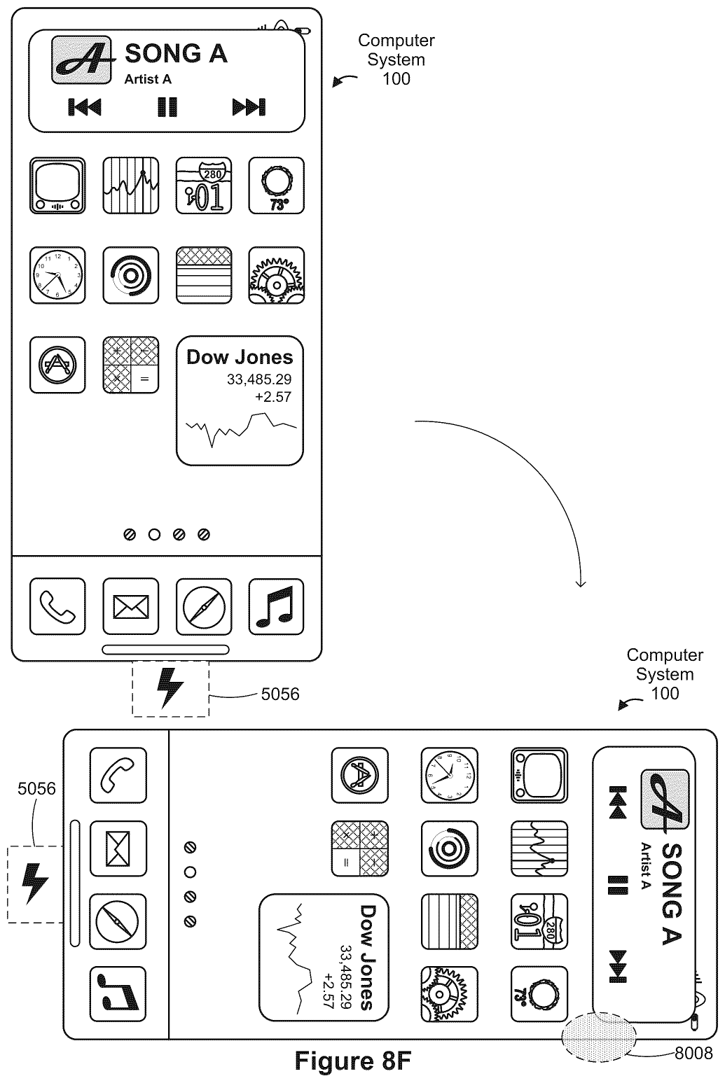

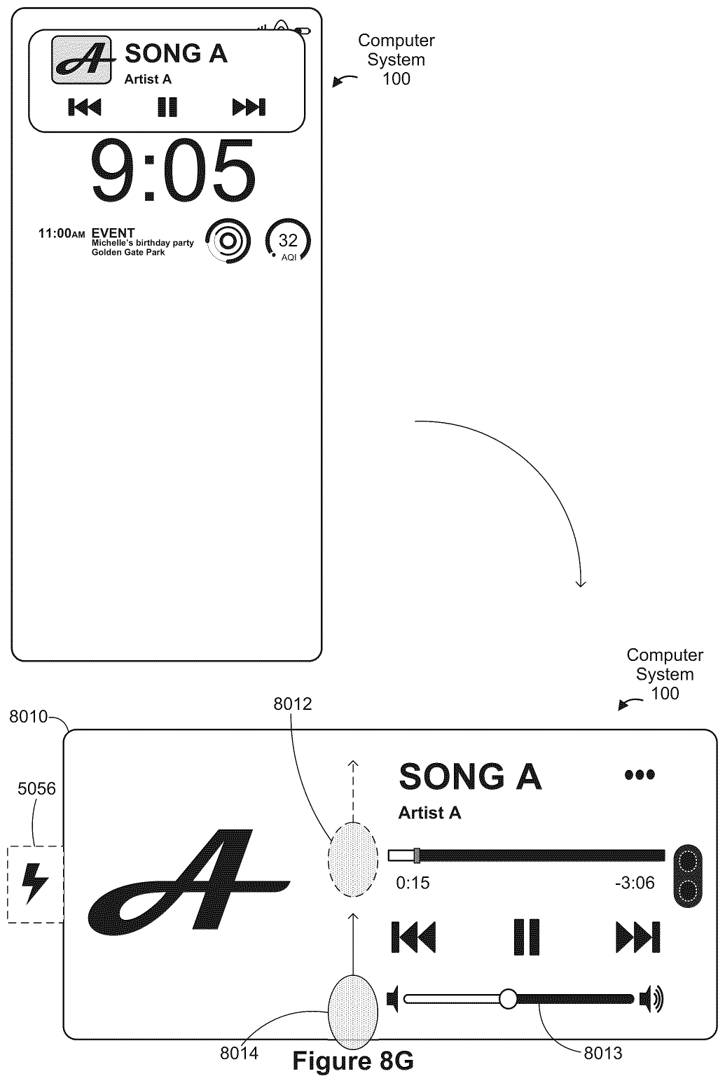

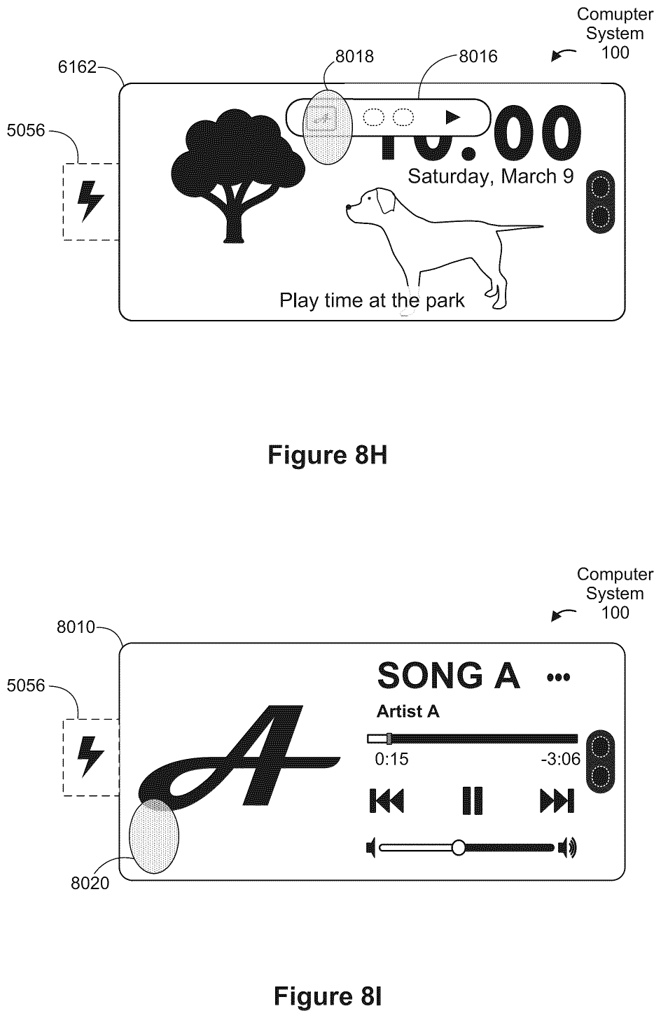

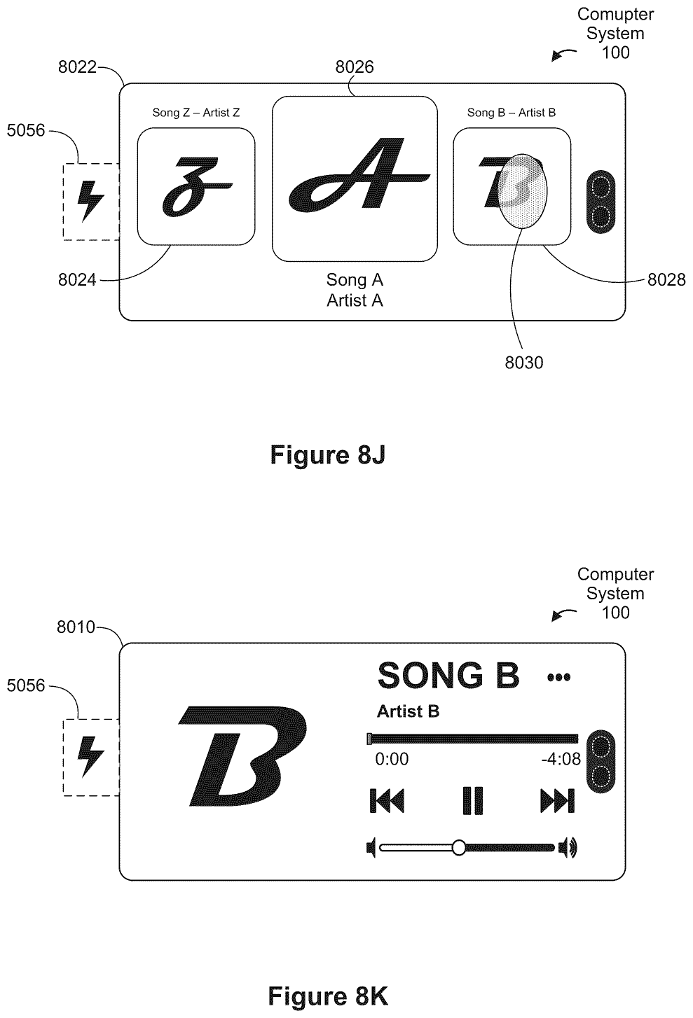

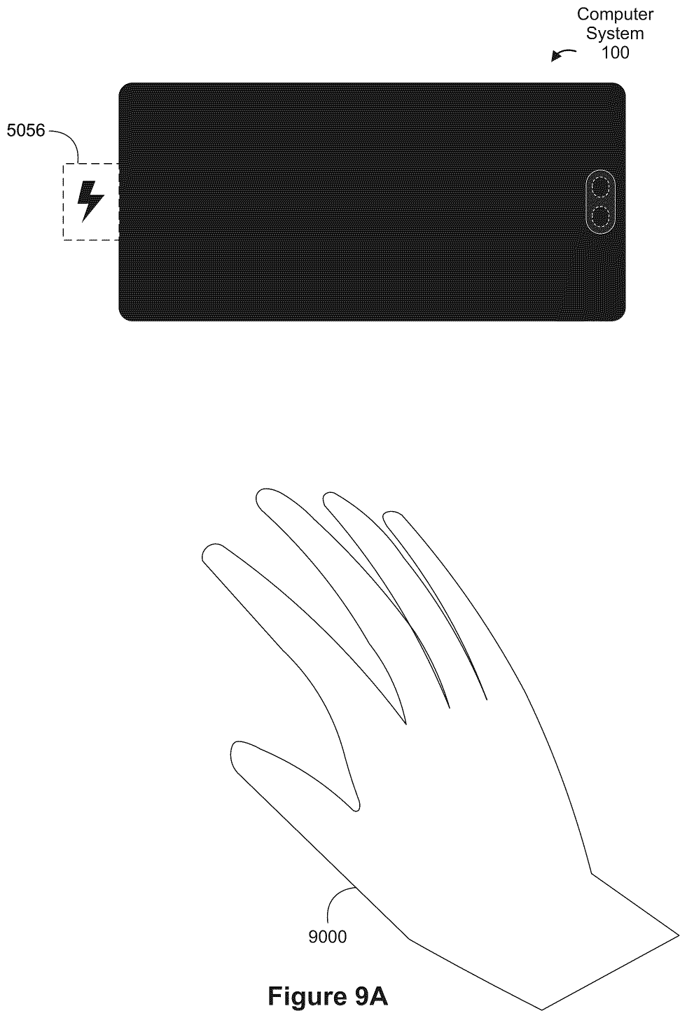

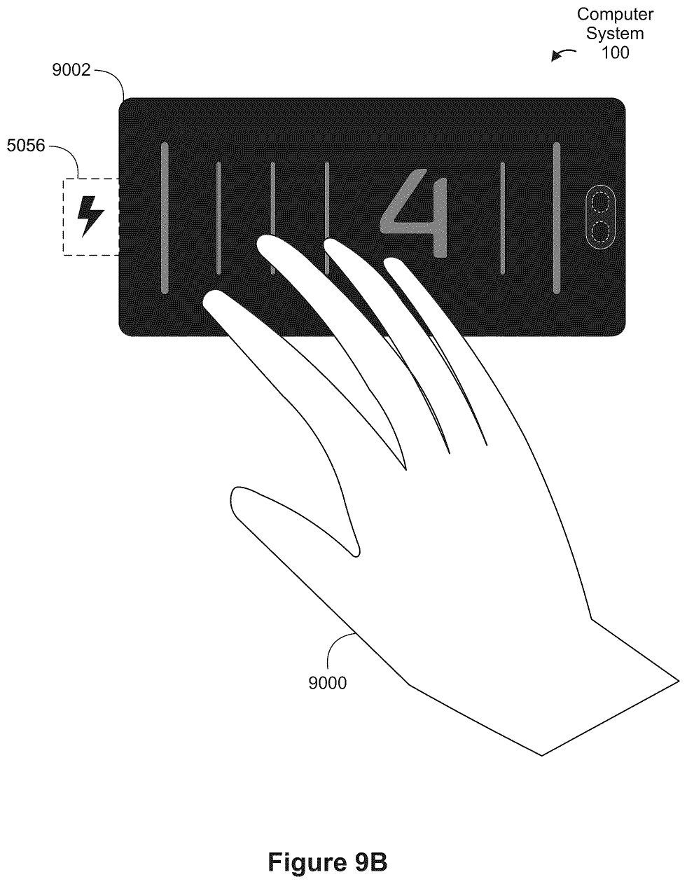

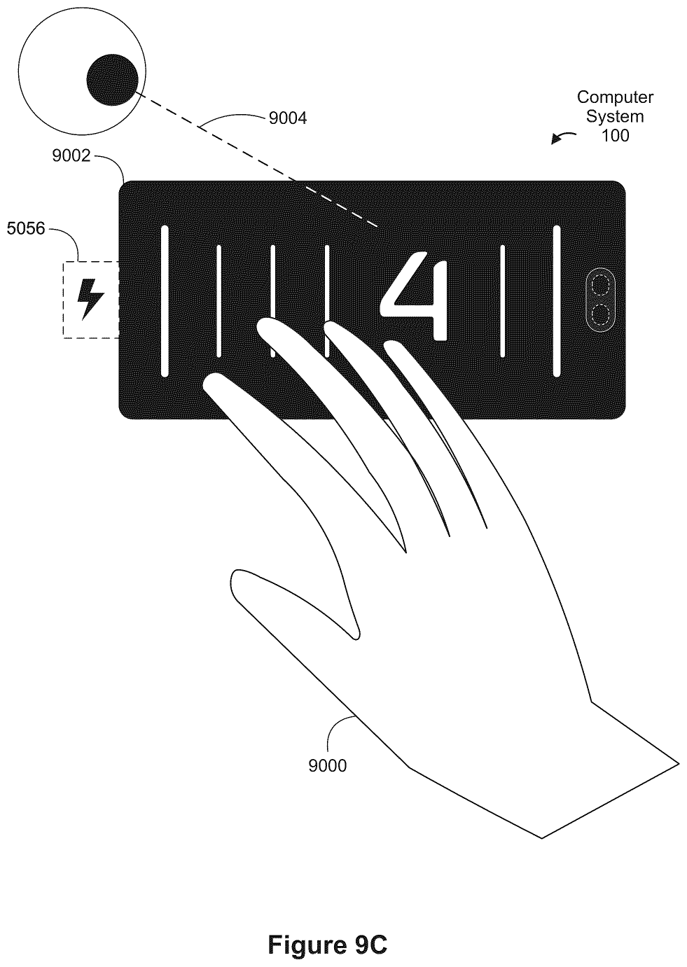

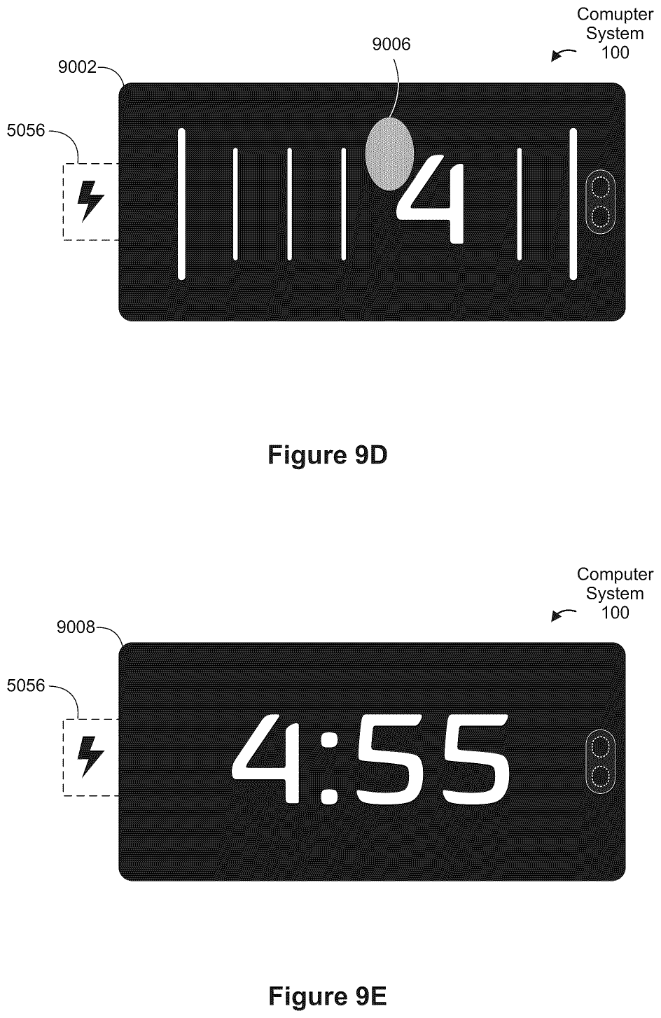

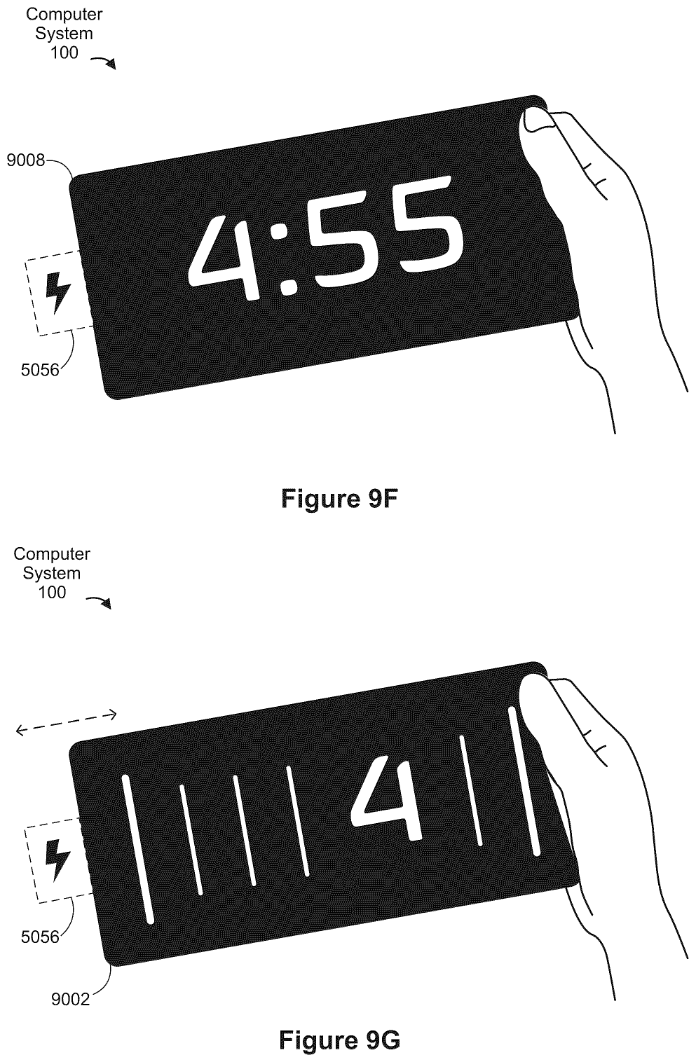

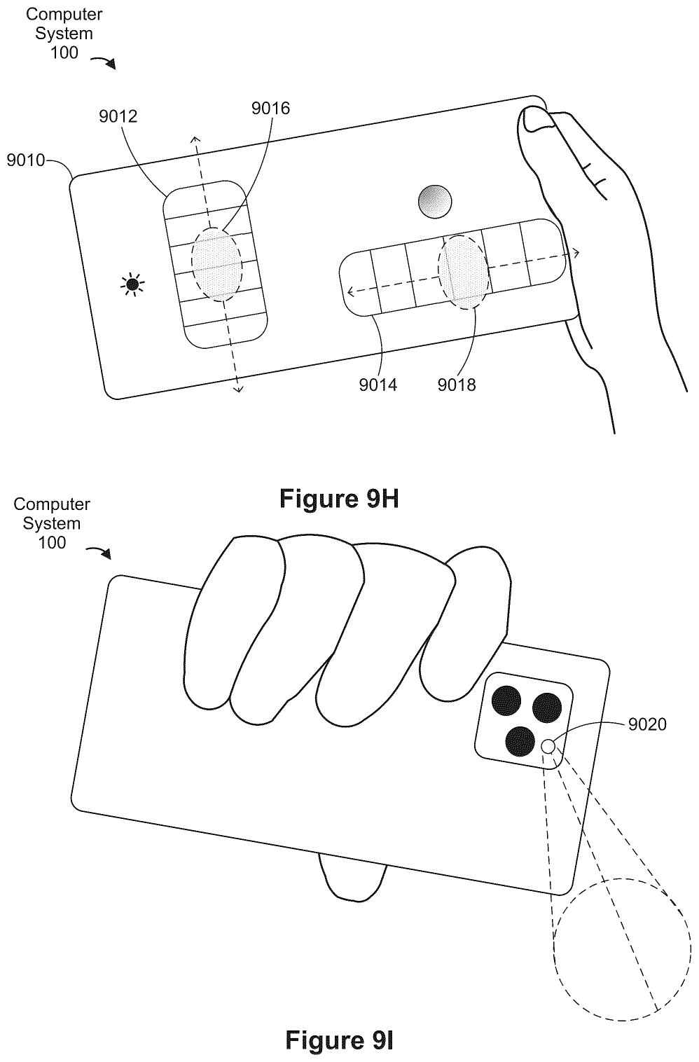

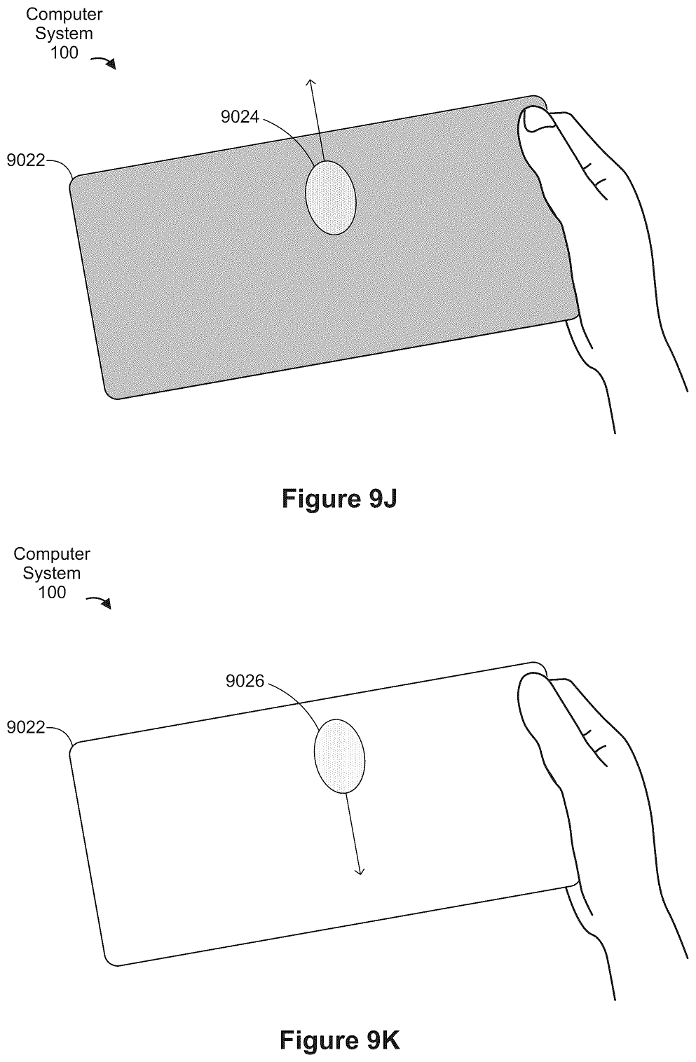

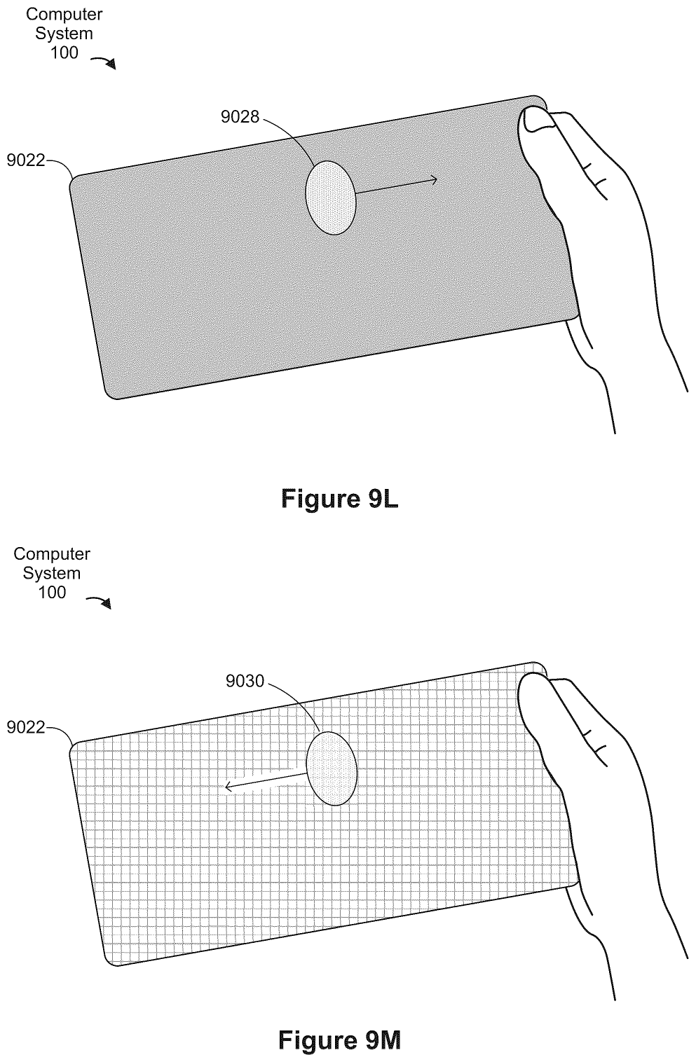

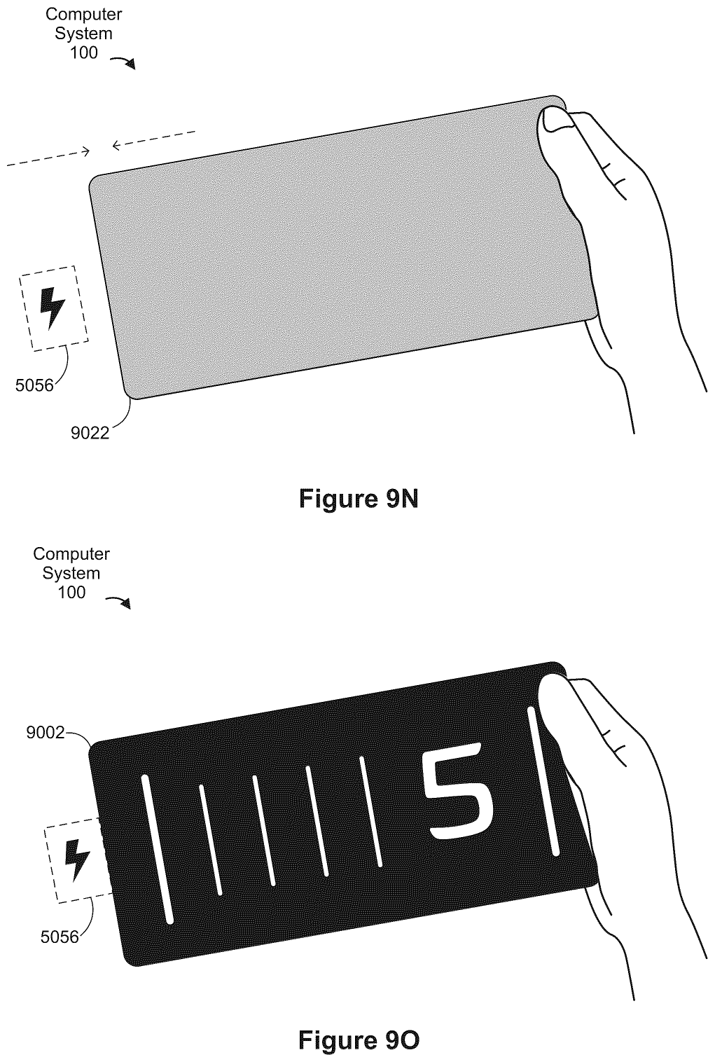

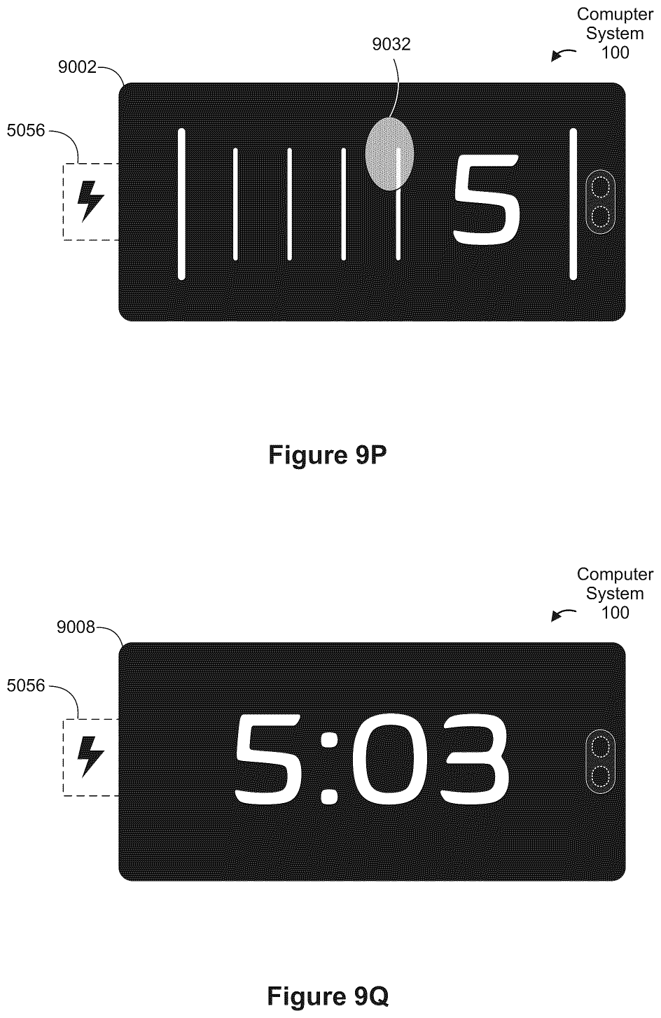

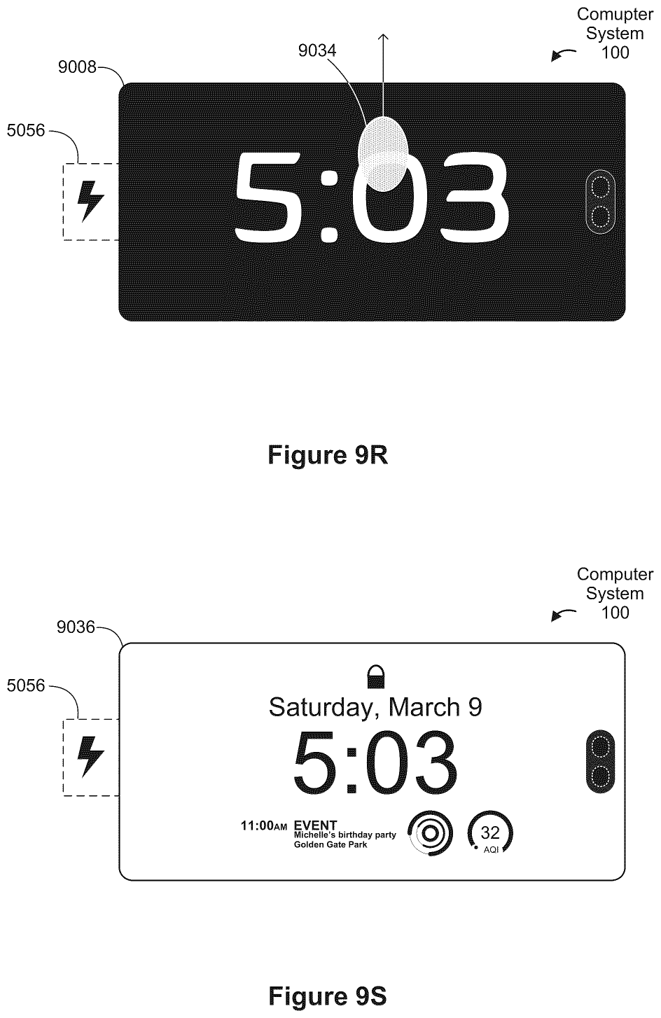

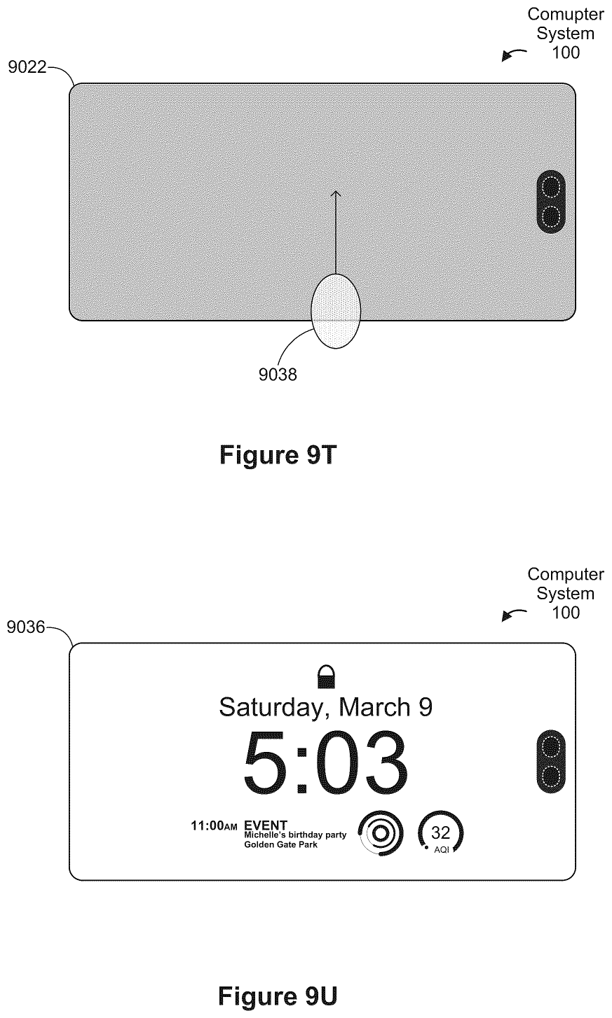

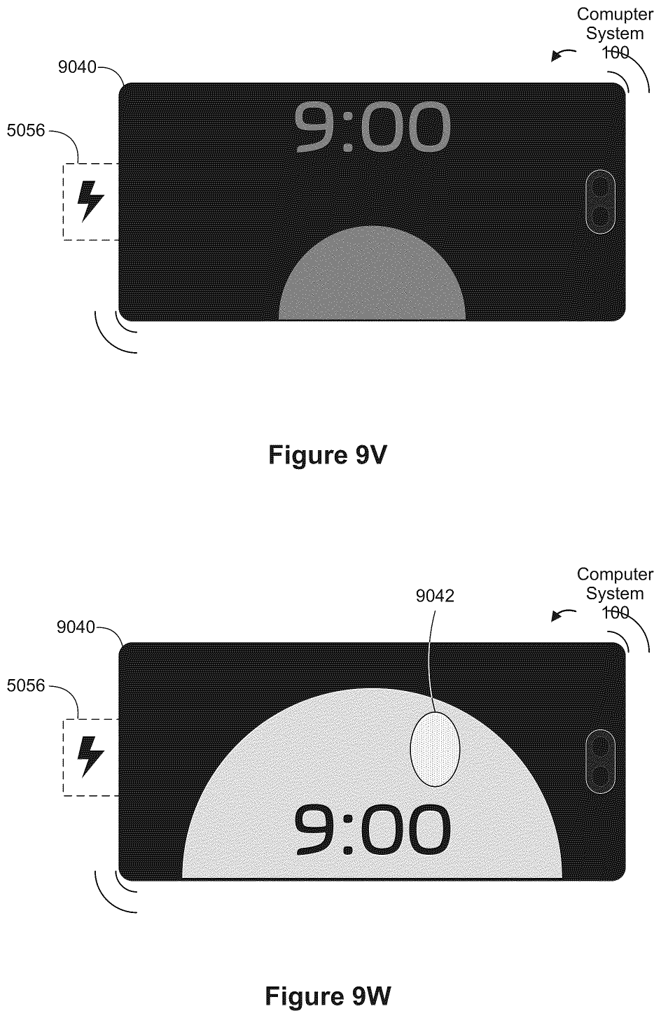

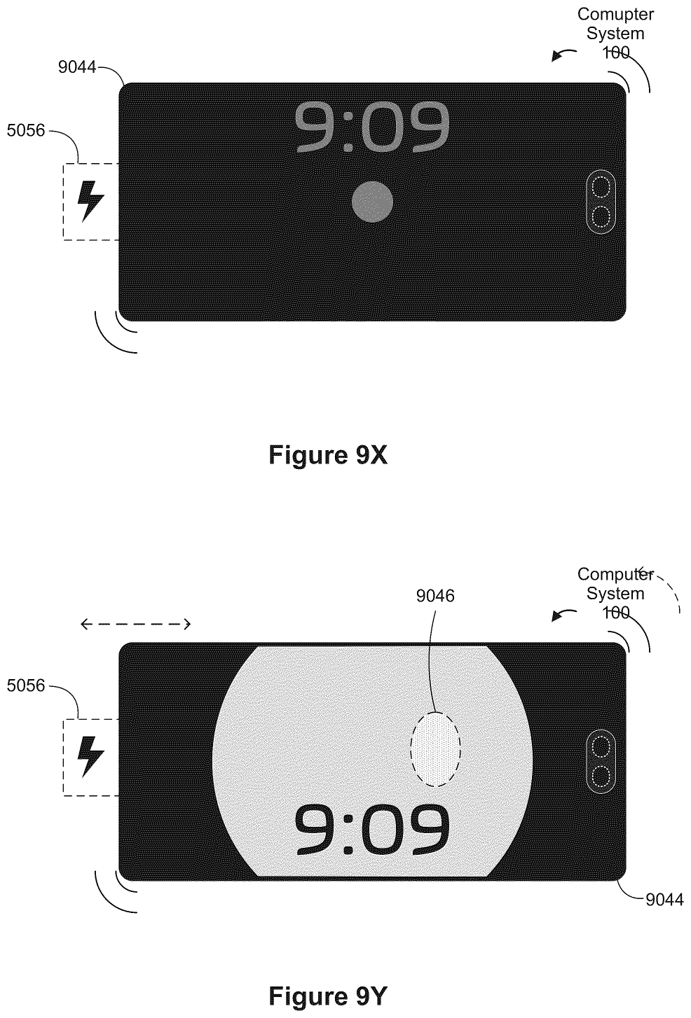

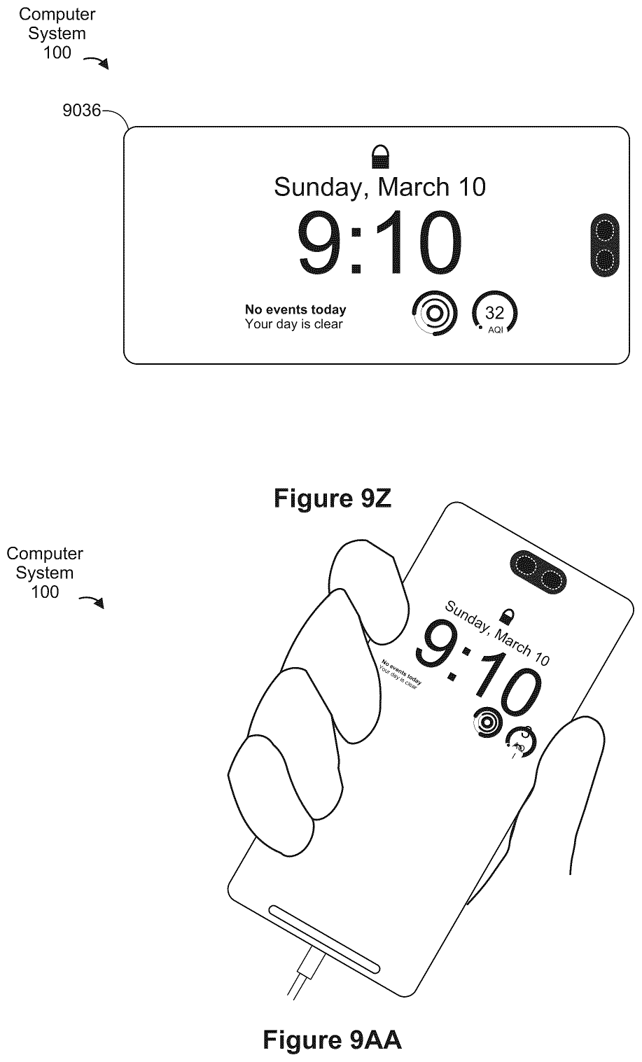

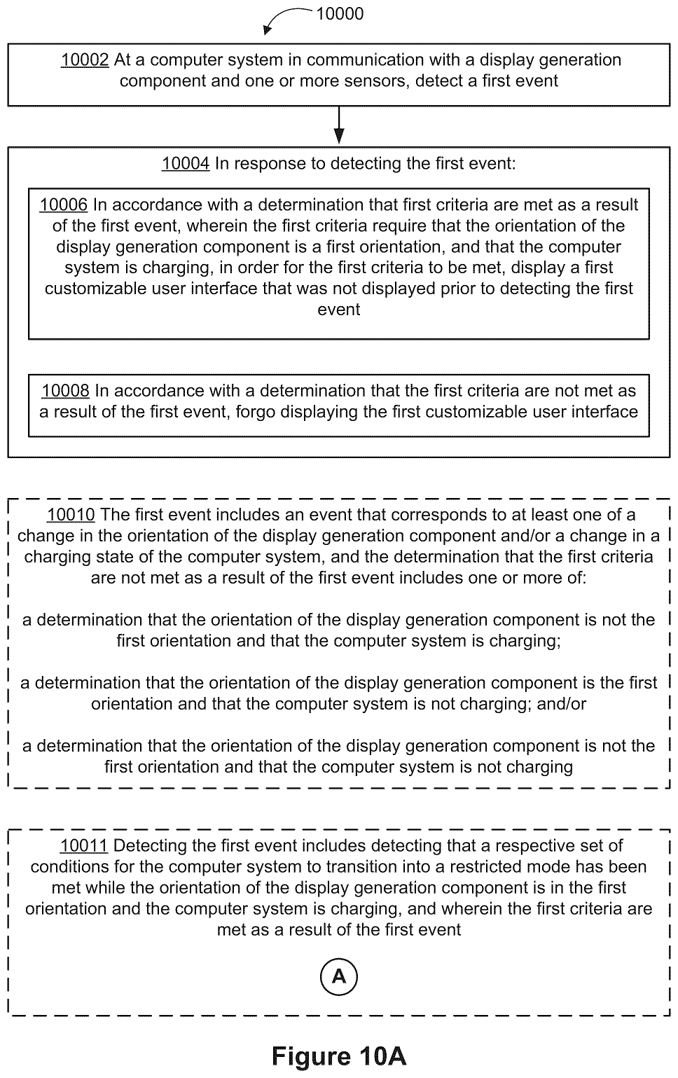

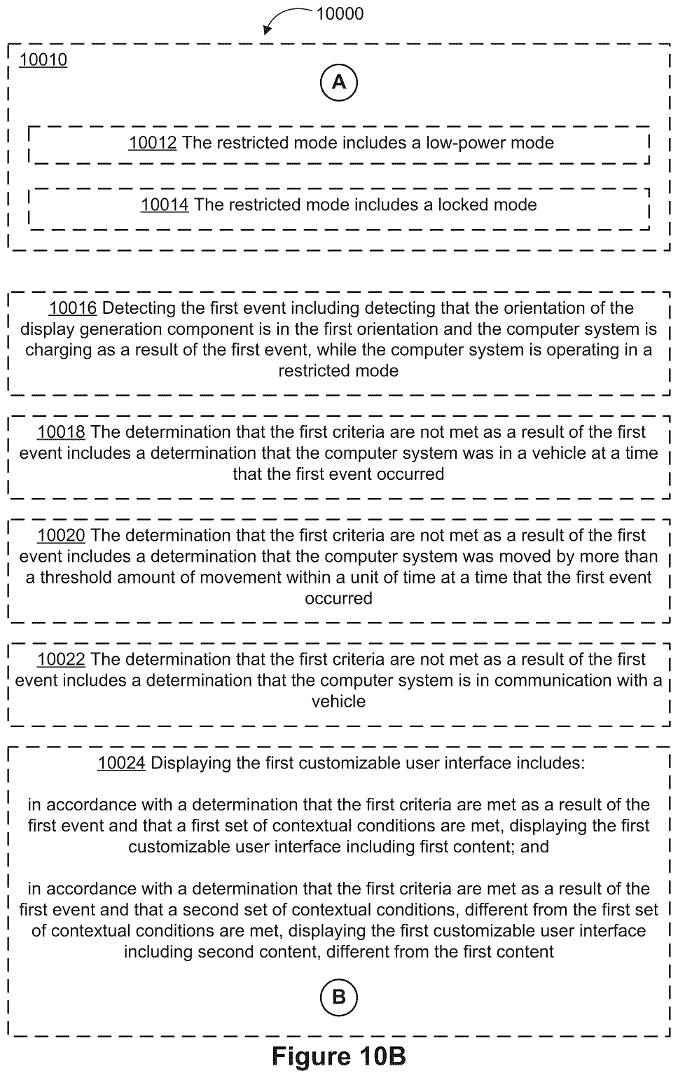

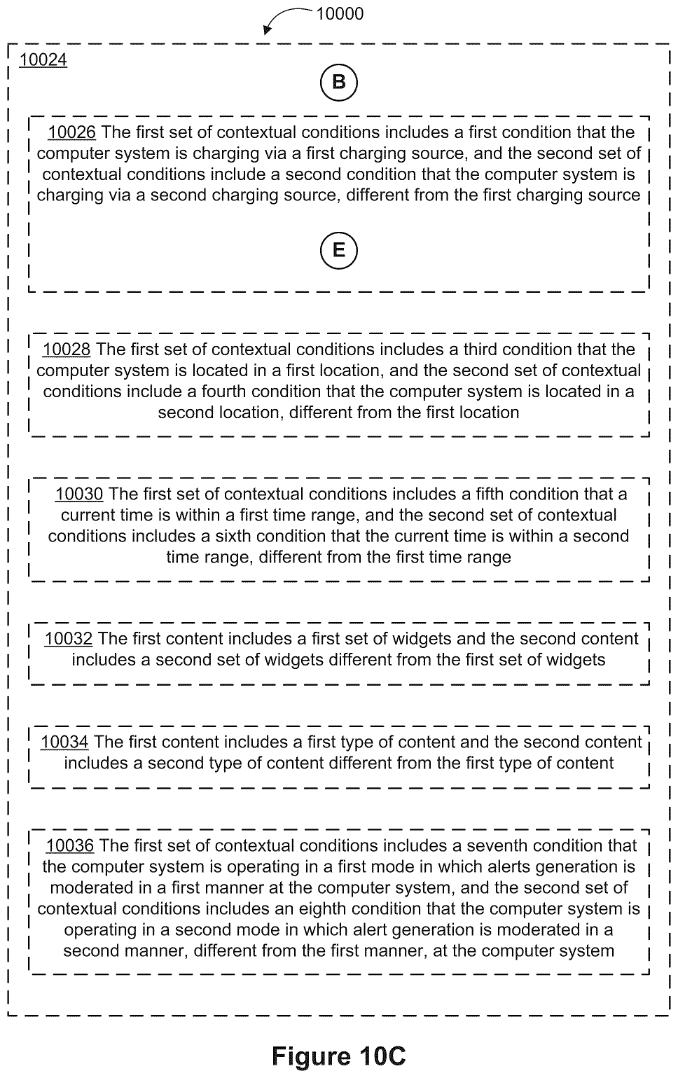

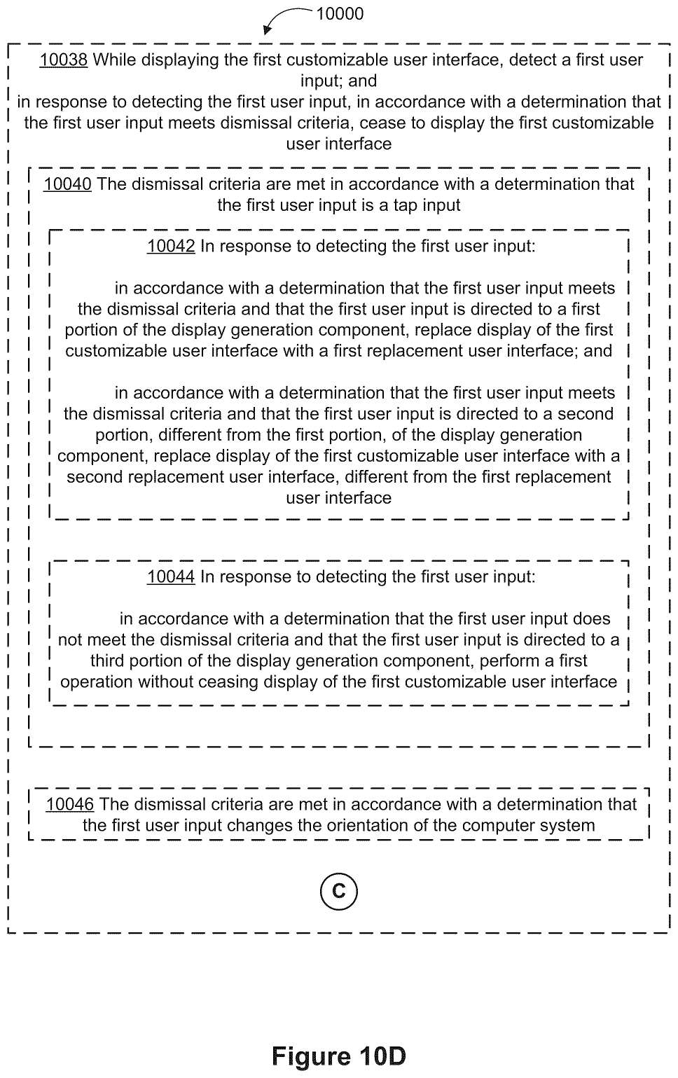

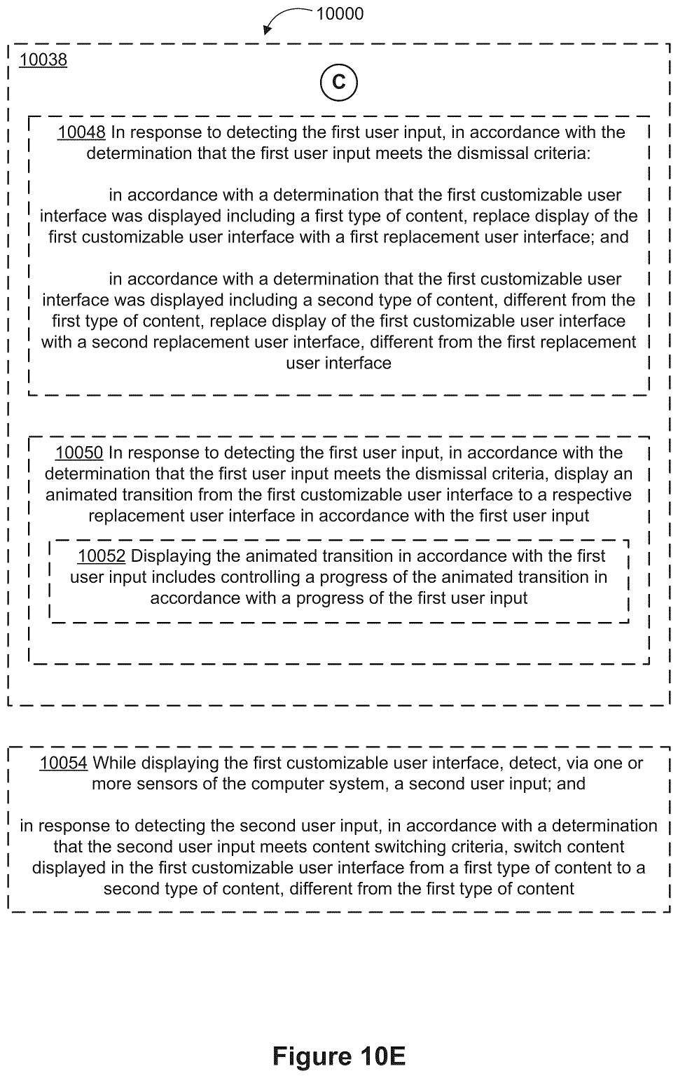

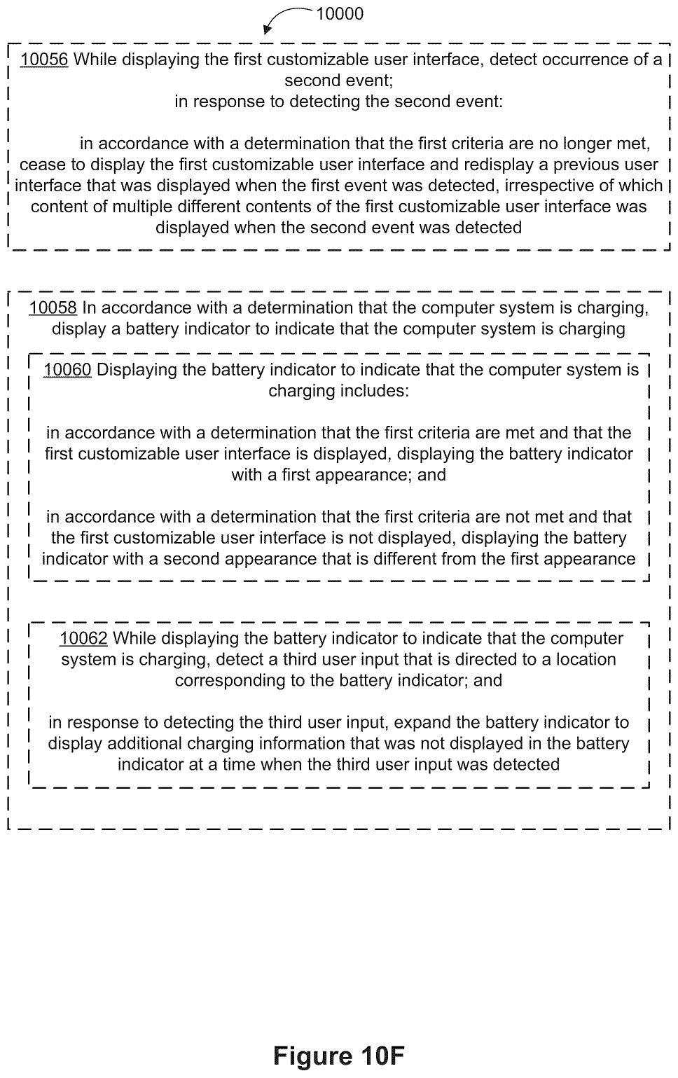

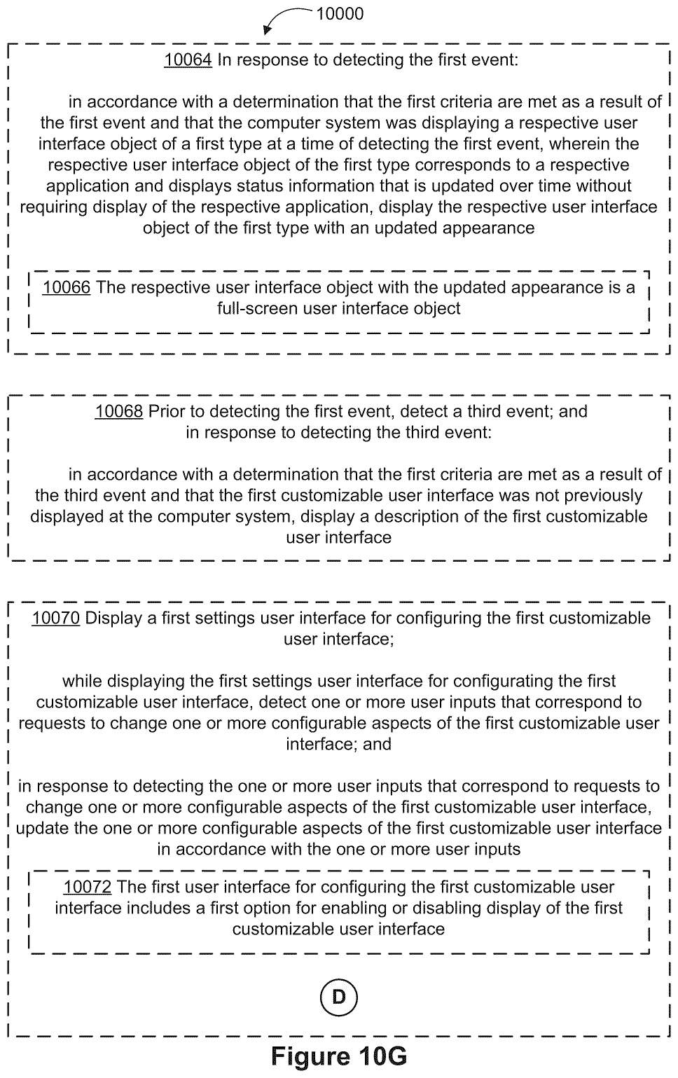

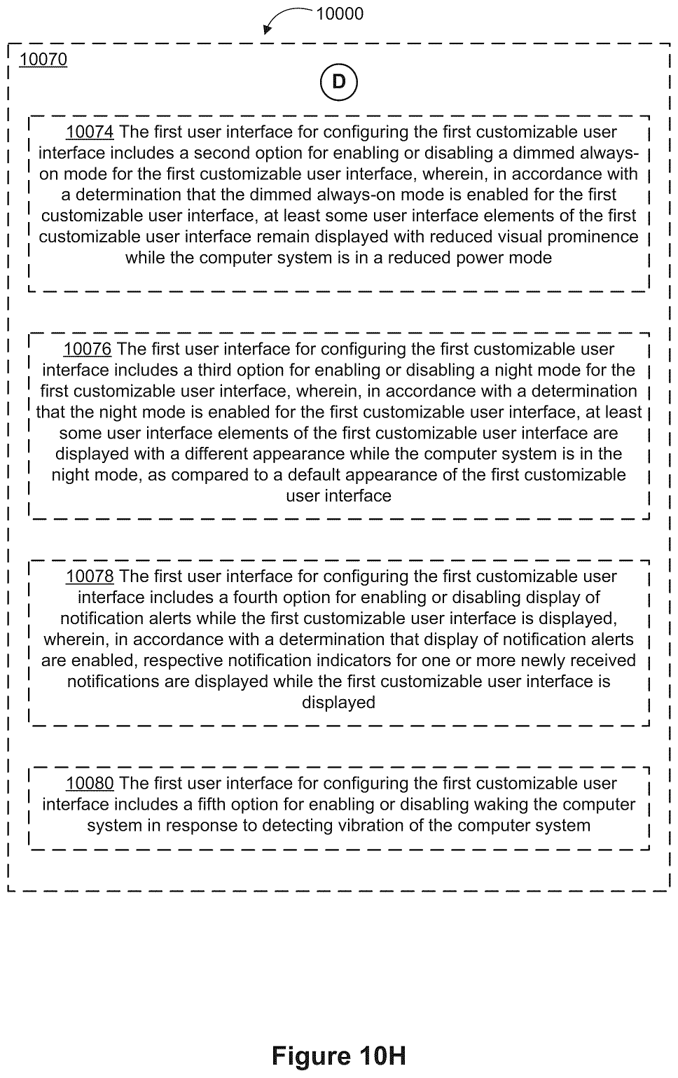

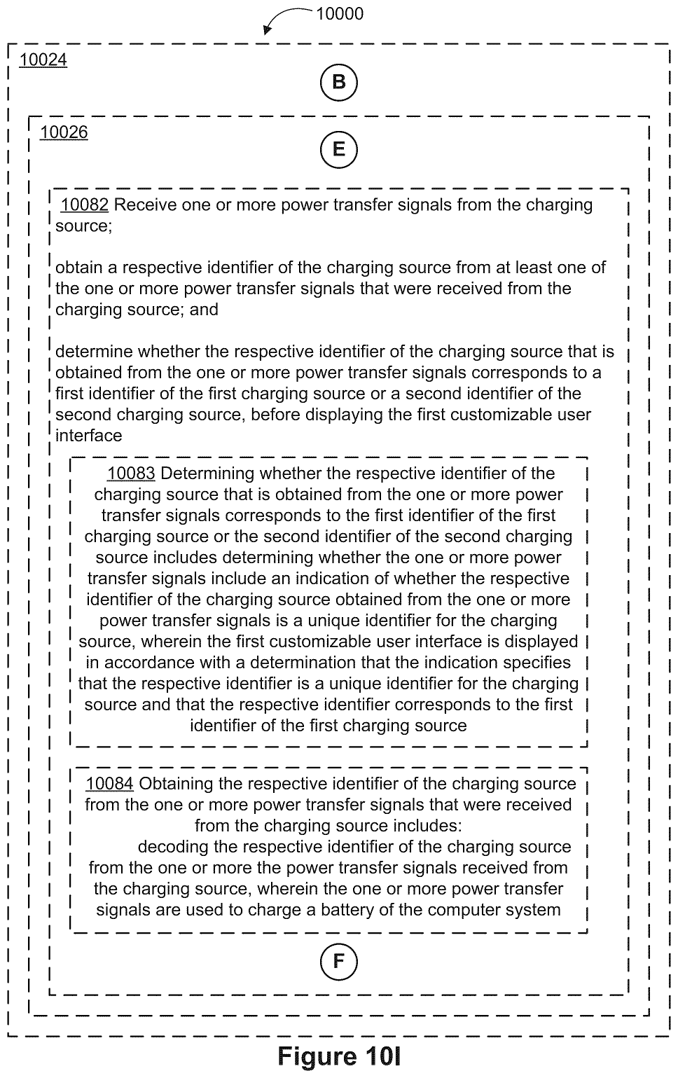

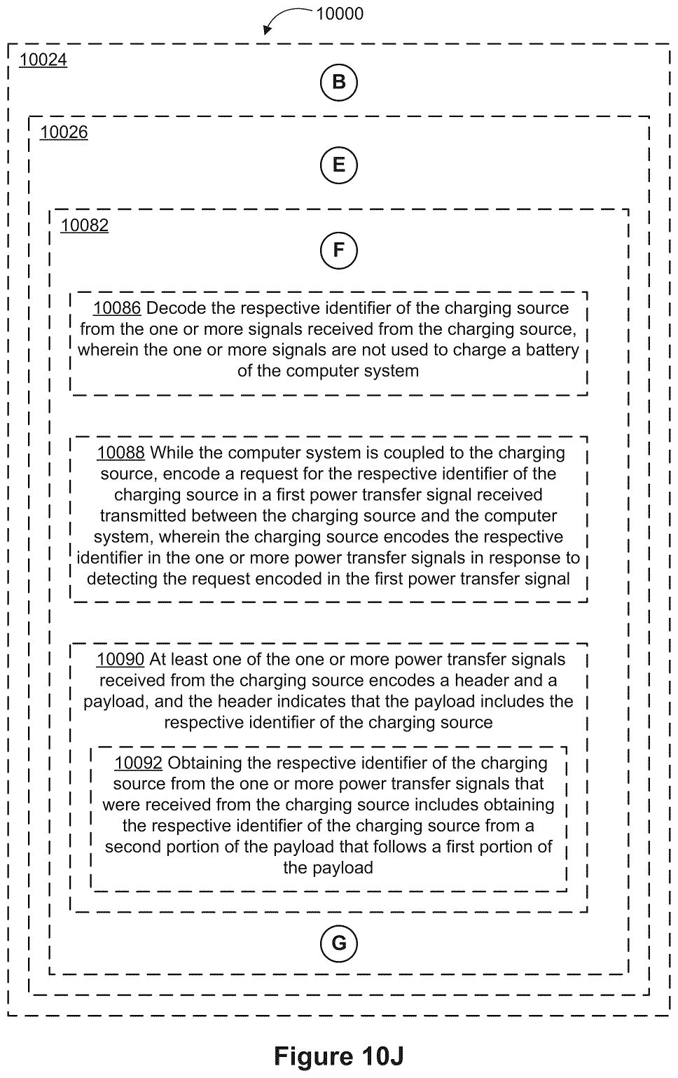

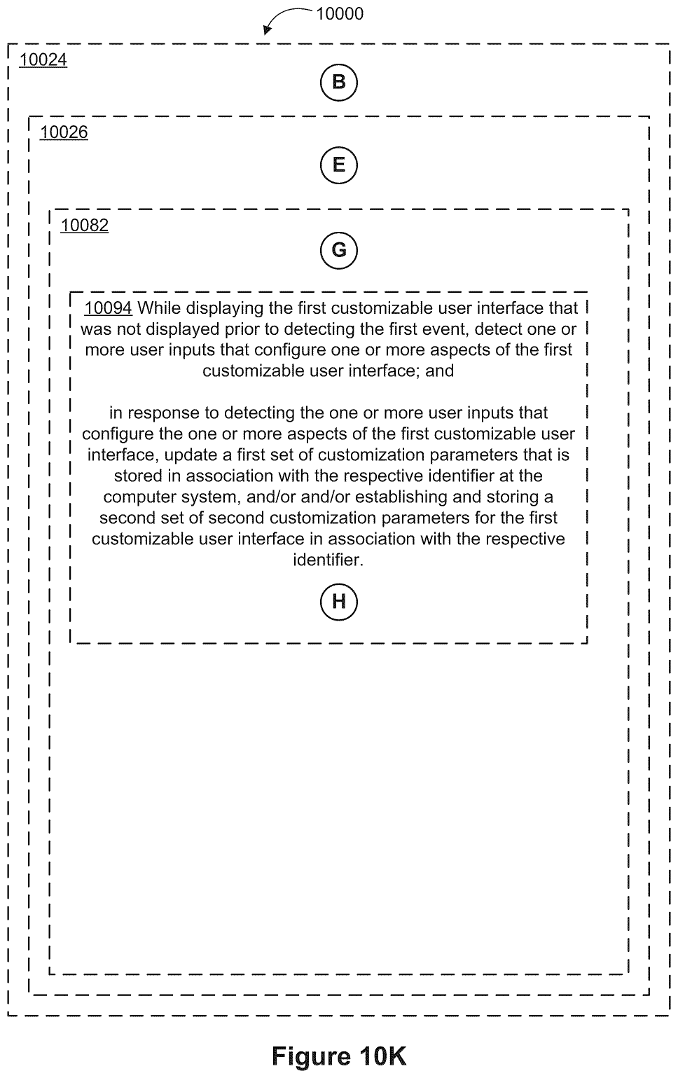

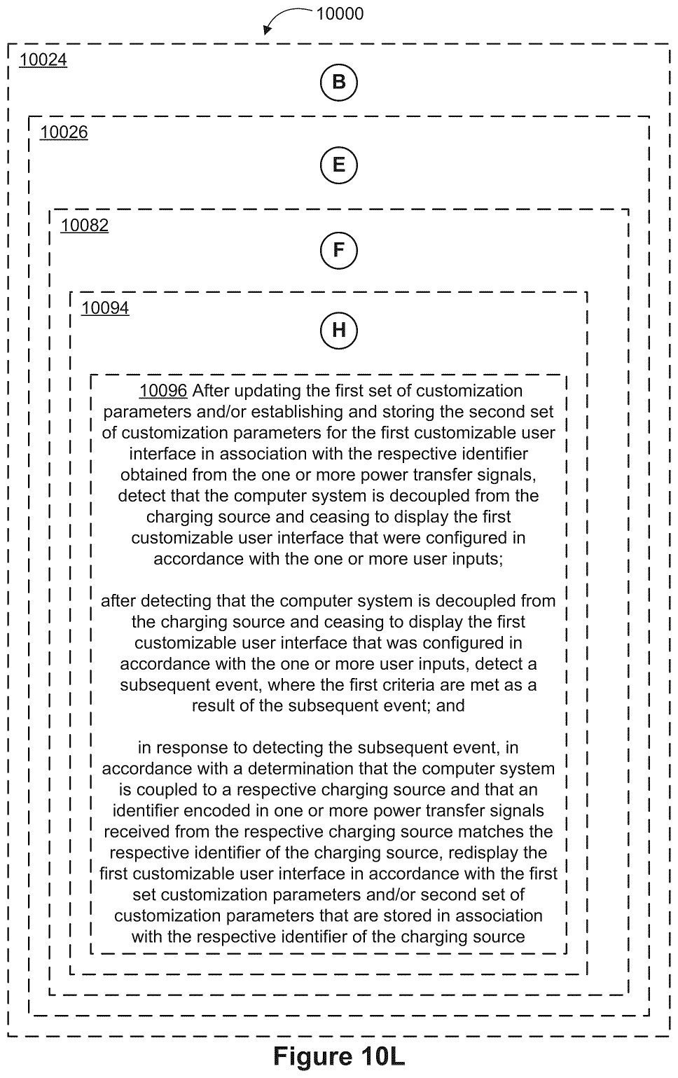

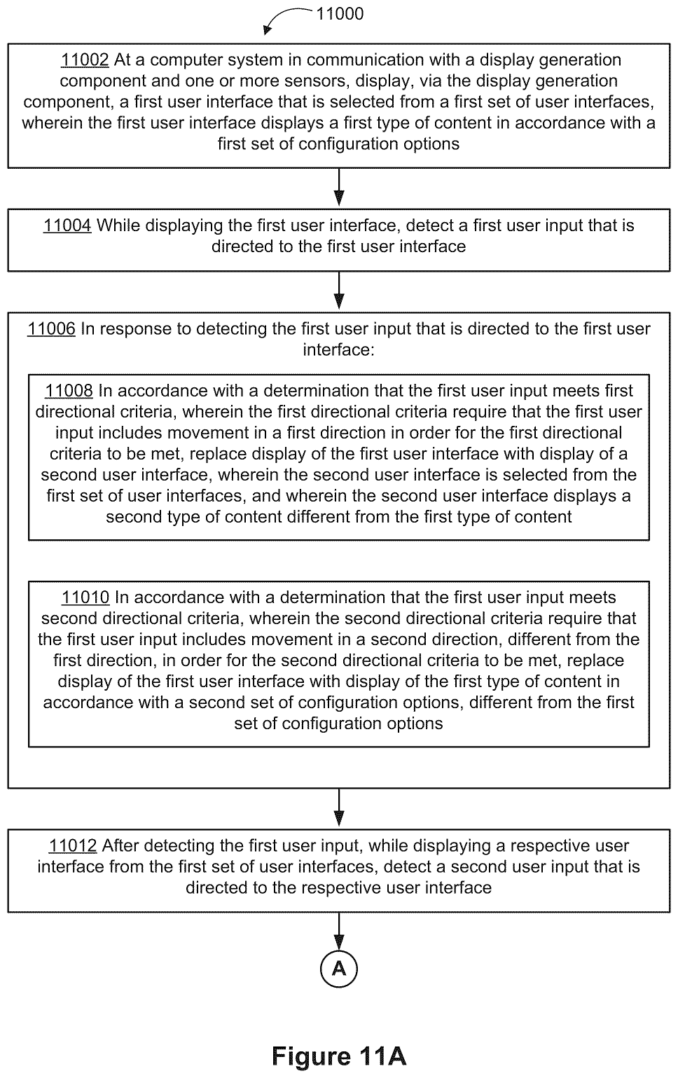

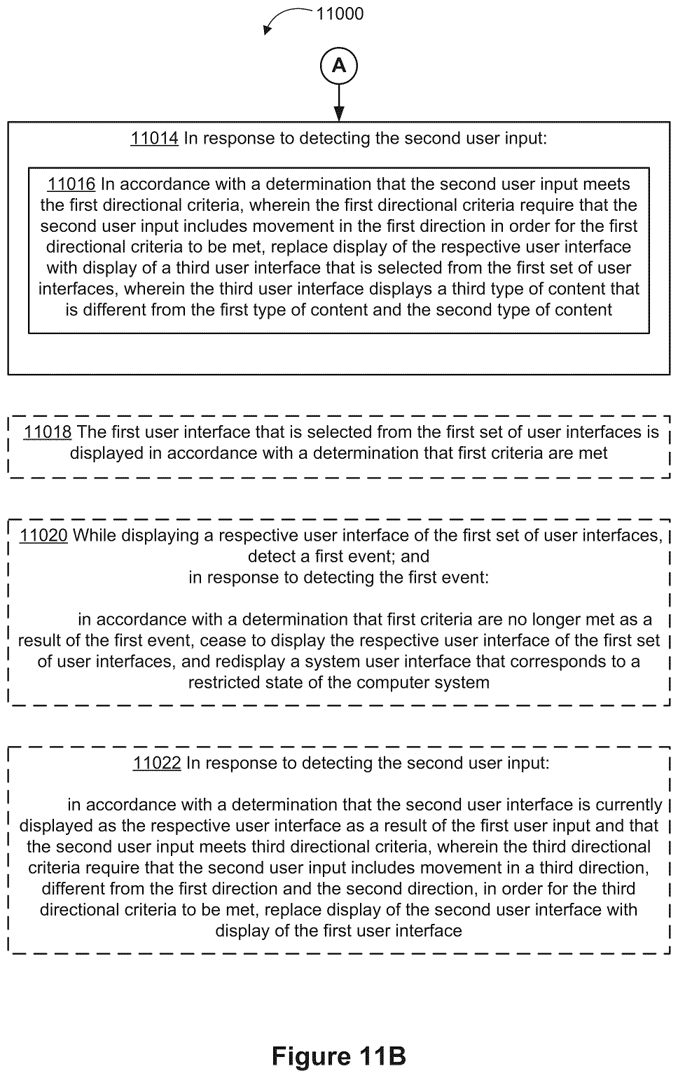

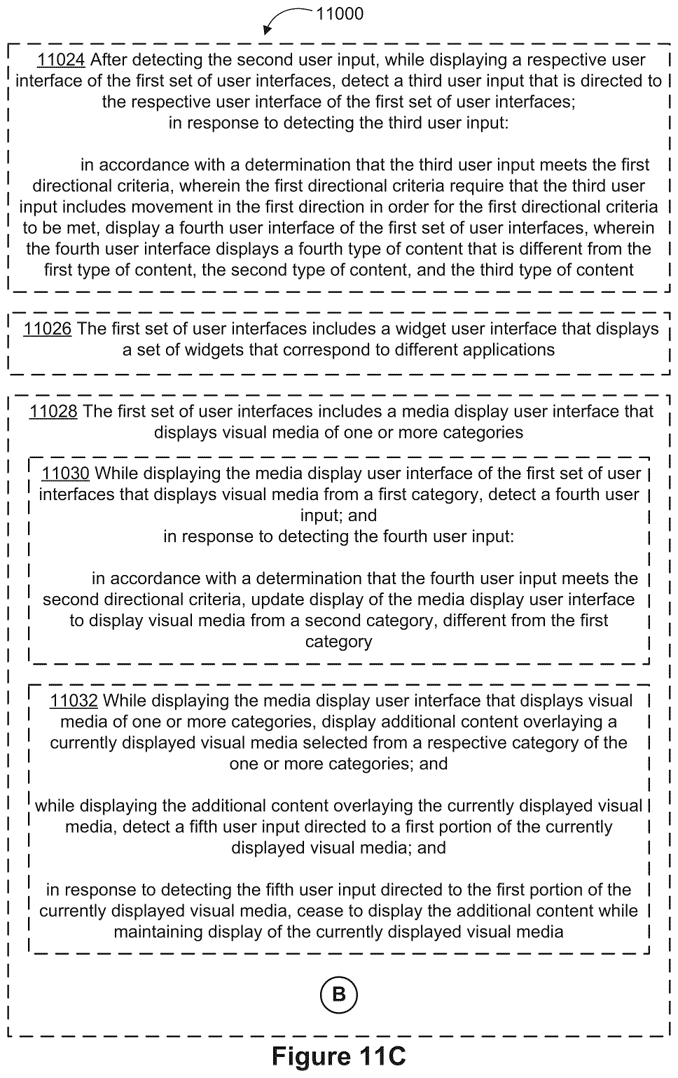

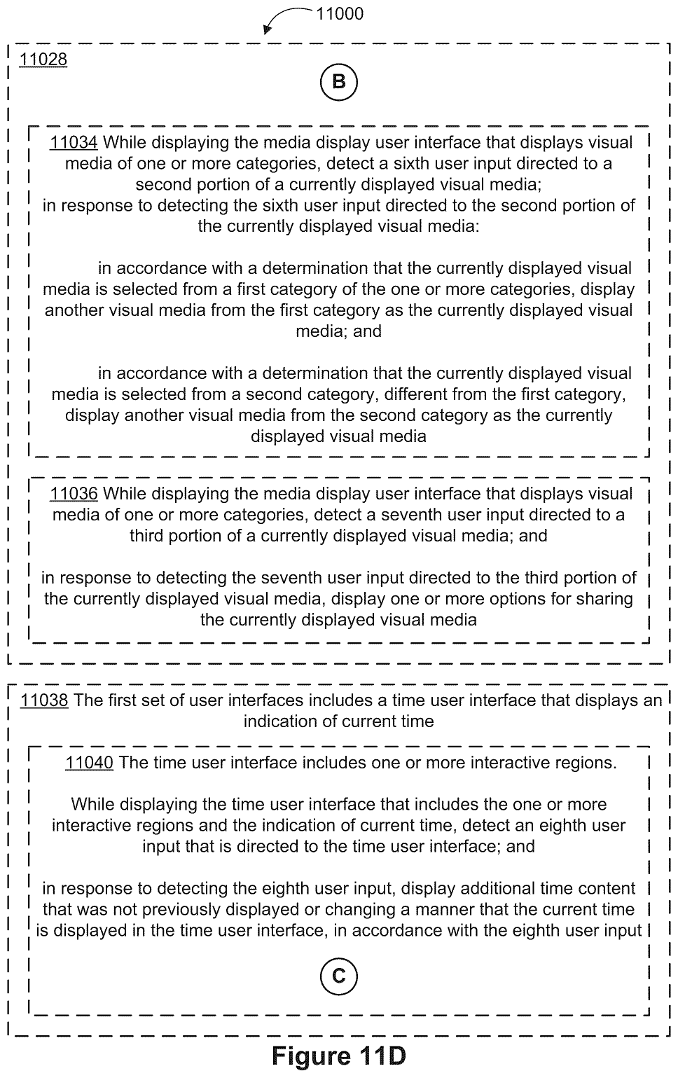

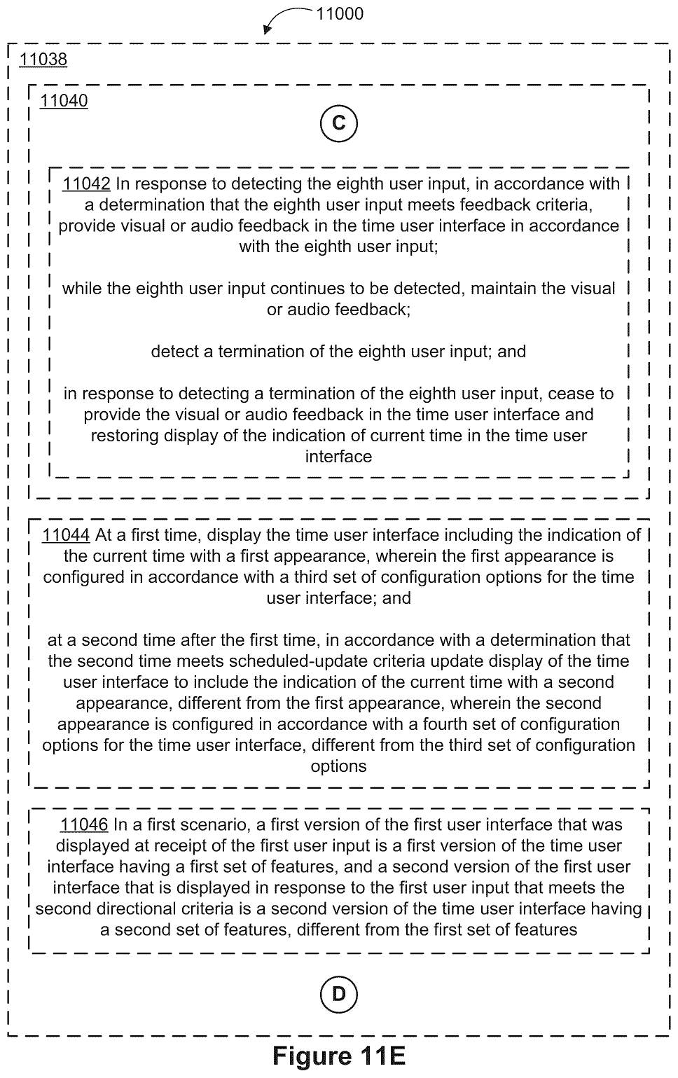

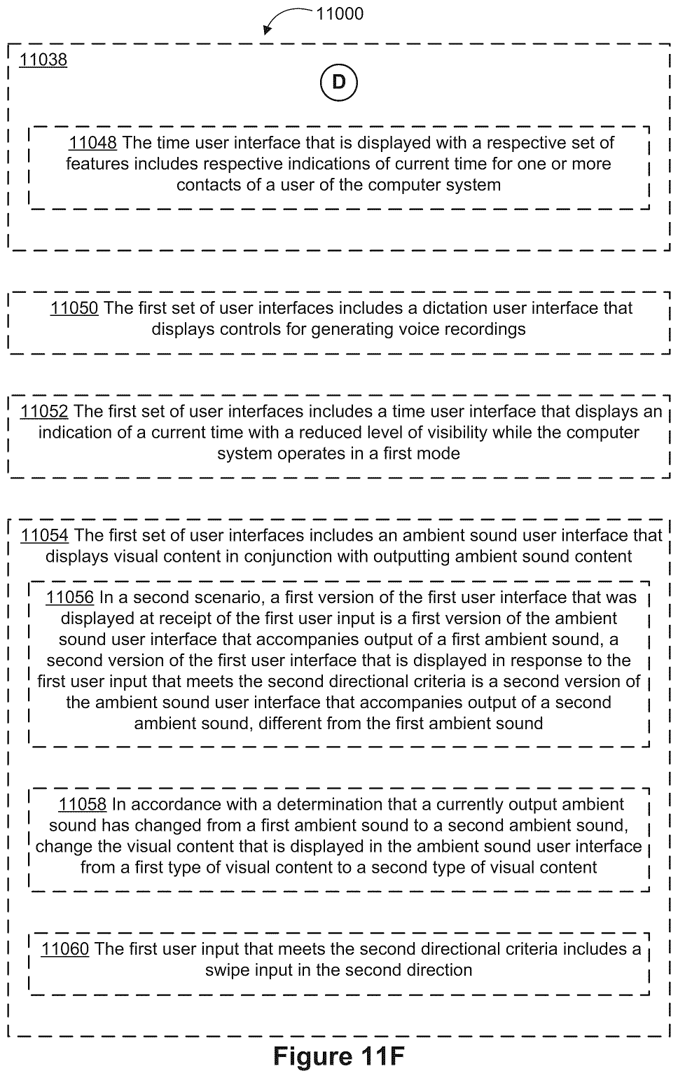

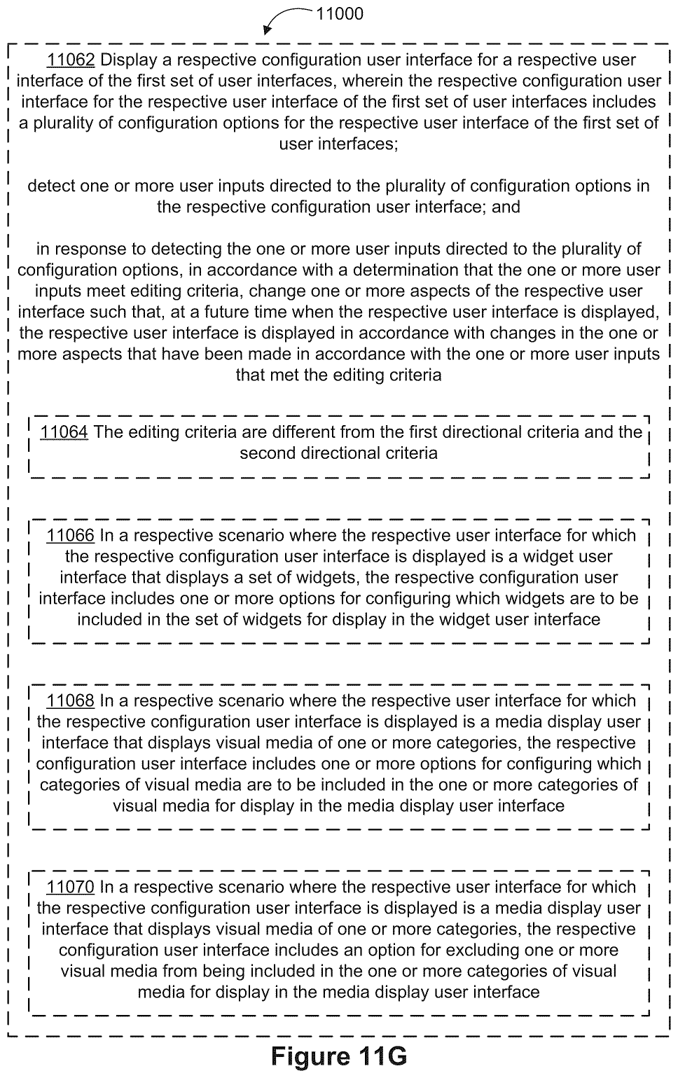

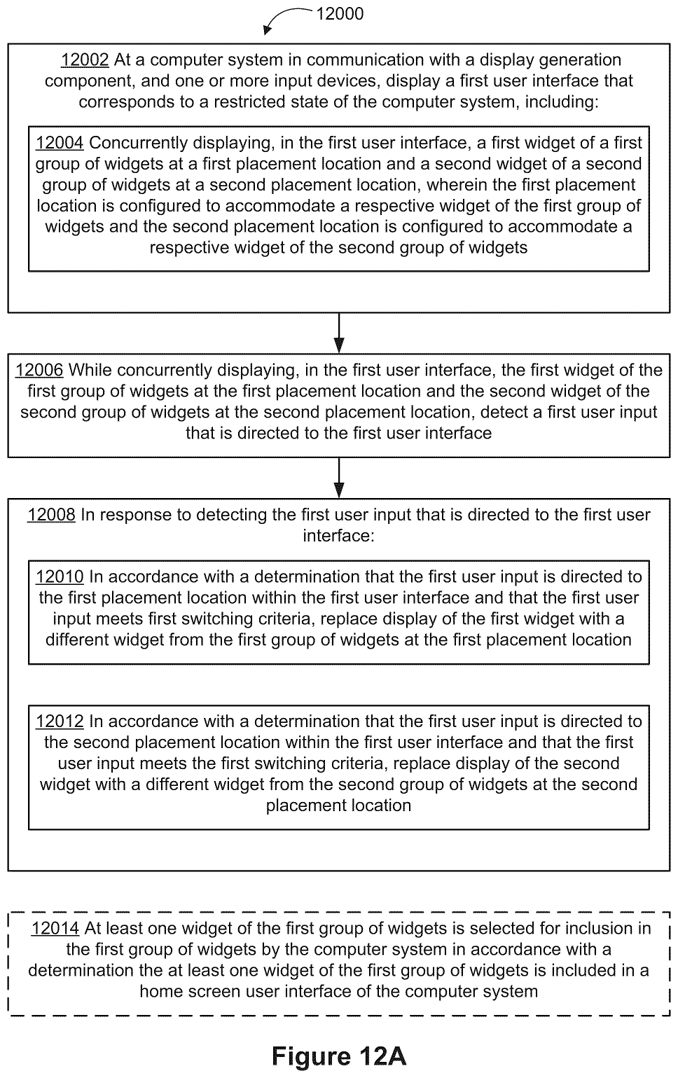

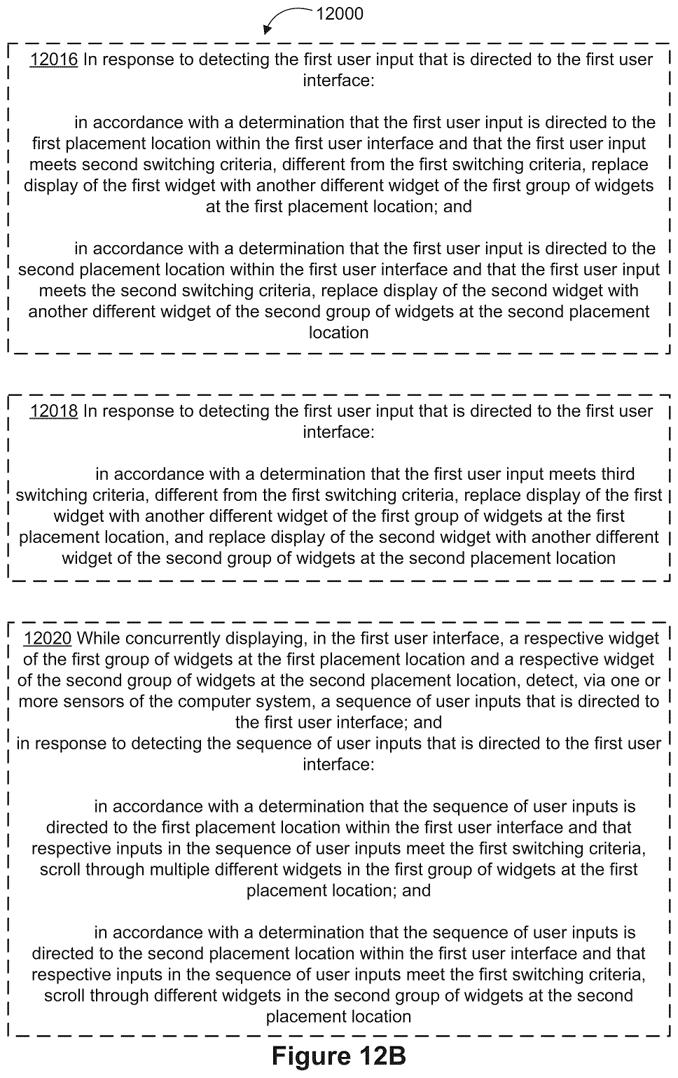

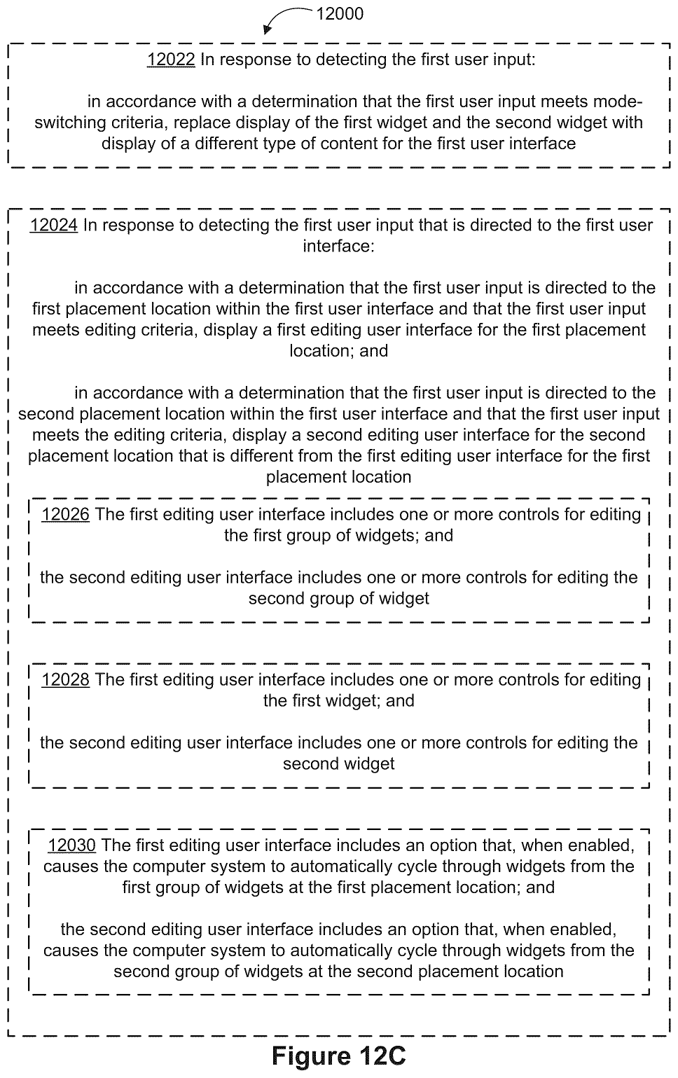

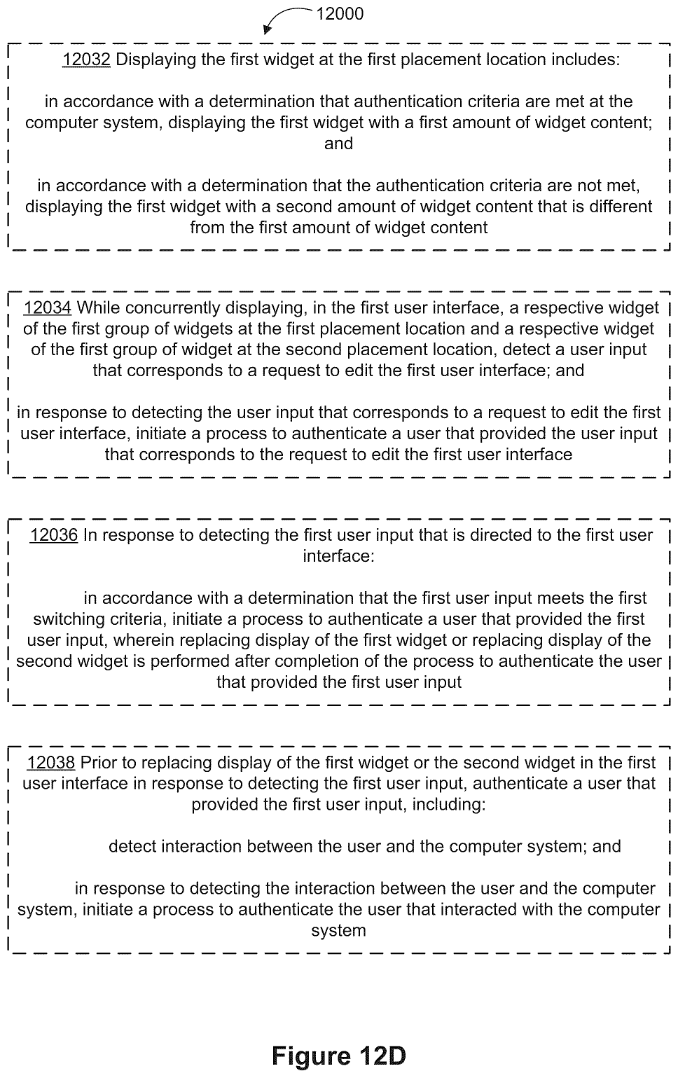

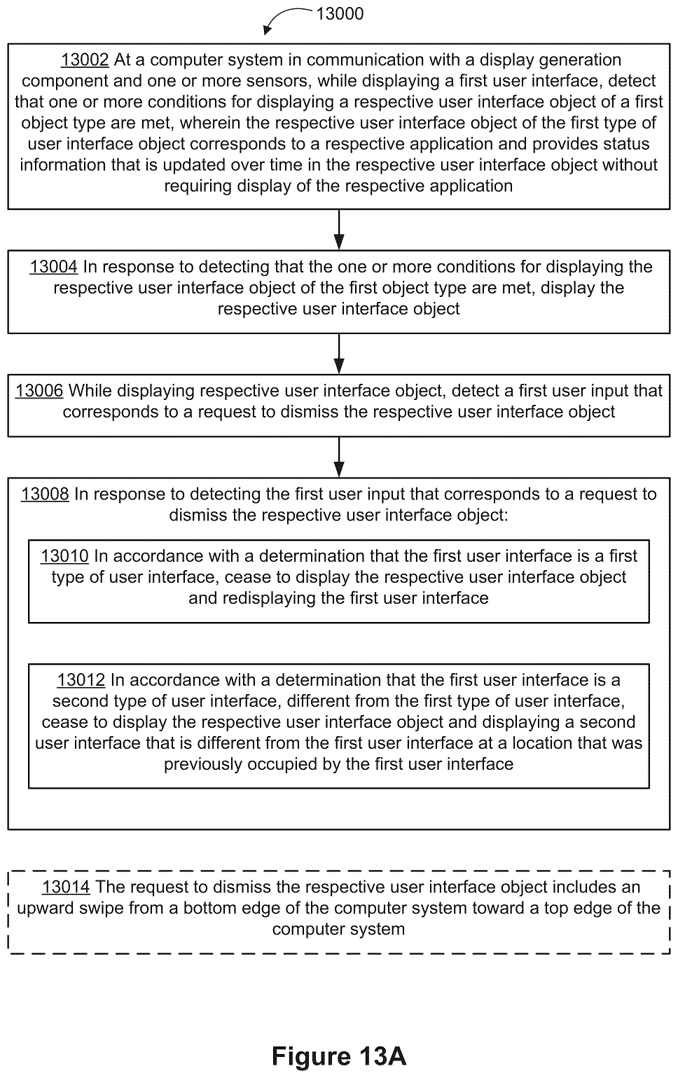

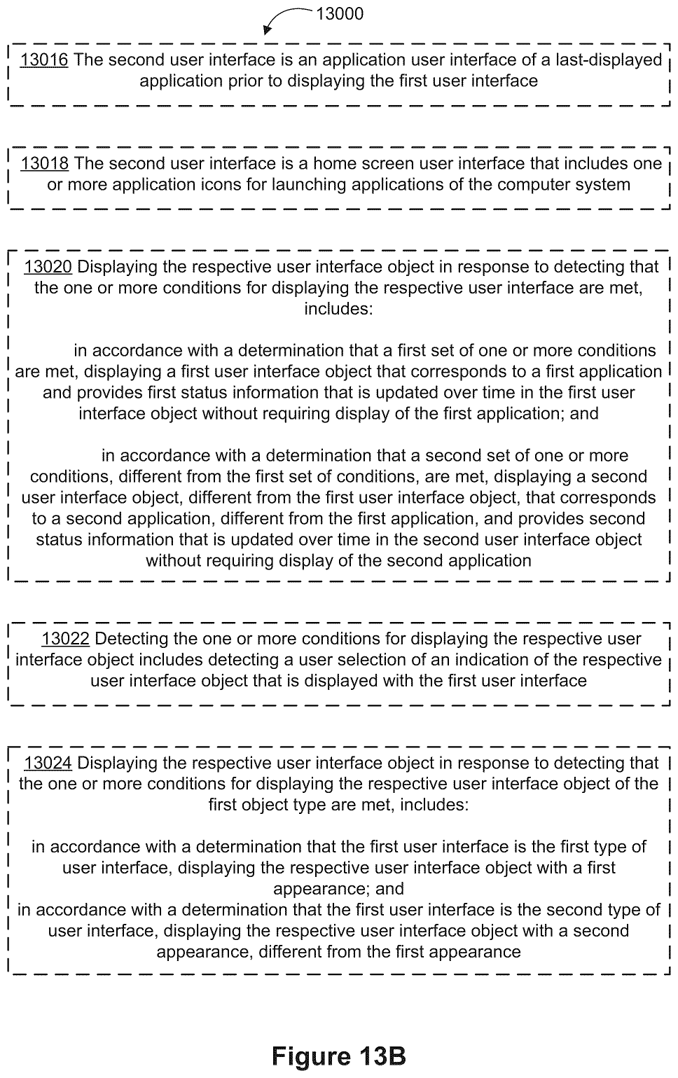

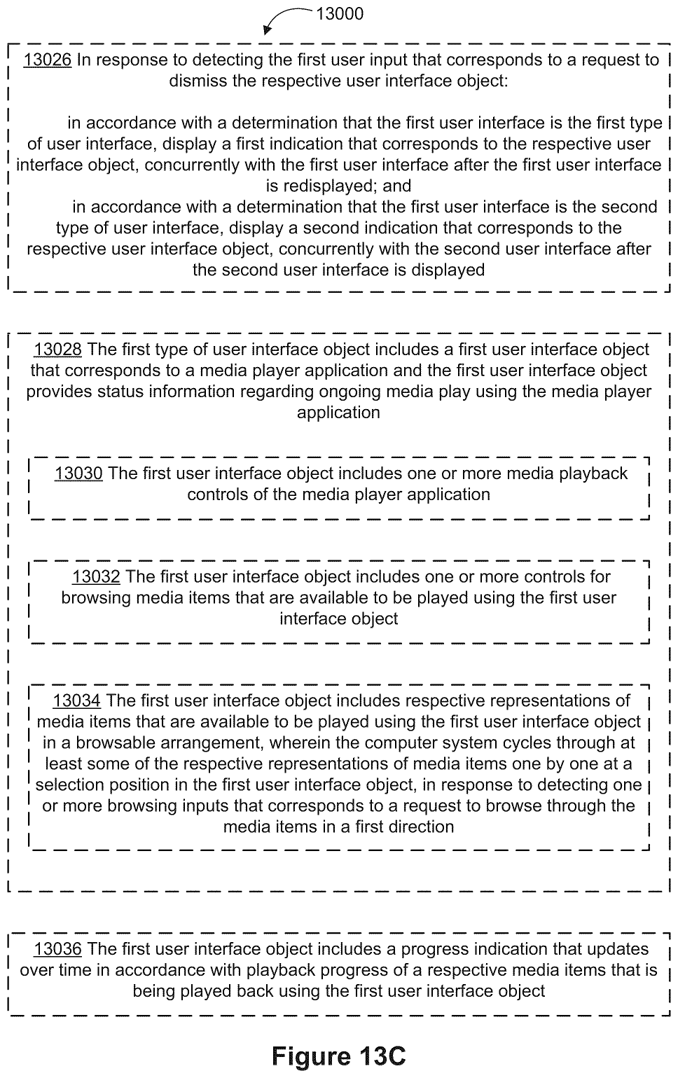

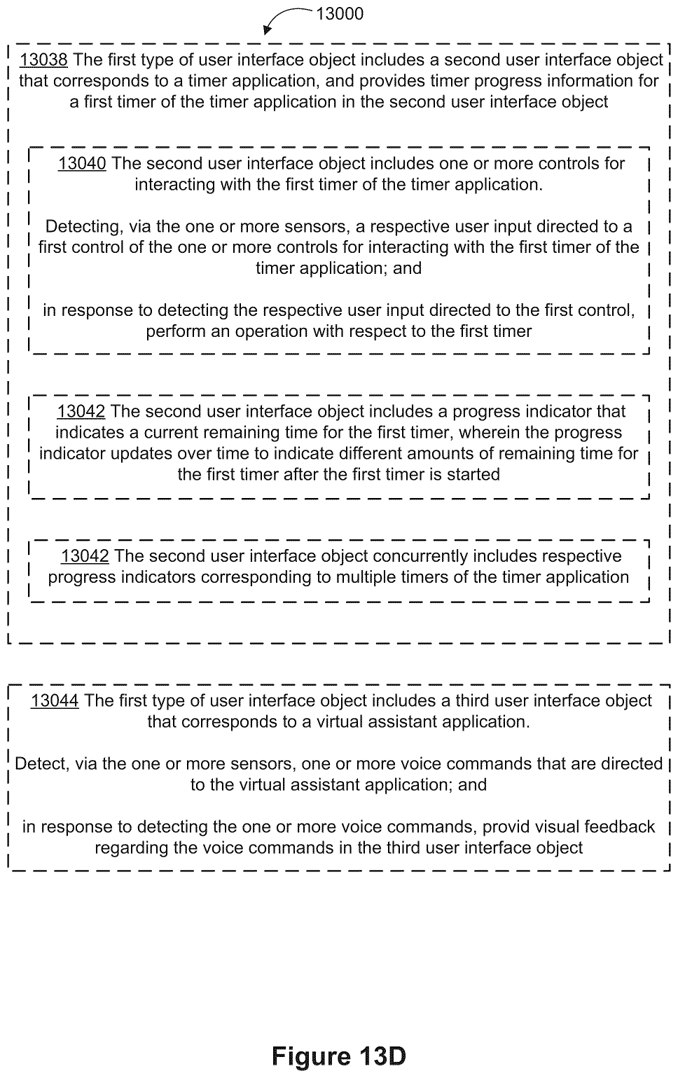

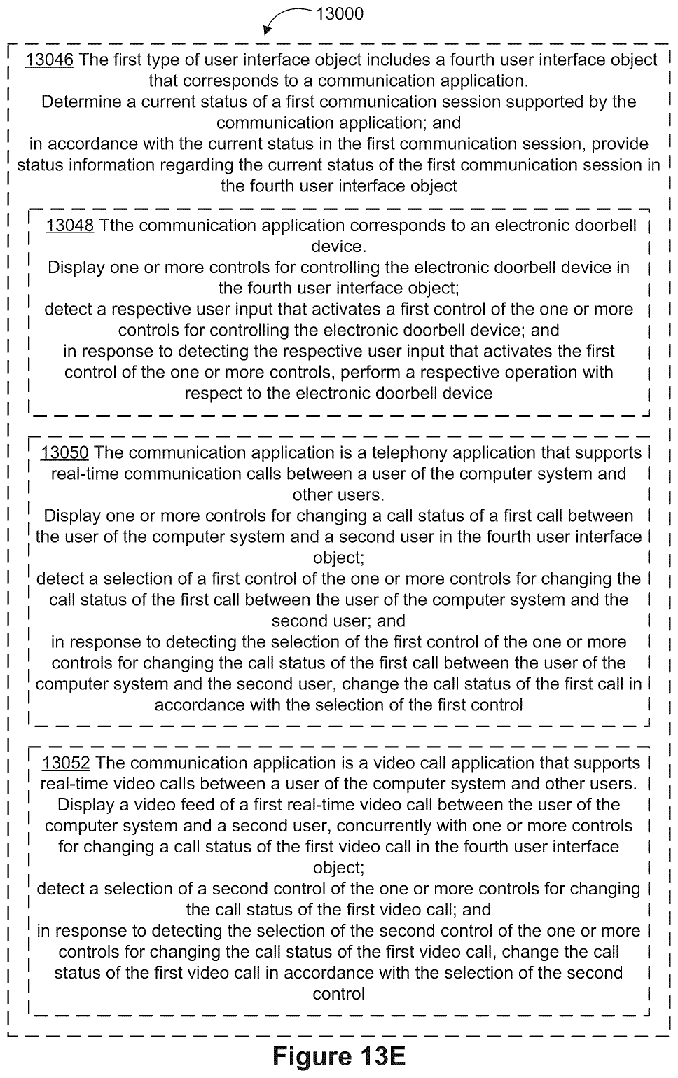

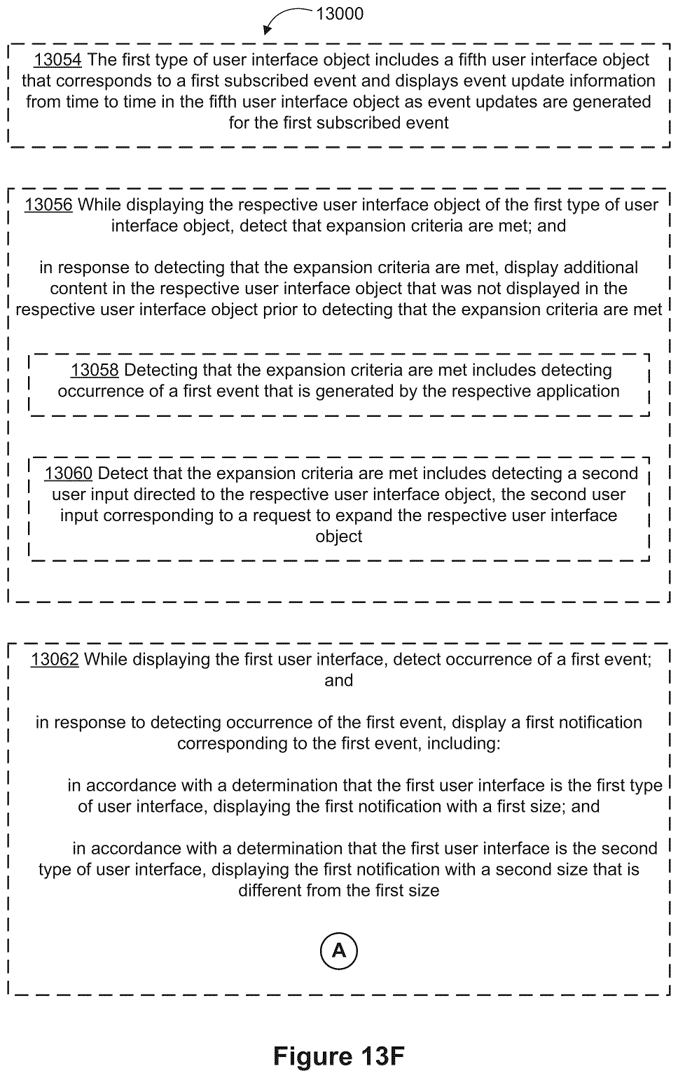

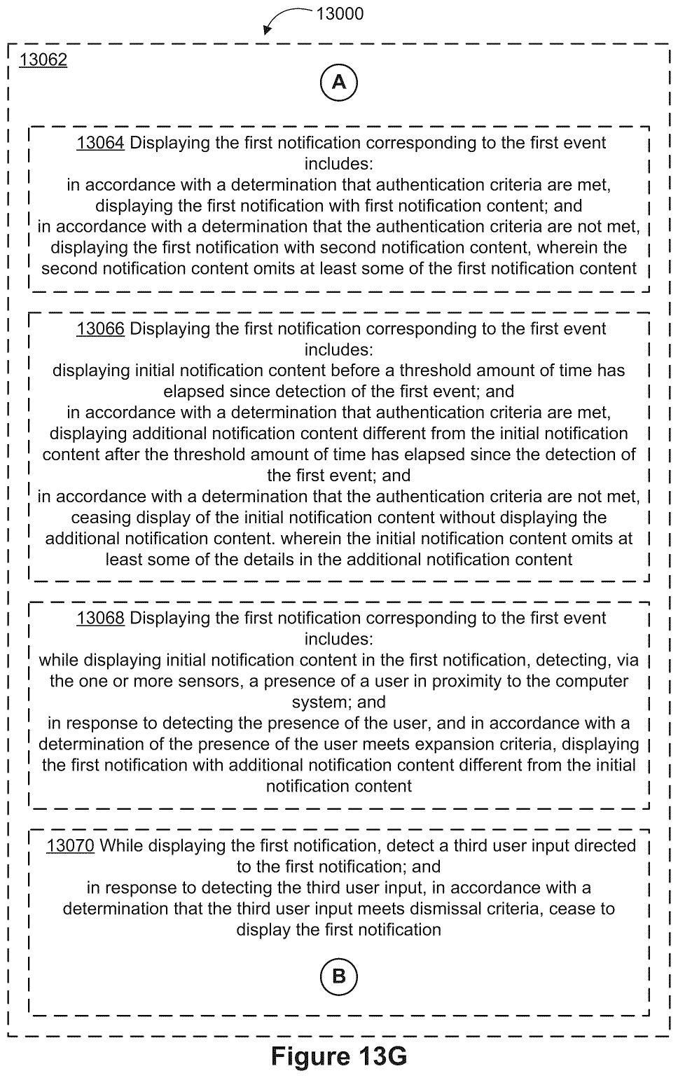

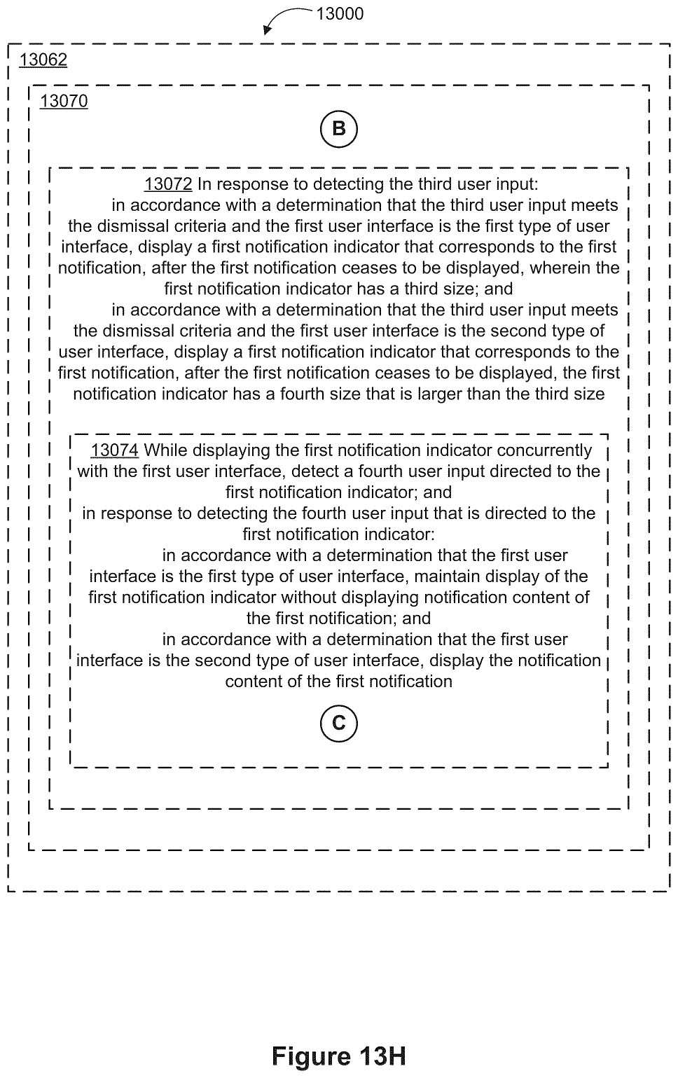

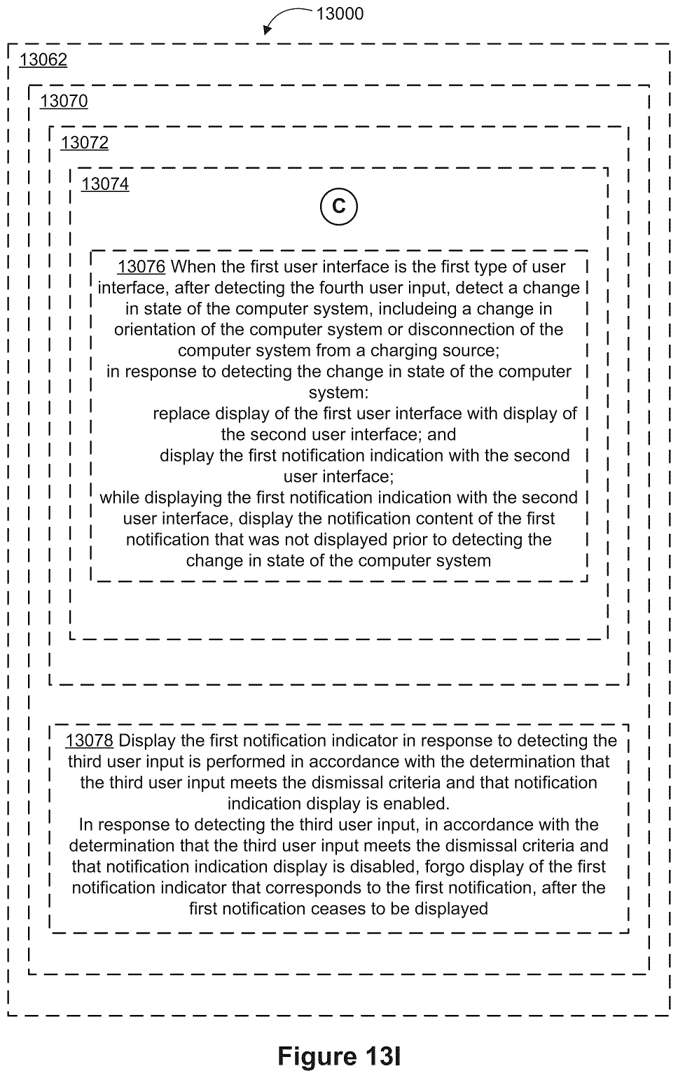

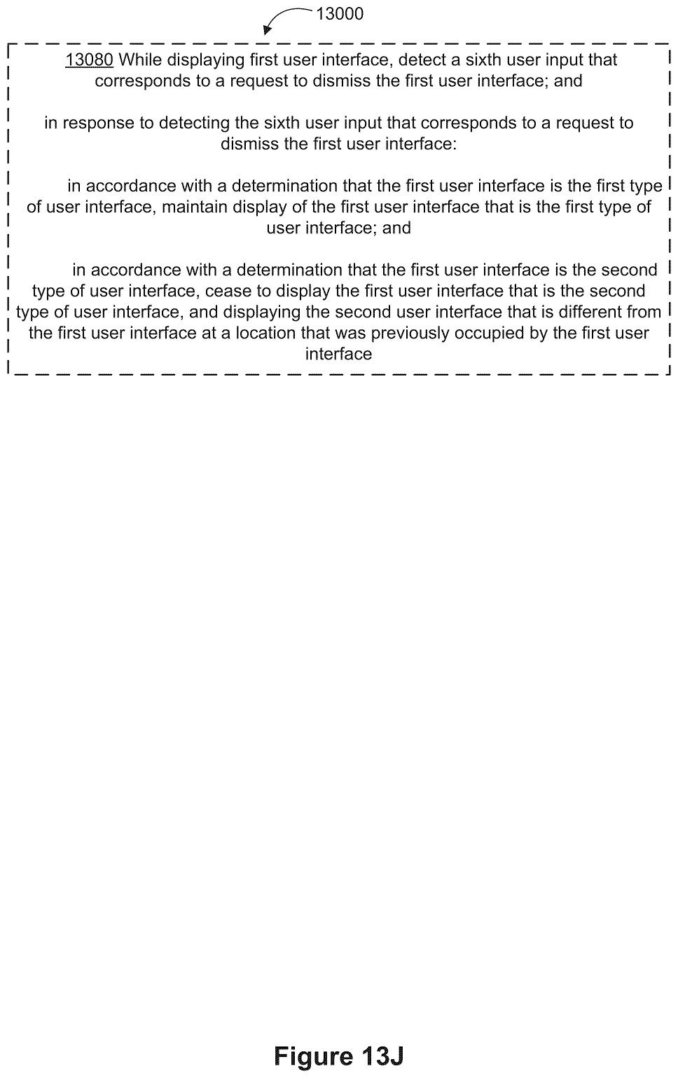

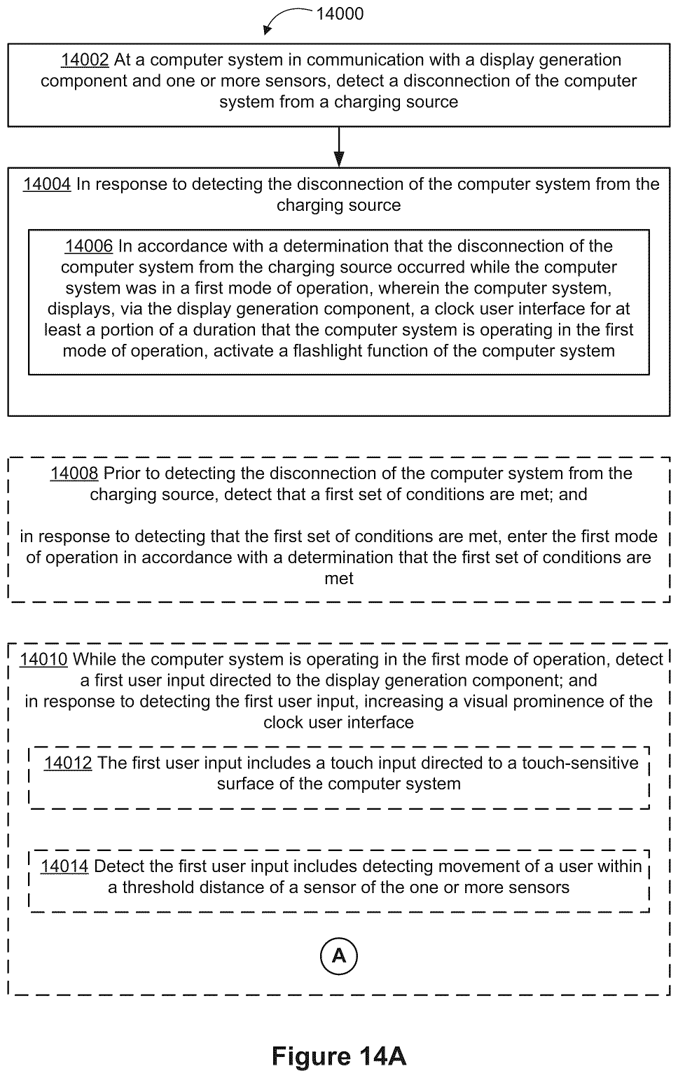

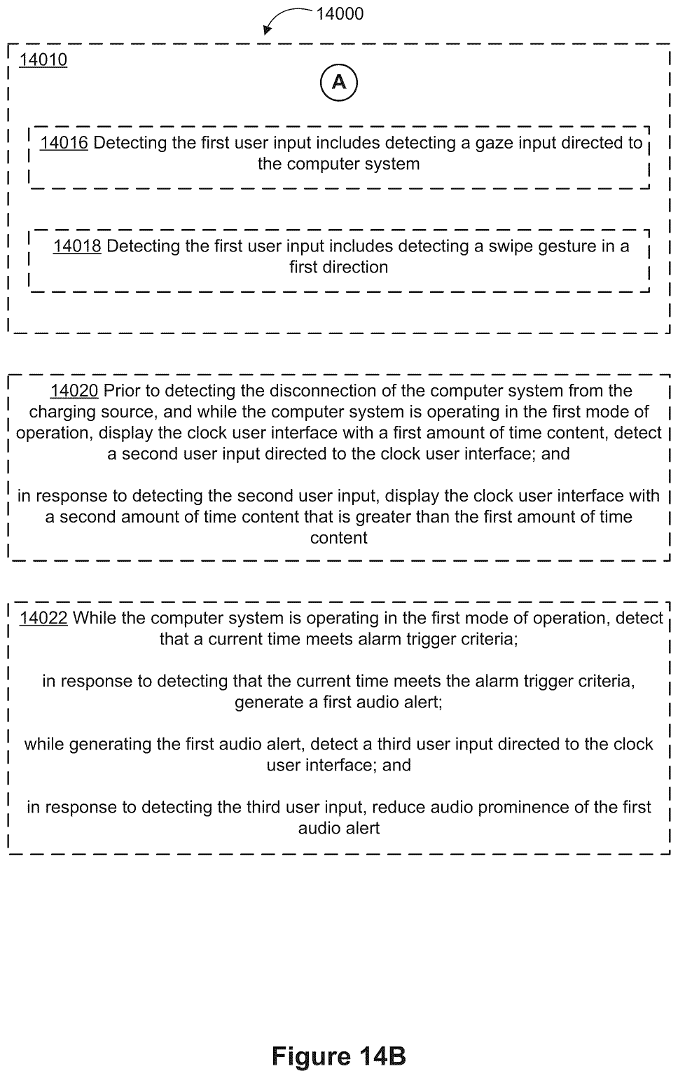

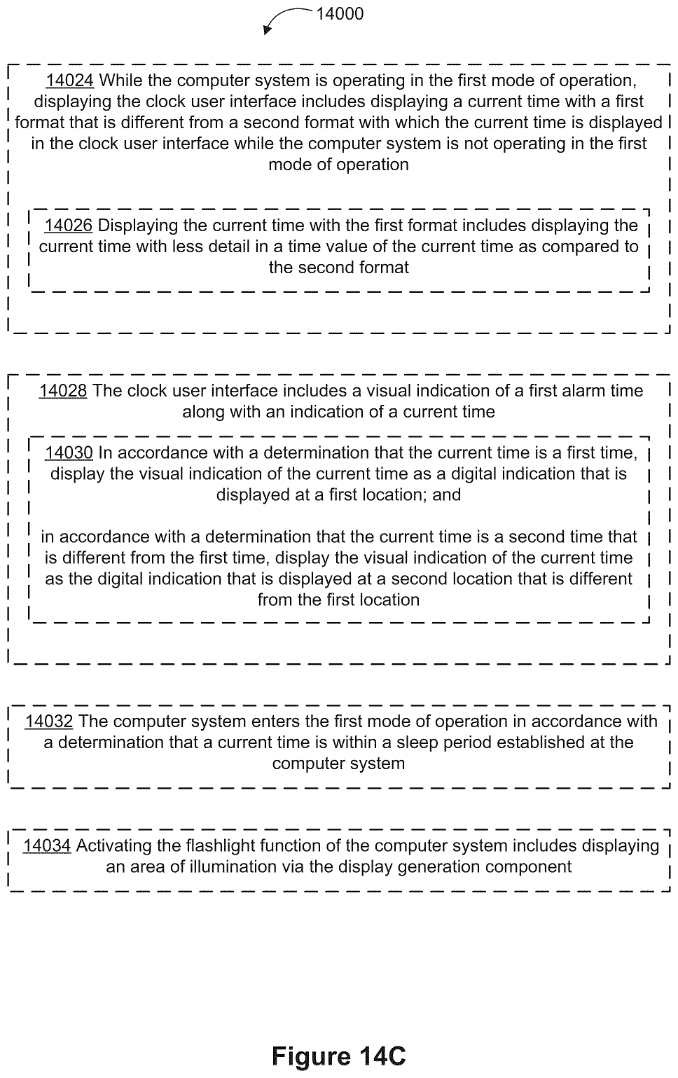

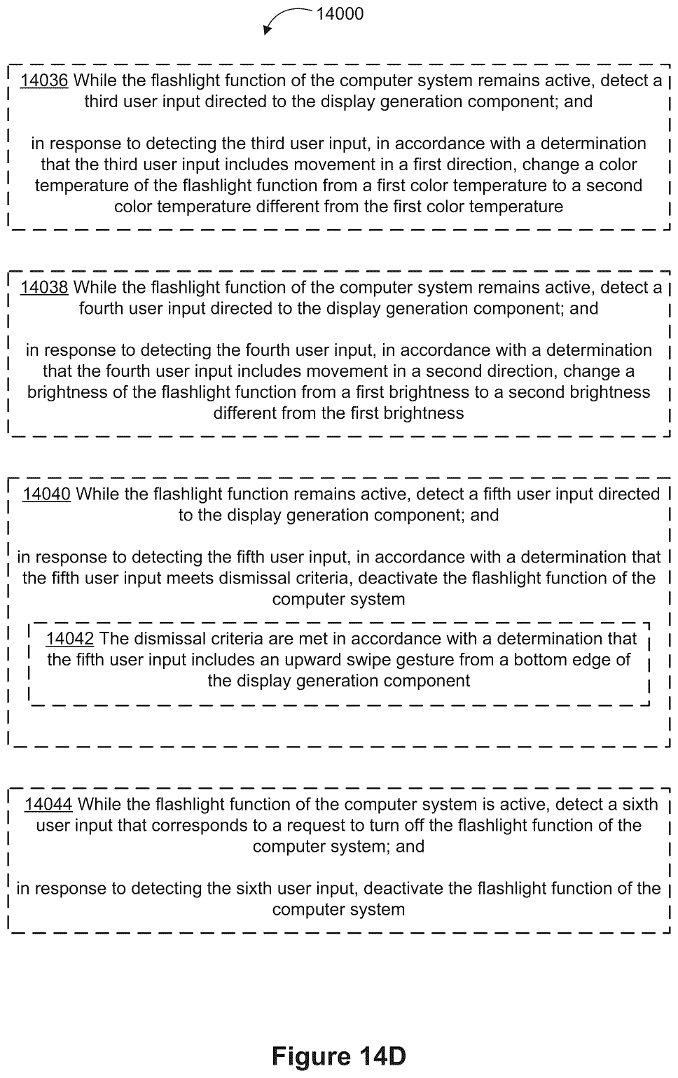

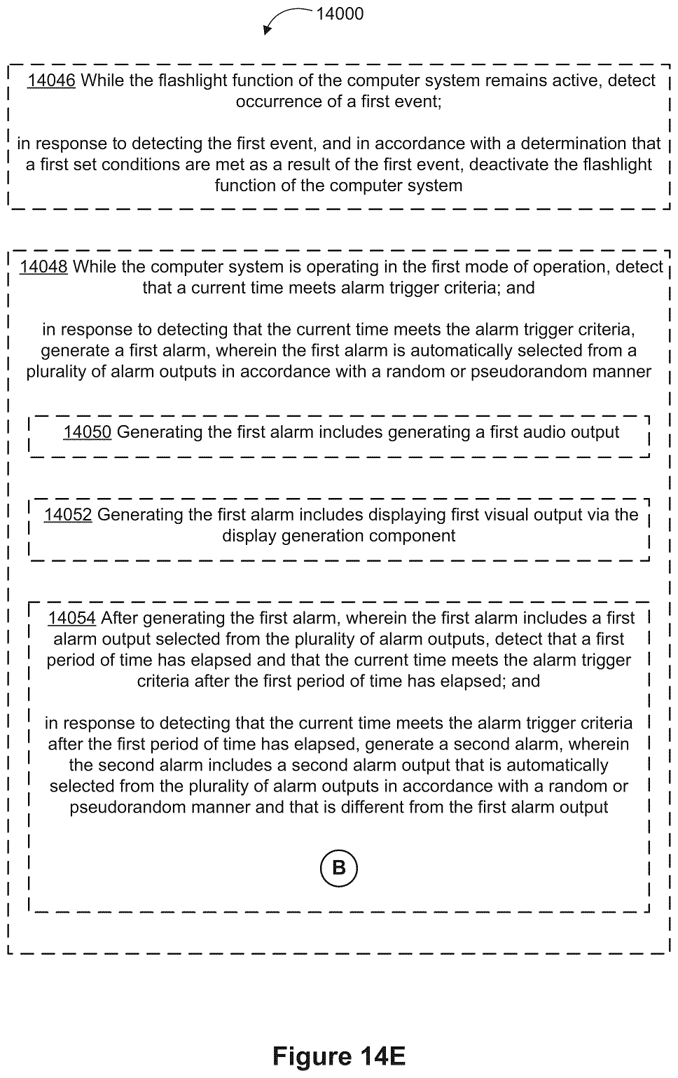

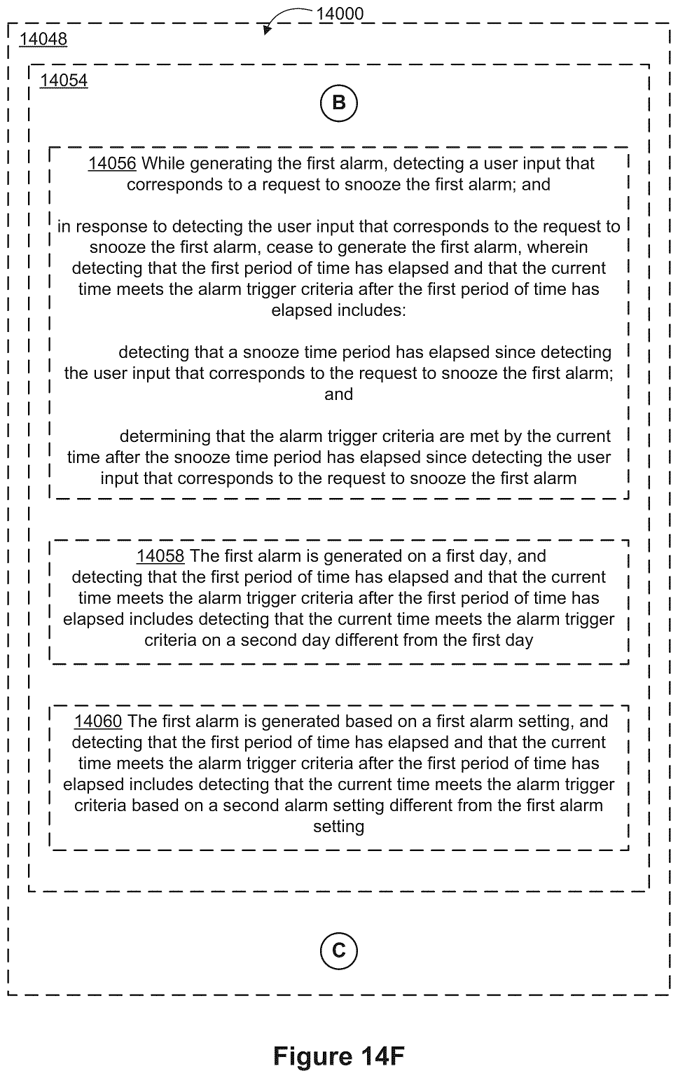

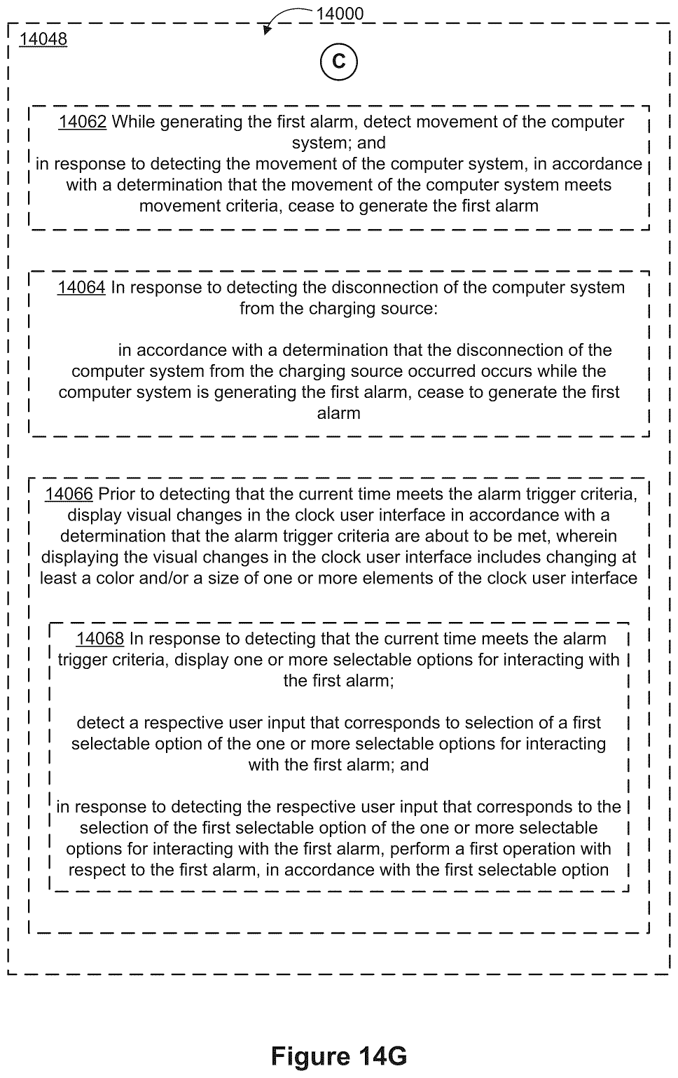

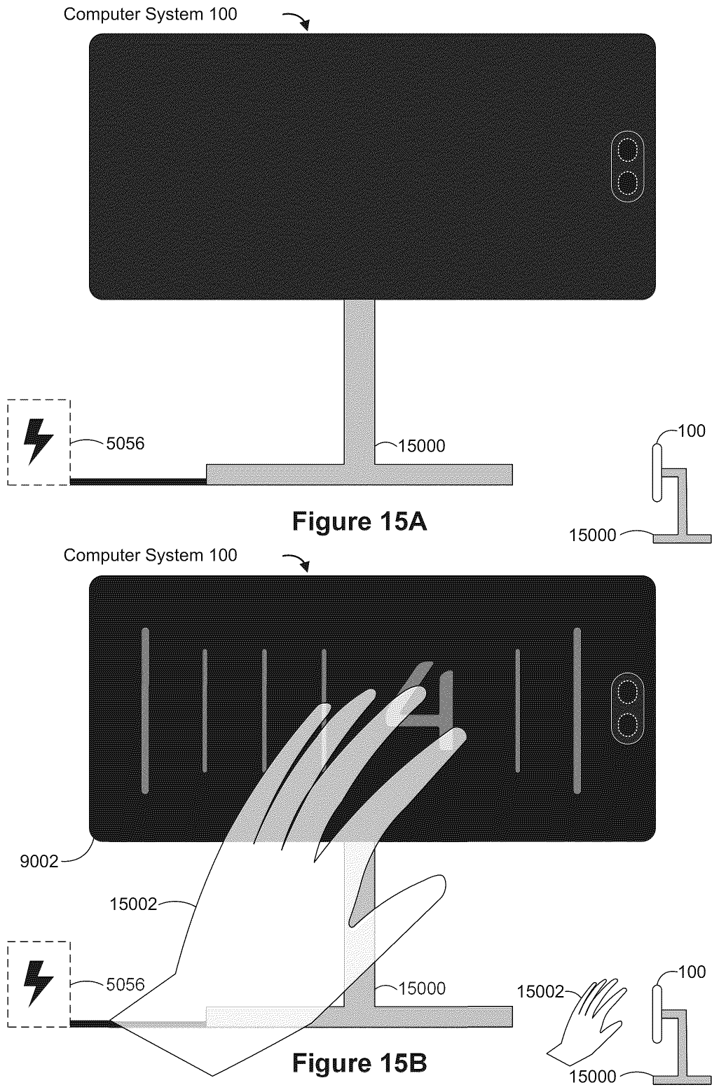

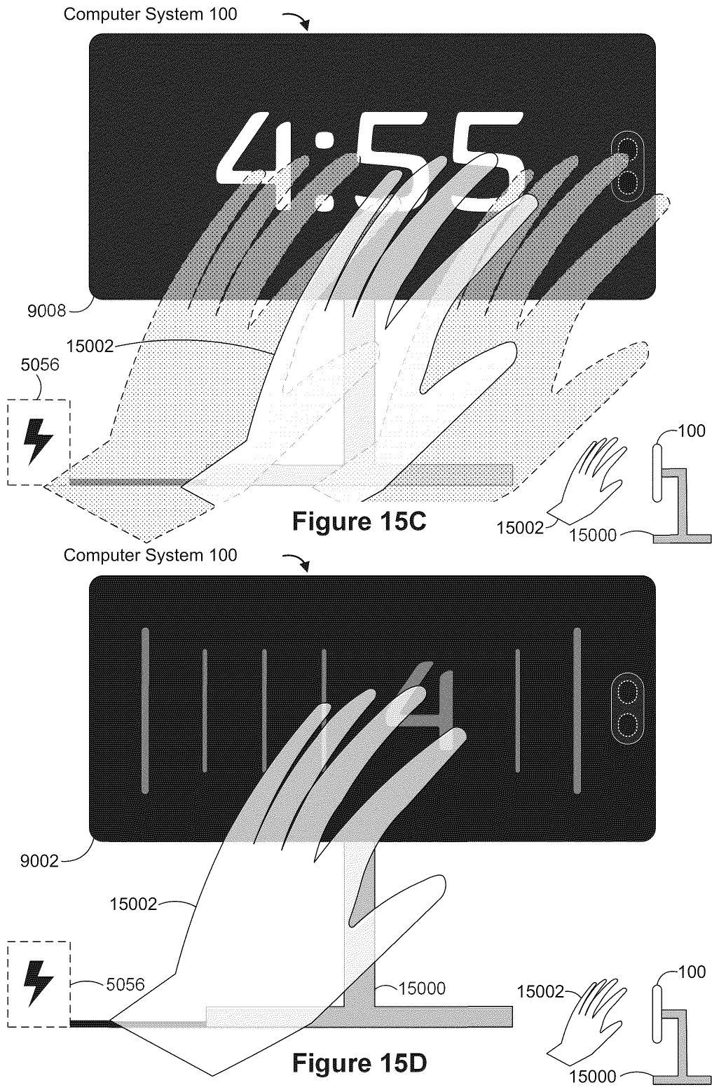

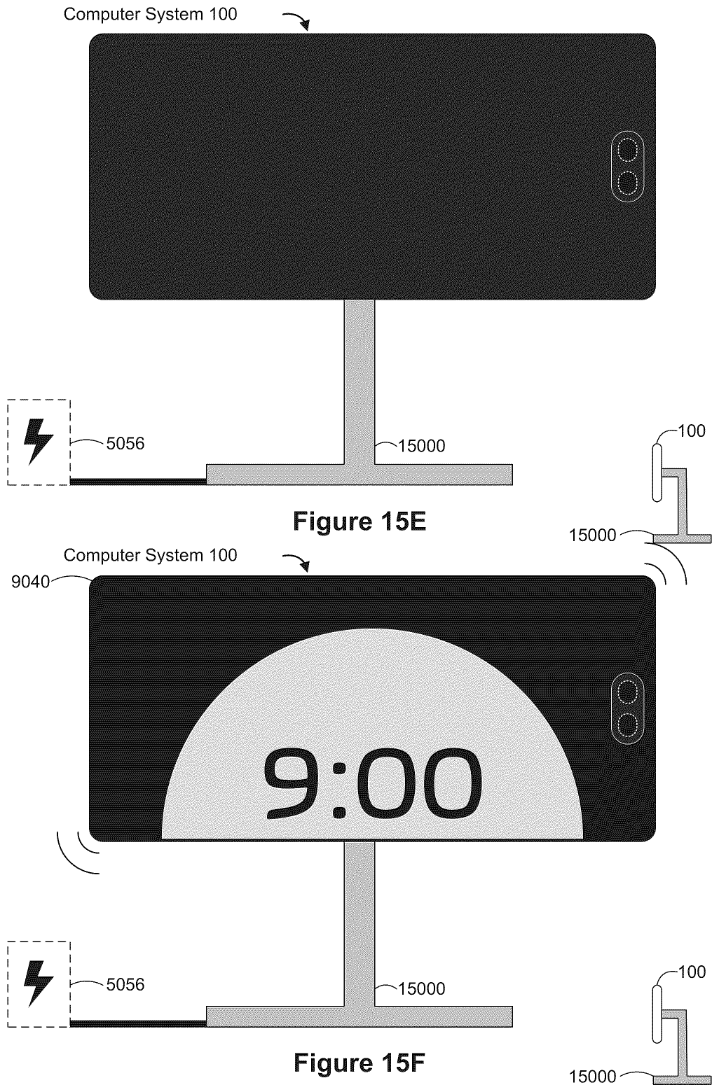

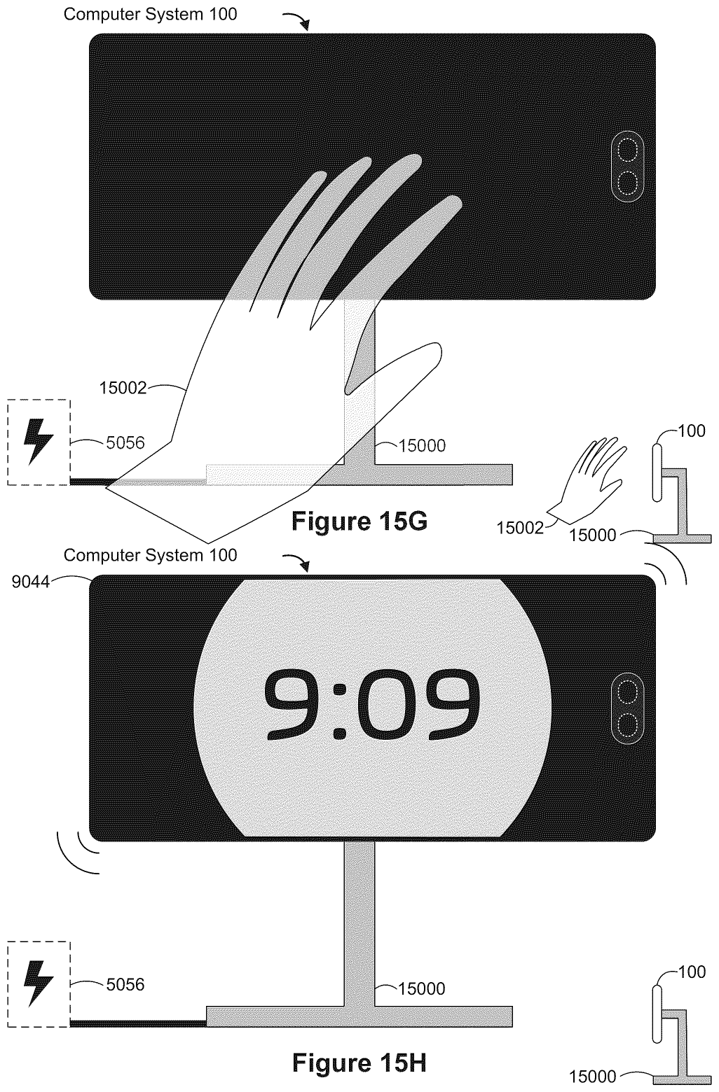

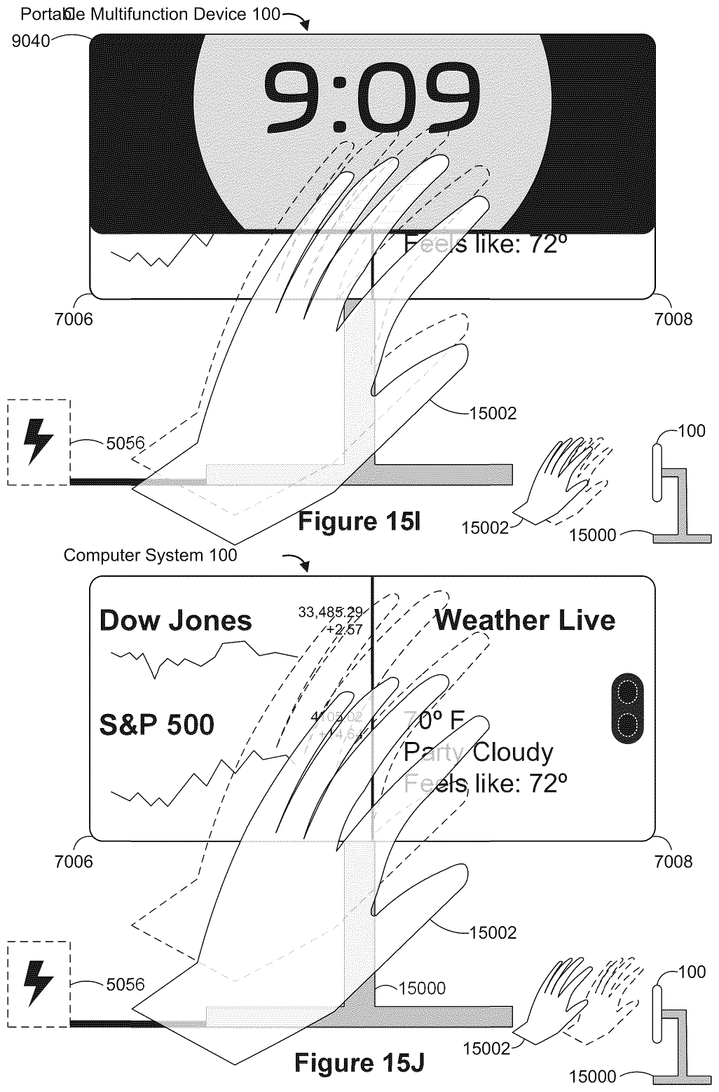

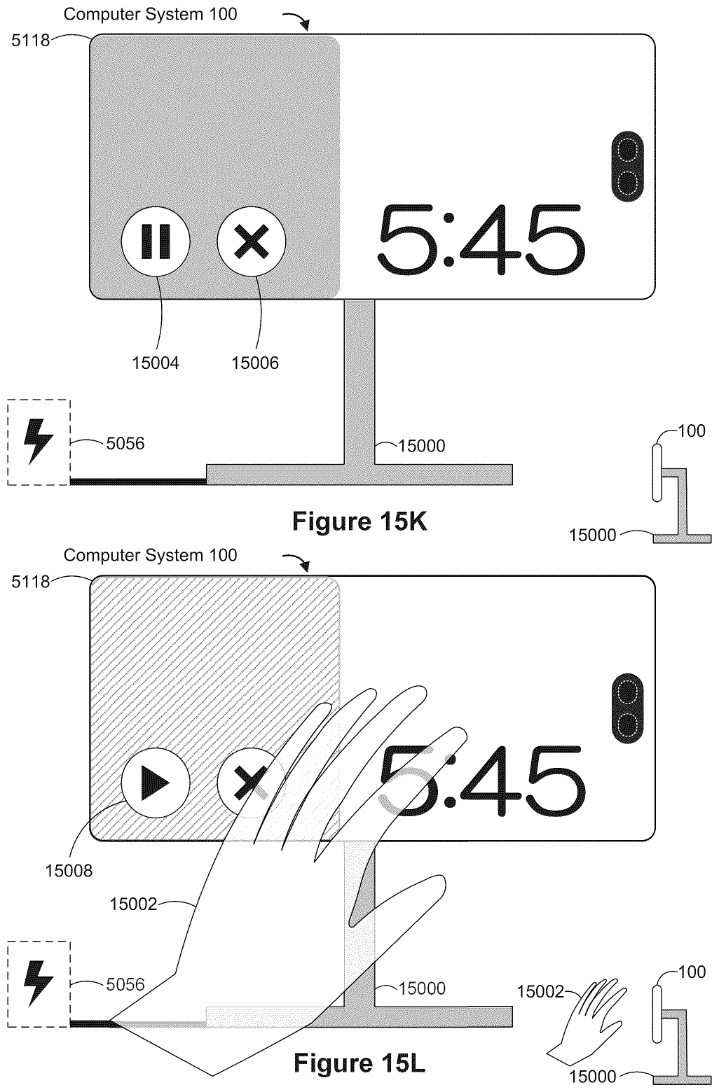

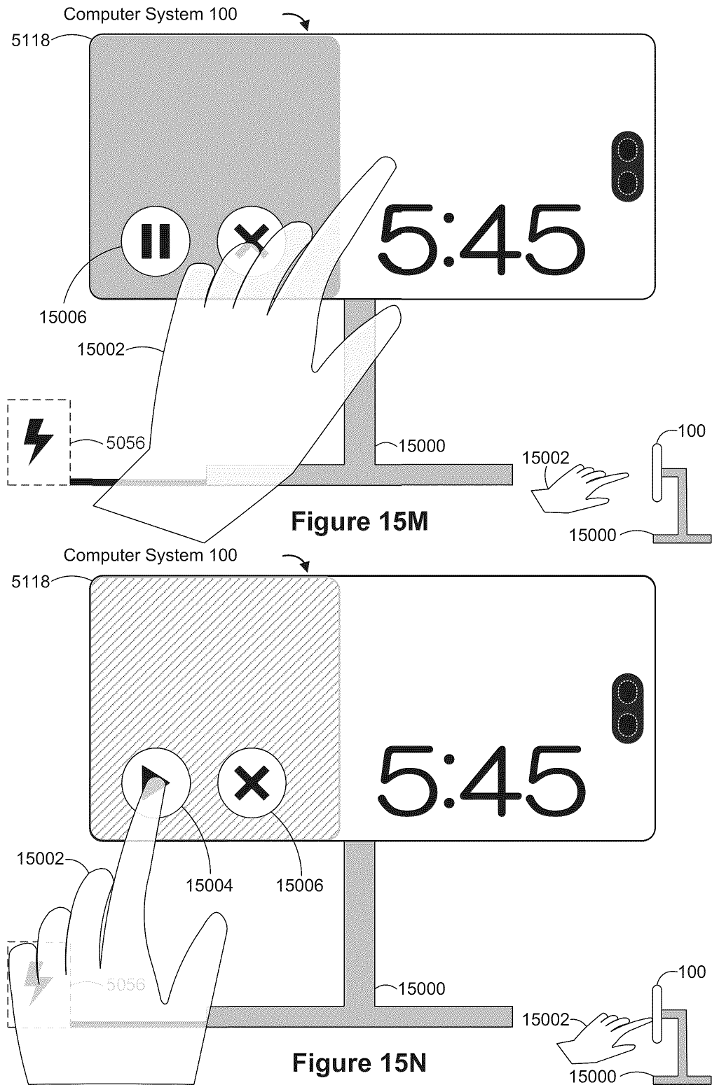

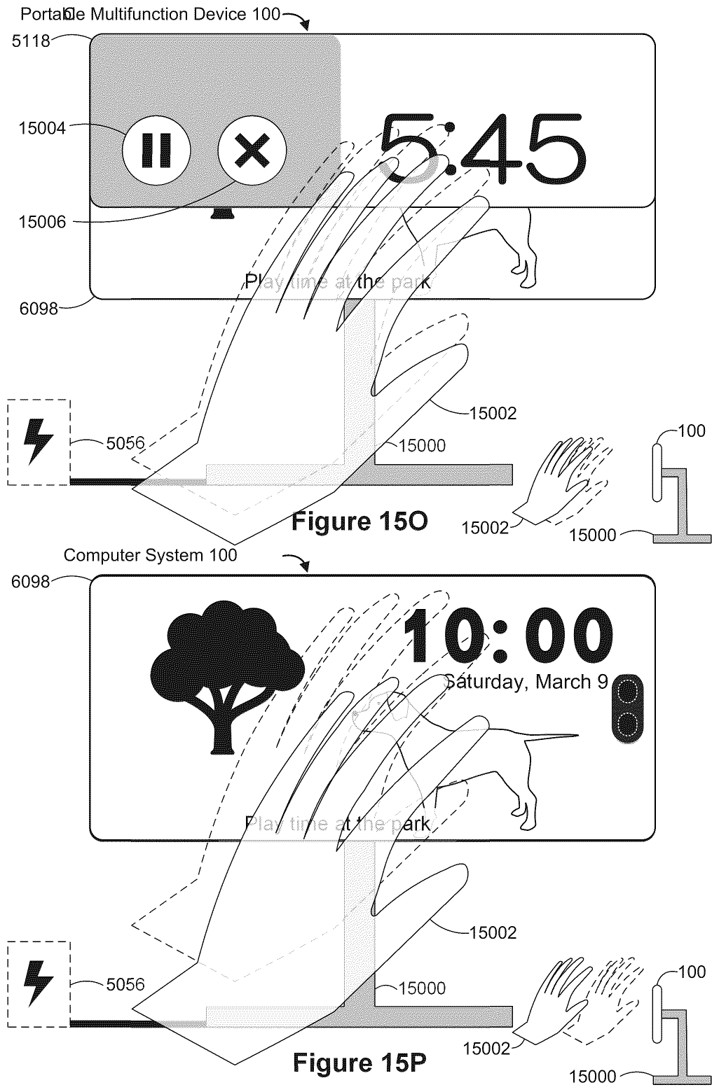

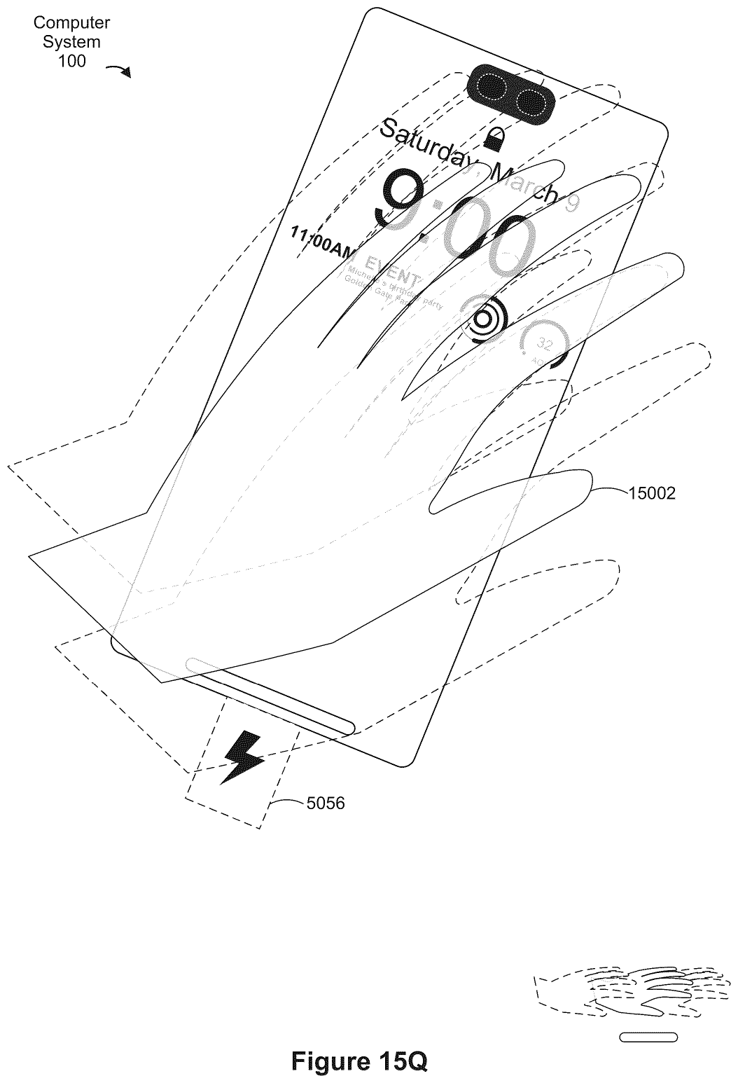

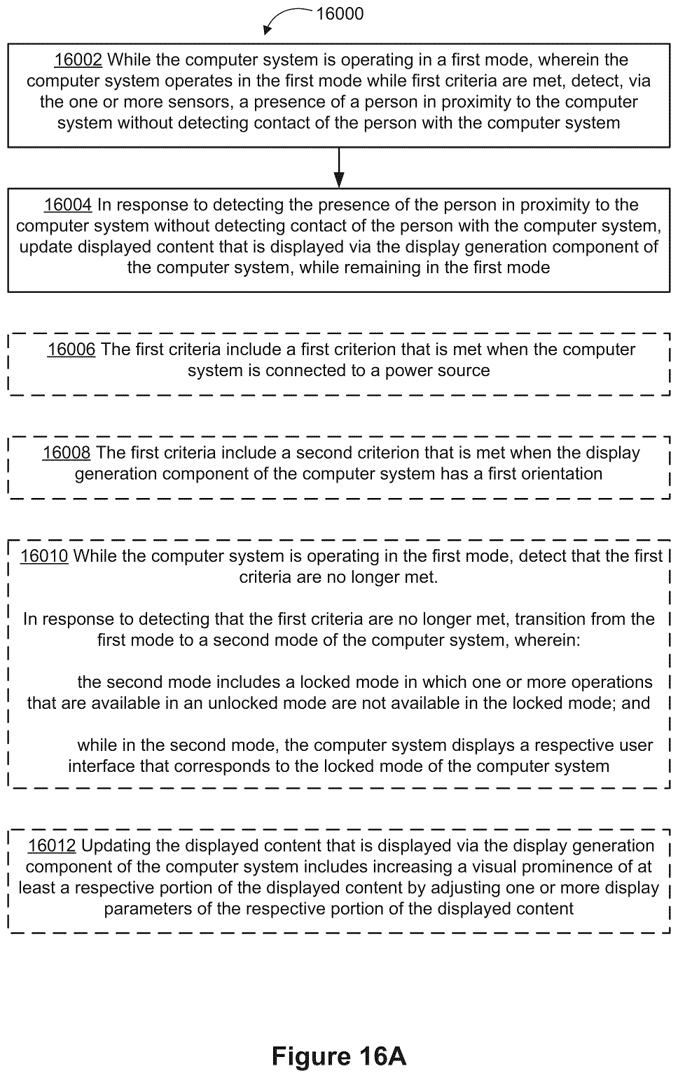

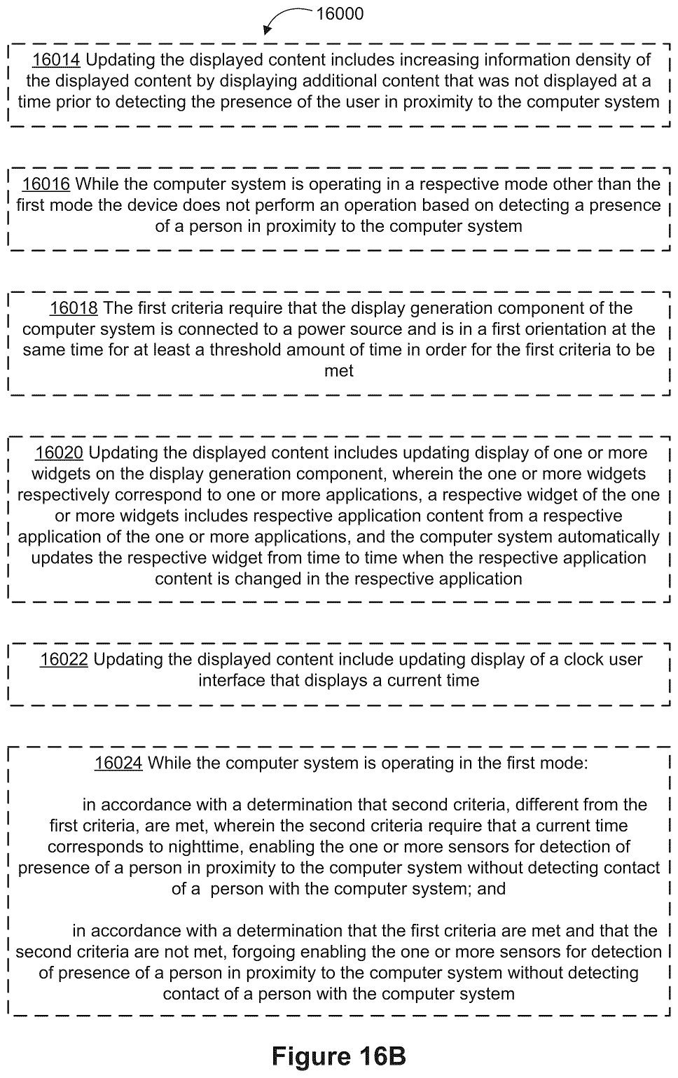

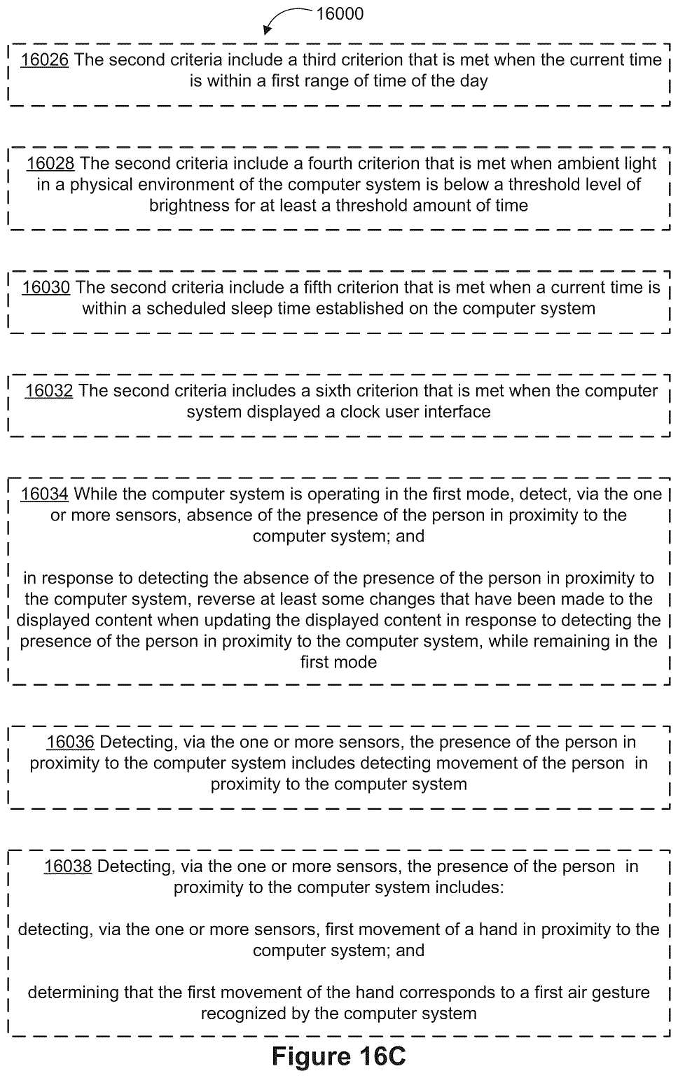

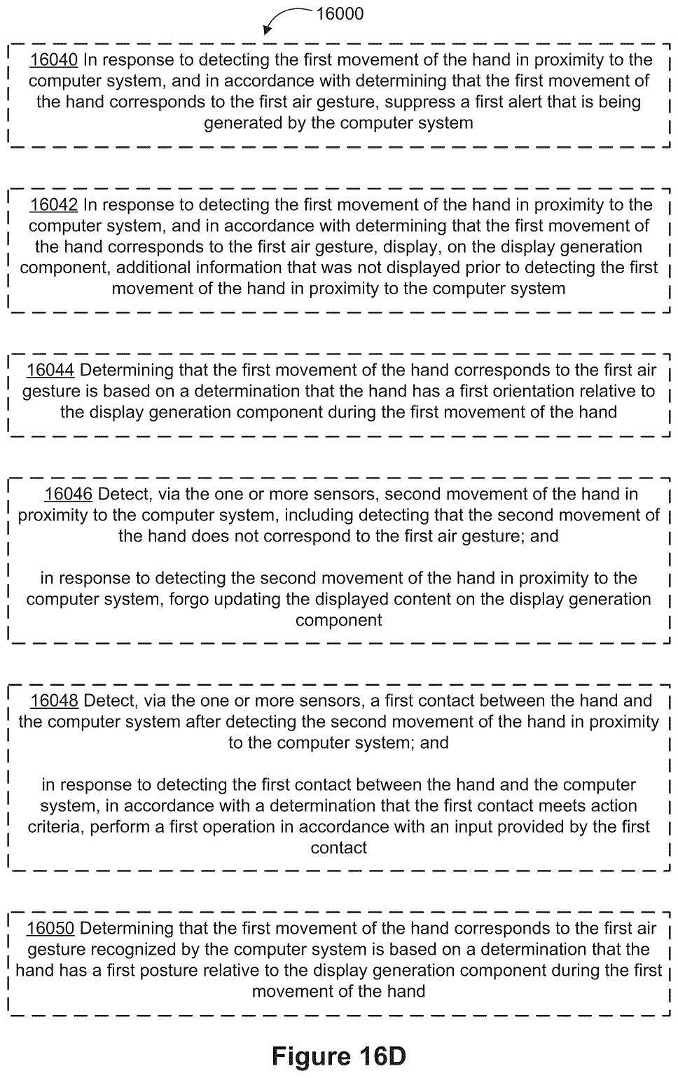

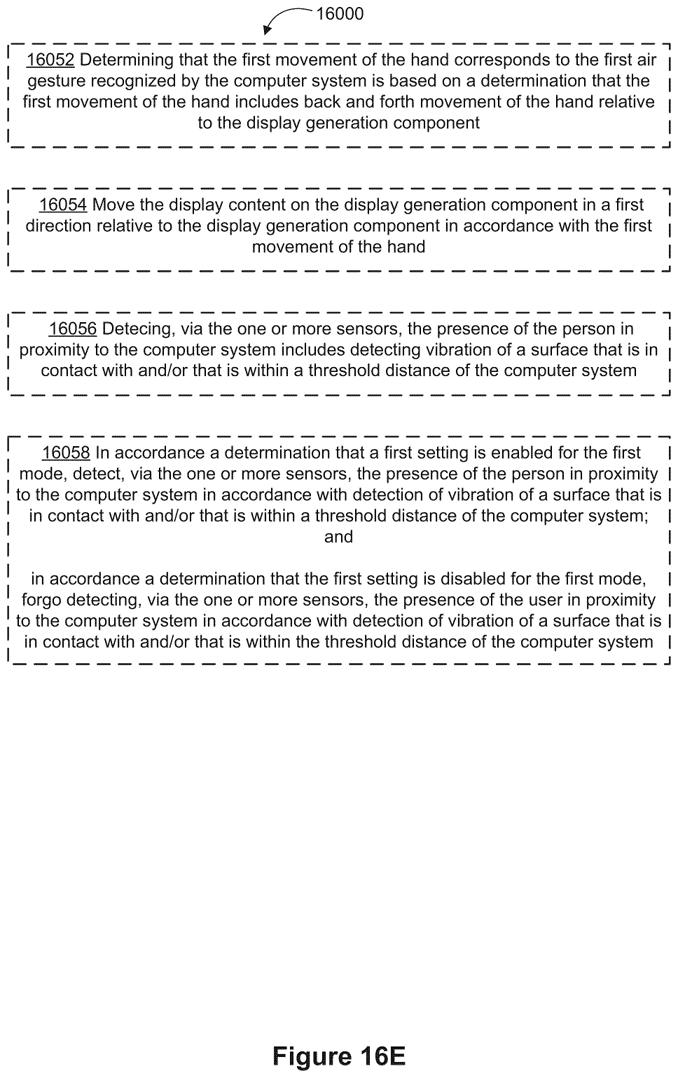

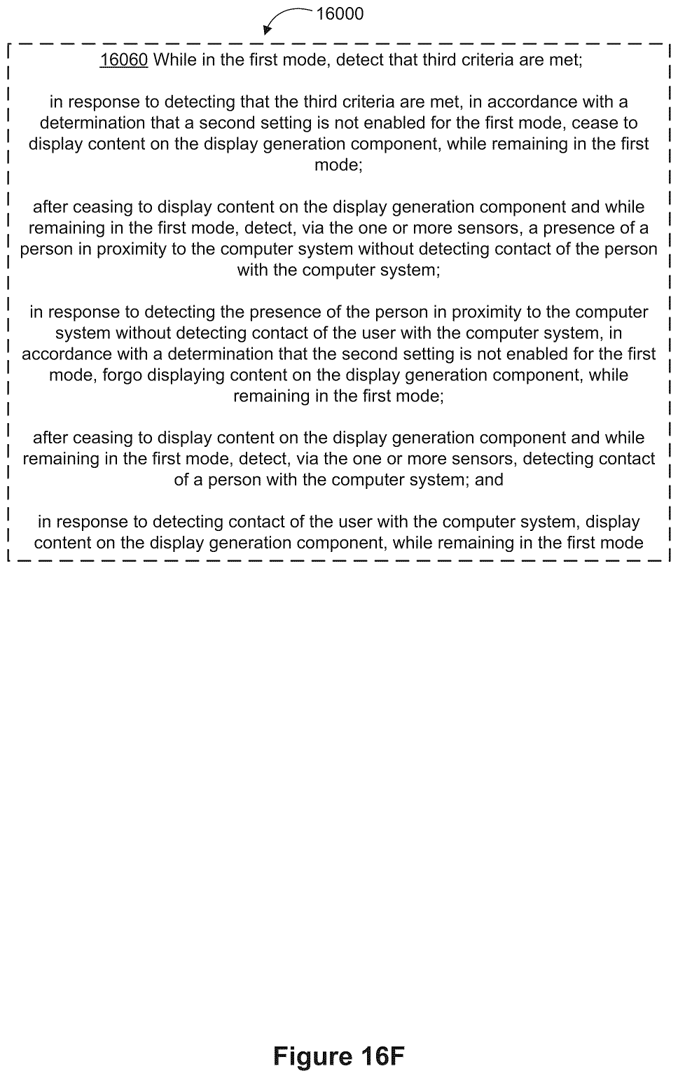

Below, FIGS. 1A-1B, 2, and 3 provide a description of example devices. FIGS. 4A-4B and 5A-5AT illustrate example user interfaces for automatically displaying a customizable user interface when specific criteria are met. FIGS. 6A-6AN illustrate example user interfaces for switching between, interacting with, and configuring different operational modes (e.g., ambient modes). FIGS. 7A-7V illustrate example user interfaces for interacting with and configuring a customizable user interface. FIGS. 8A-8K illustrate example user interfaces for interacting with different user interfaces of, and switching between, different operational modes (e.g., ambient modes). FIGS. 9A-9AA illustrate example user interfaces for automatically activating a flashlight function of the computer system 100 (e.g., a portable multifunction device, a display generation component associated with a computing device, or other device) when specific criteria are met. FIGS. 10A-10L are a flow diagram of a method for automatically displaying a customizable user interface when specific criteria are met. FIGS. 11A-11G are flow diagrams of a method for switching between, interacting with, and configuring different operational modes (e.g., ambient modes). FIGS. 12A-12D are flow diagrams of a method for interacting with and configuring a customizable user interface. FIGS. 13A-13J are flow diagrams of a method for interacting with different user interfaces of, and switching between, different operational modes (e.g., ambient modes). FIGS. 14A-14G are flow diagrams of a process for automatically activating a flashlight function of the computer system 100 (e.g., a portable multifunction device, a display generation component associated with a computing device, or other device) when specific criteria are met. FIGS. 15A-15Q illustrate example user interfaces for updating displayed content when presence criteria are met. FIGS. 16A-16F are a flow diagram of a method for updating displayed content when presence criteria are met. The user interfaces in FIGS. 5A-5AT are used to illustrate the processes in FIGS. 10A-10L. The user interfaces in FIGS. 6A-5AN are used to illustrate the processes in FIGS. 11A-11G. The user interfaces in FIGS. 7A-7V are used to illustrate the processes in FIGS. 12A-12D. The user interfaces in FIGS. 8A-8K are used to illustrate the processes in FIGS. 13A-13J. The user interfaces in FIGS. 9A-9AA are used to illustrate the processes in FIGS. 14A-14G. The user interfaces in FIGS. 15A-15Q are used to illustrate the processes in FIGS. 16A-16F.

### EXAMPLE DEVICES

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact, unless the context clearly indicates otherwise.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices (and computer systems more generally), user interfaces for such devices, and associated processes for using such devices are described. In some embodiments, the device is a portable communications device, such as a mobile telephone, that also contains other functions, such as PDA and/or music player functions. Example embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch-screen displays and/or touchpads), are, optionally, used. It should also be understood that, in some embodiments, the device is not a portable communications device, but is a desktop computer with a touch-sensitive surface (e.g., a touch-screen display and/or a touchpad).

In the discussion that follows, a computer system in the form of an electronic device that includes a display and a touch-sensitive surface is described. It should be understood, however, that the electronic device optionally includes one or more other physical user-interface devices, such as a physical keyboard, a mouse and/or a joystick.

The device typically supports a variety of applications, such as one or more of the following: a note taking application, a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of computer systems such as portable devices with touch-sensitive displays. FIG. 1A is a block diagram illustrating computer system 100 with touch-sensitive display system 112 in accordance with some embodiments. Touch-sensitive display system 112 is sometimes called a “touch screen” for convenience, and is sometimes simply called a touch-sensitive display. Device 100 includes memory 102 (which optionally includes one or more computer readable storage mediums), memory controller 122, one or more processing units (CPUs) 120, peripherals interface 118, RF circuitry 108, audio circuitry 110, speaker 111, microphone 113, input/output (I/O) subsystem 106, other input or control devices 116, and external port 124. Device 100 optionally includes one or more optical sensors 164. Device 100 optionally includes one or more intensity sensors 165 for detecting intensities of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user. Using tactile outputs to provide haptic feedback to a user enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently.

In some embodiments, a tactile output pattern specifies characteristics of a tactile output, such as the amplitude of the tactile output, the shape of a movement waveform of the tactile output, the frequency of the tactile output, and/or the duration of the tactile output.

When tactile outputs with different tactile output patterns are generated by a device (e.g., via one or more tactile output generators that move a moveable mass to generate tactile outputs), the tactile outputs may invoke different haptic sensations in a user holding or touching the device. While the sensation of the user is based on the user's perception of the tactile output, most users will be able to identify changes in waveform, frequency, and amplitude of tactile outputs generated by the device. Thus, the waveform, frequency and amplitude can be adjusted to indicate to the user that different operations have been performed. As such, tactile outputs with tactile output patterns that are designed, selected, and/or engineered to simulate characteristics (e.g., size, material, weight, stiffness, smoothness, etc.); behaviors (e.g., oscillation, displacement, acceleration, rotation, expansion, etc.); and/or interactions (e.g., collision, adhesion, repulsion, attraction, friction, etc.) of objects in a given environment (e.g., a user interface that includes graphical features and objects, a simulated physical environment with virtual boundaries and virtual objects, a real physical environment with physical boundaries and physical objects, and/or a combination of any of the above) will, in some circumstances, provide helpful feedback to users that reduces input errors and increases the efficiency of the user's operation of the device. Additionally, tactile outputs are, optionally, generated to correspond to feedback that is unrelated to a simulated physical characteristic, such as an input threshold or a selection of an object. Such tactile outputs will, in some circumstances, provide helpful feedback to users that reduces input errors and increases the efficiency of the user's operation of the device.

In some embodiments, a tactile output with a suitable tactile output pattern serves as a cue for the occurrence of an event of interest in a user interface or behind the scenes in a device. Examples of the events of interest include activation of an affordance (e.g., a real or virtual button, or toggle switch) provided on the device or in a user interface, success or failure of a requested operation, reaching or crossing a boundary in a user interface, entry into a new state, switching of input focus between objects, activation of a new mode, reaching or crossing an input threshold, detection or recognition of a type of input or gesture, etc. In some embodiments, tactile outputs are provided to serve as a warning or an alert for an impending event or outcome that would occur unless a redirection or interruption input is timely detected. Tactile outputs are also used in other contexts to enrich the user experience, improve the accessibility of the device to users with visual or motor difficulties or other accessibility needs, and/or improve efficiency and functionality of the user interface and/or the device. Tactile outputs are optionally accompanied with audio outputs and/or visible user interface changes, which further enhance a user's experience when the user interacts with a user interface and/or the device, and facilitate better conveyance of information regarding the state of the user interface and/or the device, and which reduce input errors and increase the efficiency of the user's operation of the device.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, firmware, or a combination thereof, including one or more signal processing and/or application specific integrated circuits.

Memory 102 optionally includes high-speed random access memory and optionally also includes non-volatile memory, such as one or more magnetic disk storage devices, flash memory devices, or other non-volatile solid-state memory devices. Access to memory 102 by other components of device 100, such as CPU(s) 120 and the peripherals interface 118, is, optionally, controlled by memory controller 122.

Peripherals interface 118 can be used to couple input and output peripherals of the device to CPU(s) 120 and memory 102. The one or more processors 120 run or execute various software programs and/or sets of instructions stored in memory 102 to perform various functions for device 100 and to process data.

In some embodiments, peripherals interface 118, CPU(s) 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication optionally uses any of a plurality of communications standards, protocols and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPA), long term evolution (LTE), near field communication (NFC), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11ac, IEEE 802.11ax, IEEE 802.11b, IEEE 802.11g and/or IEEE 802.11n), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

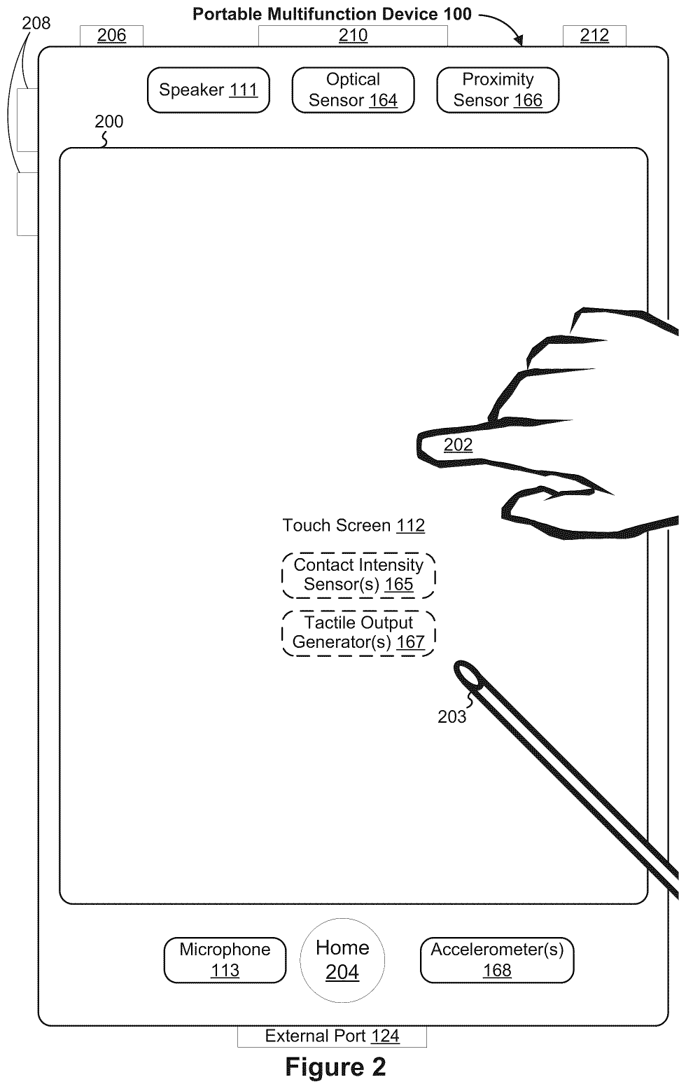

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both cars) and input (e.g., a microphone).

I/O subsystem 106 couples input/output peripherals on device 100, such as touch-sensitive display system 112 and other input or control devices 116, with peripherals interface 118. I/O subsystem 106 optionally includes display controller 156, optical sensor controller 158, intensity sensor controller 159, haptic feedback controller 161, and one or more input controllers 160 for other input or control devices. The one or more input controllers 160 receive/send electrical signals from/to other input or control devices 116. The other input or control devices 116 optionally include physical buttons (e.g., push buttons, rocker buttons, etc.), dials, slider switches, joysticks, click wheels, and so forth. In some alternate embodiments, input controller(s) 160 are, optionally, coupled with any (or none) of the following: a keyboard, infrared port, USB port, stylus, and/or a pointer device such as a mouse. The one or more buttons (e.g., 208, FIG. 2) optionally include an up/down button (e.g., a single button that rocks in opposite directions, or separate up button and down button) for volume control of speaker 111 and/or microphone 113. The one or more buttons optionally include a push button (e.g., 206, FIG. 2).

Touch-sensitive display system 112 provides an input interface and an output interface between the device and a user. Display controller 156 receives and/or sends electrical signals from/to touch-sensitive display system 112. Touch-sensitive display system 112 displays visual output to the user. The visual output optionally includes graphics, text, icons, video, and any combination thereof (collectively termed “graphics”). In some embodiments, some or all of the visual output corresponds to user interface objects. As used herein, the term “affordance” refers to a user-interactive graphical user interface object (e.g., a graphical user interface object that is configured to respond to inputs directed toward the graphical user interface object). Examples of user-interactive graphical user interface objects include, without limitation, a button, slider, icon, selectable menu item, switch, hyperlink, or other user interface control.

Touch-sensitive display system 112 has a touch-sensitive surface, sensor or set of sensors that accepts input from the user based on haptic and/or tactile contact. Touch-sensitive display system 112 and display controller 156 (along with any associated modules and/or sets of instructions in memory 102) detect contact (and any movement or breaking of the contact) on touch-sensitive display system 112 and converts the detected contact into interaction with user-interface objects (e.g., one or more soft keys, icons, web pages or images) that are displayed on touch-sensitive display system 112. In some embodiments, a point of contact between touch-sensitive display system 112 and the user corresponds to a finger of the user or a stylus.

Touch-sensitive display system 112 optionally uses LCD (liquid crystal display) technology, LPD (light emitting polymer display) technology, or LED (light emitting diode) technology, although other display technologies are used in other embodiments. Touch-sensitive display system 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch-sensitive display system 112. In some embodiments, projected mutual capacitance sensing technology is used, such as that found in the iPhone®, iPod Touch®, and iPad® from Apple Inc. of Cupertino, California.

Touch-sensitive display system 112 optionally has a video resolution in excess of 100 dpi. In some embodiments, the touch screen video resolution is in excess of 400 dpi (e.g., 500 dpi, 800 dpi, or greater). The user optionally makes contact with touch-sensitive display system 112 using any suitable object or appendage, such as a stylus, a finger, and so forth. In some embodiments, the user interface is designed to work with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch-sensitive display system 112 or an extension of the touch-sensitive surface formed by the touch screen.

Device 100 also includes power system 162 for powering the various components. Power system 162 optionally includes a power management system, one or more charging sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164 (e.g., as part of one or more cameras). FIG. 1A shows an optical sensor coupled with optical sensor controller 158 in I/O subsystem 106. Optical sensor(s) 164 optionally include charge-coupled device (CCD) or complementary metal-oxide semiconductor (CMOS) phototransistors. Optical sensor(s) 164 receive light from the environment, projected through one or more lens, and converts the light to data representing an image. In conjunction with imaging module 143 (also called a camera module), optical sensor(s) 164 optionally capture still images and/or video. In some embodiments, an optical sensor is located on the back of device 100, opposite touch-sensitive display system 112 on the front of the device, so that the touch screen is enabled for use as a viewfinder for still and/or video image acquisition. In some embodiments, another optical sensor is located on the front of the device so that the user's image is obtained (e.g., for selfies, for videoconferencing while the user views the other video conference participants on the touch screen, etc.).

Device 100 optionally also includes one or more contact intensity sensors 165. FIG. 1A shows a contact intensity sensor coupled with intensity sensor controller 159 in I/O subsystem 106. Contact intensity sensor(s) 165 optionally include one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor(s) 165 receive contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch-screen display system 112 which is located on the front of device 100.

Device 100 optionally also includes one or more proximity sensors 166. FIG. 1A shows proximity sensor 166 coupled with peripherals interface 118. Alternately, proximity sensor 166 is coupled with input controller 160 in I/O subsystem 106. In some embodiments, the proximity sensor turns off and disables touch-sensitive display system 112 when the multifunction device is placed near the user's ear (e.g., when the user is making a phone call).

Device 100 optionally also includes one or more tactile output generators 167. FIG. 1A shows a tactile output generator coupled with haptic feedback controller 161 in I/O subsystem 106. In some embodiments, tactile output generator(s) 167 include one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Tactile output generator(s) 167 receive tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch-sensitive display system 112, which is located on the front of device 100.

Device 100 optionally also includes one or more accelerometers 168. FIG. 1A shows accelerometer 168 coupled with peripherals interface 118. Alternately, accelerometer 168 is, optionally, coupled with an input controller 160 in I/O subsystem 106. In some embodiments, information is displayed on the touch-screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

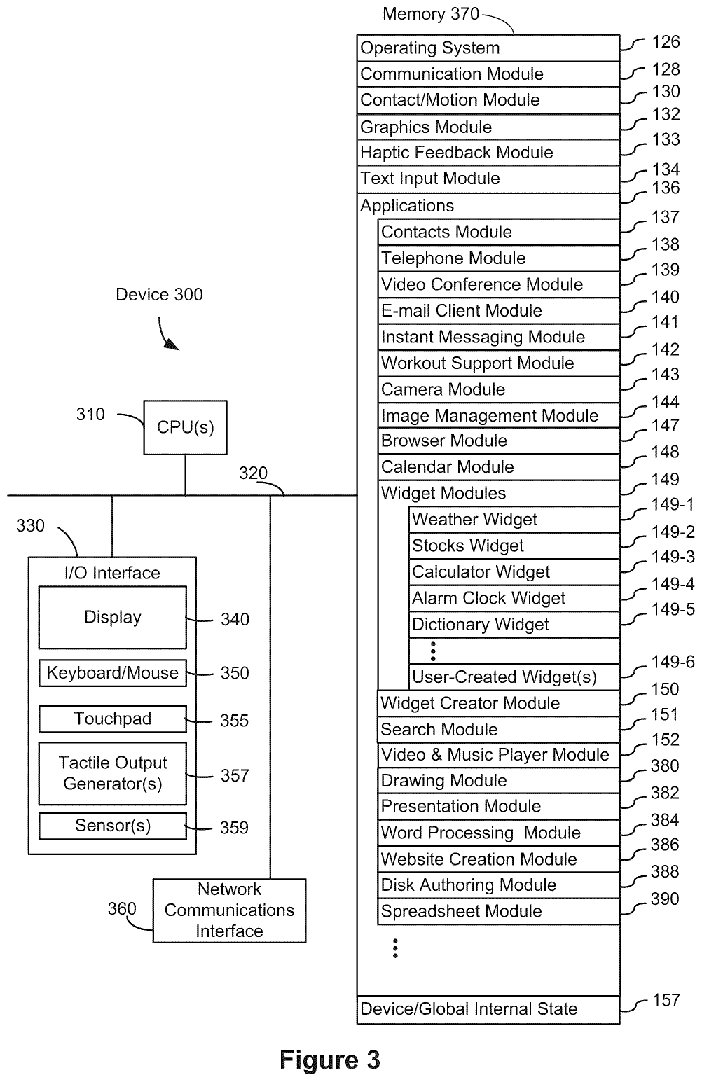

In some embodiments, the software components stored in memory 102 include operating system 126, communication module (or set of instructions) 128, contact/motion module (or set of instructions) 130, graphics module (or set of instructions) 132, haptic feedback module (or set of instructions) 133, text input module (or set of instructions) 134, Global Positioning System (GPS) module (or set of instructions) 135, and applications (or sets of instructions) 136. Furthermore, in some embodiments, memory 102 stores device/global internal state 157, as shown in FIGS. 1A and 3. Device/global internal state 157 includes one or more of: active application state, indicating which applications, if any, are currently active; display state, indicating what applications, views or other information occupy various regions of touch-sensitive display system 112; sensor state, including information obtained from the device's various sensors and other input or control devices 116; and location and/or positional information concerning the device's location and/or attitude.

Operating system 126 (e.g., iOS, Darwin, RTXC, LINUX, UNIX, OS X, WINDOWS, or an embedded operating system such as Vx Works) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used in some iPhone®, iPod Touch®, and iPad® devices from Apple Inc. of Cupertino, California. In some embodiments, the external port is a Lightning connector that is the same as, or similar to and/or compatible with the Lightning connector used in some iPhone®, iPod Touch®, and iPad® devices from Apple Inc. of Cupertino, California. In some embodiments, the external port is a USB Type-C connector that is the same as, or similar to and/or compatible with the USB Type-C connector used in some electronic devices from Apple Inc. of Cupertino, California.

Contact/motion module 130 optionally detects contact with touch-sensitive display system 112 (in conjunction with display controller 156) and other touch-sensitive devices (e.g., a touchpad or physical click wheel). Contact/motion module 130 includes various software components for performing various operations related to detection of contact (e.g., by a finger or by a stylus), such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts or stylus contacts) or to multiple simultaneous contacts (e.g., “multitouch”/multiple finger contacts). In some embodiments, contact/motion module 130 and display controller 156 detect contact on a touchpad.

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (lift off) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (lift off) event. Similarly, tap, swipe, drag, and other gestures are optionally detected for a stylus by detecting a particular contact pattern for the stylus.

In some embodiments, detecting a finger tap gesture depends on the length of time between detecting the finger-down event and the finger-up event, but is independent of the intensity of the finger contact between detecting the finger-down event and the finger-up event. In some embodiments, a tap gesture is detected in accordance with a determination that the length of time between the finger-down event and the finger-up event is less than a predetermined value (e.g., less than 0.1, 0.2, 0.3, 0.4 or 0.5 seconds), independent of whether the intensity of the finger contact during the tap meets a given intensity threshold (greater than a nominal contact-detection intensity threshold), such as a light press or deep press intensity threshold. Thus, a finger tap gesture can satisfy particular input criteria that do not require that the characteristic intensity of a contact satisfy a given intensity threshold in order for the particular input criteria to be met. For clarity, the finger contact in a tap gesture typically needs to satisfy a nominal contact-detection intensity threshold, below which the contact is not detected, in order for the finger-down event to be detected. A similar analysis applies to detecting a tap gesture by a stylus or other contact. In cases where the device is capable of detecting a finger or stylus contact hovering over a touch sensitive surface, the nominal contact-detection intensity threshold optionally does not correspond to physical contact between the finger or stylus and the touch sensitive surface.

The same concepts apply in an analogous manner to other types of gestures. For example, a swipe gesture, a pinch gesture, a depinch gesture, and/or a long press gesture are optionally detected based on the satisfaction of criteria that are either independent of intensities of contacts included in the gesture, or do not require that contact(s) that perform the gesture reach intensity thresholds in order to be recognized. For example, a swipe gesture is detected based on an amount of movement of one or more contacts; a pinch gesture is detected based on movement of two or more contacts towards each other; a depinch gesture is detected based on movement of two or more contacts away from each other; and a long press gesture is detected based on a duration of the contact on the touch-sensitive surface with less than a threshold amount of movement. As such, the statement that particular gesture recognition criteria do not require that the intensity of the contact(s) meet a respective intensity threshold in order for the particular gesture recognition criteria to be met means that the particular gesture recognition criteria are capable of being satisfied if the contact(s) in the gesture do not reach the respective intensity threshold, and are also capable of being satisfied in circumstances where one or more of the contacts in the gesture do reach or exceed the respective intensity threshold. In some embodiments, a tap gesture is detected based on a determination that the finger-down and finger-up event are detected within a predefined time period, without regard to whether the contact is above or below the respective intensity threshold during the predefined time period, and a swipe gesture is detected based on a determination that the contact movement is greater than a predefined magnitude, even if the contact is above the respective intensity threshold at the end of the contact movement. Even in implementations where detection of a gesture is influenced by the intensity of contacts performing the gesture (e.g., the device detects a long press more quickly when the intensity of the contact is above an intensity threshold or delays detection of a tap input when the intensity of the contact is higher), the detection of those gestures does not require that the contacts reach a particular intensity threshold so long as the criteria for recognizing the gesture can be met in circumstances where the contact does not reach the particular intensity threshold (e.g., even if the amount of time that it takes to recognize the gesture changes).

Contact intensity thresholds, duration thresholds, and movement thresholds are, in some circumstances, combined in a variety of different combinations in order to create heuristics for distinguishing two or more different gestures directed to the same input element or region so that multiple different interactions with the same input element are enabled to provide a richer set of user interactions and responses. The statement that a particular set of gesture recognition criteria do not require that the intensity of the contact(s) meet a respective intensity threshold in order for the particular gesture recognition criteria to be met does not preclude the concurrent evaluation of other intensity-dependent gesture recognition criteria to identify other gestures that do have criteria that are met when a gesture includes a contact with an intensity above the respective intensity threshold. For example, in some circumstances, first gesture recognition criteria for a first gesture-which do not require that the intensity of the contact(s) meet a respective intensity threshold in order for the first gesture recognition criteria to be met—are in competition with second gesture recognition criteria for a second gesture-which are dependent on the contact(s) reaching the respective intensity threshold. In such competitions, the gesture is, optionally, not recognized as meeting the first gesture recognition criteria for the first gesture if the second gesture recognition criteria for the second gesture are met first. For example, if a contact reaches the respective intensity threshold before the contact moves by a predefined amount of movement, a deep press gesture is detected rather than a swipe gesture. Conversely, if the contact moves by the predefined amount of movement before the contact reaches the respective intensity threshold, a swipe gesture is detected rather than a deep press gesture. Even in such circumstances, the first gesture recognition criteria for the first gesture still do not require that the intensity of the contact(s) meet a respective intensity threshold in order for the first gesture recognition criteria to be met because if the contact stayed below the respective intensity threshold until an end of the gesture (e.g., a swipe gesture with a contact that does not increase to an intensity above the respective intensity threshold), the gesture would have been recognized by the first gesture recognition criteria as a swipe gesture. As such, particular gesture recognition criteria that do not require that the intensity of the contact(s) meet a respective intensity threshold in order for the particular gesture recognition criteria to be met will (A) in some circumstances ignore the intensity of the contact with respect to the intensity threshold (e.g. for a tap gesture) and/or (B) in some circumstances still be dependent on the intensity of the contact with respect to the intensity threshold in the sense that the particular gesture recognition criteria (e.g., for a long press gesture) will fail if a competing set of intensity-dependent gesture recognition criteria (e.g., for a deep press gesture) recognize an input as corresponding to an intensity-dependent gesture before the particular gesture recognition criteria recognize a gesture corresponding to the input (e.g., for a long press gesture that is competing with a deep press gesture for recognition).

Graphics module 132 includes various known software components for rendering and displaying graphics on touch-sensitive display system 112 or other display, including components for changing the visual impact (e.g., brightness, transparency, saturation, contrast or other visual property) of graphics that are displayed. As used herein, the term “graphics” includes any object that can be displayed to a user, including without limitation text, web pages, icons (such as user-interface objects including soft keys), digital images, videos, animations and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions (e.g., instructions used by haptic feedback controller 161) to produce tactile outputs using tactile output generator(s) 167 at one or more locations on device 100 in response to user interactions with device 100.

Text input module 134, which is, optionally, a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone module 138 for use in location-based dialing, to camera module 143 as picture/video metadata, and to applications that provide location-based services such as weather widgets, local yellow page widgets, and map/navigation widgets).

Applications 136 optionally include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
workout support module 142;
camera module 143 for still and/or video images;
image management module 144;
browser module 147;
calendar module 148;
widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which is, optionally, made up of a video player module and a music player module;
notes module 153;
map module 154; and/or
online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch-sensitive display system 112, display controller 156, contact module 130, graphics module 132, and text input module 134, contacts module 137 includes executable instructions to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers and/or e-mail addresses to initiate and/or facilitate communications by telephone module 138, video conference module 139, e-mail client module 140, or IM module 141; and so forth.

In conjunction with RF circuitry 108, audio circuitry 110, speaker 111, microphone 113, touch-sensitive display system 112, display controller 156, contact module 130, graphics module 132, and text input module 134, telephone module 138 includes executable instructions to enter a sequence of characters corresponding to a telephone number, access one or more telephone numbers in address book 137, modify a telephone number that has been entered, dial a respective telephone number, conduct a conversation and disconnect or hang up when the conversation is completed. As noted above, the wireless communication optionally uses any of a plurality of communications standards, protocols and technologies.

In conjunction with RF circuitry 108, audio circuitry 110, speaker 111, microphone 113, touch-sensitive display system 112, display controller 156, optical sensor(s) 164, optical sensor controller 158, contact module 130, graphics module 132, text input module 134, contact list 137, and telephone module 138, videoconferencing module 139 includes executable instructions to initiate, conduct, and terminate a video conference between a user and one or more other participants in accordance with user instructions.

In conjunction with RF circuitry 108, touch-sensitive display system 112, display controller 156, contact module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch-sensitive display system 112, display controller 156, contact module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, Apple Push Notification Service (APNs) or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, APNs, or IMPS).

In conjunction with RF circuitry 108, touch-sensitive display system 112, display controller 156, contact module 130, graphics module 132, text input module 134, GPS module 135, map module 154, and video and music player module 152, workout support module 142 includes executable instructions to create workouts (e.g., with time, distance, and/or calorie burning goals); communicate with workout sensors (in sports devices and smart watches); receive workout sensor data; calibrate sensors used to monitor a workout; select and play music for a workout; and display, store and transmit workout data.

In conjunction with touch-sensitive display system 112, display controller 156, optical sensor(s) 164, optical sensor controller 158, contact module 130, graphics module 132, and image management module 144, camera module 143 includes executable instructions to capture still images or video (including a video stream) and store them into memory 102, modify characteristics of a still image or video, and/or delete a still image or video from memory 102.

In conjunction with touch-sensitive display system 112, display controller 156, contact module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch-sensitive display system 112, display controller 156, contact module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch-sensitive display system 112, display controller 156, contact module 130, graphics module 132, text input module 134, e-mail client module 140, and browser module 147, calendar module 148 includes executable instructions to create, display, modify, and store calendars and data associated with calendars (e.g., calendar entries, to do lists, etc.) in accordance with user instructions.

In conjunction with RF circuitry 108, touch-sensitive display system 112, display controller 156, contact module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch-sensitive display system 112, display controller 156, contact module 130, graphics module 132, text input module 134, and browser module 147, the widget creator module 150 includes executable instructions to create widgets (e.g., turning a user-specified portion of a web page into a widget).

In conjunction with touch-sensitive display system 112, display controller 156, contact module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch-sensitive display system 112, display controller 156, contact module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present or otherwise play back videos (e.g., on touch-sensitive display system 112, or on an external display connected wirelessly or via external port 124). In some embodiments, device 100 optionally includes the functionality of an MP3 player, such as an iPod (trademark of Apple Inc.).

In conjunction with touch-sensitive display system 112, display controller 156, contact module 130, graphics module 132, and text input module 134, notes module 153 includes executable instructions to create and manage notes, to do lists, and the like in accordance with user instructions.

In conjunction with RF circuitry 108, touch-sensitive display system 112, display controller 156, contact module 130, graphics module 132, text input module 134, GPS module 135, and browser module 147, map module 154 includes executable instructions to receive, display, modify, and store maps and data associated with maps (e.g., driving directions; data on stores and other points of interest at or near a particular location; and other location-based data) in accordance with user instructions.

In conjunction with touch-sensitive display system 112, display controller 156, contact module 130, graphics module 132, audio circuitry 110, speaker 111, RF circuitry 108, text input module 134, e-mail client module 140, and browser module 147, online video module 155 includes executable instructions that allow the user to access, browse, receive (e.g., by streaming and/or download), play back (e.g., on the touch screen 112, or on an external display connected wirelessly or via external port 124), send an e-mail with a link to a particular online video, and otherwise manage online videos in one or more file formats, such as H.264. In some embodiments, instant messaging module 141, rather than e-mail client module 140, is used to send a link to a particular online video.

Each of the above identified modules and applications correspond to a set of executable instructions for performing one or more functions described above and the methods described in this application (e.g., the computer-implemented methods and other information processing methods described herein). These modules (e.g., sets of instructions) need not be implemented as separate software programs, procedures or modules, and thus various subsets of these modules are, optionally, combined or otherwise re-arranged in various embodiments. In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) or part(s) of the user's hand) for interacting with an XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture (e.g., an air drag gesture or an air swipe gesture) includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand. In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture is performed using a first hand of the user (e.g., a pinch input, a long pinch input, or a pinch and drag input), and, in conjunction with performing the pinch input using the first hand, a second pinch input is performed using the other hand (e.g., the second hand of the user's two hands). In some embodiments, movement between the user's two hands is performed (e.g., to increase and/or decrease a distance or relative orientation between the user's two hands).

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, attention of a user is determined to be directed to a portion of the three-dimensional environment based on detection of gaze directed to the portion of the three-dimensional environment (optionally, without requiring other conditions). In some embodiments, attention of a user is determined to be directed to a portion of the three-dimensional environment based on detection of gaze directed to the portion of the three-dimensional environment with one or more additional conditions such as requiring that gaze is directed to the portion of the three-dimensional environment for at least a threshold duration (e.g., a dwell duration) and/or requiring that the gaze is directed to the portion of the three-dimensional environment while the viewpoint of the user is within a distance threshold from the portion of the three-dimensional environment in order for the device to determine that attention of the user is directed to the portion of the three-dimensional environment, where if one of the additional conditions is not met, the device determines that attention is not directed to the portion of the three-dimensional environment toward which gaze is directed (e.g., until the one or more additional conditions are met).

In some embodiments, the detection of a ready state configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user's head and above the user's waist and extended out from the body by at least 15, 20, 25, 30, or 50 cm), and/or based on whether the hand has moved in a particular manner (e.g., moved toward a region in front of the user above the user's waist and below the user's head or moved away from the user's body or leg). In some embodiments, the ready state is used to determine whether interactive elements of the user interface respond to attention (e.g., gaze) inputs.

In scenarios where inputs are described with reference to air gestures, it should be understood that similar gestures could be detected using a hardware input device that is attached to or held by one or more hands of a user, where the position of the hardware input device in space can be tracked using optical tracking, one or more accelerometers, one or more gyroscopes, one or more magnetometers, and/or one or more inertial measurement units and the position and/or movement of the hardware input device is used in place of the position and/or movement of the one or more hands in the corresponding air gesture(s). In scenarios where inputs are described with reference to air gestures, it should be understood that similar gestures could be detected using a hardware input device that is attached to or held by one or more hands of a user, user inputs can be detected with controls contained in the hardware input device such as one or more touch-sensitive input elements, one or more pressure-sensitive input elements, one or more buttons, one or more knobs, one or more dials, one or more joysticks, one or more hand or finger coverings that can detect a position or change in position of portions of a hand and/or fingers relative to each other, relative to the user's body, and/or relative to a physical environment of the user, and/or other hardware input device controls, wherein the user inputs with the controls contained in the hardware input device are used in place of hand and/or finger gestures such as air taps or air pinches in the corresponding air gesture(s). For example, a selection input that is described as being performed with an air tap or air pinch input could be alternatively detected with a button press, a tap on a touch-sensitive surface, a press on a pressure-sensitive surface, or other hardware input. As another example, a movement input that is described as being performed with an air pinch and drag (e.g., an air drag gesture or an air swipe gesture) could be alternatively detected based on an interaction with the hardware input control such as a button press and hold, a touch on a touch-sensitive surface, a press on a pressure-sensitive surface, or other hardware input that is followed by movement of the hardware input device (e.g., along with the hand with which the hardware input device is associated) through space. Similarly, a two-handed input that includes movement of the hands relative to each other could be performed with one air gesture and one hardware input device in the hand that is not performing the air gesture, two hardware input devices held in different hands, or two air gestures performed by different hands using various combinations of air gestures and/or the inputs detected by one or more hardware input devices that are described above.

FIG. 1B is a block diagram illustrating example components for event handling in accordance with some embodiments. In some embodiments, memory 102 (in FIG. 1A) or 370 (FIG. 3) includes event sorter 170 (e.g., in operating system 126) and a respective application 136-1 (e.g., any of the aforementioned applications 136, 137-155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display system 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display system 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display system 112 or a touch-sensitive surface.

In some embodiments, event monitor 171 sends requests to the peripherals interface 118 at predetermined intervals. In response, peripherals interface 118 transmits event information. In other embodiments, peripheral interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views, when touch-sensitive display system 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver module 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177 or GUI updater 178 to update the application internal state 192. Alternatively, one or more of the application views 191 includes one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170, and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event 187 include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first lift-off (touch end) for a predetermined phase, a second touch (touch begin) on the displayed object for a predetermined phase, and a second lift-off (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display system 112, and lift-off of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display system 112, when a touch is detected on touch-sensitive display system 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event 187 also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video and music player module 152. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input-devices, not all of which are initiated on touch screens. For example, mouse movement and mouse button presses, optionally coordinated with single or multiple keyboard presses or holds; contact movements such as taps, drags, scrolls, etc., on touch-pads; pen stylus inputs; movement of the device; oral instructions; detected eye movements; biometric inputs; and/or any combination thereof are optionally utilized as inputs corresponding to sub-events which define an event to be recognized.

FIG. 2 illustrates a computer system 100 having a touch screen (e.g., touch-sensitive display system 112, FIG. 1A) in accordance with some embodiments. The touch screen optionally displays one or more graphics within user interface (UI) 200. In these embodiments, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also includes one or more physical buttons, such as “home” or menu button 204. As described previously, menu button 204 is, optionally, used to navigate to any application 136 in a set of applications that are, optionally executed on device 100. Alternatively, in some embodiments, the menu button is implemented as a soft key in a GUI displayed on the touch-screen display, or as a system gesture such as an upward edge swipe.

In some embodiments, device 100 includes the touch-screen display, menu button 204 (sometimes called home button 204), push button 206 for powering the device on/off and locking the device, volume adjustment button(s) 208, Subscriber Identity Module (SIM) card slot 210, head set jack 212, and/or docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In some embodiments, device 100 also accepts verbal input for activation or deactivation of some functions through microphone 113. Device 100 also, optionally, includes one or more contact intensity sensors 165 for detecting intensities of contacts on touch-sensitive display system 112 and/or one or more tactile output generators 167 for generating tactile outputs for a user of device 100.

FIG. 3 is a block diagram of an example multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPU's) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch-screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of computer system 100 (FIG. 1A), or a subset thereof. Furthermore, memory 370 optionally stores additional programs, modules, and data structures not present in memory 102 of computer system 100. For example, memory 370 of device 300 optionally stores drawing module 380, presentation module 382, word processing module 384, website creation module 386, disk authoring module 388, and/or spreadsheet module 390, while memory 102 of computer system 100 (FIG. 1A) optionally does not store these modules.

Each of the above identified elements in FIG. 3 are, optionally, stored in one or more of the previously mentioned memory devices. Each of the above identified modules corresponds to a set of instructions for performing a function described above. The above identified modules or programs (e.g., sets of instructions) need not be implemented as separate software programs, procedures or modules, and thus various subsets of these modules are, optionally, combined or otherwise re-arranged in various embodiments. In some embodiments, memory 370 optionally stores a subset of the modules and data structures identified above. Furthermore, memory 370 optionally stores additional modules and data structures not described above.

Attention is now directed towards embodiments of user interfaces (“UI”) that are, optionally, implemented on computer system 100.

FIG. 4A illustrates an example user interface for a menu of applications on computer system 100 in accordance with some embodiments. Similar user interfaces are, optionally, implemented on device 300. In some embodiments, user interface 400 includes the following elements, or a subset or superset thereof:
Signal strength indicator(s) for wireless communication(s), such as cellular and Wi-Fi signals;
Time;
a Bluetooth indicator;
a Battery status indicator;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser”; and
   Icon 422 for video and music player module 152, labeled “Music”; and
Icons for other applications, such as:
   Icon 424 for IM module 141, labeled “Messages”;
   Icon 426 for calendar module 148, labeled “Calendar”;
   Icon 428 for image management module 144, labeled “Photos”;
   Icon 430 for camera module 143, labeled “Camera”;
   Icon 432 for online video module 155, labeled “Online Video”;
   Icon 434 for stocks widget 149-2, labeled “Stocks”;
   Icon 436 for map module 154, labeled “Maps”;
   Icon 438 for weather widget 149-1, labeled “Weather”;
   Icon 440 for alarm clock widget 149-4, labeled “Clock”;
   Icon 442 for workout support module 142, labeled “Workout Support”;
   Icon 444 for notes module 153, labeled “Notes”; and
   Icon 446 for a settings application or module, which provides access to settings for device 100 and its various applications 136.

It should be noted that the icon labels illustrated in FIG. 4A are merely examples. For example, other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an example user interface on a device (e.g., device 300, FIG. 3) with a touch-sensitive surface 451 (e.g., a tablet or touchpad 355, FIG. 3) that is separate from the display 450. Although many of the examples that follow will be given with reference to inputs on touch screen display 112 (where the touch sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures, etc.), it should be understood that, in some embodiments, one or more of the finger inputs are replaced with input from another input device (e.g., a mouse based input or a stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

In some embodiments, the response of the device to inputs detected by the device depends on criteria based on the contact intensity during the input. For example, for some “light press” inputs, the intensity of a contact exceeding a first intensity threshold during the input triggers a first response. In some embodiments, the response of the device to inputs detected by the device depends on criteria that include both the contact intensity during the input and time-based criteria. For example, for some “deep press” inputs, the intensity of a contact exceeding a second intensity threshold during the input, greater than the first intensity threshold for a light press, triggers a second response only if a delay time has elapsed between meeting the first intensity threshold and meeting the second intensity threshold. This delay time is typically less than 200 ms (milliseconds) in duration (e.g., 40, 100, or 120 ms, depending on the magnitude of the second intensity threshold, with the delay time increasing as the second intensity threshold increases). This delay time helps to avoid accidental recognition of deep press inputs. As another example, for some “deep press” inputs, there is a reduced-sensitivity time period that occurs after the time at which the first intensity threshold is met. During the reduced-sensitivity time period, the second intensity threshold is increased. This temporary increase in the second intensity threshold also helps to avoid accidental deep press inputs. For other deep press inputs, the response to detection of a deep press input does not depend on time-based criteria.

In some embodiments, one or more of the input intensity thresholds and/or the corresponding outputs vary based on one or more factors, such as user settings, contact motion, input timing, application running, rate at which the intensity is applied, number of concurrent inputs, user history, environmental factors (e.g., ambient noise), focus selector position, and the like. Example factors are described in U.S. patent application Ser. Nos. 14/399,606 and 14/624,296, which are incorporated by reference herein in their entireties.

FIGS. 4C1-4C2 illustrate an example state diagram 4000 of navigation between various user interfaces of the multifunction device 100 in accordance with some embodiments. In some embodiments, the multifunction device 100 displays a respective user interface from a plurality of different user interfaces, including a wake screen user interface 490 (also referred to as a coversheet user interface 496), a home screen user interface 492, a widget user interface 491, a control user interface 498, a search user interface 494, an application library user interface 497, and an application user interface 493 of a respective application (e.g., a camera application (e.g., camera application user interface 495), a flashlight application, a settings application, a messaging application (e.g., application user interface 493), a telephony application, a maps application, a browser application, or another type of application) of a plurality of applications. In some embodiments, the multifunction device utilizes various portions of the display (e.g., touch-screen display 112, display 340 associated with a touch-sensitive surface, a head-mounted display, or another type of display) to display persistent content across multiple user interfaces. For example, in some embodiments, the display includes a dynamic status region 4002 for displaying alerts, status updates, and/or current states for various subscribed and/or ongoing events, and/or for various application activities, in real-time or substantially real-time. In some embodiments, the display includes a static status region 4022 for displaying status information for one or more system functions that is relatively stable over a period of time. In some embodiments, the dynamic status region 4002 changes (e.g., expands and/or shrinks) from a region that accommodate one or more hardware elements of the multifunction device (e.g., the camera lenses, microphone, and/or speakers). As described herein, although examples below are given with touch-gestures on a touch-screen display, similar functions can be implemented with a display that is associated with a touch-sensitive surface, where a location (e.g., a location on a top edge, a bottom edge, a left edge, a right edge, a top left portion, a bottom right portion, an interior portion, and/or another portion) on the touch-sensitive surface has a corresponding location (e.g., a location on a top edge, a bottom edge, a left edge, a right edge, a top left portion, a bottom right portion, an interior portion, and/or another portion) on the display (and/or on the user interface presented on the display). Furthermore, although the examples below are given with touch-gestures on a touch-screen display, similar functions can be implemented with a display that is associated with another type of input, such as a mouse inputs, a pointer inputs, gaze inputs (e.g., gazes with time and location characteristics that are directed to various portions of the displayed user interface and/or user interface elements) in conjunction with air gesture inputs (e.g., air tap, air swipe, air pinch, pinch and hold, pinch-hold and drag, and/or another type of air gestures). As described herein, although examples below are given with touch-gestures on a touch-screen display, similar functions can be implemented with a head-mounted display that displays the user interfaces in a three-dimensional environment and that is controlled with various input devices and sensors for detecting various types of user inputs (e.g., touch gestures, inputs provided by a pointer or controller, gaze inputs, voice inputs, and/or air gestures).

As shown in FIG. 4C1, when the multifunction device 100 is initially powered on (e.g., in response to a long press or other activation input 4100 on a power button 116a (FIG. 4A) of the multifunction device 100), the multifunction device displays (4100) the wake screen user interface 490 that is the initially displayed system user interface of the multifunction device 100 when the multifunction device transitions from a power off state to a power on state.

In some embodiments, while the wake screen user interface 490 is displayed after a period of time, the multifunction device 100 optionally transitions (4101) to a low power state, where the display of the multifunction device 100 is optionally turned off, or dimmed, as illustrated by user interface 489. In some embodiments, the wake screen user interface 490 remains displayed in a dimmed, always on state, while the multifunction device 100 is in the low power state. For example, in the low power state illustrated by user interface 489, the time indication and/or date indication continues to be displayed.

In some embodiments, the multifunction device 100 transitions (4101) into the low power state (e.g., turns off the display or displays the wake screen user interface 490 in the dimmed, always-on state) in response to activation of the power button 116a of the multifunction device 100 by a user input 4101 (e.g., while displaying the wake screen user interface 490, and/or any of the other user interfaces described herein).

In some embodiments, the multifunction device transitions (e.g., automatically after a period of inactivity, and/or in response to detecting a user input activating the power button 116a) into the low power state from the normal operating state in which any of a number of user interfaces (e.g., the wake screen user interface 490, the home screen user interface 492, the application user interface 493 of a respective application, or another system and/or application user interface) may be the last displayed user interface before the transition into the low power state.

In some embodiments, when the multifunction device 100 is in the low power state, the multifunction device continues to detect inputs via one or more sensors and input devices of the multifunction device (e.g., movement of the device, touch gestures (e.g., swipe, tap, or other touch input), gaze input, air gestures, impact on the device, press on the power button, rotation of a crown, or other types of inputs). In some embodiments, in response to detecting a user input via the one or more sensors and input devices of the multifunction device, the multifunction device transitions (4100) from the low power state to the normal operating state, and displays the wake screen user interface 490 in a normal, undimmed state.

In some embodiments, when the multifunction device 100 is in the low power state illustrated in user interface 489, the multifunction device continues to detect events, such as arrival of notifications and status updates (e.g., notification for messages, incoming communication requests, and/or other application-generated events and system-generated events, and status updates for sessions, subscribed events, and/or other status changes that require the user's attention). In some embodiments, in response to detecting an event that generates an alert, a notification, and/or a status update, the multifunction device transitions from the low power state to the normal operating state, and displays the alert, notification, and/or status update on the wake screen user interface 490 in the normal, undimmed state. In some embodiments, the multifunction device automatically returns to the low power mode after a short period of time after displaying the alert, notification, and/or the status update.

In some embodiments, the wake screen user interface 490 displayed in the dimmed always-on state includes the same or substantially the same set of user interface elements as the wake screen user interface 490 displayed in the normal operating state (e.g., as opposed to the dark screen shown in FIGS. 4C1 and 4C2). In some embodiments, the wake screen user interface 490 displayed in the dimmed, always-on state has fewer user interface elements than the wake screen user interface 490 displayed in the normal operating state. For example, in some embodiments, the wake screen user interface 490 displayed in the normal operating state includes a time element 4004 showing the current time, a date element 4006 showing the current date, one or more widgets 4008 that include content from respective applications that is updated from time to time without user intervention. In some embodiments, the wake screen user interface 490 displayed in the normal operating state includes one or more application icons corresponding to respective applications, such as an application icon 4010 for the flashlight application, an application icon 4012 for the camera application, or another system-recommended or user selected application. In some embodiments, the wake screen user interface 490 displayed in the normal operating state includes one or more shortcuts for accessing respective operations in one or more system-recommended and/or user-selected applications (e.g., shortcuts to play music using a media player application, to send a quick message using the messaging application, or turn on the DND or sleep mode using a system application). In some embodiments, the wake screen user interface 490 includes the dynamic status region 4002 that displays status updates or current state of an ongoing activity for one or more applications, such as a communication session, a charging session, a running timer, music playing session, delivery updates, navigation instructions, location sharing status, and/or status updates for subscribed application and system events. In some embodiments, the wake screen user interface 490 includes the static status region 4022 that displays status for one or more system functions, such as the network connection status, battery status, location sharing status, cellular signal and carrier information, and other system status information. In some embodiments, a dynamic status update (e.g., battery charging, screen recording, location sharing, and other status updates) is displayed in the dynamic status region 4002 first, and then moved to the static status region 4022 after a period of time. In some embodiments, in a dimmed always on state, the wake screen user interface 490 omits the dynamic status region 4002, static status region 4022, the application icons 4010 and 4012, and/or the shortcuts for application and/or system operations, and optionally disables interaction with remaining user interface elements (e.g., the wallpaper, the time element 4004, the date element 4006, and/or the widgets 4008) of the wake screen user interface 490.

In some embodiments, the wake screen user interface includes one or more recently received notifications (e.g., notifications 4016, or other newly received notification(s)) that correspond to one or more applications. In some embodiments, the wake screen user interface displayed in the dimmed always on state transitions into the wake screen user interface 490 in response to detecting receipt or generation of a new notification (e.g., notification 4018, FIG. 4C2, or another one or more newly received notification(s)) In some embodiments, the notifications 4016 are grouped or coalesced based on event types and/or applications corresponding to the notifications. In some embodiments, user can interact with the notifications to dismiss the notifications, sent the notifications to notification history, and/or expand the notifications to see additional notification content (e.g., optionally after valid authentication data has been requested and/or obtained).

In some embodiments, the wake screen user interface 490 may be displayed while the multifunction device is in a locked state or an unlocked state. In some embodiments, when the wake screen user interface 490 is displayed while the multifunction device is in the locked state, a locked symbol 4020a is optionally displayed in the status region (e.g., dynamic status region 4002, static status region in the upper right corner of the display) or elsewhere (e.g., below the dynamic status region 4002, in the upper left corner, or in another portion of the display) in the wake screen user interface 490 to indicate that the multifunction device is in the locked state (e.g., shown in wake screen user interface 490 in FIG. 4C1), and that authentication data is required to dismiss the wake screen user interface 490 to navigate to the home screen user interface 492 or last-displayed application user interface. In some embodiments, the multifunction device automatically attempts to obtain authentication data via biometric scan (e.g., facial, fingerprint, voiceprint, and/or iris) when the wake screen user interface 490 is displayed (e.g., in the low power state, and/or the normal operating state), and automatically transitions into the unlocked state if valid authentication data is successfully obtained. In some embodiments, in conjunction with transitioning into the unlocked state, the multifunction device replaces the locked symbol 4020a with an unlocked symbol 4020b to indicate that the multifunction device is now in the unlocked state (e.g., shown in wake screen user interface 490 in FIG. 4C2).

In some embodiments, the multifunction device allows user interaction with the user interface elements of the wake screen user interface 490 when the wake screen user interface 490 is displayed in the normal operating mode.

For example, in some embodiments, selecting (e.g., by tapping, clicking, and/or air tapping) on a user interface element, such as one of the widgets 4008, status region 4002, notification 4018, and/or application icons 4010 or 4012, causes the multifunction device to navigate away from the wake screen user interface 490 and displays a respective user interface of the application that corresponds to the selected user interface element, or an enlarged version of the user interface element to show additional information and/or controls related to the initially displayed content in the selected user interface element. For example, as shown in FIG. 4C2, in response to a user input 4113 selecting message notification 4018, the computer system displays (4113) the application user interface 493 for the messaging application.

In another example, in some embodiments, an enhanced selection input 4112 (e.g., a touch and hold gesture, a light press input, or another type of input) on a respective user interface element, such as the time element 4004, the date element 4006, or a wallpaper of the wake screen user interface 490, causes the multifunction device to display a configuration user interface for configuring one or more aspects of the wake screen user interface 490 (e.g., selecting a wallpaper, configuring a color or font scheme of the user interface element, configuring how to layout the different elements of the wake screen user interface, configuring additional wake screen, selecting a previously configured wake screen, and view additional customization options for the wake screen user interface). In some embodiments, configuration of the wake screen user interface 490 is partially applied to the home screen user interface 492, and vice versa.

In some embodiments, an enhanced selection input (e.g., a touch and hold gesture, a light press input, or another type of input) on the flashlight application icon 4010 or the camera application icon 4012 causes the multifunction device to activate the flashlight of the multifunction device or display the camera user interface 495 of the camera application. For example, in response to detecting selection input 4104a on the camera application icon 4012 in the wake screen user interface 490, the multifunction device activates the camera application and displays (4104a) the camera application UI 495 (e.g., as shown in FIG. 4C1).

In some embodiments, if the multifunction device detects user interaction with the user interface elements shown in the wake screen user interface 490 and determines that the wake screen user interface is in the locked state, the multifunction device attempts to obtain authentication data from the user by displaying an authentication user interface (e.g., a passcode entry interface, a password entry user interface, and/or a biometric scan user interface). The multifunction device proceeds to navigate away from the wake screen user interface 490 and performs the operation in accordance with the user's interaction after valid authentication data has been obtained from the user.

In some embodiments, in addition to performing operations (e.g., navigating to application user interfaces, displaying expanded versions of user interface elements that show additional information, and/or displaying configuration options for a respective user interface element or the wake screen user interface), the multifunction device allows the user to navigate from the wake screen user interface 490 to other user interfaces (optionally, after valid authentication data has been obtained) in response to navigation inputs (e.g., swipe gestures or other types of navigation inputs that are directed to regions of the wake screen user interface that are not occupied by a user interface element, and/or regions of the wake screen user interface that are occupied by user interface element (e.g., widgets, application icons, and/or time elements) that do not respond to swipe gestures or said other types of navigation inputs).

For example, in some embodiments, an upward swipe gesture 4105 that starts from the bottom edge of the wake screen user interface 490 causes (4105) the multifunction device to navigate away from the wake screen user interface 490 and display the home screen user interface 492 or the last-displayed application user interface (optionally, after requesting and obtaining valid authentication data).

In some embodiments, the upward swipe gesture 4105 is a representative example of a home gesture or dismissal gesture (e.g., other examples include upward swipe gestures 4103a, 4103c, 4103d, 4103e, 4110a, and 4111a) that causes the multifunction device to dismiss the currently displayed user interface (e.g., the wake screen user interface 490, an application user interface (e.g., camera user interface 495, messages user interface 493, or another application user interface), the control user interface 498, the search user interface 494, the application library user interface 497, or the home screen configuration user interface) and navigate to the home screen user interface 492 or a last-displayed user interface (e.g., the wake screen user interface 490, the wake screen configuration user interface, the search user interface 494, an application user interface, or the home screen user interface 492).

In some embodiments, a downward swipe from a top edge (e.g., the central portion of the top edge, or any portion of the top edge) or an interior region of the wake screen user interface 490 (e.g., downward swipe 4106a, or another downward swipe) causes (4106a) the multifunction device to display the search user interface 494 that includes a search input region 4030 and one or more applications icons 4032 for recommended applications (e.g., recently used applications, and/or relevant applications based on the current context), as shown in FIG. 4C1. In some embodiments, in response to detecting a search input in the search input region 4030, the multifunction device retrieves and displays search results that include relevant application content (e.g., messages, notes, media files, and/or documents) from the different applications that are installed on the multifunction device, relevant applications (e.g., applications that are installed on the multifunction device and/or applications that are available in the app store), relevant webpages (e.g., bookmarked webpages and/or webpages newly retrieved from the Internet), and/or search results from other sources (e.g., news, social media platforms, and/or reference websites). In some embodiments, different sets of search results are provided depending on the locked and unlocked state of the multifunction device, and more details or additional search results may be displayed if the multifunction device is in the unlocked state when the search is performed. In some embodiments, the multifunction device attempts to obtain valid authentication data in response to receiving the search input, and displays different sets of search results depending on whether valid authentication data is obtained. In some embodiments, an upward swipe gesture 4103d that starts from the bottom edge of the search user interface (or another type of dismissal input) causes (4103d) the multifunction device to dismiss the search user interface 494 and redisplays the wake screen user interface 490 (e.g., since the wake screen user interface was the last displayed user interface), as shown in FIG. 4C1. In some embodiments, in response to a downward swipe 4106b from an interior region of the home screen user interface 492 causes (4106b) the multifunction device to display the search user interface 494; and in response to a subsequent upward swipe gesture 4103d from the bottom edge of the search user interface 494, the home screen user interface 492 is (4103d) redisplayed (e.g., since the home screen user interface was the last displayed user interface), as shown in FIG. 4C1.

In some embodiments, as shown in FIG. 4C1, a rightward swipe gesture 4102a that starts from a left edge or interior region of the wake screen user interface 490 causes (4102a) the multifunction device to navigate from the wake screen user interface 490 to a widget user interface 491 (or another system user interface other than the home screen user interface, such as a control user interface, a search user interface, or a notification history user interface). In some embodiments, the widget user interface 491 includes a plurality of widgets 4026 (e.g., including widget 4026a, widget 4026b and widget 4026c) that are automatically selected by the operating system and/or selected by the user for inclusion in the widget user interface 491. In some embodiments, the widgets 4026 displayed in the widget user interface 491 have form factors that are larger than the widgets 4008 displayed under the time element 4004 in the wake screen user interface 490. In some embodiments, the widgets 4026 displayed in the widget user interface 491 and the widgets 4008 displayed in the wake screen user interface 490 are independently selected and/or configured from each other. In some embodiments, the widgets 4026 in the widget user interface 491 include content from their respective applications and the content is automatically updated from time to time as the updates to the content becomes available in the respective applications. In some embodiments, selection of a respective widget (e.g., tapping on the respective widget, or providing other selection input directed to the respective widget) in the widget user interface causes the multifunction device to navigate away from the widget user interface 491 and displays a user interface of the application that corresponds to the respective widget (optionally, after valid authentication data is requested and/or obtained).

In some embodiments, an upward swipe gesture 4103a that starts from the bottom edge of the widget user interface 491 and/or a leftward swipe gesture 4103b that starts from the right edge or the interior region of the widget user interface 491 causes (4103a-1/4103b-1) the multifunction device to dismiss the widget user interface 491 and redisplay the wake screen user interface 490, as shown in FIG. 4C1.

In some embodiments, a leftward swipe gesture 4104b that starts from the right edge or interior portion of the wake screen user interface 490 causes (4104b) the multifunction device to navigate from the wake screen user interface 490 to a camera user interface 495 of the camera application. In some embodiments, access to the photo library through the camera application is restricted in the camera user interface 495 unless valid authentication data has been obtained. In some embodiments, as shown in FIG. 4C1, an upward swipe gesture 4103c that starts from the bottom edge of the camera user interface 495 or another dismissal input causes (4103c) the multifunction device to navigate away from the camera user interface 495 and redisplay the wake screen user interface 490 (e.g., since the wake screen user interface 490 is the last displayed user interface prior to displaying the camera user interface 495).

In some embodiments, a downward swipe gesture 4109a that starts from the right portion of the top edge of the wake screen user interface (e.g., as illustrated in FIG. 4C2) causes (4109a) the multifunction device to display the control user interface 498 overlaying or replacing display of the wake screen user interface 490. In some embodiments, the control user interface 498 includes status information for one or more static status indicators displayed in the static status region 4022, and respective sets of controls 4028 (e.g., including control 4028a, control 4028b, and control 4028c) for various system functions, such as network connections (WiFi, cellular data, airplane mode, Bluetooth, and other connection types), media playback controls, display controls (e.g., display brightness, color temperature, night shift, true tone, and dark mode controls), audio controls (e.g., volume, and/or mute/unmute controls, focus mode controls (e.g., DND, work, study, sleep, and other modes in which generation of alerts and notifications are moderated based on context and configurations, and application icons (e.g., flashlight, timer, calculator, camera, screen recording, and/or other user-selected or system recommended applications))). In some embodiments, an upward swipe gesture 4110a that starts from the bottom edge of the control user interface 498 (or another dismissal input) causes the multifunction device to dismiss the control user interface 498 and redisplay (4110a-1) the wake screen user interface 490 (e.g., since the wake screen user interface 490 is the last displayed user interface prior to displaying the control user interface 498).

In some embodiments, an upward swipe gesture 4107 that starts from the interior region of the wake screen user interface 490 and/or an upward swipe gesture that starts from the interior of the coversheet user interface 496 (e.g., optionally, when there are no unread notifications displayed in the coversheet user interface) causes (4107) the multifunction device to display the notification history user interface that includes a plurality of previously saved notifications and notifications that have been sent directly to notification history without first being displayed on the wake screen user interface 490. In some embodiments, the notification history user interface can be scrolled to reveal additional notifications in response to an upward swipe gesture 4118 directed to the notification history in the wake screen user interface 490 and/or the coversheet user interface 496. In some embodiments, the notification history is displayed as part of the wake screen user interface 490 and/or coversheet user interface 496, and a downward swipe gesture 4103f that is directed to the interior portion of the notification history causes the notification history to cease to be displayed and causes the wake screen user interface 490 and/or coversheet user interface 496 to be redisplayed without the notification history.

As described above, after navigating from the wake screen user interface 490 to a respective user interface other than the home screen user interface (e.g., in response to a swipe gesture in the downward, leftward, or rightward directions), an upward swipe gesture 4103 (e.g., 4103a, and 4103c through 4103f) that starts from a bottom edge of the respective user interface (e.g., an upward swipe gesture that starts from the bottom edge of the touch-sensitive display that displays a respective user interface in full screen mode, or an upward swipe gesture that starts from the bottom edge of a touch-sensitive surface that corresponds to the display that displays the respective user interface) causes the multifunction device to dismiss the respective user interface and returns to the wake screen user interface 490. In contrast, an upward swipe gesture 4105 that starts from the bottom edge of the wake screen user interface 490 causes (4105) the multifunction device to navigate away from the wake screen user interface 490 and displays the home screen user interface 492, and another upward swipe gesture that starts from the bottom edge of the home screen user interface 492 does not cause the multifunction device to dismiss the home screen user interface 492 and return to the wake screen user interface 490. In other words, once the navigation from the wake screen user interface 490 to the home screen user interface 492 is completed, the multifunction device is no longer in the restricted state, and access to the application icons displayed on the home screen user interface 492 and access to the content and functions of the computer system are unrestricted to the user. The upward swipe gesture that starts from the bottom edge of the currently displayed user interface is a representative example of a dismissal input that dismisses the currently displayed user interface and redisplays the last displayed user interface. The upward swipe gesture that starts from the bottom edge of the currently displayed user interface is also a representative example of a home gesture that dismisses the currently displayed user interface and displays the home screen user interface (e.g., irrespective of whether the home screen user interface was the last displayed user interface prior to displaying the currently displayed user interface).

As shown in FIG. 4C2, once the multifunction device navigates away from the wake screen user interface 490 and displays the home screen user interface 492, the user can access the functions and applications of the multifunction device without restriction. For example, in some embodiments, the home screen user interface 492 includes multiple pages, and a respective page of the home screen user interface includes a respective set of application icons and/or widgets corresponding to different applications, and user selection of (e.g., by tapping on, clicking on, or otherwise selecting) a respective widget or application icon causes the multifunction device to display an application user interface of the application that corresponds to the respective widget or application icon.

In some embodiments, the home screen user interface 492 displays a search affordance 4034 (e.g., as illustrated in FIG. 4C1), and a tap on the search affordance 4034 causes the search user interface 494 described above to be displayed overlaying the home screen user interface 492. In some embodiments, in response to detecting an upward swipe gesture 4103d that starts from the bottom edge of the search user interface (or another dismissal input), the multifunction device dismisses the search user interface 494 and redisplays (4103d) the home screen user interface 492 (e.g., not the wake screen user interface 490, as the upward edge swipe gesture dismisses the currently displayed user interface and redisplays the last displayed system user interface).

In some embodiments, as shown in FIG. 4C1, a rightward swipe gesture 4102b that starts from the left edge of the first page of the home screen user interface 492 causes (4102b) the multifunction device to display the widget user interface 491 described above. In some embodiments, a leftward swipe gesture (e.g., gesture 4103b, or another leftward swipe gesture) that starts from the right edge or the interior region of the widget user interface or an upward swipe gesture (e.g., gesture 4103a, or another upward swipe gesture) that starts from the bottom edge of the widget user interface 491 causes (4103a-2/4103b-2) the multifunction device to navigate away from the widget user interface 491 and redisplays the first page of the home screen user interface 492 (e.g., when the home screen user interface 492 was the last displayed user interface prior to displaying the widget user interface 491).

In some embodiments, consecutive leftward swipe gestures 4116 on the home screen user interface 492, as shown in FIG. 4C2, navigates through consecutive pages of the home screen user interface 492 until the application library user interface 497 is (4116) displayed. In some embodiments, the application library user interface 497 displays application icons from multiple pages of the home screen user interface grouped into different categories. In some embodiments, the application library user interface 497 includes a search user interface element 4036 that accepts search criteria (e.g., keywords, image, and/or other search criteria) and returns application icons for relevant applications (e.g., applications that are stored on the multifunction device and/or available in the app store) as search results. In some embodiments, user selection of (e.g., by a tap input, a click input, or another type of selection input) on an application icon in the search results and/or in the application library causes the multifunction device to display the application user interface of the application that corresponds to the selected application icon.

In some embodiments, a downward swipe gesture 4109c that starts from the right portion of the top edge of the application library user interface 497 causes display of the control user interface 498 as described above. In some embodiments, an upward swipe gesture (e.g., upward swipe gesture 4110a, or another upward swipe gesture) that starts from the bottom edge of the control user interface 498 or another dismissal input causes the multifunction device to dismiss the control user interface 498 and redisplay the application library user interface 497 (e.g., since the application library user interface is the last displayed user interface before the display of the control user interface) (e.g., or redisplay another user interface (e.g., redisplay (4110a-1) the wake screen user interface 490 (e.g., if control user interface 498 is displayed in response to swipe gesture 4109a), redisplay (4110a-3) the home screen user interface 492 (e.g., if the control user interface is displayed in response to a downward swipe from the top right portion of the top edge of the display), or redisplay (4110a-2) the application user interface (e.g., if the control user interface is displayed in response to the downward swipe 4109b) that was the last displayed user interface prior to displaying the control user interface).

In some embodiments, a rightward swipe gesture 4115 that starts from the interior region or the left edge of the application library user interface 497 or an upward swipe gesture that starts from the bottom edge of the application library user interface 497 causes (4115) the multifunction device to dismiss the application library user interface 497 and redisplays the last page of the home screen user interface 492.

In some embodiments, a downward swipe gesture 4114 that starts from the interior region of the application library user interface 497 causes the multifunction device to display the application icons for applications stored on the multifunction device in a scrollable list (e.g., according to chronological or alphabetical order).

In some embodiments, an upward swipe gesture that starts from the bottom edge of the home screen user interface causes the multifunction device to display the first page of the home screen user interface 492 or display the multitasking user interface 488 (also referred to an application switcher user interface). In some embodiments, different criteria (e.g., criteria based on the speed, direction, duration, distance, intensity, and/or other characteristics) are used to determine whether to navigate to the first page of the home screen user interface 492 or to the multitasking user interface 488 in response to detecting the upward swipe gesture that starts from the bottom edge of the home screen user interface. For example, in some embodiments, a short flick and a slow and long swipe cause the multifunction device to navigate to the first page of the home screen user interface 492, while a slow and medium length swipe causes the multifunction device to display the multitasking user interface 488. In some embodiments, a navigation gesture is dynamically evaluated before the termination of the gesture is detected, and therefore, the estimated destination user interface of the navigation gesture continues to change and visual feedback regarding the estimated destination user interface continues to be provided to guide the user to conclude the gesture when the desired destination user interface is indicated by the visual feedback. In some embodiments, in response to a user input 4117 at a portion of the multitasking user interface 488 that does not correspond to an application, a last displayed user interface that is displayed before displaying the multitasking user interface 488 is displayed (e.g., home screen user interface 492 is displayed when the multitasking user interface 488 is displayed in response to user input 4111b).

In some embodiments, a reconfiguration mode of the home screen user interface 492 is displayed in which application icons and/or widgets can be repositioned in, removed from, or added to the different pages of the home screen user interface 492. In some embodiments, a touch and hold gesture or another enhanced selection input directed to the home screen user interface 492 for a respective threshold amount of time or another enhanced selection input directed to the home screen user interface 492 cause the multifunction device to display the home screen user interface 492 in the configuration mode. In some embodiments, selection of the search affordance 4034 in the home screen user interface 492 while the home screen user interface 492 is in the reconfiguration mode causes the multifunction device to display a page editing user interface for the home screen user interface in which pages of the home screen user interface may be reordered, deleted, hidden, or created. In some embodiments, a tap input on the home screen user interface in the reconfiguration mode, causes the home screen user interface to exit the reconfiguration mode. In some embodiments, a tap input on unoccupied portion of the page editing user interface causes the multifunction device to exist the page editing user interface and redisplays the home screen user interface in the reconfiguration mode. Another tap on the home screen user interface causes the home screen user interface to exit the reconfiguration mode and be redisplayed in the normal mode.

In some embodiments, while displaying the home screen user interface 492, a downward swipe gesture 4108a that starts from the top edge of the home screen user interface 492 causes (4108a) the multifunction device to cover the home screen user interface 492 with the coversheet user interface 496 (also referred to as the wake screen user interface 490 if the user interface is displayed when transitioning from a normal mode to a low-power mode, and/or vice versa (e.g., due to inactivity, due to activation of the power button, and/or due to user input that corresponds to a request to wake or lock the device)) and the access to the home screen user interface is temporarily restricted by the coversheet user interface 496. In some embodiments, while the coversheet user interface 496 is displayed, an upward swipe gesture 4103e that starts from the bottom edge of the coversheet user interface 496 dismisses (4103e) the coversheet user interface 496 and redisplays the home screen user interface 492 (e.g., since the home screen user interface is the last displayed user interface). In some embodiments, the coversheet user interface has responses to user inputs in a manner analogous to those described with respect to the wake screen user interface 490.

In some embodiments, an application user interface of a respective application can be displayed in response to user inputs in a number of scenarios, such as tapping on a widget displayed in the home screen user interface or the widget user interface; tapping on an application icon displayed in the home screen, in the widget user interface, in the search result or recommended application portion of the search user interface, in the application library user interface or in the search results provided in a search in the application library user interface; tapping on a notification on the wake screen user interface or in the notification history; tapping on a representation of an application in the multitasking user interface; or selecting a link to an application in a user interface of another application (e.g., a link to a document, a link to a phone number, a link to a message, a link to an image, and other types of links). In some embodiments, a user interface of a single application is displayed in a full-screen mode. In some embodiments, user interfaces of two or more applications are displayed in a concurrent-display configuration, such as in a side-by-side display configuration where the user interfaces of the applications are displayed adjacent to one another to fit within the display, or in an overlay display configuration where the user interface of a first application is displayed in the full-screen mode while the user interfaces of other applications are overlaid on portion(s) of the user interface of the first application (e.g., in a single stack or separately on different portions).

In some embodiments, while displaying a user interface of an application, an upward swipe gesture (e.g., upward swipe gesture 4111a, or another upward swipe gesture) that starts from the bottom edge of the application user interface (e.g., messages user interface 493, or another user interface of an application) or another dismissal input or home gesture causes (4111a-1, or 4111a-2) the multifunction device to dismiss the currently displayed application user interface, and display either the home screen user interface (e.g., shown as transition 4111a-1) or the multitasking user interface (e.g., shown as transition 4111a-1) depending on the characteristics of the upward swipe gesture. In some embodiments, while displaying home screen user interface 492, an upward swipe gesture 4111b that starts from the bottom edge of the home screen user interface causes (4111b) the multifunction device to dismiss the currently displayed home screen user interface 492, and display the multitasking user interface 488.

In some embodiments, a horizontal swipe gesture in the leftward and/or rightward direction that is performed within a bottom portion of the application use interface(s) causes the multifunction device to switch to another previously displayed application user interface of a different application. In some embodiments, the same swipe gesture that starts from the bottom portion of a respective application user interface is continuously evaluated, to determine and update an estimated destination user interface among the multitasking user interface 488, the home screen user interface 492, or a user interface of a previously displayed application, based on the characteristics of the swipe gesture (e.g., location, speed, direction, and/or change in one or more of the above), and a final destination user interface is displayed in accordance with the estimated destination user interface at the termination of the swipe gesture (e.g., lift off of the contact, reduction in intensity of the contact, a pause in movement, and/or another type of change in the input).

In some embodiments, while displaying an application user interface of a respective application (or displaying application user interfaces of multiple applications in a concurrent-display configuration), a downward swipe gesture 4108b that starts from the top edge of the application user interface(s) causes (4108b) the multifunction device to display the coversheet user interface 496 (FIG. 4C1) (or the wake screen user interface 490 in FIG. 4C2) over the application user interface(s). The multifunction device dismisses the coversheet user interface 496 (or the wake screen user interface 490) and redisplays the application user interface(s) in response to an upward swipe gesture that starts from the bottom edge of the coversheet user interface (or another dismissal input).

In some embodiments, as shown in FIG. 4C2, a downward swipe gesture 4109b that starts from the static status region 4022 on the display cause (4109b) the multifunction device to display the control user interface 498 over the application user interface(s), and an upward swipe gesture 4110a that starts from the bottom edge of the control user interface 498 (or another dismissal input) dismisses the control user interface 498 and causes (4110a-2) the application user interfaces to be redisplayed (e.g., or the last displayed user interface that is displayed before displaying the control user interface 498).

In some embodiments, rotation of the display causes the multifunction device to display a different version of the currently displayed user interface (e.g., application user interface, home screen user interface, wake screen user interface, control user interface, notification user interface, widget user interface, application library user interface, and other user interfaces described with respect to FIGS. 4C1-4C2) that have a differently layout (e.g., landscape version vs. portrait version). In some embodiments, rotation of the display has no effect on the orientation of the respective user interface that is currently displayed.

The above description of the navigation between user interfaces and exact appearances and components of the various user interfaces are merely illustrative and may be implemented with variations in various embodiments described herein. In addition, the transitions between pairs of user interfaces illustrated in FIGS. 4C1-4C2 are only a subset of all transitions that are possible between different pairs of user interfaces illustrated in FIGS. 4C1-4C2, and a transition to a respective user interface may be possible from any of multiple other user interfaces, in accordance with a respective user input of a same type, directed to a same interaction region of the display, and/or in accordance with a different type of input or directed to a different interactive region, in accordance with various embodiments.

### User Interfaces and Associated Processes

Attention is now directed towards embodiments of user interfaces (“UI”) and associated processes that may be implemented on an electronic device (or computer system more generally), such as computer system 100 or device 300, with a display, a touch-sensitive surface, (optionally) one or more tactile output generators for generating tactile outputs, and (optionally) one or more sensors to detect intensities of contacts with the touch-sensitive surface.

FIGS. 5A-5AT illustrate example user interfaces for automatically displaying a customizable user interface when specific criteria are met. FIGS. 6A-6AN illustrate example user interfaces for switching between, interacting with, and configuring different operational modes (e.g., ambient modes). FIGS. 7A-7V illustrate example user interfaces for interacting with and configuring a customizable user interface. FIGS. 8A-8K illustrate example user interfaces for interacting with different user interfaces of, and switching between, different operational modes (e.g., ambient modes). FIGS. 9A-9AA illustrate example user interfaces for automatically activating a flashlight function of the computer system 100 when specific criteria are met. FIGS. 10A-10L are flow diagrams of a method for automatically displaying a customizable user interface when specific criteria are met. FIGS. 11A-11G are flow diagrams of a method for switching between, interacting with, and configuring different operational modes (e.g., ambient modes). FIGS. 12A-12D are flow diagrams of a method for interacting with and configuring a customizable user interface. FIGS. 13A-13J are flow diagrams of a method for interacting with different user interfaces of, and switching between, different operational modes (e.g., ambient modes). FIGS. 14A-14G are flow diagrams of a process for automatically activating a flashlight function of the computer system 100 when specific criteria are met. FIGS. 15A-15Q illustrate example user interfaces for updating displayed content when presence criteria are met. FIGS. 16A-16F are flow diagrams of a method for updating displayed content when presence criteria are met. The user interfaces in these figures are used to illustrate the processes described below, including the processes in FIGS. 10A-10L, 11A-11G, 12A-12D, 13A-13J, 14A-14G, and 16A-16F. For convenience of explanation, some of the embodiments will be discussed with reference to operations performed on a device with a touch-sensitive display system 112. In such embodiments, the focus selector is, optionally: a respective finger or stylus contact, a representative point corresponding to a finger or stylus contact (e.g., a centroid of a respective contact or a point associated with a respective contact), or a centroid of two or more contacts detected on the touch-sensitive display system 112. However, analogous operations are, optionally, performed on a device with a display 450 and a separate touch-sensitive surface 451 in response to detecting the contacts on the touch-sensitive surface 451 while displaying the user interfaces shown in the figures on the display 450, along with a focus selector.

FIGS. 5A-5AT illustrate example user interfaces for automatically displaying a customizable user interface when specific criteria are met, in accordance with some embodiments.

In FIG. 5A, a computer system 100 is in a low power state. In some embodiments, the low power state is an off state, where nothing is displayed by the portable multifunction device. In some embodiments, as in FIG. 5A, in the low power state, some user interface elements such as a current time 5002, a widget 5004, a widget 5006, and a widget 5008 are displayed, but with a reduced prominence (e.g., brightness) as compared to when the computer system 100 is not in the low power state. In some embodiments, displaying user interface elements with reduced prominence, is referred to as an “always on” display.

While the computer system 100 is in the low power state, the computer system 100 detects a user input 5010 (e.g., a tap input) directed to a touch-sensitive surface (e.g., touchscreen) of the computer system 100.

In FIG. 5B, in response to detecting the user input 5010, the computer system 100 displays a wake user interface (e.g., the same wake user interface as the wake screen user interface 490 in FIG. 4C1). The wake user interface includes the current time 5002, the widget 5004, the widget 5006, and the widget 5008. The wake user interface also includes a notification 5014 and a notification 5016 (e.g., that are not displayed while the computer system 100 is in the low power state). While displaying the wake user interface, the computer system 100 detects a user input 5018 (e.g., a leftward swipe input).

In FIG. 5C, in response to detecting the user input 5018, the computer system 100 displays a camera user interface. The camera user interface includes a preview of the current field of view of a camera of the computer system 100, and also includes affordances for switching to a video recording function of the computer system 100, for taking a photo, and for switching to the field of view of a different camera of the computer system 100. While displaying the camera user interface, the computer system 100 detects a user input 5020 (e.g., an upward swipe gesture, that begins from a bottom edge of the computer system 100).

In FIG. 5D, in response to detecting the user input 5020, the portable multifunction device redisplays the wake user interface (e.g., the wake user interface shown in FIG. 5B). While displaying the wake user interface, a user can interact with different elements of the wake user interface to perform different functions of the computer system 100. For example, in response to a user input 5022 on a region 5021. In response to a user input 5024 (e.g., a downward swipe from an upper right corner of the touch-sensitive display of the computer system 100), the computer system 100 displays a control center user interface. In response to a user input 5026 (e.g., a tap input) directed to the widget 5006, the computer system 100 displays a user interface corresponding to an application associated with the widget 5006. In response to detecting a user input 5028 (e.g., a tap input) directed to the notification 5014, the computer system 100 displays additional content associated with the notification 5014, and/or displays additional options for interacting with the notification 5014 (e.g., an option for opening an application associated with the notification 5014). In response to detecting a user input 5030 (e.g., a leftward or rightward swipe input) directed to the notification 5016, the computer system 100 displays an affordance for opening an application associated with the notification 5016, an affordance for adjusting one or more notification settings, and/or an affordance for clearing or dismissing the notification 5016.

In response to detecting a user input 5032 (e.g., a downward swipe input), the computer system 100 displays a search user interface (e.g., the optionally includes one or more suggested applications or functions). In response to detecting a user input 5034 (e.g., an upward swipe input), the computer system 100 displays a notification history (e.g., that includes one or more additional notifications, other than the notification 5014 and the notification 5016). In some embodiments, the user input 5032 and/or the user input 5034 can also be used to navigate between (e.g., scroll through) display of additional notifications (e.g., if the number of notifications that are available for display is greater than a maximum number of notifications that can be concurrently displayed by the computer system 100).

In response to detecting a user input 5036 (e.g., a leftward swipe input) in a region of the wake user interface that is not occupied by a notification (e.g., the notification 5014 or the notification 5016), the computer system 100 displays the camera user interface (e.g., as shown in FIGS. 5B-5C, and as discussed above). In response to detecting a user input 5038 (e.g., a rightward swipe input) in a region of the wake user interface that is not occupied to a notification, the computer system 100 displays a widget user interface (e.g., that includes one or more widgets of the computer system 100, and which are optionally configured by a user of the computer system 100).

In response to detecting a user input 5040 (e.g., an upward swipe input from a bottom edge of the computer system 100, and as shown in FIG. 5E, the computer system 100 displays an authentication user interface. In some embodiments, as in FIG. 5E, the authentication user interface includes one or more affordances for entering a password or passcode that authenticates the user of the computer system 100. In some embodiments, the computer system 100 authenticates the user through another method, such as through biometrics such as facial recognition or by scanning a fingerprint of the user. The computer system 100 optionally still displays the one or mor affordances for entering a password or passcode, which provides an alternative authentication mechanism to the biometric authentication (e.g., in case the user's face is obscured by a mask or helmet, or the user is wearing gloves).

In FIG. 5F, if the user successfully authenticates, the computer system 100 displays a home user interface. The home user interface includes application icons that can be interacted with to launch respective applications of the computer system 100. The home user interface can also include one or more widgets, which displays application information without needing to launch or open a respective application. The home user interface includes a settings icon 5043 (e.g., for accessing and/or configuring one or more settings of the computer system 100). In some embodiments, when the settings icon 5043 is activated by a user input 5041, the computer system 100 displays a settings user interface for configuring different modes of the computer system 100 (e.g., an ambient mode of the computer system 100). An exemplary settings user interface is described in further detail below, with reference to FIG. 5AL and FIG. 5AM.

In FIG. 5G, the computer system 100 displays the wake user interface (e.g., because the user did not interact with the computer system 100 for a threshold amount of time, causing the computer system 100 to revert to a “locked” (or unauthenticated) state of the computer system 100; or because the user manually locks the computer system 100). In FIG. 5G, the computer system 100 is not connected to a charging source. The display of the computer system 100 begins in a portrait orientation, and is rotated to a landscape orientation. Since the computer system 100 is not connected to a charging source, the computer system 100 maintains display of the wake user interface.

In some embodiments (e.g., as shown in FIG. 5G), the computer system 100 is not configured to display the wake user interface with a landscape orientation, so the computer system 100 maintains display of the wake user interface with the portrait orientation (e.g., despite the display of the computer system 100 having been rotated into a landscape orientation).

FIG. 5H is an alternative to FIG. 5G, and shows the computer system 100 with different dimensions (e.g., dimensions in which the width and height of the display of the computer system 100 are substantially similar, which enables the computer system 100 to be more effectively operated while the display of the computer system 100 is in a landscape orientation). In FIG. 5H, the computer system 100 is again not connected to a charging source. The display of the computer system 100 is rotated to a landscape orientation, and the computer system 100 maintains display of the wake user interface, but with a landscape orientation (e.g., as compared to the portrait orientation in FIG. 5G).

FIG. 51 shows an alternative to FIG. 5G. In contrast to FIG. 5G, in FIG. 51, the computer system 100 is connected to a charging source via a physical charger 5044. In response to detecting that the physical charger 5044 is connected, the computer system 100 displays an indicator 5042 that the computer system 100 is charging. For example, the indicator 5042 includes text that indicates the computer system 100 is charging, as well as a current battery level (e.g., 38%).

In FIG. 5J, after a threshold amount of time has elapsed (e.g., 1 second, 2 seconds, 5 seconds, or 10 seconds), the computer system 100 ceases to display the indicator 5042. In some embodiments, the computer system 100 displays an animated transition of the indicator 5042 transitioning (e.g., collapsing into) a region 5046, or into a battery indicator in a status region (e.g., the upper right corner of the display of the computer system 100). Since the display of the computer system 100 remains in the portrait orientation while connected to the charging source via the physical charger 5044, the computer system 100 maintains display of the wake user interface.

FIG. 5K shows an alternative to FIG. 5I, using a wireless charger 5048 instead of the physical charger 5044. FIG. 5K illustrates various views of the computer system 100 (while the display of the computer system 100 is in the portrait orientation), which show the location of the wireless charger 5048 relative to the computer system 100. In response to detecting that the computer system 100 is connected to a charging source via the wireless charger 5048, the computer system 100 displays an indicator 5050. In some embodiments, the indicator 5050 is the same as the indicator 5042 of FIG. 5J (e.g., the computer system 100 displays the same indicator when the computer system 100 is charging, regardless of whether the computer system 100 is charging via a physical cable or a wireless charger). In some embodiments, the indicator 5050 has a different appearance as compared to the indicator 542 of FIG. 5J (e.g., to provide visual feedback regarding the specific method by which the computer system 100 is being charged).

FIG. 5L shows another alternative to FIG. 5I, using a long-range wireless charger 5052. In some embodiments, the long-range wireless charger 5052 includes at least one antenna that is configured to transmit (e.g., and/or focus) energy to the computer system 100 (e.g., without requiring the computer system 100 to be in close proximity to the long-range wireless charger 5052). In response to detecting that power is being received from the long-range wireless charger 5052, the computer system 100 displays an indicator 5054. In some embodiments, the indicator 5054 is the same as the indicator 5042 (e.g., of FIG. 5J) and/or the indicator 5050 (e.g., of FIG. 5K). In some embodiments, the indicator 5054 is distinct from the indicator 5042 and the indicator 5050.

FIGS. 5J-5L show different ways through which the computer system 100 can be connected to a charging source (e.g., charged). For ease of discussion, the descriptions below will make reference to a charging source 5056, which represents any suitable method of connecting the computer system 100 to a charging source (e.g., wired charging, wireless charging, and/or long-range wireless charging, as shown in FIGS. 5J-5L). The descriptions below are understood to be applicable to any (or all) of the variations for how the computer system 100 is connected to a charging source.

FIG. 5M shows that the computer system 100 is connected to the charging source 5056, and that the display of the computer system 100 is in a landscape orientation. Since these two conditions are both concurrently met, the computer system 100 displays a clock user interface 5058 (e.g., an ambient mode user interface of an ambient mode that the computer system 100 operates in, in response to detecting that both conditions are concurrently met). In some embodiments, the computer system 100 further requires that the computer system 100 is operating in a restricted mode (e.g., a low-power mode or a locked mode) in order to display the clock user interface 5058. If the computer system 100 is connected to the charging source 5056 and the display of the computer system 100 is in the landscape orientation, but the computer system 100 is not operating in the restricted mode, the computer system 100 does not display the clock user interface 5058 (e.g., or enter the ambient mode). If the computer system 100 enters the restricted mode (e.g., in response to detecting that a user has locked the computer system 100 and/or performed user inputs to operate the computer system 100 in the low-power mode) (e.g., while the computer system 100 remains connected to the charging source 5056, and while the display of the computer system 100 remains in the landscape orientation), the computer system 100 displays the clock user interface 5056 (e.g., and enters the ambient mode) (e.g., in response to detecting that the computer system 100 has entered the restricted mode).

In some embodiments, the clock user interface 5058 is user interface that is displayed when a specific mode (e.g., an “ambient mode”) of the computer system 100 is active. In some embodiments, the specific mode is a mode where the computer system 100 is configured to (e.g., continually) display content that is relevant to a user of the computer system 100, and without any user input.

In some embodiments, the computer system 100 requires additional criteria be met, in addition to the two conditions described above, in order to display the clock user interface 5058 (e.g., an ambient mode user interface). For example, the computer system 100 may also require that the computer system 100 is in a locked (or other restricted) state (e.g., the computer system 100 will not transition to displaying the clock user interface 5058 if the computer system 100 was unlocked and displaying a home screen user interface of the computer system 100 prior to satisfying the two conditions described in the previous paragraph). For example, the computer system 100 may also require that the computer system 100 is not in (e.g., active) communication with a vehicle (e.g., is not connected to a vehicle, such as a car, via a wireless communication protocol such as Bluetooth). For example, the computer system 100 may also require that the computer system 100 does not detect more than a threshold amount of movement (e.g., that the computer system 100 is not being carried by a walking or running user, or that the computer system 100 is not in a moving vehicle). In some embodiments, if the computer system 100 detects more than the threshold amount of movement within a threshold amount of time while displaying the clock user interface 5058 (e.g., while the computer system 100 is operating in the ambient mode), the computer system 100 ceases to display the clock user interface 50508 (e.g., the computer system 100 automatically ceases to operate in the ambient mode).

In FIG. 5M, the computer system 100 displays an indicator 5060 (e.g., in response to detecting that the computer system 100 is connected to the charging source 5056). In some embodiments, and as shown in in FIG. 5M, the indicator 5060 is distinct from the indicator 5042 (e.g., of FIG. 5J), the indicator 5050 (e.g., of FIG. 5K), and the indicator 5054 (e.g., of FIG. 5L). This provides visual feedback regarding whether the computer system 100 is currently in the ambient mode (e.g., or a normal mode of the computer system 100). In some embodiments, the indicator 5060 is the same as at least one of the indicator 5042, the indicator 5050, and/or the indicator 5054.

In some embodiments, if the ambient mode has never been active for the computer system 100 (e.g., the computer system 100 recently received a system update that enables activation of the ambient mode), the computer system 100 displays an additional description of the ambient mode (e.g., the specific ambient mode that is currently active, or regarding the single ambient mode available for the computer system 100). In some embodiments, the additional description is displayed as a pop-up window, a banner, or other user interface, displayed overlaid over at least a portion of the clock user interface 5058 in FIG. 5M). In some embodiments, the additional description is displayed prior to displaying the clock user interface 5058. In some embodiments, the additional description includes instructions for activating the ambient mode (e.g., the correct orientation of the display of the computer system 100 and/or the requirement for the computer system 100 to be connected to the charging source 5056). In some embodiments, the additional information is displayed only the first time that the computer system 100 enters an ambient mode (e.g., or the single ambient mode), and is not displayed each time the computer system 100 enters an ambient mode (e.g., or the single ambient mode).

In FIG. 5N, after a threshold amount of time (e.g., 1 second, 2 seconds, 5 seconds, or 10 seconds), the computer system 100 ceases to display the indicator 5060. In some embodiments, the computer system 100 ceases to display the indicator 5060 and displays an indicator 6062. In some embodiments, the computer system 100 displays an animated transition of the indicator collapsing into the indicator 6062.

In response to detecting a user input 6062 (e.g., a tap input) directed to the indicator 6062, and as shown in FIG. 50, the computer system 100 redisplays the indicator 5060. In some embodiments, the computer system 100 instead displays additional power and/or battery information (e.g., other than, or in addition to, the information displayed in the indicator 5060). In FIG. 5P, after the threshold amount of time, the computer system 100 ceases to display the (redisplayed) indicator 5060.

In some embodiments, as shown in FIGS. 5Q-5X, the computer system 100 displays a contextually-relevant user interface while the computer system 100 is in the ambient mode. In some embodiments, the computer system 100 has different ambient modes, such as: (1) a time or clock ambient mode, (2) a widget ambient mode, (3) a home control ambient mode, (4) a voice memo ambient mode, (5) an ambient sound ambient mode, and/or (6) a visual media ambient mode. In some embodiments, the computer system 100 has only one ambient mode, but can display different categories of user interfaces (e.g., “ambient mode user interfaces) for the single ambient mode of the computer system 100 (e.g., a first category of ambient mode user interfaces is time/clock ambient mode user interfaces, a second category of ambient mode user interfaces is widget ambient mode user interfaces, a third category of ambient mode user interfaces is home control ambient mode user interfaces, a fourth category of ambient mode user interfaces is voice memo ambient mode user interfaces, a fifth category of ambient mode user interfaces is ambient sound ambient mode user interfaces, and/or a sixth category of ambient mode user interfaces is visual media ambient mode user interfaces).

In some embodiments, the user of the computer system 100 can configure settings for different ambient modes, or the single ambient mode, via a settings user interface. For example, FIG. 5AL shows a settings user interface 5136 for configuring settings of an ambient mode of the computer system 100. In some embodiments, the computer system 100 displays the settings user interface 5136 in response to detecting one or more user inputs that launch a settings application and/or open a settings user interface of the computer system 100 (e.g., the user input 5041 directed to the settings icon 5043 on the home screen user interface of the computer system 100, in FIG. 5F).

The settings user interface 5136 includes an “Ambient Mode” option 5140 for enabling or disabling the ambient mode (e.g., whether or not the computer system 100 will operate in the ambient mode when certain criteria are detected). In some embodiments, the “Ambient Mode” option 5140 is a toggle (e.g., for enabling or disabling the ambient mode, via a user input 5152). In some embodiments, the “Ambient Mode” option 5140 includes additional options for specifying one or more criteria for when the computer system 100 operates in the ambient mode. In some embodiments, the one or more criteria include default criteria (e.g., that the display of the computer system 100 is in a landscape orientation, and/or that the computer system 100 is connected to the charging source 5056). In some embodiments, the default criteria are not configurable (e.g., must always be met), but in some embodiments, the default criteria can be replaced with other user-specified criteria (e.g., to provide greater flexibility to the user in when the ambient mode is active). In some embodiments, the “Ambient Mode” option 5140 also includes one or more additional options for configuring ambient mode user interfaces of the ambient mode. For example, the user can configure which ambient mode user interface (and/or a category of ambient mode user interfaces) that is displayed in which contexts. The user can also configure a default ambient mode user interface that is initially displayed when the computer system 100 enters the ambient mode (e.g., or a default ambient mode user interface for a particular category of ambient mode user interface that is initially displayed when the computer system 100 displays an ambient mode user interface of that particular category).

The settings user interface 5136 includes an “Always On” option 5142 for enabling or displaying (e.g., via a user input 5154 on a toggle of the “Always On” option 5142) an “always-on state (e.g., a state in which at least some user interface elements are always displayed, but with reduced visual prominence, while the computer system 100 operates in a reduced power mode (e.g., a sleep mode)) for an ambient mode user interface.

The settings user interface 5136 includes a “Bump to Wake” option 5146, for enabling or disabling (e.g., via a user input 5158 on a toggle of the “Bump to Wake” option 5146) waking of the computer system 100 (e.g., from a sleep or other low power state) in response to detecting vibration of the computer system 100 (e.g., vibrations that exceed a threshold amount of vibration) (e.g., vibrations corresponding to an external impact on a supporting surface of the computer system 100, or direct impact with the computer system 100 itself).

The settings user interface 5136 includes an “Indicator” option 5148, for enabling or disabling (e.g., via a user input 5160 on a toggle of the “Indicator” option 5148) display of notifications (e.g., notification alerts) while the computer system 100 is operating in the ambient mode. In some embodiments, when the “Indicator” option is toggled on, the computer system 100 displays a visual indicator (e.g., a dot, a banner, or another visual representation) of incoming and/or missed notifications. In some embodiments, the visual indicator includes a preview of notification content corresponding to a respective notification.

The settings user interface 5136 includes a “Night Mode” option 5144, for enabling or disabling a “night mode” (e.g., a mode in which some user interface elements are displayed with a different (e.g., reduced, simplified, dimmed, tuned down, and/or less saturated) appearance (e.g., as compared to a normal or default appearance for the user interface element(s))) for an ambient mode user interface. In some embodiments, the “Night Mode” option 5144 allows the user to configure additional options relating to the night mode and/or ambient mode of the computer system 100. In response to detecting the user input 5156 directed to the option 5144, the computer system 100 displays a settings user interface 5162 (e.g., a settings user interface for configuring the night mode of the computer system 100).

FIG. 5AM shows the settings user interface 5162 for configuring the night mode of the computer system 100. The settings user interface 5162 includes an option 5164 for enabling or disabling (e.g., via a user input 5168 on a toggle of the option 5164) the night mode of the computer system 100. The settings user interface 5162 includes a “Motion to Wake” option 5166, for enabling or disabling (e.g., via a user input 5170 on a toggle of the “Motion to Wake” option 5166) waking of the device when motion is detected while the computer system 100 is operating in the night mode.

The settings user interface 5162 includes a “Back” affordance 5172 (e.g., that when activated, causes the computer system 100 to redisplay the settings user interface 5136 of FIG. 5AL). The settings user interface 5136 includes a “Settings” affordance 5150 (e.g., which when activated, causes the computer system 100 to display or redisplay a settings user interface of the computer system 100 (e.g., a general settings user interface for configuring one or more settings of the computer system 100)).

FIGS. 5Q-5X illustrate exemplary user interfaces corresponding to exemplary ambient modes. Greater detail regarding these exemplary ambient modes, as well as user inputs for switching between ambient modes, switching between variations of the same ambient mode, and/or interacting with different ambient modes, are described in greater detail with reference to FIGS. 6A-6AJ and FIGS. 7A-7V, FIGS. 9A-9AA, and FIGS. 15A-15Q.

For case of discussion, the descriptions below (including the descriptions of FIGS. 6A-6AN, FIGS. 7A-7V, FIGS. 8A-8K, FIGS. 9A-9AA, and FIGS. 15A-15Q) make reference to different ambient modes (e.g., a time or clock ambient mode, a widget ambient mode, a home control ambient mode, a voice memo ambient mode, an ambient sound ambient mode, and/or a visual media ambient mode), to provide an intuitive categorization of ambient mode user interfaces (e.g., variants of the time or clock ambient mode include varied methods of displaying time-related information and/or different types of clocks and/or clock faces, while variants of the widget ambient mode include varied methods of displaying widgets). In some embodiments, however, there is only a single ambient mode (e.g., the ambient mode is either active, or not active, for the computer system 100), and all of the described user interfaces (e.g., a clock user interface corresponding to a time or clock ambient mode; a widget user interface corresponding to a widget ambient mode; a voice memo user interface corresponding to a voice memo ambient mode; an ambient sound user interface corresponding to an ambient sound ambient mode; and a media user interface corresponding to a visual media ambient mode) are variants of ambient mode user interfaces for the (single) ambient mode of the computer system 100 (e.g., could also be described as: a clock user interface variant of the ambient mode; a widget user interface variant of the ambient mode); a voice memo user interface (variant) of the ambient mode; an ambient sound user interface variant of the ambient mode; and a media user interface variant of the ambient mode).

In some embodiments, the transitions between the figures of FIGS. 5Q-5X may happen automatically (e.g., in response to certain context-specific criteria being met, such as time-based criteria or location-based criteria), but FIGS. 5Q-5X also show optional user inputs (e.g., upward swipe inputs) for manually switching between different variations of a respective ambient mode, or optional user inputs (e.g., leftward swipe inputs) for switching between different ambient modes. In some embodiments, even when the computer system 100 automatically switches between one or more ambient modes, a user can still manually adjust the ambient mode (e.g., via the optional user inputs of FIGS. 5Q-5X).

FIG. 5Q shows a clock user interface 5068 (e.g., that corresponds to a time or clock ambient mode). In some embodiments, the clock user interface 5068 is one variation of a clock user interface for the time or clock ambient mode. The clock user interface 5058 is another variation of a clock user interface for the time or clock ambient mode. In some embodiments, the clock user interface 5068 is displayed in response to detecting a user input 5066 (in FIG. 5P).

In some embodiments, the clock user interface 5058 is displayed automatically based on time-based criteria (e.g., a time of day). For example, in FIG. 5Q, the current time is 1:30 PM (e.g., “day time”), and the computer system 100 displays the clock user interface 5068 during the “day time” (e.g., a user-specified time period corresponding to day time hours, or a predefined time period based at least in part on a sunrise and/or sunset for a current location of the computer system 100). In some embodiments, the clock user interface 5058 is displayed based on lighting criteria (e.g., the computer system 100 determines whether it is “day time” or “night time” based on the amount of ambient light detectable by one or more sensors of the computer system 100).

FIG. 5R shows a clock user interface 5072 (e.g., another variation of a clock use interface for the time or clock ambient mode). In some embodiments, the clock user interface 5072 displays the current time with a different level of emphasis (e.g., and/or detail). For example, in FIG. 5R, the current time is 1:25 AM, and the computer system 100 displays only a “1” to indicate the current hour (e.g., as opposed to displaying both hour and minutes, as in the clock user interface 5068 for the “day time” context).

In some embodiments, and as discussed in further detail with reference to FIGS. 9A-9AA, the clock user interface 5072 is instead a user interface for a different ambient mode or different category of ambient mode user interface (e.g., the time or clock ambient mode is different from a “night clock” or sleep ambient mode). In some embodiments, the clock user interface 5072 is displayed while a sleep mode (e.g., a “sleep” focus mode) is active for the computer system 100.

FIG. 5S shows a widget user interface 5078 (e.g., that corresponds to a widget ambient mode of the computer system 100). In some embodiments, the widget user interface 5078 is referred to as an “infograph” user interface (e.g., and the widget ambient mode is referred to as an “infograph ambient mode”). In some embodiments, the widget user interface 5078 is displayed in response to detecting a user input 5076 in FIG. 5R (e.g., a leftward swipe input). The widget user interface 5078 is contextually displayed when a particular focus mode (e.g., a “work” focus mode) of the computer system 100 is active. In some embodiments, while a focus mode of the computer system 100 is active, the computer system 100 moderates how content (e.g., notifications, messages, calendar events, and/or other application content) is displayed (e.g., displays a subset of available content) and/or generated (e.g., suppressing some notifications while the focus mode is active). In some embodiments, each respective focus mode of the computer system 100 modifies how content is displayed and/or generated in a respective manner (e.g., different focus modes moderate how content is displayed and/or generated differently).

In some embodiments, the widget user interface 5078 is instead displayed when the computer system 100 detects that the computer system 100 is at a work location (e.g., a location corresponding to a known office of the user of the computer system 100). In some embodiments, the widget user interface 5078 is displayed while the “work” focus mode is active for the computer system 100, and the “work” focus mode is active while the computer system 100 is at the “work” location.

The widget user interface 5078 includes a calendar widget on the left, and a notes widget on the right. In some embodiments, a user can interact with the widget user interface 5078 (e.g., without leaving the widget ambient mode). For example, in response to detecting a user input 5080 (e.g., an upward/downward swipe in the region occupied by the calendar widget), the computer system 100 ceases to display the calendar widget and displays a different widget (e.g., other than the calendar widget and the notes widget) of the computer system 100. Similarly, in response to detecting a user input 5082 (e.g., an upward/downward swipe in the region occupied by the notes widget, the computer system 100 ceases to display the notes widget and displays a different widget. In some embodiments, the user can switch between a first subset of widgets via the left side of the widget user interface 5078, and the user can switch between a second subset of widgets (e.g., that is different than the first subset of widgets) via the right side of the widget user interface 5078.

In some embodiments, different variations of widget user interfaces for the widget ambient mode include different available widgets (e.g., different subsets of widgets of the computer system 100). For example, the widget user interface 5078 includes a calendar widget and a notes widget, and another widget user interface may include one or more of a weather widget, a stock widget, a stopwatch widget, or another widget available on the computer system 100.

In some embodiments, each widget user interface for the widget ambient mode has access to each available widget (e.g., or at least a subset of widgets) of the computer system 100, and the variation in the different widget user interfaces is with respect to the layout and/or presentation of the widgets. For example, one variation of a widget user interface may display only a single widget, instead of two widgets side-by-side as in the widget user interface 5078 of FIG. 5S. Another variation of a widget user interface may display three or more widgets, instead of the two widgets that are concurrently displayed in the widget user interface 5078 of FIG. 5S. Another variation of a widget user interface may display widgets arranged in a vertical fashion, instead of the horizontal fashion of the widget user interface 5078 of FIG. 5S. In some embodiments, different widget user interfaces (e.g., including different widgets) are displayed depending on the context. For example, in FIG. 5S, the widget user interface 5078 includes a calendar widget and a notes widget while a “work” focus mode is active for the computer system 100. When a different focus mode (e.g., a “home” focus mode, as in FIG. 5T) is active, the computer system 100 displays a different widget user interface that includes different widgets (e.g., a stocks widget and a weather widget, for example, as shown in FIG. 7C).

FIG. 5T shows a home control user interface 5086 (e.g., corresponding to a home control ambient mode). In some embodiments, the home control user interface 5086 is displayed in response to detecting a user input 5084 in FIGS. 5S (e.g., a leftward swipe input). The home control user interface 5086 is contextually displayed while a “home” focus mode of the computer system 100 is active. In some embodiments (e.g., as shown in FIG. 5U), the home control user interface 5086 is instead contextually displayed when the computer system 100 detects that the computer system 100 is at a preset location (e.g., a home location).

The home control user interface 5086 includes a climate affordance 5088, a lights affordance 5090, a security affordance 5092, an audio/visual affordance 5094, and a water affordance 5096. The affordances of the home control user interface 5086 allow a user to adjust settings for one or more features (e.g., a smart thermostat, a smart light, a smart speaker, and/or a smart television) of the user's home via the computer system 100.

In some embodiments, different variations of home control user interfaces for the home control ambient mode provide access to different affordances (and/or subset of affordances). For example, one variation of a home control user interface may include a user-curated list (e.g., favorite) affordances for frequently adjusted features. For example, different variations of home control user interfaces include affordances for adjusting settings for features within a particular region of the user's home (e.g., different variations of home control user interfaces correspond to different rooms of the user's home).

In some embodiments, as shown in FIG. 5U, the user can interact with the home control user interface 5088. The computer system 100 detects a user input 5098 directed to the lights affordance 5090.

In FIG. 5V, in response to detecting the user input 5098, the computer system 100 displays a home control user interface 5100. The home control user interface 5100 includes affordances for adjusting light-related settings. For example, the home control user interface 5100 includes an affordance 5106 that allows a user to adjust settings for a desk light in the office of the user's home (e.g., in response to detecting a user input 5108 directed to the affordance 5106). The home control user interface also includes an affordance 5102 allows a user to adjust settings for lights in an entryway region of the user's home, and an affordance 5104 allows a user to adjust settings for lights in an office of the user's home.

In some embodiments, as shown in FIGS. 5W-5X, the context-specific criteria include a criterion that depends on how the computer system 100 is being charged. For example, in FIG. 5P, the computer system 100 could be charging via a physical charger (e.g., the physical charger 5044 in FIGS. 5I-5J), and the computer system 100 displays the clock user interface 5058. In FIG. 5X, the computer system 100 is charging via the wireless charger 5048 (e.g., as shown in FIG. 5W), and the computer system 100 displays a clock user interface 5110 (e.g., which is different from the clock user interface 5058 of FIG. 5P).

In FIG. 5Y, the computer system 100 displays an indicator 5112, which corresponds to an active timer (e.g., of a clock application of the computer system 100). The indicator 5112 includes an icon (e.g., a clock, timer, or stopwatch icon) that provides visual feedback regarding an application and/or function represented by the indicator 5112, and the indicator 5112 includes a current time for the active timer (e.g., 5:38 remaining for a timer that is counting down). While displaying the indicator 5112, the computer system 100 detects a user input 5114 (e.g., a tap input) directed to the indicator 5112.

In response to detecting the user input 5114, and as shown in FIG. 5Z, the computer system 100 displays a user interface 5116. The user interface 5116 includes the current time for the active timer (5:38 remaining), and also includes a pause affordance for pausing the active timer, and a stop affordance for stopping or cancelling the active timer. In some embodiments, the computer system 100 displays an animated transition of the indicator 5112 expanding (e.g., downward and/or outwards) into the user interface 5116.

In FIG. 5AA, the display of the computer system 100 is rotated from a portrait orientation to a landscape orientation. Since the display of the computer system 100 is rotated into the landscape orientation, and the computer system 100 is connected to power (e.g., as shown by the charger 5136, the computer system 100 displays a user interface 5118. In some embodiments, the user interface 5118 is a different appearance of the user interface 5116 (e.g., but displayed with a different appearance and/or with increased visual prominence).

In some embodiments, the user interface 5118 takes up the entire display of the computer system 100 (e.g., the user interface 5118 is a full-screen user interface). Similar to the user interface 5116 of FIG. 5Z, the user interface 5118 includes a pause affordance for pausing the active timer, a stop affordance for stopping or cancelling the active time, and the current time for the active timer (5:38 remaining). Additionally, the user interface 5118 also includes a (non-numeric) visual representation of the current time for the active timer. The grey region of the user interface 5118 represents the amount of time that has elapsed since the active timer was started, while the white region of the user interface 5118 represents the remaining time left before the active timer expires. In FIG. 5AA, the active timer was configured to count down starting from 10 minutes, and 5 minutes and 38 seconds remain for the active timer. The visual indication shows a grey region that is just slightly smaller than the white region (e.g., because 5:38 indicates that there is just over half of the total time for the active timer). In some embodiments, the visual indication is updated as the timer progresses (e.g., in real-time, or at predetermined time intervals). For example, the grey region continues to expand further and further to the right, as the timer progresses, to indicate how close the timer is to expiring.

In some embodiments, the user interface 5118 displays content corresponding to a plurality of active timers (e.g., visual representations of and/or controls for interacting with a plurality of active timers). In some embodiments, the content corresponding to each active timer is concurrently displayed in the user interface 5118 (e.g., stacked vertically, or arranged horizontally).

While displaying the user interface 5118, the computer system 100 detects a user input directed to the user interface 5118 (e.g., an upward swipe input). In response to detecting the user input 5120, and as shown in FIG. 5AB, the computer system 100 displays the clock user interface 5058 (e.g., the same clock user interface 5058 shown in FIG. 5M). The clock user interface 5058 is displayed because the display of the computer system 100 is in the landscape orientation while connected to power. A user interface 5122 is displayed overlaid over a portion of the user interface 5058. In some embodiments, the user interface 5122 is analogous to the user interface 5116 of FIG. 5Z (e.g., but with a different appearance, and for a landscape orientation of the computer system 100, and while the computer system 100 is operating in an ambient mode).

While displaying the user interface 5122 overlaid on the user interface 5058, the computer system 100 detects a user input 5124 (e.g., an upward swipe input) directed to the user interface 5122. In response to detecting the user input 5124, and as shown in FIG. 5AC, the computer system 100 displays an indicator 5126 overlaid on the user interface 5058. In some embodiments, the indicator 5126 is analogous to the indicator 5112 of FIG. 5Y (e.g., but with a different appearance, and for a landscape orientation of the display of the computer system 100).

In some embodiments, the computer system 100 displays the indicator 5126 overlaid on the user interface 5058 after a threshold amount of time (e.g., of inactivity or during which a user does not interact with the computer system 100 and/or the user interface 5122). Stated differently, the computer system 100 may transition from displaying the user interface 5122 of FIG. 5AB, to displaying the indicator 5126 of FIG. 5AC, automatically (e.g., without the need for the user input 5124).

While displaying the indicator 5126, the computer system 100 detects a user input 5128 (e.g., a tap input, or a long press input) directed to the indicator 5126. In response to detecting the user input 5128, the computer system 100 displays (e.g., redisplays) one or more of the previously displayed user interfaces.

For example, FIG. 5AD shows one example where the computer system 100 redisplays the user interface 5122 (e.g., again overlaid on the user interface 5058). FIG. 5AE shows another example where the computer system 100 redisplays the user interface 5116. In some embodiments, in response to detecting the user input 5128, and in accordance with a determination that the user input 5128 is a tap input, the computer system 100 redisplays the user interface 5512 (in FIG. 5AD). In response to detecting the user input 5128, and in accordance with a determination that the user input 5128 is a long press input, the computer system 100 redisplays the user interface 5116 (e.g., the computer system 100 skips the state shown in FIG. 5AD, and instead transitions from the state shown in FIG. 5AC directly to the state shown in FIG. 5AE). In some embodiments, the computer system 100 redisplays the user interface 5116 in response to detecting a user input directed to the user interface 5122 (e.g., of FIG. 5AD).

FIG. 5AE also shows a user input 5130 (e.g., an upward swipe input, starting from a bottom edge of the display of the computer system 100 in the landscape orientation). While displaying the user interface 5118, the computer system 100 detects a user input 5130.

In some embodiments, since the user input 5130 started from a bottom edge of the computer system 100 (e.g., as opposed to starting from a non-edge region, such as the similar input 5120 in FIG. 5AA), in response to detecting the user input 5130, and as shown in FIGS. 5AF and 5AG, the computer system 100 displays a wake user interface (e.g., the same wake user interface of FIG. 5G and/or 5H, but at a current time of 9:05 instead of 9:00). In some embodiments, the active timer for the computer system 100 continues to run (e.g., because the user did not activate the stop affordance for the active timer).

In some embodiments, the computer system 100 does not display the wake user interface, and in response to detecting the user input 5130, the computer system 100 maintains display of the user interface 5118. In some embodiments, the computer system 100 redisplays the clock user interface 5058 in response to detecting the user input 5130 (e.g., instead of displaying the wake user interface). In some embodiments, the computer system 100 only displays the wake user interface (e.g., or a home screen user interface) when detecting specific criteria are no longer met (e.g., as described below with reference to FIGS. 5AH-5AK) (e.g., the computer system 100 remains in the ambient mode and does not display the wake user interface or a home screen user interface, while the specific criteria continue to be met).

FIG. 5AF shows the wake user interface with a landscape orientation. Since the active timer for the computer system 100 is still running (e.g., the user did not interact with the stop affordance for the active timer, in the user interface 5118), the computer system 100 also displays an indicator (e.g., an indicator analogous to the indicator 5112 of FIG. 5Y, but for the landscape orientation) corresponding to the active timer, overlaid over of the wake user interface in the landscape orientation.

FIG. 5AG is an alternative to FIG. 5AF, and shows the wake user interface with a portrait orientation. As the active timer is still running on the computer system 100, the computer system 100 displays the indicator 5112 overlaid on the wake user interface (e.g., the same indicator 5112 shown in FIG. 5Y).

FIGS. 5AH-5AK show exemplary methods for exiting the ambient mode of the computer system 100. In FIG. 5AH, the computer system 100 displays the clock user interface 5058 for a time or clock ambient mode of the computer system 100. The user begins to rotate the display of the computer system 100 away from the landscape orientation, towards a portrait orientation. The dotted outline in FIG. 5AH shows the original landscape orientation of the display of the computer system 100, as a reference for the amount of rotation of the computer system 100. While the amount (e.g., degree) of rotation of the computer system 100 is below a threshold amount (e.g., the same, or a similar, threshold amount used by the computer system 100 in order to determine whether to display content in a portrait or landscape orientation), the computer system 100 maintains display of the clock user interface 5058 and remains in the ambient mode. This prevents the computer system 100 from exiting the ambient mode accidentally (e.g., in cases where the computer system 100 and/or a surface on which the computer system 100 is resting is bumped or moved slightly).

In FIG. 5AI, the computer system 100 has been rotated by more than the threshold amount, and the computer system 100 exits the ambient mode and displays a replacement user interface (e.g., a wake user interface). The dotted outline shows the previous orientation of the display of computer system 100 in FIG. 5AH (e.g., with a slight rotation that is below the threshold amount). In some embodiments, the computer system 100 exits the ambient mode if the charging source 5056 is disconnected from the computer system 100 (e.g., regardless of what orientation the display of the computer system 100 is in). In some embodiments, the computer system 100 exits the ambient mode in response to detecting a user input 5132 (e.g., a tap user input) directed to a portion of the clock user interface 5058 (e.g., a predetermined region of the clock user interface 5058) (e.g., regardless of what orientation the display of the computer system 100 is in, and regardless of whether the computer system 100 is connected to the charging source 5056 or not).

In some embodiments, the replacement user interface is a user interface that was displayed prior to the computer system 100 operating in the ambient mode. For example, FIGS. 5G-5L show various states of the computer system 100 prior to entering the ambient mode (e.g., because the criteria to enter the ambient mode were not met). In these states, the computer system 100 displays a wake user interface of the computer system 100. In FIG. 5AI, the replacement user interface is the same wake user interface that was displayed in FIGS. 5G-5L.

In some embodiments, the computer system 100 displays an animated transition from displaying the clock user interface 5058 to displaying the replacement user interface of FIG. 5AI. In some embodiments, the animated transition progresses in accordance with an amount of rotation of the computer system 100. For example, the animated transition begins when the computer system 100 is rotated by a first amount (e.g., more than the amount in FIG. 5AH, but less than the amount in FIG. 5AI), and ends when the computer system 100 is rotated by the threshold amount (e.g., the amount in FIG. 5AI). During the rotation of the computer system 100, the animated transition reflects the amount of rotation between the first amount and the threshold amount (e.g., when the display of the computer system 100 has been rotated to an orientation that is halfway between the first amount and the threshold amount, the animated transition has progressed to a half way point). In some embodiments, the animated transition is reversible, such that while the animated transition is in progress, the user can reverse the direction of the rotation of the computer system 100 to reverse the animated transition. In some embodiments, the animated transition is displayed only after the computer system 100 is rotated by a threshold amount (e.g., small amount of rotation does not result in displaying an animated transition).

FIG. 5AJ is analogous to FIG. 5AH, but the computer system 100 is displaying the home control user interface 5086. Since the computer system 100 has not been rotated by more than the threshold amount, the computer system 100 operates in the ambient mode and displays the home control user interface 5086.

In FIG. 5AK, the computer system 100 has been rotated by more than the threshold amount. The computer system 100 exits the ambient mode and displays a replacement user interface. In some embodiments, the replacement user interface of FIG. 5AK is the same as the replacement user interface of FIG. 5AI (e.g., the computer system 100 displays the same wake screen user interface when the computer system 100 exits the ambient mode, regardless of which user interface as displayed while the computer system 100 was in the ambient mode). In some embodiments, the computer system 100 exits the ambient mode in response to detecting a user input 5134 (e.g., a tap user input) directed to a portion of the home control user interface 5086 (e.g., a predetermined region of the home control user interface 5086) (e.g., regardless of what orientation the display of the computer system 100 is in, and regardless of whether the computer system 100 is connected to the charging source 5056 or not).

In some embodiments, the replacement user interface of FIG. 5AK is instead a different replacement user interface than the replacement user interface in FIG. 5AI (e.g., the computer system 100 displays a different replacement user interface depending on what user interface and/or category of user interface was displayed prior to exiting the ambient mode).

In some embodiments, the computer system 100 displays an animated transition from displaying the home control user interface 5086 to displaying the replacement user interface of FIG. 5AK, analogous to the animated transition described above with reference to FIG. 5AH and FIG. 5AI.

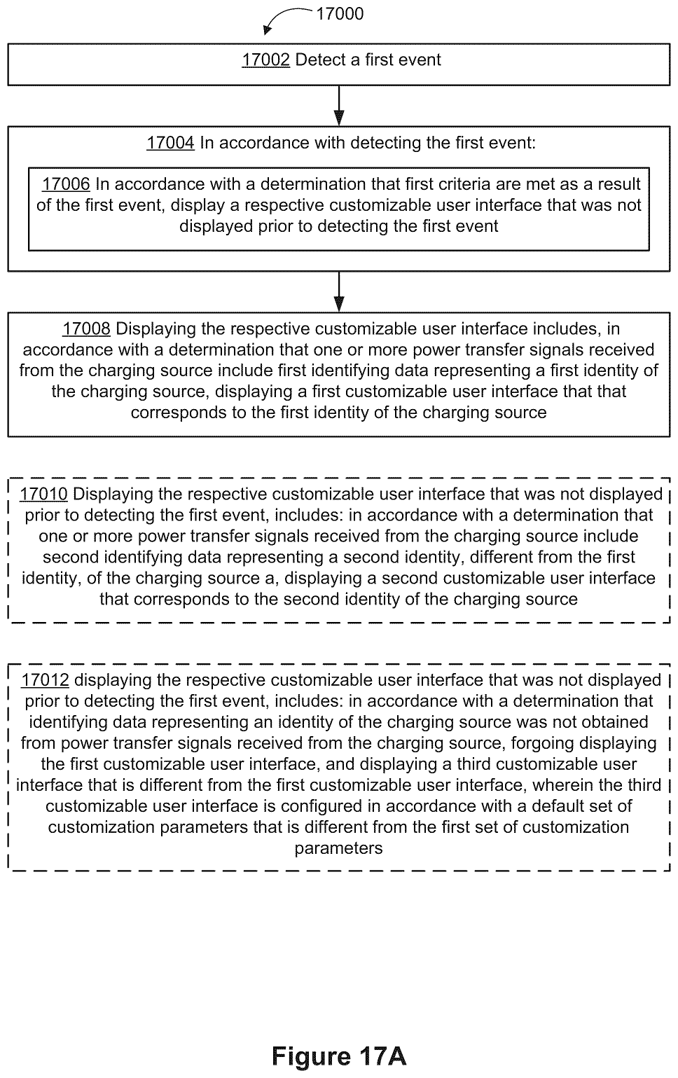

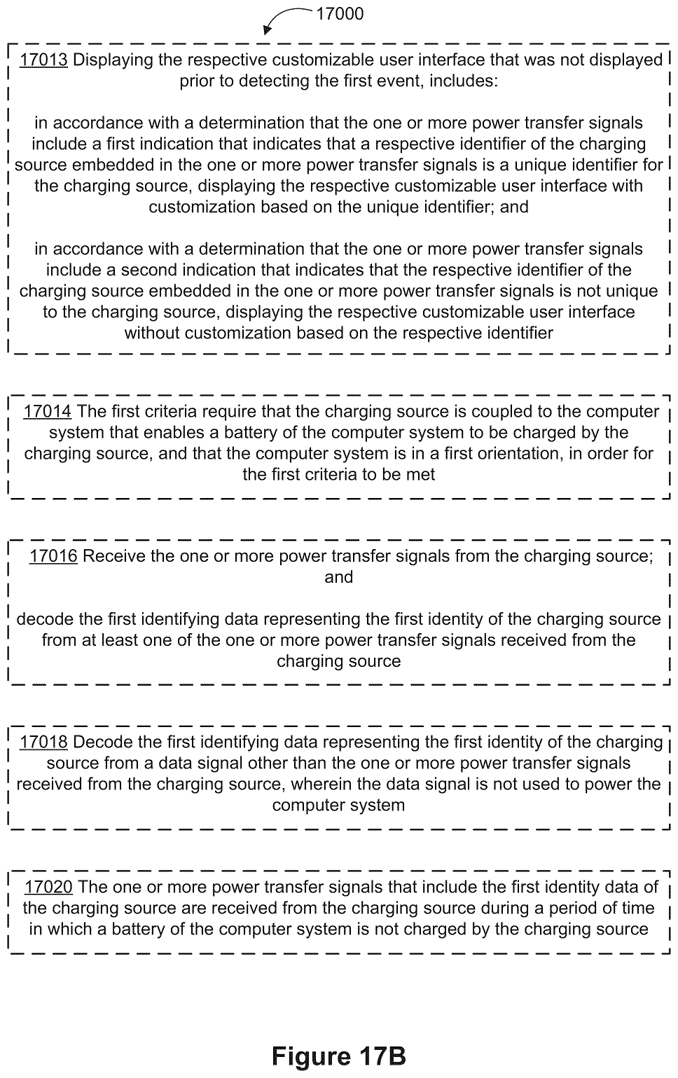

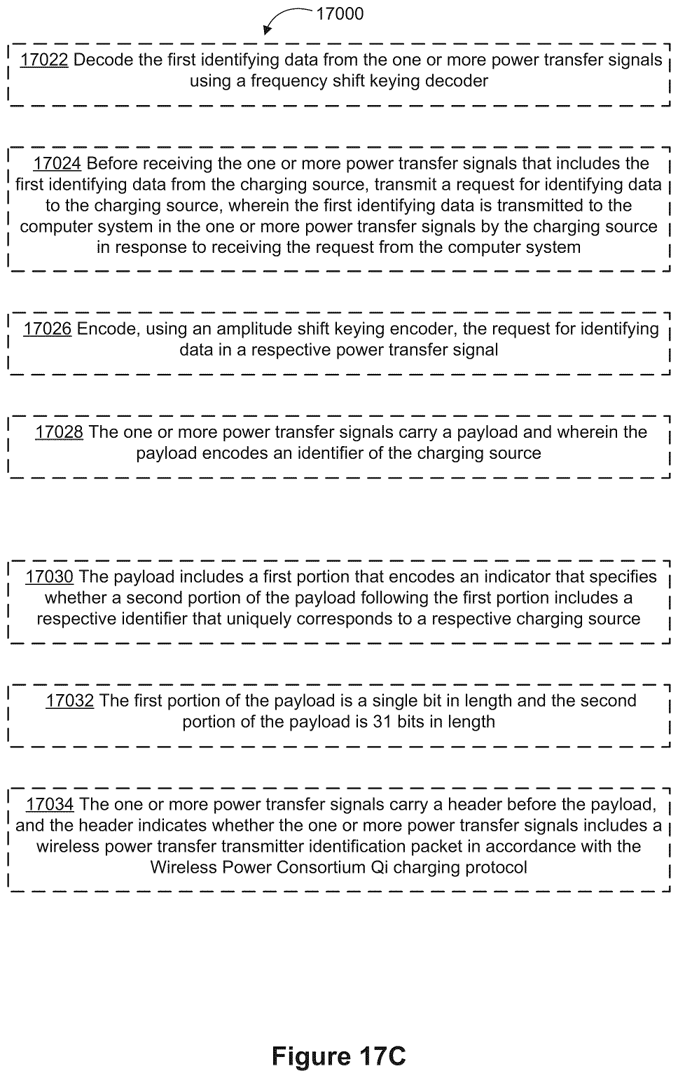

As disclosed herein, the computer system 100, in some embodiments, performs personalization and/or customization on the user interfaces that are displayed based on the context surrounding the display of the user interfaces. In some embodiments, the computer system determines the context based on an identifier associated with a charging source that is currently coupled to the computer system. In some embodiments, if the identifier is uniquely associated with the charging source, the computer system records the identifier and stores personalization and/or customization parameters in association with the unique identifier of the charging source, such that, when the charging source is recoupled to the computer system at a later time and the computer system is able to recognize that the identifier of the charging source as matching a stored identifier of a previously encountered charging source, and personalize and customize the user's experience based on the personalization and/or customization parameters that have been stored in association with the unique identifier of the charging source. In the present disclosure, the wireless or wired charging source that is coupled to the computer system transmits a transmitter identification data packet to the computer system, e.g., via one or more power transfer signals or via one or more signals that are not used to charge or power the computer system (e.g., one or more Bluetooth signals, NFC signals, or signals of other communication protocols). In some embodiments, the transmitter identification data packet encodes an identifier for the charging source, and optionally, includes an indicator that specifies whether the identifier is unique to the charging source. In some embodiments, the identifier and the optional indicator are encoded in a payload of the transmitter identification data packet, while the transmitter identification data packet further includes a header that specifies the nature of the data packet as being a transmitter identification data packet. In some embodiments, the charging source sends the transmitter identification data packet in response to a request from the computer system. More details of the interactions between the charging source and the computer system, the format of the data packets, and/or how the information contained in the data packets are utilized by the computer system and the charging source are provided below, e.g., with respect to FIGS. 5AN-5AR and FIGS. 17A-17C, and other Figures and descriptions contained herein.

FIG. 5AN illustrates a simplified block diagram of a wireless power transfer system 5101, in accordance with some embodiments. Wireless power transfer system 5101 includes a power transmitter (PTx) 5174 that wirelessly transfers power to a power receiver (PRx) 5184 via inductive coupling 5194. Power transmitter 5174 is adapted to receive input power that is converted to an AC voltage having particular voltage and frequency characteristics by an inverter 5178. Inverter 5178 is adapted to be controlled by a controller/communications module 5180 that operates as further described below. In various embodiments, the inverter and controller and communications module may be implemented in a common system, such as a system based on a microprocessor, microcontroller, or the like. In some embodiments, the inverter controller may be implemented by a separate controller module and communications module that have a means of communication between them. Inverter 5178 may be constructed using any suitable circuit topology (e.g., full bridge, half bridge, etc.) and may be implemented using any suitable semiconductor switching device technology (e.g., MOSFETs, IGBTs, etc. made using silicon, silicon carbide, or gallium nitride devices), in accordance with various embodiments.

In some embodiments, inverter 5178 is adapted to deliver the generated AC voltage to a transmitter coil 5176 of the power transmitter 5174. In addition to a wireless coil allowing magnetic coupling to the receiver, the transmitter coil block 5176 illustrated in FIG. 5AN may include tuning circuitry, such as additional inductors and capacitors, that facilitate operation of the transmitter in different conditions, such as different degrees of magnetic coupling to the receiver, and/or different operating frequencies. The wireless coil itself may be constructed in a variety of different ways, in accordance with various embodiments. In some embodiments, the wireless coil is formed as a winding of wire around a suitable bobbin. In some embodiments, the wireless coil is formed as traces on a printed circuit board. Other arrangements are also possible and may be used in conjunction with the various embodiments described herein. The wireless transmitter coil 5176 may also include a core of magnetically permeable material (e.g., ferrite) configured to affect the flux pattern of the coil in a way suitable to the particular application. The teachings herein may be applied in conjunction with any of a wide variety of transmitter coil arrangements appropriate to a given application, in accordance with various embodiments.

In some embodiments, the PTx controller/communications module 5180 is adapted to monitor the transmitter coil 51786 and use information derived therefrom to control the inverter 5178 as appropriate for a given situation. For example, in some embodiments, controller/communications module 5180 is configured to cause inverter 5178 to operate at a given frequency or output voltage depending on the particular application. In some embodiments, the controller/communications module 5180 is configured to receive information from the PRx 5184 and control inverter 5178 accordingly. This information may be received via the power transmission coils (i.e., via in-band communication) or may be received via a separate communications channel (e.g., out-of-band communication using NFC or Bluetooth). For in-band communication, controller/communications module 5180 is adapted to detect and decode signals imposed on the magnetic link (such as voltage, frequency, or load variations) by the PRx 5184 to receive information (e.g., including, but not limited to, a request for information such as a request for an identifier of the PTx 5174), and is adapted to instruct the inverter 5178 to modulate the delivered power by manipulating various parameters (such as voltage, frequency, phase, etc.) to send information to the PRx 5184 (e.g., including, but not limited to, a transmitter identification data packet that includes the identifier of the PTx and an indicator of whether the identifier is unique to the PTx), in accordance with some embodiments. In some embodiments, controller/communications module 5180 is configured to employ frequency shift keying (FSK) communications, in which the frequency of the inverter signal is modulated, to communicate data (e.g., including, but not limited to, transmitter identification data packet) to the PRx 5184. In some embodiments, controller/communications module 5180 is configured to detect amplitude shift keying (ASK) communications (e.g., including, but not limited to, requests for transmitter identification data packet) or load modulation based communications from the PRx 5184. In either case, the controller/communications module 5190 may be configured to vary the current drawn on the receiver side to manipulate the waveform seen on the Tx coil 5176 to deliver information to from the PRx 5184 to the PTx 5174. For out-of-band communication, additional modules that allow for communication between the PTx 5174 and PRx 5184 may be provided, for example, WiFi, Bluetooth, or other radio links or any other suitable communications channel, in accordance with various embodiments.

As mentioned above, controller/communications module 5180 may be a single module, for example, provided on a single integrated circuit, or may be constructed from multiple modules/devices provided on different integrated circuits or a combination of integrated and discrete circuits having both analog and digital components. The teachings herein are not limited to any particular arrangement of the controller/communications circuitry.

In some embodiments, PTx 5174 optionally includes other systems and components, such as a near field communications (“NFC”) module 5182. In some embodiments, NFC module 5182 is adapted to communicate with a corresponding module or radio frequency identification (RFID) tag in the PRx 5184 via the power transfer coils 5176 and 7186. In other embodiments, NFC module 5182 is adapted to communicate with a corresponding module or tag using a separate physical channel 5196. In some embodiments, inductive power transfer is, optionally, suspended during a time when out-of-band communication (e.g., NFC communication, or Bluetooth communication) is ongoing to prevent interference with the out-of-band communications.

As noted above, the wireless power transfer system also includes a wireless power receiver (PRx) 5184, in accordance with some embodiments. Wireless power receiver PTx 5184 includes a receiver coil 5186 that is adapted to be magnetically coupled 5194 to the transmitter coil 5176, in accordance with some embodiments. As with transmitter coil 5176 discussed above, receiver coil block 5186 illustrated in FIG. 5AN may include tuning circuitry, such as additional inductors and capacitors, that facilitate operation of the receiver in different conditions, such as different degrees of magnetic coupling to the transmitter, different operating frequencies, etc. The wireless coil itself may be constructed in a variety of different ways. In some embodiments, the wireless coil may be formed as a winding of wire around a suitable bobbin. In some embodiments, the wireless coil may be formed as traces on a printed circuit board. Other arrangements are also possible and may be used in conjunction with the various embodiments described herein. The wireless receiver coil may also include a core of magnetically permeable material (e.g., ferrite) configured to affect the flux pattern of the coil in a way suitable to the particular application, in accordance with some embodiments. The teachings herein may be applied in conjunction with any of a wide variety of receiver coil arrangements appropriate to a given application.

In some embodiments, receiver coil 5186 outputs an AC voltage induced therein by magnetic induction via transmitter coil 5176. This output AC voltage may be provided to a rectifier 5188 that provides a DC output power to one or more loads associated with the PRx 5184 (e.g., a battery of the computer system, and/or various components of the computer system that consume power in order to function). Rectifier 5188 may be controlled by a controller/communications module 5190 that operates as further described below. In various embodiments, the rectifier controller and communications module may be implemented in a common system, such as a system based on a microprocessor, microcontroller, or the like. In some embodiments, the rectifier controller may be implemented by a separate controller module and communications module that have a means of communication between them. Rectifier 5188 may be constructed using any suitable circuit topology (e.g., full bridge, half bridge, etc.) and may be implemented using any suitable semiconductor switching device technology (e.g., MOSFETs, IGBTs, etc. made using silicon, silicon carbide, or gallium nitride devices).

In some embodiments, the PRx controller/communications module 5190 is adapted to monitor the receiver coil 5186 and use information derived therefrom to control the rectifier 5188 as appropriate for a given situation. For example, in some embodiments, the controller/communications module 5190 is configured to cause rectifier 5188 to operate to provide a given output voltage depending on the particular application. In some embodiments, the controller/communications module 5190 is configured to send information to the PTx 5174 to effectively control the power delivered to the receiver. This information may be sent via the power transmission coils (i.e., in-band communication) or may be sent via a separate communications channel (not shown, i.e., out-of-band communication). For in-band communication, controller/communications module 5190 may, for example, modulate load current or other electrical parameters of the received power to send information to the PTx 5174 (e.g., including, but not limited to, a request for the transmitter identification data packet containing the identifier of the PTx). In some embodiments, controller/communications module 5190 is configured to detect and decode signals imposed on the magnetic link (such as voltage, frequency, or load variations) by the PTx 5174 to receive information from the PTx 5174 (e.g., including, but not limited to, the transmitter identification data packet). In some embodiments, controller/communications module 5190 is configured to receive frequency shift keying (FSK) communications, in which the frequency of the inverter signal has been modulated to communicate data to the PRx 5184. In some embodiments, controller/communications module 5190 is configured to generate amplitude shift keying (ASK) communications or load modulation based communications from the PRx 5184. In either case, the controller/communications module 5190 may be configured to vary the current drawn on the receiver side to manipulate the waveform seen on the Tx coil 5176 to deliver information to from the PRx 5184 to the PTx 5174. For out-of-band communication, additional modules that allow for communication between the PTx 5174 and PRx 5184 may be provided, for example, WiFi, Bluetooth, or other radio links or any other suitable communications channel.

As mentioned above, controller/communications module 5190 may be a single module, for example, provided on a single integrated circuit, or may be constructed from multiple modules/devices provided on different integrated circuits or a combination of integrated and discrete circuits having both analog and digital components, in accordance with various embodiments. The teachings herein are not limited to any particular arrangement of the controller/communications circuitry.

In some embodiments, PRx 5184 optionally includes other systems and components, such as a near field communications (“NFC”) module 5192. In some embodiments, NFC module 5192 is adapted to communicate with a corresponding module or radio frequency identification (RFID) tag in the PTx 5174 via the power transfer coils. In some embodiments, the NFC module 5192 is adapted to communicate with a corresponding module or tag using a separate physical channel 138. In some embodiments, inductive power transfer is suspended when out-of-band communications are ongoing, to prevent interference with the out-of-band communications on other channels.

Numerous variations and enhancements of the above described wireless power transmission system 5101 are possible, and the following teachings are applicable to any of such variations and enhancements. As noted above, PRx controller/communications module 5190 and PTx controller/communications module 5174 are adapted to communicate with each other to respectively identify themselves to one another and to negotiate power delivery between them, in accordance with various embodiments. This identification and negotiation process may be done in conjunction with a standard-defined protocol, such as protocols defined by the Wireless Power Consortium Qi standard, so that devices from different manufacturers can interoperate. Compliance with such a standard provides the benefit of interoperability at the potential expense of specialization. In other embodiments, the identification and negotiation process may be done in conjunction with a proprietary protocol determined by the manufacturer of the devices, which provides the benefit of improved flexibility and potentially extended performance, with the drawback of the loss of interoperability with devices that do not implement the proprietary protocol.

In some embodiments, the controller/communications modules is configured to initiate the negotiation process according to a standard-defined protocol. In the process of that negotiation, one, the other, or both devices may identify themselves—in a way that complies with the standard—as supporting an enhanced capability set that goes beyond the scope of the standard. If both devices are capable of operating in accordance with this enhanced capability set, the devices may choose to operate in accordance with the enhanced capability set. Otherwise, the devices may choose to operate in conjunction with the standards-based capability set. In some embodiments, the enhanced capability set include the ability to operate at a different frequency, at different power levels, or in other ways that go beyond what is defined in an existing standard. In some embodiments, the enhanced capability sent includes the ability to transmit/encode and receive/decode a transmitter identification data packet that includes a header that identifies a data packet as a transmitter identification data packet structured according to a predefined structure, e.g., as shown in FIGS. 5AQ, 5AS, and 5AT, and includes an indicator indicating whether an identifier carried in the payload of the data packet is unique to the sender of the packet (e.g., the PTx, and optionally, the PRx) and an identifier of the sender of the packet. In some embodiments, the receiving device of the transmitter identification data packet performs personalization and/or customization for one or more operations (e.g., displaying user interfaces, and/or respond to user inputs) based on the unique identifier contained in the data packet. In some embodiments, if one of the devices do not support the enhanced capability, the transmitter identification data packet is either not sent, or not utilized in the personalization and customization of the operations of the receiver of the transmitter identification data packet.

FIGS. 5AO-5AP illustrate an exemplary communication exchange 5103 between the wireless power receiver (PRx) 5184 and the wireless power transmitter (PTx) 5174 to enable display of a respective customizable user interface (e.g., during a standby mode as described herein, in FIGS. 5A-5AM, for example). In some embodiments, the communication exchange occurs via a communication protocol regime that is a standards-based regime such as the Wireless Power Transfer Consortium Qi charging protocol. The various communication packets described may take any of a variety of forms, employing different packet structures, different modulation schemes for communicating the packets and the like. The following description addresses at a high level the components of the communication packets, but it will be appreciated that a particular protocol implementations may specify different or additional data that may be included in these packets as appropriate.

With reference to FIG. 5AO, an exemplary negotiation process begins with PRx 5184 sending a sequence of messages 5198-5202 to power transmitter 5174. This exchange may be triggered by the PTx 5174 detecting that PRx 5184 is in proximity. The exchanges may take place using in-band communication at a frequency specified by the standard. In some embodiments, this frequency may be between about 100 kHz and about 250 kHz. In some embodiments, this frequency may be 128 kHz, 326 kHz, 360 kHz, 1.78 MHz, or another suitable frequency. In the illustrated example, the four messages 5198-5204 correspond to messages sent in accordance with the Qi standard; however, in some embodiments, there may be more or fewer messages, and they may comply with an alternative standard or protocol.

In some embodiments, the first message 5198 is a SIG packet, i.e., a Signal Strength packet in accordance with the Qi standard. In some embodiments, the second message 5200 is an ID packet, i.e., an Identification packet in accordance with the Qi standard. In some embodiments, the third message 5202 is a CFG packet, i.e., a Configuration packet in accordance with the Qi standard. In some embodiments, these three packets correspond to a “Ping” and “Configuration Phase” according to the Qi standard. Details of these packets, including the information contained therein and the effects of such packets in the system are described in detail in the Qi standard versions to which they pertain, and thus are not repeated herein. It will be appreciated that various versions of the Qi standard may incorporate different versions of such packets, and that later versions may combine, eliminate, or otherwise changes such packets. Thus the illustrated packets are provided here merely as examples of a standards-compliant initialization, and other similar arrangements could also be used. Upon receiving a communication from the PRx 5184, the PTx 5174 sends a response packet 5204 (ACK packet in FIG. 5AO), that acknowledges the communication of from the PRx 5184, in accordance with some embodiments. In embodiments utilizing in-band communication for the transmission of packet such as SIG 5198, ID 5200, CFG 5200, and ACK 5204, it is noted that such in-band (e.g., ASK, FSK) communications may be communicated between PRx 5184 and PTx 5174 using a signal referred to herein as a wireless power transfer signal.

Turning now to FIG. 5AP, further communication between the PRx 5184 and PTx 5174 is illustrated. In some embodiments, upon receiving from the PTx 5174, acknowledgement of the communication from the PRx 5184 (e.g., receiving the response packet 5204 in Figure AO), the PRx 5184 sends a further packet 5206 requesting that the PTx 5174 provide a unique ID, if any. This may take the form of a “GET” request in which the PRx 5184 requests that the PTx 5174 send its unique ID, if any. If available, the PTx 5174 sends an “EXT ID” packet 5208, which includes the unique ID for the PTx 5174. The “EXT ID” packet may provide an identifier (e.g., a device identification (ID) number or another type of ID number) specific to (e.g., unique to) the PTx 5174 (e.g., for authentication, security, and/or customization purposes). In some embodiments, the “EXT ID” packet 5208 may include an identifier for the PTx 5174 that is not unique to the PTx 5174, and includes an indication that the identifier is not unique. In some embodiments, the identifier of the sender and the indication are included in a payload of the “EXT ID” packet, where a header of the “EXT ID” packet specifies the type of the “EXT ID” packet (e.g., as a transmitter identification data packet). In some embodiments, a device identifier is considered “unique” to a device, if the identifier is unique for the device under a respective manufacturer code for the manufacturer of the device, and the same identifier may be reused by another manufacturer under a different manufacturer code. In some embodiments, the device identifier in the data packet includes a manufacturer code for the manufacturer of the device followed by a device identifier assigned to the device by the manufacturer. In some embodiments, a device identifier is considered unique for a device, if the identifier is unique for the device across all devices of the same group or type of devices (e.g., all charging device, all wireless charging devices, all wireless charging devices certified to a particular wireless charging specification, and/or other group or type of devices). In some embodiments, a device identifier is considered unique for a device, if the probability for a consumer to purchase two devices with identical identifiers is sufficient low, such as below a probability threshold. It should be appreciated that the level of uniqueness is driven by bit length of the identifier payload. In other words, if 20 bits employed used for the identifier field, the field would support 2\hat{ }20 or roughly 1 million unique identifiers.

In some embodiments, the PRx 5184 sends a further packet 5210 request that the PTx 5174 provide personalization information, if any. This may take the form of a “GET” request in which the PRx 5184 requests that the PTx 5174 send personalization information, if any. If available, the PTx 5174 sends a “UI Param” packet 5212 that includes personalization information. The “UI Param” packet 5212 may provide information relating to personalization and/or customization (e.g., personalization and/or customization of user preferences, user interfaces to be displayed, or other information relating to customization and/or personalization of the PRx 5184 and/or PTx 5174 and/or user interfaces displayed by the PRx 5184 and/or PTx 5174) specific to (e.g., unique to) the PTx 5174. In some embodiments, the information in the “UI Param” packet 5212 is included in the “EXT ID” packet 5208 (e.g., requests 5206 and 5210 are combined, and packets 5208 and 5212 are combined).

In some embodiments, the PRx 5184 does not request the unique ID and/or personalization information from the PTx 5174. Upon receiving the initial communication from the PRx 5184, the PTx 5174 automatically sends the unique ID and/or personalization information as part of the acknowledgement 5204 (e.g., the “EXT ID” packet 5208 and the “UI Param” packet 5212 in Figure AP are included in the ACK 5204 in FIG. 5AO).

FIGS. 5AO and 5AP also illustrate a power transfer step (power transfer 5214 in FIG. 5AO, and power transfer 5216 and power transfer 5218 in FIG. 5AP). In some embodiments, the power transfer step (5214) occurs after the PTx 5174 transmits the acknowledgement packet 5204 (e.g., power transfer occurs/begins before (and/or is ongoing while) the PTx 5174 transmits the unique ID and/or personalization information to the PRx 5184; and/or a wireless power signal is available for enabling in-band transmission of the “EXT ID” packet 5208 and/or the “UI Param” packet 5212 from the PTx 5174 to the PRx 5184). In some embodiments, the power transfer step (5216) occurs after the PTx 5174 transmits the “EXT ID” packet 5208 (e.g., power transfer occurs/begins after the PRx 5184 receives the “EXT ID” packet 5208 from the PTx 5174; and/or a wireless power signal is available for enabling in-band transmission of the “UI Param” packet 5212 from the PTx 5174 to the PRx 5184). In some embodiments, the power transfer step (5218) occurs after the PTx 5174 transmits the “UI Param” packet 5212. In some embodiments, the power transfer signals used to transfer power to the PRx are part of wireless power signals that are encoded with information (e.g., messages as described above) in various intervals, and the power transfer to the PRx is accomplished by at least some portions of the wireless power transfer signal (e.g., previously encoded in some cases, or not previously encoded in other cases).

FIG. 5AQ shows an exemplary data packet (e.g., an exemplary “EXT ID” packet 5206, and/or an exemplary “UI Param” packet 5210, shown in FIG. 5AP), that includes the unique ID discussed above with reference to FIGS. 5AO and 5AP (and further discussed below with reference to FIG. 5AR and FIGS. 17A-17C). For case of illustration and discussion, the exemplary data packet in FIG. 5AQ includes 8 bytes (bytes B₀-B₈), but it is understood that the data packet can include any suitable number of bytes.

In some embodiments, the data packet FIG. 5AQ includes a preamble (“0 (selector)”) and/or reserved portions (e.g., as shown in B₀-B₄). For example, the reserved portions may include a header (e.g., that identifies the type of packet and/or protocol information for the data packet) and/or a checksum (e.g., for error correction and/or validation purposes). In some embodiments, the header and/or checksum are (each) 8 bits (1 byte) of data, or any other suitable number of bits.

In some embodiments, the data packet includes a payload portion (e.g., bytes B₅-B₈). The payload portion includes an indicator (bit b₇ of byte B₅), which indicates whether the payload portion includes a unique ID (e.g., an identifier unique to the PTx 5174, as described above with reference to FIGS. 5AO-5AP). In some embodiments, if the payload portion includes a unique ID, the indicator bit b₇ is a “1,” and when the payload portion does not include a unique ID, the indicator bit b₇ is a “0” (e.g., the bit b₇ is a Boolean indicator for whether or not the payload portion includes a unique ID). In some embodiments, if the payload portion does not include a unique ID, the payload portion does not include the indicator bit b₇ (or the unique ID). In some embodiments, the indicator is 1 bit and the unique ID is 31 bits (e.g., the payload is 32 bits). In some embodiments, the indicator is 1 bit and the unique ID is any suitable number of bits (e.g., N-1 bits, where N is the total number of bits comprising the payload portion), such that the payload is a suitable number of bits (e.g., to meet certain standards governing the structure of the data packet and/or payload portion of the data packet). For example, in some embodiments, the payload portion is 64 bits, the indicator is 1 bit, and the unique ID is 63 bits (where N=64, and N-1=64−1=63).

In some embodiments, the payload portion also includes personalization information (e.g., in addition to the indicator and the unique ID). In some embodiments (e.g., where the exemplary data packet in FIG. 5AQ is an exemplary “UI Param” packet 5212 in FIG. 5AP), the payload portion includes personalization information (e.g., in licu of the indicator and/or unique ID illustrated in FIG. 5AQ). In some embodiments, the personalization information is optionally loaded onto the PTx by a manufacturer of the PTx. In some embodiments, the personalization information (e.g., an indicator of whether to personalize based on the unique transmitter identifier, and/or customization parameters associated with the unique transmitter identifier) is previously transmitted to the PTx by the same or different PRx for future customization and personalization use, after customization or personalization have occurred on the computer system corresponding to the PRx.

FIG. 5AS shows another exemplary data packet (e.g., an exemplary “EXT ID” packet 5206, and/or an exemplary “UI Param” packet 5210, shown in FIG. 5AP), that includes an ID discussed above with reference to FIGS. 5AO and 5AP (and further discussed below with reference to FIG. 5AR and FIGS. 17A-17C). For case of illustration and discussion, the exemplary data packet in FIG. 5AS includes 8 bytes (bytes B₀-B₈), but it is understood that the data packet can include any suitable number of bytes.

In some embodiments, the data packet in FIG. 5AS includes a preamble (“0 (selector)”) and/or reserved portions (e.g., as shown in B₀-B₄ and B₆ b₂-B₈). For example, the reserved portions may include a header (e.g., that identifies the type of packet and/or protocol information for the data packet) and/or a checksum (e.g., for error correction and/or validation purposes). In some embodiments, the header and/or checksum are (each) 8 bits (1 byte) of data, or any other suitable number of bits. The reserved portions, e.g., B₆ b₂-B₈ also can provide an indication of whether the ID portion of B₄-B₆ is intended as a unique ID. In one example, in the data packet in FIG. 5AS, the device identifier is included in a portion of the payload that spans B4b6-B6b3 (20 bits), and the indication of whether the device identifier is unique is included in the manufacturer reserved portion of the payload that spans B6b2-B₈ (19 bits). In some embodiments, to indicate that the device identifier included in the payload is unique, the manufacturer reserved portion of the payload is set to a non-zero value. In some embodiments, the computer system that receives the data packet shown in FIG. 5AS would be able to determine whether to perform personalization and/or customization based on the device identifier decoded from the payload (e.g., from the portion spanning B4b6-B6b3 of the payload), in accordance with a determination of whether the manufacturer reserved portion (e.g., the portion spanning B6b2-B8) is set to a non-zero value. For example, in some embodiments, if the manufacturer reserved portion is set to a non-zero value (e.g., 1 or another non-zero integer value less than or equal to 2\hat{ }19), the computer system treats the identifier as unique to the PTx, and performs personalization and/or customization based on the unique identifier of the PTx. On the other hand, if the manufacturer reserved portion is set to zero, the computer system does not treat the identifier as unique to the PTx, and forgoes performing personalization and/or customization based on the identifier obtained from the data packet. In some embodiments, when the PTx sends the data packet, the manufacturer reserved portion is set to a non-zero value by the PTx according to manufacturer specification preloaded into the PTx. The manufacturer is responsible to also preload the PTx with a unique identifier for the PTx that is a number within the 2\hat{ }20 (about 1 million) range which can be accommodated in the portion of the payload for the device identifier (e.g., in the B4b6-B6b3 of the payload). In some embodiments, the manufacturer can generate the unique identifier using a hash function such that the identifier is spread out in the 2\hat{ }20 (about 1 million) range.

FIG. 5AT shows yet another exemplary data packet (e.g., an exemplary “EXT ID” packet 5206, and/or an exemplary “UI Param” packet 5210, shown in FIG. 5AP), that includes an ID discussed above with reference to FIGS. 5AO and 5AP (and further discussed below with reference to FIG. 5AR and FIGS. 17A-17C). For case of illustration and discussion, the exemplary data packet in FIG. 5AT includes 8 bytes (bytes B₀-B₈), but it is understood that the data packet can include any suitable number of bytes.

In some embodiments, the data packet in FIG. 5AT includes a preamble (“0 (selector)”) and/or reserved portions (e.g., as shown in B₀-B₄ and B₆ b₂-B₈). For example, the reserved portions may include a header (e.g., that identifies the type of packet and/or protocol information for the data packet) and/or a checksum (e.g., for error correction and/or validation purposes). In some embodiments, the header and/or checksum are (each) 8 bits (1 byte) of data, or any other suitable number of bits. The reserved portions, e.g., B0b3-B4b7, also can provide an indication of whether the ID portion of B₄-B₆ is intended as a unique ID. In one example, in the data packet in FIG. 5AT, the device identifier is included in a portion of the payload that spans at least B4b6-B6b3 (20 bits or longer), and the indication of whether the device identifier is unique is included in the reserved portion of the payload that spans B0b3-B4b7 (e.g., at B0b0, or another sub-portion of the reserved portion). In some embodiments, to indicate that the device identifier included in the payload is unique, the manufacturer reserved portion of the payload is set to a non-zero value. In some embodiments, the computer system that receives the data packet shown in FIG. 5AS would be able to determine whether to perform personalization and/or customization based on the device identifier decoded from the payload (e.g., from the portion spanning B0b3-B4b7 of the payload), in accordance with a determination of whether the reserved portion (e.g., B0b0) is set to a non-zero value (e.g., “1”). For example, in some embodiments, if the reserved portion (e.g., B0b0) is set to a non-zero value (e.g., “1”), the computer system treats the identifier as unique to the PTx, and performs personalization and/or customization based on the unique identifier of the PTx. On the other hand, if the reserved portion (e.g., B0b0) is set to zero, the computer system does not treat the identifier as unique to the PTx, and forgoes performing personalization and/or customization based on the identifier obtained from the data packet. In some embodiments, when the PTx sends the data packet, the reserved portion (e.g., B0b0) is set to a non-zero value (e.g., “1”) by the PTx according to manufacturer specification preloaded into the PTx. The manufacturer is responsible to also preload the PTx with a unique identifier for the PTx that is a number within the 2\hat{ }20 (about 1 million) range which can be accommodated in the portion of the payload for the device identifier (e.g., in the B4b6-B6b3 of the payload, or further extended into the manufacturer reserved portion B6b2-B8). In some embodiments, the manufacturer can generate the unique identifier using a hash function such that the identifier is spread out in the 2\hat{ }20 (about 1 million) range or the extended range including the manufacturer reserved portion B6b2-B8. In some embodiments, the identifier of the device includes a manufacturer code followed by a device identifier assigned to the device by the manufacturer, and the unique identifier of the device includes the manufacturer code and the manufacturer assigned identifier for the device. In some embodiments, the PTx chooses to perform personalization and/or customization based on the unique identifier of the PTx, in accordance with instructions stored on the computer system, and/or instructions and preferences established by the manufacturer of the PTx which is optionally received in the transmitter identification data packet containing the device identifier and/or the indicator of whether the device identifier is unique, and/or in additional data packets following the transmitter identification data packet.

FIG. 5AR illustrates an exemplary method 50000 of communicating personalization information between a PRx and a PTx. First, a PRx (e.g., PRx 5184 in FIGS. 5AN-5AP) is moved (50002) within proximity (e.g., within wireless charging range, and/or coupling range) of a PTx (e.g., PTx 5174 in FIGS. 5AN-5AP). For example, the PRx is a computer system or electronic device such as a smartphone or other handheld device, and the PTx is a wireless charger. The PRx is “within proximity” of the PTx when the PRx is able to receive power wirelessly from the PTx, in accordance with some embodiments.

The PRx use(s) (50004) impulse pings to detect the PTx (or, optionally, the PTx uses impulse pings to detect the PRx, or both PTx and PRx use impulse pings to detect the other device), in accordance with some embodiments.

In response to detecting the pings from the other device, the PRx and/or PTx initiates (50006) a digital handshake between the PRx and the PTx, in accordance with some embodiments. As discussed in greater detail with respect to the later steps of the method 50000 below, the digital handshake allows the PRx and the PTx to communicate relevant information regarding personalization information, which can be used by the PRx (and/or the PTx) to customize one or more outputs (e.g., a displayed user interface that is customized based on the personalization information). In some embodiments, the digital handshake involves transmission of and/or verification of a unique identifier (e.g., an identification number), and optionally, respective personalization information that is specific to (e.g., tied to and/or otherwise corresponds to) a respective unique identifier (hereinafter, “unique ID”). This allows, for example, a PRx to identify a specific PTx that is in proximity, and display a customized user interface corresponding to the specific PTx (e.g., the PRx displays a first customized user interface when in proximity to a first PTx, and a second customized user interface that is different from the first customized user interface when in proximity to a second PTx that is different from the first PTx). In some embodiments, if the PRx does not receive and/or the PTx does not send a unique identifier and/or personalization information (e.g., does not send any identifier, or sends an identifier that is not unique to the PTx), the PRx forgoes customization and provides a generic and/or default user interface or interaction behaviors to a user.

In some embodiments, the PRx requests (50008) that the PTx send a unique ID from the PTx to the PRx (e.g., the PRx sends a request to the PTx, for the PTx to transmit a unique ID packet), and the PTx does not send the unique ID until it receives the request from the PRx. In some embodiments, the PRx does not request the unique ID (e.g., the PTx automatically sends the unique ID, if available, without needing to receive a request from the PRx), as represented by the dotted outline of step S0008 in FIG. 5AR.

The PTx transfers (50010) the unique ID to the PRx (e.g., either automatically or in response to receiving a request from the PRx). In some embodiments, the unique ID packet includes personalization information. In some embodiments, the personalization information includes customizations relating to displayed user interfaces (e.g., the personalization information includes a customized and/or user-configured user interface that can be displayed when the PRx and the PTx are in proximity of one another, such as when the PRx is being wirelessly charged by the PTx). In some embodiments, personalization information is sent is a separate packet (e.g., in an analogous manner to the unique ID as described above with reference to steps S0008 and S0010).

This interaction sequence and data exchange allow the PRx to display different contextual information depending on the identity of the PTx that is coupled to the PRx, in accordance with various embodiments. For example, when the PRx (e.g., a smartphone, or handheld device) is within proximity of a first PTx (e.g., a wireless charger in a bedroom), the PRx may display a contextually relevant user interface such as the clock user interface 9002 (and/or the clock user interface 9008) described with reference to FIGS. 9A-9G below (e.g., a clock user interface that is suitable and/or configured for bedtime/nighttime use). When the PRx is within proximity of a second PTx (e.g., a wireless charger in an office or work location), the PRx detects that the PTx has a different unique identifier from before, and displays a different contextually relevant user interface such as the widget user interface 5078 described above with reference to FIG. 5S, in accordance with some embodiments.

In some embodiments, the PTx also initiates (50012) wireless power transfer. In some embodiments, the PTx initiates the wireless power transfer after (e.g., in response to) detecting the PRx within proximity of the PTx. In some embodiments, the wireless power transfer involves transmission of a wireless power signal, and the digital handshake uses the wireless power signal to transmit at least some communications involved in the digital handshake (e.g., the digital handshake occurs over in-band communications). In some embodiments, the unique ID is also transmitted via the wireless power signal (e.g., in-band communication).

After receiving the unique ID from the PTx, the PRx displays (50014) a customized user interface (e.g., one or more of the customized user interfaces discussed herein with reference to FIGS. 5A-5AM, 6A-6AN, 7A-7V, 8A-8JK, and/or 9A-9AA) in accordance with personalization information received via the unique ID.

In some embodiments, the PTx performs (e.g., all or substantially all) the active steps requiring transfer (e.g., transmission) of data. For example, the PTx uses impulse pings to detect the PRx, transmitting the unique ID, and/or initiating wireless power transfer, which allows PTx to handle all transmission steps via the wireless power signal (e.g., in-band).

Below are additional descriptions of a computer system (e.g., with exemplary hardware) for displaying a customized user interface that is configured in accordance with customization parameters corresponding to a received identity of a charging source, in accordance with various embodiments. In some embodiments, the computer system described below is configured to perform the operations described above with reference to FIG. 5AR and/or to perform the operations of the method 17000 described above with reference to FIGS. 17A-17C. Some operations described below are, optionally, combined and/or the order of some operations is, optionally, changed.

In some embodiments, the computer system includes a display generation component (e.g., a touch-screen display, a standalone display, or another type of display that is enclosed in the same housing as some or all of the other components of the computer system) (e.g., the touch-sensitive display system 112 in FIG. 1A, the touch screen 112 in FIGS. 2 and 4A-4C2); one or more sensors for detecting user inputs (e.g., cameras, touch-sensitive surfaces, pressure sensors, orientation sensors, motion sensors, and/or other input sensors) (e.g., the touch-sensitive display system 112 in FIG. 1A, the touch screen 112 in FIGS. 2 and 4A-4CS, the contact intensity sensor(s) 165 in FIG. 1A and FIG. 2, the keyboard/mouse 350 in FIG. 3, and/or the touchpad 355 in FIG. 3); a power transfer coil adapted to receive power transfer signals from a charging source (e.g., a wireless power transfer (WPT) transmitting device, or a wired power transfer device) (e.g., the receiving coil 5186 in FIG. 5AN); a rectifier (e.g., the rectifier 5188 in FIG. 5AN) adapted to charge a battery of the computer system (e.g., a battery that supplies power to the one or more processors, the one or more sensors, and/or the display generation component) using the power transfer signals received from the charging source by the power transfer coil; communication circuitry (e.g., the PRx controller/communications module 5190 in FIG. 5AN) adapted to obtain identifying data representing a respective identity of the charging source from at least one of the power transfer signals received from the charging source (e.g., in some embodiments, the power transfer coil, the rectifier, and the communication circuitry are integrated into a single charging component that receives power from the charging source and supplies power to the battery of the computer system); one or more processors; and memory storing instructions that, when executed by the one or more processors, cause the processors to perform operations

The operations include: detecting a first event (e.g., an event that corresponds to at least one of a change in an orientation (e.g., as shown in FIG. 5G) of the display generation component and/or a change in a charging state of the computer system (e.g., as shown in FIGS. 5I-5K), or other event(s) relevant to whether to activate a respective operating mode of the device (e.g., detecting a user's hand and/or a gaze of the user directed to the computer system, as in FIGS. 9B and 9C)). In some embodiments, the first event can be any of a number of events that trigger a determination of the identity of the charging source and/or subsequent displaying of the first customizable user interface based on the identifying data received in a power transfer signal from the charging source.

The operations include in accordance with detecting the first event (e.g., in response to detecting the first event, or in response to detecting another triggering event that is different from the first event) (e.g., in FIG. 5M, the computer system 100 has been rotated into the landscape orientation and is connected to the charging source 5056, the computer system is coupled to the charging source while in the landscape orientation, or the conditions for entering a low power mode or locked state are met while the computer system is coupled to the charging source and in the landscape orientation, or other events).

The operations include in accordance with a determination that first criteria are met as a result of the first event (e.g., in FIG. 5M, the computer system 100 is both in the landscape orientation and connected to the charging source 5056, or another customizable user interface described herein), displaying a respective customizable user interface (e.g., the clock user interface 5058 in FIG. 5M) that was not displayed prior to detecting the first event (e.g., the clock user interface 5058 was not displayed in FIGS. 5G-5L. In some embodiments, the respective customizable user interface includes a user interface with customizable content, appearance, and/or behavior, and includes but is not limited to the customizable user interfaces described herein. In some embodiments, the first criteria do not require that the computer system is being charged by the charging source in order to be met. In some embodiments, the first criteria do not require the computer system to be in a specific orientation in order to be met. In some embodiments, the first criteria require other conditions (e.g., conditions on authentication state, current time, current location, and/or other conditions) to be met in order to display the first customizable user interface.

Displaying the respective customizable user interface includes, in accordance with a determination that one or more power transfer signals (e.g., a wireless power transfer signal or a wired power transfer signal) received from the charging source (e.g., by the power transfer coil of the computer system, or another charging component of the computer system) include first identifying data (e.g., the unique ID in FIGS. 5AQ and 5AR, or another unique identifier) representing a first identity of the charging source (and, optionally, that the first identity of the charging source is stored at the computer system in association with a first set of customization parameters), displaying a first customizable user interface that corresponds to the first identity of the charging source (e.g., a first customizable user interface that is configured in accordance with the first set of customization parameters corresponding to the first identity of the charging source) (e.g., as described in step S0014 of the method 50000 in FIG. 5AR) (e.g., a user interface with content, appearance, and/or behavior that are customized based on the first set of customization parameters corresponding to the first identity of the charging source that is obtained from power transfer signal received from the charging source). In some embodiments, the one or more processors and memory include embedded systems, firmware, software, hardware, and/or a combination of two or more of the above to perform at least some of the steps recited herein. For example, in some embodiments, the receiving of power transfer signals, encoding and sending a request for identifying data to the charging source, decoding the power transfer signals received from the charging source to obtain identifying data of the charging source, charging the battery of the computer system are performed by a different sub-system than the processors and memory that provide the main operating system and associated functions of the computer system, including but not limited to evaluating the conditions for displaying various user interfaces, storing identifiers of known charging sources in association with their respective customization parameters for various types of customizable user interfaces, comparing a newly obtained identifier of the charging source with stored identifiers of previously encountered charging sources; and storing customization parameters in association with a currently used charging source based on user input and customization received while the currently used charging source is coupled to the computer system. In some embodiments, other divisions of the operations described herein among different types of processors of the computer system are possible and are not enumerated herein in the interest of brevity. In some embodiments, the payload of the transmitter identification packet carried by the one or more power transfer signals includes an indicator that specifies that the respective identifier carried in the payload of the transmitter identification packet is unique to the charging source, and according to this indication, the computer system perform personalization and/or customization steps for the charging source, and displays a customized version of the respective customizable user interface based on the unique identifier of the charging source. In some embodiments, the payload of the transmitter identification packet carried by the one or more power transfer signals includes an indicator that specifies that the respective identifier carried in the payload of the transmitter identification packet is not unique to the charging source, and according to this indication, the computer system does not perform personalization and/or customization steps for the charging source, and displays a generic or default version of the respective customizable user interface and does not record the personalization and/or customization made by the user while this charging source is coupled to the computer system. In some embodiments, the computer system performs automatic personalization and/or customization steps (e.g., storing unique identifiers, comparing unique identifiers, storing personalized parameters in association with unique identifiers) that ensure the display of the next user interface is personalized and/or customized based on previous recorded states of the user interface in accordance with a determination that personalization criteria are met, where the personalization criteria includes a requirement that the transmitter identity packet received from the charging source (e.g., either through in-band power transfer signals, or out-of-band communication packets) includes an indicator that the identifier carried in the transmitter identity packet is unique to the charging source in order for the personalization criteria to be met. For example, in some embodiments, the computer system determines that the transmitter identification data packet shown in FIGS. 5AQ, 5AS, and/or 5AT includes a unique identifier for the charging source and that personalization/customization should be performed based on the unique identifier, based on a determination that an indication in the payload of the data packet is set to a non-zero value (e.g., “1” or another positive integer value) (e.g., indicator in B5b7 in FIG. 5AQ, mfg reserved portion in B6b2-B8 in FIG. 5AS, or B0b0 in FIG. 5AT).

In some embodiments, the operations include displaying the respective customizable user interface that was not displayed prior to detecting the first event, including: in accordance with a determination that one or more power transfer signals (e.g., a wireless power transfer signal or a wired power transfer signal) received from the charging source (e.g., by a power transfer coil of the computer system, or another charging component of the computer system) include second identifying data representing a second identity, different from the first identity, of the charging source (and, optionally, that the second identity of the charging source is stored at the computer system in association with a second set of customization parameters different from the first set of customization parameters), displaying a second customizable user interface that corresponds to the second identity of the charging source (e.g., a second customizable user interface that is configured in accordance with the second set of customization parameters corresponding to the second identity of the charging source) (e.g., a user interface with content, appearance, and/or behavior that are customized based on the second set of customization parameters corresponding to the second identity of the charging source that is obtained from power transfer signal received from the charging source). In some embodiments, the computer system can be charged by a plurality of different charging sources, and the computer system is able to distinguish between the different charging sources based identifying data that are embedded in the power transfer signals received from the different charging sources as the different charging sources are, respectively, coupled to the computer system, at a given time. In some embodiments, the payload of the transmitter identification packet carried by the one or more power transfer signals includes an indicator that specifies that the respective identifier carried in the payload of the transmitter identification packet is unique to the charging source, and according to this indication, the computer system perform personalization and/or customization steps for the charging source, and displays a customized version of the respective customizable user interface based on the unique identifier of the charging source. In some embodiments, the payload of the transmitter identification packet carried by the one or more power transfer signals includes an indicator that specifies that the respective identifier carried in the payload of the transmitter identification packet is not unique to the charging source, and according to this indication, the computer system does not perform personalization and/or customization steps for the charging source, and displays a generic or default version of the respective customizable user interface and does not record the personalization and/or customization made by the user while this charging source is coupled to the computer system. In some embodiments, the computer system performs automatic personalization and/or customization steps (e.g., storing unique identifiers, comparing unique identifiers, storing personalized parameters in association with unique identifiers) that ensure the display of the next user interface is personalized and/or customized based on previous recorded states of the user interface in accordance with a determination that personalization criteria are met, where the personalization criteria includes a requirement that the transmitter identity packet received from the charging source (e.g., either through in-band power transfer signals, or out-of-band communication packets) includes an indicator that the identifier carried in the transmitter identity packet is unique to the charging source in order for the personalization criteria to be met. For example, as described with reference to step S0006 in FIG. 5AR, in some embodiments, respective personalization information is specific to (e.g., tied to and/or otherwise corresponds to) a respective unique identifier (hereinafter, “unique ID”). This allows, for example, a PRx to identify a specific PTx that is in proximity, and display a customized user interface corresponding to the specific PTx (e.g., the PRx displays a first customized user interface when in proximity to a first PTx, and a second customized user interface that is different from the first customized user interface when in proximity to a second PTx that is different from the first PTx). In some embodiments, the computer system determines that the transmitter identification data packet shown in FIGS. 5AQ, 5AS, and/or 5AT includes a unique identifier for the charging source and that personalization/customization should be performed based on the unique identifier, based on a determination that an indication in the payload of the data packet is set to a non-zero value (e.g., “1” or another positive integer value) (e.g., indicator in B5b7 in FIG. 5AQ, mfg reserved portion in B6b2-B8 in FIG. 5AS, or B0b0 in FIG. 5AT).

In some embodiments, the operations include displaying the respective customizable user interface that was not displayed prior to detecting the first event, including: in accordance with a determination that identifying data representing an identity of the charging source was not obtained from power transfer signals received from the charging source, forgoing displaying the first customizable user interface (and forgoing displaying the second customizable user interface), and displaying a third customizable user interface that is different from the first customizable user interface (and different from the second customizable user interface), wherein the third customizable user interface is configured in accordance with a default set of customization parameters (e.g., displaying a user interface with content, appearance, and/or behavior that are customized based on generic customization parameters corresponding to a generic identity of a charging source) that is different from the first set of customization parameters (and different from the second set of customization parameters). In some embodiments, the computer system is coupled to a charging source that does not embed its identity data in its power transfer signals, and the computer system is not able to obtain the identity data of the charging source from the power transfer signals of the charging source. In some embodiments, the computer system is coupled to a charging source that embeds its identity data in its power transfer signals in a different manner that is not decipherable for the computer system, and the computer system is not able to obtain the identity data of the charging source from the power transfer signals of the charging source. For example, as described with reference to step S0014 of FIG. 5AR, in some embodiments, if the PRx does not receive the unique ID from the PTx (e.g., the PTx does not have a unique ID and/or is not configured to transmit a unique ID to the PRx), the PRx forgoes displaying the first customizable user interface and instead displays a default user interface that optionally includes a default set of (e.g., customization) parameters, and is different from the first customizable user interface.

In some embodiments, the operations include displaying the respective customizable user interface that was not displayed prior to detecting the first event, including: in accordance with a determination that the one or more power transfer signals include a first indication (e.g., an indicator in FIG. 5AQ, such as a single leading bit in the payload that includes the respective identifier, or another portion of the payload that includes the respective identifier, the mfg reserved portion of the payload (e.g., B₆b2-B8) in FIG. 5AS, or the indicator in BOBO of the reserved portion of the payload in FIG. 5AT) that indicates that a respective identifier of the charging source embedded in the one or more power transfer signals is a unique identifier for the charging source, displaying the respective customizable user interface with customization based on the unique identifier (e.g., a fourth customizable user interface that is either the first or the second customizable user interface, depending on whether the unique identifier corresponds to the first identity or the second identity stored at the computer system); and in accordance with a determination that the one or more power transfer signals include a second indication (e.g., an indicator in FIG. 5AQ, such as a single leading bit in the payload that includes the respective identifier, a manufacturer (mfg) reserved field in FIG. 5AS, a reserved portion (e.g., B0b0) of the payload, or another portion of the payload that includes the respective identifier) that indicates that the respective identifier of the charging source embedded in the one or more power transfer signals is not unique to the charging source, displaying the respective customizable user interface without customization based on the respective identifier (e.g., the third customizable user interface that is configured in accordance with a set of default parameters, and different from the first, second, and fourth customizable user interface that have been customized based on unique identifiers). In some embodiments, the payload of the transmitter identification packet carried by the one or more power transfer signals includes an indicator that specifies that the respective identifier carried in the payload is not unique to the charging source, and according to this indication, the computer system does not perform personalization and/or customization steps for the charging source, and displays a generic or default version of the respective customizable user interface and does not record the personalization and/or customization made by the user while this charging source is coupled to the computer system. In some embodiments, the computer system performs automatic personalization and/or customization steps (e.g., storing unique identifiers, comparing unique identifiers, storing personalized parameters in association with unique identifiers) that ensure the display of the next user interface is personalized and/or customized based on previous recorded states of the user interface in accordance with a determination that personalization criteria are met, where the personalization criteria includes a requirement that the transmitter identity packet received from the charging source (e.g., either through in-band power transfer signals, or out-of-band communication packets) includes an indicator that the identifier carried in the transmitter identity packet is unique to the charging source in order for the personalization criteria to be met. For example, as described with reference to FIG. 5AQ, the data packet includes the payload portion includes an indicator (bit b₇ of byte B5), which indicates whether the payload portion includes a unique ID (e.g., an identifier unique to the PTx 5174, as described above with reference to FIGS. 5AO-5AP). As another example, FIG. 5AS illustrates the data packet as including a payload portion having a manufacturer (mfg) reserved portion (start at b₂ of byte 6 through byte 8) which can be used to carry an indicator indicating whether the payload portion includes a unique ID. As yet another example, FIG. 5AT illustrates the data packet as including a payload that has a reserved portion that includes an indicator in a single bit located at BOBO that can be used to carry an indicator indicating whether the payload portion includes a unique ID. As described with respect to step S0014 in FIG. 5AR, in some embodiments, if the PRx does not receive the unique ID from the PTx (e.g., the PTx does not have an ID, the PTx has only a non-unique ID, and/or is not configured to transmit a unique ID to the PRx), the PRx forgoes displaying the first customizable user interface.

In some embodiments, the first criteria require that the charging source is coupled to the computer system that enables a battery of the computer system to be charged by the charging source (e.g., through power transfer signals received from the charging source), and that the computer system is in a first orientation, in order for the first criteria to be met. In some embodiments, the respective customizable user interface is a user interface selected from all or a subset of the example user interfaces described herein (e.g., user interfaces in illustrated in FIGS. 5A-5AM, 6A-6AN, 7A-7V, 8A-8K, 9A-9AA, and 15A-15Q, and user interfaces described in FIGS. 10A-10L, 11A-11G, 12A-12D, 13A-13J, 14A-14G, and 16A-16F) that are displayed in response to detecting that the first criteria are met, where the selected user interface is configured in accordance with customization parameters stored in association with a stored identity of a charging source that matches the identity decoded from the power transfer signal received from the charging source that is currently coupled to the computer system. For example, as described with reference to step S0014 of FIG. 5AR, in some embodiments, the customized user interface is only displayed if the PRx and/or the PTx meet specific criteria (e.g., the first criteria). This is also shown in FIGS. 5G (e.g., where the computer system is not being charged by the charging source but is in the first orientation) and FIG. 5I (e.g., where the computer system is charged by the charging source but is not in the first orientation), where the computer system 100 only partially meets the first criteria, and the first customizable user interface (e.g., the clock user interface 5058 in FIG. 5M, where the first criteria are met) is not displayed. This is also described above with reference to FIG. 10I, reference number 10082.

In some embodiments, the power transfer coil is adapted to receive the one or more power transfer signals from the charging source (e.g., wirelessly, or through a wired connection); and the communication circuitry is adapted to decode the first identifying data representing the first identity of the charging source from at least one of the one or more power transfer signals received from the charging source (wherein the rectifier is adapted to use the one or more power transfer signals to increase a charge level of a battery of the computer system). In some embodiments, when the charging source having the second identity different from the first identity is coupled to the computer system, the computer system receives (e.g., using one or more power transfer coils of the computer system, and/or other charging components of the computer system) the one or more power transfer signals from the charging source (e.g., wirelessly, or through a wired connection); and the computer system decodes the second identifying data representing the second identity of the charging source from at least one of the one or more power transfer signals received from the charging source (wherein the one or more power transfer signals are used (e.g., by a rectifier or another charging component of the computer system) to charge a battery of the computer system). In some embodiments, the communication circuitry of the computer system is adapted to obtain the identifying data embedded in the power transfer signals received from the charging source while the battery is being charging using the power transfer signals received from the charging source. For example, as described with reference to FIGS. 5AO and 5AP, in some embodiments, the power transfer step (5214) occurs after the PTx 5174 transmits the acknowledgement packet 5204 (e.g., power transfer occurs/begins before (and/or is ongoing while) the PTx 5174 transmits the unique ID and/or personalization information to the PRx 5184; and/or a wireless power signal is available for enabling in-band transmission of the “EXT ID” packet 5208 and/or the “UI Param” packet 5212 from the PTx 5174 to the PRx 5184).

In some embodiments, the communication circuitry is adapted to decode the first identifying data representing the first identity of the charging source from a data signal other than the one or more power transfer signals received from the charging source, wherein the data signal is not used (e.g., by a rectifier or another charging component of the computer system) to power the computer system. In some embodiments, when the charging source having the second identity different from the first identity is coupled to the computer system, the computer system decodes the second identifying data representing the second identity of the charging source from a data signal other than the one or more power transfer signals received from the charging source, wherein the data signal is not used (e.g., by a rectifier or another charging component of the computer system) to power the computer system. In some embodiments, the computer system includes communication circuitry that is adapted to obtain the identifying data embedded in the power transfer signals received from the charging source when the power transfer signals are not used to charge the battery. In other words, the power transfer signals that include the identity data of the charging source are out-of-band communications that is not used for charging the battery of the computer system. In some embodiments, various features described with respect to the data encoding, decoding, transmission, and usage of information carried by the one or more power transfer signals are also applicable to the out-of-band communication signals (e.g., Bluetooth signals, NFC signals, or signals of other types of communication protocols) that are not used to charge the battery of the computer system but carry the identifying data for the charging source. For example, the structure of the transmitter identification packet, the interaction sequence between the charging source and the computer system, and the usage of the information in the data packets, as described with respect to the power transfer signals that carry identifying data of the charging source are analogously applicable to the out-of-band signals that carry identifying data of the charging source, and are not repeated herein in the interest of brevity. For example, in FIG. 5AP, the power transfer step 5218 occurs after transmission of the “EXT ID” packet 5208 and the “UI Param” packet 5212, and so the power transfer signals (e.g., of and/or associated with the power transfer step S218) are not available for use for in-band communication (e.g., the transmission of the “EXT ID” packet 5208 and the “UI Param” packet 5212 uses a different signal (e.g., Bluetooth or NFC signals) than the signals sent during the power transfer step 5218).

In some embodiments, power transfer coil is adapted to receive the one or more power transfer signals that include the first identity data of the charging source from the charging source (and the communication circuitry is adapted to decode the first identity data from the one or more power transfer signals) during a period of time in which a battery of the computer system is not charged by the charging source (e.g., the power transfer signals are not being used by the rectifier to charge the battery). In some embodiments, the one or more power transfer signals that include the second identity data of the charging source are received from the charging source during a period of time in which a battery of the computer system is not receiving power from the charging source (e.g., the power transfer signals are not being used by the rectifier to charge the battery). In some embodiments, the power transfer signals that include identity data of the charging source are received by the computer system during a break in the active power transfer from the charging source to the battery of the computer system (e.g., through the power transfer coil and rectifier, and/or other charging components of the computer system). For example, in FIGS. 5AO-5AP, the “EXT ID” packet 5208 and/or the “UI Param” packet 5212 are optionally sent and received during a break in wireless power transfer. For example, wireless power is transferred during the power transfer step S214. During a period of time (e.g., a break) in which the battery of the PRx is not receiving power from the PTx, the “EXT ID” packet 5208 and/or the “UI Param” packet 5212 are optionally sent and received, and the wireless power transfer optionally resumes (e.g., via the power transfer step 5218) afterwards.

In some embodiments, the communication circuitry is adapted to decode the first identifying data from the one or more power transfer signals using a frequency shift keying decoder (e.g., because the charging source has encoded the first identifying data using frequency shift keying on the one or more power transfer signals, before transmitting the one or more power transfer signals to the power transfer coils of the computer system). In some embodiments, the computer system (e.g., the communication circuitry of the computer system or another charging component of the computer system) decodes the second identifying data from the one or more power transfer signals using a frequency shifting keying decoder (e.g., because the charging source has encoded the second identifying data using frequency shift keying on the one or more power transfer signals, before transmitting the one or more power transfer signals to the power transfer coils of the computer system). For example, as described with reference to FIGS. 5AO and 5AP, in some embodiments, the PRx 5184 receives the “EXT ID” packet 5208 and/or the “UI Param” packet 5212 (e.g., via in-band communication enabled by a power transfer signal, e.g., from the power transfer step S214), and uses a frequency shift keying decoder to decode the power transfer signal and obtain the “EXT ID” packet 5208 and/or the “UI Param” packet 5212.

In some embodiments, the communication circuitry is adapted to: before the power transfer coil receives the one or more power transfer signals, transmits a request for identifying data to the charging source (e.g., using amplitude shift keying on received power transfer signals, or using other out-of-band communication means), wherein the first identifying data is transmitted to the computer system in the one or more power transfer signals by the charging source in response to receiving the request from the communication circuit (e.g., through the power transfer coil of the computer system). In some embodiments, before receiving the one or more power transfer signals that includes the second identifying data from the charging source, the computer system transmits a request for identifying data to the charging source (e.g., using amplitude shift keying on received power transfer signals, or using other out-of-band communication means), wherein the second identifying data is transmitted to the computer system in the one or more power transfer signals by the charging source in response to receiving the request from the computer system (e.g., by the communication circuit via the power transfer coil of the computer system). In some embodiments, the charging source does not send identity data until it has received the request from the computer system. For example, in FIG. 5AP, the PRx 5184 (e.g., the computer system) sends a “GET” request 5206 to the PTx 5174 (e.g., the charging source), which then causes the PTx 5174 to send the “EXT ID” packet 5208 to the PRx 5184.

In some embodiments, the communication circuit is adapted to encode, using an amplitude shift keying encoder, the request for identifying data in a respective power transfer signal (e.g., a power transfer signal that was between the charging source and the computer system before receiving the one or more power transfer signals including the first identifying data). In some embodiments, the computer system or the communication circuit thereof, encodes, using an amplitude shift keying encoder, the request for identifying data in a respective power transfer signal (e.g., a power transfer signal that was between the charging source and the computer system before receiving the one or more power transfer signals including the second identifying data). In some embodiments, the charging source detects (e.g., using an ASK decoder) the request in the respective power transfer signal, and in response to the request, encodes (e.g., using an FSK encoder) identifying data in one or more subsequent power transfer signals when the one or more subsequent power transfer signals are transmitted to the computer system. In some embodiments, the computer system suspends the active charging of the battery of the computer system when sending the request and receiving subsequent power transfer signals to decode the identifying data in the subsequent power transfer signals. In some embodiments, once the decoding of the identifying data is completed, the computer system resumes charging using power transfer signals received from the charging source which may or may not include identifying data of the charging source (e.g., using the rectifier to provide the power transfer signals to the battery to increase the charge level of the battery). In some embodiments, the charging source does not require a request from the computer system before sending the respective identifier of the charging source to the computer system in the one or more power transfer signals. In some embodiments, the power transfer signals transmitted from the charging source and the computer system includes AC signals sent via wireless power coils (e.g., converting magnetic flux to and from voltage, and/or current seen by downstream electronics), and when the computer system decides to send a request and/or other types of communication data packets to the charging source, the computer system, optionally, perturbs the ongoing AC signals in a manner that encodes the request and/or other types of communication data packets, where the charging source detects such perturbance and decodes the request and/or communication data packets and responds accordingly. The computer system ceases to perturb the ongoing AC signals when the transmission of the request and/or other types of data packets are completed (e.g., while the AC signals persist between the computer system and the charging source, to charge the battery and provide a carrier for additional communication packets to be transmitted). In some embodiments, the charging source encodes the respective identifier of the charging source using frequency shift keying on the one or more power transfer signals before sending the one or more power transfer signals to the computer system. For example, as described with reference to FIGS. 5AO and 5AP, in some embodiments, the PRx 5184 encodes the packet 5408 and/or the packet 5210 using amplitude shift keying.

In some embodiments, the communication circuitry is adapted to decode the one or more power transfer signals that carry a payload, wherein the payload encodes an identifier (e.g., a UUID, a serial number, or another type of identifying data) of the charging source. In some embodiments, the UUID is digitally encoded in a sequence of bits (e.g., 20 bits, 23 bits, 31 bits, 39 bits, or another finite number of bits) in the payload. In some embodiments, the computer system obtains the identifier of the charging source and compares it to one or more stored identifiers of previously encountered charging sources that have corresponding sets of customization parameters for the respective customizable user interface. In some embodiments, the identifier is a unique identifier. In some embodiments, the identifier is not necessarily a unique identifier, and the payload carries an indicator that indicates whether the identifier in the same payload is unique or not unique to the charging source. In some embodiments, the computer system determines, based on whether the indicator value corresponds to a unique ID or a non-unique ID, whether to decode the identifier and/or whether to carry out additional steps to personalize and/or customize the behavior of the computer system in accordance with the identifier of the charging source. For example, in FIG. 5AQ, the payload portion (e.g., bytes B₅-B₈) of the data packet includes an indicator in bit b₇ of the byte B₅ and a unique ID of the PTx. If the bit b₇ is set to a first value (e.g., TRUE, unique, customize, or 0) that indicates the identifier in B₅ is unique to the PTx, the computer system performs personalization and/or customization based on the identifier (e.g., displaying a version of the customizable user interface that is configured in accordance with configuration parameters stored in association with the identifier, or recording customization made during the time that the computer system is coupled to the charger). If the bit b₇ is set to a different value (FALSE, non-unique, generic, or 1) that indicates the identifier in B₅ is not unique to the PTx, the computer system forgoes performing personalization and/or customization based on the identifier and performs generic or non-customized operations (e.g., displaying a generic version of the customizable user interface). As another example, in FIG. 5AS, the payload portion includes an indicator in the “Mfg Reserved” portion (e.g., bytes B₆ bit b₂-B₈) that indicates whether the “ID” portion (e.g., bytes B₄ bit b₆-B₆ bit b₃) is intended as a unique identifier. As another example, in FIG. 5AT, the payload portion includes an indicator in the reserved portion (e.g., at B0b0) that indicates whether the “ID” portion (e.g., bytes B₄ bit b₆-B₆ bit b₃) is intended as a unique identifier.

In some embodiments, the communication circuitry is adapted to decode the payload, where the payload includes a first portion that encodes an indicator that specifies whether a second portion of the payload following the first portion includes a respective identifier that uniquely corresponds to a respective charging source (e.g., the first identifying data that corresponds to a first identity of a charging source, the second identifying data that corresponds to a second identity of another charging source, or other identifying data that corresponds to a third identity of yet another different charging source). In some embodiments, different charging sources are represented by different identifying data that are carried in the power transfer signals in the different charging sources. In some embodiments, the first portion of the payload is a single bit or a sequence of bits that can be set to indicate whether or not the second portion of the payload includes identifying data for the charging source and should be decoded according to a standard format to obtain a unique identifier of the charging source. In some embodiments, the first portion of the payload optionally include additional space to accommodate additional information such as where the second portion of the payload is located in the payload, how long is the second portion of the payload is, and/or other properties of the second portion of the payload. In some embodiments, if the computer system determines that the identifier stored in the payload of the power transfer signals do not match any stored identifiers of previously encountered charging sources, the computer system optionally stores the identifier as the identifier of the currently coupled charging source, and records various customization that occur while the charging source is connected as customization parameters for the charging source. In some embodiments, the identifier is a unique identifier. In some embodiments, the identifier is not necessarily a unique identifier, and the payload carries an indicator that indicates whether the identifier in the same payload is unique or not unique to the charging source. In some embodiments, the computer system determines, based on whether the indicator value corresponds to a unique ID or a non-unique ID, whether to decode the identifier and/or whether to carry out additional steps to personalize and/or customize the behavior of the computer system in accordance with the identifier of the charging source. In various examples described herein, unless otherwise made clear, it is to be understood that an identifier carried in the payload of a transmitter identification data packet is not necessarily unique to the charging source, and that the computer system ascertains whether the identifier is unique or not unique based on an indicator that is carried in the payload. The computer system performs customization and/or forgoes customization based on the identifier depending on the indicator value and/or whether the identifier is determined to be unique or non-unique to the charging source, in accordance with some embodiments. For example, in FIG. 5AQ, the payload portion (e.g., bytes B₅-B₈) of the data packet includes an indicator in bit b₇ of the byte B₅ (e.g., a first portion of the payload) and a unique ID (a second portion of the payload). If the bit b₇ is set to a first value (e.g., TRUE, unique, customize, or 0) that indicates the identifier in B₅ is unique to the PTx, the computer system performs personalization and/or customization based on the identifier (e.g., displaying a version of the customizable user interface that is configured in accordance with configuration parameters stored in association with the identifier, or recording customization made during the time that the computer system is coupled to the charger). If the bit b₇ is set to a different value (FALSE, non-unique, generic, or 1) that indicates the identifier in B₅ is not unique to the PTx, the computer system forgoes performing personalization and/or customization based on the identifier and performs generic or non-customized operations (e.g., displaying a generic version of the customizable user interface).

In some embodiments, the first portion of the payload is a single bit in length and the second portion of the payload is 31 bits in length (e.g., the first portion of the payload combined with the second portion of the payload constitute a 4-byte block in the payload). In some embodiments, the second portion of the payload follows immediately after the first portion of the payload, in accordance with some embodiments. In some embodiments, the second portion of the payload does not immediately follow the first portion of the payload, and there may be other intermediate portions that encode other information or is empty, in accordance with some embodiments. In some embodiments, the first portion of the payload and the second portion of the payload are consecutive and the total length of the first portion and the second portion of the payload is an integer number of bytes. In some embodiments, the first portion of the payload and the second portion of the payload are respectively 2 bits and 30 bits, 3 bits and 29 bits, four bits and 28 bits, 5 bits and 27 bits, 6 bits and 26 bits, 7 bits and 27 bits, 8 bits and 24 bits, 1 bit and 39 bits, 2 bits and 38 bits, . . . , 1 bit and 47 bits, 2 bits and 46 bits, . . . , 1 bits and 55 bits, 2 bits and 54 bits, . . . . 1 bit and 63 bits, 2 bits and 62 bits, . . . , 8 bits and 56 bits, and other combinations that result in an integer number of bytes. For example, in FIG. 5AQ, the payload portion (e.g., bytes B₅-B₈) of the data packet includes an indicator in bit by of the byte B₅ (e.g., the “indicator” that is a first portion of the payload, and is 1 bit in length) and a unique ID (a second portion of the payload that is 31 bits in length). In various embodiments, the indicator can have other lengths (e.g., 2 bits, 3 bits, 4 bits, or other number of bits) and combined with the length of the identifier (unique or non-unique) result in an integer number of bytes (e.g., 4 bytes, 8 bytes, 12 bytes, or other number of bytes).

In some embodiments, the communication circuitry is adapted to decode the one or more power transfer signals that carry a header before the payload, and the header indicates whether the one or more power transfer signals includes a wireless power transfer transmitter identification packet in accordance with the Wireless Power Consortium Qi charging protocol (e.g., the header specifies whether the payload carried by the power transfer signals includes any identifying data for the charging source, and/or whether identifying data is unique to the charging source)). For example, as described with reference to FIG. 5AQ, the data packet includes a preamble (“0 (selector)”) and/or reserved portions (e.g., as shown in B₀-B₄), which optionally include a header (e.g., that identifies the type of packet and/or protocol information for the data packet).

In some embodiments, the operations include: while displaying the respective customizable user interface (e.g., the first customizable user interface, the second customizable user interface, a customizable user interface that is associated with another known identity of the charging source, or a default version of the customizable user interface, depending on whether identifying data for a known identity has been obtained in the received power transfer signals from the charging source), receiving one or more user inputs configuring (e.g., updating) a respective set of customization parameters for the respective customizable user interface; and in accordance with a determination that the power transfer signals include a respective identifier of the charging source that uniquely corresponds to the charging source (e.g., in accordance with a determination that an indicator portion of the payload of the transmitter identification data packet has a value that indicates that an identifier in the payload is unique to the charging source), storing the respective set of customization parameters as configured by the one or more user inputs in association with the respective identifier of the charging source. For example, as described with reference to step S0014 in FIG. 5AR, while the first customizable user interface is displayed, the PRx may detect (e.g., via one or more input mechanisms of the PRx) one or more user inputs configuring one or more aspects of the first customizable user interface. The PRx may update a first set of customization parameters (e.g., stored in memory of the PRx) that is associated with the unique ID, and/or the PRx may establish and/or store a second set of second customization parameters for the first customizable user interface that is associated with the unique ID.

In some embodiments, the operations include: after storing the respective set of customization parameters in association with the respective identifier of the charging source, detecting that the computer system is decoupled from the charging source and ceasing to display the respective customizable user interface that were configured in accordance with the one or more user inputs; after detecting that the computer system is decoupled from the charging source and ceasing to display the respective customizable user interface that was configured in accordance with the one or more user inputs, detecting a subsequent event (e.g., detecting that the computer system is coupled to a respective charging source, detecting that the computer system is turned into the first orientation, and/or detecting that the computer system is entering into a low power mode or a locked state), where the first criteria are met as a result of the subsequent event (e.g., the first criteria require that the computer system is coupled to a charging source, the computer system is in the first orientation, and optionally, that the computer system is entering into a low power mode or locked mode while it is being charged and in the first orientation); and in response to detecting the subsequent event, in accordance with a determination that the computer system is coupled to a respective charging source and that an identifier encoded in one or more power transfer signals received from the respective charging source matches the respective identifier (e.g., the computer system receives one or more power transfer signals from the respective charging source, (optionally, in accordance with a determination that an indicator portion of the payload of the transmitter identification data packet has a value that indicates that an identifier in the payload is unique to the charging source) decodes the identifier of the respective charging source from the one or more charging signals as described herein, compares the decoded identifier with one or more stored identifiers of previously encountered charging sources, including but not limited to the respective identifier of the charging source, and recognizes that the decoded identifier of the respective charging source that is currently coupled to the computer system matches the respective identifier of the charging source that was previously coupled to the computer system), redisplaying the respective customizable user interface in accordance with the respective set customization parameters that is stored in association with the respective identifier of the charging source. For example, as described with reference to step S0014 in FIG. 5AR, if the PRx and the PTx are decoupled and/or moved out of proximity of one another, and then subsequently recoupled and/or moved back within proximity of one another, the PRx displays the customized user interface with the updated first set of customization parameters and/or with the second set of second customization parameters for the first customizable user interface.

The foregoing describes exemplary embodiments of wireless power transfer systems that are able to negotiate enhanced/extended operating modes while remaining compliant with wireless power transfer standards that do not support such enhanced/extended operating modes. Such systems may be used in a variety of applications but may be particularly advantageous when used in conjunction with personal electronic devices such as mobile computing devices (e.g., laptop computers, tablet computers, smart phones, and the like) and their accessories (e.g., wireless earphones, styluses and other input devices, etc.) as well as wireless charging accessories (e.g., charging mats, pads, stands, etc.). Although numerous specific features and various embodiments have been described, it is to be understood that, unless otherwise noted as being mutually exclusive, the various features and embodiments may be combined various permutations in a particular implementation. Thus, the various embodiments described above are provided by way of illustration only and should not be constructed to limit the scope of the disclosure. Various modifications and changes can be made to the principles and embodiments herein without departing from the scope of the disclosure and without departing from the scope of the claims.

The foregoing describes exemplary embodiments of wireless power transfer systems that are able to transmit certain information amongst the PTx and PRx in the system. The present disclosure contemplates this passage of information improves the devices' ability to provide wireless power signals to each other in an efficient and non-damaging manner to facilitate battery charging. It is contemplated some implementers of the present technology may consider the passage of identifiers, such as serial numbers, UIDs, manufacturer IDs, MAC addresses, or the like, to aide in the limited identification of PTx's and PRx's to one another.

Entities implementing the present technology should take care to ensure that, to the extent any sensitive information is used in particular implementations, that well-established privacy policies and/or privacy practices are complied with. In particular, such entities would be expected to implement and consistently apply privacy practices that are generally recognized as meeting or exceeding industry or governmental requirements for maintaining the privacy of users. Implementers should inform users where personally identifiable information is expected to be transmitted in a wireless power transfer system, and allow users to “opt in” or “opt out” of participation. For instance, such information may be presented to the user when they place a device onto a power transmitter.

It is the intent of the present disclosure that personal information data, if any, should be managed and handled in a way to minimize risks of unintentional or unauthorized access or use. Risk can be minimized by limiting the collection of data and deleting data once it is no longer needed. In addition, and when applicable, data de-identification can be used to protect a user's privacy. For example, a device identifier may be partially masked to convey the power characteristics of the device without uniquely identifying the device. Also, the device identifier could identify a unit (similar to the way a serial number identifies an electronic unit without more) but need not identify a user of the device. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy. Robust encryption may also be utilized to reduce the likelihood that communication between inductively coupled devices are spoofed.

FIGS. 6A-6AJ show exemplary methods for switching between, interacting with, and configuring different operational modes (e.g., ambient modes) of the computer system 100.

In FIG. 6A, the computer system 100 displays a clock user interface 6000 (e.g., corresponding to a time or clock ambient mode of the computer system 100), as the display of the computer system 100 is in a landscape orientation and is connected to the charging source 5056. In some embodiments, the computer system 100 ceases to display the clock user interface 6000 if the display of the computer system 100 is no longer in the landscape orientation, or if the computer system 100 is no longer connected to the charging source 5056. While displaying the clock user interface 6000, the computer system 100 detects a user input 6002 (e.g., an upward swipe input).

In response to detecting the user input 6002, and as shown in FIG. 6B, the portable multifunction device displays a clock user interface 6004 (e.g., a variation of a clock user interface corresponding to the time or clock ambient mode of the computer system 100). In comparison to FIG. 6A, the hour and minutes of the clock user interface 6004 are shown with a different appearance (e.g., a different font), and the background of the clock user interface 6004 is different from the clock user interface 6000.

In some embodiments, different clock user interfaces for the time or clock ambient mode of the computer system 100 include one or more additional differences not shown in FIGS. 6A and 6B. For example, some clock user interfaces may display additional time information (e.g., seconds, in addition to the hour and the minutes), or may display an analog clock face instead of a digital clock face. In some embodiments, different clock user interfaces have different colored backgrounds, different background images, different animated backgrounds, and/or different visual effects (e.g., as compared to other clock user interfaces).

In some embodiments, in response to detecting a user input 6006 (e.g., a swipe input in a direction opposite the swipe input 6002 in FIG. 6A), the computer system 100 redisplays the clock user interface 6000. In other words, a user of the computer system 100 can cycle through different clock user interfaces for the time or clock ambient mode by swiping in a first direction, and can reverse the direction through which the different clock user interfaces are cycled by swiping in a second direction that is the reverse of the first direction.

In FIG. 6C, while displaying the clock user interface 6004, the computer system 100 detects a user input 6008 (e.g., a tap input) directed to the clock user interface 6004. In response to detecting the user input 6004, the computer system 100 may display additional information relating to the current time, and/or generate audio feedback 6010.

In some embodiments, the user input 6008 is a continuous input (e.g., a long press input), and as shown in FIG. 6D, the computer system 100 displays additional information relating to the current time (e.g., the current time in different locations for one or more contacts who have shared their location with the user of the computer system 100) while the user maintains the user input 6008 (represented by the dotted outline of the user input 6008 in FIG. 6D). In some embodiments, the computer system 100 generates audio feedback 6010 as long as the computer system 100 detects the user input 6008. In some embodiments, the additional information is displayed in a separate user interface (e.g., a user interface 6012, in FIG. 6D). In some embodiments, the user interface 6012 replaces displays of the clock user interface 6004 (e.g., as long as the computer system 100 detects the user input 6008). In some embodiments, the user interface 6012 is displayed overlaid over a portion of the clock user interface 6004 (e.g., such that at least a portion of the clock user interface 6004 is displayed concurrently with the user interface 6012).

In FIG. 6E, in response to detecting termination of the user input 6008, the computer system 100 ceases to display the additional information and displays (e.g., or redisplays) the clock user interface 6004.

In some embodiments, the computer system 100 automatically displays a different clock user interface (e.g., without any user input). In FIG. 6F, the current time is now 10:00, which is one hour later than the current time in FIG. 6E, and the computer system 100 displays a clock user interface 6014. The hour and minutes in the clock user interface 6014 are displayed with a different appearance compared to the clock user interface 6004 (e.g., of FIG. 6E) and the clock user interface 6000 (e.g., of FIG. 6A), and the background of the clock user interface 6014 is also different from the backgrounds of the clock user interface 6004 and the clock user interface 6000.

In some embodiments, the computer system 100 switches to a different clock user interface for the time or clock ambient mode of the computer system 100 every hour. In some embodiments, the computer system 100 automatically displays a different clock user interface after a threshold duration of time (e.g., 5 minutes, 10 minutes, 30 minutes, 1 hour, 2 hours, 6 hours, 12 hours, or 1 day). While displaying the clock user interface 6014, the computer system 100 detects a user input 6016 (e.g., an upward swipe input). In some embodiments, the user input 6016 is the same type of user input as the user input 6002 in FIG. 6A (e.g., both are upward swipe inputs).

In some embodiments, the user can configure the order in which the different clock user interfaces for the time or clock ambient mode of the computer system 100 are displayed (e.g., via a settings user interface for configuring settings for the time or clock ambient mode).

In response to detecting the user input 6016, and as shown in FIG. 6G, the computer system 100 displays a clock user interface 6018. In some embodiments, the clock user interface 6018 is a clock user interface corresponding to a time or clock ambient mode of the computer system 100. In some embodiments, the clock user interface 6018 is a user interface corresponding to a sleep or night clock ambient mode (e.g., that is distinct from the time or clock ambient mode) of the computer system 100.

In some embodiments, one or more clock user interfaces corresponding to the time or clock ambient mode have both a daytime (or light) version, and a night time (or dark) version. For example, the daytime/light version of the clock user interface 6014 is shown in FIG. 6F. A corresponding night time/dark version of the clock user interface 6014 would have a different appearance (e.g., a black background with the current time in white, similar to the color scheme of the clock user interface 6018 in FIG. 6G, but with otherwise the same appearance of the clock user interface 6014 in FIG. 6F).

While displaying the clock user interface 6018, the computer system 100 detects a user input 6020 (e.g., an upward swipe input) directed to the clock user interface 6018. In response to detecting the user input 6020, and as shown in FIG. 6H, the computer system 100 displays a clock user interface 6022 that corresponds to the time or clock ambient mode of the computer system 100.

The clock user interface 6022 includes a visual representation of multiple time zones (e.g., a sinusoidal shape representing the different time zones, with a vertical, dashed line indicating the current time zone for the computer system 100). In some embodiments, contacts that have shared a location with the user of the computer system 100 are displayed in the clock user interface 6022, with a visual representation at a location corresponding to the time zone of the contact's shared location. For example, a contact “Amy” has a shared location in France, and the clock user interface 6022 includes an indicator 6024 corresponding to the user “Amy.” The indicator 6024 appears ahead of (e.g., to the right of) the current time zone (e.g., Pacific Time) for the computer system 100 (e.g., as the CET/CEST time zone is 8 to 9 hours ahead of the PST/PDT time zone). Similarly, a contact “Jon” has a shared location in South Korea, and the clock user interface 6022 includes an indicator 6026 corresponding to the user “Jon.” The indicator 6026 appears ahead of both the current time zone and the indicator 6024 (e.g., as the KST time zone is ahead of both the CET/CEST time zones and the PST/PDT time zones).

While displaying the clock user interface 6022, the computer system 100 detects a user input 6028 (e.g., a long press input) directed to the clock user interface 6022.

In response to detecting the user input 6028, and as shown in FIG. 61, the computer system 100 displays an editing user interface 6030. The editing user interface 6030 includes a representation 6038 that corresponds to the clock user interface 6022 of FIG. 6H. The representation 6038 includes an affordance 6042, which when activated, enables editing and/or configuration of the clock user interface 6022 (e.g., the clock user interface corresponding to the representation 6038). The editing user interface 6030 also includes a representation 6036 that corresponds to the clock user interface 6018 of FIG. 6G, a representation 6040 that corresponding to the clock user interface 6000 of FIG. 6A, a “Cancel” affordance 6032 (e.g., for exiting and/or ceasing to display the editing user interface 6030, without saving any changes) and a “Done” affordance 6034 (e.g., for saving changes and exiting and/or ceasing to display the editing user interface 6030).

In response to detecting a user input 6044 (e.g., an upward swipe input), the computer system 100 scrolls display of the representations of clock user interfaces. In some embodiments, the user input 6044 can be scrolled in an opposite direction (e.g., a downward swipe input) to scroll display of the representations of clock user interfaces in an opposite direction. In some embodiments, the representations of clock user interfaces are displayed in the same order through which the user navigates through the clock user interfaces while the time or clock ambient mode is active for the computer system 100 (e.g., the same order as shown in FIG. 6A-6H).

In some embodiments, the user can continuously cycle through the representations of clock user interfaces (e.g., multiple times) in the editing user interface 6030, without needing to scroll in a reverse direction. For example, the representation 6038 is the “last” representation in the ordered representations, and the representation 6040 is the “first” representation in the ordered representations. Upon reaching the end of the order (e.g., upon displaying the representation 6038 in the focal or central region of the editing user interface 6030), the user can continue scrolling to display the representation 6040 in the focal or central region of the editing user interface 6030 (e.g., and continue scrolling through the representations again).

In FIG. 6J, in response to detecting the user input 6044, the computer system 100 scrolls display of the representations of clock user interfaces. The representation 6038 scrolls upward (e.g., and is now in the position occupied by the representation 6036 in FIG. 6I), and the representation 6040 is displayed in the focal or central region of the editing user interface 6030 (e.g., the position occupied by the representation 6038 in FIG. 6I). The representation 6040 includes an affordance 6048 (e.g., an analogous affordance to the affordance 6042 in FIG. 6I).

The computer system 100 detects a user input 6046 (e.g., a tap input) directed to the affordance 6048. In response to detecting the user input 6046, and as shown in FIG. 6K, the computer system 100 displays an editing user interface 6050. The editing user interface 6050 includes the representation 6040 (e.g., to indicate the clock face that is currently being edited), as well as a “Cancel” affordance 6052 (e.g., for exiting and/or ceasing to display the editing user interface 6050, without saving any changes) and a “Done” affordance 6054 (e.g., for saving changes and exiting and/or ceasing to display the editing user interface 6050). The editing user interface 6050 include region 6058 that includes a plurality of affordances for modifying an appearance of the clock user interface 6000 (e.g., that is represented by the representation 6040). In some embodiments, the affordances for modifying the appearance of the clock user interface 6000 are color affordances, which when selected, modify the background of the clock user interface 6000 to use the selected color. In FIG. 6K, a color affordance 6060 has a thicker border to indicate the current color that is in use by the clock user interface 6000.

While displaying the editing user interface 6050, the computer system 100 detects a user input 6064 (e.g., a tap input) directed to a color affordance 6062. In response to detecting the user input 6062, the computer system 100 updates the display of the representation 6050 to include a color corresponding to the color affordance 6062. The border of the color affordance 6062 is also updated (e.g., to have a thicker border, as compared to FIG. 6K), and the border of the color affordance 6060 is updated to have a default appearance (e.g., a normal sized or default sized border). The computer system 100 also configures the clock face 6000, which corresponds to the representation 6040, to have an appearance that mirrors the appearance shown by the representation 6040 in FIG. 6L.

After updating the display of the representation 6040, the computer system 100 detects a user input 6066 (e.g., a tap input) directed to the “Done” affordance 6064. In response to detecting the user input 6066, and as shown in FIG. 6M, the computer system 100 ceases to display the editing user interface 6050, and redisplays the editing user interface 6030.

After redisplaying the editing user interface 6030, the computer system 100 detects a user input 6068 (e.g., a tap input) directed to the “Done” affordance 6034. In response to detecting the user input 6068, and as shown in FIG. 6N, the computer system 100 redisplays the clock user interface 6000. In comparison to FIG. 6A, the clock user interface 6000 has a different background color (e.g., the new background color selected by the user in FIGS. 6K-6L).

While displaying the (updated) clock user interface 6000, the computer system 100 detects a user input 6070 (e.g., a leftward swipe input) directed to the clock user interface 6000. In some embodiments, the user input 6000 is detected in any region of the clock user interface 6000. In some embodiments, the user input is detected in a predetermined region of the clock user interface (e.g., the leftward swipe input is detected along a bottom edge of the computer system 100, as illustrated by an optional input 6072).

In response to detecting the user input 6070 (or the user input 6072), and as shown in FIG. 6O, the computer system 100 replaces display of the clock user interface 6000 with display of a voice memo user interface 6074. The voice memo user interface 6074 corresponds to a voice memo ambient mode of the computer system 100. The voice memo user interface 6074 includes an affordance 6076 (e.g., which when activated, via a user input 6078 (e.g., a tap input) begins recording a voice memo). In some embodiments, the voice memo user interface 6074 includes one or more visual elements related to a voice recording function of the computer system 100 (e.g., wave forms corresponding speech and/or sound detected by one or more sensors of the computer system 100).

While displaying the voice memo user interface 6074, the computer system 100 detects a user input 6080 (e.g., an upward swipe input) directed to the voice memo user interface 6074. In response to detecting the user input 6080, and as shown in FIG. 6P, the computer system 100 displays a voice memo user interface 6082. The voice memo user interface 6082 includes previously recorded voice memos (e.g., if any previously recorded voice memos are stored in memory of the computer system 100, and are available for playback). For example, in FIG. 6P, the computer system 100 displays 3 voice memos that were previously recorded on March 8, March 6, and February 29. In some embodiments, the previously recorded voice memos are listed in reverse chronological order (e.g., the most recently recorded voice memos are listed above older voice memos). In some embodiments, the order of the previously recorded voice memos is user configurable (e.g., via a settings user interface, or through manual user inputs that re-order the previously recorded voice memos within the voice memo user interface 6082). In some embodiments, the user can redisplay the voice memo user interface 6074 (of FIG. 6O) by performing a downward swipe input 6086 (e.g., by performing an input that moves in an opposite direction, as compared to the user input 6080 in FIG. 6O). In some embodiments, if additional voice memo user interfaces are available for display, the computer system 100 displays the additional voice memo user interfaces in response to detecting further user inputs that are analogous to the user input 6080 in FIG. 6O (e.g., in response to detecting an additional upward swipe gesture directed to the voice memo user interface 6082).

While displaying the voice memo user interface 6082, the computer system 100 detects a user input 6088 (e.g., a leftward swipe input) directed to the voice memo user interface 6082. In response to detecting the user input 6088, and as shown in FIG. 6Q, the computer system 100 displays an ambient sound user interface 6090 that corresponds to an ambient sound ambient mode of the computer system 100. In some embodiments, the computer system 100 also generates audio feedback (e.g., thunderstorm sounds) corresponding to the ambient sound user interface 6090, while displaying a visual representation of the audio feedback (e.g., a cloud and lightning bolts, which represents a thunderstorm).

While displaying the ambient sound user interface 6090 (e.g., and while outputting the audio feedback corresponding to the ambient sound user interface 6090), the computer system 100 detects a user input 6092 (e.g., an upward swipe input). In response to detecting the user input 6092, and as shown in FIG. 6R, the computer system 100 displays an ambient sound user interface 6094 (e.g., that corresponds to an ocean or water ambient sound). The ambient sound user interface 6094 includes a visual representation of a wave (e.g., that corresponds to the ocean and/or water), and the computer system 100 generates audio feedback (e.g., ocean, wave, and/or running water sounds) corresponding to the ambient sound user interface 6094. In some embodiments, the ambient sound user interface 6094 includes a different background (or other visual differences) compared to the ambient sound user interface 6090, which provides improved visual feedback to the user regarding which ambient sound is playing.

While displaying the ambient sound user interface 6090, the computer system 100 detects a user input 6096 (e.g., a leftward swipe input) directed to the ambient sound user interface 6090. In response to detecting the user input 6096, and as shown in FIG. 6S, the computer system 100 displays a media user interface 6098 that corresponds to a visual media ambient mode of the computer system 100. The media user interface 6098 includes a first media item (e.g., a photo, a video, or other visual media item), and optionally includes a chrome 6100 (e.g., that displays the current time, the current date, and/or a caption corresponding to the first media item). For case of discussion, the descriptions below sometimes refer to a photo, but the descriptions are applicable to any suitable visual media item (e.g., photos, videos, animations, animated photograph, or other visual media item).

In FIG. 6T, the computer system 100 automatically displays a media user interface 6102 (e.g., that includes a second media item, different from the first media item of FIG. 6S) after a threshold amount of time has elapsed (e.g., the computer system 100 changes the displayed media item every hour, so displays the first media item in FIG. 6S at 10:00, and the second media item in FIG. 6T at 11:00). The media user interface 6102 includes a chrome 6104 (e.g., that is analogous to the chrome 6100 in FIG. 6S, but updated based on the current time in FIG. 6T, and with the appropriate caption that corresponds to the second media item shown in the media user interface 6102). In some embodiments, the computer system 100 switches between media items only from a particular category (e.g., the computer system 100 switches between photos of a particular user-specified album). In some embodiments, the computer system 100 switches between any media item stored in memory of the computer system 100. In some embodiments, the computer system 100 switches between a subset of media items that are organized in a method other than the particular category (e.g., a user-configured subset of media items, a subset of media items grouped by person and/or pet, a subset of media items grouped by location, and/or a subset of media items grouped by time).

While displaying the media user interface 6102 that includes the chrome 6104, the computer system 100 detects a user input 6106 (e.g., a tap input) directed to the chrome 6104. In response to detecting the user input 6106, and as shown in FIG. 6U, the computer system 100 displays a media application user interface 6001.

The media application user interface 6001 includes representations of media items stored in memory of the computer system 100, such as a representation 6003 of a first media item (e.g., the media item in the media user interface 6098 of FIG. 6S), a representation 6005 of a second media item (e.g., the media item in the media user interface 6102 of FIG. 6T), and a representation 6007 of a third media item. In some embodiments, in response to detecting a user input 6013 (e.g., a long press input) on a representation of a media item, the computer system 100 displays a media user interface (e.g., corresponding to the visual media ambient mode of the computer system 100) that includes a media item represented by the representation 6013 (e.g., a media user interface 6110 in FIG. 6Z).

In some embodiments, in response to detecting a user input 6015 (e.g., a tap input) on the representation 6005, and as shown in FIG. 6V, the computer system 100 displays a media user interface 6017. The media user interface 6017 includes a media item 6019 (e.g., the media item represented by the representation 6015 in FIG. 6U), along with affordances for interacting with (e.g., favoriting, editing, displaying additional information regarding, deleting, copying, duplicating, hiding, and/or organizing) the media item 6019 (e.g., the affordance shown along the top edge of the media user interface 6017 in FIG. 6V), and a back affordance 6021 for redisplaying the media user interface 6001. The media user interface 6017 also includes representations of additional media items (e.g., along a bottom edge of the media user interface 6017) that allow the user to quickly navigate to other media items if desired. In some embodiments, the representations of additional media items include additional media items that are organized together with the media item 6019 (e.g., are part of the same category, the same album, are taken within the same time period, are taken from the same location, and/or have the share the same subject matter (e.g., people and/or pets) as the media item 6019).

While displaying the media user interface 6017, the computer system 100 detects a user input 6023 (e.g., a tap user input) directed to the back affordance 6021. In FIG. 6W, in response to detecting the user input 6023, the computer system 100 redisplays the media user interface 6001 (e.g., the same media user interface 6001 of FIG. 6U).

In some embodiments, the media application user interface 6001 is a user interface of a media application of the computer system 100 (e.g., the same application user interface 6001 that would be displayed if the user opened or launched the media application while the computer system 100 was not in the ambient mode (e.g., from a regular home screen of the computer system 100, such as the user interface shown in FIG. 5F). In some embodiments, the computer system 100 exits the ambient mode (e.g., the visual media ambient mode) and displays the media application user interface 6001 (e.g., and the upward/downward inputs and/or leftward/rightward swipe inputs described above for switching between variation of ambient mode user interfaces and/or different ambient modes are not available while displaying the media application user interface 6001 in FIG. 6W, as the computer system 100 has exited the ambient mode).

In some embodiments, the computer system 100 remains in the ambient mode while displaying the media application user interface 6001. The user can redisplay an ambient mode user interface (e.g., the media user interface 6102 in FIG. 6T) by performing a user input 6025 (e.g., an upward swipe input that starts from a bottom edge of the computer system 100) or a user input 6027 (e.g., actuating a physical button of the computer system 100, such as a lock button or home button).

In FIG. 6X, in response to detecting the user input 6025, the computer system 100 redisplays the media user interface 6102. While displaying the media user interface 6012, the computer system 100 detects a user input 6029 (e.g., a tap input) in a region of the media user interface 6102 that does not include the chrome 6104 (e.g., the user input 6106 is not detected in the upper right corner, or along the bottom edge, of the media user interface 6102).

In response to detecting the user input 6029, and as shown in FIG. 6Y, the computer system 100 ceases to display the chrome 6104 (e.g., in FIG. 6Y, no time, date, or caption is displayed). While displaying the user interface 6102, without the chrome 6104, the computer system 100 detects a user input 6108 (e.g., a tap input) directed to a right edge of the computer system 100.

In response to detecting the user input 6108, and as shown in FIG. 6Z, the computer system 100 displays a media user interface 6110. In response to detecting additional user input (e.g., a user input 6113, again directed to the right edge of the computer system 100), the computer system 100 displays a different media user interface (e.g., other than the media user interface 6098, 6102, and/or 6110). In some embodiments, in response to detecting a user input 6111 (e.g., a tap input) directed to a left edge of the computer system 100, the computer system 100 redisplays the media user interface 6102 of FIG. 6Y. In some embodiments, a user input directed to a first edge of the computer system 100 allows the user to navigate through media items in a first order, and a user input directed to a second edge that is opposite the first edge of the computer system 100 allows the user to navigate through media items in the reverse order of the first order.

In some embodiments, the user can perform user inputs directed to the left and/or right edge of the computer system 100 in order to navigate through media items in a first category (e.g., photos in a first album, including photos from a trip to the park), or media items of a first category (e.g., pets). To navigate to media items of a different category, the user performs a different user input. For example, while displaying the media user interface 6110, the computer system 100 detects a user input 6112 (e.g., an upward swipe gesture) directed to the media user interface 6110.

In response to detecting the user input 6112, and as shown in FIG. 6AA, the computer system 100 displays a media user interface 6114. In some embodiments, the media user interface 6114 includes a media item from a different category (e.g., photos from a different album that includes photos from a birthday party), and/or photos of a different category (e.g., people).

In FIG. 6AB, similar to the transition between FIGS. 6S and 6T, the computer system 100 automatically displays a media user interface 6116 after a threshold amount of time (e.g., 5 minutes, 10 minutes, 15 minutes, 30 minutes, 1 hour, or 1 day) has elapsed. In some embodiments, the media user interface 6116 includes a media item that is of the same category as the media item in the media user interface 6114 (e.g., the media user interface 6116 includes a media item from the same birthday party, or additional media items categorized by “people”). While displaying the media user interface 6116, the computer system 100 detects a user input 6118 (e.g., a long press input) directed to the media user interface 6116.

In response to detecting the user input 6118, and as shown in FIG. 6AC, the computer system 100 displays an editing user interface 6120 (e.g., because the user input 6118 was a long press detected when no chrome was displayed, in contrast to FIG. 6T, where a long press input was detected directed to the chrome 6104).

The editing user interface 6120 includes a category 6128 (e.g., a “People” category that includes the media item displayed in the media user interface 6116), a category 6126 (e.g., a “Pets” category that includes the media item displayed in the media user interface 6114), and a category 6130 (e.g., a third category other than “People” and “Pets”). In some embodiments, the category 6130 is instead an album 6130 (e.g., a photo album that includes one or more photos organized by album, rather than by category).

The editing user interface 6120 also includes a “Cancel” affordance 6122 (e.g., for ceasing to display the editing user interface 6120, without saving any changes) and a “Done” affordance 6124 (e.g., for ceasing to display the editing user interface 6120, and saving any changes made by the user). The editing user interface 6120 also includes a hide affordance 6132 (e.g., that when activated by a user input 6134, removes an entire category of media items (e.g., the category 6128) from the pool of available media items for display (either automatically or in response to detecting a user input), and an affordance 6138. While displaying the editing user interface 6120, the computer system 100 detects a user input 6140 (e.g., a tap input) directed to the affordance 6138. In some embodiments, the hide affordance 6132 applies to an individual media item (e.g., the media item in the media user interface 6114 of FIG. 6AA), and when activated by the user input 6134, removes only the specific media item from the pool of available media items for display.

In FIG. 6AD, in response to detecting the user input 6140, the computer system 100 displays a user interface 6148. Since the category 6128 is a “People” category, the user interface 6148 displays representations of different people (e.g., including the user of the computer system 100, a contact 6150 for “Gina,” and a contact 6152 for “Mary”). Each representation of a person includes a visual indicator (e.g., a checkmark, or an empty circle) that indicates whether media items that include the particular person are available for display in the media ambient mode of the computer system 100. For example, in FIG. 6AD, the computer system 100 can display media items that include the user of the computer system 100, Frank, and Mary. As indicated by the lack of checkmarks, the computer system 100 does not display media items that include Gina, Isaac, or Pierre. While displaying the user interface 6148, the computer system 100 detects a user input 6154 (e.g., a tap input) directed to the contact 6150.

In FIG. 6AE, in response to detecting the user input 6150, the portable multifunction device updates the display of the user interface 6148 to indicate that the computer system 100 can now display media items that include Gina. A user can also deselect a person to remove media items including that person from the pool of media items available for display in the media ambient mode of the computer system 100. For example, in response to detecting a user input 6156 (e.g., a tap input) directed to the contact 6152, the computer system 100 removes media items including Mary from the pool of media items available for display in the media ambient mode. After updating the display of the user interface 6148, and while continuing to display the user interface 6148, the computer system 100 detects a user input 6158 directed to the “Done” affordance 6124.

In FIG. 6AF, in response to detecting the user input 6158, the computer system 100 ceases to display the media editing user interface 6120, and displays (e.g., redisplays) the media user interface 6116. While displaying the media user interface 6116, the computer system 100 detects a user input 6160 (e.g., an upward swipe input).

In FIG. 6AG, in response to detecting the user input 6160, the computer system 100 displays a media user interface 6162. While displaying the media user interface 6162, the computer system 100 detects a user input 6164 (e.g., a tap input) directed to a predefined region (e.g., an upper left portion) of the media user interface 6162.

In FIG. 6AH, in response to detecting the user input 6164, the computer system 100 displays a sharing user interface 6166 (e.g., overlaid over a portion of the media user interface 6162). The sharing user interface 6166 includes one or more affordances for sharing the media item displayed in the media user interface 6162. For example, the sharing user interface 6166 in FIG. 6AH includes an affordance 6188 for sharing media items via Bluetooth (e.g., or other short-range wireless communication protocol), an affordance 6170 for sharing media items via a text messaging application, an affordance 6172 for sharing media items via an email application, and an affordance 6174 for sharing media items in a chat application. In response to detecting a user input 6176 (e.g., a tap input) directed to the affordance 6168, the computer system 100 shares media content for the media item in the media user interface 6162 with one or more other devices that are in communication with the computer system 100. While displaying the sharing user interface 6166 (e.g., and after sharing media content for the media item in the media user interface 6162), the computer system 100 detects a user input 6178 that is directed to the media user interface 6162 (e.g., and is not within the region occupied by the sharing user interface 6166).

In FIG. 6AI, in response to detecting the user input 6178, the computer system 100 ceases to display the sharing user interface 6166. While displaying the media user interface 6162 (and after ceasing to display the sharing user interface 6166), the computer system 100 detects a user input 6180 directed to the media user interface 6162.

In FIG. 6AJ, in response to detecting the user input 6180, the computer system 100 displays an editing user interface 6182. In some embodiments, the media user interface 6162 of FIG. 6AI includes a media item from a first album stored in memory of the computer system 100, and the media user interface 6116 includes a media item from a first category (e.g., “people”) of media items stored in memory of the computer system 100. The editing user interface 6182 of FIG. 6AJ is analogous to the editing user interface 6120 of FIG. 6AC, but includes a different set of editing options (e.g., because different options are needed to configure display of media items organized by category, as compared to media items organized by album).

The editing user interface 6120 displays an album 6188 (e.g., an album that includes the media item displayed in the media user interface 6162 of FIG. 6AI), and an album 6190 (e.g., corresponding to an album other than the album 6188). The editing user interface 6120 also displays a plus affordance 6184 (e.g., for enabling display of one or more additional albums that are not currently enabled for display in the media ambient mode of the computer system 100). A minus affordance 6194 for the album 6188 allows a user to remove an album (e.g., to disable the album 6188 from being displayed while the computer system 100 is in the media ambient mode). In some embodiments, albums (e.g., photo albums) are considered their own category (e.g., other categories include people, pets, nature, cities, and favorites). In some embodiments, the editing user interface 6120 in FIG. 6J is the same as the editing user interface 6120 in FIG. 6AC, but displays different content and/or affordances, which are contextual and based on category (e.g., in FIG. 6AJ, the plus affordance 6184 is displayed to enable adding additional albums to the album category (e.g., while the editing user interface 6128 displays the album 6188 in a focal or central position), but the plus affordance 6184 is not displayed in FIG. 6AC because no corresponding functionality exists for the pets category).

In FIG. 6AK, in response to detecting the user input 6200, the computer system 100 displays a user interface 6202. The user interface 6202 includes one or more album that can be enables for display while the computer system 100 is in the media ambient mode. For example, the user interface 6202 includes a “Recents” album 6206, a “Favorites” album 6204, a “Hawaii” album 6208, and an “Edited” album 6210. While displaying the user interface 6202, the computer system 100 detects a user input 6212 (e.g., a tap input) directed to the “Hawaii” album 6208.

In FIG. 6AL, in response to detecting the user input 6212, the computer system 100 displays an album 6214 in the editing user interface 6120. In some embodiments, the newly added “Hawaii” album is added after the “Big Sur Vacation” album 6188. The editing user interface 6120 includes a minus affordance 6216 for removing the “Hawaii” album (e.g., an analogous affordance to the minus affordance 6194 in FIG. 6AJ, but for the “Hawaii” album instead of the “Big Sur Vacation” album).

In FIG. 6AM, in response to detecting a user input 6218 directed to the “Done” affordance 6124, the computer system 100 ceases to display the editing user interface 6120, and displays a media user interface 6220, which includes a media item from the “Hawaii” album. In some embodiments, the user can navigate between different media items in the “Hawaii” album via a user input 6224 (e.g., a tap input directed to a left edge of the computer system 100) and/or a user input 6226 (e.g., a tap input directed to a right edge of the computer system 100). In some embodiments, albums (e.g., photo albums) are a separate category, and the computer system 100 displays different albums in response to detecting the user input 6224 and/or the user input 6226 (e.g., and the user can navigate between different photos within a specific album via a different type of user input, such as a user input directed to a predefined region of the media user interface 6220, a long press, a double tap, and/or a swipe input).

In FIG. 6AN, in response to detecting a user input 6222 (e.g., a downward swipe input) directed to the media user interface 6220, the computer system 100 redisplays the media user interface 6162 (e.g., that includes a media item from the “Big Sur Vacation” album, the previously displayed album, before enabling the “Hawaii” album for display in the media ambient mode of the computer system 100).

FIGS. 7A-7V show exemplary user interfaces for interacting with and configuring a customizable user interface (e.g., a widget user interface) for an operational mode (e.g., an ambient mode) of the computer system 100.

In FIG. 7A, the computer system 100 displays a home screen user interface of the computer system 100. The home screen user interface includes one or more application icons (e.g., for launching respective applications), and a widget 7000 (e.g., a widget that displays application content for at least one application, without requiring the user of the computer system 100 to open or launch that application). In some embodiments, the home screen user interface includes a plurality of widgets, which optionally have a different size than the widget 7000. For example, in FIG. 7A, each application icon has the same size, and the widget 7000 is approximately 2 application icons wide and 2 application icons tall. Some widgets could be displayed with different sizes, such as 4 application icons wide and 2 application icons tall, or 3 application icons wide and 3 application icons tall.

In some embodiments, the widget 7000 is one widget in a “stack” of widgets (e.g., in response to detecting a user input, the computer system 100 can display widgets other than the widget 7000, at the same location at which the widget 7000 is shown in FIG. 7A). For example, in FIG. 7A, the widget 7000 is currently displaying content for a stocks application. While displaying the widget 7000 that includes content for the stocks application, the computer system 100 detects a user input 7002 (e.g., an upward swipe input).

In FIG. 7B, in response to detecting the user input 7002, the computer system 100 replaces display of the widget 7000 (e.g., that displays content for a stocks application) with display of a widget 7004 (e.g., that displays content for a notes application).

FIG. 7C shows a widget user interface of the computer system 100, while the computer system 100 is operating in an ambient mode (e.g., as described above with reference to FIGS. 5A-5AT, the computer system 100 operates in the ambient mode when the display of the computer system 100 is in a landscape orientation and is connected to the charging source 5056). In some embodiments, the widget user interface of the computer system 100 is the widget user interface 5078 described with reference to FIG. 5S. For case of discussion (e.g., because the widget user interface can include a plurality of widgets), the widget user interface is not labelled in FIGS. 7A-7V, and instead in figures where the widget user interface is displayed, the labels refer to the specific widgets that are displayed in the widget user interface.

In FIG. 7C, the widget user interface includes a widget 7006 (e.g., a widget that displays content for a stocks application, and is optionally the same widget as the widget 7000 shown in FIG. 7A), and a widget 7008 (e.g., a widget that displays content for a weather application). In some embodiments (e.g., as shown in FIG. 7C), the widget 7006 and the widget 7008 have the same size, and the widget 7006 and the widget 7008 are displayed side by side (e.g., because the display of the computer system 100 is in the landscape orientation). In some embodiments, the widget 7006 and the widget 7008 have different sizes. In some embodiments, the widget 7006 and the widget 7008 are displayed in a different layout (e.g., the widget 7006 is displayed in a top half of the widget user interface, and the widget 7008 is displayed in a bottom half of the widget user interface). In some embodiments, the widget user interface includes at least three widgets (e.g., including the widget 7006, the widget 7008, and at least one additional widget).

While displaying the widget user interface that includes the widget 7006 and the widget 7008, the computer system 100 detects a user input (e.g., an upward swipe input) directed to the widget 7006 (e.g., the region of the widget user interface occupied by the widget 7006).

In FIG. 7D, in response to detecting the user input 7010 directed to the widget 7006, the computer system 100 replaces display of the widget 7006 with display of a widget 7012 (e.g., a widget that displays content for the notes application, and is optionally the same as the widget 7004 shown in FIG. 7B). In some embodiments, the computer system 100 replaces display of the widget 7006 with display of the widget 7012, and the computer system 100 replaces display of the widget 7008 with display of another widget (e.g., the widget 7016 in FIG. 7E), in response to detecting the user input 7010 (e.g., the computer system 100 replaces display of all previously displayed widgets in response to single user input) (e.g., the computer system 100 displays both the widgets in FIG. 7E, in response to detecting the user input 7010, and skips over FIG. 7D).

While displaying the widget user interface that includes the widget 7012 and the widget 7008, the computer system 100 detects a user input 7014 (e.g., an upward swipe input) directed to the widget 7008 (e.g., the region of the widget user interface occupied by the widget).

In FIG. 7E, in response to detecting the user input 7014, the computer system 100 replaces display of the widget 7008 with display of a widget 7016 (e.g., a widget that includes content for a clock, timer, or stopwatch application). While displaying the widget user interface that includes the widget 7012 and the widget 7016, the computer system 100 detects a user input 7018 (e.g., a downward swipe input, and/or an input that includes movement in an opposite direction as compared to the input 7014 in FIG. 7D), directed to the widget 7016 (e.g., the region of the widget user interface occupied by the widget 7016).

In FIG. 7F, in response to detecting the user input 7018, the computer system 100 replaces display of the widget 7016 with display of the widget 7008 (e.g., the computer system 100 redisplays the widget 7008, and/or returns to the state shown in FIG. 7D). In other words, the user of the computer system 100 can navigate through different widgets in a first order (e.g., in response to a user input that includes movement in a first direction), and can navigate through the same widgets in an order opposite the first order (e.g., in response to a user input that includes movement in a direction opposite the first direction). While displaying the widget user interface that includes the widget 7012 and the widget 7008, the computer system 100 detects a user input 7020 (e.g., an upward swipe input) directed to the widget 7012.

In FIG. 7G, in response to detecting the user input 7020 directed to the widget 7012, the computer system 100 replaces display of the widget 7012 with display of a widget 7022 (e.g., a widget that includes content for a calendar application). While displaying the widget user interface that includes the widget 7022 and the widget 7008, the computer system 100 detects a user input 7024 (e.g., an upward swipe input) directed to the widget 7022.

In FIG. 7H, in response to detecting the user input 7024, the computer system 100 replaces display of the widget 7022 with display of the widget 7006. In some embodiments, the widget 7006 is displayed because the left region of the widget user interface (e.g., the left “stack” of widgets) is configured to (e.g., only) include the widget 7006, the widget 7012, and the widget 7022. Since the widget 7006 was the first widget displayed in the left region of the widget user interface, and since the user navigated through each available widget for the left region of the widget user interface, the computer system 100 redisplays the widget 7006 (e.g., the computer system 100 loops back to the beginning of the order of the widgets available for display in the left region of the widget user interface). While displaying the widget user interface that includes the widget 7006 and the widget 7008, the computer system 100 detects a user input 7026 (e.g., a leftward swipe input).

In FIG. 71, in response to detecting the user input 7026, the computer system 100 displays a media user interface 6098 (e.g., the media user interface 6098 described above with reference to FIG. 6S. In other words, consistent with the descriptions above for FIGS. 6A-6AN, the user can switch from a first category of ambient mode user interfaces (e.g., widget user interfaces) to a second category of ambient mode user interface (e.g., media user interfaces). While displaying the media user interface 6098, the computer system 100 detects a user input 7028 (e.g., a rightward swipe input) directed to the media user interface 6098.

In FIG. 7J, in response to detecting the user input 7028, the computer system 100 redisplays the widget user interface (e.g., including the widget 7006 and the widget 7008, which were the two widgets displayed in the widget user interface before the user navigated away from the widget user interface in FIG. 7H). While displaying the widget user interface that includes the widget 7006 and the widget 7008, the computer system 100 detects a user input 7030 (e.g., a long press input), directed to the widget 7006 (e.g., the region in the widget user interface occupied by the widget 7006). In some embodiments, the computer system 100 performs analogous functions (e.g., but for the widget 7008, and/or the right region of the widget user interface) in response to a user input 7032 (e.g., a long press input) directed to the widget 7008, but those details are not described here for brevity.

In FIG. 7K, in response to detecting the user input 7030 directed to the widget 7006, the computer system 100 displays an editing user interface 7034. The editing user interface 7034 includes a representation 7038 (e.g., a representation of the widget 7006), a representation 7040 (e.g., a representation of the widget 7012), and a representation 7042 (e.g., a representation of the widget 7022), a plus affordance 7036 (e.g., which when activated by a user input 7048 (e.g., a tap input), allows the user to enable a widget (e.g., a widget other than the widget 7006, the widget 7012, and the widget 7022) for display in the left region of the widget user interface (e.g., to add a widget to the left “stack” of widgets)), a “Done” affordance 7044 (e.g., for ceasing to display the editing user interface 7034), and an option 7046 (e.g., which when activated by a user input 7050, enables (or disables) automatically cycling through (e.g., display of) widgets that are enabled for display in the left region of the widget editing user interface (e.g., after a threshold amount of time has elapsed)). In some embodiments, the editing user interface 7034 includes an option for automatically displaying a contextually-relevant widget of the widgets enables for display in the left region of the widget user interface. For example, when the current time is 10:30, the computer system 100 automatically displays the widget 7022 in the left region of the widget user interface, because the widget 7022 is contextually-relevant due to a saved calendar event from 10:30-11:00. While displaying the editing user interface 7034, the computer system 100 detects a user input 7054 directed to the representation 7040. Analogous functions are performed in response to detecting a user input 7052 (e.g., a tap input) directed to the representation 7038, or in response to detecting a user input directed to the representation 7042, but are not described for brevity.

In FIG. 7L, in response to detecting the user input 7054 directed to the representation 7040, the computer system 100 displays an editing user interface 7056. The editing user interface 7056 is a user interface for editing the widget 7012 (e.g., the widget corresponding to the representation 7040). As the widget 7012 displays content for a notes application, the editing user interface 7056 includes options for configuring the widget 7012, which are specific to the notes application (e.g., options for switching between display of different notes stored in memory of the computer system 100), and also includes an affordance 7058 (e.g., for ceasing to display the editing user interface 7056). For example, the editing user interface 7056 displays a “Health” note 7060, a “Work” note 7062, a “Grocery/Recipes” note 7064, and a “Travel” note 7066 (e.g., each corresponding to notes stored in the memory of the computer system 100). An indicator (e.g., a check mark) indicates that the “Work” note 7062 is currently selected for display in the widget 7012 (e.g., in FIGS. 7D-7F, the widget 7012 displays content from the “Work” note 7062). In some embodiments, a respective editing user interface for a respective widget includes different options from those in the editing user interface 7056. For example, an editing user interface for the widget 7006 (e.g., displayed in response to the user input 7052 directed to the representation 7038 in FIG. 7K), includes options for enabling and/or disabling different stock market indexes from being displayed in the widget 7006.

While displaying the editing user interface 7056, the computer system 100 detects a user input 7068 (e.g., a tap input) directed to the “Grocery/Recipes” note 7064. In FIG. 7M, in response to detecting the user input 7068, the computer system 100 updates display of the editing user interface 7056 to indicate that the “Grocery/Recipes” note 7064 is now enabled for display in the widget 7012 (e.g., instead of the “Work” note 7062). While displaying the (updated) editing user interface 7056, the computer system 100 detects a user input 7072 (e.g., a tap input) directed to the affordance 7058.

In FIG. 7N, in response to detecting the user input 7072, the computer system 100 ceases to display the editing user interface 7056 and displays (e.g., redisplays) the editing user interface 7034. The representation 7040 (e.g., the representation corresponding to the widget 7012, which was edited by the user in FIGS. 7L-7M) has been updated to reflect the user edits (e.g., in FIG. 7K the representation 7040 shows content from the “Work” note 7062, while in FIG. 7N the representation 7040 shows content from the “Grocery/Recipes” note 7064). While displaying the editing user interface 7034, the computer system 100 detects a user input 7074 (e.g., a tap input) directed to the “Done” affordance 7044.

In FIG. 70, in response to detecting the user input 7074, the computer system 100 ceases to display the editing user interface 7034 and displays (e.g., redisplays) the widget user interface. In some embodiments (e.g., as shown in FIG. 70), the widget user interface includes the widget 7006 and the widget 7008 (e.g., the widgets displayed in FIG. 7J, prior to detecting the user input 7030 directed to the widget 7006). In some embodiments, the widget user interface instead displays the widget 7012 (e.g., because the widget 7012 was editing in FIGS. 7K-7M) and the widget 7008 (e.g., transitions directly from FIG. 7N to FIG. 7P, skipping FIG. 70). While displaying the widget user interface that includes the widget 7006 and the widget 7008, the computer system 100 detects a user input 7076 (e.g., an upward swipe input) directed to the widget 7006.

In FIG. 7P, in response to detecting the user input 7076, the computer system 100 replaces display of the widget 7006 with display of the widget 7012. The widget 7012 now displays content from the “Grocery/Recipes” note 7064 (e.g., in contrast to the widget 7012 in FIGS. 7D-7F, which display content from the “Work” note 7062). While displaying the widget user interface that includes the widget 7012 and the widget 7008, the computer system 100 detects a user input 7078 (e.g., an upward swipe input) directed to the widget 7012.

In FIG. 7Q, in response to detecting the user input 7078 directed to the widget 7012, the computer system 100 replaces display of the widget 7012 with display of the widget 7022. In some embodiments, while displaying the widget user interface that includes the widget 7022 and the widget 7008, the computer system 100 detects a user input 7080 (e.g., a long press input) directed to the widget 7022. In some embodiments, the user input 7080 is an input analogous to the user input 7030 in FIG. 7J (e.g., is a user input that causes the computer system 100 to display the editing user interface 7034 of FIG. 7K).

In FIG. 7R, in response to detecting the user input 7080 directed to the widget 7022, the computer system 100 attempts to authenticate the user of the computer system 100. In some embodiments, the computer system 100 displays an authentication user interface 7082 while attempting to authenticate the user of the computer system 100. In some embodiments, the computer system 100 attempts to authenticate the user of the computer system 100 through facial recognition (e.g., as shown by the “Face Authentication” in the authentication user interface 7082). In some embodiments, the computer system 100 attempts to authenticate the user of the computer system 100 through biometric data (e.g., a fingerprint scan).

FIG. 7S is an alternative to FIG. 7R, and shows that in some embodiments, the computer system 100 attempts to authenticate the user of the computer system 100 by requiring the user to input a passcode, by displaying an authentication user interface 7084. In some embodiments, if the computer system 100 is unable to authenticate the user of the computer system 100 through means other than the passcode of the device (e.g., the computer system 100 fails to authenticate the user of the computer system 100 in FIG. 7R), the computer system 100 displays the authentication user interface 7084 (e.g., as a back-up in cases where the user is an authenticated user, but the computer system 100 is unable to authenticate the user through other means (e.g., the user's face is obstructed by a mask or helmet, or the user is wearing gloves that hinder fingerprint authentication)).

In FIG. 7T, after successfully authenticating the user of the computer system 100, the computer system 100 displays the widget 7022 (in the widget user interface) with additional content that is not displayed when the user of the computer system 100 is not authenticated. For example, in FIG. 7T, the widget 7012 includes names and/or descriptions of the three calendar events displayed in the widget 7022. In contrast, in FIG. 7Q (e.g., before the user is authenticated), the widget 7012 includes only the times for the three calendar events. In some embodiments, the widget 7012 includes a visual indication that indicates whether or not the user of the computer system 100 is authenticated (e.g., in FIG. 7Q, each of the three calendar events displays a lock icon to indicate that the user is not authenticated, while in FIG. 7T, the three calendar events include an unlocked icon to indicate that the user is authenticated). This improves the privacy and security of the computer system 100, by displaying some content e.g., sensitive content) only when a user is authenticated.

In some embodiments, user authentication persists while the computer system 100 remains in the ambient mode (e.g., a user only needs to authenticate once, each time the computer system 100 enters the ambient mode). In some embodiments, the computer system 100 requires the user to reauthenticate after a threshold amount of time (e.g., 1 minute, 2 minutes, 5 minutes, 10 minutes, 15 minutes, 30 minutes, 1 hour, 2 hours, 6 hours, or 12 hours).

In some embodiments, the computer system 100 attempts to authenticate the user when different criteria are met. In some embodiments, the computer system 100 may attempt to authenticate the user any time the computer system 100 receives a request to display a widget (e.g., for which additional display content is available for display for authenticated users). For example, when the computer system 100 displays the widget 7022 for the first time (e.g., in FIG. 7G), the computer system 100 automatically attempts to authenticate the user. In some embodiments, the computer system 100 attempts to authenticate the user prior to displaying the widget 7022 for the first time (e.g., and if successful, displays the widget 7022 with additional content as shown in FIG. 7T, and if unsuccessful, displays the widget 7022 with less content as shown in FIG. 7Q). In some embodiments, the computer system 100 automatically attempts to authenticate the user at set time intervals (e.g., every 5 minutes, every 10 minutes, every 30 minutes, or every hour). In some embodiments, the computer system 100 automatically attempts to authenticate the user at set time intervals regardless of whether the computer system 100 is currently displaying any widgets for which additional content can be displayed for authenticated users (e.g., and if the user successfully authenticates the use, the computer system 100 does not require the user to re-authenticate if the computer system 100 displays a widget for which additional content can be displayed for authenticated users). In some embodiments, the computer system 100 attempts to authenticate the user when it detects that the user is interacting with the computer system 100 (e.g., the user touches the computer system 100, the user is within a field of view of a sensor of the computer system 100, and/or the user lifts or rotates the computer system 100 or a display of the computer system 100).

In FIG. 7U, the computer system 100 attempts to authenticate the user when the user of the computer system 100 raises the computer system 100. In FIG. 7V, if the computer system 100 successfully authenticates the user, the computer system 100 displays additional content for authenticated users (e.g., the widget 7022 in FIG. 7V displays the same additional content as the widget 7022 in FIG. 7T, since in both cases, the user is authenticated).

FIGS. 8A-8K show exemplary user interfaces for interacting with different user interfaces of, and switching between, different operational modes (e.g., ambient modes) of the computer system 100.

In FIG. 8A, the computer system 100 displays a home screen user interface (e.g., the same home screen user interface of FIG. 5F and/or FIG. 7A). The computer system 100 also displays a user interface 8000 overlaid over a portion of the home screen user interface. In some embodiments, the user interface 8000 displays content corresponding to a respective application (e.g., a music application, a video player application, or another media application), and the user interface 8000 provides status information (e.g., regarding a currently playing song, a currently playing video, or currently playing media) that is updated over time (e.g., each time the currently playing song changes in the music application, each time the currently playing video changes, or each time the currently playing media changes), and does not requiring displaying a (e.g., normal) user interface of the music application (e.g., video playing application, or other media application) (e.g., by launching the music application/video application/other media application from the home screen user interface of the computer system 100).

In some embodiments, the respective application is a virtual assistant application (e.g., and the user interface 800 provides visual feedback regarding voice commands directed to the virtual assistant). In some embodiments, the respective application is a communication application (e.g., and the user interface 8000 provides status information regarding an activate communication session supported by the communication application), and optionally includes one or more controls for interacting with the active communication session (e.g., for adding a user to the communication session, for muting a microphone of the computer system 100, and/or for terminating and/or disconnecting from the active communication session). In some embodiments, the respective application is a communication application that corresponds to an electronic doorbell device (e.g., and the user interface 8000 enables the user of the computer system to communication with, interact with, and/or control the electronic doorbell device). In some embodiments, the respective application is a telephony application that supports real-time communication (e.g., calls) between the computer system 100 and another electronic device (e.g., user interface 8000 includes one or more controls for interacting with the real-time communication, such as a volume controls and/or an option to disconnect). In some embodiments, the respective application is a video call application that supports real-time video calls between the computer system 100 and another electronic device.

In some embodiments, the user interface 8000 displays status information that corresponds to a first subscribed event (e.g., a sports game, a delivery activity, a flight status, or another subscribed event), and the status information is updated periodically (e.g., in real time, substantially real time, or at preset time intervals) to reflect event updates that are generated for the first subscribed events (e.g., as the score changes for a sports game, as a delivery status changes, as a flight status changes, or as other updates become available). In some embodiments, the user interface 8000 displays status information for a plurality of subscribed events (e.g., concurrently).

In some embodiments, the user interface 8000 includes one or more controls (e.g., media playback controls for the music application, such as a rewind, fast forward, play, pause, and/or stop control) for interacting with the user interface 8000. While displaying the user interface 8000, the computer system 100 detects a user input 8002 (e.g., an upward swipe input) directed to the user interface 8000.

In FIG. 8B, in response to detecting the user input 8002, the computer system 100 displays a user interface 8004. The user interface 8004 corresponds to the user interface 8002 (e.g., and also the same music application), but displays less content than the user interface 8002. For example, in FIG. 8B, the user interface 8004 includes a visual indicator of the currently playing song, but does not include any media playback controls. In some embodiments, the user interface 8004 is a visual indication of, or corresponding to, the user interface 8000 (e.g., that was previously displayed in FIG. 8A).

In some embodiments, displaying the user interface 8004 includes displaying portions of the home screen user interface (e.g., a top row of application icons of the home screen user interface) that were not displayed while the computer system 100 was displayed in the user interface 8000 in FIG. 8A. In some embodiments, the portion of the home screen user interface (e.g., the top row of application icons) is referred to as a separate user interface (e.g., a second home screen user interface, wherein the first home screen user interface includes only the portions of the home screen user interface that are visible in FIG. 8A).

While FIGS. 8A and 8B show a home screen user interface of the computer system 100, in some embodiments, the computer system 100 instead displays an application user interface (e.g., of an application launched from the home screen user interface of the computer system 100, optionally, prior to displaying the user interface 8000 in FIG. 8A), and the user interface 8000 and the user interface 8004 behave in an analogous manner as described with reference to FIGS. 8A and 8B (but with the computer system 100 displaying the application user interface instead of the home screen user interface).

In FIG. 8C, while displaying the user interface 8004, the display of the computer system 100 is rotated from a portrait orientation into a landscape orientation. Since the computer system 100 is not connected to a charging source, the computer system 100 maintains display of the home screen user interface and the user interface 8004.

In FIG. 8D, while displaying the user interface 8004 (e.g., after rotating the display of the computer system 100 back into the portrait orientation), the computer system 100 detects a user input 8006 (e.g., a tap input) directed to the user interface 8004. In FIG. 8E, in response to detecting the user input 8006, the computer system 100 redisplays the user interface 8000.

In some embodiments, the computer system 100 displays an expanded version of the user interface 8000, which includes at least some application content that is not displayed in the user interface 8000 (e.g., with the appearance or version shown in FIG. 8A). For example, in response to detecting a user input directed to the user interface 8000 that is different than the user input 8002 (e.g., a tap input, or a long press input), the computer system 100 displays the expanded version of the user interface 8000. In some embodiments, the computer system 100 automatically displays the expanded version of the user interface 8000 in response to detecting a first event (e.g., that corresponds to the same application for which application content is displayed in the user interface 8000). In some embodiments, the computer system 100 displays the expanded version of the user interface 8000 in response to detecting the first event, regardless of what is displayed on the display of the computer system 100).

In FIG. 8F, while displaying the user interface 8000, the computer system 100 is connected to the charging source 5056 and the display of the computer system 100 is rotated into the landscape orientation. In some embodiments, the computer system 100 does not transition into the ambient mode when the computer system 100 is displayed the home screen user interface (e.g., the computer system 100 only enters the ambient mode if: (1) the computer system 100 is connected to power, (2) the display of the computer system 100 is in the landscape orientation, and (3) the computer system 100 is not displaying a user interface corresponding to an active state (e.g., unlocked state) of the computer system 100). In response to detecting a user input 8008 (e.g., a physical activation of a lock button of the computer system 100), the computer system 100 displays a user interface 8010 (e.g., as shown in FIG. 8G). In some embodiments, the computer system 100 instead detects that the user has not interacted with the computer system 100 for a threshold amount of time (e.g., 5 seconds, 10 seconds, 15 seconds, 30 seconds, 1 minute, 2 minutes, 5 minutes, 10 minutes, or 15 minutes) (e.g., the computer system 100 enters a low power or sleep state automatically after a period in which the user does not interact with the computer system 100, for example, to conserve battery power).

FIG. 8G is analogous to FIG. 8F, but shows the computer system 100 while the computer system 100 is displaying a wake user interface (e.g., the wake user interface of FIG. 5B and/or FIG. 5D). If the computer system 100 is connected to the charging source 5056 (e.g., as shown in the landscape orientation at the bottom of FIG. 8G), and if the display of the computer system 100 is rotated into the landscape orientation, the computer system 100 displays the user interface 8010. In some embodiments, the user interface 8010 is the user interface 8000 in FIG. 8A, but displayed with a different appearance (e.g., full screen and landscape, as opposed to the smaller appearance in a portrait appearance in FIG. 8A).

In some embodiments, the user interface 8010 is not an ambient user interface corresponding to the ambient mode of the computer system 100 (e.g., because the user interface 8010 is a similar user interface to the user interface 8000, and corresponds to the music applications of the computer system 100, and not the ambient mode of the computer system 100). In some embodiments, the user interface 8010 displays additional content (e.g., corresponding to the music application and/or the currently playing song) that is not displayed in the user interface 8000. For example, the user interface 8010 includes a progress bar (e.g., that shows that the currently playing song has been playing for 15 seconds, with 3 minutes and 6 seconds remaining in the currently playing song) and a volume slider 8013 (e.g., for adjusting a volume of the computer system 100 and/or the music application) that is not displayed in the user interface 8000.

In some embodiments, the user interface 8010 is a customizable user interface corresponding to the ambient mode of the computer system 100 (e.g., but is not normally accessible, or displayed, unless music is playing in the music application while the computer system 100 is operating in the ambient mode).

While displaying the user interface 8010, the computer system 100 detects a user input 8014 directed to the user interface 8010. In some embodiments, the user input 8014 is an upward swipe input that begins from a lower edge of the display of the computer system 100 in the landscape orientation. In some embodiments, the user input 8014 is detected in a different location (e.g., as shown by the user input 8012).

In FIG. 8H, in response to detecting the user input 8014, the computer system 100 ceases to display the user interface 8010 and displays the media user interface 6162 (e.g., or another user interface corresponding to the ambient mode of the computer system 100, such as the clock user interface 6000 in FIG. 6A, the voice memo user interface in FIG. 6O, the ambient sound user interface 6090 in FIG. 6Q, the widget user interface 5078 in FIG. 5S, and/or the home control user interface 5086 in FIG. 5T). The computer system 100 displays a user interface 8016 (e.g., overlaid over a portion of the media user interface 6162), which is an analogous user interface to the user interface 8004 of FIG. 8D (e.g., includes similar content to the user interface 8004, but the user interface 8004 is displayed when the computer system 100 is not operating in the ambient mode, while the user interface 8016 is displayed while the computer system 100 is operating in the ambient mode). While displaying the media user interface 6162 and the user interface 8016, the computer system 100 detects a user input 8018 (e.g., a tap input) directed to the user interface 8016.

In FIG. 8I, in response to detecting the user input 8018, the computer system 100 ceases to display the media user interface 6162 (e.g., and the user interface 8016), and displays (e.g., redisplays) the user interface 8010. In some embodiments, while displaying the user interface 8010, in response to detecting another user input analogous to the user input 8014 in FIG. 8G, the computer system 100 redisplays the media user interface 6162 in FIG. 8H. While displaying the user interface 8010, the computer system 100 detects a user input 8020 (e.g., a tap input directed to a lower left corner of the user interface 8010). In some embodiments, the user interface 8010 includes an affordance (e.g., at the location of the user input 8020 in the lower left corner of the user interface 8010), which is activated by the user input 8020 (e.g., and is a browse affordance, which when activated, enables browsing media items that are available to be played by the music application of the computer system 100).

In FIG. 8J, in response to detecting the user input 8020, the computer system 100 displays a user interface 8022. The user interface 8022 includes a plurality of representations of music that is available to be played by the computer system 100, including the representation 8024, the representation 8026 (e.g., corresponding to the currently playing song), and the representation 8028. In some embodiments, each displayed representation in the user interface 8022 includes a visual indication corresponding to a media item (e.g., song and/or album) stored in memory of the computer system 100. For example, each representation displays the album art that corresponds to the song represented by the representation.

In some embodiments, the representation corresponding to the currently playing song (e.g., the representation 8026) is displayed with increased prominence (e.g., with a larger size, in a more central location, with larger font, and/or with a brighter or different colored appearance) as compared to representations corresponding to music that is not currently playing (e.g., the representation 8024 and the representation 8028). In some embodiments, the representation 8024, the representation 8026, and the representation 8028 are arranged in a browsable carousel. In some embodiments, in response to a user input (e.g., a leftward or rightward swipe input), the computer system 100 scrolls display of the representations of music (e.g., so that the user can access and/or navigate to additional music items, beyond the three representations 8024, 8026, and 8028 shown in FIG. 8J). While displaying the user interface 8022, the computer system 100 detects a user input 8030 directed to the representation 8028.

In FIG. 8K, in response to detecting the user input 8030, the computer system 100 switches from playing song A (e.g., the song corresponding to the representation 8026) to playing song B (e.g., the song corresponding to the representation 8028 selected by the user input 8030 in FIG. 8J).

While FIGS. 8A-8K are described with references to a specific user interface 8000 and a specific user interface 8010 (e.g., both corresponding to a music application of the computer system 100), in some embodiments, the user interface 8000 and the user interface 8010 include different content.

For example, in some embodiments, the user interface 8000 and the user interface 8010 includes notification content (e.g., and the user interface 8010 displays different and/or additional notification content as compared to the user interface 8000). In some embodiments, the user interface 8000 and/or the user interface 8010 display first notification content when a user of the computer system 100 is not authenticated, and displays second notification content that includes some notification content not included in the first notification content, when the user of the computer system 100 is authenticated (e.g., authenticated as described above with reference to FIGS. 7Q-7V). In some embodiments, the computer system 100 automatically displays the second notification content when the user (e.g., an authenticated user) is detected within a threshold distance of the computer system 100.

In some embodiments, the user interface 8000 and/or the user interface 8010 display the first notification content at a first time (e.g., when a first event corresponding to the notification for which notification content is being displayed occurs and/or is detected by the computer system 100), and displays the second notification content at a second time after the first time (e.g., after a threshold amount of time has elapsed since the computer system 100 detected first event corresponding to the notification) if the user has successfully authenticated before the second time (e.g., and maintains display of the first notification content if the user has not successfully authenticated before the second time). In some embodiments, the computer system 100 displays additional notification content (e.g., optionally, the second notification content) if the computer system 100 detects movement of the user towards the computer system 100, a hand or other body part of the computer system 100 (e.g., performing a user input and/or moving in a predefined manner), that the user has successfully authenticated, and/or that the user is within a threshold distance of the computer system 100.

In some embodiments, the user can dismiss or cease displaying the notification content in the user interface 8000 and/or the user interface 8010 by performing a user input (e.g., a user input analogous to the user input 8002 in FIG. 8A, or the user input 8014 in FIG. 8G). In some embodiments, when dismissing or ceasing to display the notification content, the computer system 100 replaces display of the notification content with a notification indicator (e.g., a persistent indicator analogous to the user interface 8004 in FIG. 8B, or the user interface 8016 in FIG. 8H, which are displayed with a smaller size compared to the user interface 8000 and the user interface 8010). In some embodiments, the notification indicator is displayed in accordance with settings of the computer system 100 (e.g., the user can configure the settings of the computer system 100 to display the notification indicator, or to disable display of the notification indicator (e.g., in which case the computer system 100 ceases to display the notification content without displaying a notification indicator in the scenario described above)).

In some embodiments, the user can redisplay the notification content by performing a user input (e.g., an analogous user input to the user input 8006 in FIG. 8D, or the user input 8018 in FIG. 8H). In some embodiments, the user cannot redisplay the notification content while the computer system 100 is operating in the ambient mode (e.g., the user must first exit the ambient mode of the computer system 100, for example, as described above with reference to FIGS. 5AH-5AM). In some embodiments, if the notification content was previously displayed while the computer system 100 operated in the ambient mode (e.g., and/or the computer system 100 detects the first notification while the computer system 100 is operating in the ambient mode), the notification content is redisplayed in response to detecting that the computer system 100 has exited the ambient mode (e.g., the user has rotated the display of the computer system 100 out of the landscape orientation and/or disconnected the computer system 100 from the charging source 5056).

FIGS. 9A-9AA show exemplary user interfaces for automatically activating a flashlight function of the computer system 100 when specific criteria are met.

While FIGS. 9A-9G, FIGS. 9P-9Y, and FIG. 9AA) show the computer system 100 operating in an ambient mode (e.g., the computer system 100 in a landscape orientation and connected to the charging source 5056). In some embodiments, the portable multifunction device operates in a first mode (e.g., optionally, in additional to operating in the ambient mode) during a scheduled time period (e.g., a sleep period that begins at a scheduled bed time and ends at a scheduled wake or alarm time), the computer system 100 operates in a first mode (e.g., a sleep mode). In some embodiments, the behaviors described below with reference to FIGS. 9A-9G, FIGS. 9P-9Y, and FIG. 9AA, are applicable only if the computer system 100 meets certain conditions. In some embodiments, those conditions require that the computer system 100 be operating in the ambient mode (e.g., regardless of whether the computer system 100 is also operating in the first mode/sleep mode). In some embodiments, those conditions require that the computer system 100 be operating in the first mode/sleep mode (e.g., regardless of whether or not the computer system 100 is operating in the ambient mode). In some embodiments, those conditions require that the computer system 100 be operating in both the ambient mode and the first mode/sleep mode.

In FIG. 9A, the display of the computer system 100 is in a landscape orientation and the computer system 100 is connected to the charging source 5056. While the display of the computer system 100 is in the low power state, the computer system 100 detects a user's hand 9000 in proximity to the computer system 100 (e.g., within a field of view or effective range of a sensor of the computer system 100).

In FIG. 9B, the user's hand 9000 moves closer to the computer system 100. In response to detecting that the user's hand 9000 is within a threshold distance (e.g., within 1 cm, 5 cm, 10 cm, or 25 cm) of the computer system 100, the computer system 100 displays a clock user interface 9002 (e.g., a clock user interface that is similar to the clock user interface 5072 in FIG. 5R, and/or the clock user interface 6018 in FIG. 6G). In some embodiments, the clock user interface 9002 is displayed with reduced prominence (e.g., with a lower brightness, as compared to the clock user interface 5072 in FIG. 5R and/the clock user interface 6018 in FIG. 6G), as compared to a default and/or maximum brightness for the computer system 100. In some embodiments, the computer system 100 displays the clock user interface 9002 only if the computer system 100 is operating in the ambient mode (e.g., the display of the computer system 100 is in the landscape orientation, and the computer system 100 is connected to a charging source, such as the charging source 5056).

In FIG. 9C, the computer system 100 detects a user's gaze is directed to the computer system 100 (e.g., while the user's hand 9000 is within the threshold distance of the computer system 100). In response to detecting the user's gaze 9004 directed to the computer system 100, the computer system 100 displays the clock user interface 9002 with increased prominence (e.g., with a higher brightness as compared to the clock user interface 9002 in FIG. 9B).

While the descriptions of FIGS. 9A-9C describe detecting particular portions of the user (e.g., that meet specific criteria, such as proximity to the computer system 100), the different states in FIGS. 9A-9C can be triggered by any suitable user input and/or combination of user inputs. For example, the computer system 100 may display the clock user interface 9002 in response to detecting the user's gaze directed to the computer system 100 (e.g., regardless of whether or not the user's hand 9000 is within the threshold distance of the computer system 100). For example, the computer system 100 may displays the clock user interface 9002 in response to detecting movement of the user, whether that is movement of the user's hand 9000, or movement of another body part of the user, or movement of the entire user (e.g., and the brightness with which the clock user interface 9002 is displayed is based at least in part on the speed and/or relative amount of movement of the user or the brightness with which the clock user interface 9002 is displayed is based at least in part on the distance of the user to the computer system 100). In some embodiments, the user input(s) include physical contact with the computer system 100 (e.g., a tap input, swipe input, pinch input, and/or long press input directed to a touch-sensitive surface of the computer system 100; lifting and/or changing an orientation of the computer system 100; and/or moving the computer system 100 with a threshold amount of speed or by a threshold amount of distance).

In FIG. 9D, the computer system 100 displays the clock user interface 9002. In some embodiments, the clock user interface 9002 is a simplified clock display (e.g., the clock user interface 9002 includes only the current hour, and does not display the current minute value for the current time). The clock user interface 9002 also includes a visual indication of the current time, relative to a scheduled alarm (e.g., and optionally, also relative to a scheduled or detected bedtime). For example, the clock user interface 9002 includes 6 tick marks, and the leftmost and rightmost tick marks are longer (and thicker) representing the bedtime and the alarm time, respectively. The hour value of the current time is displayed at a position that reflects the current time relative to the bedtime and/or alarm time. If the bedtime is 10:00 PM and the alarm time in 7:00 AM, the current hour (e.g., 4) for the current time (e.g., 4:00 AM) is displayed at a location that is approximately two thirds of the distance between the leftmost and rightmost tick marks, as measured from the leftmost tick mark (e.g., because there are 9 hours between the bedtime of 10:00 PM and the alarm time of 7:00 AM, two thirds of 9 hours is 6 hours, and 6 hours from the bedtime of 10:00 PM is 4:00 AM, the current time). While displaying the clock user interface 9002, the computer system 100 detects a user input 9006 (e.g., a tap user input) 9006.

In FIG. 9E, in response to detecting the user input 9006, the computer system 100 displays additional time content in a clock user interface 9008. For example, the clock user interface 9008 includes both the hour value (4) and the minute value (55) for the current time. In contrast, the simplified clock of the clock user interface 9002 in FIG. 9D displays only the hour value (4) for the current time. In some embodiments, the clock user interface 9008 is the same as the clock user interface 9002, but displayed with a second level of content in FIG. 9E that is greater than a first level of content in FIG. 9D.

FIG. 9F shows an alternative to FIGS. 9D-9E. In FIG. 9F, the computer system 100 displays the clock user interface 9008 (e.g., that includes the additional time content) in response to detecting that the display of the computer system 100 has a particular orientation (e.g., that a user of the computer system 100 has picked up the computer system 100). In some embodiments, when in the particular orientation, the display of the computer system 100 substantially in the landscape orientation (e.g., the computer system 100 is not “perfectly” in the landscape orientation (e.g., the longer edges of the computer system 100 are not exactly parallel with the ground), as changing the orientation of the display of the computer system 100 by too large a degree (e.g., rotating the display of the computer system 100 into a portrait orientation) causes the computer system 100 to exit the ambient mode (e.g., as described above with reference to FIGS. 5AH-5AM).

In FIG. 9G, the computer system 100 redisplays the clock user interface 9002. In some embodiments, the computer system 100 automatically redisplays the clock user interface 9002 after a threshold amount of time (e.g., 5 seconds, 10 seconds, 15 seconds, 30 seconds, or 1 minute) has passed (e.g., since the computer system 100 detected the user input 9006 in FIG. 9D, or since the computer system 100 detected the change in orientation when the user picks up the computer system 100 in FIG. 9F). In some embodiments, the computer system 100 redisplays the clock user interface 9002 in response to detecting a user input (e.g., a tap input, a long press input, or a swipe input) directed to the clock user interface 9008. While displaying the clock user interface 9002, the computer system 100 detects that the computer system 100 is disconnected from the charging source 5056 (e.g., as shown by the dotted arrow in FIG. 9G).

In FIGS. 9H-9N, in response to detecting that the computer system 100 has been disconnected from the charging source 5056, the computer system 100 activates a flashlight function of the computer system 100. In some embodiments, the flashlight function of the computer system 100 is activated, as described below, (e.g., only) if the computer system 100 was previously displaying the clock user interface 9002 (e.g., as in FIG. 9G) or the clock user interface 9008 (e.g., as in FIG. 9F), when the computer system 100 is disconnected from the charging source 5056 (e.g., whether or not the computer system 100 is operating in the first mode/sleep mode, as the clock user interface 9002 can optionally be manually invoked by the user outside of the scheduled time period corresponding to the first mode/sleep mode). In some embodiments, the flashlight function of the computer system 100 is activated even if no clock user interface is displayed (e.g., the display of the computer system 100 is in an off or low power state, as in FIG. 9A, or the computer system 100 is displaying a different user interface). In some embodiments, the flashlight function of the computer system 100 is activated, regardless of what is (or is not) displayed on the display of the computer system 100, if the computer system 100 is operating in the first mode (e.g., the sleep mode). In some embodiments, the flashlight function of the computer system 100 is activated (e.g., only) if the computer system 100 meets the criteria to operate in the ambient mode (e.g., the computer system 100 is in the landscape orientation and was connected to the charging source 5056), when the computer system 100 is disconnected from the charging source 5056 (e.g., or just prior to detecting that the computer system 100 is disconnected from the charging source 5056). In some embodiments, the flashlight function of the computer system 100 is activated (e.g., only) if the computer system 100 meets the criteria to operate in the ambient mode and also criteria to operate in the first mode/sleep mode).

FIG. 9H shows that in some embodiments, the flashlight function activates a hardware flashlight of the computer system 100 (e.g., a light source that is distinct from the display of the computer system 100). While the flashlight function of the computer system 100 is active, the computer system 100 displays a flashlight user interface 9010, which includes a control 9012 (e.g., for adjusting a brightness of the flashlight, and can be adjusted by a user input 9016 that includes upward or downward movement (e.g., along an axis of the control 9012)), and a control 9014 (e.g., for adjusting a color of the flashlight, and can be adjusted by a user input 9018 that includes leftward or rightward movement (e.g., along an axis of the control 9014)). In some embodiments, the user can adjust the brightness of the flashlight to a minimum value (e.g., completely off state), which deactivates the flashlight function of the computer system 100 (e.g., because the hardware flashlight of the computer system 100 emits no light), but optionally the computer system 100 maintains display of the flashlight user interface 9010 (e.g., such that the flashlight function of the computer system 100 can quickly be reenabled or reactivated, by increasing the brightness via the control 9012). In some embodiments, while displaying the flashlight user interface, the computer system 100 detects a user input (e.g., a double tap input, a swipe input, a long press input, or another type of user input) directed to the flashlight user interface 9010, and in response, the computer system 100 deactivates the flashlight function of the computer system 100 (e.g., to preserve battery life and avoid projecting light in scenarios where the user needs to disconnect the computer system 100 from the charging source 5056, but does not require the flashlight function of the computer system 100). In some embodiments, the user input to deactivate the flashlight function is analogous to a user input 9038 in FIG. 9T (but while displaying the flashlight user interface 9010), as described in further detail below.

FIG. 91 shows the computer system 100 from a different angle, and shows that a hardware flashlight of the computer system 100 is active (e.g., is activated in response to detecting that the computer system 100 is disconnected from the charging source 5056).

FIGS. 9J-9N show an alternative flashlight function, wherein the computer system 100 leverages the display of the computer system 100 as the flashlight. In FIG. 9J, in response to detecting that the computer system 100 is disconnected from the charging source 5056, the computer system 100 displays a flashlight user interface 9022. In some embodiments, the flashlight user interface 9022 is a substantially uniform display of a single color (e.g., white), which outputs sufficient brightness to be used as a flashlight. In some embodiments, the flashlight user interface 9022 includes one or more areas of illumination, which are displayed when activating the flashlight function of the computer system 100. While displaying the flashlight user interface 9022, the computer system 100 detects a user input 9024 (e.g., an upward swipe input) directed to the flashlight user interface 9022.

In FIG. 9K, in response to detecting the user input 9024, the computer system 100 adjusts a setting (e.g., a brightness) of the flashlight (e.g., updates an appearance of the flashlight user interface 9022 to have a higher brightness). For example, in FIG. 9K, the computer system 100 increases a brightness of the display (e.g., as shown by the white color of the flashlight user interface 9022 in FIG. 9K, as compared to the light grey color of the flashlight user interface 9022 in FIG. 9J). While displaying the (updated) flashlight user interface 9022, the computer system 100 detects a user input 9026 (e.g., a downward swipe input) directed to the flashlight user interface 9022.

In FIG. 9L, in response to detecting the user input 9026, the computer system 100 adjusts the setting (e.g., the brightness) of the flashlight. For example, in FIG. 9L, the flashlight user interface 9022 is displayed with the same (e.g., or similar) light grey appearance as in FIG. 9J. While displaying the (updated) flashlight user interface 9022, the computer system 100 detects a user input 9028 (e.g., a rightward swipe input) directed to the flashlight user interface 9022.

In FIG. 9M, in response to detecting the user input 9028, the computer system 100 adjusts a setting (e.g., a color or color temperature) of the flashlight (e.g., updates an appearance of the flashlight user interface 9022 to have a different color). In FIG. 9M, the flashlight user interface 9022 is shown with a different background pattern to indicate a different color. While displaying the (updated) flashlight user interface 9022, the computer system 100 detects a user input 9030 (e.g., a leftward swipe input) directed to the flashlight user interface 9022.

In FIG. 9N, in response to detecting the user input 9022, the computer system 100 adjusts the setting (e.g., the color) of the flashlight. For example, in FIG. 9N, the flashlight user interface 9022 is displayed with the same background pattern (e.g., solid color) as in FIG. 9L.

While FIGS. 9J-9N show only a single input in each direction (e.g., up, down, left, and/or right), it is understood that the user can perform multiple inputs to adjust the settings of the flashlight of the computer system 100 (e.g., repeated user inputs in the upward direction will continue to adjust (e.g., increase) the brightness of the flashlight user interface 9022, and (repeated) user inputs in an opposite direction (e.g., downward) will adjust (e.g., decreasing or otherwise reversing the increase in the brightness of the flashlight user interface) the brightness of the flashlight user interface 9022. Further, in some embodiments, the user can perform a single input (e.g., a diagonal input, or an input that includes a first portion involving vertical movement and a second portion involving horizontal movement (e.g., or vice versa)), to adjust both the brightness and the color of the flashlight user interface 9022 simultaneously.

In FIG. 9N, the user reconnects the computer system 100 to the charging source 9056 (e.g., as shown by the two converging arrows in FIG. 9N). In FIG. 90, in response to detecting that the computer system 100 has been reconnected to the charging source 5056 (e.g., and that the display of the computer system 100 is in the landscape orientation, such that the computer system 100 meets the criteria for entering the ambient mode), the computer system 100 displays (e.g., redisplays) the clock user interface 9002 (e.g., replaces display of the flashlight user interface 9022 with display of the clock user interface 9002). In some embodiments, the computer system 100 also deactivates the flashlight function of the computer system 100 (e.g., by ceasing to display the flashlight user interface 9022, and/or by deactivating a hardware flashlight of the computer system 100).

In some embodiments, if the computer system 100 does not satisfy criteria for operating in the ambient mode (e.g., the computer system 100 reconnected to the charging source 5056, but the display of the computer system 100 is in a portrait orientation), the computer system 100 does not display the clock user interface 9002.

The clock user interface 9002 shows an hour value of 5 (e.g., as compared to the hour value of 4, in the clock user interface 9002 of FIG. 9G), because the current time has advanced to a time that is at or after 5:00 (e.g., the user disconnected the computer system 100 from the charging source 5056 and used the computer system 100 as a flashlight for 8 minutes before reconnecting the computer system 100 to the charging source 5056, at a current time of 5:03).

In some embodiments, in addition to updating the hour value, the clock user interface 9002 is also updated to provide one or more additional visual indications of the current time. For example, in FIG. 90, the hour value of 5 appears with only one bar to the right, and with five bars to the left. In contrast, in FIG. 9D, the hour value of 4 appears with two bars to the right, and with four bars to the left. In some embodiments, the clock user interface 9002 displays the hour value at a horizontal position that indicates the relative position of the current time to a bed time (e.g., represented by the larger and leftmost bar) and a wake time or alarm time (e.g., represented by the larger and rightmost bar), which provides visual feedback regarding the current time.

While displaying the clock user interface 9002, the computer system 100 detects a user input 9032 (e.g., a tap input) directed to the clock user interface 9002 (e.g., an analogous user input to the user input 9006 in FIG. 9D). In FIG. 9Q, the computer system 100 displays the clock user interface 9008 (e.g., the same clock user interface 9008 in FIG. 9E, but reflecting the current time of 5:03).

In FIG. 9R, while displaying the clock user interface 9008, the computer system 100 detects a user input 9034 (e.g., an upward swipe input) directed to the clock user interface 9008. In some embodiments, the behavior described below applies also to a user input analogous to the user input 9034, but detected while displaying the clock user interface 9002 (e.g., the user input 9032 in FIG. 9P is an upward swipe input instead of a tap input).

In FIG. 9S, in response to detecting the user input 9034, the computer system 100 displays a wake user interface of the computer system 100.

FIG. 9T shows that while the flashlight function of the computer system 100 is active (e.g., while the computer system 100 is disconnected from the charging source 5056, and is displaying the flashlight user interface 9022), the computer system 100 detects a user input 9038 (e.g., an upward swipe input, optionally from the bottom edge of the computer system 100). In FIG. 9U, in response to detecting the user input 9038, the computer system 100 displays the wake user interface of the computer system 100 (e.g., the same wake user interface of FIG. 9S). In some embodiments, displaying the wake user interface of the computer system 100 includes ceasing to display the flashlight user interface 9038 (e.g., replacing display of the flashlight user interface 9038 with the wake user interface) and/or deactivating the flashlight function of the computer system 100 (e.g., because the flashlight user interface 9038 is no longer displayed).

FIGS. 9V-9AA show exemplary user interfaces corresponding to an alarm function of the computer system 100 (e.g., alarm user interfaces that are displayed while the computer system 100 is operating in the ambient mode when a scheduled alarm is triggered).

In FIG. 9V, the computer system 100 detects that the current time is 9:00 and that there is a scheduled alarm for 9:00. In response, the computer system 100 displays an alarm user interface 9040. The alarm user interface 9040 displays the current time (e.g., 9:00) and a visual (e.g., a hemisphere in the bottom center of the alarm user interface 9040). In some embodiments, the alarm user interface 9040 is displayed while the computer system 100 generates an audio alert corresponding to the scheduled alarm and/or corresponding to the alarm user interface 9040 (e.g., different audio alerts are generated when different alarm user interfaces are displayed, such that not every alarm includes the same audio alert). In some embodiments, the alarm user interface 9040 is displayed with a reduced prominence (e.g., a low brightness and/or a darker color or shade of color). In some embodiments, the alarm user interface 9040 of FIG. 9V is displayed during a “wind up” period that is immediately before the scheduled alarm time. For example, if the scheduled alarm is for 9:00, the computer system 100 displays the alarm user interface 9040 of FIG. 9V from 8:45 to 9:00.

In FIG. 9W, as the alarm progresses, the computer system 100 updates the display of the alarm user interface 9040. The visual has expanded (e.g., the hemisphere has increased in size), and the alarm user interface 9040 is displayed with increased prominence (e.g., a higher brightness than in FIG. 9V, and/or a brighter color or shade of color). In some embodiments, the computer system 100 updates the display of the alarm user interface 9040 by displaying an animated transition from the appearance in FIG. 9V to the appearance in FIG. 9W (e.g., an animated transition of the hemisphere growing in size and increasing in brightness). In some embodiments, the alarm user interface 9040 includes one or more selectable options for interacting with the alarm (e.g., an option of snoozing the alarm, an option for ceasing to display the visual, an option to mute or silence the audio alert, and/or to deactivate the alarm).

While displaying the alarm user interface 9040, the computer system 100 detects a user input 9042 (e.g., a tap user input). In some embodiments, the user input 9042 is directed to a selectable option for snoozing the alarm. In response to detecting the user input 9042, the computer system 100 snoozes the active alarm. In some embodiments, snoozing the active alarm includes ceasing to display the visual and ceasing to generate the audio alert (e.g., for a predetermined period of time, such as 9 minutes). In some embodiments, snoozing the active alarm includes reducing a level of prominence with which the visual is displayed and/or the audio alert is generated (e.g., displaying a dimmed visual and/or generating a softer or more muted audio alert) (e.g., for the predetermined amount of time).

In FIG. 9X, 9 minutes (e.g., the snooze duration) have elapsed, and the active alarm triggers again. In some embodiments, the visual displayed for the alarm is randomized (e.g., each time the alarm is triggered, or randomized by day, or randomized by alarm) and/or the audio alert provided is randomized (e.g., each time the specific alarm is triggered, or randomized by day, or randomized any time any alarm is triggered). In some embodiments, a respective visual is paired with a respective audio alert (e.g., such that the respective visual is always displayed while generating the respective audio alert, and the randomization described above selects a paired visual and audio alert), and in some embodiments, visuals and audio alerts are randomized independently (e.g., visuals are not paired with audio alerts, and can be randomly selected regardless of which audio alert is generated, and audio alerts are not paired with visuals, and can be randomly selected regardless of what visual is displayed. For example, in FIG. 9X, the visual is now a circle (e.g., centered in an alarm user interface 9044). Similar to FIGS. 9V-9W, the alarm user interface is initially displayed with low prominence (e.g., low brightness in FIG. 9X).

In FIG. 9Y, as the alarm progresses, the computer system 100 updates the display of the alarm user interface 9044. The visual has expanded (e.g., the circle has increased in size), and the alarm user interface 9044 is displayed with increased prominence (e.g., a higher brightness than in FIG. 9X). As shown by the optional user input 9046 (e.g., a tap user input), the user can continue to snooze the active alarm (e.g., and the next time the alarm triggers, the displayed alarm user interface is optionally different from both the alarm user interface 9040 of FIGS. 9V-9W and the alarm user interface 9044 of FIGS. 9X-9Y, and the computer system 100 generates an audio alert that is different than the audio alert corresponding to the alarm user interface 9040 and the alarm user interface 9044).

FIGS. 9V-9Y show some exemplary visuals for different alarm user interfaces. In some embodiments, an alarm user interface includes a visual that is different than the visuals in FIGS. 9V-9Y. For example, an alarm user interface may display an analog clock face (e.g., instead of the digital clock face in FIGS. 9V-9Y), and the visual may include displaying the hands of the analog clock face with different appearances (e.g., different sizes, shapes, and/or colors). In some embodiments, the different visuals change as the alarm corresponding to the alarm user interface progresses, in an analogous fashion to the changes shown in FIGS. 9V-9Y (e.g., the hands of an analog clock face increase/decrease in size, change shape, and/or change color, as the alarm progresses).

While displaying the alarm user interface 9044 (e.g., while the active alarm is progressing), the computer system 100 detects a user input that either disconnects the computer system 100 from the charging source 5056, rotates the display of the computer system 100 out of the landscape orientation (e.g., into a portrait orientation), or both. In other words, the user interacts with the computer system 100 such that the computer system 100 no longer meets the criteria for operating in the ambient mode.

In FIG. 9Z, if the computer system 100 is disconnected from the charging source 5056, but the display of the computer system 100 remains in the landscape orientation, the computer system 100 displays a wake user interface 9036 (e.g., the same wake user interface 9036 in FIGS. 9S and 9U).

In FIG. 9AA, if the computer system 100 is rotated without disconnected the computer system 100 from the charging source 5056, the computer system 100 displays a wake user interface (e.g., but in the portrait orientation instead of the landscape orientation). In both FIGS. 9Z and 9AA, the computer system 100 deactivates the alarm and cease to operate in the ambient mode.

In some embodiments, the computer system 100 also deactivates the alarm (and/or ceases to operate in the ambient mode) in response to detecting movement of the computer system 100 that meets movement criteria (e.g., that the computer system 100 is moved by more than a threshold amount within a threshold time period, that the computer system 100 is moved with at least a threshold amount of speed, and/or that the computer system 100 is moved such that is has a specific orientation).

FIGS. 10A-10L are flow diagrams illustrating method 10000 of automatically displaying a customizable user interface when specific criteria are met, in accordance with some embodiments. Method 10000 is performed at an electronic device (e.g., device 300, FIG. 3, or computer system 100, FIG. 1A) with a display, a touch-sensitive surface, and one or more sensors. In some embodiments, the display is a touch-screen display and the touch-sensitive surface is on or integrated with the display. In some embodiments, the display is separate from the touch-sensitive surface. Some operations in method 10000 are, optionally, combined and/or the order of some operations is, optionally, changed.

Displaying a first customizable user interface that was not displayed prior to detecting a first event, in response to detecting the first event and in accordance with a determination that first criteria are met as a result of the first event, the first criteria requiring that a display generation component of a computer system is in a first orientation and that the computer system is charging in order for the first criteria to be met, and forgoing displaying the first customizable user interface, in response to detecting the first event and in accordance with a determination that the first criteria are not met as a result of the first event, automatically displays an appropriate user interface without requiring additional user input (e.g., additional user inputs to display the first customizable user interface when first criteria are met, and/or additional user inputs to cease displaying the first customizable user interface if first criteria are not met).

In some embodiments, the method 10000 is performed at a computer system in communication with a display generation component and one or more sensors. In some embodiments, the computer system further includes one or more power transfer components, including but not limited to, a power transfer coil (e.g., receiving coil 5186 in FIG. 5AN, or another power transfer coil) and/or other charging component(s) (e.g., NFC module 5192 in FIG. 5AN), that are adapted to receive power transfer signals from a charging source (e.g., a wireless power transfer (WPT) transmitting device, or another type of charging device or charging source), and a rectifier (e.g., rectifier 5188 in FIG. 5AN) adapted to charge a battery of the computer system using the power transfer signals received from the charging source (e.g., PTx 5174 in FIG. 5AN) by the power transfer coil and/or other charging component(s). In some embodiments, the computer system includes software, firmware, circuitry, embedded systems, and/or hardware components that are configured to decode information carried by the power transfer signals received from the charging source, and/or to encode and send requests and information in the power transfer signals for the charging source to detect and decode, in accordance with an agreed-upon protocol or communication standard (e.g., including, but not limited to, the protocol or communication standard described herein). In some embodiments, the computer system includes one or more batteries that are charged by the power transfer signals received from the charging source. In some embodiments, some of the power transfer signals are used for out-of-band communication and are not used to charge the one or more batteries of the computer system, while other power transfer signals are used for charging the one or more batteries of the computer system. In some embodiments, a charging source provides AC signals (e.g., magnetic flux and/or electric current) that is received by the charging component of the computer system (e.g., receiving coil 5186 or other charging components), and the AC signals serve as the carrier for encoded data packets (e.g., encoded using frequency shift keying, amplitude shift keying, and/or other encoding techniques) to be transmitted between the computer system and the charging source. In some embodiments, power transfer signals described herein includes portions of the AC signals that are not directly used to increase the charge level of the battery, such as signals that precede or succeed the portions of the AC signals that are used to transfer power to the battery. These portions of the power transfer signals include, for example, handshaking signals between the computer system and the charging source, and data packets or portions thereof that include identity data and/or other related data (e.g., requests for identity data, acknowledgement, indicators of whether identity data is unique and/or whether the data packets include identity data, and/or other data related to the communication between the computer system and the charging source). The computer system detects (10002) (e.g., via the one or more sensors and/or input devices of the computer system, and/or based on a change in an internal state of the computer system) a first event (e.g., an event that corresponds to at least one of a change in an orientation of the display generation component and/or a change in a charging state of the computer system, or other event(s) relevant for whether to activate a respective operating mode of the device).

In response to detecting (10004) the first event, and in accordance with a determination that first criteria are met as a result of the first event, wherein the first criteria require that the orientation of the display generation component is a first orientation (e.g., a portrait orientation or a landscape orientation; a particular pitch, yaw, and/or roll relative to a physical reference plane (e.g., the floor, a table top, a wall, or a charging stand); or is within a threshold range of pitch, yaw, and/or roll values relative to the physical reference plane) (e.g., the computer system 100 is in a landscape orientation in FIG. 5M), and that the computer system is charging (e.g., the computer system is physically connected to a plug-in power source via a charging cable to receive power from the power source, or the computer system is coupled wirelessly to a wireless charging source to receive power from the wireless charging source, optionally, irrespective of the current charge level or whether the computer system is fully charged and drawing little power from the power source) (e.g., the computer system 100 is connected to the charging source 5056 in FIG. 5M), in order for the first criteria to be met, the computer system displays (10006) a first customizable user interface that was not displayed prior to detecting the first event (e.g., the clock user interface 50508 in FIG. 5M). In some embodiments, the first criteria are not met based on one or more exceptions, even if the orientation of the display generation component and the charging state of the computer system both met the above requirements of the first criteria. For example, in some embodiments, in accordance with a determination that the electronic device is moving by more than a threshold amount in a unit of time, the first criteria are not met even if the electronic device is charging and is in the first orientation during the movement of the electronic device. In some embodiments, the first customizable user interface includes one or more features that are use-configurable, and/or include content or functions that are selected by the user using a configuration user interface for the first customizable user interface. In some embodiments, the first criteria further require that the first event is detected when the last-displayed user interface of electronic device immediately prior to detecting the first event to be a lock screen user interface, a wake screen user interface, a home screen user interface, a system user interface that corresponds to a restricted state of the electronic device where access to a home screen user interface is restricted (e.g., by requiring authentication and/or dismissing the system user interface with a system navigation gesture), and/or other system user interfaces). In some embodiments, the first customizable user interface provides a limited number of functions (e.g., including a function that is provided via a widget of an application or a widget of the operating system) that are also provided by the electronic device via one or more applications or the operating system.

In response to detecting (10004) the first event, and in accordance with a determination that the first criteria are not met as a result of the first event, the computer system forgoes (10008) displaying the first customizable user interface (e.g., in FIG. 5G, the computer system 100 is not connected to the charging source 5056 and so the computer system 100 does not display the clock user interface 5058; and in FIGS. 5I-5L, the computer system 100 is not in the landscape orientation, and the computer system 100 does not display the clock user interface 5058). In some embodiments, displaying the first customizable user interface includes displaying a first set of user interface objects corresponding to a first ambient mode, and in accordance with a determination that the first criteria are not met, the computer system displays a subset of the first set of user interface objects (e.g., only displaying the objects on the regular wake screen user interface, such as the time and date indication, and system status indicators, and optionally widgets that includes less widget content than that shown in the first customizable user interface), or displays a different user interface that includes a completely different set of user interface objects from the first set of user interface objects. In some embodiments, in accordance with a determination that the first criteria are not met as a result of the first event, the electronic device maintains display of the user interface that was displayed at the time that the first event had occurred (and optionally, with a different orientation if the first event includes a change in orientation of the device).

In some embodiments, the first event includes (10010) an event that corresponds to at least one of a change in the orientation of the display generation component and/or a change in a charging state of the computer system, and wherein the determination that the first criteria are not met as a result of the first event includes one or more of: a determination that the orientation of the display generation component is not the first orientation and that the computer system is charging; a determination that the orientation of the display generation component is the first orientation and that the computer system is not charging; and/or a determination that the orientation of the display generation component is not the first orientation and that the computer system is not charging. In some embodiments, the determination that the first criteria are not met as a result of the first event includes a determination that the display generation component is moving by more than a threshold amount of movement while the orientation of the display generation component is the first orientation and the computer system is charging. For example, in FIGS. 5I and 5J, the computer system 100 is not in the first orientation (e.g., is not in the landscape orientation) and the computer system 100 is charging (e.g., via the charger 5044), and the computer system 100 does not display an ambient mode user interface. In FIGS. 5G and 5H, the computer system 100 is in the first orientation (e.g., is in the landscape orientation after rotation of the computer system 100) and is not connected to the charging source 5056, and the computer system 100 does not display an ambient mode user interface. Also in FIGS. 5G and 5H, the computer system 100 is not in the first orientation (e.g., is in the portrait orientation prior to rotation of the computer system 100) and is not connected to the charging source 5056, and the computer system 100 does not display an ambient mode user interface. Displaying a first customizable user interface that was not displayed prior to detecting the first event, in accordance with a determination that the first criteria are met as a result of the first event, and forgoing displaying the first customizable user interface in accordance with a determination that the first criteria are not met as a result of the first event, enables the computer system to automatically display the appropriate user interface (e.g., depending on whether or not the first criteria are met) without requiring additional user inputs (e.g., additional user inputs for displaying the first customizable user interface when the first criteria are met, or additional user inputs for ceasing to display the first customizable user interface when the first criteria are not met).

In some embodiments, detecting the first event includes (10011) detecting that a respective set of conditions for the computer system to transition into a restricted mode has been met (e.g., the set of conditions for the computer system to transition from display a user interface in a normal mode to displaying a dimmed always-on wake screen user interface, to displaying a lock screen user interface, to displaying a wake screen user interface, or a user interface of a restricted state in which access to the home screen is restricted (e.g., requiring a home gesture, and/or authentication of the user) are met, e.g., due to a period of inactivity by the user, or due to the user pressing the power button) while the orientation of the display generation component is in the first orientation and the computer system is charging (e.g., coupled to the charging source in a manner that enables charging the batteries of the computer system using the power transfer signals received from the charging source if the batteries of the computer system is not yet fully charged), and wherein the first criteria are met as a result of the first event. In some embodiments, in response to detecting the first event, the computer system, optionally, sends a request (e.g., the packet 5206 and/or the packet 5210 in FIG. 5AP) to the charging source (e.g., the PTx 5174 in FIG. 5AP) to receive a unique identifier of the charging source via one or more power transfer signals sent from the charging source (e.g., a wireless charging source, or a wired charging source) to the computer system (e.g., to the power transfer coil, or other charging components), and decodes the unique identifier of the charging source from the one or more power transfer signals. In some embodiments, the computer system has already obtained the unique identifier of the charging source (e.g., when the charging connection is first established, or in response to detecting a change in the orientation of the computer system into the first orientation while the computer system is charging) before the first event (e.g., when the set of conditions for transitioning into the restricted mode (e.g., the sleep or locked mode) are met) is detected. For example, in FIG. 8F, the computer system 100 is in the first orientation (e.g., is in the landscape orientation after rotation) and is connected to the charging source 5056, but is in a non-restricted mode (e.g., an unrestricted or unlocked mode, displaying a home screen user interface), but an ambient mode user interface (e.g., the media display user interface 6162 in FIG. 8H) is displayed in response to detecting a transition to a restricted mode (e.g., by activating a lock button of the computer system 100 via the user input 8008 in FIG. 8F, and optionally dismissing the user interface 8010 in FIG. 8G, if necessary). Displaying a first customizable user interface that was not displayed prior to detecting the first event, in accordance with a determination that the first criteria are met as a result of the first event, and forgoing displaying the first customizable user interface in accordance with a determination that the first criteria are not met as a result of the first event, in accordance with a determination that the first criteria are met, wherein detecting the first event includes detecting that a respective set of conditions for the computer system to transition into the restricted mode are met while the orientation of the display generation component is in the first orientation and the first computer system is charging, enables the computer system to automatically display the appropriate user interface (e.g., depending on whether or not the first criteria are met) without requiring additional user inputs (e.g., additional user inputs for displaying the first customizable user interface when the first criteria are met, or additional user inputs for ceasing to display the first customizable user interface when the first criteria are not met).

In some embodiments, the restricted mode includes (10012) a low-power mode (e.g., a sleep mode, a display-off mode, and/or a dimmed always-on mode that is usually turned on when the user has not interacted with the computer system for at least a threshold amount of time). For example, in some embodiments, the display generation component is rotated into the first orientation and the computer system is put into a charging state while the computer system is operating in a normal state (e.g., responding to user interactions and/or displaying user interfaces in the normal mode); and later, while the display generation component remains in the first orientation and remains in the charging state, the computer system determines that the respective set of conditions for the computer system to transition into the low-power mode are met; however, instead of actually transitioning into the low-power mode, the computer system, in accordance with a determination that the orientation of the display generation component is the first orientation and the computer system is charging, automatically displays the first customized user interface. In some embodiments, when the device is in the low-power mode, the device consumes less power per unit time than when the device is operating in the normal mode, because some components and/or functions of the device is turned off or reduced, while the states of the device are stored in the memory of the device. For example, as described with reference to FIG. 8F, the computer system 100 is in the first orientation (e.g., is in the landscape orientation after rotation) and is connected to the charging source 5056, but is in a non-restricted mode (e.g., an unrestricted or unlocked mode, displaying a home screen user interface). An ambient mode user interface (e.g., the media display user interface 6162 in FIG. 8H) is displayed in response to detecting that the computer system 100 enters a low-power or sleep state (e.g., automatically after a period in which the user does not interact with the computer system 100). Displaying a first customizable user interface that was not displayed prior to detecting the first event, in accordance with a determination that the first criteria are met as a result of the first event, and forgoing displaying the first customizable user interface in accordance with a determination that the first criteria are not met as a result of the first event, in accordance with a determination that the first criteria are met, wherein detecting the first event includes detecting that a respective set of conditions for the computer system to transition into a low-power mode are met while the orientation of the display generation component is in the first orientation and the first computer system is charging, enables the computer system to automatically display the appropriate user interface (e.g., depending on whether or not the first criteria are met) without requiring additional user inputs (e.g., additional user inputs for displaying the first customizable user interface when the first criteria are met, or additional user inputs for ceasing to display the first customizable user interface when the first criteria are not met).

In some embodiments, the restricted mode includes (10014) a locked mode (e.g., the set of conditions for the computer system to transition from display a user interface in a normal mode to displaying a lock screen user interface, e.g., due to a locking input provided by a user (e.g., pressing the lock button, or power button)). For example, in some embodiments, the display generation component is rotated into the first orientation and the computer system is put into a charging state while the computer system is operating in a normal state (e.g., responding to user interactions and/or displaying user interfaces in the normal mode); and later, while the display generation component remains in the first orientation and remains in the charging state, the computer system determines that the respective set of conditions for the computer system to transition into the locked mode are met; however, instead of actually transitioning into the locked mode and displaying the lock screen user interface, the computer system, in accordance with a determination that the orientation of the display generation component is the first orientation and the computer system is charging, automatically displays the first customized user interface. For example, in FIG. 8F, the computer system 100 is in the first orientation (e.g., is in the landscape orientation after rotation) and is connected to the charging source 5056, but is in a non-restricted mode (e.g., an unrestricted or unlocked mode, displaying a home screen user interface), but an ambient mode user interface (e.g., the media display user interface 6162 in FIG. 8H) is displayed in response to detecting a transition to a restricted mode (e.g., by activating a lock button of the computer system 100 via the user input 8008 in FIG. 8F, and optionally dismissing the user interface 8010 in FIG. 8G, if necessary). Displaying a first customizable user interface that was not displayed prior to detecting the first event, in accordance with a determination that the first criteria are met as a result of the first event, and forgoing displaying the first customizable user interface in accordance with a determination that the first criteria are not met as a result of the first event, in accordance with a determination that the first criteria are met, wherein detecting the first event includes detecting that a respective set of conditions for the computer system to transition into a locked mode are met while the orientation of the display generation component is in the first orientation and the first computer system is charging, enables the computer system to automatically display the appropriate user interface (e.g., depending on whether or not the first criteria are met) without requiring additional user inputs (e.g., additional user inputs for displaying the first customizable user interface when the first criteria are met, or additional user inputs for ceasing to display the first customizable user interface when the first criteria are not met).

In some embodiments, detecting the first event includes (10016) detecting that the orientation of the display generation component is in the first orientation and the computer system is charging as a result of the first event, while the computer system is operating in a restricted mode (e.g., displaying a dimmed always-on wake screen user interface, displaying a lock screen user interface, displaying a wake screen user interface or a user interface of a restricted state in which access to the home screen is restricted (e.g., requiring a home gesture, and/or authentication of the user). For example, while the device is operating in a restricted mode (e.g., a low-power mode, a locked mode, or another state), if the computer system detects that the computer system is connected to a charging source and starts charging and/or that the orientation of the computer system has transitioned into the first orientation, such that the computer system is in the first orientation and is charging at the same time, the computer system determines that the first criteria are met and displays the first customizable user interface. In some embodiments, if the computer system is not operating in the restricted mode when the computer system detects that the computer system is in the first orientation and is charging at the same time, the computer system determines that the first criteria are not met, and does not display the first customizable user interface. In some embodiments, in response to detecting the first event, e.g., when the computer system is coupled to the charging source while the computer system is in the first orientation, or when the computer system is turned into the first orientation while the computer system is coupled to the charging source, the computer system, optionally, sends a request (e.g., the packet 5206 and/or the packet 5212 in FIG. 5AP) to the charging source (e.g., the PTx 5174 in FIG. 5AP) to receive a unique identifier of the charging source via one or more power transfer signals sent from the charging source (e.g., a wireless charging source, or a wired charging source) to the computer system (e.g., to the power transfer coil, or other charging components), and decodes the unique identifier of the charging source from the one or more power transfer signals. In some embodiments, the computer system has already obtained the unique identifier of the charging source (e.g., when the charging connection is first established), before the computer system is turned into the first orientation while in the restricted mode. For example, this is described with reference to FIG. 5M, if the computer system 100 is connected to the charging source 5056 and the display of the computer system 100 is in the landscape orientation, but the computer system 100 is not operating in the restricted mode, the computer system 100 does not display the clock user interface 5058 (e.g., or enter the ambient mode). If the computer system 100 enters the restricted mode (e.g., in response to detecting that a user has locked the computer system 100 and/or performed user inputs to operate the computer system 100 in the low-power mode) (e.g., while the computer system 100 remains connected to the charging source 5056, and while the display of the computer system 100 remains in the landscape orientation), the computer system 100 displays the clock user interface 5056 (e.g., and enters the ambient mode) (e.g., in response to detecting that the computer system 100 has entered the restricted mode).

This is also shown in FIGS. 8F, 8G, and 8H. In FIG. 8F, the computer system 100 is in the landscape orientation and is connected to the charging source 5056, but the computer system 100 displays a home screen user interface (e.g., the computer system 100 is not operating in a restricted state). In response to detecting the user input 8008 (e.g., which locks the computer system 100), the computer system 100 displays the user interface 8010 in FIG. 8G (e.g., and enters an ambient mode of the computer system 100, as shown in FIG. 8H). Displaying a first customizable user interface that was not displayed prior to detecting a first event, in response to detecting that the orientation of the display generation component is in the first orientation and the computer system is charging as a result of the first event, while the computer system is operating in a restricted mode, and forgoing displaying the first customizable user interface, in response to detecting the first event and in accordance with a determination that the first criteria are not met as a result of the first event, automatically displays an appropriate user interface without requiring additional user input (e.g., additional user inputs to display the first customizable user interface when first criteria are met, and/or additional user inputs to cease displaying the first customizable user interface if first criteria are not met).

In some embodiments, the determination that the first criteria are not met as a result of the first event includes (10018) a determination that the computer system was in a vehicle (e.g., a car, a train, a boat, or other vehicles) at a time that the first event occurred. In some embodiments, the electronic device determines whether the electronic device was in a vehicle at the time that the first event occurred in accordance with a change in location (e.g., GPS location, cell tower information, or other geolocation information associated with the electronic device), a movement pattern (e.g., speed, movement along a road or highway) of the electronic device, and/or existence of a communication link (e.g., wired or wireless) established from the electronic device with to a vehicle. For example, as described with reference to FIG. 5M, the computer system 100 may also require that the computer system 100 is not in active communication with a vehicle (e.g., in addition to having the right orientation and being connected to a charging source), before displaying an ambient mode user interface. Displaying a first customizable user interface that was not displayed prior to detecting the first event, in accordance with a determination that the first criteria are met as a result of the first event, and forgoing displaying the first customizable user interface in accordance with a determination that the computer system was in a vehicle at a time that the first event occurred, enables the computer system to automatically display the appropriate user interface (e.g., depending on whether or not the first criteria are met) without requiring additional user inputs (e.g., additional user inputs for displaying the first customizable user interface when the first criteria are met, or additional user inputs for ceasing to display the first customizable user interface when the first criteria are not met).

In some embodiments, the determination that the first criteria are not met as a result of the first event includes (10020) a determination that the computer system was moved by more than a threshold amount of movement within a unit of time at a time that the first event occurred (e.g., translational movement of the computer system, optionally, within a threshold amount of time). For example, in some embodiments, the movement of the electronic device is indicative of whether the electronic device is in a moving vehicle or is being carried around by a user, and therefore not suitable for displaying the first customizable user interface. For example, as described with reference to FIG. 5M, the computer system 100 may also require that the computer system 100 does not detect more than a threshold amount of movement within a threshold amount of time (e.g., in addition to having the right orientation and being connected to a charging source), before displaying and/or in order to display an ambient mode user interface. Displaying a first customizable user interface that was not displayed prior to detecting the first event, in accordance with a determination that the first criteria are met as a result of the first event, and forgoing displaying the first customizable user interface in accordance with a determination that the computer system was moved by more than a threshold amount of movement within a unit of time at a time that the first event occurred, enables the computer system to automatically display the appropriate user interface (e.g., depending on whether or not the first criteria are met) without requiring additional user inputs (e.g., additional user inputs for displaying the first customizable user interface when the first criteria are met, or additional user inputs for ceasing to display the first customizable user interface when the first criteria are not met).

In some embodiments, the determination that the first criteria are not met as a result of the first event includes (10022) a determination that the computer system is in communication (e.g., through a wired connection, via wireless communication, and/or via a Bluetooth connection) with a vehicle (e.g., a sound system, or radio of the vehicle). For example, in some embodiments, when a user connects the electronic device to the vehicle's communication port, the orientation of the electronic device and the charging state of the electronic device meet the requirements of the first criteria in those two respects, however, the first customizable user interface is not displayed because the electronic device is connected to the vehicle. For example, as described with reference to FIG. 5M, the computer system 100 may also require that the computer system 100 is not in active communication with a vehicle (e.g., in addition to having the right orientation and being connected to a charging source), before displaying an ambient mode user interface. Displaying a first customizable user interface that was not displayed prior to detecting the first event, in accordance with a determination that the first criteria are met as a result of the first event, and forgoing displaying the first customizable user interface in accordance with a determination that the computer system is in communication with a vehicle, enables the computer system to automatically display the appropriate user interface (e.g., depending on whether or not the first criteria are met) without requiring additional user inputs (e.g., additional user inputs for displaying the first customizable user interface when the first criteria are met, or additional user inputs for ceasing to display the first customizable user interface when the first criteria are not met).

In some embodiments, displaying the first customizable user interface includes (10024): in accordance with a determination that the first criteria are met as a result of the first event and that a first set of contextual conditions are met, displaying the first customizable user interface including first content (e.g., a first ambient mode, a first set of user interface objects that correspond to a first ambient mode, a first version of a first ambient mode); and in accordance with a determination that the first criteria are met as a result of the first event and that a second set of contextual conditions, different from the first set of contextual conditions are met, displaying the first customizable user interface including second content (e.g., a second ambient mode, a second set of user interface objects that correspond to a second ambient mode, a second version of the first ambient mode), different from the first content. In some embodiments, the first customizable user interface includes different ambient modes, and a respective one of the different ambient modes is automatically selected and displayed when the first criteria are met, where the respective one of the ambient mode is selected based on the current context as determined based on different sets of contextual conditions associated with different ambient modes. In some embodiments, the content in a respective ambient mode (e.g., appearance and substantive content) is also customized based on the current context. In some embodiments, the first set of contextual conditions includes a requirement that a respective identifier of the charging source (e.g., as decoded from the power transfer signals provided by the charging source, or obtained through other means) is a first identifier (e.g., an identifier for a first type of charging source, or a first unique identifier that was stored by the computer system for a first previously encountered charging source, and/or the respective identifier is indicated as being unique by the information decoded from the power transfer signals provided by the charging source); and the second set of contextual conditions includes a requirement that the respective identifier of the charging source (e.g., as decoded from the power transfer signals provided by the charging source, or obtained through other means) is a second identifier (e.g., an identifier for a second type of charging source, or a second unique identifier that was stored by the computer system for a second previously encountered charging source, and/or the respective identifier is indicated as being unique by the information decoded from the power transfer signals provided by the charging source) that is different from the first identifier. In some embodiments, the first set of contextual conditions includes a requirement that a respective identifier of the charging source (e.g., as decoded from the power transfer signals provided by the charging source, or obtained through other means) is a first identifier (e.g., an identifier for a first type of charging source, or a first unique identifier that was stored by the computer system for a first previously encountered charging source, and/or the respective identifier is indicated as being unique by the information decoded from the power transfer signals provided by the charging source); and the second set of contextual conditions includes a requirement that no previously stored identifier was detected in the power transfer signals provided by the charging source (e.g., the charging source has an identifier that is not previously stored by the computer system, the computer system is not able to decode an identifier from the power transfer signals of the charging source, the respective identifier is indicated as not being unique by the information decoded from the power transfer signals provided by the charging source, and/or the charging source does not encode its identifier in the power transfer signals). In some embodiments, the first content and the second content of the first customizable user interface are respectively configured in accordance with the respective sets of customization parameters stored in association with the first identifier and the second identifier. In some embodiments, the first content is configured in accordance with the respective set of customization parameters stored in association with the first identifier, and the second content is configured in accordance with a default set of customization parameters that is not associated with a specific identifier of a charging source and is used for charging sources of which a unique identifier could not be decoded, the respective identifier that is not indicated as being unique by the information decoded from the power transfer signals provided by the charging source, and/or of which a unique identifier was not previously known and/or stored. For example, in FIGS. 5Q-5V, the computer system 100 displays a different ambient mode user interface depending on the context. In FIG. 5Q, during “day time” hours, the computer system 100 displays the clock user interface 5068. In FIG. 5R, during “night time” hours, the computer system 100 displays the clock user interface 5072. In FIG. 5S, while a “work” focus mode of the computer system 100 is active, the computer system 100 displays the widget user interface 5078. In FIGS. 5T-5V, while a “home” focus mode of the computer system 100 is active, the computer system 100 displays the home control user interface 7086 (and/or the home control user interface 5100). Displaying the first customizable user interface including first content in accordance with a determination that the first criteria are met as a result of the first event and that a first set of contextual conditions are met, and displaying the first customizable user interface including second content that is different from the first content, in accordance with a determination that the first criteria are met as a result of the first event and that a second set of contextual conditions different from the first set of contextual conditions are met, automatically displays the appropriate content (e.g., first content or second content) without requiring additional user inputs (e.g., additional user inputs to display the first content, additional user inputs to display the second content, and/or additional user inputs to switch from displaying the first content to displaying the second content).

In some embodiments, the first set of contextual conditions includes (10026) a first condition that the computer system is charging via a first charging source, and the second set of contextual conditions include a second condition that the computer system is charging via a second charging source, different from the first charging source (e.g., different in type (e.g., wired, wireless, a stand, a cable, a smart charging station, or a simple charger), or located at different locations (e.g., office, home, school, coffee shop, or other locations), different owners (e.g., shared, private, public, or other ownership types), or other differences). For example, in some embodiments, if the electronic device is being charged via a stand versus a cable, the electronic device displays different ambient modes, or the same ambient modes with different categories of content (e.g., work-related, home-related, fun-related, or other suitable content for a stable setting or temporary setting). In some embodiments, the computer system distinguishes the first charging source and the second charging source based on the type of charging source (e.g., wireless vs. wired, AC vs. DC, and/or other different types of charging technologies). In some embodiments, the computer system distinguishes the first charging source and the second charging source based on respective identifiers that are carried by the power transfer signals received from the charging source. In some embodiments, the charging sources encode their respective unique identifiers in their power transfer signals and the computer system obtains the respective unique identifiers from the power transfer signals (e.g., either while charging the battery using the power transfer signals, or between active charging cycles (e.g., when first coupled to the charging source and before active charging is started, or after battery is fully charged and active charging is slowed or suspended)). In some embodiments, the computer system compares the unique identifier obtained from the currently used charging source with one or more stored identifiers for charging sources that were used during previous occasions that one or more customizable user interfaces were displayed and/or configured by a user. If the identifier of the currently used charging source matches one of the stored identifiers for charging sources, the computer system displays the first customizable user interface (e.g., the clock user interface 5058 in FIG. 5M, the widget user interface 5078 in FIG. 5S, the home control user interface 5086 in FIG. 5T, the voice memo user interface 6074 in FIG. 6O, the ambient sound user interface 6090 in FIG. 6Q, the media user interface 6098 in FIG. 6S, or the user interface 8010 in FIG. 8I) according to one or more customization parameters associated with the matched identifier (e.g., choosing a preferred customizable user interface for the respective identifier out of a plurality of contextually relevant customizable user interfaces, and/or generating a respective versions of the first customizable user interface with customized content and/or display options for the content). For example, in FIG. 5X, while the computer system 100 is connected to a wireless charger 5048, the computer system 100 displays the clock user interface 5110 (e.g., and displays the clock user interface 5058 if the computer system 100 is charging via physical charger). Displaying the first customizable user interface including first content in accordance with a determination that the first criteria are met as a result of the first event and that the computer system is charging via a first charging source, and displaying the first customizable user interface including second content that is different from the first content, in accordance with a determination that the first criteria are met as a result of the first event and that the computer system is charging via a second charging source that is different from the first charging source, automatically displays the appropriate content (e.g., first content or second content) without requiring additional user inputs (e.g., additional user inputs to display the first content, additional user inputs to display the second content, and/or additional user inputs to switch from displaying the first content to displaying the second content).

In some embodiments, the first set of contextual conditions includes (10028) a third condition that the computer system is located in a first location, and the second set of contextual conditions include a fourth condition that the computer system is located in a second location, different from the first location. In some embodiments, the first location is specified by the user (e.g., the user can manually set locations at which different ambient modes and/or different versions of the same ambient mode is displayed, when the first criteria are met). In some embodiments, the computer system automatically determines the locations at which different ambient modes and/or different versions of the same ambient mode are displayed (e.g., based on location history and/or patterns of the computer system). In one example, in some embodiments, different ambient modes or different versions of the same ambient mode are displayed depending on whether the device is located at a home location, an office location, a public location, and/or a private location. In some embodiments, the computer system determines a location of the computer system when a respective charging source is used to charge the computer system and location information is available, and associates the identifier of the charging source with the location; and subsequently, if the computer system detects that a charging source of the same identifier is being used to charge the computer system, the computer system, optionally, uses the location associated with the identifier of the charging source as the location of the computer system, and customize the customizable user interface based on the location. For example, in FIG. 5S, the computer system 100 could be in the “work” focus mode because the computer system 100 is at a “work” location, and the computer system 100 displays the widget user interface 5078. In FIG. 5U, the computer system 100 is at a “home” location, and the computer system 100 displays the home control user interface 5086. Displaying the first customizable user interface including first content in accordance with a determination that the first criteria are met as a result of the first event and that the computer system is located in a first location, and displaying the first customizable user interface including second content that is different from the first content, in accordance with a determination that the first criteria are met as a result of the first event and that the computer system is located in a second location that is different from the first location, automatically displays the appropriate content (e.g., first content or second content) without requiring additional user inputs (e.g., additional user inputs to display the first content, additional user inputs to display the second content, and/or additional user inputs to switch from displaying the first content to displaying the second content).

In some embodiments, the first set of contextual conditions includes (10030) a fifth condition that a current time is within a first time range, and the second set of contextual conditions includes a sixth condition that the current time is within a second time range, different from the first time range (e.g., the first and second time range differ in time of day, season, whether it is a workday, weekend, or holiday, relationship to a user-specified range and/or a scheduled event, and/or other relevant time frames). In some embodiments, the first time range and/or the second time range are specified by the user. In some embodiments, the first time range and the second time range are established automatically by the electronic device. For example, in FIG. 5Q, during “day time” hours, the computer system 100 displays the clock user interface 5068. In FIG. 5R, during “night time” hours, the computer system 100 displays the clock user interface 5072. Displaying the first customizable user interface including first content in accordance with a determination that the first criteria are met as a result of the first event and that a current time is within the first time range, and displaying the first customizable user interface including second content that is different from the first content, in accordance with a determination that the first criteria are met as a result of the first event and that the current time is within a second time range, different from the first time range, automatically displays the appropriate content (e.g., first content or second content) without requiring additional user inputs (e.g., additional user inputs to display the first content, additional user inputs to display the second content, and/or additional user inputs to switch from displaying the first content to displaying the second content).

In some embodiments, the first content includes (10032) a first set of widgets and the second content includes a second set of widgets different from the first set of widgets. For example, in some embodiments, the first set of widgets include work-related widgets (e.g., stock, calendar, office to-dos, and other work-related widgets) and are displayed when the time of day is between work hours and/or the location is at the office; and the second set of widgets include home-related widgets (e.g., home control, music, home to-dos, and other home-related widgets). As used herein, in some embodiments, widgets (also referred to as mini application objects) are user interface objects that provide a limited subset of functions and/or information available from their corresponding applications without requiring the applications to be launched. In some embodiments, mini-application objects (or widgets) contain application content that is dynamically updated based on the current context. In some embodiments, a tap input or other selection input on a mini-application object (widget) causes the corresponding application to be launched. In some embodiments, a respective mini application object operates as a standalone application residing in memory of the device, distinct from an associated application also residing in the memory of the device. In some embodiments, a respective mini application object operates as an extension or component of an associated application on the device. In some embodiments, a respective mini application object has a dedicated memory portion for temporary storage of information. In some embodiments, the memory portion is accessible by a corresponding full-featured application of the respective mini application object. In some embodiments, a mini application object is configured to perform a subset, less than all, of the functions of a corresponding application. In some embodiments, a mini application object displays an identifier for the corresponding application. In some embodiments, a mini application object displays a portion of the content from the corresponding application. For example, as described with reference to FIG. 5S, the widget user interface 5078 includes a calendar widget and a notes widget while a “work” focus mode is active for the computer system 100. When a different focus mode (e.g., a “home” focus mode, as in FIG. 5T) is active, the computer system 100 displays a different widget user interface that includes different widgets (e.g., a stocks widget and a weather widget, for example, as shown in FIG. 7C). Displaying the first customizable user interface including a first set of widgets in accordance with a determination that the first criteria are met as a result of the first event and that a first set of contextual conditions are met, and displaying the first customizable user interface including a second set of widgets that is different from the first set of widgets, in accordance with a determination that the first criteria are met as a result of the first event and that a second set of contextual conditions different from the first set of contextual conditions are met, automatically displays the appropriate content (e.g., first content or second content) without requiring additional user inputs (e.g., additional user inputs to display the first content, additional user inputs to display the second content, and/or additional user inputs to switch from displaying the first content to displaying the second content).

In some embodiments, the first content includes (10034) a first type of content (e.g., a first ambient mode, or a first version of the first ambient mode) and the second content includes a second type of content (e.g., a second ambient mode, or a second version of the first ambient mode) different from the first type of content. In some embodiments, the first type of content includes a first ambient mode such as a sleep clock ambient mode, and the second type of content includes a second ambient mode such as a widgets ambient mode. In some embodiments, the first type of content includes sleep clock mode of a clock ambient mode, and the second type of content includes a time zone mode of a clock ambient mode. In some embodiments, the first type of content includes a media display ambient mode, and the second type of content includes a calendar ambient mode or home control ambient mode. In some embodiments, other ambient modes and/or other versions of the ambient modes are displayed in the first customizable user interface depending on the different contexts. In some embodiments, displaying a respective ambient mode (and/or displaying a respective type of content) includes displaying a user interface of the respective ambient mode that presents information (e.g., data, content, and/or media, in useful and/or informative formats), provide user interface controls (e.g., controls for changing how information is presented, and changing and/or causing performance of one or more device and/or application functions), and navigation functions to access additional information, configuration options, and/or other ambient modes and/or to exit the ambient mode. For example, in FIG. 5R, the computer system 100 displays a clock user interface 5072 (e.g., sleep clock user interface of a sleep clock ambient mode, or a sleep clock version of the ambient mode). In FIG. 5S, the computer system 100 displays a widget user interface 5078 (e.g., a widget user interface for a widget ambient mode, or a widget version of the ambient mode). Displaying the first customizable user interface including a first type of content, in accordance with a determination that the first criteria are met as a result of the first event and that a first set of contextual conditions are met, and displaying the first customizable user interface including a second type of content that is different from the first type of content, in accordance with a determination that the first criteria are met as a result of the first event and that a second set of contextual conditions different from the first set of contextual conditions are met, automatically displays the appropriate content (e.g., first content or second content) without requiring additional user inputs (e.g., additional user inputs to display the first content, additional user inputs to display the second content, and/or additional user inputs to switch from displaying the first content to displaying the second content).

In some embodiments, the first set of contextual conditions includes (10036) a seventh condition that the computer system is operating in a first mode in which alerts generation is moderated in a first manner at the computer system (e.g., a first focus mode, such as a sleep mode), and the second set of contextual conditions includes an eighth condition that the computer system is operating in a second mode in which alert generation is moderated in a second manner (e.g., a second focus mode, such as a work focus mode), different from the first manner, at the computer system. For example, in some embodiments, if the sleep mode is active on the electronic device, the electronic device displays a sleep clock ambient mode, and if the work focus mode is active on the electronic device, the electronic device displays an ambient mode showing work-related information (e.g., in graphics (e.g., charts, graphs, and other types of visualization of information), widgets (e.g., stock widget, world clock widget, and/or calendar widget), lists and/or summaries). In some embodiments, the computer system operating in the first mode and/or the second mode also adjust other device and/or operating system behaviors in different manners, such as adjusting display brightness and color temperature settings, wallpaper configurations for system user interfaces, and/or availability of certain applications (e.g., via screentime management, shortcut management, and/or other types of management of access to applications and functions), in different manners. For example, in FIG. 5R, the clock user interface 5072 is a clock user interface that is displayed while the a “sleep” focus mode is active for the computer system 100. In FIG. 5S, the widget user interface 5078 (e.g., a user interface for an ambient mode that presents contextually relevant information or data) while the “work” focus mode is active for the computer system 100. As described with reference to FIG. 5S, in some embodiments, different focus modes moderate how content is displayed and/or generated differently). Displaying the first customizable user interface including first content in accordance with a determination that the first criteria are met as a result of the first event and that the computer system is operating in a first mode in which alerts generation is moderated in a first manner at the computer system, and displaying the first customizable user interface including second content that is different from the first content, in accordance with a determination that the first criteria are met as a result of the first event and that the computer system is operating in a second mode in which alert generation is moderated in a second manner that is different from the first manner, automatically displays the appropriate content (e.g., first content or second content) without requiring additional user inputs (e.g., additional user inputs to display the first content, additional user inputs to display the second content, and/or additional user inputs to switch from displaying the first content to displaying the second content).

In some embodiments, while displaying the first customizable user interface, the computer system detects (10038) (e.g., via the one or more sensors and/or input devices of the computer system) a first user input (e.g., a tap on the display generation component, a long press on the display generation component, an upward swipe from a bottom edge of the computer system while the computer system is in the first orientation, a downward swipe from a top edge of the computer system while the computer system is in the first orientation, or a left or right swipe from an edge of the computer system); and in response to detecting the first user input, in accordance with a determination that the first user input meets dismissal criteria, the computer system ceases to display the first customizable user interface. In some embodiments, in response to detecting the first user input, in accordance with a determination that the first user input does not meet the dismissal criteria, the computer system does not cease to display the first customizable user interface. For example, in some embodiments, in response to detecting the first user input, in accordance with a determination that the first user input meets first switching criteria, the electronic device switches the content of the first customizable user interface to display a different ambient mode, a different version of the same ambient mode, or performing an operation and/or navigating within the currently displayed ambient mode. In some embodiments, in response to detecting the first user input, in accordance with a determination that the first user input meets the dismissal criteria, the computer system redisplays a previously displayed user interface (e.g., a user interface displayed when the first event was detected) in conjunction with ceasing to display the first customizable user interface. For example, in FIGS. 5AH-5AI and FIGS. 5AJ-5AK, the computer system 100 detects a first user input that meets dismissal criteria (e.g., rotates the computer system 100 so that it is no longer in the landscape orientation and/or disconnects the computer system 100 from the charging source 5056), and in response, the computer system 100 ceases to display an ambient mode user interface (e.g., the clock user interface 5058 in FIG. 5AH, or the home control user interface 5086 in FIG. 5AJ). Ceasing to display the first customizable user interface, in response to detecting the first user input and in accordance with a determination that the first user input meets dismissal criteria, automatically ceases to display the first customizable user interface without requiring additional user inputs (e.g., additional user inputs to cease to display the first customizable user interface) (e.g., when the first customizable user interface is no longer contextually relevant and should not be displayed).

In some embodiments, the dismissal criteria are met (10040) in accordance with a determination that the first user input is a tap input (e.g., a tap on the display, and/or in an unoccupied region of the first customizable user interface). For example, in FIG. 5AH, the computer system 100 detects the user input 5132, and in response (e.g., as shown in FIG. 5AI), the computer system 100 ceases to display the clock user interface 5058 and displays a wake user interface. Ceasing to display the first customizable user interface, in response to detecting a tap input and in accordance with a determination that the first user input meets dismissal criteria, automatically ceases to display the first customizable user interface without requiring additional user inputs (e.g., additional user inputs to cease to display the first customizable user interface) (e.g., when the first customizable user interface is no longer contextually relevant and should not be displayed).

In some embodiments, in response to detecting (10042) the first user input: in accordance with a determination that the first user input meets the dismissal criteria and that the first user input is directed to a first portion of the display generation component (e.g., directed to a first portion of unoccupied region of the first customizable user interface), the computer system replaces display of the first customizable user interface with a first replacement user interface (e.g., a wake screen user interface, a home screen user interface, or another replacement user interface); and in accordance with a determination that the first user input meets the dismissal criteria and that the first user input is directed to a second portion, different from the first portion, of the display generation component (e.g., directed to a second portion of unoccupied region of the first customizable user interface), the computer system replaces display of the first customizable user interface with a second replacement user interface (e.g., a configuration user interface for the first customizable user interface, or another ambient mode), different from the first replacement user interface. For example, in some embodiments, tapping on the upper right corner of the user interface of the currently displayed ambient mode causes display of the configuration of the currently displayed ambient mode; and tapping on other portions of the currently displayed ambient mode that is not occupied by a selectable user interface object causes display of the wake screen user interface. For example, as described with reference to FIGS. 5AH, the computer system 100 optionally displays the wake screen user interface of the computer system 100 in response to detecting a tap input at a first location, and displays a different user interface of the computer system 100 in response to detecting a tap input at a second location different from the first location. Replacing display of the first customizable user interface with a first replacement user interface, in accordance with a determination that the first user input meets the dismissal criteria and that the first user input is directed to a first portion of the display generation component, and replacing display of the first customizable user interface with a second replacement user interface that is different from the first replacement user interface, in accordance with a determination that the first user input meets the dismissal criteria and that the first user input is directed to a second portion, different from the first portion, of the display generation component, provides additional control options for displaying an appropriate replacement user interface without cluttering the UI with additional displayed controls (e.g., additional displayed controls for displaying the first replacement user interface and/or the second replacement user interface).

In some embodiments, in response to detecting (10044) the first user input: in accordance with a determination that the first user input does not meet the dismissal criteria and that the first user input is directed to a third portion of the display generation component (e.g., directed to a first user interface element in the first customized user interface, or an unoccupied portion of the first customized user interface that is different from the first portion and second portion of unoccupied region of the first customizable user interface), the computer system performs a first operation without ceasing display of the first customizable user interface. For example, in some embodiments, tapping on a user interface element within the first customized user interface causes navigation within the first customized user interface, such as displaying additional information, related content, and/or navigating to a different version of the first customized user interface. For example, in some embodiments, tapping on a time element shown in a media display ambient mode causes the time element to fade out without exiting the media display ambient mode. In some embodiments, tapping on a calendar item shown in the calendar ambient mode cause more details of the calendar to be displayed without existing the calendar ambient mode. For example, in FIG. 5V, the computer system 100 performs a first operation (e.g., navigates to the home control user interface 5100 without leaving the ambient mode of the computer system 100. Performing an operation without ceasing display of the first customizable user interface, in accordance with a determination that the first user input does not meet the dismissal criteria and that the first user input is directed to a third portion of the display generation component, provides additional control options without cluttering the UI with additional displayed controls (e.g., additional displayed controls for displaying the first replacement user interface or the second replacement user interface, when the first user input meets the dismissal criteria).

In some embodiments, the dismissal criteria are met (10046) in accordance with a determination that the first user input changes the orientation of the computer system (e.g., such that the first criteria are no longer met (e.g., from the first orientation to a second orientation that is different from the first orientation)). For example, in FIGS. 5AH-5AI and FIGS. 5AJ-5AK, the user rotates the computer system 100 so that it is no longer in the landscape orientations (e.g., as shown in FIG. 5AI and FIG. 5AK), and in response, the computer system 100 ceases to display an ambient mode user interface (e.g., the clock user interface 5058 in FIG. 5AH, or the home control user interface 5086 in FIG. 5AJ). Ceasing to display the first customizable user interface, in response to detecting the first user input and in accordance with a determination that the first user input meets dismissal criteria, automatically ceases to display the first customizable user interface without requiring additional user inputs (e.g., additional user inputs to cease to display the first customizable user interface) (e.g., when the first customizable user interface is no longer contextually relevant and should not be displayed).

In some embodiments, in response to detecting (10048) the first user input, in accordance with the determination that the first user input meets the dismissal criteria: in accordance with a determination that the first customizable user interface was displayed including a first type of content (e.g., a first ambient mode, a first version of a first ambient mode, or another type of content), the computer system replaces display of the first customizable user interface with a first replacement user interface (e.g., a wake screen user interface displaying first content, a first application user interface for a first application, or other types of replacement user interface); and in accordance with a determination that the first customizable user interface was displayed including a second type of content (e.g., a second ambient mode, a second version of the first ambient mode, or another type of content), different from the first type of content, the computer system replaces display of the first customizable user interface with a second replacement user interface, different from the first replacement user interface (e.g., a wake screen user interface displaying second content different from the first content, a second application user interface for a second application, or other types of replacement user interface). For example, as described with reference to FIG. 5AK, in some embodiments, the replacement user interface of FIG. 5AK is different from the replacement user interface of FIG. 5AI (e.g., the computer system 100 displays a different replacement user interface depending on what user interface and/or category of user interface was displayed prior to exiting the ambient mode). Replacing display of the first customizable user interface with a first replacement user interface, in accordance with a determination that the first customizable user interface was displayed including a first type of content, and replacing display of the first customizable user interface with a second replacement user interface different from the first replacement user interface, in accordance with a determination that the first customizable user interface was displayed including a second type of content, automatically displays an appropriate replacement user interface without requiring additional user inputs (e.g., additional user input to display the second replacement user interface when the first customizable user interface was displaying including a first type of content, or additional user inputs to display the first replacement user interface when the first customizable user interface was displayed including a second type of content).

In some embodiments, in response to detecting (10050) the first user input, in accordance with the determination that the first user input meets the dismissal criteria, the computer system displays an animated transition from the first customizable user interface to a respective replacement user interface (e.g., the first replacement user interface, a second replacement user interface, or another replacement user interface) in accordance with the first user input (e.g., the first user input is a rotation of the device, and the device displays an animated transition between the currently displayed first customizable user interface to the replacement user interface during the rotation of the device (e.g., the animated transition is started after a threshold amount of rotation is detected, and/or at least a portion of the animated transition is displayed during the rotation)). In some embodiments, the first user input includes a movement that causes the computer system to deviate from the first orientation such that the first criteria are no longer met (e.g., the computer system is rotated by more than a threshold amount and/or the computer system is no longer within the angular range of the first orientation), and the animated transition to the respective replacement user interface is triggered, and proceeds with a fixed progression speed until the respective replacement user interface is fully displayed. For example, as described with reference to FIGS. 5AI (and 5AK), in some embodiments, the computer system 100 displays an animated transition from displaying the clock user interface 5058 in FIG. 5AH (or from displaying the home control user interface 5086 in FIG. 5AK) to displaying the replacement user interface of FIG. 5AI (or FIG. 5AK), in response to a rotation of the device 100. Displaying an animated transition from the first customizable user interface to a respective replacement user interface, in response to detecting the first user input, in accordance with the determination that the first user input meets the dismissal criteria, and in accordance with the first user input, provides improved visual feedback to the user (e.g., improved visual feedback regarding the first user input and whether or not the first user input has met the dismissal criteria).

In some embodiments, displaying (10052) the animated transition in accordance with the first user input includes controlling a progress of the animated transition in accordance with a progress of the first user input (e.g., in accordance with the amount or rate of rotation of the electronic device caused by the first user input). For example, as described with reference to FIG. 5AH and FIG. 5AI, in some embodiments, the computer system 100 displays an animated transition that progresses in accordance with an amount of rotation of the computer system 100 (e.g., reflects the amount of rotation of the computer system 100). Displaying an animated transition in accordance with progress of the first user input provides improved visual feedback to the user (e.g., improved visual feedback regarding the first user input and/or the orientation of the computer system, and improved visual feedback regarding progress towards replacing display of the first customizable user interface with a replacement user interface).

In some embodiments, while displaying the first customizable user interface, the computer system detects (10054), via one or more sensors of the computer system, a second user input; and in response to detecting the second user input, in accordance with a determination that the second user input meets content switching criteria (e.g., the second user input is a vertical swipe input, a horizontal swipe input, or another type of content switching input), the computer system switches content displayed in the first customizable user interface from a first type of content to a second type of content, different from the first type of content (e.g., switching from a first ambient mode to a second ambient mode, or switching from a first version of a first ambient mode to a second version of the first ambient mode). For example, in some embodiments, horizontal swipes cause the first customizable user interface to switch between different ambient modes, such as the media display ambient mode, the calendar ambient mode, the clock ambient mode, and other ambient modes. For example, in some embodiments, vertical swipes cause the first customizable user interface to switch between different looks or versions of the same ambient mode, such as different albums in the media display ambient mode, different home controls of the home control ambient mode, or different clock faces for the clock ambient mode. For example, in FIG. 5R, the computer system 100 detects the user input 5074 (or the user input 5076) while displaying the clock user interface 5072 (e.g., a first type of content that includes clocks and/or clock faces), and in response, the computer system 100 switches to displaying the widget user interface 5078 (e.g., a second type of content that includes widgets, and is different from the clock and/or clock face content). Switching content displayed in the first customizable user interface from a first type of content to a second type of content different from the first type of content, in response to detecting a second user input that meets content switching criteria, provides additional control options without cluttering the UI with additional displayed controls (e.g., additional displayed controls for switching between the first type of content and the second type of content).

In some embodiments, while displaying the first customizable user interface, the computer system detects (10056) occurrence of a second event (e.g., an event that corresponds to at least one of a change in an orientation of the display generation component detected via one or more sensors of the computer system and/or a change in a charging state of the computer system, or other event(s) relevant for whether to deactivate a respective operating mode of the device); in response to detecting the second event: in accordance with a determination that the first criteria are no longer met, the computer system ceases to display the first customizable user interface and redisplaying a previous user interface that was displayed when the first event was detected, irrespective of which content of multiple different contents of the first customizable user interface (e.g., a first ambient mode, a second ambient, another ambient mode, or different versions of a respective ambient mode) was displayed when the second event was detected. For example, in FIGS. 5AH-5AI, the computer system 100 displays the same replacement user interface (e.g., the wake user interface in FIG. 5AI and FIG. 5AK), regardless of what content was displayed prior to detecting the second event (e.g., rotating the computer system 100 and/or disconnecting the computer system 100 from the charging source 5056). In FIG. 5AH, the computer system 100 is displaying the clock user interface 5058, while in FIG. 5AJ, the computer system 100 is displayed the home control user interface 5086. In both cases (e.g., in both FIG. 5AI and FIG. 5K), exiting the ambient mode results in displaying the same replacement user interface (e.g., the replacement user interfaces in FIG. 5AI and FIG. 5AK are identical) (e.g., which is a previously displayed user interface displayed when the computer system 100 entered the ambient mode). Ceasing to display the first customizable user interface and redisplaying a previous user interface that was displayed when the first event was detected, in accordance with a determination that the first criteria are no longer met, automatically displays an appropriate user interface without requiring additional user inputs (e.g., additional user inputs to display, redisplay, and/or navigate to the previous user interface that was displayed when the first event was detected).

In some embodiments, in accordance with a determination that the computer system is charging, the computer system displays (10058) a battery indicator to indicate that the computer system is charging. In some embodiments, after an identifier of the charging source is obtained from the one or more power transfer signals received from the charging source currently coupled to the computer system, the battery indicator includes an indication of the identifier of the charging source. For example, in some embodiments, a unique identifier of the charging source is mapped to a nickname or charger name specified by the manufacturer or user (e.g., “bedroom charger”, “kitchen charger”, “Nick's charger”, “Charger No. 1”, and other default or user-specified names) and displayed with the battery indicator. In some embodiments, the battery indicator includes the additional information related to the charging source in accordance with a determination that the identifier of the charging source that have been obtained from the charging source is unique to the charging source (e.g., based on the indicator in the payload of the transmitter identification packet of the charging source); and forgoes displaying the additional information of the charging source if the identifier is not unique to the charging source and/or personalization would not be performed based on the identifier of the charging source. For example, in FIG. 51, the computer system 100 displays an indicator 5042 when the computer system 100 is connected to the physical charger 5044. Similarly, in FIG. 5K, the computer system 100 displays the indicator 5050 when the computer system 100 is connected to the wireless charger 5048; in FIG. 5L, the computer system 100 displays the indicator 5054 when the computer system 100 is received power from the long-range wireless charger 5052; and in FIG. 5M, the computer system 100 displays the indicator 5060 while the computer system 100 is connected to the charging source 5056. Displaying a battery indicator to indicate that the computer system is charging, in accordance with a determination that the computer system is charging, provides improved visual feedback to the user (e.g., improved visual feedback that the computer system is charging, and/or that there are no issues with the connection between the computer system and the charging source (or the charging source itself)).

In some embodiments, displaying the battery indicator to indicate that the computer system is charging includes (10060): in accordance with a determination that the first criteria are met and that the first customizable user interface is displayed, displaying the battery indicator with a first appearance (e.g., a smaller battery indicator that pops up in the status region of the display, and which subsequently shrinks and stays in the status region of the display); and in accordance with a determination that the first criteria are not met and that the first customizable user interface is not displayed, displaying the battery indicator with a second appearance (e.g., a larger battery indicator, displayed in the central region of the display, which subsequently shrinks and moves to the upper right corner of the display) that is different from the first appearance. In some embodiments, after an identifier of the charging source is obtained from the one or more power transfer signals received from the charging source currently coupled to the computer system, the battery indicator includes an indication of the identifier of the charging source. For example, in some embodiments, a unique identifier of the charging source is mapped to a nickname or charger name specified by the manufacturer or user (e.g., “bedroom charger”, “kitchen charger”, “Nick's charger”, “Charger No. 1”, and other default or user-specified names) and displayed with the battery indicator. In some embodiments, the identifier or name of the charging source is displayed when the first customizable user interface is displayed, and the identifier or name of the charging source is not displayed when the first criteria are not met and the first customizable user interface is not displayed. In some embodiments, the identifier or name of the charging source is displayed if the first customizable user interface has been customized to be different from the default user interface based on the identifier of the charging source, and the identifier or name of the charging source is not displayed if the first customizable user interface has not been customized based on the identity of the charging source (e.g., as uniquely identified by the identifier of the charging source). In some embodiments, the battery indicator includes the additional information related to the charging source in accordance with a determination that the identifier of the charging source that have been obtained from the charging source is unique to the charging source (e.g., based on the indicator in the payload of the transmitter identification packet of the charging source); and forgoes displaying the additional information of the charging source if the identifier is not unique to the charging source and/or personalization would not be performed based on the identifier of the charging source. For example, in some embodiments, when the device is first connected to a charging source such that the charging condition of the first criteria are met, but other conditions of the first criteria are not met, the computer system displays the battery indicator in a status region of the display to indicate that the battery level and that it is charging without switching to display of the first customizable user interface; and when then the device is first connected to the charging source such that the first criteria are met, the computer system switches to displaying the first customizable user interface and displays a more prominence battery indicator in the upper right corner of the first customizable user interface. For example, the indicator 5042 in FIG. 5I (e.g., and/or the indicator 5050 in FIG. 5K, and/or the indicator 5054 in FIG. 5L) have a first appearance (e.g., because the first criteria are not met, as the computer system 100 is in a portrait orientation) and the first customizable user interface is not displayed (e.g., the wake user interface in FIGS. 5I-5L is different from the clock user interface in FIG. 5M). In contrast, in FIG. 5M, the indicator 5060 has a different appearance (e.g., because the computer system 100 is in the landscape orientation and connected to the charging source 5056, and because the computer system 100 is displayed the clock user interface 5058). Displaying the battery indicator with a first appearance, in accordance with a determination that the first criteria are met and that the first customizable user interface is displayed, and displaying the battery indicator with a second appearance that is different from the first appearance, in accordance with a determination that the first criteria are not met and that the first customizable user interface is not displayed, provides improved visual feedback to the user (e.g., improved visual feedback regarding whether or not the first criteria are met, in what mode the computer system 100 is currently operating, and/or whether the computer system is connected to the charging source and charging).

In some embodiments, while displaying the battery indicator to indicate that the computer system is charging (e.g., while the first customizable user interface is displayed, and while the battery indicator is displayed with a reduced visual prominence), the computer system detects (10062) (e.g., via the one or more sensors and/or input devices of the computer system) a third user input that is directed to a location corresponding to the battery indicator; and in response to detecting the third user input, the computer system expands the battery indicator to display additional charging information that was not displayed in the battery indicator at a time when the third user input was detected. In some embodiments, the additional charging information includes, e.g., a current battery level and/or percentage, battery health information, and/or whether a power-saving or low-power mode is active for the computer system, that is not displayed at a time when the third user input was detected, and that is displayed in response to detecting the third user input. In some embodiments, the additional charging information includes an identifier or name associated with the charging source that is determined based on the identifying information encoded in one or more power transfer signals received from the charging source that is currently used to charge the battery of the computer system. In some embodiments, the battery indicator includes the additional information related to the charging source in accordance with a determination that the identifier of the charging source that have been obtained from the charging source is unique to the charging source (e.g., based on the indicator in the payload of the transmitter identification packet of the charging source); and forgoes displaying the additional information of the charging source if the identifier is not unique to the charging source and/or personalization would not be performed based on the identifier of the charging source. For example, in FIG. 5N, the computer system 100 detects the user input 6064 directed to the indicator 6062 (e.g., which corresponds to the indicator 5060 in FIG. 5M, but displayed with reduced visual prominence), and in response, the computer system 100 displays (e.g., redisplays) the indicator 5060 (e.g., that was not displayed in FIG. 5N). Expanding the battery indicator to display additional charging information that was not displayed in the battery indicator prior to detecting the third user input, in response to detecting the third user input at a location corresponding to the battery indicator, provides improved visual feedback to the user (e.g., improved visual feedback regarding a current battery level, battery health information, and/or whether a power-saving or low-power mode) without cluttering the UI (e.g., without needing to permanently display the additional charging information).

In some embodiments, in response to detecting (10064) the first event: in accordance with a determination that the first criteria are met as a result of the first event and that the computer system was displaying a respective user interface object of a first type (e.g., a session user interface object, a subscribed event status update, or other user interface objects that includes updated information from an application in real-time or substantially real-time) at a time of detecting the first event, wherein the respective user interface object of the first type corresponds to a respective application and displays status information that is updated over time without requiring display of the respective application, the computer system displays the respective user interface object of the first type with an updated appearance (e.g., partially or completely overlaying the first customizable user interface). In some embodiments, while displaying the respective user interface object with the update appearance (e.g., in the changed orientation, and with an expanded size and change dimensions, and optionally, with additional information from the respective application), the computer system detects an input that meets dismissal criteria; in response to detecting the input that meets the dismissal criteria, the computer system ceases to display the respective user interface object or reduces visual prominence of the respective user interface object, to reveal more of the first customizable user interface underlying the respective user interface object of the first type (e.g., the ambient mode is turned on when the first criteria are met, but the first customizable user interface is not initially fully displayed if there is an ongoing session that was displayed at a time when the first event occurred). For example, in FIG. 5AA, the computer system 100 displays the user interface 5118 in the landscape orientation (e.g., which corresponds to the user interface 5116 that was displayed while the computer system 100 was in the portrait orientation). Display the respective user interface object of the first type with an updated appearance, in accordance with a determination that the first criteria are met as a result of the first event and that the computer system was displaying a respective user interface object of a first type at a time of detecting the first event, provides improved visual feedback to the user (e.g., improved visual feedback regarding which mode the computer system 100 is currently operating in).

In some embodiments, the respective user interface object with the updated appearance is (10066) a full-screen user interface object (e.g., the respective user interface object occupies an entirety or substantially the entirety of display of the display generation component, and obscures the first customizable user interface completely). In some embodiments, the respective user interface object occupies less than the entire display of the display generation component, overlays a portion of the first customizable user interface that is displayed in response to the first event that meets the first criteria. For example, in FIG. 5AA, the computer system 100 displays the user interface 5118 as a full-screen user interface object in the landscape orientation (e.g., which corresponds to the user interface 5116 that was displayed while the computer system 100 was in the portrait orientation). Display the respective user interface object of the first type as a full-screen user interface object, in accordance with a determination that the first criteria are met as a result of the first event and that the computer system was displaying a respective user interface object of a first type at a time of detecting the first event, provides improved visual feedback to the user (e.g., improved visual feedback regarding which mode the computer system 100 is currently operating in).

In some embodiments, prior to detecting the first event, the computer system detects (10068) a third event (e.g., an event that corresponds to at least one of a change in an orientation of the display generation component and/or a change in a charging state of the computer system, or other event(s) relevant for whether to activate a respective operating mode of the device); and in response to detecting the third event: in accordance with a determination that the first criteria are met as a result of the third event and that the first customizable user interface was not previously displayed at the computer system (e.g., the computer system receives and/or installs a system update that includes functionality for displaying the first customizable user interface, and has not previously displayed the first customizable user interface), the computer system displays a description of the first customizable user interface (e.g., a pop-up window or a banner, that includes instructions for satisfying the first criteria and displaying the first customizable user interface) (e.g., before displaying the first customizable user interface, or without displaying the first user interface). In some embodiments, if a charging source is coupled to the computer system and the computer system determines that charging source has not previously been used to charge the computer system (e.g., after obtaining the identifier for the charging source from one or more power transfer signals received from the charging source and compared it with the stored identifiers of previously encountered charging sources at the computer system), the computer system displays a description of the charging source (e.g., indicating to the user that this is a new charging source to the computer system and optionally displays an identifier, a default name, and/or a user interface object that prompts the user to provide a customized name to be associated with the charging source). In some embodiments, the computer system displays the information related to the charging source in accordance with a determination that the identifier of the charging source that have been obtained from the charging source is unique to the charging source (e.g., based on the indicator in the payload of the transmitter identification packet of the charging source); and forgoes displaying the information of the charging source if the identifier is not unique to the charging source and/or personalization would not be performed based on the identifier of the charging source. For example, as described with reference to FIG. 5M, the computer system 100 displays an additional description of the ambient mode (e.g., as a pop-up window or a banner, or prior to displaying an ambient mode user interface). Displaying a description of the first customizable user interface in accordance with a determination that the first criteria are met as a result of the third event and that the first customizable user interface was not previously displayed at the computer system, provides improved visual feedback to the user (e.g., improved visual feedback that the computer system is entering the ambient mode, along with details for how to either consistently enter the ambient mode, or avoid accidentally triggering the ambient mode when not needed) without cluttering the UI (e.g., without permanently displaying the additional description).

In some embodiments, the computer system displays (10070) a first settings user interface for configuring the first customizable user interface (e.g., in response to detecting a request to edit the first customizable user interface while displaying the first customizable user interface, or in response to selection of an option for editing the first customizable user interface in a device settings app); while displaying the first settings user interface for configurating the first customizable user interface, the computer system detects (e.g., via one or more sensors and/or input devices of the computer system) one or more user inputs that correspond to requests to change one or more configurable aspects of the first customizable user interface (e.g., options for configuring the first criteria, the content of the first customizable user interface, the contextual conditions for choosing which ambient mode to display in the first customizable user interface, and/or conditions for updating and changing the ambient modes that are displayed in the first customizable user interface); and in response to detecting the one or more user inputs that correspond to requests to change one or more configurable aspects of the first customizable user interface, the computer system updates the one or more configurable aspects of the first customizable user interface in accordance with the one or more user inputs (e.g., changing how display of the first customizable user interface is triggered next time, change which ambient mode is displayed when the first criteria are met, change the content and/or appearance of one or more ambient modes that are to be displayed in the first customizable user interface, changing how the ambient mode are chosen and rotated based on contextual conditions). For example, as described with reference to FIG. 5AL and FIG. 6B, the user can configure settings (e.g., which ambient mode user interface is displayed when the computer system 100 enters the ambient mode; which context-based triggers cause the computer system 100 to enter the ambient mode; and/or which ambient mode user interfaces are available for display while the computer system 100 is operating in the ambient mode, and in which order the available ambient mode user interface is displayed and/or can be navigated through) of the ambient mode via a settings user interface. Updating the one or more configurable aspects of the first customizable user interface in response to detecting one or more user inputs that corresponds to requests to change one or more configurable aspects of the first customizable user interface, and in accordance with the one or more user inputs, enables the computer system 100 to display appropriate user interfaces at the appropriate times, without additional user inputs (e.g., the user can configure when the computer system is in the ambient mode, and what is displayed when the computer system is in the ambient mode, such that the computer system automatically displays the appropriate user interface when certain conditions are met, which ensures the user does not need to perform additional user inputs to enter the ambient mode and/or display an appropriate ambient mode user interface).

In some embodiments, the first user interface for configuring the first customizable user interface includes (10072) a first option for enabling or disabling display of the first customizable user interface (e.g., in accordance with a determination that the first criteria are met or not met). In some embodiments, in accordance with a determination that display of the first customizable user interface is disabled, the computer system forgoes displaying the first customizable user interface even if the first criteria are met as a result of a detected event and there are no other exceptions (e.g., first customizable user interface has never been displayed at this device before, a session user interface object is being displayed, or other exceptions) being present at the time that the first criteria are met. For example, in FIG. 5AL, the settings user interface 5136 includes the option 5140 for configuring whether a specific ambient mode user interface, and/or whether any ambient mode user interface, is displayed while the computer system 100 is operating in the ambient mode (e.g., the option 5140 includes a toggle that can be toggled via the user input 5152, which enables or disables display of an ambient mode user interface while the computer system 100 is operating in the ambient mode). Including an option for enabling or disabling display of the first customizable user interface allows the computer system to automatically display an appropriate user interface (e.g., an ambient mode user interface, or a non-ambient mode user interface), without requiring additional user inputs (e.g., additional user inputs for ceasing to display an ambient mode user interface when unneeded).

In some embodiments, the first user interface for configuring the first customizable user interface includes (10074) a second option for enabling or disabling a dimmed always-on mode for the first customizable user interface, wherein, in accordance with a determination that the dimmed always-on mode is enabled for the first customizable user interface, at least some user interface elements of the first customizable user interface remain displayed with reduced visual prominence while the computer system is in a reduced power mode. In some embodiments, in accordance with a determination that the dimmed always-on mode is disabled for the first customizable user interface, the first customizable user interface ceases to be displayed while the computer system is in a reduced power mode (e.g., because the display is turned off in the reduced power mode). For example, in FIG. 5AL, the settings user interface 5136 includes the “Always On” option 5142 for enabling or disabling (e.g., via the user input 5154 on a toggle of the “Always On” option 5142) an “always-on” state for an ambient mode user interface. Including an option for enabling or disabling a dimmed always-on mode for the first customizable user interface allows the computer system to automatically display relevant information without requiring additional user inputs (e.g., the always-on elements are always displayed, so the user does not need to perform additional user inputs in order to display those always-on elements).

In some embodiments, the first user interface for configuring the first customizable user interface includes (10076) a third option for enabling or disabling a night mode for the first customizable user interface, wherein, in accordance with a determination that the night mode is enabled for the first customizable user interface, at least some user interface elements of the first customizable user interface are displayed with a different appearance (e.g., reduced, simplified with fewer objects and less information, dimmed, tuned down, with reduced overall brightness, with a darker wallpaper, with a different wallpaper of a different color temperature or image, and/or with less saturated colors) while the computer system is in the night mode (e.g., based on time of day being night time, when the computer system is in a sleep mode, or a DND mode, or other quiet modes), as compared to a default appearance of the first customizable user interface. In some embodiments, in accordance with a determination that the night mode is disabled for the first customizable user interface, the computer system maintains the appearance of the first customizable user interface, irrespective of whether the current time is nighttime, and/or whether the sleep mode is turned on at the computer system. For example, in FIG. 5AL, the settings user interface 5136 includes the “Night Mode” option 5144 for enabling or disabling a “night mode” (e.g., a mode in which some user interface elements are displayed with a different (e.g., reduced, simplified, dimmed, tuned down, and/or less saturated) appearance (e.g., as compared to a normal or default appearance for the user interface element(s))) for an ambient mode user interface. When the “Night Mode” option 5144 is selected by the user input 5156, the computer system 100 displays the settings user interface 5162 in FIG. 5AM, which includes additional options for configuring the night mode of the computer system 100 (e.g., the option 5164 enables or disables the night node, and the option 5166 enables or disables waking the computer system 100 when motion is detected, while the night mode is active). Including an option for enabling or disabling a night mode for the first customizable user interface allows the computer system to automatically display the first customizable user interface with an appropriate appearance, without requiring additional user inputs (e.g., the user does not need to perform additional user inputs in order to change the appearance of the first customizable user interface (e.g., to or from a night mode appearance)).

In some embodiments, the first user interface for configuring the first customizable user interface includes (10078) a fourth option for enabling or disabling display of notification alerts while the first customizable user interface is displayed, wherein, in accordance with a determination that display of notification alerts are enabled, respective notification indicators for one or more newly received notifications are displayed while the first customizable user interface is displayed. In some embodiments, in accordance with a determination that display of notification alerts are disabled, respective notification indicators for one or more newly received notifications are not displayed while the first customizable user interface is displayed. For example, in FIG. 5AL, the settings user interface 5136 includes the “Indicator” option 5148 for enabling or disabling display of notifications (e.g., notification alerts) while the computer system 100 is operating in the ambient mode. Including an option for enabling or disabling display of notification alerts while the first customizable user interface is displayed, allows the computer system to automatically display and/or suppress notifications and/or notification alerts without requiring further user input (e.g., the user does not need to perform additional user inputs to dismiss notifications and/or notification alerts while the first customizable user interface is displayed).

In some embodiments, the first user interface for configuring the first customizable user interface includes (10080) a fifth option for enabling or disabling waking the computer system (e.g., from a sleep or low power state) in response to detecting vibration of the computer system (e.g., through external impact on a supporting surface of the computer system, or a direct impact on the computer system). In some embodiments, the computer system detects a vibration of the computer system (e.g., via one or more sensors of the computer system) while the computer system is in a low power mode; and in response to detecting the vibration of the computer system: in accordance with a determination that the option for waking the computer system in response to detecting vibration of the computer system is enabled, the computer system transitions the computer system from the low power mode to the normal mode (e.g., optionally displaying a wake screen user interface, a lock screen user interface, or a respective ambient mode if criteria for entering the ambient mode are met), and in accordance with a determination that the option is not enabled, the computer system remains in the low power mode. For example, in FIG. 5AL, the settings user interface 5136 includes the “Bump to Wake” option 5146 for enabling or disabling waking of the computer system 100 (e.g., from a sleep or other low power state) in response to detecting vibration of the computer system 100 (e.g., vibrations that exceed a threshold amount of vibration) (e.g., vibrations corresponding to an external impact on a supporting surface of the computer system 100, or direct impact with the computer system 100 itself), which can be enabled or disabled via the user input 5160 (e.g., directed to a toggle of the “Bump to Wake” option 5146. Including an option for enabling or disabling waking the computer system in response to detecting vibration of the computer system, allows the computer system to only wake when needed (e.g., without requiring further user input to either reset the computer system to the sleep or low power state when waking is not desired, or to wake the device when waking is desired).

In some embodiments, the computer system receives (10082) one or more power transfer signals from the charging source (e.g., receiving a wireless power transfer signal from a wireless charging source or receiving a wired power transfer signal from a wired charging source, optionally, when the charging source is first coupled to the computer system). In some embodiments, when the computer system is coupled to the charging source in a manner that enables charging of the battery of the computer system, the charging source transmits power transfer signals to the charging system of the computer system, where some portions of the power transfer signals are used as carrier for one or more data packets (e.g., handshake signals, standard Qi packets, extended ID packet, requests and acknowledgements for requests, indicators, flags, and/or other types of data) encoded on those portions of the power transfer signals, before, after, and/or while the battery of the computer system is charged by the same and/or other portions of the power transfer signals. The computer system obtains a respective identifier of the charging source from at least one of the one or more power transfer signals that were received from the charging source (e.g., decoding a payload carried by the power transfer signal in accordance with a first protocol or a first power transfer standard). In some embodiments, the payload of the data packet carried by the one or more power transfer signals also includes an indicator that specifics whether the payload carries an identifier for the charging source, and/or whether the identifier is unique to the charging source. The computer system determines whether the respective identifier of the charging source that is obtained from the one or more power transfer signals corresponds to a first identifier of the first charging source or a second identifier of the second charging source, before displaying the first customizable user interface. In some embodiments, a sequence of bits (e.g., 31 bits, 39 bits, 47 bits, 55 bits, or other digital data sequence of finite length) is encoded in at least one of the one or more power transfer signals, and the sequence of bits corresponds to a unique identifier (e.g., a UUID, or other types of unique identifiers for the charging source) of the charging source. The computer system compares the obtained identifier with one or more stored identifiers for previously encountered charging sources to determine whether a match could be found. If a match is found, the computer system stores subsequent customization of the first customizable user interface in association with the matched identifier until the charging source is disconnected from the computer system; and if a match is not found, the computer system records the newly discovered identifier and stores subsequent customization of the first customizable user interface in association with the identifier of the charging source, until the charging source is disconnected from the computer system. In some embodiments, the computer system records the newly discovered identifier and stores the subsequent customization of the first customizable user interface in association with the identifier of the charging source, in accordance with a determination that the identifying data encoded in the power transfer signals received from the charging source also indicates that the identifier is an identifier unique to the charging source (e.g., not generic to a plurality of charging sources that can be used to charge the computer system). For example, in FIG. 5AP, the PRx 5184 (e.g., the computer system, and/or a charging system of the computer system) receives the “EXT ID” packet 5208 and the “UI Param” packet 5212 from the PRX 5174 (e.g., the charging source), and the “UI Param” packet 5212 may contain information relating to personalization and/or customization (e.g., personalization and/or customization of user preferences, user interfaces to be displayed, or other information relating to customization and/or personalization of the PRx 5184 and/or PTx 5174 and/or user interfaces displayed by the PRx 5184 and/or PTx 5174). In FIG. 5AR, the PTx transfers the unique ID to the PRx in step S0010, before the customized user interface is displayed in step S0014. Obtaining a respective identifier of the charging source from at least one of the one or more power transfer signals that were received from the charging source, and determining whether the respective identifier of the charging source that is obtained from the one or more power transfer signals corresponds to a first identifier of the first charging source or a second identifier of the second charging source, before displays the first customizable user interface, enables the first customizable user interface to be displayed in accordance with the respective identifier of the charging source. Further, obtaining the respective identifier from at least one of the one or more power transfer signals allows the respective identifier to be obtained without the need for separate (e.g., external and/or dedicated) communications circuitry, which reduces the power requirements of the computer system and also minimizes the amount of radiation (e.g., from wireless power and/or other (e.g., communication) signals) emitted by or received by the computer system while in usc.

In some embodiments, determining whether the respective identifier of the charging source that is obtained from the one or more power transfer signals corresponds to the first identifier of the first charging source or the second identifier of the second charging source includes (10083) determining whether the one or more power transfer signals include an indication (e.g., an indicator in FIG. 5AQ, such as a single leading bit in the payload that includes the respective identifier, or another portion of the payload that includes the respective identifier) of whether the respective identifier of the charging source obtained from the one or more power transfer signals is a unique identifier for the charging source, wherein the first customizable user interface is displayed in accordance with a determination that the indication specifies that the respective identifier is a unique identifier for the charging source and that the respective identifier corresponds to the first identifier of the first charging source. In some embodiments, the payload of the transmitter identification packet carried by the one or more power transfer signals includes an indicator that specifies that the respective identifier carried in the payload is not unique to the charging source, and according to this indication, the computer system does not perform personalization and/or customization steps for the charging source, and displays a generic or default version of the respective customizable user interface and does not record the personalization and/or customization made by the user while this charging source is coupled to the computer system. In some embodiments, the computer system performs automatic personalization and/or customization steps (e.g., storing unique identifiers, comparing unique identifiers, storing personalized parameters in association with unique identifiers) that ensure the display of the next user interface is personalized and/or customized based on previous recorded states of the user interface in accordance with a determination that personalization criteria are met, where the personalization criteria includes a requirement that the transmitter identity packet received from the charging source (e.g., either through in-band power transfer signals, or out-of-band communication packets) includes an indicator that the identifier carried in the transmitter identity packet is unique to the charging source in order for the personalization criteria to be met. For example, as described with reference to FIG. 5AQ, the data packet includes the payload portion includes an indicator (bit b₇ of byte B₅), which indicates whether the payload portion includes a unique ID (e.g., an identifier unique to the PTx 5174, as described above with reference to FIGS. 5AO-5AP). As described with respect to step S0014 in FIG. 5AR, in some embodiments, if the PRx does not receive the unique ID from the PTx (e.g., the PTx does not have an ID, the PTx has only a non-unique ID, and/or is not configured to transmit a unique ID to the PRx), the PRx forgoes displaying the first customizable user interface. Determining whether the one or more power transfer signals include an indication of whether the respective identifier of the charging source obtained from the one or more power transfer signals is a unique identifier for the charging source, and displaying the first customizable user interface in accordance with a determination that the indication specifies that the respective identifier is a unique identifier for the charging source and that that the respective identifier corresponds to the first identifier of the first charging source, minimizes the power consumption for processing and/or decoding operations (e.g., the computer system need not continue processing and/or decoding the received signals, to obtain a unique identifier for the charging source, if the indication does not specify that the respective identifier is a unique identifier for the charging source).

In some embodiments, obtaining the respective identifier of the charging source from the one or more power transfer signals that were received from the charging source includes (10084) decoding the respective identifier of the charging source from the one or more power transfer signals received from the charging source, wherein the one or more power transfer signals are used to charge a battery of the computer system (e.g., to input to the rectifier that provides power to the battery of the computer system, and/or to increase the charge level of the battery). For example, in FIG. 5AO, the power transfer step S214 allows for in-band transmission of the “EXT ID” packet and/or the “UI Param” packet 5212 (e.g., in FIG. 5AP). This is also described with reference to FIGS. 5AO and 5AP, where in some embodiments, power transfer occurs/begins before (and/or is ongoing while) the PTx 5174 transmits the unique ID and/or personalization information to the PRx 5184; and/or a wireless power signal is available for enabling in-band transmission of the “EXT ID” packet 5208 and/or the “UI Param” packet 5212 from the PTx 5174 to the PRx 5184. Decoding the respective identifier of the charging source from the one or more power transfer signals received from the charging source, while the one or more power transfer signals are used to charge a battery of the computer system, allows the respective identifier to be obtained without the need for separate (e.g., external and/or dedicated) communications circuitry, which reduces the power requirements of the computer system and also minimizes the amount of radiation (e.g., from wireless power and/or other (e.g., communication) signals) emitted by or received by the computer system while in use.

In some embodiments, the computer system decodes (10086) the respective identifier of the charging source from one or more signals received from the charging source, wherein the one or more signals are not used to charge a battery of the computer system (e.g., are not input to the rectifier that provides power to the battery of the computer system, and are not used to increase the charge level of the battery). In some embodiments, various features described with respect to the data encoding, decoding, transmission, and usage of information carried by the one or more power transfer signals are also applicable to the out-of-band communication signals (e.g., Bluetooth signals, NFC signals, or signals of other types of communication protocols) that are not used to charge the battery of the computer system but carry the identifying data for the charging source. For example, the structure of the transmitter identification packet, the interaction sequence between the charging source and the computer system, and the usage of the information in the data packets, as described with respect to the power transfer signals that carry identifying data of the charging source are analogously applicable to the out-of-band signals that carry identifying data of the charging source, and are not repeated herein in the interest of brevity. For example, in FIG. 5AP, the power transfer step 5218 occurs after transmission of the “EXT ID” packet 5208 and the “UI Param” packet 5212, and so the power transfer signals (e.g., of and/or associated with the power transfer step 5218) are not available for use for in-band communication (e.g., the transmission of the “EXT ID” packet 5208 and the “UI Param” packet 5212 must uses a different signal (e.g., Bluetooth or NFC signals) than the signals sent via the wireless power transfer coil during the power transfer step 5218). Decoding the respective identifier of the charging source from one or more signals received from the charging source, wherein the one or more signals are not used to charge a battery of the computer system, allows the respective identifier to be obtained without requiring additional bandwidth in the one or more power transfer signals (e.g., additional bandwidth to include the respective identifier).

In some embodiments, while the computer system is coupled to the charging source (e.g., via a wired connection, or a wireless connection; and optionally, after a handshake between the charging source and the computer system has occurred), the computer system encodes (10088) a request for the respective identifier of the charging source (e.g., by modulating a power transfer signal received from the charging source, or through other types of out-of-band communication between the computer system and the charging source) in a first power transfer signal transmitted between the charging source and the computer system, wherein the charging source encodes the respective identifier in the one or more power transfer signals in response to detecting the request encoded in the first power transfer signal. In some embodiments, the charging source does not require a request from the computer system before sending the respective identifier of the charging source to the computer system in the one or more power transfer signals. In some embodiments, the power transfer signals transmitted from the charging source and the computer system includes AC signals sent via wireless power coils (e.g., converting magnetic flux to and from voltage, and/or current seen by downstream electronics), and when the computer system decides to send a request and/or other types of communication data packets to the charging source, the computer system, optionally, perturbs the ongoing AC signals in a manner that encodes the request and/or other types of communication data packets, where the charging source detects such perturbance and decodes the request and/or communication data packets and responds accordingly. The computer system ceases to perturb the ongoing AC signals when the transmission of the request and/or other types of data packets are completed (e.g., while the AC signals persist between the computer system and the charging source, to charge the battery and provide a carrier for additional communication packets to be transmitted). In some embodiments, the computer system encodes the request for the respective identifier of the charging source using amplitude shift keying on the first power transfer signal received from the charging source. In some embodiments, the charging source encodes the respective identifier of the charging source using frequency shift keying on the one or more power transfer signals before sending the one or more power transfer signals to the computer system. For example, in FIG. 5AP, the PRx 5184 (e.g., the computer system and/or its charging components) sends a “GET” request 5206 to the PTx 5174 (e.g., the charging source), which then causes the PTx 5174 to send the “EXT ID” packet 5208 to the PRx 5184. Encoding a request for the respective identifier of the charging source in a first power transfer signal, wherein the charging source encodes the respective identifier of the charging source in the one or more power signals in response to detecting the request encoded in the first power transfer signal, minimizes the amount of energy transferred between the computer system and the charging source (e.g., the charging source only sends power transfer signals (e.g., that include the respective identifier) to the computer system when requested, and can otherwise send lower energy/bandwidth power transfer signals when the respective identifier has not been requested by the computer system).

In some embodiments, at least one of the one or more power transfer signals received from the charging source encodes (10090) a header and a payload (e.g., using frequency shift keying, or another encoding method), and the header indicates (e.g., by indicating the type of data packet as a transmitter identification packet for the charging source) that the payload includes the respective identifier (e.g., a unique identifier and/or an identifier that can be used for personalization and/or customization of user interfaces by the computer system) of the charging source. In some embodiments, the computer system determines whether the respective identifier of the charging source that is obtained from the one or more power transfer signals corresponds to a first identifier of the first charging source or a second identifier of the second charging source, before displaying the first customizable user interface, by comparing the respective identifier encoded in the payload with one or more stored identifiers of previously encountered charging sources that have corresponding sets of configuration parameters for one or more customizable user interfaces. In some embodiments, the header indicates whether the payload includes identifying data for the changing source (e.g., the header indicates whether the power transfer signal carrying the header and payload carries a transmitter identification packet (e.g., a wireless power transfer transmitter identification packet, or another type of transmitter identification packet)). For example, as described with reference to FIG. 5AQ, in some embodiments, the data packet includes a reserved portion that may include a header (e.g., that identifies the type of packet and/or protocol information for the data packet, and/or whether the data packet is a transmitter identification packet), and a payload portion (e.g., bytes B₅-B₈) that includes the unique ID. Encoding a header and a payload, wherein the header indicates that the payload includes the respective identifier of the charging source, increases the efficiency of communication between the computer system and the charging source (e.g., by indicating, in the header, whether the power transfer signal carrying the header and payload carries a transmitter identification packet).

In some embodiments, obtaining the respective identifier of the charging source from the one or more power transfer signals that were received from the charging source includes (10092) obtaining the respective identifier of the charging source from a second portion of the payload that follows a first portion of the payload. In some embodiments, the first portion of the payload is a single bit in length and the second portion of the payload is 31 bits in length, or another finite number of bits (e.g., 39 bits, 47 bits, and so on) that combined with the length of the first portion of the payload makes an integer number of bytes. In some embodiments, the first portion of the payload and the second portion of the payload are respectively 2 bits and 30 bits, 3 bits and 29 bits, four bits and 28 bits, 5 bits and 27 bits, 6 bits and 26 bits, 7 bits and 27 bits, 8 bits and 24 bits, 1 bit and 39 bits, 2 bits and 38 bits, . . . , 1 bit and 47 bits, 2 bits and 46 bits, . . . , 1 bits and 55 bits, 2 bits and 54 bits, . . . , 1 bit and 63 bits, 2 bits and 62 bits, . . . , 8 bits and 56 bits, and other combinations that result in an integer number of bytes. For example, in FIG. 5AQ, the payload portion (e.g., bytes B₅-B₈) of the data packet includes an indicator in bit b₇ of the byte B₅ (e.g., a first portion of the payload) and a unique ID (a second portion of the payload). Obtaining the respective identifier of the charging source from a second portion of the payload that follows a first portion of the payload increases the efficiency of communication between the computer system and the charging source (e.g., the first portion of the payload can indicate to the computer system whether there is or is not a respective identifier that can be obtained from the one or more power transfer signals; if no respective identifier is available, then the computer system can ceases attempting to obtain the respective identifier from the payload).

In some embodiments, while displaying the first customizable user interface that was not displayed prior to detecting the first event, the computer system detects (10094) one or more user inputs that configure one or more aspects of the first customizable user interface; and In some embodiments, configuring the one or more aspects of the first customizable user interface includes, but is not limited to, changing the set of widgets displayed in a widget user interface, changing the location of a weather or a time zone of a time user interface, changing the available photos for display in a photos user interface, and/or changing other types of content that is to be displayed in the first customizable user interface. In some embodiments, configuring the one or more aspects of the first customizable user interface includes, but is not limited to, changing a preferred customization user interface, e.g., from a clock user interface to a widget user interface, from a news user interface to a weather user interface, and/or from a default customizable user interface (e.g., the clock user interface, the widget user interface, or another default customizable user interface that is displayed for a charging source that is not previously encountered) to a first preferred customizable user interface (e.g., a customizable user interface that is different from the default customizable user interface). In some embodiments, configuring the one or more aspects of the first customizable user interface includes, but is not limited to, changing an update schedule and/or update conditions for the first customizable user interface, and/or changing the display properties, such as color scheme, layout, font, and/or other display properties, for one or more portions of the first customizable user interface. In response to detecting the one or more user inputs that configure the one or more aspects of the first customizable user interface (and optionally, in accordance with a determination that the respective identifier is unique (e.g., in accordance with a determination that the transmitter identification data packet used to carry the respective identifier of the charging source also includes an indicator that specifies that the respective identifier in the same data packet is unique to the charging source, and/or in accordance with another source of data that specifies that the respective identifier is unique to the charging source)), the computer system updates a first set of customization parameters that is stored in association with the respective identifier at the computer system (e.g., if the user inputs change one or more customization parameters that are stored in association with a known identifier of a charging source stored at the computer system), and/or establishing and storing a second set of second customization parameters for the first customizable user interface in association with the respective identifier (e.g., if the respective identifier is not already stored at the computer system with some customization parameters, and/or if additional customization parameters are obtained from the user inputs for the respective identifier stored at the computer system). In some embodiments, when the criteria for personalization and/or customization based on a respective identifier of the charging source are not met (e.g., the computer system cannot decode an identifier from the power transfer signals of the charging source, the computer system did not receive a transmitter identification packet from the charging source (e.g., either in-band or out-of-band), or the indicator in the transmitter identification packet received from the charging source indicates that the identifier in the packet is not unique (e.g., the indicator in FIG. 5AQ indicates “false”) to the charging source and/or that personalization should not be performed based on the identifier in the packet), the computer system forgoes the personalization steps, such storing the identifier of the charging source, updating the customization parameters and storing them in association with the identifier at the computer system. For example, as described with reference to step S0014 in FIG. 5AR, while the first customizable user interface is displayed, the PRx may detect (e.g., via one or more input mechanisms of the PRx) one or more user inputs configuring one or more aspects of the first customizable user interface. The PRx may update a first set of customization parameters (e.g., stored in memory of the PRx) that is associated with the unique ID, and/or the PRx may establish and/or store a second set of second customization parameters for the first customizable user interface that is associated with the unique ID. Updating a first set of customization parameters that is stored in association with the respective identifier at the computer system and/or establishing and storing a second set of second customization parameters for the first customizable user interface in association with the respective identifier, in response to detecting the one or more user inputs that configure the one or more aspects of the first customizable user interface, automatically updates the customization parameters for the first customizable user interface, which reduces the number of user inputs needed to save the customization parameters (e.g., the user does not need to perform additional user inputs to save the changes to the one or more aspects of the first customizable user interface) and reduces the number of user inputs needed to display an appropriate user interface (e.g., the first customizable user interface, including the updates to the one or more aspects of the first customizable user interface, when the computer system obtains the respective identifier) without requiring additional user inputs (e.g., the user does not need to manually configure the one or more aspects of the first customizable user interface each time it is displayed).

In some embodiments, after updating the first set of customization parameters and/or establishing and storing the second set of customization parameters for the first customizable user interface in association with the respective identifier obtained from the one or more power transfer signals, the computer system detects that the computer system is decoupled from the charging source and ceases to display the first customizable user interface that were configured in accordance with the one or more user inputs. After detecting that the computer system is decoupled from the charging source and ceasing to display the first customizable user interface that was configured in accordance with the one or more user inputs, the computer system detects a subsequent event (e.g., detecting that the computer system is coupled to a respective charging source, detecting that the computer system is turned into the first orientation, and/or detecting that the computer system is entering into a low power mode or a locked state), where the first criteria are met as a result of the subsequent event (e.g., the first criteria require that the computer system is coupled to a charging source, the computer system is in the first orientation, and optionally, that the computer system is entering into a low power mode or locked mode while it is being charged and in the first orientation). In response to detecting the subsequent event, in accordance with a determination that the computer system is coupled to a respective charging source and that an identifier encoded in one or more power transfer signals received from the respective charging source matches the respective identifier of the charging source (e.g., the computer system receives one or more power transfer signals from the respective charging source, decodes the identifier of the respective charging source from the one or more charging signals as described herein, compares the decoded identifier with one or more stored identifiers of previously encountered charging sources, including but not limited to the respective identifier of the charging source, and recognizes that the decoded identifier of the respective charging source that is currently coupled to the computer system matches the respective identifier of the charging source that was previously coupled to the computer system), the computer system redisplays the first customizable user interface in accordance with the first set customization parameters and/or second set of customization parameters that are stored in association with the respective identifier of the charging source (e.g., the computer system carries out the comparison between the identifier encoded in the respective charging signal with the stored unique identifiers in accordance with a determination that the respective charging signal also carries an indicator (e.g., in the same transmitter identity packet that includes the identifier of the respective charging source) that indicates that the identifier is unique to the respective charging source, such that personalization criteria are met). In some embodiments, in accordance with a determination that personalization criteria are not met (e.g., the computer system cannot decode an identifier from the power transfer signals of the respective charging source, the computer system did not receive a transmitter identification packet from the respective charging source (e.g., either in-band or out-of-band), or the indicator in the transmitter identification packet received from the respective charging source indicates that the identifier in the packet is not unique (e.g., the indicator in FIG. 5AQ indicates “false”) to the respective charging source and/or that personalization should not be performed based on the identifier in the packet), the computer system forgoes the personalization steps, such comparing the identifier of the respective charging source to the unique identifiers of previously encountered charging sources stored at the computer system. For example, as described with reference to step S0014 in FIG. 5AR, if the PRx and the PTx are decoupled and/or moved out of proximity of one another, and then subsequently recoupled and/or moved back within proximity of one another, the PRx displays the customized user interface with the updated first set of customization parameters and/or with the second set of second customization parameters for the first customizable user interface. Redisplaying the first customizable user interface in accordance with the first set customization parameters and/or second set of customization parameters that are stored in association with the respective identifier of the charging source, reduces the number of user inputs needed to display an appropriate user interface (e.g., the first customizable user interface, including the updates to the one or more aspects of the first customizable user interface, when the computer system obtains the respective identifier) without requiring additional user inputs (e.g., the user does not need to manually configure the one or more aspects of the first customizable user interface each time it is displayed).

It should be understood that the particular order in which the operations in FIGS. 10A-10L have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 11000, 12000, 13000, 14000, 16000, and 17000) are also applicable in an analogous manner to method 10000 described above with respect to FIGS. 10A-10L. For example, the contacts, gestures, user interface objects, and/or animations described above with reference to method 10000 optionally have one or more of the characteristics of the contacts, gestures, user interface objects, and/or animations described herein with reference to other methods described herein (e.g., 11000, 12000, 13000, 14000, 16000, and 17000). For brevity, these details are not repeated here.

FIGS. 11A-11G are flow diagrams illustrating method 11000 for switching between, interacting with, and configuring different operational modes (e.g., ambient modes) in accordance with some embodiments. Method 11000 is performed at an electronic device (e.g., device 300, FIG. 3, or computer system 100, FIG. 1A) with a display, a touch-sensitive surface, and one or more sensors to detect intensity of contacts with the touch-sensitive surface. In some embodiments, the display is a touch-screen display and the touch-sensitive surface is on or integrated with the display. In some embodiments, the display is separate from the touch-sensitive surface. Some operations in method 11000 are, optionally, combined and/or the order of some operations is, optionally, changed.

Replacing display of a first user interface that is selected from a first set of user interfaces and that displays a first type of content in accordance with a first set of configuration options, with display of a second user interface that is selected from the first set of user interface and that displays a second type of content different from the first type of content, in response to detecting a first user input and in accordance with a determination that the first user input meets first directional criteria; replacing display of the first user interface with display of the first type of content in accordance with a second set of configuration options different from the first set of configuration options, in response to detecting the first user input and in accordance with a determination that the first user input meets second directional criteria different from the first directional criteria; and replacing display of a respective user interface of the first user interface and the second user interface with display of a third user interface that displays a third type of content that is different from the first type of content and different from the second type of content, in response to detecting a second user input and in accordance with a determination that the second user input meets the first directional criteria, provides additional control options without cluttering the UI with additional displayed controls (e.g., additional displayed controls for displaying the second user interface and/or for displaying the first type of content in accordance with the second set of configuration options).

In some embodiments, the method 11000 is performed at a computer system in communication with a display generation component (e.g., a touch-sensitive display, a display that has a corresponding touch-sensitive surface, or a head-mounted display that has a corresponding sensor for detecting gestural inputs) and one or more input devices. The computer system displays (11002), via the display generation component, a first user interface that is selected from a first set of user interfaces (e.g., the first set of user interfaces include different screens including, but not limited to, widget screen, media display screen, game screen, and other user-configurable or system-configured types of screens associated with the ambient mode) (e.g., the clock user interface 6000 in FIG. 6A), wherein the first user interface displays a first type of content (e.g., widget content, game content, time content, visual media content, and other types of content) (e.g., the clock user interface 6000 includes time-related content) in accordance with a first set of configuration options (e.g., spatial and/or temporal configurations); In some embodiments, if the first user interface corresponds to a widget screen, the first content includes a first plurality of widgets displayed in accordance with a first layout and/or display schedule; and if the first user interface corresponds to a media display screen, the first content include a plurality of visual media displayed in accordance with a second layout and/or display schedule; and if the first user interface corresponds to a game screen, the first content include game content that is displayed in accordance with a third layout and/or display schedule. In some embodiments, the first set of user interfaces are different versions of a first customizable user interface described above (e.g., in the descriptions of FIGS. 5A-5AK) that corresponds to different ambient modes (e.g., widget screen, media display screen, clock screen, or other types of screens) or different versions of a same ambient mode (e.g., different clock faces of the clock screen, different visual media albums of the media display screen, different sets of widgets for the widget screen, or other variations of a respective screen of the ambient mode).

While displaying the first user interface, the computer system detects (11004) (e.g., via the one or more sensors and/or input devices of the computer system) a first user input that is directed to the first user interface (e.g., a touch gesture, an air gesture, or another type of input, that is directed to the first user interface). In response to detecting (11006) the first user input that is directed to the first user interface: in accordance with a determination that the first user input meets first directional criteria, wherein the first directional criteria require that the first user input includes movement in a first direction in order for the first directional criteria to be met (e.g., the first direction is a direction that corresponds to a latitudinal direction, or left-and-right direction, of the first user interface) (e.g., the user input 6070 in FIG. 6N is a leftward swipe input), the computer system replaces (11008) display of the first user interface with display of a second user interface, wherein the second user interface is selected from the first set of user interfaces, and wherein the second user interface displays a second type of content different from the first type of content (e.g., the first type of content and the second type of content come from two different applications, or the first type of content correspond to system content and the second type of content correspond to application content, or the first type of content and the second type of content provide different types of functions and/or correspond to different types of screens in the ambient mode) (e.g., in FIG. 6O, the computer system 100 replaces display of the clock user interface 6000 in FIG. 6N, with display of the voice memo user interface 6074); and in accordance with a determination that the first user input meets second directional criteria, wherein the second directional criteria require that the first user input includes movement in a second direction, different from the first direction (e.g., substantially perpendicular to the first direction), in order for the second directional criteria to be met (e.g., the second direction is a direction that corresponds to a longitudinal direction, or up-and-down direction, of the first user interface) (e.g., the user input 6002 in FIG. 6A is an upward swipe input), the computer system replaces (11010) display of the first user interface with display of the first type of content in accordance with a second set of configuration options (e.g., spatial and/or temporal configurations), different from the first set of configuration options (e.g., a first version of the first user interface was initially displayed, and a second version of the first user interface is displayed in response to the first user input meeting the second directional criteria) (e.g., in FIG. 6B, the computer system 100 replaces display of the clock user interface 6000 in FIG. 6A, with display of the clock user interface 6004 (e.g., that includes time-content displayed in accordance with a different set of configuration options, such as having a different background and font)).

After detecting the first user input, while displaying a respective user interface from the first set of user interfaces (e.g., including the second user interface or the first user interface that displays the first type of content in accordance with the second set of configuration options), the computer system detects (11012) (e.g., via the one or more sensors and/or input devices of the computer system) a second user input that is directed to the respective user interface (e.g., a touch gesture, an air gesture, or another type of input, that is directed to the first user interface). In response to detecting (11014) the second user input: in accordance with a determination that the second user input meets the first directional criteria, wherein the first directional criteria require that the second user input includes movement in the first direction in order for the first directional criteria to be met, the computer system replaces (11016) display of the respective user interface with display of a third user interface that is selected from the first set of user interfaces, wherein the third user interface displays a third type of content that is different from the first type of content and the second type of content (e.g., the first type of content, the second type of content, and the third type of content come from three different applications, or from different types of system content or application content; or the first type of content, the second type of content, and the third type of content provide different types of functions and/or correspond to different types of screens in the ambient mode) (e.g., in FIG. 6P, the computer system 100 detects the user input 6088, and in response, replaces display of the voice memo user interface 6082 with display of the ambient sound user interface 6090 in FIG. 6Q).

In some embodiments, the first user interface that is selected from the first set of user interfaces is displayed (11018) in accordance with a determination that first criteria are met (e.g., the computer system is charging, and the display generation component has a first orientation; and/or the conditions for displaying the first customizable user interface (e.g., activating a respective one of the available screens in the ambient mode are met)). For example, in FIG. 6A, the clock user interface 6000 is a first user interface (e.g., specific clock user interface) that is selected from a first set of user interfaces (e.g., clock user interfaces), and is displayed while (e.g., and/or because) the display of the computer system 100 is in the landscape orientation and the computer system 100 is connected to the charging source 5056. Displaying the first user interface that is selected from the first set of user interfaces in accordance with a determination that first criteria are met enables the computer system to automatically display an appropriate user interface without requiring additional user inputs (e.g., additional user inputs to display the first user interface when first criteria are met).

In some embodiments, while displaying (e.g., in accordance with a determination that the first criteria are met as a result of a detected event that occurred while the device is displaying a wake screen or lock screen user interface) a respective user interface of the first set of user interfaces (e.g., the respective user interface being the first user interface, the second user interface, the third user interface, or another user interface of the first set of user interfaces), the computer system detects (11020) (e.g., via the one or more sensors and/or input devices of the computer system, and/or based on a change in an internal state of the computer system) a first event (e.g., an event that corresponds to at least one of a change in an orientation of the display generation component and/or a change in a charging state of the computer system, or other event(s) relevant for whether to activate or deactivate a respective operating mode of the device). In response to detecting the first event, in accordance with a determination that first criteria are no longer met as a result of the first event, ceasing to display the respective user interface of the first set of user interfaces, and redisplaying a system user interface that corresponds to a restricted state of the computer system (e.g., a wake screen user interface, a lock screen user interface, a dimmed always-on user interface that is displayed when the device is in a low-power mode). In some embodiments, the first criteria require that the orientation of the display generation component is a first orientation (e.g., a portrait orientation or a landscape orientation; a particular pitch, yaw, and/or roll relative to a physical reference plane (e.g., the floor, a table top, a wall, or a charging stand); or is within a threshold range of pitch, yaw, and/or roll values relative to the physical reference plane), and that the computer system is charging (e.g., the computer system is physically connected to a plug-in power source via a charging cable to receive power from the power source, or the computer system is coupled wirelessly to a wireless charging source to receive power from the wireless charging source, optionally, irrespective of the current charge level or whether the computer system is fully charged and drawing little power from the power source), in order for the first criteria to be met. In some embodiments, the first criteria are not met based on one or more exceptions, even if the orientation of the display generation component and the charging state of the computer system both met the above requirements of the first criteria. For example, in some embodiments, in accordance with a determination that the electronic device is moving by more than a threshold amount in a unit of time, the first criteria are not met even if the electronic device is charging and is in the first orientation during the movement of the electronic device. For example, in FIGS. 5AH, the display of the computer system 100 is rotated away from the landscape orientation and/or the computer system 100 is disconnected from the charging source 5056, and in FIG. 5AI, the computer system 100 ceases to display the clock user interface 5058. This is also described with reference to FIG. 6A (e.g., which shows an analogous clock user interface 6000). Ceasing to display the respective user interface of the first set of user interfaces, and redisplaying a system user interface that corresponds to a restricted state of the computer system, in accordance with a determination that first criteria are no longer met as a result of the first event, enables the computer system to automatically display an appropriate user interface without requiring additional user inputs (e.g., additional user inputs to cease displaying the respective user interface of the first set of user interfaces, and to display another user interface, when the first criteria are no longer met as a result of the first event).

In some embodiments, in response to detecting (11022) the second user input, in accordance with a determination that the second user interface is currently displayed as the respective user interface as a result of the first user input (e.g., the first user input met the first directional criteria and caused display of the second user interface to replace display of the first user interface, and the second user input follows the first user input in a sequence of user inputs (e.g., a sequence of swipe inputs, air gestures, or other types of directional inputs)) and that the second user input meets third directional criteria, wherein the third directional criteria require that the second user input includes movement in a third direction, different from the first direction and the second direction (e.g., the third direction is opposite, or substantially a reverse of the first direction; the third direction is substantially perpendicular to the second direction), in order for the third directional criteria to be met, the computer system replaces display of the second user interface with display of the first user interface. For example, in response to the first user input, the second user interface of the first set of user interfaces replaced the first user interface of the first set of user interfaces as the currently displayed user interface of the first set of user interfaces; and in response to the second user input in an opposite direction while the second user interface is displayed, the first user interface replaces the second user interface as the currently displayed user interface of the first set of user interfaces. In some embodiments, the first user interface still displays the first type of content, but the content itself may have been updated automatically due to elapse of time and/or change of current context surrounding the computer system. For example, as described with reference to FIG. 6B, the computer system 100 detects a user input 6006 (e.g., a downward swipe input that is opposite the upward swipe input 6002 in FIG. 6A), and in response, the computer system 100 redisplays the clock user interface 6000. Replacing display of the second user interface with display of the first user interface, in accordance with a determination that the second user interface is currently displayed and that the second user input includes movement in a third direction, different from the first direction and the second direction, provides additional control options (e.g., for switching between different user interfaces) without cluttering the UI with additional displayed controls (e.g., additional displayed controls for navigating to a next user interface, and/or additional displayed controls for navigating to a previous user interface).

In some embodiments, after detecting the second user input, while displaying a respective user interface of the first set of user interfaces, detecting (11024) (e.g., via the one or more sensors and/or input devices of the computer system) a third user input that is directed to the respective user interface of the first set of user interfaces (e.g., a touch gesture, an air gesture, or another type of input, that is directed to the first user interface). In response to detecting the third user input, in accordance with a determination that the third user input meets the first directional criteria, wherein the first directional criteria require that the third user input includes movement in the first direction in order for the first directional criteria to be met, the computer system displays a fourth user interface of the first set of user interfaces (e.g., the fourth user interface is different from the first, second, and third user interface), wherein the fourth user interface displays a fourth type of content that is different from the first type of content, the second type of content, and the third type of content (e.g., the first type of content, the second type of content, the third type of content, and the fourth type of content come from four different applications, or from different types of system content or application content; or the first type of content, the second type of content, the third type of content, and the fourth type of content provide different types of functions and/or correspond to different types of screens in the ambient mode). In some embodiments, in response to detecting the third user input, in accordance with a determination that the third user input meets the second directional criteria, wherein the second directional criteria require that the third user input includes movement in the second direction in order to be met, the computer system displays the third user interface in accordance with a different set of configuration options associated with the third user interface. In some embodiments, in response to detecting the third user input, in accordance with a determination that the third user input meets the third directional criteria, wherein the third directional criteria require that the third user input includes movement in the third direction in order to be met, the computer system replaces the third user interface with the second user interface as the currently displayed user interface from the first set of user interfaces. In some embodiments, user inputs that meet the first directional criteria cause navigation between a series of user interfaces from the first set of user interfaces; user inputs that meet the second directional criteria cause the currently displayed user interface of the first set of user interfaces to be displayed with a different set of configuration options that are associated with the currently displayed user interface; and user inputs that meet the third directional criteria cause navigation from the currently displayed user interface of the first set of user interfaces to a previously displayed user interface of the first set of user interfaces (e.g., in the order that they were previously displayed as the currently displayed user interface of the first set of user interfaces, or in a default order). In some embodiments, a respective user interface of the first set of user interfaces, when displayed, includes content of a corresponding content type in accordance with a corresponding set of configuration options; and when the respective user interface of the first set of user interfaces is redisplayed at a later time, the respective user interface is displayed with the previously used set of configuration options, or a default set of configuration options, unless the user uses an input to change the configuration options. For example, in FIGS. 6F, the computer system 100 displays a clock user interface 6014. In response to detecting the user input 6016 (e.g., meeting first criteria, such as an upward swipe input), the computer system 100 displays the clock user interface 6018 in FIG. 6G. In response to detecting another user input meeting the same criteria (e.g., the user input 6020 in FIG. 6G is also an upward swipe input), the computer system 100 displays the clock user interface 6022. Displaying a fourth user interface that displays a fourth type of content that is different from the first type of content, the second type of content, and the third type of content, in response to detecting the third user input that includes movement in the first direction, provides additional control options (e.g., for switching between different user interfaces) without cluttering the UI with additional displayed controls (e.g., additional displayed controls for navigating to a next user interface, and/or additional displayed controls for navigating to a previous user interface).

In some embodiments, the first set of user interfaces includes (11026) a widget user interface that displays a set of widgets that correspond to different applications (e.g., the first user interface, the second user interface, or another user interface of the first set of user interfaces, displays a first set of widgets). In some embodiments, the selection of widgets that are included in the widget user interface, the display format of the widgets, and/or the content of the widgets are determined in accordance with a set of configurations established for the widget user interface that displays the set of widgets. For example, in FIG. 5S, the computer system 100 displays the widget user interface 5078. Similarly, in FIG. 7C, the computer system 100 displays a widget user interface that includes the widget 7006 (e.g., corresponding to a stocks application) and the widget 7008 (e.g., corresponding to a weather application). Replacing display of a first user interface that is selected from a first set of user interfaces (that includes a widget user interface that displays a set of widgets that correspond to different applications) and that displays a first type of content in accordance with a first set of configuration options, with display of a second user interface that is selected from the first set of user interface and that displays a second type of content different from the first type of content, in response to detecting a first user input and in accordance with a determination that the first user input meets first directional criteria; replacing display of the first user interface with display of the first type of content in accordance with a second set of configuration options different from the first set of configuration options, in response to detecting the first user input and in accordance with a determination that the first user input meets second directional criteria different from the first directional criteria; and replacing display of a respective user interface of the first user interface and the second user interface with display of a third user interface that displays a third type of content that is different from the first type of content and different from the second type of content, in response to detecting a second user input and in accordance with a determination that the second user input meets the first directional criteria, provides additional control options without cluttering the UI with additional displayed controls (e.g., additional displayed controls for displaying the second user interface and/or for displaying the first type of content in accordance with the second set of configuration options).

In some embodiments, the first set of user interfaces includes (11028) a media display user interface that displays visual media (e.g., photographs, animated photographs, and/or videos) of one or more categories (e.g., the first user interface, the second user interface, or another user interface of the first set of user interfaces, displays visual media of different categories). In some embodiments, the selection of visual media that are included in the media display user interface (e.g., based on subject, location taken, albums, or other descriptors or characteristics of the visual media), the display format of the visual media, the switching of visual media, the transition between visual media, and/or other aspects of how the visual media are displayed in the user interface are determined in accordance with a set of configurations established for the media display user interface that displays the set of visual media. For example, in FIG. 6S-6Z, the computer system 100 displays different media display user interfaces (e.g., that include different visual media of one or more categories), such as the media display user interface 6098 in FIG. 6S, the media display user interface 6102 in FIG. 6T, and the media display user interface 6110 in FIG. 6Z. Replacing display of a first user interface that is selected from a first set of user interfaces (that includes a media display user interface that displays visual media (e.g., photographs, animated photographs, and/or videos) of one or more categories) and that displays a first type of content in accordance with a first set of configuration options, with display of a second user interface that is selected from the first set of user interface and that displays a second type of content different from the first type of content, in response to detecting a first user input and in accordance with a determination that the first user input meets first directional criteria; replacing display of the first user interface with display of the first type of content in accordance with a second set of configuration options different from the first set of configuration options, in response to detecting the first user input and in accordance with a determination that the first user input meets second directional criteria different from the first directional criteria; and replacing display of a respective user interface of the first user interface and the second user interface with display of a third user interface that displays a third type of content that is different from the first type of content and different from the second type of content, in response to detecting a second user input and in accordance with a determination that the second user input meets the first directional criteria, provides additional control options without cluttering the UI with additional displayed controls (e.g., additional displayed controls for displaying the second user interface and/or for displaying the first type of content in accordance with the second set of configuration options).

In some embodiments, while displaying the media display user interface of the first set of user interfaces that displays visual media (e.g., photographs, animated photographs, and/or videos) from a first category, detecting (11030) (e.g., via the one or more sensors and/or input devices of the computer system) a fourth user input. In response to detecting the fourth user input, in accordance with a determination that the fourth user input meets the second directional criteria, the computer system updates display of the media display user interface to display visual media (e.g., photographs, animated photographs, and/or videos) from a second category, different from the first category (e.g., visual media that belong to a different album, visual media that include a different subject, visual media that were taken during a different time period, and/or visual media that were taken within a different geographical region). For example, in FIG. 6Z, the media display user interface 6110 includes a piece of visual media from a first category of visual media (e.g., pets, or animals), and in response to detecting the user input 6112, the computer system 100 displays the media display user interface 6114 that includes a piece of visual media from a second category of visual media (e.g., people, or family members). Updating display of the media display user interface to display visual media from a second category that is different from the first category, in response to detecting a fourth user input that meets second directional criteria, and while the media display user interface displays visual media from the first category, provides additional control options (e.g., for switching between display of different categories of photographs) without cluttering the UI with additional displayed controls (e.g., additional displayed controls for navigating between visual media of the same category and/or additional displayed controls for navigating to visual media of a different category).

In some embodiments, while displaying (e.g., in accordance with a determination that the first criteria are met, and/or the criteria for displaying the media display ambient mode are met) the media display user interface that displays visual media (e.g., photographs, animated photographs, and/or videos) of one or more categories, the computer system displays additional content (e.g., a time indication, a location indication, a timestamp, or other data related to the currently displayed album or photo) overlaying a currently displayed visual media selected from a respective category of the one or more categories. While displaying the additional content overlaying the currently displayed visual media, the computer system detects (e.g., via the one or more sensors and/or input devices of the computer system) a fifth user input directed to a first portion of the currently displayed visual media (e.g., a portion that is not overlaid by the additional content). In response to detecting the fifth user input directed to the first portion of the currently displayed visual media, the computer system ceases to display the additional content while maintaining display of the currently displayed visual media. In some embodiments, the currently displayed visual media is automatically updated to another visual media selected from the respective category of visual media (e.g., photographs, animated photographs, and/or videos). For example, in FIG. 6X, the computer system 100 displays the media display user interface 6102 that includes the photo chrome 6104. In FIG. 6Y, in response to detecting the user input 6029, the computer system 100 ceases to display the photo chrome 6014. Ceasing to display the additional content while maintaining display of the currently displayed visual media, in response to detecting a fifth user input directed to a first portion of the currently display visual media, provides additional control options (e.g., for displaying or ceasing to display the additional content) without cluttering the UI with additional displayed controls (e.g., additional displayed controls for displaying and/or ceasing to display the additional content).

In some embodiments, while displaying (e.g., in accordance with a determination that the first criteria are met, and/or the criteria for displaying the media display ambient mode are met) the media display user interface that displays visual media (e.g., photographs, animated photographs, and/or videos) of one or more categories, the computer system detects (11034) (e.g., via the one or more sensors and/or input devices of the computer system) a sixth user input directed to a second portion of a currently displayed visual media (e.g., an edge portion of the currently displayed visual media, or another portion that is associated with switching visual media within the currently displayed category of visual media in the media display screen of the ambient mode). In response to detecting the sixth user input directed to the second portion of the currently displayed visual media: in accordance with a determination that the currently displayed visual media is selected from a first category of the one or more categories, the computer system displays another visual media from the first category as the currently displayed visual media (e.g., navigating to the next visual media or an automatically selected visual media in the first category); and in accordance with a determination that the currently displayed visual media is selected from a second category, different from the first category, the computer system displays another visual media from the second category as the currently displayed visual media (e.g., navigating to the next visual media or an automatically selected visual media in the second category). In some embodiments, the currently displayed visual media is automatically updated to another visual media selected from the respective category of visual media that is currently displayed. For example, in FIG. 6Y, the computer system 100 displays the media display user interface 6012 that includes a photo of the first category (e.g., pets, or another first category). In FIG. 6Z, in response to detecting the user input 6108 in FIG. 6Y, the computer system 100 displays the media display user interface 6110 that includes another photo of the first category (e.g., the pets category, or another first category). FIGS. 6AM-6AN show an analogous operation (e.g., in response to the user input 6226 in FIG. 6AM), but for a second category (e.g., an “albums” category, or another second category). Displaying another visual media from the first category as the currently displayed visual media, in response to detecting the sixth user input directed to the second portion of the currently displayed visual media and in accordance with a determination that the currently displayed visual media is selected from a first category of the one or more categories, and displaying another visual media from the second category as the currently displayed visual media, in response to detecting the sixth user input directed to the second portion of the currently displayed visual media and in accordance with a determination that the currently displayed visual media is selected from a second category, provides additional control options (e.g., for navigating between different pieces of visual media and/or categories of visual media) without cluttering the UI with additional displayed controls (e.g., additional displayed controls for navigating to a next piece of visual media, additional displayed controls for navigating to a previous piece of visual media, and/or additional displayed controls for navigating to another category of visual media).

In some embodiments, while displaying (e.g., in accordance with a determination that the first criteria are met, and/or the criteria for displaying the media display ambient mode are met) the media display user interface that displays visual media (e.g., photographs, animated photographs, and/or videos) of one or more categories, the computer system detects (11036) (e.g., via the one or more sensors and/or input devices of the computer system) a seventh user input directed to a third portion of a currently displayed visual media (e.g., a corner portion of the currently displayed visual media, or another portion that is associated with sharing visual media in the media display screen of the ambient mode). In response to detecting the seventh user input directed to the third portion of the currently displayed visual media, the computer system displays one or more options for sharing the currently displayed visual media (e.g., displaying application icons for one or more applications that can be selected and used to share the currently displayed visual media, displaying avatars for one or more contacts that may be selected as the recipient of the currently displayed visual media, displaying options to save, copy, edit the currently displayed photograph). For example, in FIG. 6AH, the computer system 100 displays a sharing user interface 6166 which includes one or more options for sharing the currently displayed visual media (e.g., via different protocols). Displaying one or more options for sharing the currently display visual media, in response to detecting the seventh user input directed to the third portion of the currently displayed visual media, provides additional control options (e.g., for sharing the currently displayed photograph) without cluttering the UI with permanently displayed controls (e.g., without needing to permanently display the one or more option for sharing the currently displayed photograph).

In some embodiments, the first set of user interfaces includes (11038) a time user interface that displays an indication of current time (e.g., a clock or clock face, a world clock, a sleep clock, or multiple clocks for different time zones) (e.g., the first user interface, the second user interface, or another user interface of the first set of user interfaces, displays an indication of the current time). For example, in FIG. 6B, the clock user interface 6004 displays an indication of the current time (9:00). Replacing display of a first user interface that is selected from a first set of user interfaces (that includes a time user interface that displays an indication of current time) and that displays a first type of content in accordance with a first set of configuration options, with display of a second user interface that is selected from the first set of user interface and that displays a second type of content different from the first type of content, in response to detecting a first user input and in accordance with a determination that the first user input meets first directional criteria; replacing display of the first user interface with display of the first type of content in accordance with a second set of configuration options different from the first set of configuration options, in response to detecting the first user input and in accordance with a determination that the first user input meets second directional criteria different from the first directional criteria; and replacing display of a respective user interface of the first user interface and the second user interface with display of a third user interface that displays a third type of content that is different from the first type of content and different from the second type of content, in response to detecting a second user input and in accordance with a determination that the second user input meets the first directional criteria, provides additional control options without cluttering the UI with additional displayed controls (e.g., additional displayed controls for displaying the second user interface and/or for displaying the first type of content in accordance with the second set of configuration options).

In some embodiments, the time user interface includes (11040) one or more interactive regions. While displaying the time user interface that includes the one or more interactive regions and the indication of current time, the computer system detects (e.g., via the one or more sensors and/or input devices of the computer system) an eighth user input that is directed to the time user interface. In response to detecting the eighth user input, the computer system displays additional time content that was not previously displayed or changing a manner that the current time is displayed in the time user interface, in accordance with the eighth user input. In some embodiments, the time user interface includes a digital clock face that shows the current time (e.g., for the local time zone for the computer system), and the additional time content includes the current time in time zones other than the local time zone for the computer system (e.g., time zones corresponding to the locations of one or more user contacts stored in memory of the computer system). In some embodiments, in response to detecting the user input directed to the time user interface, the computer system generates audio feedback corresponding to the time content (e.g., in addition to, or in lieu of, displaying the additional time content). In some embodiments, the computer system increases the level of detail or the visual prominence of the time indication in response to detecting the eighth user input. For example, in FIG. 6C, the computer system 100 detects the user input 6008 directed to the clock user interface 6004. In FIG. 6D, in response to detecting the user input 6008, the computer system 100 displays additional time content that was not previously displayed (e.g., displays a current time for contacts Amy and Jon, who are sharing their location with the user of the computer system 100). Displaying additional time content that was not previously displayed or changing a manner that the current time is displayed in the time user interface, in response to detecting the eighth user input that is directed to the time user interface, provides additional control option (e.g., for displaying the additional time content and/or changing the manner in which current time content is displayed), without cluttering the UI with additional displayed controls (e.g., individual controls for displaying the additional time content and changing the manner in which the current time content is displayed).

In some embodiments, in response to detecting the eighth user input, in accordance with a determination that the eighth user input meets feedback criteria, the computer system provides (11042) visual or audio feedback in the time user interface (e.g., including displaying the additional time content that was not previously displayed, changing a manner that the current time is displayed in the time user interface, and/or reading out the current time out loud) in accordance with the eighth user input. While the eighth user input continues to be detected, the computer system maintains the visual or audio feedback. The computer system detects a termination of the eighth user input, and in response to detecting a termination of the eighth user input, the computer system ceases to provide the visual or audio feedback in the time user interface and restoring display of the indication of current time in the time user interface. In some embodiments, in response to detecting termination of the user input or that the user input is no longer directed to the time content, the computer system ceases to generate and output the audio feedback corresponding to the time content, and ceasing to display the visual feedback that was generated during the user input. For example, in FIG. 6D, the computer system 100 provides visual feedback (e.g., time content corresponding to contacts Amy and Jon) and audio feedback (e.g., the audio feedback 6010), while the user input 6008 continues to be detected (e.g., while the user continues the user input 6008 from FIG. 6C), and ceases to provide the visual and audio feedback when the user input 6008 terminates (e.g., as shown in FIG. 6E). Maintaining the visual or audio feedback while the eighth user input continues to be detected, and ceasing to provide the visual or audio feedback (and restoring display of the indication of the current time), in response to detecting termination of the eight user input, provides additional control option (e.g., for displaying the additional time content, ceasing to display the additional time content, and/or changing the manner in which current time content is displayed), without cluttering the UI with additional displayed controls (e.g., individual controls for displaying the additional time content, ceasing to display the additional time content, and changing the manner in which the current time content is displayed).

In some embodiments, at a first time, the computer system displays (11044) the time user interface including the indication of the current time with a first appearance, wherein the first appearance is configured in accordance with a third set of configuration options for the time user interface. At a second time after the first time, in accordance with a determination that the second time meets scheduled-update criteria (e.g., the current time is in a first time of day, the time user interface has been displayed for more than a first threshold amount of time, or other criteria for updating the appearance of the time user interface based on elapse of time or a schedule) the computer system updates (automatically, without user intervention) display of the time user interface to include the indication of the current time with a second appearance (e.g., change the font, color, background, level of details, brightness, format, appearance of the clock face, time zone, and/or other appearance aspects), different from the first appearance, wherein the second appearance is configured in accordance with a fourth set of configuration options for the time user interface, different from the third set of configuration options. For example, in FIG. 6F, the computer system 100 automatically displays the clock user interface 6014 (e.g., because one hour has elapsed since displaying the clock user interface 6004 in FIG. 6E). Updating display of the time user interface to include the indication of the current time with the second appearance that is different from the first appearance, in accordance with a determination that the second time meets scheduled-update criteria, automatically displays the time user interface with an appropriate appearance without requiring additional user inputs (e.g., additional user inputs to update the display of the time user interface).

In some embodiments, in a first scenario where a first version of the first user interface that was displayed at receipt of the first user input is (11046) a first version of the time user interface having a first set of features, and a second version of the first user interface that is displayed in response to the first user input that meets the second directional criteria is a second version of the time user interface having a second set of features, different from the first set of features. For example, in FIG. 6G, the clock user interface 6018 includes a first set of features (e.g., a simplified display of the current time and/or a darker appearance), and in FIG. 6H, the clock user interface 6022 includes a second set of features (e.g., time information for different contacts in different time zones). Displaying a first version of the time user interface that has a first set of features, when detecting the first user input and displaying a second version of the time user interface that has a second set of features different from the first set of features, in response to detecting the first user input, provides additional control options without cluttering the UI with additional displayed controls (e.g., additional displayed controls for switching from the first time user interface to the second time user interface, and/or for switching from displaying the first set of features to the second set of features).

In some embodiments, the time user interface that is displayed with a respective set of features includes (11048) respective indications of current time for one or more contacts of a user of the computer system (e.g., in addition to the current local time for the computer system, and, optionally, respective time zones and locations of the contacts of the user). In some embodiments, the contacts of the user include friends and/or family members that have opted to share locations with the user of the computer system. For example, in FIG. 6H, the clock user interface 6022 includes indications of the current time for a contact Amy, and a contact Jon. Displaying the time user interface with respective indications of the current time for one or more contacts of a user of the computer system enables the computer system to efficiently display current time information for multiple contacts without requiring multiple user interface and/or additional user inputs (e.g., current time information for multiple contacts is consolidated in one time user interface, and the current time information for some contacts need not be permanently displayed in said time user interface, which removes the need for a user to perform additional user inputs to navigate to the individual contact information (e.g., that contains time zone information) for each contact and/or to look up the current time in different time zones).

In some embodiments, the first set of user interfaces includes (11050) a dictation user interface that displays controls for generating voice recordings (e.g., a visual representation of recorded audio and/or controls for recording audio). For example, in FIG. 6O, the voice memo user interface 6074 is a dictation user interface, and includes an affordance 6076 for recording a voice memo (e.g., a voice recording). Replacing display of a first user interface that is selected from a first set of user interfaces (that includes a dictation user interface that displays controls for generating voice recordings) and that displays a first type of content in accordance with a first set of configuration options, with display of a second user interface that is selected from the first set of user interface and that displays a second type of content different from the first type of content, in response to detecting a first user input and in accordance with a determination that the first user input meets first directional criteria; replacing display of the first user interface with display of the first type of content in accordance with a second set of configuration options different from the first set of configuration options, in response to detecting the first user input and in accordance with a determination that the first user input meets second directional criteria different from the first directional criteria; and replacing display of a respective user interface of the first user interface and the second user interface with display of a third user interface that displays a third type of content that is different from the first type of content and different from the second type of content, in response to detecting a second user input and in accordance with a determination that the second user input meets the first directional criteria, provides additional control options without cluttering the UI with additional displayed controls (e.g., additional displayed controls for displaying the second user interface and/or for displaying the first type of content in accordance with the second set of configuration options).

In some embodiments, the first set of user interfaces includes (11052) a time user interface that displays an indication of a current time with a reduced level of visibility while the computer system operates in a first mode (e.g., a sleep mode, a DND mode, or another mode that is activated during night time, or sleep time as indicated by an active sleep schedule). In some embodiments, the appearance of the time user interface changes over time and/or in response to detecting different times of input directed to the time user interface, without exiting the time user interface or the first mode (e.g., as described herein with reference to FIGS. 9D-9R). For example, in FIG. 6G, the computer system 100 displays the clock user interface 6018 that include an indication of the current time with a reduced level of visibility (e.g., displays only the hour value of 10, without displaying the minutes value, for the current time). Replacing display of a first user interface that is selected from a first set of user interfaces (that includes a time user interface that displays an indication of a current time with a reduced level of visibility while the computer system operates in a first mode) and that displays a first type of content in accordance with a first set of configuration options, with display of a second user interface that is selected from the first set of user interface and that displays a second type of content different from the first type of content, in response to detecting a first user input and in accordance with a determination that the first user input meets first directional criteria; replacing display of the first user interface with display of the first type of content in accordance with a second set of configuration options different from the first set of configuration options, in response to detecting the first user input and in accordance with a determination that the first user input meets second directional criteria different from the first directional criteria; and replacing display of a respective user interface of the first user interface and the second user interface with display of a third user interface that displays a third type of content that is different from the first type of content and different from the second type of content, in response to detecting a second user input and in accordance with a determination that the second user input meets the first directional criteria, provides additional control options without cluttering the UI with additional displayed controls (e.g., additional displayed controls for displaying the second user interface and/or for displaying the first type of content in accordance with the second set of configuration options).

In some embodiments, the first set of user interfaces includes (11054) an ambient sound user interface that displays visual content (e.g., a dark screen, dancing dots or ribbons, night sky, forest scene, color variations, light show, streams, and other visual content) in conjunction with outputting ambient sound content (e.g., a visual representation corresponding to and/or accompanying one or more types of ambient sounds, such as white noise, ocean sound, rainfall sound, insects sound, and other types of ambient sounds). For example, in FIG. 6Q, the computer system 100 displays an ambient sound user interface 6090 that include visual content (e.g., the cloud and lightning bolts, representing a thunderstorm) in conjunction with outputting ambient sound content (e.g., thunderstorm sounds). Replacing display of a first user interface that is selected from a first set of user interfaces (that includes an ambient sound user interface that displays visual content in conjunction with outputting ambient sound content) and that displays a first type of content in accordance with a first set of configuration options, with display of a second user interface that is selected from the first set of user interface and that displays a second type of content different from the first type of content, in response to detecting a first user input and in accordance with a determination that the first user input meets first directional criteria; replacing display of the first user interface with display of the first type of content in accordance with a second set of configuration options different from the first set of configuration options, in response to detecting the first user input and in accordance with a determination that the first user input meets second directional criteria different from the first directional criteria; and replacing display of a respective user interface of the first user interface and the second user interface with display of a third user interface that displays a third type of content that is different from the first type of content and different from the second type of content, in response to detecting a second user input and in accordance with a determination that the second user input meets the first directional criteria, provides additional control options without cluttering the UI with additional displayed controls (e.g., additional displayed controls for displaying the second user interface and/or for displaying the first type of content in accordance with the second set of configuration options).

In some embodiments, a second scenario where a first version of the first user interface that was displayed at receipt of the first user input is (11056) a first version of the ambient sound user interface that accompanies output of a first ambient sound, and a second version of the first user interface that is displayed in response to the first user input that meets the second directional criteria is a second version of the ambient sound user interface that accompanies output of a second ambient sound, different from the first ambient sound. For example, in FIG. 6R, the computer system 100 displays the ambient sound user interface 6094, which includes a wave visual (e.g., corresponding to the ocean and/or water) that is accompanied by second ambient sound (e.g., ocean or water ambient sound), and which is different from the thunderstorm visual and audio in the ambient sound user interface 6090 in FIG. 6Q. Displaying a first version of the ambient sound user interface that accompanies output of the first ambient sound (e.g., prior to detecting the first user input), and displaying a second version of the first user interface that accompanies output of the second ambient sound in response to detecting the first user input, provides additional control options without cluttering the UI with additional displayed controls (e.g., additional displayed controls for switching between different versions of the first user interface).

In some embodiments, in accordance with a determination that a currently output ambient sound has changed from a first ambient sound to a second ambient sound (e.g., in response to a swipe input, in response to a user input that meets the second directional criteria), the computer system changes (11058) the visual content (e.g., a dark screen, dancing dots or ribbons, night sky, forest scene, color variations, light show, streams, and other visual content) that is displayed in the ambient sound user interface from a first type of visual content to a second type of visual content. In some embodiments, the first type of visual content, and/or the second type of visual content varies in appearance (e.g., is animated, and/or changes in color, intensity, and other display properties) in accordance with variations in the first ambient sound and/or the second ambient sound that is being output by the computer system. For example, the visual content (e.g., waves) in the ambient sound user interface 6094 in FIG. 6R is different than the visual content (e.g., cloud and lightning bolts) in the ambient sound user interface 6090 in FIG. 6Q. Changing the visual content that is displayed in the ambient sound user interface from a first type of visual content to a second type of visual content, in accordance with a determination that a currently output ambient sound has changed from a first ambient sound to a second ambient sound, provides improved visual feedback to the user (e.g., improved visual feedback regarding the current ambient sound).

In some embodiments, the first user input that meets the second directional criteria includes (11060) a swipe input in the second direction. For example, in FIG. 6Q, the computer system 100 displays the ambient sound user interface 6090, and detects the user input 6092 (e.g., an upward swipe input). In FIG. 6R, in response to detecting the user input 6092, the computer system 100 displays the ambient user interface 6094. Displaying a first version of the ambient sound user interface that accompanies output of the first ambient sound (e.g., prior to detecting the first user input), and displaying a second version of the first user interface that accompanies output of the second ambient sound in response to detecting the first user input that includes a swipe input in the second direction, provides additional control options without cluttering the UI with additional displayed controls (e.g., additional displayed controls for switching between different versions of the first user interface).

In some embodiments, the computer system displays (11062) a respective configuration user interface for a respective user interface of the first set of user interfaces (e.g., by performing a touch and hold gesture, or other required input on the respective user interface, and/or navigating to the configuration option for the respective user interface in a device settings user interface), wherein the respective configuration user interface for the respective user interface of the first set of user interfaces includes a plurality of configuration options for the respective user interface of the first set of user interfaces. The computer system detects (e.g., via the one or more sensors and/or input devices of the computer system) one or more user inputs directed to the plurality of configuration options in the respective configuration user interface. In response to detecting the one or more user inputs directed to the plurality of configuration options, in accordance with a determination that the one or more user inputs meet editing criteria (e.g., changes one or more configurations of the respective user interface, adding or deleting content from the respective user interface, changes the conditions for displaying and changing the respective user interface, and/or making other changes in various aspects related to the display of the respective user interface), the computer system changes one or more aspects of the respective user interface such that, at a future time when the respective user interface is displayed, the respective user interface is displayed in accordance with changes in the one or more aspects that have been made in accordance with the one or more user inputs that met the editing criteria. For example, in FIG. 6AC, the computer system 100 displays the editing user interface 6120, which includes a hide affordance 6132 (e.g., for removing visual media in the category 6128 from the pool of available visual media for display while the computer system 100 is in the ambient mode). In FIGS. 6AD-6AE, additional configuration options are available (e.g., the user interface 6148 includes different contacts, and the user can configure whether visual media that include a particular contact are available for display while the computer system 100 is in the ambient mode). Changing one or more aspects of the respective user interface such that, at a future time when the respective user interface is displayed, the respective user interface is displayed in accordance with changes in the one or more aspects that have been made in accordance with the one or more user inputs that met the editing criteria, in response to detecting the one or more user inputs directed to the plurality of configuration options and in accordance with a determination that the one or more user inputs meet the editing criteria, provides improved privacy by allowing the user to configure how the respective user interface is displayed (e.g., to hide or disable some content from being displayed in the respective user interface).

In some embodiments, the editing criteria are (11064) different from the first directional criteria and the second directional criteria. In some embodiments, the editing criteria includes a criterion that requires the third user input to a light press input or a touch and hold input, in order for the editing criteria to be met. For example, the user input 6118 in FIG. 6AB is a long press input, which is different from the upward swipe input and the leftward swipe inputs (e.g., inputs meeting first and second directional criteria). In FIG. 6AC, in response to detecting the user input 6118, the computer system 100 displays the editing user interface 6120. For example, the user input 6134 and the user input 6140 are tap inputs (e.g., the editing criteria require the user input be a tap input, and is different from the first and second directional criteria). Changing one or more aspects of the respective user interface such that, at a future time when the respective user interface is displayed, the respective user interface is displayed in accordance with changes in the one or more aspects that have been made in accordance with the one or more user inputs that met the editing criteria that is different from the first directional criteria and the second directional criteria, in response to detecting the one or more user inputs directed to the plurality of configuration options and in accordance with a determination that the one or more user inputs meet the editing criteria, provides improved privacy by allowing the user to configure how the respective user interface is displayed (e.g., to hide or disable some content from being displayed in the respective user interface).

In some embodiments, in a respective scenario where the respective user interface for which the respective configuration user interface is displayed is a widget user interface that displays a set of widgets, the respective configuration user interface includes (11066) one or more options for configuring which widgets are to be included in the set of widgets for display in the widget user interface (e.g., options to add, remove, order, and/or group widgets that are available to be selected for display in the widget user interface by the computer system and/or the user's browsing input (e.g., horizontal swipes, taps on the side edge, and/or vertical swipes)). For example, in FIG. 7K and FIG. 7N, the computer system 100 displays an editing user interface 7034 for configuring a widget user interface (e.g., changing the displayed note content for a notes widget, as shown in FIGS. 7K-7N). Changing one or more aspects of the widget user interface such that, at a future time when the widget user interface is displayed, the widget user interface is displayed in accordance with changes in the one or more aspects that have been made in accordance with the one or more user inputs that met the editing criteria, in response to detecting the one or more user inputs directed to the plurality of configuration options and in accordance with a determination that the one or more user inputs meet the editing criteria, provides improved privacy by allowing the user to configure how the respective user interface is displayed (e.g., to hide or disable some widgets and/or widget content from being displayed in the widget user interface), and reduces the number of user inputs needed to access relevant application content (e.g., the computer system 100 displays relevant content (e.g., corresponding to one or more applications), as specified by the user in the configuration user interface, such that the user does not need to navigate to the one or more applications in order to display the relevant content).

In some embodiments, in a respective scenario where the respective user interface for which the respective configuration user interface is displayed is a media display user interface that displays visual media (e.g., photographs, animated photographs, and/or videos) of one or more categories, the respective configuration user interface includes (11068) one or more options for configuring which categories of visual media are to be included in the one or more categories of visual media for display in the media display user interface (e.g., options to add, remove, order, and/or group the categories of visual media and/or albums that are available to be selected for display in the media display user interface by the computer system and/or by the user's browsing input (e.g., horizontal swipes, taps on the side edges, and/or vertical swipes)). For example, in FIG. 6AC, the computer system 100 displays the editing user interface 6120, which includes a hide affordance 6132 (e.g., for removing visual media in the category 6128 from the pool of available visual media for display while the computer system 100 is in the ambient mode). Changing one or more aspects of the media display user interface such that, at a future time when the media display user interface is displayed, the media display user interface is displayed in accordance with changes in the one or more aspects that have been made in accordance with the one or more user inputs that met the editing criteria (e.g., configuring which categories of visual media are to be included in the one or more categories of visual media for display), in response to detecting the one or more user inputs directed to the plurality of configuration options and in accordance with a determination that the one or more user inputs meet the editing criteria, provides improved privacy by allowing the user to configure how the respective user interface is displayed (e.g., to hide or disable some content from being displayed in the respective user interface).

In some embodiments, in a respective scenario where the respective user interface for which the respective configuration user interface is displayed is a media display user interface that displays visual media (e.g., photographs, animated photographs, and/or videos) of one or more categories, the respective configuration user interface includes (11070) an option for excluding one or more visual media from being included in the one or more categories of visual media for display in the media display user interface (e.g., the configuration user interface for the media display user interface allows the user to select individual pieces of visual media from one or more included categories of visual media, such that those individual pieces of visual media are not selected for display in the media display user interface, even though other visual media from the same categories are selected for display in the media display user interface). For example, in FIG. 6AC, the editing user interface includes the affordance 6132, which when activated by the user input 6134, removes a specific photo from the pool of available photos for display (e.g., in a media display user interface). Changing one or more aspects of the media display user interface such that, at a future time when the media display user interface is displayed, the media display user interface is displayed in accordance with changes in the one or more aspects that have been made in accordance with the one or more user inputs that met the editing criteria (e.g., configuring options for excluding one or more photographs), in response to detecting the one or more user inputs directed to the plurality of configuration options and in accordance with a determination that the one or more user inputs meet the editing criteria, provides improved privacy by allowing the user to configure how the respective user interface is displayed (e.g., to hide or disable some content from being displayed in the respective user interface).

It should be understood that the particular order in which the operations in FIGS. 11A-11G have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 10000, 12000, 13000, 14000, 16000, and 17000) are also applicable in an analogous manner to method 11000 described above with respect to FIGS. 11A-11G. For example, the contacts, gestures, user interface objects, and/or animations described above with reference to method 11000 optionally have one or more of the characteristics of the contacts, gestures, user interface objects, and/or animations described herein with reference to other methods described herein (e.g., methods 10000, 12000, 13000, 14000, 16000, and 17000). For brevity, these details are not repeated here.

FIGS. 12A-12D are flow diagrams illustrating method 12000 for interacting with and configuring a customizable user interface, in accordance with some embodiments. Method 12000 is performed at an electronic device (e.g., device 300, FIG. 3, or portable multifunction device 80, FIG. 1A) with a display, a touch-sensitive surface, and one or more sensors to detect intensity of contacts with the touch-sensitive surface. In some embodiments, the display is a touch-screen display and the touch-sensitive surface is on or integrated with the display. In some embodiments, the display is separate from the touch-sensitive surface. Some operations in method 12000 are, optionally, combined and/or the order of some operations is, optionally, changed.

Replacing display of a first widget from a first group of widgets at a first placement location with a different widget from the first group of widgets, in response to detecting a user input that meets first switching criteria and that is directed to the first placement location, and replacing display of a second widget from a second group of widgets at a second placement location with a different widget from the second group of widgets, in response to detecting a user input that meets the first switching criteria and that is directed to the second placement location, provides additional control options without cluttering the UI with additional displayed controls (e.g., additional displayed controls for replacing display of the first widget and/or the second widget) and provides greater flexibility for displaying appropriate content (e.g., the user can replace display of the first widget, the second widget, or both the first and the second widget, as needed, rather than needing to navigate to and/or switch between different user interfaces for the first widget, the second widget, and/or widgets other than the first or second widget).

In some embodiments, the method 12000 is performed at a computer system in communication with a display generation component (e.g., a touch-sensitive display, a head-mounted display device, a display associated with a touch-sensitive surface), and one or more input devices. The computer system displays (12002) a first user interface that corresponds to a restricted state of the computer system (e.g., the first user interface is a lock screen that requires authentication information before a user can navigate to a home screen of the computer system; a wake screen (e.g., a fully-lit wake screen, or a dimmed, always-on wake screen) that does not provide access to a majority of applications installed on the computer system and that needs to be dismissed by a user in order to gain full access to the applications installed on the computer system, or another system user interface that is not a springboard, application library, or a home screen of the computer system) (e.g., the widget user interface in FIG. 7C), including: concurrently displaying (12004), in the first user interface, a first widget of a first group of widgets at a first placement location (e.g., the widget 7006 in FIG. 7C) and a second widget of a second group of widgets at a second placement location (e.g., the widget 7008 in FIG. 7C), wherein the first placement location is configured to accommodate a respective widget of the first group of widgets and the second placement location is configured to accommodate a respective widget of the second group of widgets (e.g., the first placement location and the second placement location have respective sizes that correspond to the size of one widget in their respective groups of widgets) (e.g., the widgets in the first group and the second group are separately selected by a user, and respectively correspond to different applications in a first set of application and a second set of applications); In some embodiments, the first group of widgets are arranged in a first stack following a first ordering of the first group of widgets, and the second group of widgets are arranged in a second stack following a second ordering of the second group of widgets. In some embodiments, while displaying the first user interface, in response to detecting a user input (e.g., an upward edge swipe gesture, or another dismissal input) that meets first directional criteria, the computer system navigates away from the first user interface, and displays a home screen user interface of the computer system. In some embodiments, while displaying the first user interface, in response to detecting a user input (e.g., an upward swipe gesture, or another dismissal input) that meets second directional criteria different from the first navigation criteria (e.g., a rightward swipe gesture, or another paging input), the computer system navigates away from the first user interface, and displays a widget screen user interface of the computer system. In some embodiments, while displaying the home screen user interface, in response to detecting a user input (e.g., a downward edge swipe gesture, or another coverup input) that meets a third directional criteria that is substantially opposite of the first directional criteria, the computer system brings down the first user interface to cover up the home screen user interface. In some embodiments, while displaying the widget user interface, in response to detecting a user input that meets the first directional criteria (e.g., an upward edge swipe, or another dismissal input), the computer system navigates away from the widget user interface, and displays the first user interface. While concurrently displaying, in the first user interface, the first widget of the first group of widgets at the first placement location and the second widget of the second group of widgets at the second placement location, the computer system detects (12006) (e.g., via the one or more sensors and/or input devices of the computer system) a first user input that is directed to the first user interface (e.g., the first user input includes movement in one of a plurality of directions and/or has a start location and/or end location corresponding a location within the first user interface; and the first user input is a touch gesture, an air gesture, or another type of input, that has a characteristic movement direction and/or a characteristic location). In response to detecting (12008) the first user input that is directed to the first user interface: in accordance with a determination that the first user input is directed to the first placement location within the first user interface (e.g., directed to the first widget of the first stack of widgets currently displayed at the first placement location) and that the first user input meets first switching criteria (e.g., the first user input includes a movement that meets first direction criteria, and/or the first user input is of a first input type (e.g., swipe, double tap, and/or another selected input type)) (e.g., the user input 7010 in FIG. 7C is an upward swipe input directed to the left region of the widget user interface), the computer system replaces (12010) display of the first widget with a different widget (e.g., a next widget, or another automatically selected widget) from the first group of widgets at the first placement location (e.g., while maintaining display of the second widget of the second stack of widgets at the second placement location, or irrespective of which widget is displayed at the second placement location (e.g., the second widget may be replaced due to some other mechanisms (e.g., change of context, and/or automatic rotation based on time or schedule))) (e.g., in FIG. 7D, the computer system 100 replaces display of the widget 7006 with display of the widget 7012); and in accordance with a determination that the first user input is directed to the second placement location within the first user interface (e.g., directed to the second widget of the second stack of widgets currently displayed at the second placement location) and that the first user input meets the first switching criteria (e.g., the user input 7014 in FIG. 7D is an upward swipe input in the right region of the widget user interface), the computer system replaces (12012) display of the second widget with a different widget (e.g., a next widget, or another automatically selected widget) from the second group of widgets at the second placement location (e.g., while maintaining display of the first widget of the first stack of widgets at the first placement location, or irrespective of which widget is displayed at the first placement location (e.g., the first widget may be replaced due to some other mechanisms (e.g., change of context, and/or automatic rotation based on time or schedule))) (e.g., in FIG. 7E, the computer system 100 replaces display of the widget 7008 with display of the widget 7016).

In some embodiments, at least one (e.g., some, or all) widget of the first group of widgets is selected (12014) (e.g., automatically, without the users explicit selection of the at least one widget) for inclusion in the first group of widgets by the computer system in accordance with a determination the at least one widget of the first group of widgets is included in a home screen user interface of the computer system. In some embodiments, at least one (e.g., some, or all) widget of the second group of widgets is selected (e.g., automatically, without the user's explicit selection of the at least one widget) for inclusion in the first group of widgets by the computer system in accordance with a determination the at least one widget of the second group of widgets is included in an application launch user interface (e.g., also referred to as a home screen user interface) of the computer system. In some embodiments, in accordance with a determination that a respective widget that is included in both the first group of widgets and the home screen user interface is removed from the home screen user interface in accordance with a user input, the computer system automatically removes the respective widget from the first group of widgets as well, so that the respective widget is no longer available to be displayed at the first placement location in the first user interface. For example, in FIG. 7C, the widget user interface includes the widget 7006 and the widget 7008, which are both widgets that appear in a home screen user interface of the computer system 100 (e.g., the widget 7006 in FIG. 7C is the same as the widget 7000 in FIG. 7A, and the widget 7008 in FIG. 7C is the same as the widget 7004 in FIG. 7B). Concurrently displaying, in the first user interface, a first widget of a first group of widgets at a first placement location and a second widget of a second group of widgets at a second placement location, wherein at least one widget of the first group of widgets is selected for inclusion in accordance with a determination that the at least one of widget the first group of widgets is included in a home screen user interface of the computer system, reduces the number of user inputs needed to display appropriate content (e.g., application content in a widget) (e.g., the user does not need to perform additional user inputs to unlock and/or navigate to the home screen user interface of the computer system in order to display the at least one widget and/or application content corresponding to the at least one widget).

In some embodiments, in response to detecting (12016) the first user input that is directed to the first user interface, in accordance with a determination that the first user input is directed to the first placement location within the first user interface (e.g., directed to the first widget of the first stack of widgets currently displayed at the first placement location) and that the first user input meets second switching criteria (e.g., the first user input includes a movement that meets second direction criteria, that is different from the first direction criteria (e.g., substantially opposite to the first directional criteria or otherwise different from the first directional criteria in one or more aspects)), different from the first switching criteria, the computer system replaces display of the first widget with another different widget (e.g., a previous widget, or another automatically selected widget) of the first group of widgets at the first placement location (e.g., while maintaining display of the second widget of the second stack of widgets at the second placement location, or irrespective of which widget is displayed at the second placement location (e.g., the second widget may be replaced due to some other mechanisms (e.g., change of context, and/or automatic rotation based on time or schedule))); and in accordance with a determination that the first user input is directed to the second placement location within the first user interface (e.g., directed to the second widget of the second stack of widgets currently displayed at the second placement location) and that the first user input meets the second switching criteria, the computer system replaces display of the second widget with another different widget (e.g., a previous widget, or another automatically selected widget) of the second group of widgets at the second placement location (e.g., while maintaining display of the first widget of the first stack of widgets at the first placement location, or irrespective of which widget is displayed at the first placement location (e.g., the first widget may be replaced due to some other mechanisms (e.g., change of context, and/or automatic rotation based on time or schedule))). For example, in FIG. 7E, the computer system 100 detects the user input 7018 (e.g., a swipe user input in a different direction than the user input 7014 in FIG. 7D). In FIG. 7F, in response to detecting the user input 7018, the computer system 100 replaces display of the widget 7016 with display of the widget 7008 (e.g., redisplays the widget 7008, which was initially displayed in FIG. 7D). Replacing display of the first widget with another different widget of the first group of widgets at the first placement location, in accordance with a determination that the first user input is directed to the first placement location and that the first user input meets second switching criteria, and replacing display of the second widget with another different widget of the second group of widgets at the second placement location, in accordance with a determination that the first user input is directed to the second placement location and that the first user input meets the second switching criteria, provides additional control options without cluttering the UI with additional displayed controls (e.g., separate controls for replacing display of the first widget and for replacing display of the second widget).

In some embodiments, in response to detecting (12018) the first user input that is directed to the first user interface, in accordance with a determination that the first user input meets third switching criteria (e.g., the first user input includes a movement that meets third direction criteria, that is different from the first direction criteria and/or the second directional criteria (e.g., substantially opposite to the first directional criteria or the second directional criteria, substantially perpendicular to the first directional criteria and the second directional criteria, or otherwise different from the first and second directional criteria in one or more aspects) and/or the first user input is of a second input type (e.g., two-finger swipe, light press, triple tap, and/or another selected input type)), different from the first switching criteria (and, optionally, different from the second switching criteria), the computer system replaces display of the first widget with another different widget (e.g., a previous widget, or another automatically selected widget) of the first group of widgets at the first placement location, and the computer system replaces display of the second widget with another different widget (e.g., a previous widget, or another automatically selected widget) of the second group of widgets at the second placement location (e.g., irrespective of whether the location of the first user input corresponds to the first placement location or the second placement location, or in accordance with a determination that the first user input is directed to at least one of the first placement location and the second placement location). For example, as described with reference to FIG. 7D, in some embodiments, the computer system 100 replaces display of the widget 7006 with display of the widget 7012, and the computer system 100 replaces display of the widget 7008 with display of another widget (e.g., the widget 7016 in FIG. 7E), in response to detecting the user input 7010 (e.g., the computer system 100 replaces display of all previously displayed widgets in response to single user input). Replacing display of the first widget with another different widget of the first group of widgets at the first placement location, and replacing display of the second widget with another different widget of the second group of widgets at the second placement location, in accordance with a determination that the first user input meets third switching criteria that is different from the first switching criteria, provides additional control options without cluttering the UI with additional displayed controls (e.g., separate controls for replacing display of the first widget and for replacing display of the second widget), and reduces the number of user inputs needed to replace display of the first widget and the second widget (e.g., the user only needs to perform a single input, rather than two separate inputs directed to the first placement location and the second placement location).

In some embodiments, while concurrently displaying, in the first user interface, a respective widget of the first group of widgets at the first placement location and a respective widget of the second group of widgets at the second placement location, the computer system detects (12020), via one or more sensors of the computer system, a sequence of user inputs that is directed to the first user interface. In response to detecting the sequence of user inputs that is directed to the first user interface: in accordance with a determination that the sequence of user inputs is directed to the first placement location within the first user interface and that respective inputs in the sequence of user inputs meet the first switching criteria, the computer system scrolls through multiple different widgets (e.g., some or all widgets) in the first group of widgets at the first placement location; and in accordance with a determination that the sequence of user inputs is directed to the second placement location within the first user interface and that respective inputs in the sequence of user inputs meet the first switching criteria, the computer system scrolls through different widgets in the second group of widgets at the second placement location. For example, in some embodiments, a user can continue to switch to other widgets (that have not yet been displayed) in the first group of widgets and/or the second group of widgets with additional user inputs that meet the first switching criteria (and are directed to the first placement location and the second placement location, respectively). In some embodiments, the user can switch sequentially through all widgets in the first group of widgets and/or the second group of widgets with repeated inputs that meet the first switching criteria. In some embodiments, when a user performs a user input that meets the first switching criteria and that is directed to the first placement location (or the second placement location), and when a currently displayed widget at the first placement location (or the second placement location) is a last widget (e.g., a last widget in a sequential order) from the first widget group (or the second widget group), the computer system replaces display of the last widget from the first widget group (or the second widget group) with the first widget (or the second widget) (e.g., the first widget in the sequential order). For example, in FIG. 7D, the computer system 100 replaces display of the widget 7006 in FIG. 7C, with display of the widget 7012, in response to detecting the user input 7010 in FIG. 7C. In FIG. 7G, the computer system 100 replaces display of the widget 7012 in FIG. 7F, with display of the widget 7022, in response to detecting the user input 7020 in FIG. 7F. In FIG. 7H, the computer system 100 replaces display of the widget 7022 in FIG. 7G, with display of the widget 7006 (e.g., since all available widgets for the left stack of widgets have been displayed), in response to detecting the user input 7024 in FIG. 7G. Scrolling through multiple different widgets in the first group of widgets at the first placement location, in accordance with a determination that the sequence of user inputs is directed to the first placement location, and scrolling through different widgets in the second group of widgets at the second placement location, in accordance with a determination that the sequence of user inputs is directed to the second placement location, provides additional control options without cluttering the UI with additional displayed controls (e.g., separate controls for scrolling through widgets in the first group of widgets, and for scrolling through widgets in the second group of widgets).

In some embodiments, in response to detecting (12022) the first user input, in accordance with a determination that the first user input meets mode-switching criteria (e.g., the first user input includes a movement that meets a different set of directional criteria than the first directional criteria, or the first user input is of a different input type from the first input type), the computer system replaces display of the first widget and the second widget with display of a different type of content for the first user interface (e.g., that includes content of a first type, wherein the first type of content is a type of content other than widgets) (e.g., the first user interface displaying the clock screen, media display screen, timer screen, dictation screen, and/or other screens of the ambient mode). In some embodiments, more details of the type of content for the first user interface (also referred to as the first customizable user interface, or user interfaces or screens of the ambient mode) are disclosed in FIGS. 6A-6AN and accompanying descriptions. For example, in FIG. 7H, the computer system 100 detects the user input 7026 (e.g., a leftward swipe input) directed to the widget user interface. In FIG. 71, in response to detecting the user input 7026, the computer system 100 displays the media display user interface 6098 (e.g., the computer system 100 replaces display of the widget 7006 and the widget 7008, with display of the media display user interface 6098). Replacing display of the first widget and the second widget with display of a different type of content for the first user interface, in accordance with a determination that the first user input meets mode-switching criteria, and replacing display of the first widget or second widget, in response to detecting a user input that meets first switching criteria, provides additional control options without cluttering the UI with additional displayed controls (e.g., additional displayed controls for replacing display of one or more widgets, and/or additional displayed controls for switching between displaying widget content and a different type of content).

In some embodiments, in response to detecting (12024) the first user input that is directed to the first user interface: in accordance with a determination that the first user input is directed to the first placement location within the first user interface and that the first user input meets editing criteria (e.g., the first input is of a third type that is different from the first input type and the second input type, such as a long press), the computer system displays a first editing user interface for the first placement location; and in accordance with a determination that the first user input is directed to the second placement location within the first user interface and that the first user input meets the editing criteria, the computer system displays a second editing user interface for the second placement location that is different from the first editing user interface for the first placement location. For example, in some embodiments, individual placement locations can be configured independently of one another, to include different sets of widgets, have different rotation schedules, privacy settings, and/or have different appearances. For example, in FIG. 7J, the computer system 100 detects a user input 7030 (or 7032) that meets editing criteria (e.g., is a long press input), and in response, the computer system 100 displays the editing user interface 7034 (e.g., as shown in FIG. 7K). Displaying a respective editing user interface for a respective placement location, in response to detecting a user input that is directed to the respective placement location and that meets editing criteria, and replacing display of a respective widget, in response to detecting a user input that is directed to the respective placement location and that meets switching criteria, provides additional control options without cluttering the UI with additional displayed controls (e.g., additional displayed controls for displaying the respective editing user interface, and/or additional displayed controls for replacing the respective widget).

In some embodiments, the first editing user interface includes (12026) one or more controls for editing the first group of widgets (e.g., one or more controls for adding widgets to, removing widgets from, and/or re-ordering widgets in the first group of widgets), and the second editing user interface includes one or more controls for editing the second group of widgets (e.g., one or more controls for adding widgets to, removing widgets from, and/or re-ordering widgets in the second group of widgets). For example, in FIG. 7K, the editing user interface 7034 includes options for editing a group of widgets (e.g., a first group of widgets including the widget 7006, the widget 7012, and the widget 7022). Displaying a respective editing user interface that includes one or more controls for editing a respective group of widgets at a respective placement location, in response to detecting a user input that is directed to the respective placement location and that meets editing criteria, and replacing display of a respective widget, in response to detecting a user input that is directed to the respective placement location and that meets switching criteria, provides additional control options without cluttering the UI with additional displayed controls (e.g., additional displayed controls for displaying the respective editing user interface, and/or additional displayed controls for replacing the respective widget).

In some embodiments, the first editing user interface includes (12028) one or more controls for editing the first widget (e.g., one or more controls for editing content of and/or an appearance of the first widget), and the second editing user interface includes one or more controls for editing the second widget (e.g., one or more controls for editing content of and/or an appearance of the second widget). For example, in FIG. 7K, the computer system 100 detects the user input 7054 directed to the representation 7040 (e.g., for editing the widget 7012, which corresponds to the representation 7040, as shown in FIG. 7L and FIG. 7M). Displaying a respective editing user interface that includes one or more controls for editing a respective widget of the first and second widget at a respective placement location of the first or second placement location, in response to detecting a user input that is directed to the respective placement location and that meets editing criteria, and replacing display of a respective widget, in response to detecting a user input that is directed to the respective placement location and that meets switching criteria, provides additional control options without cluttering the UI with additional displayed controls (e.g., additional displayed controls for displaying the respective editing user interface, and/or additional displayed controls for replacing the respective widget).

In some embodiments, the first editing user interface includes (12030) an option that, when enabled, causes the computer system to automatically cycle through widgets from the first group of widgets at the first placement location (e.g., change the currently displayed widget with another widget from the first group of widgets after a predetermined amount of time, such as every 1 minute, 5 minutes, 10 minutes, 30 minutes, or hour), or in response to occurrence of a condition (e.g., upon redisplay of the first user interface, or upon waking from a low-power mode after a period of inactivity, a change in the time of day, a change in weather condition, reaching a threshold window of a scheduled calendar event, receipt of a notification for an application associated with the currently displayed widget, and/or satisfaction of other conditions and/or occurrence of other events). The second editing user interface includes an option that, when enabled, causes the computer system to automatically cycle through widgets from the second group of widgets at the second placement location (e.g., change the currently displayed widget with another widget from the second group of widgets after a predetermined amount of time, such as every 1 minute, 5 minutes, 10 minutes, 30 minutes, or hour), or in response to occurrence of a condition (e.g., upon redisplay of the first user interface, or upon waking from a low-power mode after a period of inactivity, a change in the time of day, a change in weather condition, reaching a threshold window of a scheduled calendar event, receipt of a notification for an application associated with the currently displayed widget, and/or satisfaction of other conditions and/or occurrence of other events). In some embodiments, the timing for changing the widget at the first widget placement location and the timing for changing the widget at the second widget placement location are independently controlled, and are optionally, not synchronized with each other. In some embodiments, the computer system detects that a first set of conditions for switching the currently displayed widget at the first placement location is met; and in response to detecting that the first set of conditions are met, in accordance with determination that the option for automatic cycling through widgets at the first placement location is enabled, the computer system automatically selects a different widget from the first group of widgets and displays it at the first placement location, and in accordance with a determination that the option is disabled, the computer system foregoes selecting and displaying the different widget from the first group of widgets at the first placement location. In some embodiments, the computer system detects that a second set of conditions for switching the currently displayed widget at the second placement location is met; and in response to detecting that the second set of conditions are met, in accordance with determination that the option for automatic cycling through widgets at the second placement location is enabled, the computer system automatically selects a different widget from the second group of widgets and displays it at the second placement location, and in accordance with a determination that the option is disabled, the computer system foregoes selecting and displaying the different widget from the second group of widgets at the first placement location. For example, in FIG. 7K, the editing user interface 7034 includes the option 7046, which enables or disables automatic cycling of widgets that are enabled for display in the widget user interface. Displaying a respective editing user interface that includes an option for automatically cycling through widgets from a respective group of widgets at a respective placement location, in response to detecting a user input that is directed to the respective placement location and that meets editing criteria, and replacing display of a respective widget, in response to detecting a user input that is directed to the respective placement location and that meets switching criteria, provides additional control options without cluttering the UI with additional displayed controls (e.g., additional displayed controls for displaying the respective editing user interface, and/or additional displayed controls for replacing the respective widget) and reduces the number of user inputs required to display appropriate content (e.g., the user does not need to perform additional user inputs to cycle through widgets of the respective group of widgets).

In some embodiments, displaying the first widget at the first placement location includes (12032): in accordance with a determination that authentication criteria are met at the computer system (e.g., valid authentication data has been obtained, e.g., either automatically by scanning the user's face or touch, or upon request by the computer system and entry of biometric or password information), displaying the first widget with a first amount of widget content; and in accordance with a determination that the authentication criteria are not met, displaying the first widget with a second amount of widget content that is different from (e.g., less than, or missing at least some private or sensitive content of) the first amount of widget content. In some embodiments, the computer system attempts to obtain authentication data from the user in response to the user's input to switch to a different widget, raising the device, holding the device in a predetermined orientation, movement of the user into a field of view of one or more sensors of the computer system, and/or switching to display of the first widget (e.g., from a different widget that was displayed while the first widget was not displayed). In some embodiments, analogous behavior is also implemented for the second widget at the second placement location. In some embodiments, at least one widget from the first group of widgets that are available to be displayed at the first placement location and/or at least one widget from the second group of widgets that are available to be displayed at the second placement location have the same appearance and content, irrespective of the authentication state of the computer system. In some embodiments, at least one widget from the first group of widgets that are available to be displayed at the first placement location and/or at least one widget from the second group of widgets that are available to be displayed at the second placement location have different appearances and contents, depending on the authentication state of the computer system. For example, in FIG. 7T, authentication criteria are met and the computer system 100 displays the widget 7022 with a first amount of widget content (e.g., including a name and/or description of each calendar event, in addition to the times corresponding to each event). In FIG. 7Q, authentication criteria are not met, and the computer system 100 displays the widget 7022 with a second amount of widget content (e.g., only including the times corresponding to each event, without including the name or description for calendar events). Displaying the first widget with a first amount of widget content in accordance with a determination that authentication criteria are met, and displaying the first widget with a second amount of widget content that is different from the first amount of widget content, in accordance with a determination that the authentication criteria are not met, provides improved privacy by automatically displays an appropriate amount of content based on whether the authentication criteria are or are not met.

In some embodiments, while concurrently displaying, in the first user interface, a respective widget of the first group of widgets at the first placement location and a respective widget of the first group of widget at the second placement location, the computer system detects (12034) a user input that corresponds to a request to edit the first user interface (e.g., a request to display the first editing user interface for the first placement location, a request to display the second editing user interface for the second placement location, and/or a request to edit the respective widget that is currently displayed in the first placement location or the second placement location). In response to detecting the user input that corresponds to a request to edit the first user interface, the computer system initiates a process to authenticate a user that provided the user input that corresponds to the request to edit the first user interface (e.g., displaying a prompt for the user to provide authentication information, such as entering a password, touching a fingerprint sensor to provide a fingerprint, presenting face for a facial scan, or automatically initiate a biometric scan to attempt to authenticate the user). For example, in FIG. 7Q, the computer system 100 detects the user input 7080 that is a request to edit the widget 7022 (or the stack of widgets displayed in the left region of the widget user interface), and in response, the computer system 100 attempts to authenticate the user. Displaying the first widget with a first amount of widget content in accordance with a determination that authentication criteria are met, and displaying the first widget with a second amount of widget content that is different from the first amount of widget content, in accordance with a determination that the authentication criteria are not met, and initiating a process to authenticate a user that provides a user input that corresponds to a request to edit the first user interface, provides improved privacy by automatically displays an appropriate amount of content based on whether the authentication criteria are or are not met and reduces the number of user inputs needed to display appropriate content (e.g., the user does not need to perform additional user inputs to initiate authentication).

In some embodiments, in response to detecting (12036) the first user input that is directed to the first user interface, in accordance with a determination that the first user input meets the first switching criteria (and/or the first user input meets the second switching criteria), the computer system initiates a process to authenticate a user that provided the first user input (e.g., displaying a prompt for the user to provide authentication information, such as entering a password, touching a fingerprint sensor to provide a fingerprint, presenting face for a facial scan, or automatically initiate a biometric scan to attempt to authenticate the user), wherein replacing display of the first widget or replacing display of the second widget is performed after completion of the process to authenticate the user that provided the first user input. For example, as described with reference to FIG. 7T, the computer system 100 may attempt to authenticate the user any time the computer system 100 displays a widget for which additional content can be displayed (e.g., when the computer system 100 switches to displaying a widget for which additional content can be displayed). Displaying the first widget with a first amount of widget content in accordance with a determination that authentication criteria are met, and displaying the first widget with a second amount of widget content that is different from the first amount of widget content, in accordance with a determination that the authentication criteria are not met, and initiating a process to authenticate a user that provides a user input that that meets switching criteria, provides improved privacy by automatically displays an appropriate amount of content based on whether the authentication criteria are or are not met and reduces the number of user inputs needed to display appropriate content (e.g., the user does not need to perform additional user inputs to initiate authentication).

In some embodiments, prior to replacing display of the first widget or the second widget in the first user interface in response to detecting the first user input, the computer system authenticates (12038) a user that provided the first user input, including: detecting interaction between the user and the computer system (e.g., a tap, swipe, long press, and/or double tap on the touch-sensitive display of the computer system; a change in physical orientation of the computer system (e.g., when a user raises and/or rotates the computer system); and/or detected movement of the user to within a threshold distance of the computer system); and in response to detecting the interaction between the user and the computer system, initiating a process to authenticate the user that interacted with the computer system (e.g., displaying a prompt for the user to provide authentication information, such as entering a password, touching a fingerprint sensor to provide a fingerprint, presenting face for a facial scan, or automatically initiate a biometric scan to attempt to authenticate the user). In some embodiments, in response to detecting the interaction between the user and the computer system, the computer system determines an authentication state of the computer system based on authentication data obtained through the process to authenticate the user. In accordance with a determination that the authentication data is valid, the computer system enables replacement of the first widget and/or the second widget at the first and/or second placement location(s) in response to detecting the first user input when the first switching criteria are met by the first user input. In accordance with a determination that the authentication data is not valid, the computer system remains in an unauthenticated state and does not permit replacement of the first widget and/or the second widget at the first and/or second placement locations in response to detecting the first user input, even if other requirements of the first switching criteria are met. For example, as described with reference to FIG. 7T, the computer system 100 may attempt to authenticate the user when it detects that the user is interacting with the computer system 100 (e.g., the user touches the computer system 100, the user is within a field of view of a sensor of the computer system 100, and/or the user lifts or rotates the computer system 100 or a display of the computer system 100). Displaying the first widget with a first amount of widget content in accordance with a determination that authentication criteria are met, and displaying the first widget with a second amount of widget content that is different from the first amount of widget content, in accordance with a determination that the authentication criteria are not met, and initiating a process to authenticate a user in response to detecting interaction between the user and the computer system, provides improved privacy by automatically displays an appropriate amount of content based on whether the authentication criteria are or are not met and reduces the number of user inputs needed to display appropriate content (e.g., the user does not need to perform additional user inputs to initiate authentication).

In some embodiments, the widgets described above with reference to FIGS. 12A-12D, are the same (and/or have analogous behavior to) the widgets in the widget user interface 5078 described with reference to FIG. 5S (e.g., the first user interface of the method 12000 is the widget user interface 5078 in FIG. 5S) (e.g., the calendar widget and the notes widget in the widget user interface of FIGS. 5S, are the same as the widget 7022 in FIG. 7G and the widget 7012 in FIG. 7D). In some embodiments, a user of the computer system can switch from displaying the first user interface of the method 12000, to displaying a different user interface that includes a different type of content (e.g., other than widget content), through user inputs as described with reference to FIGS. 6A-6AN (e.g., left or right swipe inputs, allow the user to navigate between different types of content, and one of the types of content is widget content).

It should be understood that the particular order in which the operations in FIGS. 12A-12D have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 10000, 11000, 13000, 14000, 16000, and 17000) are also applicable in an analogous manner to method 12000 described above with respect to FIGS. 12A-12D. For example, the contacts, gestures, user interface objects, and/or animations described above with reference to method 12000 optionally have one or more of the characteristics of the contacts, gestures, user interface objects, and/or animations described herein with reference to other methods described herein (e.g., methods 10000, 11000, 13000, 14000, 16000, and 17000). For brevity, these details are not repeated herc.

FIGS. 13A-13J are flow diagrams illustrating method 13000 for interacting with different user interfaces of, and switching between, different operational modes (e.g., ambient modes), in accordance with some embodiments. Method 13000 is performed at an electronic device (e.g., device 300, FIG. 3, or computer system 100, FIG. 1A) with a display, a touch-sensitive surface, and one or more sensors to detect intensity of contacts with the touch-sensitive surface. In some embodiments, the display is a touch-screen display and the touch-sensitive surface is on or integrated with the display. In some embodiments, the display is separate from the touch-sensitive surface. Some operations in method 13000 are, optionally, combined and/or the order of some operations is, optionally, changed.

Ceasing to display a respective user interface object and redisplay a first user interface, in response to detecting a first user input and in accordance with a determination that the first user interface is a first type of user interface, and ceasing to display the respective user interface object and displaying a second user interface different from the first user interface, in response to detecting the first user input and in accordance with a determination that the first user interface is a second type of user interface that is different from the first type of user interface, automatically displays the appropriate user interface without requiring additional user inputs (e.g., the user does not need to perform a first user input to first cease to display the respective user interface object and display the first user interface, and then perform a second user input to cease to display the first user interface and display the second user interface).

In some embodiments, the method 13000 is performed at a computer system in communication with a display generation component and one or more sensors. While displaying a first user interface (e.g., a user interface of a normal mode or a user interface of the ambient mode) (e.g., the home screen user interface in FIG. 8A), the computer system detects (13002) that one or more conditions for displaying a respective user interface object of a first object type are met (e.g., detecting that conditions for displaying a session user interface object are met (e.g., the session user interface object is displayed in response to user's request, or in response to detecting contextual conditions meeting session starting criteria)), wherein the respective user interface object of the first type of user interface object (e.g., a respective full-screen session user interface, and/or a user interface object corresponding to a respective session) corresponds to a respective application (e.g., a telephony application, a messaging application, a delivery service application, a ride-share application, a navigation application, a sport game application, and/or other applications) and provides status information that is updated over time (e.g., in real-time or substantially real-time as the update occurs) in the respective user interface object without requiring display of the respective application (e.g., session user interface object is different from, and may exist separately from, a full user interface of the application itself) (e.g., the computer system 100 displays the user interface 8000, which provides status information regarding currently playing music in a music application of the computer system 100). For example, in some embodiments, the computer system detects occurrence of a time-sensitive event (e.g., an urgent notification, an emergency alert, an update from a subscribed live event, and/or other time-sensitive updates), and displays a notification or alert regarding the time-sensitive event on top of the first user interface or replacing the first user interface. In some embodiments, the computer system detects that an event for which content should be persistently or periodically displayed is ongoing (e.g., a boarding pass is persistently displayed while the current time is near a boarding time for a flight, a score board is persistently displayed during a live sports event, and is updated in real-time or substantially real-time during the live sports event. Other examples of the respective user interface object include session user interface displaying tracking information or delivery updates for a package delivery, a food delivery, ride-sharing, and/or other services, in real-time or in substantially real-time). In some embodiments, the respective user interface object includes updated information and affordances for a navigation session, a real-time communication session, or a media playback session. In some embodiments, the respective user interface object is chosen and displayed at a respective location in accordance with a determination that the one or more display conditions that correspond to the respective user interface object are met. In response to detecting that the one or more conditions for displaying the respective user interface object of the first object type are met, the computer system displays (13004) the respective user interface object (e.g., overlaying the first user interface, or replacing display of the first user interface). While displaying respective user interface object (and updating content of the respective user interface object, e.g., in accordance with updates received from the respective application), the computer system detects (13006) (e.g., via the one or more sensors and/or input devices of the computer system) a first user input that corresponds to a request to dismiss the respective user interface object (e.g., a dismissal input, an upward edge swipe gesture, a press on a home button, an air gesture for navigating to the home screen, a request to dismiss a currently displayed full-screen user interface, and/or an input that corresponds to a request to navigate to a home screen user interface from a currently displayed user interface) (E.g., the user input 8002 in FIG. 8A, or the user input 8014 in FIG. 8G). In response to detecting (13008) the first user input that corresponds to a request to dismiss the respective user interface object: in accordance with a determination that the first user interface is a first type of user interface (e.g., a user interface of an ambient mode that is associated with a respective application, where the ambient mode is activated in response to satisfaction of a set of conditions (e.g., as described above with reference to FIGS. 5G-5M), the computer system ceases (13010) to display the respective user interface object and redisplaying the first user interface (e.g., the respective user interface previously covered the entirety or substantially the entirety of the first user interface, or replaced display of the first user interface in response to the first set of conditions being met, but the computer system remained in the ambient mode) (e.g., the computer system 100 redisplays the media display user interface 6162 in FIG. 8H); and in accordance with a determination that the first user interface is a second type of user interface (e.g., a wake screen user interface, a lock screen user interface, and/or a system user interface that corresponds to a restricted state of the computer system), different from the first type of user interface, the computer system cease (13012) to display the respective user interface object and displaying a second user interface that is different from the first user interface at a location that was previously occupied by the first user interface (e.g., the second user interface replaces some or all of the first user interface, and optionally without dismissing the first user interface object) (e.g., the second user interface is a home screen user interface, or an application user interface corresponding to an application that was recently in use (e.g., the last application in use prior to the computer system)) (e.g., in FIG. 8B, the computer system 100 displays the top row of application icons that was not previously displayed in FIG. 8A). For example, in some embodiments, the respective user interface object is displayed as a user interface object that partially overlays or replaces a portion of the user interface of the second type (e.g., a home screen user interface, an application user interface, or another user interface that is not a user interface of the ambient mode), and a user input that corresponds to a request to dismiss the currently displayed user interface (e.g., an upward edge swipe gesture, a press on the home button, or another input that corresponds to a request to dismiss the currently displayed user interface), causes the first user interface to be dismissed and causes the home screen user interface or last displayed application user interface to be displayed (e.g., with the respective user interface object overlaying or replacing a portion of the home screen user interface or the last displayed application user interface). In contrast, in some embodiments, the respective user interface object is displayed as a full-screen user interface object that completely overlays or replaces the user interface of the first type (e.g., a user interface of the ambient mode, and/or a customizable user interface that is displayed when a first set of conditions are met), and a user input that corresponds to a request to dismiss the currently displayed user interface (e.g., an upward edge swipe gesture, a press on the home button, or another input that corresponds to a request to dismiss the currently displayed user interface), causes the full-screen user interface object to be dismissed (and optionally reduced to a smaller version of the respective user interface object) and causes the user interface of the first type (e.g., the user interface of the ambient mode, or the first customizable user interface) to be displayed (e.g., with the respective user interface object overlaying or replacing a portion of the user interface of the first type).

In some embodiments, the request to dismiss the respective user interface object includes (13014) an upward swipe from a bottom edge of the computer system toward a top edge of the computer system (e.g., from a bottom edge of a touch-screen display of the computer system toward a top edge of the touch-screen display of the computer system, from a location on a touch-sensitive surface that corresponds to a bottom edge of a currently displayed user interface toward a location that corresponds to a top edge of the currently displayed user interface, and/or an air gesture that starts while a gaze input is directed to a bottom edge of the currently displayed user interface and that includes an upward flick or swipe movement). For example, in FIG. 8G, the computer system 100 detects the user input 8014 (e.g., an upward swipe input from a bottom edge toward a top edge of the computer system 100), and in response (e.g., as shown in FIG. 8H), the computer system 100 displays the media display user interface 6162. For example, as described with reference to FIG. 8I, while displaying the user interface 8010, in response to detecting an analogous user input to the user input 8014 in FIG. 8G, the computer system 100 redisplays the media display user interface 6162 (e.g., that was displayed prior to displaying the user interface 8010 in FIG. 8I). Ceasing to display a respective user interface object and redisplay a first user interface, in response to detecting a first user input and in accordance with a determination that the first user interface is a first type of user interface, and ceasing to display the respective user interface object and displaying a second user interface different from the first user interface, in response to detecting the first user input and in accordance with a determination that the first user interface is a second type of user interface that is different from the first type of user interface, automatically displays the appropriate user interface without requiring additional user inputs (e.g., the user does not need to perform a first user input to first cease to display the respective user interface object and display the first user interface, and then perform a second user input to cease to display the first user interface and display the second user interface).

In some embodiments, the second user interface is (13016) an application user interface of a last-displayed application prior to displaying the first user interface. This is described with reference to FIGS. 8A and 8B, where in some embodiments, the computer system 100 displays an application user interface (e.g., and the user interface 8000 is displayed overlaid over a portion of the application user interface) in FIG. 8A, and a portion of the application user interface that was previously overlaid by the user interface 8000 is displayed in FIG. 8B (e.g., in response to detecting the user input 8002 in FIG. 8A). Ceasing to display a respective user interface object and redisplay a first user interface, in response to detecting a first user input and in accordance with a determination that the first user interface is a first type of user interface, and ceasing to display the respective user interface object and displaying an application user interface of a last-displayed application prior to displaying the first user interface, in response to detecting the first user input and in accordance with a determination that the first user interface is a second type of user interface that is different from the first type of user interface, automatically displays the appropriate user interface without requiring additional user inputs (e.g., the user does not need to perform a first user input to first cease to display the respective user interface object and display the first user interface, and then perform a second user input to cease to display the first user interface and display the second user interface).

In some embodiments, the second user interface is (13018) a home screen user interface that includes one or more application icons for launching applications of the computer system. For example, in FIG. 8B, the computer system 100 displays a second user interface that is a home screen user interface of the computer system 100, in response to detecting the user input 8002 directed to the user interface 800 (as shown in FIG. 8A). Ceasing to display a respective user interface object and redisplay a first user interface, in response to detecting a first user input and in accordance with a determination that the first user interface is a first type of user interface, and ceasing to display the respective user interface object and displaying home screen user interface that includes one or more application icons for launching applications of the computer system, in response to detecting the first user input and in accordance with a determination that the first user interface is a second type of user interface that is different from the first type of user interface, automatically displays the appropriate user interface without requiring additional user inputs (e.g., the user does not need to perform a first user input to first cease to display the respective user interface object and display the first user interface, and then perform a second user input to cease to display the first user interface and display the second user interface).

In some embodiments, displaying the respective user interface object in response to detecting that the one or more conditions for displaying the respective user interface are met, includes (13020): in accordance with a determination that a first set of one or more conditions are met, displaying a first user interface object that corresponds to a first application (e.g., sports app, timer app, navigation app, or another application) and provides first status information that is updated over time in the first user interface object (e.g., scores, running time, navigation prompts, or other status updates) without requiring display of the first application; and in accordance with a determination that a second set of one or more conditions, different from the first set of conditions, are met, displaying a second user interface object (e.g., call status information, media playing information, or other status updates), different from the first user interface object, that corresponds to a second application (e.g., a telephony application, a media player application, or another application), different from the first application, and provides second status information that is updated over time (e.g., call time and call status; play time, title, and play/pause status, or other status updates) in the second user interface object without requiring display of the second application. For example, in FIG. 8A, the user interface 8000 provides status information relating to a currently playing song in a music application of the computer system 100. Displaying a first user interface object that corresponds to a first application and provides first status information that is updated over time in the first user interface object without requiring display of the first application, in response to detecting that a first set of one or more conditions are met, and displaying a second user interface object that corresponds to a second application and provides second status information that is updated over time in the second user interface object without requiring display of the second application, in response to detecting that a second set of one or more conditions are met, automatically displays the appropriate user interface object when a respective set of one or more conditions is met, without requiring additional user inputs (e.g., additional user inputs to display the first user interface object, to display the second user interface object, and/or to switch from displaying the first user interface object to displaying the second user interface object (or vice versa).

In some embodiments, detecting the one or more conditions for displaying the respective user interface object includes (13022) detecting a user selection of an indication of the respective user interface object that is displayed with the first user interface (e.g., a tap or other selection input on an alert or pop-up for the respective user interface object displayed overlaying or concurrently with the first user interface). For example, in some embodiments, the respective user interface object is an expanded version of the indication of the respective user interface object, occupying more display area than the indication of the respective user interface object and optionally includes more information or controls than the indication of the respective user interface object. For example, in FIG. 8E, the computer system 100 displays the user interface 8000 in response to detecting the user input 8006 directed to the user input 8004 in FIG. 8D. Displaying the respective user interface object, in response to detecting a user selection of an indication of the respective user interface object that is displayed with the first user interface, enables the computer system to display appropriate content without requiring permanent display of content (e.g., the respective user interface object need not be permanently displayed, but can be displayed in response to detecting user selection of an indication).

In some embodiments, displaying the respective user interface object in response to detecting that the one or more conditions for displaying the respective user interface object of the first object type are met, includes (13024): in accordance with a determination that the first user interface is the first type of user interface (e.g., the first user interface is a media player user interface, a navigation user interface, or another example of a first type of user interface), displaying the respective user interface object with a first appearance (e.g., with the status information in a first layout, and/or with a first level of detail for the status information); and in accordance with a determination that the first user interface is the second type of user interface (e.g., the first user interface is a sports game user interface, a delivery update user interface, or another example of a second type of user interface), displaying the respective user interface object with a second appearance, different from the first appearance (e.g., the status information is provided in a second layout that is different than the first layout, and/or with a second level of detail different from the first level of detail). In some embodiments, the respective user interface object with the first appearance is a full-screen user interface object that replaces display of the first user interface of the first type of user interface, and the respective user interface object with the second appearance is not a full-screen user interface, and does not replace display of the first user interface of the second type of user interface (e.g., overlays a portion of the first user interface of the second type). For example, in FIG. 8A, the user interface 8000 has a first appearance (e.g., an appearance that includes album art, a song title, and artist name, a rewind, a fast forward, and a pause affordance), and in FIG. 8G, the user interface 8010 has a different appearance from the user interface 8000 (e.g., and the user interface 8010 is the user interface 8000, but displayed with the different appearance) (e.g., the user interface 8010 includes the album art, the song title, the artist name, a rewind affordance, a fast forward affordance, and a pause affordance, similar to the user interface 8000, but also includes a progress bar that indicates a length of the song and how far playback has progressed, and the volume slider 8013, which were not included in the user interface 8000). Displaying the respective user interface object with a first appearance, in accordance with a determination that the first user interface is a first type of user interface, and displaying the respective user interface object with a second appearance that is different from the first appearance, in accordance with a determination that the first user interface is a second type of user interface that is different from the first type of user interface, provides improved visual feedback to the user (e.g., improved visual feedback regarding whether the first user interface is a user interface of a first type or a second type).

In some embodiments, in response to detecting (13026) the first user input that corresponds to a request to dismiss the respective user interface object: in accordance with a determination that the first user interface is the first type of user interface, the computer system displays a first indication that corresponds to the respective user interface object (e.g., shrinking the respective user interface object into a session region on the display (e.g., a top center region in the landscape orientation, or another session region on the display), with reduced content and size in the first indication), concurrently with the first user interface after the first user interface is redisplayed; and in accordance with a determination that the first user interface is the second type of user interface, the computer system displays a second indication that corresponds to the respective user interface object (e.g., shrinking the respective user interface object into a different session region on the display (e.g., a top center region in the portrait orientation, or another session region on the display), with reduced content and size in the second indication), concurrently with the second user interface after the second user interface is displayed. In some embodiments, the first indication and the second indication have the same content and/or appearance. In some embodiments, the first indication and the second indication have different content and/or appearances. In some embodiments, the first indication and the second indication are displayed at different portions of the display, with different spatial relationships to the currently displayed user interface. For example, in FIG. 8B, the computer system 100 displays the user interface 8004, which is a visual indication corresponding to the user interface 8000 displayed in FIG. 8A. Similarly, in FIG. 8H, the computer system 100 displays the user interface 8016, which is a visual indication corresponding to the user interface 8010 in FIG. 8G. Concurrently displaying a first indication that correspond to the respective user interface object and the first user interface, in accordance with a determination that the first user interface is the first type of user interface, and concurrently displaying a second indication that corresponds to the respective user interface object with the second user interface, in accordance with a determination that the first user interface is the second type of user interface, provides improved visual feedback to the user (e.g., improved visual feedback regarding whether the first user interface is a user interface of a first type or a second type).

In some embodiments, the first type of user interface object includes (13028) a first user interface object that corresponds to a media player application (e.g., a music player or a video player) and the first user interface object provides status information regarding ongoing media play using the media player application. For example, in some embodiments, the first user interface object is the respective user interface object described herein. For example, in FIG. 8A, the user interface 8000 corresponds to a music application (e.g., a media player application) of the computer system 100. Similarly, the user interface 8010 in FIG. 8G corresponds to the same music application. Displaying a first user interface object that corresponds to a media player application, and that provides status information regarding ongoing media play using the media player application, in response to detecting that the one or more conditions for displaying the first user interface object are met, provides improved visual feedback to the user (e.g., improved visual feedback regarding the ongoing media play), and reduces the number of user inputs needed to provide status information regarding ongoing media play (e.g., the user does not need to navigate back to the media player application each time the user needs status information regarding ongoing media play).

In some embodiments, the first user interface object includes (13030) one or more media playback controls (e.g., a play, pause, stop, fast forward, rewind, volume, seeking (e.g., a scrubber or scrub bar, for navigating to a particular time or time stamp of music and/or video content), next media item, and/or previous media item control) of the media player application. In some embodiments, while displaying the first user interface that includes a first user interface object that corresponds to a media player application (e.g., a music player or a video player), and the first user interface object includes the one or more media playback controls, the computer system detects a user input that corresponds to a request to select and/or adjust a first media playback control of the one or more media playback controls; and in response to detecting the user input, the computer system performs an operation with respect to media content presented in the first user interface in accordance with the selection and/or adjustment of the first media playback control (e.g., selection of a play/pause control causes playing/pausing the media content that is currently presented in the first user interface, selection of the fast forward control causes fast forwarding of the playback of the media content that is being played in the first user interface, and/or selection and dragging a scrubber control causes scrubbing through a portion of the currently played media content in accordance with the drag input). For example, in FIG. 8A, the user interface 8000 includes media playback controls (e.g., a rewind, fast forward, play, pause, and/or stop control). Similarly, the user interface 8010 in FIG. 8G includes analogous media playback controls (e.g., and also includes the volume slider 8013). Displaying the first user interface object that correspond to the media player application, including one or more media playback controls, in response to detecting that the one or more conditions for displaying the first user interface object are met, reduces the number of user inputs needed for a user to interact with the media player application (e.g., the user can interact with the media player application via the one or more media playback controls, without needing to perform additional user inputs to navigate to the media player application).

In some embodiments, the first user interface object includes (13032) one or more controls for browsing media items that are available to be played (e.g., in the respective user interface object) using the first user interface object. In some embodiments, while displaying the first user interface that includes a first user interface object that corresponds to a media player application (e.g., a music player or a video player), and the first user interface object includes a respective control for browsing available media, such as an affordance for displaying a listing of media titles or navigating to a next media item in an album or library, the computer system detects a user input that corresponds to a request to invoke the respective control; and in response to detecting the user input, the computer system displays and/or play a next set of one or more media items that are available to be played using the first user interface and/or navigate to a listing of available media items. For example, as described with reference to FIG. 8I, in some embodiments, the user interface 8010 includes an affordance (e.g., in the lower left corner of the user interface 8010) for browsing media items that are available to be played by a music application of the computer system 100. Displaying the first user interface object that correspond to the media player application, including one or more controls for browsing media items that are available to be played using the first user interface object, in response to detecting that the one or more conditions for displaying the first user interface object are met, reduces the number of user inputs needed for a user to interact with the media player application (e.g., the user can browse through media items without needing to perform additional user inputs to navigate to the media player application).

In some embodiments, the first user interface object includes (13034) respective representations of media items that are available to be played using the first user interface object in a browsable arrangement, wherein the computer system cycles through at least some of the respective representations of media items one by one at a selection position in the first user interface object, in response to detecting one or more browsing inputs that corresponds to a request to browse through the media items in a first direction (e.g., horizontal swipes, vertical swipes, taps on a left or right browsing control, and/or other browsing inputs that specify a navigation direction). In some embodiments, the representations of media items include album art for media content (e.g., music albums, songs, and other media content), and the computer system sequentially present the album art of the available media items in a selection position (e.g., a central portion of an album art presentation area, or selection box over a respective item in a listing of media items, a front position of a rotating carousel holding the album art) in response to detecting one or more browsing inputs in a respective browsing direction. For example, in FIG. 8J, the representation 8024, the representation 8026, and the representation 8028, correspond to songs (e.g., media items) and are arranged in a browsable carousel. Displaying the first user interface object that corresponds to the media player application, including representations of media items that are available to be played, arranged in a browsable arrangement, in response to detecting that the one or more conditions for displaying the first user interface object are met, and cycling through at least some of the respective representations of media items one by one at a selection position in the first user interface object, in response to detecting one or more browsing inputs that corresponds to a request to browse through the media items in a first direction, reduces the number of user inputs needed for a user to interact with the media player application (e.g., the user can browse through media items without needing to perform additional user inputs to navigate to the media player application).

In some embodiments, the first user interface object includes (13036) a progress indication that updates over time in accordance with playback progress of a respective media items that is being played back using the first user interface object. In some embodiments, while displaying the progress indication in the first user interface object, the computer system detects a user input that is directed to the progress indication and changes a current playback position indicated using the progress indication (e.g., the user input is a tap-hold and drag input directed to a playback position indicator on a slider control, or the user input is a pinch and drag input directed to the progress indication); and in response to detecting the user input, the computer fast forward or rewind through the media item in accordance with the user input (e.g., in a direction and/or by an amount and/or speed that correspond to the direction, magnitude, and/or speed of the user input). For example, in FIG. 8G, the user interface 8010 includes a progress indication that updates over time, in accordance with playback progress of a currently playing song (e.g., the currently playing song has been playing for 15 seconds, with 3 minutes and 6 seconds remaining). Displaying the first user interface object that correspond to the media player application, including one or more controls for browsing media items that are available to be played using the first user interface object and including a progress indication that updates overtime in accordance with playback progress of a respective media items that is being played back using the first user interface object, in response to detecting that the one or more conditions for displaying the first user interface object are met, reduces the number of user inputs needed for a user to interact with the media player application (e.g., the user can browse through media items without needing to perform additional user inputs to navigate to the media player application) and provides improved visual feedback to the user (e.g., improved visual feedback regarding playback progress of the respective media items being played back using the first user interface object).

In some embodiments, the first type of user interface object includes (13038) a second user interface object that corresponds to a timer application, and provides timer progress information for a first timer of the timer application in the second user interface object (e.g., a progress bar or other visual indication of the time remaining for the timer, where the visual indication updates over time after the timer is started and running). For example, in some embodiments, the second user interface object is the respective user interface object described herein. For example, in FIG. 5AE, the computer system 100 displays the user interface 5118, which corresponds to an active timer (e.g., of a clock, timer, or stopwatch application of the computer system 100), and which includes a visual representation of the current time remaining for the active timer (e.g., timer progress information). Displaying a second user interface object that corresponds to a timer player application, and that provides timer progress information for a first timer of the timer application in the second user interface object, in response to detecting that the one or more conditions for displaying the second user interface object are met, provides improved visual feedback to the user (e.g., improved visual feedback regarding the first timer), and reduces the number of user inputs needed to provide timer progress information for the first timer (e.g., the user does not need to navigate back to the timer application each time the user wants to check timer progress for the first timer).

In some embodiments, the second user interface object includes (13040) one or more controls (e.g., a start, pause, and/or stop control) for interacting with the first timer of the timer application. The computer system detects, via the one or more sensors, a respective user input directed to a first control of the one or more controls for interacting with the first timer of the timer application. In response to detecting the respective user input directed to the first control, the computer system performs an operation with respect to the first timer (e.g., starting the first timer, pausing the first timer, or stopping the first timer, depending on whether the first control is a start control, a pause control, or a stop control). For example, in FIG. 5AE, the computer system 100 displays the user interface 5118, which includes a pause affordance and a stop affordance (e.g., controls for interacting with the first timer). Displaying the second user interface object that correspond to the timer application, including one or more controls for interacting with the first time of the timer application, in response to detecting that the one or more conditions for displaying the second user interface object are met, and performing an operation with respect to the first time in response to detecting a respective user input directed to a first control of the one or more controls, reduces the number of user inputs needed for a user to interact with the first timer and/or the timer application (e.g., the user can interact with the first timer and/or the timer application via the second user interface object, without needing to perform additional user inputs to navigate to the timer application).

In some embodiments, the second user interface object includes (13042) a progress indicator that indicates a current remaining time for the first timer (e.g., a progress bar that indicates the current remaining time relative to the total or initial time for the timer), wherein the progress indicator updates over time to indicate different amounts of remaining time for the first timer after the first timer is started. For example, in FIG. 5AE, the computer system 100 displays the user interface 5118, which includes a visual representation (e.g., a grey region) of the remaining time for the active timer. Displaying the second user interface object that correspond to the timer application, including a progress bar that indicates a current remaining time for the first timer and that updates over time to indicate different amounts of remaining time for the first time after the first time is started, in response to detecting that the one or more conditions for displaying the second user interface object are met, provides improved visual feedback to the user (e.g., improved visual feedback regarding a current status of an active timer).

In some embodiments, the second user interface object concurrently includes (13042) respective progress indicators corresponding to multiple timers of the timer application (e.g., with progress updated concurrently for multiple timers). In some embodiments, the progress indicators bar respectively update over time to indicate respective amounts of remaining time for the multiple timers (e.g., a first progress indicator updates over time to show different amounts of time remaining for the first timer after the first timer is started, and a second progress indicator updates over time to show different amounts of time remaining for the second timer after the second timer is started, where the first timer and the second timer are optionally concurrently running, with one timer running and the other timer stopped (and not updating over time during the period of time that the timer is stopped). For example, as described with reference to FIG. 5AA, in some embodiments, the user interface 5118 includes content corresponding to a plurality of active timers (e.g., visual representations of and/or controls for interacting with a plurality of active timers). Displaying the second user interface object that correspond to the timer application, including respective progress indicators corresponding to multiple timers of the timer application, in response to detecting that the one or more conditions for displaying the second user interface object are met, provides improved visual feedback to the user (e.g., improved visual feedback regarding the multiple timers of the timer application).

In some embodiments, the first type of user interface object includes (13044) a third user interface object that corresponds to a virtual assistant application. The computer system detects, via the one or more sensors, one or more voice commands that are directed to the virtual assistant application (e.g., voice commands that correspond to a question, a request to perform an operation (e.g., sending a message, starting a timer, or performing another operation using another application), and/or another request to display content or change a state of the computer system, optionally started with a trigger word to invoke the virtual assistant application (e.g., “Hey, Assistant!” “Lisa assistant,” or another trigger word)). In response to detecting the one or more voice commands, the computer system provides visual feedback regarding the voice commands in the third user interface object (e.g., visual indication of speech input that is detected, and responses to the voice command that is detected). For example, in some embodiments, the visual feedback includes animated patterns and colors that change with a rhythm that corresponds to the characteristics (e.g., volume, speed, and/or change in tone and/or change in pitch) of the speech input that is being detected. In some embodiments, the visual characteristics (e.g., color, animated movements, brightness, size, direction of movement, and/or other characteristics) of the visual feedback change in accordance with a state of the interaction between the virtual assistant and the user (e.g., a respective state among a plurality of states corresponding to a command detection state, a command processing state, an answer state, an action performance state, a completion state, and/or other assistant states). In some embodiments, the third user interface object is the respective user interface object described herein. For example, as described with reference to FIG. 8A, in some embodiments, the respective application is a virtual assistant application (e.g., and the user interface 800 provides visual feedback regarding voice commands directed to the virtual assistant). Displaying a third user interface object that corresponds to a virtual assistant application, and that provides visual feedback regarding voice commands received from a user in the third user interface object, in response to detecting that the one or more conditions for displaying the third user interface object are met, provides improved visual feedback to the user (e.g., improved visual feedback regarding received and/or detected voice commands).

In some embodiments, the first type of user interface object includes (13046) a fourth user interface object that corresponds to a communication application. The computer system determines a current status of a first communication session supported by the communication application. In accordance with the current status in the first communication session, the computer system provides status information regarding the current status of the first communication session (e.g., visual indication of an ongoing real-time communication (e.g., the type, the duration, and/or the caller of the ongoing real-time communication session), an indication of an incoming communication request (e.g., type, and caller), and, optionally, along with one or more controls for controlling the first communication session (e.g., pause, accept, end, or other operations of the first communication session)) in the fourth user interface object. For example, in some embodiments, the fourth user interface object is the respective user interface object described herein. For example, as described with reference to FIG. 8A, in some embodiments, the respective application is a communication application (e.g., and the user interface 8000 provides status information regarding an activate communication session supported by the communication application). Displaying a fourth user interface object that corresponds to a communication application, and that provides status information regarding a communication session supported by the communication application, in response to detecting that the one or more conditions for displaying the fourth user interface object are met, provides improved visual feedback to the user (e.g., improved visual feedback regarding status information for the communication session), and reduces the number of user inputs needed to provide status information regarding the communication session (e.g., the user does not need to navigate back to the communication application each time the user wants to see status information regarding the communication session).

In some embodiments, the communication application corresponds (13048) to an electronic doorbell device (e.g., determining the current status of the first communication session includes detecting activation of the doorbell device from outward facing portion of the doorbell device, detecting a status check request for the doorbell device (e.g., lock, camera, battery, or other components of the doorbell device) from a user of the computer system, and displaying the status information for the first communication session includes displaying camera view of the caller, displaying identity of the caller, and/or displaying status of the components of the doorbell device). The computer system displays one or more controls for controlling the electronic doorbell device in the fourth user interface object, and the computer system detects a respective user input that activates a first control of the one or more controls for controlling the electronic doorbell device (e.g., a tap input directed to the first control, a light press input directed to the first control, or another type of selection input directed to the first control). In response to detecting the respective user input that activates the first control of the one or more controls, the computer system performs a respective operation with respect to the electronic doorbell device (e.g., enabling a user of the computer system to communicate with the electronic doorbell device (e.g., seeing a video feed of a person who is at and/or interacting with the electronic doorbell device, and/or establishing a video or voice communication session with the person via the fourth user interface object and the electronic doorbell device)). For example, as described with reference to FIG. 8A, in some embodiments, the respective application is a communication application that corresponds to an electronic doorbell device (e.g., and the user interface 8000 enables the user of the computer system to communication with, interact with, and/or control the electronic doorbell device). Displaying a fourth user interface object that corresponds to a communication application that enables the computer system to communicate with an electronic doorbell device, in response to detecting that the one or more conditions for displaying the fourth user interface object are met, and performing a respective operation with respect to the electronic doorbell device in response to detecting a respective user input that activates a first control of one or more controls, provides improved visual feedback to the user (e.g., improved visual feedback regarding the electronic doorbell device.

In some embodiments, the communication application is (13050) a telephony application that supports real-time communication calls between a user of the computer system and other users (e.g., the current status is a status of an ongoing telephone call, and the status information displayed in the fourth user interface object includes a type, a duration, and/or a caller of the phone call). The computer system displays one or more controls for changing a call status of a first call between the user of the computer system and a second user in the fourth user interface object, and the computer system detects a selection of a first control of the one or more controls for changing the call status of the first call between the user of the computer system and the second user. In response to detecting the selection of the first control of the one or more controls for changing the call status of the first call between the user of the computer system and the second user, the computer system changes the call status of the first call in accordance with the selection of the first control (e.g., if the first control is a call acceptance control, accepting the first call; if the first control is a call rejection control, rejecting the first call; if the first control is a call pause control, pausing the first call; if the first control is a call forwarding control, displaying a call forwarding user interface object; and/or if the first control is a call termination control, terminating the first call). For example, as described with reference to FIG. 8A, in some embodiments, the respective application is a telephony application that supports real-time communication (e.g., calls) between the computer system 100 and another electronic device. Displaying a fourth user interface object that corresponds to a communication application that is a telephony application supporting real-time communication calls, in response to detecting that the one or more conditions for displaying the fourth user interface object are met, and changing the call status of the first call in response to detecting selection of a first control of one or more controls, provides improved visual feedback to the user (e.g., improved visual feedback regarding a real-time communication call).

In some embodiments, the communication application is (13052) a video call application that supports real-time video calls between a user of the computer system and other users. The computer system displays a video feed of a first real-time video call between the user of the computer system and a second user, concurrently with one or more controls for changing a call status of the first video call in the fourth user interface object, and the computer system detects a selection of a second control of the one or more controls for changing the call status of the first video call. In response to detecting the selection of the second control of the one or more controls for changing the call status of the first video call, the computer system changes the call status of the first video call in accordance with the selection of the second control (e.g., if the first control is a call pause control, pausing the first video call including the video feed; if the first control is a call forwarding control, displaying a call forwarding user interface object; and/or if the first control is a call termination control, terminating the first video call and video feed). For example, as described with reference to FIG. 8A, in some embodiments, the respective application is a video call application that supports real-time video calls between the computer system 100 and another electronic device. Displaying a fourth user interface object that corresponds to a communication application that is a video call application supporting real-time video calls, in response to detecting that the one or more conditions for displaying the fourth user interface object are met, provides improved visual feedback to the user (e.g., improved visual feedback regarding a real-time video call).

In some embodiments, the first type of user interface object includes (13054) a fifth user interface object that corresponds to a first subscribed event (e.g., a sports game, a delivery activity, a flight status for a flight, or other subscribed event) and displays event update information from time to time (e.g., periodically, or in real-time or substantially real-time) in the fifth user interface object as event updates are generated for the first subscribed event (e.g., as new scores are generated, as delivery status is changed, as flight status is updated, or other updates becomes available). In some embodiments, updates of multiple subscribed events are concurrently monitored, and may concurrently overlay a currently displayed user interface (e.g., a wake screen user interface, a home screen user interface, or a status region of the display). For example, as described with reference to FIG. 8A, in some embodiments, the user interface 8000 displays status information that corresponds to a first subscribed event (e.g., a sports game, a delivery activity, a flight status, or another subscribed event), and the status information is updated periodically (e.g., in real time, substantially real time, or at preset time intervals) to reflect event updates that are generated for the first subscribed events (e.g., as the score changes for a sports game, as a delivery status changes, as a flight status changes, or as other updates become available). In some embodiments, the user interface 8000 displays status information for a plurality of subscribed events (e.g., concurrently). Displaying a fifth user interface object that corresponds to a first subscribed event, and that displays event update information from time to time, in response to detecting that the one or more conditions for displaying the fifth user interface object are met, provides improved visual feedback to the user (e.g., improved visual feedback regarding the first subscribed event), and reduces the number of user inputs needed to provide status information regarding the first subscribed event (e.g., the user does not need to navigate back to an application specific to the subscribed event, each time the user wants to see status information for the first subscribed event).

In some embodiments, while displaying the respective user interface object of the first type of user interface object (e.g., overlaying a portion of the first user interface, replacing the first user interface entirely, or displayed concurrently with the first user interface), the computer system detects (13056) that expansion criteria are met (e.g., a tap input, a light press input, or another type of input that meets the expansion criteria, that corresponds to a request to expand the respective user interface object is detected, or a new update to the status information is received, and/or another event that causes the respective user interface object to be expanded or updated). In response to detecting that the expansion criteria are met, the computer system displays additional content (e.g., new status information, additional controls, more details and information related to the content of the respective user interface object that were already displayed prior to the expansion criteria being met) in the respective user interface object that was not displayed in the respective user interface object prior to detecting that the expansion criteria are met. In some embodiments, in addition to displaying additional content in the respective user interface object, the computer system expands the dimensions (e.g., width, and/or height) of the respective user interface object in response to detecting that the expansion criteria are met. In some embodiments, in response to detecting that the expansion criteria are met, the computer system changes the location of the respective user interface object relative to the display area of the computer system (e.g., from an edge or corner of the display area to a more central region of the display area, or from the corner to the center of the top edge). For example, as described with reference to FIG. 8E, in some embodiments, the computer system 100 displays an expanded version of the user interface 8000, which includes at least some application content that is not displayed in the user interface 8000 (e.g., with the appearance or version shown in FIG. 8A). Displaying additional content in the respective user interface object that was not displayed in the respective user interface object prior to detecting that the expansion criteria are met, in response to detecting that the expansion criteria are met, provides additional control options without cluttering the UI with additional displayed controls (e.g., additional displayed controls for displaying the additional content) and without needing to permanently display the additional content (e.g., the additional content is displayed in response to detecting that the expansion criteria are met, and need not be displayed when the respective user interface object is first displayed).

In some embodiments, detecting that the expansion criteria are met includes (13058) detecting occurrence of a first event that is generated by the respective application. In one example, the respective user interface object corresponds to a music application and the first event is a change in music being played in the respective user interface object. In another example, the respective user interface object corresponds to a sports application and the first event is a change in score of a sports game for which status information is provided in the respective user interface object. In another example, the respective user interface object corresponds to a timer application and the first event is an ending of an active timer. In another example, the respective user interface object corresponds to a doorbell application and the first event is an activation of an electronic doorbell. In another example, the respective user interface object corresponds to a communication application and the first event is receipt of an incoming voice or video call. In another example, the respective user interface object corresponds to a ride sharing application and the first event is an event corresponding to an active ride share session (e.g., a driver is approaching, or a driver has arrived). In another example, the respective user interface object corresponds to a food delivery application and the first event is an event corresponding to an active food delivery (e.g., a food order has been confirmed, a food order has been cancelled, a food order has been picked up by a delivery driver, a delivery driver is approaching with a food order, a food order has been delivered, or a communication from a delivery driver has been received). For example, as described with reference to FIG. 8E, in some embodiments, the computer system 100 automatically displays the expanded version of the user interface 8000 in response to detecting a first event (e.g., that corresponds to the same application for which application content is displayed in the user interface 8000). Displaying additional content in the respective user interface object that was not displayed in the respective user interface object prior to detecting occurrence of a first event that is generated by the respective application, in response to detecting occurrence of a first event that is generated by the respective application, provides additional control options without cluttering the UI with additional displayed controls (e.g., additional displayed controls for displaying the additional content) and without needing to permanently display the additional content (e.g., the additional content is displayed in response to detecting that the expansion criteria are met, and need not be displayed when the respective user interface object is first displayed).

In some embodiments, detecting that the expansion criteria are met includes detecting (13060) (e.g., via the one or more sensors and/or input devices of the computer system) a second user input directed to the respective user interface object, the second user input corresponding to a request to expand the respective user interface object (e.g., the second user input is a tap on the respective user interface object, or an air tap while a gaze is directed to the respective user interface object). For example, as described with reference to FIG. 8E, in some embodiments, in response to detecting a user input directed to the user interface 8000 that is different than the user input 8002 (e.g., a tap input, or a long press input), the computer system 100 displays the expanded version of the user interface 8000. Displaying additional content in the respective user interface object that was not displayed in the respective user interface object prior to detecting a second user input directed to the respective user interface object, the second user input corresponds to a request to expand the respective user interface object, in response to detecting the second user input directed to the respective user interface object, and that corresponds to a request to expand the respective user interface object, provides additional control options without cluttering the UI with additional displayed controls (e.g., additional displayed controls for displaying the additional content) and without needing to permanently display the additional content (e.g., the additional content is displayed in response to detecting that the expansion criteria are met, and need not be displayed when the respective user interface object is first displayed).

In some embodiments, while displaying the first user interface, the computer system detects (13062) occurrence of a first event. In response to detecting occurrence of the first event, the computer system displays a first notification (e.g., overlaid on the first user interface) corresponding to the first event (e.g., concurrently with the first user interface), including: in accordance with a determination that the first user interface is the first type of user interface (e.g., a user interface of the ambient mode, and/or a first customizable user interface that is displayed when a first set of conditions are met), displaying the first notification with a first size; and in accordance with a determination that the first user interface is the second type of user interface (e.g., a wake screen user interface, a lock screen user interface, and/or a system user interface that corresponds to a restricted state of the computer system), displaying the first notification with a second size that is different from the first size (e.g., larger than the first size, or smaller than the first size). For example, as described with reference to FIG. 8G, in some embodiments, the user interface 8010 includes notification content (e.g., that is displayed in a full-screen user interface 8010, that is larger than the user interface 8000, which also displays the same notification content, or notification content corresponding to the same notification). Displaying the first notification with a first size, in accordance with a determination that the first user interface is the first type of user interface, and displaying the first notification with a second size that is different from the first size, in accordance with a determination that the first user interface is the second type of user interface, provides improved visual feedback to the user (e.g., improved visual feedback regarding what type of user interface the first user interface is).

In some embodiments, displaying the first notification corresponding to the first event includes (13064): in accordance with a determination that authentication criteria are met (e.g., the computer system is in an unlocked state, and/or valid authentication data has been obtained), displaying the first notification with first notification content; and in accordance with a determination that the authentication criteria are not met (e.g., the computer system is in a locked state, and/or valid authentication data has not been obtained), displaying the first notification with second notification content, wherein the second notification content omits at least some of the first notification content (e.g., displaying a summary of the first notification content, without all details of the first notification content, and/or displaying part, less than all of the first notification content). For example, as described with reference to FIGS. 8A and 8G, in some embodiments, the user interface 8000 and/or the user interface 8010 display first notification content when a user of the computer system 100 is not authenticated, and displays second notification content that includes some notification content not included in the first notification content, when the user of the computer system 100 is authenticated (e.g., authenticated as described above with reference to FIGS. 7Q-7V). Displaying the first notification with first notification content, in accordance with a determination that authentication criteria are met, and displaying the first notification with second notification content that omits at least some of the first notification content, in accordance with a determination that the authentication criteria are not met, provides improved privacy by displaying appropriate notification content based on the authentication criteria (e.g., sensitive notification content is not displayed when the authentication criteria is not met).

In some embodiments, displaying the first notification corresponding to the first event includes (13066): displaying initial notification content before a threshold amount of time has elapsed since detection of the first event (e.g., an indication of the first notification, or reduced notification content is displayed initially irrespective of the authentication state of the computer system); and in accordance with a determination that authentication criteria are met (e.g., the computer system is in an unlocked state, and/or valid authentication data has been obtained), displaying additional notification content different from the initial notification content after the threshold amount of time has elapsed since the detection of the first event (e.g., expanding the first notification to display the initial notification content and the additional notification content after a short delay) (e.g., in some embodiments, after ceasing display of the additional notification content, the device redisplays the first user interface (or other content that was displayed prior to displaying the initial notification content)); and in accordance with a determination that the authentication criteria are not met (e.g., the computer system is in a locked state, and/or valid authentication data has not been obtained), ceasing display of the initial notification content without displaying the additional notification content (e.g., removing the first notification from display), wherein the initial notification content omits at least some of the details in the additional notification content (e.g., initial notification content displaying a summary of the additional notification content, without all details of the additional notification content, and/or displaying part, less than all of the additional notification content). In some embodiments, after ceasing display of the initial notification content, the device redisplays the first user interface (or other content that was displayed prior to displaying the initial notification content). In some embodiments, in accordance with a determination that the authentication criteria are not met, the device returns to displaying the first user interface (or other content that was displayed prior to displaying the initial notification content) more quickly than when authentication criteria are met, because when authentication criteria are met, the computer system takes time to display the additional notification content before returning to displaying the first user interface. For example, as described with reference to FIGS. 8A and 8G, in some embodiments, the user interface 8000 and/or the user interface 8010 display the first notification content at a first time (e.g., when a first event corresponding to the notification for which notification content is being displayed occurs and/or is detected by the computer system 100), and displays the second notification content at a second time after the first time (e.g., after a threshold amount of time has elapsed since the computer system 100 detected first event corresponding to the notification) if the user has successfully authenticated before the second time (e.g., and maintains display of the first notification content if the user has not successfully authenticated before the second time). Displaying initial notification content before a threshold amount of time has elapsed since detection of the first event, displaying additional notification content different from the initial notification content after a threshold amount of time has elapsed since detection of the first event and in accordance with a determination that authentication criteria are met, and ceasing display of the initiation notification content without display the additional notification content in accordance with a determination that authentication criteria are not met, provides improved privacy by displaying appropriate notification content based on the authentication criteria (e.g., sensitive notification content is not displayed when the authentication criteria is not met).

In some embodiments, displaying the first notification corresponding to the first event includes (13068): while displaying initial notification content in the first notification, detecting, via the one or more sensors, a presence of a user in proximity to the computer system (e.g., movement of a person, or movement of an authenticated user toward the display, presence of a person within a threshold distance of the display, or presence of an authenticated user within a threshold distance of the display); and in response to detecting the presence of the user, and in accordance with a determination of the presence of the user meets expansion criteria (e.g., the movement of the user is toward the computer system, the user's hand is waving at the computer system, the user is an authenticated user, valid authentication data has been obtained from the user, and/or the user is within a threshold distance from the computer system, and/or other requirements for displaying the expanded notification content), displaying the first notification with additional notification content different from the initial notification content. In some embodiments, in accordance with a determination that the user does not meet the expansion criteria, the computer system forgoes displaying the additional notification content. For example, as described with reference to FIGS. 8A and 8G, in some embodiments, the computer system 100 automatically displays the second notification content when the user (e.g., an authenticated user) is detected within a threshold distance of the computer system 100. Displaying the first notification with additional notification content different from the initial notification content, in response to detecting the presence of the user and in accordance with a determination that the presence of the user meets expansion criteria, provides improved privacy by displaying appropriate notification content based on the authentication criteria (e.g., sensitive notification content is not displayed when the authentication criteria is not met) and enables the computer system to display appropriate content without cluttering the UI with additional displayed controls (e.g., additional displayed controls for displaying the additional content).

In some embodiments, while displaying the first notification, the computer system detects (13070) (e.g., via the one or more sensors and/or input devices of the computer system) a third user input (e.g., an upward swipe input) directed to the first notification. In response to detecting the third user input, in accordance with a determination that the third user input meets dismissal criteria (e.g., the third user input is an upward swipe input directed to the first notification, or another type of input that corresponds to a request to dismiss the notification (e.g., a leftward swipe that moves pass a threshold distance, a tap on a deletion or save affordance associated with the first notification)), the computer system ceases to display the first notification. In some embodiments, ceasing to display the first notification includes replacing display of the first notification with display of a first notification indicator (e.g., an icon, a dot, or another indicator that is not specific to notification content of the first notification). For example, as described with reference to FIGS. 8A and 8G, in some embodiments, the user can dismiss or cease displaying the notification content in the user interface 8000 and/or the user interface 8010 by performing a user input (e.g., a user input analogous to the user input 8002 in FIG. 8A, or the user input 8014 in FIG. 8G). Ceasing to display the first notification in response to detecting a third user input that meets dismissal criteria, provides additional control options without cluttering the UI with additional displayed controls (e.g., additional displayed controls for ceasing to display the first notification).

In some embodiments, in response to detecting (13072) the third user input: in accordance with a determination that the third user input meets the dismissal criteria and the first user interface is the first type of user interface (e.g., the first notification indicator is displayed overlaid on, or as part of, the first user interface), the computer system displays a first notification indicator that corresponds to the first notification, after the first notification ceases to be displayed (e.g., an indicator that indicates there are recent notifications, but that does not include notification content for the recent notifications), wherein the first notification indicator has a third size; and in accordance with a determination that the third user input meets the dismissal criteria and the first user interface is the second type of user interface, the computer system displays a first notification indicator that corresponds to the first notification, after the first notification ceases to be displayed (e.g., an indicator that indicates there are recent notifications, but that does not include notification content for the recent notifications), the first notification indicator has a fourth size that is larger than the third size. In some embodiments, the first notification indicator is concurrently displayed with the first user interface. For example, as described with reference to FIGS. 8B and 8H, in some embodiments, when dismissing or ceasing to display the notification content, the computer system 100 replaces display of the notification content with a notification indicator (e.g., a persistent indicator analogous to the user interface 8004 in FIG. 8B, or the user interface 8016 in FIG. 8H, which are displayed with a smaller size compared to the user interface 8000 and the user interface 8010). Displaying a first notification indicator with a third size, in accordance with a determination that the third user input meets the dismissal criteria and the first user interface is the first type of user interface, and displaying the first notification indicator with a fourth size that is larger than the third size, in accordance with a determination that the third user input meets the dismissal criteria and the first user interface is the second type of user interface, provides improved visual feedback to the user (e.g., improved visual feedback regarding what type of user interface the first user interface is).

In some embodiments, while displaying the first notification indicator concurrently with the first user interface, the computer system detects (13074) (e.g., via the one or more sensors and/or input devices of the computer system) a fourth user input directed to the first notification indicator. In response to detecting the fourth user input that is directed to the first notification indicator: in accordance with a determination that the first user interface is the first type of user interface, the computer system maintains display of the first notification indicator without displaying notification content of the first notification; and in accordance with a determination that the first user interface is the second type of user interface, the computer system displays the notification content of the first notification (e.g., redisplaying the first notification). For example, as described with reference to FIGS. 8A and 8G, in some embodiments, the user cannot redisplay the notification content while the computer system 100 is operating in the ambient mode (e.g., the user must first exit the ambient mode of the computer system 100, for example, as described above with reference to FIGS. 5AH-5AK). Maintaining display of the first notification indicator without displaying notification content of the first notification, in response to detecting the fourth user input directed to the first notification indicator and in accordance with a determination that the first user interface is the first type of user interface, and displaying the notification content of the first notification, in response to detecting the fourth user input directed to the first notification indicator and in accordance with a determination that the first user interface is the second type of user interface, provides improved privacy by displaying only appropriate notification content and/or notification indicators (e.g., by not allowing display (e.g., redisplay) of the notification content of the first notification if the first user interface is the first type of user interface).

In some embodiments, when (e.g., in a scenario where) the first user interface is (13076) the first type of user interface, after detecting the fourth user input, detecting a change in state of the computer system, wherein the change in state of the computer system includes a change in orientation of the computer system or disconnection of the computer system from a charging source. In response to detecting the change in state of the computer system, the computer system replaces display of the first user interface with display of the second user interface, and the computer system displays the first notification indication with the second user interface. While displaying the first notification indication with the second user interface (e.g., in response to detecting a fifth user input directed to the first notification indicator), the computer system displays the notification content of the first notification that was not displayed prior to detecting the change in state of the computer system. For example, as described with reference to FIGS. 8A and 8G, in some embodiments, the user cannot redisplay the notification content while the computer system 100 is operating in the ambient mode (e.g., the user must first exit the ambient mode of the computer system 100, for example, by rotating the display of the computer system 100 away from the landscape orientation and/or disconnecting the charging source 5056, as described above with reference to FIGS. 5AH-5AK). Replacing display of the first user interface with display of the second user interface and displaying the first notification indication with the second user interface, in response to detecting a change in state of the computer system that includes a change in orientation of the computer system or disconnection of the computer system from a power source, provides additional control options without cluttering the UI with additional displayed controls (e.g., additional displayed controls for replacing display of the first user interface with display of the second user interface, for displaying the first notification indication with the second user interface, and/or navigating between the first user interface and the second user interface).

In some embodiments, the computer system displays (13078) the first notification indicator in response to detecting the third user input is performed in accordance with the determination that the third user input meets the dismissal criteria and that notification indication display is enabled (e.g., in a configuration user interface for notifications and/or for user interface of the first type of user interface). In response to detecting the third user input, in accordance with the determination that the third user input meets the dismissal criteria and that notification indication display is disabled, the computer system forgoes display of the first notification indicator that corresponds to the first notification, after the first notification ceases to be displayed. For example, as described with reference to FIGS. 8B and 8H, in some embodiments, the notification indicator is displayed in accordance with settings of the computer system 100 (e.g., the user can configure the settings of the computer system 100 to display the notification indicator, or to disable display of the notification indicator (e.g., in which case the computer system 100 ceases to display the notification content without displaying a notification indicator in the scenario described above)). Displaying the first notification indicator in response to detecting the third user input that meets the dismissal criteria and in accordance with a determination that notification indication display is enabled, and forgoing displaying the first notification indicator that corresponds to the first notification after the first notification ceases to be displayed, in response to detecting the third user input that meets the dismissal criteria and in accordance with a determination that notification indication display is disabled, automatically displays the first notification indicator only in the appropriate contexts, without requiring additional user input (e.g., additional user inputs to cease displaying the first notification indicator in contexts where the first notification indicator should not be displayed).

In some embodiments, while displaying first user interface (e.g., without displaying the respective user interface object, or after the respective user interface object has been dismissed or reduced into a status region), the computer system detects (13080) (e.g., via the one or more sensors and/or input devices of the computer system) a sixth user input that corresponds to a request to dismiss the first user interface (e.g., a dismissal input, an upward edge swipe gesture, a press on a home button, an air gesture for navigating to the home screen, a request to dismiss a currently displayed full-screen user interface, and/or an input that corresponds to a request to navigate to a home screen user interface from a currently displayed user interface). In response to detecting the sixth user input that corresponds to a request to dismiss the first user interface: in accordance with a determination that the first user interface is the first type of user interface (e.g., a user interface of an ambient mode that is associated with a respective application, where the ambient mode is activated in response to satisfaction of a set of conditions (e.g., that the computer system is in a specific orientation and connected to a charging source, as described above with reference to FIGS. 5G-5M), the computer system maintains display of the first user interface that is the first type of user interface; and in accordance with a determination that the first user interface is the second type of user interface (e.g., a wake screen user interface, a lock screen user interface, and/or a system user interface that corresponds to a restricted state of the computer system), the computer system ceases to display the first user interface that is the second type of user interface, and displaying the second user interface that is different from the first user interface at a location that was previously occupied by the first user interface (e.g., the second user interface is a home screen user interface, or an application user interface corresponding to an application that was recently in use (e.g., the last application in use prior to the computer system)). For example, as described above with reference to FIG. 5AF, the computer system 100 only displays the wake user interface (e.g., or a home screen user interface) when detecting specific criteria are no longer met (e.g., as described below with reference to FIGS. 5AH-5AK) (e.g., the computer system 100 remains in the ambient mode and does not display the wake user interface or a home screen user interface, while the specific criteria continue to be met). Maintaining display of the first user interface that is the first type of user interface, in response to detecting the sixth user input and in accordance with a determination that the first user interface is the first type of user interface, and ceasing to display the first user interface that is the second type of user interface and displaying the second user interface that is different from the first user interface at a location that was previously occupied by the first user interface, in response to detecting the sixth user input and in accordance with a determination that the first user interface is the second type of user interface, automatically displays an appropriate user interface when detecting a user input and reduces the risk of performing incorrect operations in response to the user input (e.g., the user cannot accidentally cease to display the first user interface of the first type of user interface in response to performing the sixth user input that corresponds to a request to dismiss the first user interface).

It should be understood that the particular order in which the operations in FIGS. 13A-13J have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 10000, 11000, 12000, 14000, 16000, and 17000) are also applicable in an analogous manner to method 13000 described above with respect to FIGS. 13A-13J. For example, the contacts, gestures, user interface objects, and/or animations described above with reference to method 13000 optionally have one or more of the characteristics of the contacts, gestures, user interface objects, and/or animations described herein with reference to other methods described herein (e.g., methods 10000, 11000, 12000, 14000, 16000, and 17000). For brevity, these details are not repeated here.

FIGS. 14A-14G are flow diagrams illustrating method 14000 for automatically activating a flashlight function of the computer system 100 when specific criteria are met, in accordance with some embodiments. Method 14000 is performed at an electronic device (e.g., device 300, FIG. 3, or portable multifunction device 80, FIG. 1A) with a display, a touch-sensitive surface, and one or more sensors to detect intensity of contacts with the touch-sensitive surface. In some embodiments, the display is a touch-screen display and the touch-sensitive surface is on or integrated with the display. In some embodiments, the display is separate from the touch-sensitive surface. Some operations in method 14000 are, optionally, combined and/or the order of some operations is, optionally, changed.

Activating a flashlight function of the computer system, in response to detecting disconnection of the computer system from a power supply, and in accordance with a determination that the disconnection of the computer system from the power supply occurred while the computer system was in a first mode of operation, automatically enables the flashlight function of the computer system without requiring further user input, reducing the number of user inputs needed to activate the flashlight function of the computer system.

In some embodiments, the method 14000 is performed at a computer system in communication with a display generation component and one or more sensors. The computer system detects (14002) a disconnection of the computer system from a charging source (e.g., the computer system is physically disconnected (e.g., a charging cable is disconnected) from a connection with a charging source, that the computer system is no longer within an effective range of a wireless charging source, and/or that the computer system is picked up by a user and moved by more than a threshold distance away from its original location) (e.g., in FIG. 9G, the computer system 100 detects that the computer system 100 is disconnected from the charging source 5056). In response to detecting (14004) the disconnection of the computer system from the charging source, in accordance with a determination that the disconnection of the computer system from the charging source occurred while the computer system was in a first mode of operation (e.g., while the computer system is displaying the sleep clock user interface of the ambient mode, and/or while the computer system displays a clock face in a sleep mode of the clock face), wherein the computer system, displays, via the display generation component, a clock user interface for at least a portion of a duration that the computer system is operating in the first mode of operation, the computer system activates (14006) a flashlight function of the computer system (e.g., in FIGS. 9H-91, the computer system 100 activates a hardware flashlight of the computer system 100, and in FIG. 9J, the computer system 100 displays the flashlight user interface 9022). In some embodiments, while operating in the first mode of operation, the computer system ceases to display the clock user interface after a period of inactivity (e.g., no movement from the user, no ambient light, and/or other conditions that indicate that the user is asleep and that the environment is dark). In some embodiments, the computer system modifies the manner in which time is displayed on the clock user interface (e.g., color, format, visual prominence, and/or responsiveness to user inputs) in accordance with various inputs (e.g., various touch inputs, movements, gaze, speech, sound, and/or other inputs) and contextual conditions (e.g., ambient lighting, ambient noise, and/or system or application events or configuration options) that are detected in the environments (e.g., external and/or internal environments) of the computer system. In some embodiments, the computer system includes a light source (e.g., a flashlight, a camera light, or other light sources) that is distinct from the display generation component of the computer system, and uses that light source to provide the flashlight function. In some embodiments, in response to detecting that the computer system is disconnected from the power source and activating the light source as the flashlight, the computer system also displays a flashlight user interface on the display for controlling one or more aspects of the flashlight function (e.g., brightness, color temperature, and other properties of the flashlight). In some embodiments, in response to detecting that the computer system is disconnected from the charging source, the computer system displays a flashlight user interface such that the display generation component of the computer system can be used as a flashlight). In some embodiments, a portion of the flashlight user interface provides the flashlight and other portions of the flashlight user interface includes controls (e.g., sliders and buttons) for controlling one or more aspects of the flashlight (e.g., brightness, color temperature, and other properties of the flashlight). In some embodiments, the computer system replaces display of the clock user interface with display of the flashlight user interface. In some embodiments, the computer system concurrently displays the clock user interface with the flashlight user interface. In some embodiments, while the first mode of the computer system is not active, the computer system displays a second user interface (e.g., a user interface that corresponds to a restricted state of the device, a user interface for launching one or more applications of the computer system, or another user interface for interacting with the computer system while the computer system is in use by a user) that is different from the clock user interface, in accordance with a determination that the first event corresponds to a movement of the computer system that disconnected the computer system from a power source.

In some embodiments, prior to detecting the disconnection of the computer system from the charging source, the computer system detects (14008) that a first set of conditions are met. In response to detecting that the first set of conditions are met, the computer system enters the first mode of operation in accordance with a determination that the first set of conditions are met (e.g., the current time is within a predetermined time period, which is optionally a user configured time period (e.g., a sleep schedule, a work schedule, and/or another schedule time period; the computer system is operating in an ambient mode; and/or the computer system is connected to a power source and has a first orientation)). In some embodiments, the computer system detects a first event, and determines that first criteria are met as a result of the first event; and displays the first customized user interface (e.g., a user interface of the ambient mode). In some embodiments, while the computer system displays a user interface of the first customized user interface (e.g., a first user interface of the ambient mode, a second user interface of the ambient mode, or another user interface of the ambient mode), the computer system determines that sleep conditions are met (e.g., the current time is within a sleep time of a sleep schedule of the user, the environment is dark and there is no movement of the user around for at least a period of time, or other conditions indicative of a time that the user may be asleep); and in accordance with a determination that the sleep conditions are met, the computer system enters the first mode of operation and displays a sleep clock user interface of the ambient mode. In some embodiments, the first mode of operation does not require that the ambient mode is active in order for the clock user interface to be displayed. In some embodiments, the first mode of operation does not require that the clock face is the currently displayed user interface in the ambient mode in order for the clock user interface to be displayed in the first mode of operation. For example, in FIG. 9A, prior to detecting disconnection of the computer system 100 from the charging source 5056, the computer system 100 enters the ambient mode in response to detecting that the computer system 100 is in a landscape orientation and that the computer system 100 is connected to the charging source 5056. Entering the first mode of operation in accordance with a determination that a first set of conditions are met, prior to detecting the disconnection of the computer system from the power supply, enable the computer system to provide access to the flashlight function of the computer system in response to detecting disconnection of the computer system from the power supply in the appropriate contexts, reducing the risk of automatically activating the flashlight function of the computer system when unneeded (e.g., the computer system does not always activate the flashlight function when disconnected from the power supply, which could result in extra user inputs needed to disable or deactivate the flashlight function when unneeded).

In some embodiments, while the computer system is operating in the first mode of operation, the computer system detects (14010) (e.g., via the one or more sensors and/or input devices of the computer system) a first user input directed to the display generation component (e.g., while the display generation component is off, is in a dimmed always-on state, is displaying a simplified clock face, is displaying one of multiple versions of the sleep clock face). In response to detecting the first user input, the computer system increases a visual prominence of the clock user interface (e.g., increasing a brightness of the clockface (e.g., from an off state, or from a dimmed and/or simplified state) for at least a threshold amount of time, such as 1, 2, 5 seconds, 10 seconds, 15 seconds, 30 seconds, 1 minute, or 5 minutes). For example, in FIG. 9C, in response to detecting a first user input (e.g., the user's hand 9000 in proximity to the computer system 100 and that the user's gaze 9004 is directed to the computer system 100), the computer system 100 displays the clock user interface 9002 with increased prominence (e.g., with a higher brightness as compared to the clock user interface 9002 in FIG. 9B). Increasing a visual prominence of the clock user interface, in response to detecting the first user input directed to the display generation component, enables the computer system to display the clock user interface with an appropriate level of visual prominence in the appropriate contexts, without needing to permanently display the clock user interface at an increased level of visual prominence.

In some embodiments, the first user input includes (14012) a touch input directed to a touch-sensitive surface of the computer system. In some embodiments, the touch-sensitive surface is the display generation component (e.g., the display generation component is a touch screen). For example, as described with reference to FIGS. 9A-9C, in some embodiments, the computer system 100 detects a tap input, directed to a touch-sensitive surface of the computer system 100. Increasing a visual prominence of the clock user interface, in response to detecting the first user input that includes a touch input directed to a touch-sensitive surface of the computer system, enables the computer system to display the clock user interface with an appropriate level of visual prominence in the appropriate contexts, without needing to permanently display the clock user interface at an increased level of visual prominence.

In some embodiments, detecting the first user input includes (14014) detecting movement of a user (e.g., the user touching a portion of the computer system, making an impact on the computer system or a surface in contact with the computer system, picking up the computer system, gazing at the computer system, and/or walking toward or otherwise moving around near the computer system) within a threshold distance of a sensor of the one or more sensors (e.g., proximity sensors, touch sensors, thermal sensors, accelerometers, impact sensors, gaze sensors, vibration sensors, and/or other sensors for detecting movement and/or interactions of a user within a threshold distance of the computer system). For example, in FIGS. 9B and 9C, the computer system 100 detects that the user's hand 9000 is within a threshold distance of the computer system 100). Increasing a visual prominence of the clock user interface, in response to detecting the first user input that includes movement of a user within a threshold distance of a sensor of the one or more sensors, enables the computer system to display the clock user interface with an appropriate level of visual prominence in the appropriate contexts, without needing to permanently display the clock user interface at an increased level of visual prominence.

In some embodiments, detecting the first user input includes (14016) detecting (e.g., via a camera, and/or another type of gaze detection component) a gaze input directed to the computer system. For example, in FIG. 9C, the computer system 100 detects that the user's hand 9000 is within the threshold distance of the computer system 100, and that the user's gaze 9004 is directed to the computer system 100). Increasing a visual prominence of the clock user interface, in response to detecting the first user input that includes a gaze input directed to the computer system, enables the computer system to display the clock user interface with an appropriate level of visual prominence in the appropriate contexts, without needing to permanently display the clock user interface at an increased level of visual prominence.

In some embodiments, detecting the first user input includes (14018) detecting (e.g., via one or more touch-sensitive surfaces, a touch-screen display, and/or another type of input device) a swipe gesture in a first direction (e.g., the display generation component is a touch-sensitive surface, and the swipe gesture in the first direction is detected on the display generation component). For example, as described with refence to FIGS. 9A-9C, in some embodiments, the computer system 100 detects a swipe input, directed to a touch-sensitive surface of the computer system 100. Increasing a visual prominence of the clock user interface, in response to detecting the first user input that includes a swipe gesture in a first direction, enables the computer system to display the clock user interface with an appropriate level of visual prominence in the appropriate contexts, without needing to permanently display the clock user interface at an increased level of visual prominence.

In some embodiments, prior to detecting the disconnection of the computer system from the charging source, and while the computer system is operating in the first mode of operation, the computer system displays (14020) the clock user interface with a first amount of time content (e.g., showing the hour, without showing the minute of the current time, showing the current time relative to a total duration, without indicating the exact numbers for the current time, or showing a color or luminance level relative to a color scale to indicate the current time relative to a scheduled wake time, or other ways of showing time and/or relative time), detecting (e.g., via the one or more sensors and/or input devices of the computer system) a second user input (e.g., a first type of input such as a tap, a long press, a swipe, and/or a gaze) directed to the clock user interface. In response to detecting the second user input, the computer system displays the clock user interface with a second amount of time content that is greater than the first amount of time content (e.g., showing time with more details and/or visual prominence). For example, in FIG. 9E, the computer system 100 displays the clock user interface 9008 (e.g., that includes the second amount of time content that is greater than the amount of time content displayed in clock user interface 9002), in response to detecting the user input 9006 in FIG. 9D. Displaying the clock user interface with a second amount of time content greater than the first amount of time content, in response to detecting the second user input directed to the clock user interface, enables the computer system to display the second amount of time content in the appropriate contexts, without needed to permanently display the second amount of time content in the clock user interface.

In some embodiments, while the computer system is operating in the first mode of operation, the computer system detects (14022) that a current time meets alarm trigger criteria (e.g., the current time is the time set of an alarm, and/or the current time is within a threshold amount of time of the wake time set by the sleep schedule). In response to detecting that the current time meets the alarm trigger criteria, the computer system generates a first audio alert (e.g., in conjunction with generating visual changes in the clock user interface). While generating the first audio alert, the computer system detects (e.g., via the one or more sensors and/or input devices of the computer system) a third user input directed to the clock user interface. In response to detecting the third user input, the computer system reduces audio prominence of the first audio alert (e.g., pausing, muting, reducing the volume of, and/or delaying generation of the first audio alert to a later time). For example, in FIG. 9W, the computer system 100 displays the alarm user interface 9040 (e.g., in response to detecting that the current time meets alarm trigger criteria) and generates an audio alert corresponding to the scheduled alarm, and while displaying the alarm user interface 9040, detects a user input 9042 to snooze the alarm (e.g., which includes ceasing to generate the audio alert and/or reducing a level of prominence with which the audio alert is generated). Generating a first audio alert in response to detecting that the current time meets alarm trigger criteria, while the computer system is operating in the first mode of operation, and reducing audio prominence of the first audio alert, in response to detecting the third user input directed to the clock user interface, provides additional control options without cluttering the UI with additional displayed controls (e.g., additional displayed controls for reducing audio prominence of the first audio alert).

In some embodiments, while the computer system is operating in the first mode of operation, displaying the clock user interface includes (14024) displaying a current time with a first format that is different from a second format with which the current time is displayed in the clock user interface while the computer system is not operating in the first mode of operation (e.g., while the computer system is operating in the ambient mode displaying a normal clock face, and/or while the computer system is operating in a normal mode displaying a user interface of a clock application). In some embodiments, the current time is displayed with reduced detail (e.g., without exact hour and/or minute values, and/or without normal tick marks on a clock face) and/or visual prominence (e.g., with reduced brightness, muted color contrast, and/or darkened display) when the computer system is operating in the first mode of operation, as compared to how current time is displayed when the computer system is not in the first mode of operation (e.g., while the computer system is displaying a clock face in a regular ambient mode, and/or when the computer system is displaying a clock face in a normal operating mode). For example, in FIG. 9D, the clock user interface 9002 includes on the hour value for the current time (e.g., without the minutes value for the current time). In contrast, in FIG. 6A, the clock user interface includes both the hour value and the minutes value for the current time. Displaying the clock user interface, including displaying a current time with a first format while the computer system is operating in the first mode of operation, and displaying the clock user interface, including displaying a current time with a second format different from the first format, while the computer system is not operating in the first mode of operation, provides improved visual feedback to the user (e.g., improved visual feedback regarding a current mode of operation of the computer system).

In some embodiments, displaying the current time with the first format includes (14026) displaying the current time with less detail in a time value of the current time as compared to the second format. For example, in some embodiments, the current time displayed with the first format does not provide the numerical tick marks for the minutes, and/or hours on the clock face. For example, multiple time values in a range of time values all have the same representation (e.g., “4ish” or some other indication of approximate time such as “just after 4 pm” or “around 4 pm” for a range of time values between four and five o'clock; or different shades and tints of colors representing “night,” “midnight” “early morning” “dawn,” “morning”). For example, in FIG. 9D, the clock user interface 9002 includes on the hour value for the current time (e.g., without the minutes value for the current time). In contrast, in FIG. 6A, the clock user interface includes both the hour value and the minutes value for the current time. Displaying the clock user interface, including displaying a current time with less detail in a time value of the current time as compared to a second format, while the computer system is operating in the first mode of operation, and displaying the clock user interface, including displaying a current time with a second format different from the first format, while the computer system is not operating in the first mode of operation, provides improved visual feedback to the user (e.g., improved visual feedback regarding a current mode of operation of the computer system).

In some embodiments, the clock user interface includes (14028) a visual indication of a first alarm time along with an indication of a current time (e.g., displaying a changing relationship (e.g., relative color temperature, relative distance, and/or other visual differences) between the current time and the first alarm time in accordance with elapse of time). For example, in FIG. 9D, the rightmost tick mark of the clock user interface 9002 is a visual representation of a first alarm time (e.g., 7:00 AM), the leftmost tick mark of the clock user interface 9002 is a visual representation of a bed time (e.g., 10:00 PM), and the indication of the current time (e.g., the displayed hour value of 4) is displayed closer to the representation of the alarm time than the representation of the bed time (e.g., because 4:55 AM is closer to 7:00 AM than it is to 10:00 PM). Displaying the clock user interface, including a visual indication of a first alarm along with an indication of a current time, provides improved visual feedback to the user (e.g., improved visual feedback regarding the first alarm time, the current time, the current operating mode of the computer system, and/or the relationship between the first alarm time, the current time, and/or the current operating mode of the computer system).

In some embodiments, in accordance with a determination that the current time is a first time, the computer system displays (14030) the visual indication of the current time as a digital indication that is displayed at a first location. In accordance with a determination that the current time is a second time that is different from the first time, the computer system displays the visual indication of the current time as the digital indication that is displayed at a second location that is different from the first location (e.g., displaying an animated movement of a visual indication of a current time toward the visual indication of the first alarm time in accordance with elapse of time). For example, in FIG. 9D, the computer system 100 displays the clock user interface 9002 with the visual indication of the current time (e.g., the hour value of 4) with one tick mark between the visual indication and the rightmost tick mark. After some time has passed (e.g., 8 minutes, from 4:55 to 5:03), the computer system 100 displays (e.g., updates display of) the clock user interface 9002 to include a visual indication of the current time (e.g., the hour value of 5, displayed with no tick marks between the visual indication and the right most tick mark). Displaying the visual indication of the current time as a digital indication that is displayed at a first location, in accordance with a determination that the current time is a first time, and displaying a visual indication of the current time as the digital indication that is displayed at a second location different from the first location, in accordance with a determination that the current time is a second time different from the first time, provides improved visual feedback to the user (e.g., improved visual feedback regarding the relationship between the current time and the first alarm time).

In some embodiments, the computer system enters (14032) the first mode of operation in accordance with a determination that a current time is within a sleep period established at the computer system (e.g., according to a sleep schedule set by the user, according to tracking of user activity and ambient conditions (e.g., dark outside, and/or user movement has subsided), according to sleep tracking function being turned on, according to a wake alarm being set, and/or according to a DND mode being active (e.g., reduced notifications or alerts, limited device functionalities)). For example, as described with reference to FIG. 9A, during a scheduled time period (e.g., a sleep period that begins at a scheduled bed time and ends at a scheduled wake or alarm time), the display of the computer system 100 is off (e.g., or in a lower power state, and displaying some “always on” elements, such as a time and/or date). Activating a flashlight function of the computer system, in response to detecting disconnection of the computer system from a power supply, and in accordance with a determination that the disconnection of the computer system from the power supply occurred while the computer system was in a first mode of operation that the computer system enters in accordance with a determination that a current time is within a sleep period established at the computer system, automatically enables the flashlight function of the computer system without requiring further user input, reducing the number of user inputs needed to activate the flashlight function of the computer system.

In some embodiments, activating the flashlight function of the computer system includes (14034) displaying an area of illumination (e.g., an area of white or off-white illumination, or an area of reddish or yellowish hue, to serve as the flashlight) via the display generation component (e.g., optionally, replacing display of the time indication on the clock user interface, if the time indication is displayed at the time that the disconnection from the power supply occurred). For example, in FIG. 9J, the computer system 100 displays the flashlight user interface 9022, which is a substantially uniform display of a single color. Activating a flashlight function of the computer system that includes displaying an area of illumination via the display generation component of the computer system, in response to detecting disconnection of the computer system from a power supply, and in accordance with a determination that the disconnection of the computer system from the power supply occurred while the computer system was in a first mode of operation, automatically enables the flashlight function of the computer system without requiring further user input, reducing the number of user inputs needed to activate the flashlight function of the computer system.

In some embodiments, while the flashlight function of the computer system remains active, the computer system detects (14036) (e.g., via the one or more sensors and/or input devices of the computer system) a third user input directed to the display generation component (e.g., directed to a first portion of the display region or touch-sensitive region (e.g., a color temperature slider, or a left half of the touch-screen display), and/or along a first dimension of the display region or touch-sensitive region (e.g., the longitudinal dimension, or the width dimension)). In response to detecting the third user input, in accordance with a determination that the third user input includes movement in a first direction, the computer system changes a color temperature of the flashlight function from a first color temperature to a second color temperature different from (e.g., lower than, or higher than) the first color temperature. In some embodiments, while the flashlight is active with the second color temperature, the computer system detects a subsequent user input directed to the display generation component. In response to detecting the subsequent user input, in accordance with a determination that the subsequent user input includes movement in a direction that is substantially opposite the first direction, the computer system changes the color temperature of the flashlight from the second color temperature to the first color temperature (or to another color temperature between the first and second color temperature, or to another color temperature different from the first color temperature, e.g., lower than the first color temperature or higher than the first color temperature). In some embodiments, in response to detecting the third user input, in accordance with a determination that the third user input includes a first magnitude and/or speed of movement in a first respective direction, the computer system changes the color temperature of the flashlight function by a first amount of change in a direction that corresponds to the first respective direction of the movement; and in accordance with a determination that the third user input includes a second magnitude and/or speed of movement, different from the first magnitude and/or speed of movement, in the first respective direction, the computer system changes the color temperature of the flashlight function by a second amount of change, different from the first amount of change, in the direction that corresponds to the first respective direction of the movement. For example, in FIG. 9H, the computer system 100 displays the flashlight user interface 9010, that includes a control 9014 (e.g., for adjusting a color of the flashlight, and can be adjusted by a user input 9018 that includes leftward or rightward movement (e.g., along an axis of the control 9014)). Additionally, in FIGS. 9L-9M, the computer system 100 adjusts a color of the flashlight user interface 9022 in response to detecting the user input 9028 (e.g., a rightward swipe input). Changing a color temperature of the flashlight function from a first color temperature to a second color temperature different from the first color temperature, in response to detecting the third user input directed to the display generation component, reduces the number of user inputs to adjust the color temperature of the flashlight function (e.g., the user does not need to perform additional user inputs to navigate to, and to adjust settings in, a separate user interface for configuring settings of the flashlight function of the computer system).

In some embodiments, while the flashlight function of the computer system remains active, the computer system detects (14038) (e.g., via the one or more sensors and/or input devices of the computer system) a fourth user input directed to the display generation component (e.g., directed to a second portion of the display region or touch-sensitive region (e.g., a brightness slider, or a right half of the touch-screen display), and/or along a second dimension of the display region or touch-sensitive region (e.g., the latitudinal dimension, or the height dimension)). In response to detecting the fourth user input, in accordance with a determination that the fourth user input includes movement in a second direction, the computer system changes a brightness of the flashlight function from a first brightness to a second brightness different from (e.g., lower than, or higher than) the first brightness. In some embodiments, while the flashlight is active with the second brightness, the computer system detects a subsequent user input directed to the display generation component. In response to detecting the subsequent user input, in accordance with a determination that the subsequent user input includes movement in a direction that is substantially opposite the second direction, the computer system changes the brightness of the flashlight from the second brightness to the first brightness (or to another brightness between the first and second brightness, or to another brightness different from the first brightness, e.g., lower than the first brightness or higher than the first brightness). In some embodiments, in response to detecting the fourth user input, in accordance with a determination that the fourth user input includes a third magnitude and/or speed of movement in a second respective direction, the computer system changes the brightness of the flashlight function by a third amount of change in a direction that corresponds to the second respective direction of the movement; and in accordance with a determination that the fourth user input includes a fourth magnitude and/or speed of movement, different from the first magnitude and/or speed of movement, in the second respective direction, the computer system changes the brightness of the flashlight function by a fourth amount of change, different from the third amount of change, in the direction that corresponds to the second respective direction of the movement. In some embodiments, the third user input and the fourth user input are detected in a single user input (e.g., the same swipe gesture, or the same drag input across the air, the touch-screen display, or a controller device), and the movement of the single user input is decomposed into movement in the first respective direction and the second respective direction (e.g., the first and second respective directions are, respectively, the up-and-down direction and the left-and-right direction, a first diagonal direction and a second diagonal direction, and/or other pairings of different directions). In some embodiments, the decomposition of the single user input is performed sequentially in time (e.g., a first portion of the input is in the first respective direction, and a second portion of the input following the first portion of the input is in the second respective direction), and/or based on directions (e.g., a diagonal swipe is decomposed into an up and down swipe input and a left and right swipe input, optionally, with different magnitude and/or speed depending on the angle of the diagonal swipe). In a more specific example, a swipe input in the up and to the right direction is optionally used to increase the brightness by a first amount of change corresponding to a magnitude of the horizontal component of the wipe input and to change the color temperature of the flashlight toward a warmer color by a second amount of change corresponding to a magnitude of the vertical component of the swipe input. In another more specific example, a swipe input in the down and to the left direction is optionally used to decrease the brightness by a fifth amount of change corresponding to a magnitude of the horizontal component of the wipe input and to change the color temperature of the flashlight toward a cooler color by a sixth amount of change corresponding to a magnitude of the vertical component of the swipe input. In another more specific example, a swipe input in the down and to the right direction is optionally used to increase the brightness by a seventh amount of change corresponding to a magnitude of the horizontal component of the wipe input and to change the color temperature of the flashlight toward a cooler color by an eighth amount of change corresponding to a magnitude of the vertical component of the swipe input. For example, in FIG. 9H, the computer system 100 displays the flashlight user interface 9010, that includes a control 9012 (e.g., for adjusting a brightness of the flashlight, and can be adjusted by a user input 9016 that includes upward or downward movement (e.g., along an axis of the control 9012)). Additionally, in FIGS. 9J-9K, the computer system 100 adjusts a brightness of the flashlight user interface 9022 in response to detecting the user input 9024 (e.g., an upward swipe input). Changing a brightness of the flashlight function from a first brightness to a second brightness different from the first brightness, in response to detecting the third user input directed to the display generation component, reduces the number of user inputs to adjust the brightness of the flashlight function (e.g., the user does not need to perform additional user inputs to navigate to, and to adjust settings in, a separate user interface for configuring settings of the flashlight function of the computer system).

In some embodiments, while the flashlight function remains active, the computer system detects (14040) (e.g., via the one or more sensors and/or input devices of the computer system) a fifth user input directed to the display generation component (e.g., directed to a third portion (e.g., the first portion, the second portion, and/or a different portion from the first portion and the second portion) of the display region or touch-sensitive region). In response to detecting the fifth user input, in accordance with a determination that the fifth user input meets dismissal criteria (e.g., the fifth user input is a swipe from a bottom edge of the display generation component toward an top edge of the display generation component, or the fifth user input is another type of user input that corresponds to a request to stop the flashlight function), the computer system deactivates the flashlight function of the computer system. In some embodiments, the computer system ceases to display the flashlight user interface and redisplays the clock user interface, in response to detecting the fifth user input. In some embodiments, the computer system ceases to display the flashlight user interface and displays a wake screen user interface (e.g., a lock screen or another wake screen of the computer system). In some embodiments, the computer system ceases to display the flashlight user interface and displays an application launch user interface (e.g., a home screen of the computer system). In some embodiments, the computer system exists the first mode of operation in response to detecting the fifth user input. In some embodiments, the computer system returns to the first mode of operation in response to detecting the fifth user input. For example, in FIGS. 9T-9U, the computer system 100 deactivates the flashlight function of computer system 100 in response to detecting the user input 9038 (e.g., an upward swipe input) while displaying the flashlight user interface 9022 in FIG. 9T (e.g., while the flashlight function is active). Deactivating the flashlight function of the computer system in response to detecting the fifth user input that meets dismissal criteria, provides additional control options without cluttering the UI with additional displayed controls (e.g., additional displayed controls for deactivating the flashlight function of the computer system).

In some embodiments, the dismissal criteria are met (14042) in accordance with a determination that the fifth user input includes an upward swipe gesture from a bottom edge of the display generation component. For example, in FIGS. 9T-9U, the computer system 100 deactivates the flashlight function of computer system 100 in response to detecting the user input 9038 (e.g., an upward swipe input) while displaying the flashlight user interface 9022 in FIG. 9T (e.g., while the flashlight function is active). Deactivating the flashlight function of the computer system in response to detecting the fifth user input that includes an upward swipe gesture from a bottom edge of the display generation component, provides additional control options without cluttering the UI with additional displayed controls (e.g., additional displayed controls for deactivating the flashlight function of the computer system).

In some embodiments, while the flashlight function of the computer system is active, the computer system detects (14044) (e.g., via the one or more sensors and/or input devices of the computer system) a sixth user input that corresponds to a request to turn off the flashlight function of the computer system (e.g., a double tap on the display generation component, a swipe to reduce to brightness of the flashlight to a minimum level, a selection of an on/off affordance displayed in the flashlight user interface, or an input of another input type). In response to detecting the sixth user input, the computer system deactivates the flashlight function of the computer system. In some embodiments, the computer system redisplays the clock user interface after deactivating the flashlight function of the computer system. In some embodiments, the computer system displays another user interface, such as the wake screen user interface or the home screen user interface of the computer system. For example, in FIG. 9T, the computer system 100 detects the user input 9038 while displaying the flashlight user interface 9022, and in FIG. 9U, in response to detecting the user input 9038, the computer system 100 ceases to display the flashlight user interface 9022 and deactivates the flashlight function of the computer system 100. Deactivating the flashlight function of the computer system, in response to detecting the sixth user input while the flashlight function of the computer system is active, provides additional control options without cluttering the UI with additional displayed controls (e.g., additional displayed controls for deactivating the flashlight function of the computer system).

In some embodiments, while the flashlight function of the computer system remains active, the computer system detects (14046) occurrence of a first event (e.g., detecting reconnection of the computer system to a charging source (e.g., reconnection of the charging source from which the computer system was previously disconnected, or connection of a different charging source to the computer system), detecting that the orientation of the computer system is in the first orientation, and/or detecting that the computer system is substantially stationary)). In response to detecting the first event, and in accordance with a determination that a first set conditions are met as a result of the first event (e.g., the current time is still within a predetermined time period, which is optionally a user configured time period (e.g., a sleep schedule, a work schedule, and/or another schedule time period; the computer system is reconnected to a power source and/or returned to the first orientation; the environment is dark and there is no more movement of the user around for at least a period of time, and/or other conditions indicative of the user is done using the flashlight), the computer system deactivates the flashlight function of the computer system (e.g., and optionally, redisplaying the clock user interface). In some embodiments, the computer system further determines that other conditions for displaying the ambient mode of the computer system and/or other conditions for returning to the first mode of operation are met before deactivating the flashlight function of the computer system and/or redisplaying the clock user face in the first mode of operation. For example, in FIG. 90, the computer system 100 is reconnected to the charging source 5056, and in response, the computer system 100 displays the clock user interface 9002 (e.g., and deactivates the flashlight function of the computer system 100, by ceasing to display the flashlight user interface 9022). Deactivating the flashlight function of the computer system in response to detecting reconnection of the computer system to the power supply, reduces the number of user inputs needed to deactivate the flashlight function when unneeded (e.g., the user does not need to perform additional user inputs to deactivate the flashlight function of the computer system after reconnecting the computer system to the power supply).

In some embodiments, while the computer system is operating in the first mode of operation, the computer system detects (14048) that a current time mects alarm trigger criteria (e.g., the current time is within a threshold amount of time of a scheduled wake time, and/or other conditions for generating a wake alarm are met). In response to detecting that the current time meets the alarm trigger criteria, the computer system generates a first alarm, wherein the first alarm is automatically selected from a plurality of alarm outputs in accordance with a random or pseudorandom manner. In some embodiments, the plurality of alarm outputs include different alarm sounds (e.g., different sound patterns, pitches, and/or duration), and/or different visual accompaniment for the different alarm sounds. For example, in FIG. 9V, the alarm user interface 9040 includes a first visual and generates a first audio alert, and in FIG. 9X, the alarm user interface 9044 includes a second visual (e.g., different from the first visual) and optionally generates a second audio alert (e.g., different from the first audio alert). Generating a first alarm that is automatically selected from a plurality of alarm outputs in accordance with a random or pseudorandom manner, in response to detecting that the current time meets the alarm trigger criteria, provides improved audio and/or visual feedback to the user (e.g., improved audio and/or visual feedback regarding the current time, which is provided via audio and/or visuals corresponding to the first alarm).

In some embodiments, generating the first alarm includes (14050) generating a first audio output (e.g., and also displaying the first alarm user interface) (e.g., the first audio output is automatically selected from a plurality of audio outputs in a random or pseudo-random manner). For example, in FIG. 9V, the computer system 100 displays the alarm user interface 9040 and generates an audio alert corresponding to the scheduled or active alarm. Generating a first alarm, including generating a first audio output, in response to detecting that the current time meets the alarm trigger criteria, provides improved audio feedback to the user (e.g., improved audio feedback regarding the current time).

In some embodiments, generating the first alarm includes (14052) displaying first visual output via the display generation component (e.g., with animated changes that corresponds to the first alarm output). In some embodiments, other randomly selected visual outputs (e.g., corresponding to other trigger conditions and/or wake events) are different from the first visual output. In some embodiments, audio and visual outputs that correspond to a respective alarm (e.g., the first alarm, or another alarm) are randomized as a pair (e.g., a pair of audio and visual outputs are selected together a pair randomly from a pool of combinations of audio and visual outputs), or separately and/or independently of each other (e.g., the audio output and the visual output for a respective alarm are respectively selected randomly from respective pools of audio and visual outputs, such that different combinations of the randomly selected audio output and the randomly selected visual output may be generated for a respective alarm). For example, in FIG. 9V, the computer system 100 displays the alarm user interface 9040 that includes a visual (e.g., a hemisphere in the bottom center of the alarm user interface 9040). Generating a first alarm, including displaying a first visual output, in response to detecting that the current time meets the alarm trigger criteria, provides improved visual feedback to the user (e.g., improved visual feedback regarding the current time).

In some embodiments, after generating the first alarm, wherein the first alarm includes a first alarm output selected from the plurality of alarm outputs, the computer system detects (14054) that a first period of time has elapsed and that the current time meets the alarm trigger criteria after the first period of time has elapsed. In response to detecting that the current time meets the alarm trigger criteria after the first period of time has elapsed, the computer system generates a second alarm, wherein the second alarm includes a second alarm output that is automatically selected from the plurality of alarm outputs in accordance with a random or pseudorandom manner and that is different from the first alarm output. In some embodiments, the first alarm output is removed from the pool of available alarm outputs, before the second alarm is randomly selected (e.g., the first alarm and the second alarm are both randomly selected, but the first alarm is different from the second alarm). For example, in FIG. 9V, the alarm user interface 9040 includes a first visual and generates a first audio alert, and in FIG. 9X, the alarm user interface 9044 includes a second visual (e.g., different from the first visual) and optionally generates a second audio alert (e.g., different from the first audio alert). Further, as described with reference to FIG. 9Y, the user can continue to snooze the active alarm (e.g., and the next time the alarm triggers, the displayed alarm user interface is optionally different from both the alarm user interface 9040 and the alarm user interface 9044, and a generated audio alert is also different from the audio alerts corresponding to the alarm user interface 9040 and the alarm user interface 9044). Generating a second alarm that includes a second alarm output that is automatically selected from the plurality of alarm outputs in accordance with a random or pseudorandom manner, that is different from the first alarm output, in response to detecting that the current time meets the alarm trigger criteria after the first period of time has elapsed, provides improved audio and/or visual feedback to the user (e.g., improved audio and/or visual feedback regarding the current time, which is provided via audio and/or visuals corresponding to the first alarm, and improved audio and/or visual feedback to distinguish the second alarm from the first alarm).

In some embodiments, while generating the first alarm, the computer system detects (14056) a user input that corresponds to a request to snooze the first alarm. In response to detecting the user input that corresponds to the request to snooze the first alarm, the computer system ceases to generate the first alarm, wherein detecting that the first period of time has elapsed and that the current time meets the alarm trigger criteria after the first period of time has elapsed includes: detecting that a snooze time period has elapsed since detecting the user input that corresponds to the request to snooze the first alarm; and determining that the alarm trigger criteria are met by the current time after the snooze time period has elapsed since detecting the user input that corresponds to the request to snooze the first alarm. In some embodiments, after ceasing to generating the first alarm due to detection of a snooze input, and after a threshold amount of time (e.g., 3, 5, 7 or 9 minutes, or other snooze period of time) has passed, the computer system determines that the alarm trigger criteria are met again by the current time, and generates another randomly selected alarm selected from the first set of alarm outputs. For example, in FIG. 9V, the alarm user interface 9040 includes a first visual and generates a first audio alert, and the alarm is snoozed in FIG. 9W in response to detecting the user input 9042. In FIG. 9X, after a snooze time period (e.g., 9 minutes) has elapsed, the computer system 100 alarm user interface 9044 includes a second visual (e.g., different from the first visual) and optionally generates a second audio alert (e.g., different from the first audio alert). Generating a second alarm that includes a second alarm output that is automatically selected from the plurality of alarm outputs in accordance with a random or pseudorandom manner, that is different from the first alarm output, in response to detecting that the current time meets the alarm trigger criteria after a snooze time period of time has elapsed, provides improved audio and/or visual feedback to the user (e.g., improved audio and/or visual feedback regarding the current time, which is provided via audio and/or visuals corresponding to the first alarm, and improved audio and/or visual feedback that the first alarm has been previously snoozed).

In some embodiments, the first alarm is generated (14058) on a first day, and detecting that the first period of time has elapsed and that the current time meets the alarm trigger criteria after the first period of time has elapsed includes detecting that the current time meets the alarm trigger criteria on a second day different from the first day. For example, in some embodiments, on different days, the alarm will be output at the same time of day, but different alarm output are generated on the different days. For example, as described with reference to FIG. 9X, in some embodiments, the displayed visual and/or the generated audio alert are randomized (e.g., randomized each time the specific alarm is triggered, randomized by day, or randomized each time any alarm is triggered). Generating a second alarm on a second day different from a first day, that includes a second alarm output that is automatically selected from the plurality of alarm outputs in accordance with a random or pseudorandom manner, that is different from the first alarm output that is generated on the first day, in response to detecting that the current time meets the alarm trigger criteria after the first period of time has elapsed, provides improved audio and/or visual feedback to the user (e.g., improved audio and/or visual feedback regarding the current time, which is provided via audio and/or visuals corresponding to the first alarm, and improved audio and/or visual feedback to distinguish the second alarm from the first alarm).

In some embodiments, the first alarm is generated (14060) based on a first alarm setting (e.g., alarm time setting, alarm condition setting), and detecting that the first period of time has elapsed and that the current time meets the alarm trigger criteria after the first period of time has elapsed includes detecting that the current time meets the alarm trigger criteria based on a second alarm setting different from the first alarm setting (e.g., different alarm time setting, for different times of the same day, or for different times on different days). For example, as described with reference to FIG. 9X, in some embodiments, the displayed visual and/or the generated audio alert are randomized (e.g., randomized each time the specific alarm is triggered, randomized by day, or randomized each time any alarm is triggered). Generating a second alarm that includes a second alarm output that is automatically selected from the plurality of alarm outputs in accordance with a random or pseudorandom manner, that is different from the first alarm output, in response to detecting that the current time meets second alarm trigger criteria different from first alarm trigger criteria, provides improved audio and/or visual feedback to the user (e.g., improved audio and/or visual feedback regarding the current time, which is provided via audio and/or visuals corresponding to the first alarm, and improved audio and/or visual feedback to distinguish the second alarm from the first alarm).

In some embodiments, while generating the first alarm, the computer system detects (14062) movement of the computer system. In response to detecting the movement of the computer system, in accordance with a determination that the movement of the computer system meets movement criteria (e.g., the computer system is moved by more than a threshold amount, the computer system is moved by at least a threshold speed, and/or the computer system is moved such that it has a specific orientation), the computer system ceases to generate the first alarm. For example, in FIG. 9AA, the computer system 100 is rotated into a specific orientation (e.g., rotated out of the landscape orientation), and in response the computer system 100 deactivates the alarm and ceases to operate in the ambient mode. Ceasing to generate the first alarm in response to detecting movement of the computer system that meets movement criteria, provide additional control options (e.g., for ceasing to generate the first alarm) without cluttering the UI with additional displayed controls (e.g., additional displayed controls for ceasing to generate the first alarm).

In some embodiments, in response to detecting (14064) the disconnection of the computer system from the charging source: in accordance with a determination that the disconnection of the computer system from the charging source occurred occurs while the computer system is generating the first alarm (e.g., while the computer system is operating in the first mode of operation, or while the computer system is not operating in the first mode of operation), the computer system ceases to generate the first alarm (e.g., optionally, existing the first mode of operation, and/or forgoing activating the flashlight function). For example, in FIG. 9Z, the computer system 100 is disconnected from the charging source 5056, and in response, the computer system 100 deactivates the alarm and ceases to operate in the ambient mode. Ceasing to generate the first alarm, in response to detecting disconnection of the computer system from the power supply, and in accordance with a determination that the disconnection of the computer system from the power supply occurs while the computer system is generating the first alarm, provide additional control options (e.g., for ceasing to generate the first alarm) without cluttering the UI with additional displayed controls (e.g., additional displayed controls for ceasing to generate the first alarm).

In some embodiments, prior to detecting that the current time meets the alarm trigger criteria, the computer system displays (14066) visual changes in the clock user interface in accordance with a determination that the alarm trigger criteria are about to be met (e.g., the current time is within a threshold amount of time of the alarm time, and/or the user's movement indicates that the user is about to wake up), wherein displaying the visual changes in the clock user interface includes changing (e.g., gradually, over time) at least a color and/or a size of one or more elements of the clock user interface (e.g., the color and size of the hands of the clock face, or the numerical representation of the current time). For example, in FIGS. 9V-9W, the visual (e.g., the hemisphere in the bottom center of the alarm user interface 9040) expands (e.g., in FIG. 9W, compared to in FIG. 9V), and is displayed with increased prominence (e.g., with a higher brightness and/or a brighter color or shade, in FIG. 9W as compared to FIG. 9V). Displaying visual changes in the clock user interface in accordance with a determination that the alarm trigger criteria are about to be met, provides improved visual feedback to the user (e.g., improved visual feedback regarding the relationship between the current time and an alarm time) and also enables the computer system to gradually (or incrementally) adjust the visual(s) of the clock user interface prior to the alarm trigger criteria being met (e.g., to establish a regular rhythm of light exposure of a user of the computer system).

In some embodiments, in response to detecting that the current time meets the alarm trigger criteria, the computer system displays (14068) one or more selectable options for interacting with the first alarm (e.g., to cease to display the visual alarm content, to mute the audio component of the first alarm, and/or to snooze the alarm and have another alarm regenerated at a later time). The computer system detects a respective user input that corresponds to selection of a first selectable option of the one or more selectable options for interacting with the first alarm. In response to detecting the respective user input that corresponds to the selection of the first selectable option of the one or more selectable options for interacting with the first alarm, the computer system performs a first operation with respect to the first alarm, in accordance with the first selectable option (e.g., if the first selectable option is an option for muting the audio output of the alarm, ceasing to output a respective audio output of the alarm; if the first selectable option is an option for stopping the alarm, ceasing to display the respective visual output and ceasing to output the respective audio output of the alarm and dismissing the alarm; if the first selectable option is an option for snoozing the alarm, ceasing to output the visual and audio output of the alarm, and after a period of time corresponding to the snooze period, generating the alarm, optionally with a set of newly selected audio and visual output for the alarm). For example, as described with reference to FIG. 9V, in some embodiments, the alarm user interface 9040 includes one or more selectable options for interacting with the alarm (e.g., an option of snoozing the alarm, an option for ceasing to display the visual, an option to mute or silence the audio alert, and/or to deactivate the alarm). Displaying one or more selectable options for interacting with the first alarm, in response to detecting that the current time meets the alarm trigger criteria, reduces the number of user inputs needed to interact with the first alarm (e.g., the user does not need to perform additional user inputs to first navigate to a time or clock application that corresponds to the first alarm).

It should be understood that the particular order in which the operations in FIGS. 14A-14G have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 10000, 11000, 12000, 13000, 16000, and 17000) are also applicable in an analogous manner to method 14000 described above with respect to FIGS. 14A-14G. For example, the contacts, gestures, user interface objects, and/or animations described above with reference to method 14000 optionally have one or more of the characteristics of the contacts, gestures, user interface objects, and/or animations described herein with reference to other methods described herein (e.g., methods 10000, 11000, 12000, 13000, 16000, and 17000). For brevity, these details are not repeated here.

FIGS. 15A-15Q show exemplary user interfaces and methods for interacting with the computer system 100 (e.g., without physical or touch inputs), while the computer system 100 is operating in the ambient mode, in accordance with some embodiments.

FIG. 15A illustrates the computer system 100 on a stand 15000. The stand 15000 is connected to the charging source (e.g., by a wire or cable). FIG. 15A also includes a side view of the computer system 100 on the stand 15000 in the lower right corner of FIG. 15A. In FIG. 15A, the display of the computer system 100 is in a low power or off state (e.g., the computer system 100 is not displaying any content via the display of the computer system 100). In some embodiments, the computer system 100 meets criteria for operating in an ambient mode (e.g., an ambient mode as described above with reference to FIGS. 5A-9AA). For example, the criteria for operating in the ambient mode require that the display of the computer system 100 be in a landscape orientation and that the computer system 100 be connected to the charging source 5056 via the stand 15000 (e.g., and optionally, both conditions are met for at least a threshold amount of time (e.g., 1 second, 2 seconds, 5 seconds, 10 seconds, 15 seconds, 30 seconds, or 1 minute)).

In FIG. 15B, the computer system 100 detects the presence of a person. In some embodiments, the computer system 100 detects the presence of a person when a body part of the person is detected within a threshold distance (e.g., 5 cm, 10 cm, 25 cm, 50 cm, 1 m, 2 m or 5 m) of the computer system 100 (e.g., or one or more sensors of the computer system 100). In FIG. 15B, the computer system 100 detects a hand 15002 of the person within the threshold distance of the computer system 100 (e.g., the display of the computer system 100). As shown in the side view, the hand 15002 is not in physical contact with the computer system 100.

In some embodiments, detecting the presence of a person includes detecting a hand of the person performing a predefined gesture (e.g., an air tap, and air pinch, or another air gesture, as described herein). In some embodiments, detecting the presence of the person includes detecting a body part of the person in a predefined orientation and/or configuration. For example, the computer system 100 detects the presence of the person when the computer system 100 detects the hand 15002 in an upright position with the palm of the hand 15002 facing the computer system 100, and with the fingers of the hand 15002 extended. While FIG. 15B illustrates a first example orientation and configuration of the hand 15002, the methods described herein can be applied to any suitable orientation and/or configuration (e.g., a back of the hand 15002 facing the computer system 100, a hand configuration in which a first number of fingers are extended while a second number of fingers are not extended, or a hand configuration in which the hand 15002 makes a fist).

In some embodiments, detecting the presence of a person includes detecting movement of the person (e.g., or a body part of the person), and/or detecting a predefined type of movement of the person (e.g., or a body part of the person). For example, the presence of the person is detected when the computer system 100 detects movement of the hand 15002 waving back and forth in front of the display of the computer system 100 (e.g., moving back and forth in a plane that is substantially parallel to the display of the computer system 100, without substantial movement of the hand 15002 closer to or further from the display of the computer system 100). For example, the presence of the person is detected when the computer system 100 detects movement of the hand 15002 moving towards and/or away from the display of the computer system 100 (e.g., in a pushing and/or pulling motion). In some embodiments, the criteria for “detecting the presence of the person” are configurable (e.g., the computer system 100 can be configured to enable detecting the presence of a person via detecting movement of the person, via the “Motion to Wake” setting 5166 described above with reference to FIG. 5AM).

In some embodiments, detecting the presence of a person includes detecting vibration of the computer system 100 (e.g., vibrations corresponding to an external impact on a supporting surface of the computer system 100, direct impact with the computer system 100 itself, and/or vibrations that exceed a threshold amount of vibration). In some embodiments, the computer system 100 can be configured to detect the presence of a person at least in part based on vibration of the computer system 100, in addition to, or in place of, the other forms of “detecting the presence of the person” described above (e.g., through settings such as the “Bump to Wake” option 5146 described with reference to FIG. 5AL).

In response to detecting the presence of the person (e.g., the hand 15002, or another portion of the person), the computer system 100 updates the displayed content that is displayed via the display of the computer system 100, and displays the user interface 9002 (e.g., the same user interface 9002 or another analogous user interface as described above with reference to FIGS. 9B-9G). In some embodiments, updating the displayed content includes displaying at least some content that was not previously displayed (e.g., in FIG. 15A, no content is displayed; and in FIG. 15B, the user interface 9002 is displayed). In some embodiments, updating the displayed content includes increasing an amount of content (e.g., information) that is displayed. In some embodiments, updating the displayed content includes ceasing to display (e.g., removing) some previously displayed content. In some embodiments, updating the displayed content includes increasing or decreasing a brightness with which content is displayed (e.g., in FIG. 15A, one or more features of the user interface 9002 are displayed (e.g., as an “always on” user interface element), and in FIG. 15B, the one or more features of the user interface 9002 are displayed with an increased brightness, in response to detecting the hand 15002 in proximity to the computer system 100). In some embodiments, updating the displayed content includes increasing or decreasing a size with which content is displayed.

In FIG. 15C, the computer system 100 detects movement of the hand 15002 waving back and forth in front of the display of the computer system 100 (e.g., moving back and forth in a plane that is substantially parallel to the display of the computer system 100, without substantial movement of the hand 15002 closer to or further from the display of the computer system 100). In the side view, the hand 15002 would be moving into and out of the page. In response to detecting the movement of the hand 15002, the computer system 100 updates the displayed content to display the user interface 9008 (e.g., the same user interface 9008 or another analogous user interface as described above with reference to FIGS. 9E-9F and 9Q-9R).

In some embodiments, the computer system 100 updates the displayed content differently depending on one or more characteristics of the person (e.g., the hand 15002) that is detected. For example, in response to detecting the presence of the person (e.g., the hand 15002, held substantially stationary, with fingers extended and the palm facing the display of the computer system 100), the computer system 100 updates the displayed content to display the user interface 9002 (e.g., from previously displaying no content); and in response to detecting the hand 15002 waving back and forth before the display of the computer system 100, the computer system 100 updates the displayed content to display the user interface 9008.

In FIG. 15D, the person is no longer waving the hand 15002 back and forth in front of the display of the computer system 100, and the computer system 100 updates the displayed content to display (e.g., redisplay) the user interface 9002.

In FIG. 15E, the hand 15002 is no longer within the threshold distance of the computer system 100 (e.g., the computer system 100 no longer detects the presence of the person), and the computer system 100 updates the displayed content (e.g., by ceasing to display the user interface 9002 and returning to the display off state in FIG. 15A.

FIGS. 15F-15J illustrate human interactions with the computer system 100 in a different context. In FIG. 15F, the computer system 100 displays the alarm user interface 9040 (e.g., the same alarm user interface 9040 or an analogous alarm user interface as described above with reference to FIGS. 9V and 9W), and generates audio (e.g., audio corresponding to an active alarm that triggers at the current time 9:00).

In FIG. 15G, the computer system 100 detects the presence of the hand 15002 (e.g., in a predefined orientation and/or configuration, and/or performing a predefined gesture such as an air gesture). In response to detecting the presence of the hand (e.g., the hand 15002), the computer system 100 snoozes (e.g., temporarily suppresses) the alarm and updates the displayed content (e.g., ceases to display the alarm user interface 9040).

In FIG. 15H, after a predefined snooze time period (e.g., 9 minutes, or another period of time), the computer system 100 displays the alarm user interface 9044 (e.g., the same alarm user interface 9044 or another analogous alarm user interface described above with reference to FIGS. 9X and 9Y).

In FIG. 151, the computer system 100 detects movement of the hand 15002 towards the display of the computer system 100. In response to detecting the movement of the hand 15002 towards the display of the computer system 100 (e.g., as also shown in the side view), the computer system 100 updates the displayed content to display the user interface 9040 being “pushed off” the display (e.g., the alarm user interface 9040 is shifted upwards on the display of the computer system 100, and an upper portion of the alarm user interface 9040 ceases to be displayed).

The widget 7006 and the widget 7008 (e.g., the same widget 7006 and the same widget 7008 described above with reference to FIG. 7C, which are optionally widgets that are included in a widget user interface such as the widget user interface 5078 described with reference to FIG. 5S) are also displayed in the portions of the display that previously included the alarm user interface 9040 (e.g., prior to the alarm user interface 9040 being shifted upwards). In some embodiments, the widget 7006 and the widget 7008 are displayed with an appearance of being “underneath” the alarm user interface 9040, such that the alarm user interface 9040 is being “pushed off” the display to reveal the widget 7006 and the widget 7008.

In FIG. 15J, the computer system 100 detects continued movement of the hand 15002 towards the display of the computer system 100. As compared to FIG. 151, the hand 15002 in FIG. 15J is closer to the display of the computer system 100. In response to detecting the continued movement of the hand 15002 (e.g., and/or in response to detecting that the hand 15002 has moved by a threshold distance towards the display of the computer system 100, and/or in response to detecting that the hand 15002 has moved to a position that is a threshold distance from the display of the computer system 100), the computer system 100 ceases to display the alarm user interface 9040 (e.g., the alarm user interface 9040 is fully or completely “pushed off” the display) and displays (e.g., the entirety of, or substantially the entirety of) the widget 7006 and the widget 7008.

In some embodiments, the computer system 100 displays an animated transition of the alarm user interface 9040 being “pushed off” the display, as the hand 15002 moves from the position in FIG. 151 to the position in FIG. 15J (e.g., an animated transition that begins with the alarm user interface 9040 occupying the entire display of the computer system 100, has intermediate states where the alarm user interface 9040 is progressively “pushed off” the display to reveal more and more of the widget 7006 and the widget 7008, and ends when the alarm user interface 9040 is completely “pushed off” the display and is no longer displayed).

In some embodiments, the computer system 100 displays (e.g., a widget user interface that includes) the widget 7006 and the widget 7008, because the computer system 100 meets the criteria for the computer system 100 to operate in the ambient mode (e.g., and the widget user interface is configured to be displayed while the computer system 100 operates in the ambient mode). In some embodiments, the computer system 100 displays a different user interface that is available for display while the computer system 100 operates in the ambient mode (e.g., the clock user interface 5058 described with reference to FIG. 5M, the home control user interface 5086 described with reference to FIG. 5T, the voice memo user interface 6074 described with reference to FIG. 6O, the ambient sound user interface 6090 described with reference to FIG. 6Q, and/or the media user interface 6098 described with reference to FIG. 6S). In some embodiments, a person can navigate between different user interfaces while the computer system 100 operates in the ambient mode, as described above with reference to FIGS. 6A-6AN.

FIGS. 15K-15P illustrate human interactions with the computer system 100 in a different context. FIG. 15K illustrates the computer system 100 displaying the user interface 5118 (e.g., the same user interface 5118 described above with reference to FIGS. 5AA and 5AE). The user interface 5118 displays the current remaining time for an active timer (e.g., of a clock application) of the computer system 100, and includes a pause affordance 15004 (e.g., which when activated, pauses the active timer) and a stop affordance 15008 (e.g., which when activated, stops or cancels the active timer. In some embodiments, the user interface 5118 also includes a visual representation (e.g., the grey bar) of the current time remaining for the active timer, which optionally updates in real time as the active timer progresses.

In FIG. 15L, the computer system 100 detects the presence of the person (e.g., detects the hand 15002, optionally, in a predefined orientation and/or configuration). In response to detecting the presence of the person, the computer system 100 pauses the active timer (e.g., activates the pause affordance 15004). In some embodiments, the visual representation of the current time remaining for the active timer is displayed with a different appearance when the active timer is paused. For example, in FIG. 15L, the bar that represents the current time remaining for the active timer is displayed with a different appearance than in FIG. 15K (e.g., a diagonal striped pattern in FIG. 15L, as compared to a solid gray appearance in FIG. 15K).

The pause affordance 15004 is replaced with a start affordance 15008, which provides additional visual feedback that the active timer is paused, and also provides functionality for restarting the timer (e.g., by activating the start affordance 15008). In some embodiments, the active timer is restarted in response to detecting another input of the same type (e.g., each time the computer system 100 detects the presence of a person, and/or the hand 15002 in the predefined orientation and/or configuration, the computer system 100 switches between pausing and restarting the active timer). In some embodiments, the computer system 100 is configured to restart the timer in response to detecting a different type of input (e.g., detecting the hand 5002 with a back of the hand 5002 facing the display of the computer system 100).

FIG. 15M illustrates the computer system 100 detecting the hand 15002 in an orientation and/or configuration that is not a predefined orientation and/or configuration (e.g., or performing a predefined gesture). As shown in the side view, the hand 15002 has a configuration where the hand 15002 is pointing at the display of the computer system 100 (e.g., an index finger of the hand 15002 is extended towards the display of the computer system 100, and one or more other fingers of the hand 15002 are not extended), and the hand 15002 is not in physical contact with the computer system 100. In some embodiments, the computer system 100 is configured such that the computer system 100 does not respond to (e.g., perform any functions, such as pausing, stopping, or cancelling the active timer, in response to detecting) the hand 15002 in the orientation and/or configuration shown in FIG. 15M (e.g., because the computer system 100 is configured to accept touch inputs via the display of the computer system 100, which is a touch-sensitive surface, and performing functions in response to detecting the hand 15002 pointing at the display of the computer system 100 without physical contact with the display of the computer system 100, could result in the computer system 100 performing unintended functions as the hand 15002 approaches the display of the computer system 100 in order to perform touch inputs).

In FIG. 15N, the computer system 100 detects a touch input (e.g., physical contact between the hand 15002 and the display generation component of the computer system 100), directed to the pause affordance 15004 (e.g., shown in FIG. 15M), In response to detecting the touch input, the computer system 100 pauses the active timer (e.g., and displays the visual indicator of the current time remaining for the active timer with the different appearance), and replaces the pause affordance 15004 with the start affordance 15008.

In FIG. 15O, the computer system 100 detects movement of the hand 15002 towards the display of the computer system 100 (e.g., analogous movement of the hand 5002, as described above with reference to FIG. 151). In response to detecting the movement of the hand 15002 towards the display of the computer system 100 (e.g., as also shown in the side view), the computer system 100 updates the displayed content to display the user interface 5118 being “pushed off” the display (e.g., the user interface 5118 is shifted upwards on the display of the computer system 100, and an upper portion of the user interface 5118 ceases to be displayed).

The media user interface 6098 (e.g., the same media user interface 6098 described above with reference to FIG. 6S) is also displayed in the portion of the display that previously included the user interface 5118 (e.g., prior to the user interface 5118 being shifted upwards). In some embodiments, the media user interface 6098 is displayed with an appearance of being “underneath” the user interface 5118, such that the user interface 5118 is being “pushed off” the display to reveal the media user interface 6098.

In FIG. 15P, the computer system 100 detects continued movement of the hand 15002 towards the display of the computer system 100. As compared to FIG. 150, the hand 15002 in FIG. 15P is closer to the display of the computer system 100. In response to detecting the continued movement of the hand 15002 (e.g., and/or in response to detecting that the hand 15002 has moved by a threshold distance towards the display of the computer system 100, and/or in response to detecting that the hand 15002 has moved to a position that is a threshold distance from the display of the computer system 100), the computer system 100 ceases to display the user interface 5118 (e.g., the user interface 5118 is fully or completely “pushed off” the display) and displays (e.g., the entirety of) the media user interface 6098. In some embodiments, the computer system 100 displays an animated transition of the user interface 5118 being “pushed off” the display, as the hand 15002 moves from the position in FIG. 150 to the position in FIG. 15P (e.g., an animated transition that begins with the user interface 5118 occupying the entire display of the computer system 100, has intermediate states where the user interface 5118 is progressively “pushed off” the display to reveal more and more of the media user interface 6098, and ends when the user interface 5118 is completely “pushed off” the display and is no longer displayed).

In some embodiments, the behaviors described above with reference to FIGS. 15A-15P are applicable as long as the computer system 100 operates in the ambient mode (e.g., regardless of what is displayed via the display of the computer system 100).

In some embodiments, the behaviors described above (e.g., detecting the presence of a person in proximity to the computer system 100 and/or updating displayed content) with reference to FIGS. 15A-15P are applicable while the computer system 100 operates in a specific (e.g., ambient) mode (e.g., a “Night Mode” or other specific ambient mode of the computer system 100) and/or while the computer system 100 displays a specific user interface (e.g., the clock user interface 9002 that corresponds to a “Night Mode” or other specific ambient mode of the computer system 100). In some embodiments, the behaviors described above are applicable only when criteria for operating in a specific (e.g., ambient) mode are met (e.g., the computer system 100 detects that the current time is within a first range of time of the day (e.g., 10 PM and 7 AM); the computer system 100 detects that the current time is within a scheduled sleep time period for the computer system 100 and/or a scheduled time period corresponding to the “Night Mode”; and/or the computer system 100 detects that a current level of ambient light is below a threshold level of ambient light).

FIG. 15Q illustrates the computer system 100 when the computer system 100 is not operating in the ambient mode. For example, in FIG. 15Q, the computer system 100 is connected to the charging source 5056, but the display of the computer system 100 is not in the landscape orientation (e.g., the computer system 100 is instead laying flat on a surface such as a desk or table). Because the computer system 100 does not meet the criteria to operate in the ambient mode, the computer system 100 displays a regular lock screen of the computer system 100 (e.g., instead of one of the user interfaces that correspond to the ambient mode of the computer system 100). In some embodiments, the computer system 100 does not display any user interface (e.g., the display of the computer system 100 is off state or a low power state, such as the state described above with reference to FIG. 5A).

Further, when (e.g., and/or while) the computer system 100 does not satisfy the criteria to operate in the ambient mode, the computer system 100 does not respond to a person's presence (e.g., the presence of the hand 15002 above the computer system 100, or movement of the hand 15002 in proximity to the computer system 100). In some embodiments, when (e.g., and/or while) the computer system 100 does not satisfy the criteria to operate in the ambient mode, the computer system 100 does not attempt to detect presence of a person.

While FIGS. 15A-15Q illustrate specific user interfaces for which the computer system 100 updates displayed content, it is understood that the descriptions above are applicable to any suitable user interface (e.g., any suitable user interface illustrated in, and/or described with reference to, FIGS. 5A-5AK, FIGS. 6A-6AN, FIGS. 7A-7B, FIGS. 8A-8K, and FIGS. 9A-9AA), and the displayed content can be updated in any suitable fashion (e.g., as illustrated in and/or described with reference to FIGS. 5A-5AK, FIGS. 6A-6AN, FIGS. 7A-7B, FIGS. 8A-8K, and FIGS. 9A-9AA). For example, the interactions with the user interface 5118, in FIGS. 15K-15P, are applicable to other ambient mode user interface, such as the widget user interface 5078 described with reference to FIG. 5S, which can be interacted with as illustrated and described with reference to FIGS. 7A-7V.

FIGS. 16A-16F are flow diagrams illustrating method 16000 for updating displayed content when presence criteria are met, in accordance with some embodiments. Method 16000 is performed at a computer system (e.g., device 300, FIG. 3, or portable multifunction device 80, FIG. 1A) that is in communication with a display generation component (e.g., touch screen 112, FIG. 1A, or display 340, FIG. 3) and one or more sensors (e.g., one or more optical sensors 164 and/or one or more proximity sensors 166, FIG. 1A, or sensor(s) 359, FIG. 3). In some embodiments, the display is a touch-screen display and the touch-sensitive surface is on or integrated with the display. In some embodiments, the display is separate from the touch-sensitive surface. Some operations in method 16000 are, optionally, combined and/or the order of some operations is, optionally, changed.

Updating displayed content while remaining in a first mode, while the computer system is operating in a first mode that is active while first criteria are met, and in response to detecting the presence of a person in proximity to a computer system without detecting contact of the person with the computer system, provides additional control options and/or functionality for the computer system (e.g., control options and/or functionality for updating displayed content, displaying content that was not previously displayed, and/or enabling human interaction with displayed content) without requiring physical contact with the computer system (e.g., enabling interactions from a distance, enabling interactions when the person's hands and/or other body parts are not available for physical interaction with the computer system, and/or enabling interactions when it would be inconvenient or undesirable for the person to physically interact with the computer system), and also provides additional functionality without needing to display additional controls (e.g., additional controls that a person touches and/or physically interacts with). For example, the claimed invention enables interaction with the computer system even if the person's hands are full or otherwise preoccupied (e.g., carrying objects and/or interacting with other object other than the computer system). This also enables interaction with the computer system in scenarios while minimizing the spread of germs or other contaminants, via a touch-sensitive surface of the computer system, particularly for computer systems that are used and/or available to multiple different people and/or in higher risk environments (e.g., doctor's offices, hospitals, and/or children's classrooms). This also enables streamlines user interface with the computer system, for example, if the person is cooking and/or eating, as the person does not need to clean the person's hands before interacting with the computer system (e.g., rather than risk damaging or dirtying a touch-sensitive surface of the computer system, and/or rather than risk inconsistent detecting of touch inputs because the person's hands are covered in food or other substances that inhibit detection of physical contact by the person).

In some embodiments, the method 16000 is performed at a computer system including a display generation component (e.g., a touch-sensitive display, a LED display, a stereoscopic display, a head-mounted display, a heads-up display, or another type of display generation component, that is in communication with the computer system and/or integrated with the computer system) and one or more sensors (e.g., cameras, touch-sensors, proximity sensors, motion sensors, light sensors, heat sensors, and/or other sensors in communication with the computer system and/or integrated with the computer system). While the computer system is operating in a first mode (e.g., a first restricted mode, a respective mode that is different from a second restricted mode or a normal mode of the computer system, wherein the computer system enters the first mode (e.g., from the second restricted mode and/or from the normal mode) when a first set of conditions for transitioning from the normal mode into the second restricted mode have been met (e.g., power button is pressed to turn off the display, prolonged inactivity by the user, and/or user input to display the wake screen or coversheet screen) and a second set of conditions for transitioning from the second restricted mode to the first mode have also been met (e.g., orientation condition, charging condition, and/or device stillness condition)), wherein the computer system operates in the first mode while first criteria are met (e.g., the computer system starts operating in the first mode when the first criteria are met and/or stops operating in the first mode when the first criteria cease to be met) (e.g., first set of condition and the second set of conditions have both been met at the same time, or one set of conditions are met while the other set of conditions have already been met) (e.g., in FIG. 15A, the display generation component of the computer system 100 is in the landscape orientation and the computer system 100 is connected to charging source 5056 via the stand 15000), the computer system detects (16002), via the one or more sensors, a presence of a person (e.g., a recognized user associated with the computer system, or a person irrespective of an association between the person and the computer system) in proximity to the computer system without detecting contact of the person with the computer system (e.g., detecting the user and/or a person, or a body part of the user and/or person within a field of view of at least one sensor of the one or more sensors; detecting a first hand gesture, hand position, and/or body position; detecting a first movement of the user and/or person, and/or a body part of the user and/or person in proximity to the computer system; and/or detecting the user and/or person or a portion of the body of the user and/or person coming within a threshold distance of the computer system without making contact with the computer system) (e.g., in FIG. 15B, the computer system 100 detects the hand 15002 in proximity to the computer system 100). In some embodiments, the computer system scans, via the one or more sensors, the environment for indications that a person (e.g., as opposed to another moving object or pets) is present in proximity to the computer system without detecting contact of the person with the computer system. In some embodiments, the computer system scans, via the one or more sensors, the environment for indications that a user associated with the computer system is present in proximity to the computer system without detecting contact of the user with the computer system. In some embodiments, the computer system distinguishes between the user that is associated with the computer system from other persons that are not associated with the computer system, and provide different responses (e.g., displays different information via the display generation component, and/or ignores the presence of a person who is not a user associated with the computer system) depending on whether the person detected is the user associated with the computer system or a person who is not associated with the computer system.

In response to detecting the presence of the person in proximity to the computer system without detecting contact of the person with the computer system, the computer system updates (16004) displayed content (e.g., content of a respective customizable user interface described with respect to FIGS. 5A-5AT, FIGS. 6A-6AN, FIGS. 7A-7V, FIGS. 8A-8K and/or FIGS. 9A-9AA; and/or content of a sleep clock, content of a respective user interface of an application that is associated with the first mode, and/or other displayed content) that is displayed via the display generation component of the computer system, while remaining in the first mode (e.g., the computer system 100 initially displays no content in FIG. 15A, and updates the displayed content to display the clock user interface 9002 in response to detecting the hand 15002 in proximity to the computer system 100 without contacting the computer system 100). In some embodiments, the computer system displays no content prior to detecting the presence of a person (e.g., the display of the computer system is turned off), and in response to detecting the presence of the person, the computer system displays content (e.g., in a user interface of the respective customizable user interface described with respect to FIGS. 5A-5AT, FIGS. 6A-6AN, FIGS. 7A-7V, FIGS. 8A-8K and/or FIGS. 9A-9AA, or in another user interface of an application that corresponds to the first mode). In some embodiments, the display generation component is operating in a reduced power mode, such as a dimmed always-on mode, and/or a reduced content mode in which a respective user interface that is displayed prior to entering the first mode is reduced to include less content (e.g., simplified versions of the content, and/or fewer user interface objects) and/or has a reduced level of visual prominence (e.g., through changes in one or more display parameters (e.g., brightness, color saturation, translucency, and/or other display parameters that affect visual prominence of content) of the respective user interface).

In some embodiments, the first criteria include (16006) a first criterion that is met when the computer system is connected to a power source (e.g., a physical charging cable, a wireless charger, or a long-range wireless charging source). In some embodiments, more details on the first criteria for entering the first mode are provided with respect to FIGS. 5A-5AT. In some embodiments, the computer system does not require all of the conditions described with respect to the first criteria in FIGS. 5A-5AT to be met in order to enter the first mode. In some embodiments, the computer system requires one or more conditions that are different from the conditions described with respect to the first criteria in FIGS. 5A-5AT to be met in order to enter the first mode. For example, in FIGS. 15A-15P, the computer system 100 is connected to the charging source 5056 (e.g., via the stand 15000), and the computer system 100 updates displayed content in various ways in response to detecting the hand 15002 in proximity to the computer system 100 (e.g., without contacting the computer system 100). The clock user interface 9002, which was not displayed in FIG. 9A, is displayed in response to detecting the hand 15002 in FIG. 9B. The clock user interface 9008, which includes additional time content that is not included in the clock user interface 9002 in FIG. 9B, and is displayed in response to detecting back and forth movement of the hand 15002 in FIG. 9C. In contrast, as described with reference to FIG. 15Q, in some embodiments, if the computer system 100 is not connected to the charging source 5056, the computer system 100 does not respond to the presence of the hand 15002 (e.g., and/or does not attempt to detect presence of a person). Updating displayed content while remaining in a first mode, while the computer system is operating in a first mode that is active while the computer system is connected to a power source, and in response to detecting the presence of a person in proximity to a computer system without detecting contact of the person with the computer system, provides additional control options and/or functionality for the computer system (e.g., control options and/or functionality for updating displayed content, displaying content that was not previously displayed, and/or enabling human interaction with displayed content) without requiring physical contact with the computer system (e.g., enabling interactions from a distance, enabling interactions when the person's hands and/or other body parts are not available for physical interaction with the computer system, and/or enabling interactions when it would be inconvenient or undesirable for the person to physically interact with the computer system), and also provides additional functionality without needing to display additional controls (e.g., additional controls that a person touches and/or physically interacts with).

In some embodiments, the first criteria include (16008) a second criterion that is met when the display generation component of the computer system has a first orientation (e.g., an orientation that corresponds to a resting and/or plugged—in state on a stand, a landscape orientation with the long edges of the display region parallel or substantially parallel to the floor or to a stand of the computer system, a portrait orientation with the short edges of the display region parallel or substantially parallel to the floor or a stand of the computer system, and/or with the display region within a threshold angular range (e.g., 0-20 degrees, 0-15 degrees, or another angular range corresponding to a comfortable viewing angle for an upright viewer and/or a reclined viewer) of a downward direction of the physical environment (e.g., the direction of gravity, and/or a direction perpendicular to a floor or table top in the physical environment)). For example, in FIGS. 15A-15P, the display generation component of the computer system 100 is the landscape orientation (e.g., while on the stand 15000), and the computer system 100 updates displayed content in various ways in response to detecting the hand 15002 in proximity to the computer system 100 (e.g., without contacting the computer system 100). The clock user interface 9002, which was not displayed in FIG. 9A, is displayed in response to detecting the hand 15002 in FIG. 9B. The clock user interface 9008, which includes additional time content that is not included in the clock user interface 9002 in FIG. 9B, and is displayed in response to detecting back and forth movement of the hand 15002 in FIG. 9C. In contrast, as described with reference to FIG. 15Q, in some embodiments, if the computer system 100 is not connected to the charging source 5056, the computer system 100 does not respond to the presence of the hand 15002 (e.g., and/or does not attempt to detect presence of a person). Updating displayed content while remaining in a first mode, while the computer system is operating in a first mode that is active while the display generation component of the computer system has the first orientation, and in response to detecting the presence of a person in proximity to a computer system without detecting contact of the person with the computer system, provides additional control options and/or functionality for the computer system (e.g., control options and/or functionality for updating displayed content, displaying content that was not previously displayed, and/or enabling human interaction with displayed content) without requiring physical contact with the computer system (e.g., enabling interactions from a distance, enabling interactions when the person's hands and/or other body parts are not available for physical interaction with the computer system, and/or enabling interactions when it would be inconvenient or undesirable for the person to physically interact with the computer system), and also provides additional functionality without needing to display additional controls (e.g., additional controls that a person touches and/or physically interacts with).

In some embodiments, while the computer system is operating in the first mode, the computer system detects (16010) that the first criteria are no longer met (e.g., the computer system is disconnected from the power source, the computer system is moved by more than a threshold amount, the orientation of the computer system is changed from the first orientation to another orientation, and/or a user input that corresponds to a request to dismiss the first mode (e.g., an upward swipe from the bottom edge of the display, a press on the power button, and/or other type of dismissal input) is detected); and in response to detecting that the first criteria are no longer met, the computer system transitions from the first mode to a second mode of the computer system, wherein: the second mode includes a locked mode in which one or more operations (e.g., displaying a home screen user interface, and/or providing full access to an application installed on the computer system) that are available in an unlocked mode (e.g., the normal mode, and/or or a third mode displaying a user interface of an application or the home screen after dismissing the respective user interface of the locked mode in response to a dismissal input (e.g., an upward swipe gesture from the bottom portion of the respective user interface, a press on a home button, and/or other dismissal input)) are not available in the locked mode; and while in the second mode, the computer system displays a respective user interface that corresponds to the locked mode of the computer system (e.g., displaying a lock screen, a wake screen user interface, or a coversheet user interface). In some embodiments, the second mode of the computer system includes an authenticated state, an unauthenticated state, a low-power state, or another state in which the computer system provides reduced functionality as compared to the unlocked mode, such as a normal mode of the computer system and/or a mode which is enabled to display a home screen user interface and an application that provides normal and/or unrestricted access to functionality of the application. For example, in FIG. 15Q, the computer system 100 does not satisfy the criteria to operate in the ambient mode (e.g., because the computer system 100 is not connected to the charging source 5056 and/or the display of the computer system 100 is not in the landscape orientation), and the computer system 100 displays a regular lock screen of the computer system 100. Transitioning from the first mode to the second mode of the computer system, including displaying a respective user interface that corresponds to the locked mode of the computer system, in response to detecting that the first criteria are no longer met, automatically displays an appropriate user interface without requiring additional user inputs (e.g., additional user inputs to transition out of the first mode, additional user inputs to enter the second mode, and/or additional user inputs to display the respective user interface that corresponds to the locked mode of the computer system.

In some embodiments, updating the displayed content that is displayed via the display generation component of the computer system includes (16012) increasing a visual prominence of at least a respective portion of the displayed content (e.g., some or all of textual content, image(s), background, wallpaper, user interface objects, and/or other displayed content) by adjusting one or more display parameters of the respective portion of the displayed content (e.g., changing the brightness, contrast, color saturation, opacity, and/or other display parameters of one or more portions of the displayed content to increase the visual prominence of the at least a portion of the displayed content relative to a previous appearance of the at least a portion of the displayed content before detecting the presence of the user in proximity to the computer system). For example, as described with reference to FIG. 15B, in some embodiments, updating the displayed content includes increasing or decreasing a brightness with which content is displayed (e.g., in FIG. 15A, one or more features of the user interface 9002 are displayed (e.g., as an “always on” user interface element), and in FIG. 15B, the one or more features of the user interface 9002 are displayed with an increased brightness, in response to detecting the hand 15002 in proximity to the computer system 100). Increasing a visual prominence of at least a respective portion of the displayed content by adjusting one or more display parameters of the respective portion of the displayed content, in response to detecting the presence of the person in proximity to the computer system without detecting contact of the person with the computer system, provides additional control options and/or functionality for the computer system (e.g., control options and/or functionality for updating displayed content, displaying content that was not previously displayed, and/or enabling human interaction with displayed interactions from a distance, enabling interactions when the person's hands and/or other body parts are not available for physical interaction with the computer system, and/or enabling interactions when it would be inconvenient or undesirable for the person to physically interact with the computer system), and also provides additional functionality without needing to display additional controls (e.g., additional controls that a person touches and/or physically interacts with).

In some embodiments, updating the displayed content (e.g., that is displayed via the display generation component of the computer system) includes (16014) increasing information density of the displayed content by displaying additional content (e.g., textual content, images, user interface objects, and/or other content) that was not displayed at a time prior to detecting the presence of the user in proximity to the computer system. For example, in FIG. 15B, the clock user interface 9002 includes a first amount of information (e.g., an hour value corresponding to a current time). In response to detecting back and forth movement of the hand 15002 in FIG. 15C, the computer system 100 displays the clock user interface 9008 that includes additional content (e.g., a minute value corresponding to the current time) not displayed in the clock user interface 9002 of FIG. 15B. Increasing information density of the displayed content by displaying additional content that was not displayed at a time prior to detecting the presence of the person in proximity of the computer system, in response to detecting the presence of the person in proximity to the computer system without detecting contact of the person with the computer system, provides additional control options and/or functionality for the computer system (e.g., control options and/or functionality for updating displayed content, displaying content that was not previously displayed, and/or enabling human interaction with displayed content) without requiring physical contact with the computer system (e.g., enabling interactions from a distance, enabling interactions when the person's hands and/or other body parts are not available for physical interaction with the computer system, and/or enabling interactions when it would be inconvenient or undesirable for the person to physically interact with the computer system), and also provides additional functionality without needing to display additional controls (e.g., additional controls that a person touches and/or physically interacts with).

In some embodiments, while the computer system is operating in a respective mode other than the first mode, the device does not perform (16016) an operation based on detecting a presence of a person in proximity to the computer system (e.g., while the computer system is operating in the second mode, and/or a third mode, such as the normal mode) (e.g., the computer system is not monitoring for the presence of a person in proximity to the computer system or the computer system forges detecting, via the one or more sensors, a presence of a person in proximity to the computer system and/or forgoing triggering performance of an operation based on detection of a presence of a person in proximity to the computer system). In some embodiments, the computer system deactivates sensors that are used to detect proximity of a person to the computer system in accordance with a determination that the computer system is not operating in the first mode. In some embodiments, while the computer system is operating in a second mode or a third mode different from the first mode, the computer system ignores detection of the presence of a person in proximity to the computer system and/or does not use the detection of the presence of a person in proximity to the computer system as an input to trigger performance of an operation in the second mode or third mode. For example, as described with reference to FIG. 15Q, in some embodiments, when (e.g., and/or while) the computer system 100 does not satisfy the criteria to operate in the ambient mode, the computer system 100 does not attempt to detect presence of a person. Not performing an operation based on detecting of a presence of a person in proximity to the computer system, while the computer system is operating in a respective mode other than the first mode, enables the computer system to update displayed content only when appropriate (e.g., the computer system does constantly expend power attempting to detect the presence of the person at all times).

In some embodiments, the first criteria require (16018) that the display generation component of the computer system is connected to a power source and is in a first orientation at the same time for at least a threshold amount of time in order for the first criteria to be met. For example, in FIGS. 15A-15P, the computer system 100 is connected to the charging source 5056 while the display of the landscape orientation (e.g., optionally, for at least a threshold amount of time, as described with reference to FIG. 15A), and the computer system 100 updates displayed content in various ways in response to detecting the hand 15002 in proximity to the computer system 100 (e.g., without contacting the computer system 100). The clock user interface 9002, which was not displayed in FIG. 9A, is displayed in response to detecting the hand 15002 in FIG. 9B. The clock user interface 9008, which includes additional time content that is not included in the clock user interface 9002 in FIG. 9B, and is displayed in response to detecting back and forth movement of the hand 15002 in FIG. 9C. In contrast, as described with reference to FIG. 15Q, in some embodiments, if the computer system 100 is not connected to the charging source 5056, the computer system 100 does not respond to the presence of the hand 15002 (e.g., and/or does not attempt to detect presence of a person). Updating displayed content while remaining in a first mode, while the computer system is operating in a first mode that is active while the computer system is connected to a power source and while the display generation component of the computer system has the first orientation, and in response to detecting the presence of a person in proximity to a computer system without detecting contact of the person with the computer system, provides additional control options and/or functionality for the computer system (e.g., control options and/or functionality for updating displayed content, displaying content that was not previously displayed, and/or enabling human interaction with displayed content) without requiring physical contact with the computer system (e.g., enabling interactions from a distance, enabling interactions when the person's hands and/or other body parts are not available for physical interaction with the computer system, and/or enabling interactions when it would be inconvenient or undesirable for the person to physically interact with the computer system), and also provides additional functionality without needing to display additional controls (e.g., additional controls that a person touches and/or physically interacts with).

In some embodiments, updating the displayed content includes (16020): updating display of one or more widgets (e.g., weather widget, stock widget, calendar widget, clock widget, and/or other widgets) on the display generation component (e.g., the one or more widgets are optionally displayed with a reduced level of visual prominence, reduced and/or content density prior to the update), wherein the one or more widgets respectively correspond to one or more applications, a respective widget of the one or more widgets includes respective application content from a respective application of the one or more applications, and the computer system automatically updates the respective widget from time to time when the respective application content is changed in the respective application (e.g., through receipt of notifications, background processes, occurrence of events, and/or base on user inputs detected within the respective application). Additional details regarding the appearance of, content displayed in, and/or functionality for interacting with, exemplary widgets, is described in further detail with reference to FIGS. 7A-7V. In some embodiments, updating display of one or more widgets includes retrieving and displaying the latest application content from the applications corresponding to the one or more widgets. In some embodiments, updating display of the one or more widgets includes increasing the visual prominence of the one or more widgets by adjusting the values of one or more display parameters of one or more portions of the one or more widgets. In some embodiments, updating display of the one or more widgets includes increasing the content density of the one or more widgets, for example, by displaying additional information, text, images, user interface objects, and/or controls in the one or more widgets that were not displayed prior to detecting the presence of the user in proximity to the computer system. For example, the interactions illustrated in and/or described with reference to FIGS. 15A-15Q are applicable to any suitable user interface. As described with reference to FIG. 15Q, in one example, the interactions with the user interface 5118, in FIGS. 15K-15P, are applicable to other ambient mode user interface, such as the widget user interface 5078 described with reference to FIG. 5S, which can be interacted with as illustrated and described with reference to FIGS. 7A-7V (e.g., which illustrates switching between different widgets, editing widgets, and/or displaying additional content in widgets). Updating display of one or more widgets, while the computer system is operating in a first mode that is active while first criteria are met, and in response to detecting the presence of a person in proximity to a computer system without detecting contact of the person with the computer system, provides additional control options and/or functionality for the computer system (e.g., control options and/or functionality for updating displayed content in one or more widgets, displaying widget content that was not previously displayed, and/or enabling human interaction with one or more widgets) without requiring physical contact with the computer system (e.g., enabling interactions from a distance, enabling interactions when the person's hands and/or other body parts are not available for physical interaction with the computer system, and/or enabling interactions when it would be inconvenient or undesirable for the person to physically interact with the computer system), and also provides additional functionality without needing to display additional controls (e.g., additional controls that a person touches and/or physically interacts with).

In some embodiments, updating the displayed content includes (16022): updating display of a clock user interface that displays a current time (e.g., a dimmed clockface, a simplified clockface, a clockface that indicates the current time relative to a scheduled time, such as an alarm time, a wake time, or another scheduled time). In some embodiments, updating display of the clock user interface includes increasing the visual prominence of the clock user interface by adjusting values of one or more display parameters of one or more portions of the clock user interface. In some embodiments, updating display of the clock user interface includes changing the format by which the current time is displayed from a first format (e.g., showing the hour without the minute, showing the hour and minute without the second, showing the time without tick marks or numerical values for the tick marks for the full hours, and/or showing relative time to a scheduled time without showing the absolute time) to a second format different from the first format (e.g., showing the time with more accuracy than the first format, showing the time with tick marks and numerical values for the tick marks, and/or showing absolute time as opposed to relative time to a scheduled time). For example, in FIG. 15A-15D, the computer system 100 displays and/or updates displayed content in a clock user interface (e.g., the clock user interface 9002 of FIG. 15B and/or the clock user interface 9008 in FIG. 15C), in response to detecting the hand 15002 in proximity to the computer system 100. Updating display of a clock user interface that displays a current time, while the computer system is operating in a first mode that is active while first criteria are met, and in response to detecting the presence of a person in proximity to a computer system without detecting contact of the person with the computer system, provides additional control options and/or functionality for the computer system (e.g., control options and/or functionality for updating displayed content in the clock user interface, displaying content for the clock user interface that was not previously displayed, and/or enabling human interaction with the clock user interface) without requiring physical contact with the computer system (e.g., enabling interactions from a distance, enabling interactions when the person's hands and/or other body parts are not available for physical interaction with the computer system, and/or enabling interactions when it would be inconvenient or undesirable for the person to physically interact with the computer system), and also provides additional functionality without needing to display additional controls (e.g., additional controls that a person touches and/or physically interacts with).

In some embodiments, while the computer system is operating in the first mode: in accordance with a determination that second criteria, different from the first criteria, are met (e.g., while the first criteria are also met), wherein the second criteria require that a current time corresponds to nighttime (e.g., a time between an hour in the late evening to an hour in the early morning, a time that corresponds to a scheduled sleep time for a user of the computer system, and/or a time after sundown and before sunrise, which are optionally determined, updated and/or adjusted based on a current location of the computer system and/or a current date (e.g., to accommodate geographical and/or seasonal factors that affect sunrise and sunset times)), the computer system enables (16024) the one or more sensors for detection of presence of a person in proximity to the computer system without detecting contact of a person with the computer system (and enabling updating displayed content based on detection of presence of a person in proximity to the computer system without the person making contact with the computer system); and in accordance with a determination that the first criteria are met and that the second criteria are not met, the computer system forgoes enabling the one or more sensors for detection of presence of a person in proximity to the computer system without detecting contact of a person with the computer system. For example, while the first criteria are met, but the current time is not nighttime, the computer system displays a respective customizable user interface (e.g., a widget user interface, a media display user interface, a timer user interface, or another customizable user interface described with respect to FIGS. 5A-5AT), without enabling human interaction with the computer system based on detection of a presence of a person in proximity to the computer system without detecting contact with the computer system by the person. For example, as described with reference to FIG. 15P, in some embodiments, the behaviors described with reference to FIGS. 15A-15P (e.g., detecting the presence of a person in proximity to the computer system 100 and/or updating displayed content), are applicable when the computer system 100 operates in a specific mode (e.g., a “Night Mode”). Enabling one or more sensors for detection of the presence of a person in proximity to the computer system without detecting contact of a person with the computer system in accordance with a determination that the current time corresponds to nighttime; and forgoing enabling the one or more sensors for detection of the presence of a person in proximity to the computer system without detecting contact of a person with the computer system in accordance with a determination that the current time does not correspond to nighttime, automatically enables the one or more sensors only in the appropriate contexts (e.g., to conserve power and/or reduce power consumption of the computer system, since the one or more sensors are not constantly enabled).

In some embodiments, the second criteria include (16026) a third criterion that is met when the current time is within a first range of time of the day (e.g., between 10 PM and 7 AM, between midnight and 6 AM, or a time between another hour in the late evening to another hour in the early morning, a time that corresponds to a scheduled sleep time for a user of the computer system, and/or a time after sundown and before sunrise). For example, in some embodiments, while operating in the first mode, in accordance with a determination that the first criteria are met and that the current time is not within the first range of time of the day, the computer system forgoes enabling the one or more sensors for detection of presence of a person in proximity to the computer system without detecting contact of the person with the computer system. For example, as described with reference to FIG. 15P, in some embodiments, the behaviors described with reference to FIGS. 15A-15P (e.g., detecting the presence of a person in proximity to the computer system 100 and/or updating displayed content), are applicable when the computer system 100 meets criteria for operating in a specific mode (e.g., the computer system 100 detects that the current time is within a first range of time of the day (e.g., 10 PM and 7 AM)). Enabling one or more sensors for detection of the presence of a person in proximity to the computer system without detecting contact of a person with the computer system in accordance with a determination that the current time is within a first range of time of the day; and forgoing enabling the one or more sensors for detection of the presence of a person in proximity to the computer system without detecting contact of a person with the computer system in accordance with a determination that the current time is not within the first range of time of the day, automatically enables the one or more sensors only in the appropriate contexts (e.g., to conserve power and/or reduce power consumption of the computer system, since the one or more sensors are not constantly enabled).

In some embodiments, the second criteria include (16028) a fourth criterion that is met when ambient light in a physical environment of the computer system is below a threshold level of brightness for at least a threshold amount of time (e.g., without natural light or artificial lighting for at least a half hour, an hour, and optionally, without a threshold level of ambient noise). For example, in some embodiments, while operating in the first mode, in accordance with a determination that the first criteria are met and that the ambient light in the physical environment of the computer system is not below the threshold level of brightness for at least the threshold amount of time, the computer system forgoes enabling the one or more sensors for detection of presence of a person in proximity to the computer system without detecting contact of the person with the computer system. For example, as described with reference to FIG. 15P, in some embodiments, the behaviors described with reference to FIGS. 15A-15P (e.g., detecting the presence of a person in proximity to the computer system 100 and/or updating displayed content), are applicable when the computer system 100 meets criteria for operating in a specific mode (e.g., the computer system 100 detects that a current level of ambient light is below a threshold level of ambient light). Enabling one or more sensors for detection of the presence of a person in proximity to the computer system without detecting contact of a person with the computer system in accordance with a determination that ambient light in a physical environment of the computer system is below a threshold level of brightness for at least a threshold amount of time; and forgoing enabling the one or more sensors for detection of the presence of a person in proximity to the computer system without detecting contact of a person with the computer system in accordance with a determination that the ambient light in the physical environment of the computer system is below the threshold level of brightness for at least the threshold amount of time, automatically enables the one or more sensors only in the appropriate contexts (e.g., to conserve power and/or reduce power consumption of the computer system, since the one or more sensors are not constantly enabled).

In some embodiments, the second criteria include (16030) a fifth criterion that is met when a current time is within a scheduled sleep time established on the computer system (e.g., a bedtime and a wake time established through settings of a sleep application, and/or a system application that manages a night mode in which interruptions and/or alerts are suppressed to facility better sleep for a user of the computer system). For example, in some embodiments, while operating in the first mode, in accordance with a determination that the first criteria are met and that the current time is not within a scheduled sleep time established on the computer system, the computer system forgoes enabling the one or more sensors for detection of presence of a user in proximity to the computer system without detecting contact of a person with the computer system. For example, as described with reference to FIG. 15P, in some embodiments, the behaviors described with reference to FIGS. 15A-15P (e.g., detecting the presence of a person in proximity to the computer system 100 and/or updating displayed content), are applicable when the computer system 100 meets criteria for operating in a specific mode (e.g., the computer system 100 detects that the current time is within a scheduled sleep time period for the computer system 100 and/or a scheduled time period corresponding to the “Night Mode”). Enabling one or more sensors for detection of the presence of a person in proximity to the computer system without detecting contact of a person with the computer system in accordance with a determination that the current time is within a scheduled sleep time established on the computer system; and forgoing enabling the one or more sensors for detection of the presence of a person in proximity to the computer system without detecting contact of a person with the computer system in accordance with a determination that the current time is not within the scheduled sleep time established on the computer system, automatically enables the one or more sensors only in the appropriate contexts (e.g., to conserve power and/or reduce power consumption of the computer system, since the one or more sensors are not constantly enabled).

In some embodiments, the second criteria include (16032) a sixth criterion that is met when the computer system displayed a clock user interface (e.g., a sleep clock that is reduced in visual prominence and accuracy as compared to a regular clock face, or a regular clock face that is dimmed) in the first mode. For example, in some embodiments, while operating in the first mode, in accordance with a determination that the first criteria are met and that the computer system is not displaying a clock user interface in the first mode, the computer system forgoes enabling the one or more sensors for detection of presence of a person in proximity to the computer system without detecting contact of the person with the computer system. For example, as described with reference to FIG. 15P, in some embodiments, the behaviors described with reference to FIGS. 15A-15P (e.g., detecting the presence of a person in proximity to the computer system 100 and/or updating displayed content), are applicable while the computer system 100 displays a specific user interface (e.g., the clock user interface 9002 that corresponds to a “Night Mode” or other specific ambient mode of the computer system 100). Enabling one or more sensors for detection of the presence of a person in proximity to the computer system without detecting contact of a person with the computer system in accordance with a determination that the current time corresponds to nighttime and that the computer system is displaying a clock user interface; and forgoing enabling the one or more sensors for detection of the presence of a person in proximity to the computer system without detecting contact of a person with the computer system in accordance with a determination that the current time does not correspond to nighttime or that the computer system is not displaying the clock user interface, automatically enables the one or more sensors only in the appropriate contexts (e.g., to conserve power and/or reduce power consumption of the computer system, since the one or more sensors are not constantly enabled).

In some embodiments, while the computer system is operating in the first mode, the computer system detects (16034), via the one or more sensors, absence of the presence of the person in proximity to the computer system (e.g., detecting that the person or a body part of the person has exited the field of view of at least one sensor of the one or more sensors; detecting absence of the first hand gesture, hand position, and/or body position; detecting absence of movement of the person and/or a body part of the person in proximity to the computer system; and/or detecting the person or a portion of the body of the person exiting the threshold distance of the computer system); and in response to detecting the absence of the presence of the person in proximity to the computer system, the computer system reverses at least some changes (e.g., reducing the visual prominence of at least a portion of the displayed content that had increased in visual prominence, ceasing to display the additional content that was displayed, and/or otherwise restoring the previous appearance of the displayed content that had been changed during the updating) that have been made to the displayed content when updating the displayed content in response to detecting the presence of the person in proximity to the computer system, while remaining in the first mode. For example, in FIG. 15E, the hand 15002 is no longer detected in proximity to the computer system 100, and the clock user interface 9002 that was displayed in FIG. 15D (e.g., when the hand 15002 was detected in proximity to the computer system 100) ceases to be displayed (e.g., FIG. 15E-15E are the reverse of FIGS. 15A-15B). Reversing at least some changes that have been made to the display content when updating the displayed content in response to detecting the presence of the person in proximity to the computer system and while remaining in the first mode, in response to detecting the absence of the presence of the person in proximity to the computer system,

In some embodiments, detecting, via the one or more sensors, the presence of the person in proximity to the computer system includes (16036) detecting movement of the person in proximity to the computer system (e.g., using one or more heat sensors, imaging sensors, light sensors, positions sensors, motion sensors, and/or other proximity sensors that senses movement of a person without requiring a contact with the sensors and/or the computer system). In some embodiments, detecting, via the one or more sensors, the presence of the person in proximity to the computer system includes detecting a respective amount of movement of an object in proximity to the computer system, and in accordance with a determination that the respective amount of movement of the object (e.g., a hand, a body, and/or another object that resembles a person or part thereof) is more than a threshold amount of movement (e.g., a threshold amount of distance, speed, and/or other characteristics of motion), determining that movement of a person is presence in proximity to the computer system; and in accordance with a determination that the respective amount of movement is less than the threshold amount of movement, determining that movement of a person is not present in proximity to the computer system. For example, in FIG. 15C, the computer system 100 detects movement of the hand 15002 waving back and forth in front of (e.g., in proximity of) the computer system 100, and the computer system 100 displays the clock user interface 9008 in response to detecting the movement of the hand 15002. For example, in FIGS. 151-15J and FIG. 150-15P, the computer system 100 detects movement of the hand 15002 towards the display of the computer system 100, and in response, the computer system 100 updates displayed content (e.g., switches to displaying a different user interface). Updating displayed content while remaining in a first mode, while the computer system is operating in a first mode that is active while first criteria are met, and in response to detecting movement of a person in proximity to a computer system without detecting contact of the person with the computer system, provides additional control options and/or functionality for the computer system (e.g., control options and/or functionality for updating displayed content, displaying content that was not previously displayed, and/or enabling human interaction with displayed content) without requiring physical contact with the computer system (e.g., enabling interactions from a distance, enabling interactions when the person's hands and/or other body parts are not available for physical interaction with the computer system, and/or enabling interactions when it would be inconvenient or undesirable for the person to physically interact with the computer system), and also provides additional functionality without needing to display additional controls (e.g., additional controls that a person touches and/or physically interacts with).

In some embodiments, detecting, via the one or more sensors, the presence of the person in proximity to the computer system includes (16038): detecting, via the one or more sensors, first movement of a hand in proximity to the computer system; and determining that the first movement of the hand corresponds to a first air gesture recognized by the computer system (e.g., an air gesture such as an air tap gesture, an air pinch gesture, a wave in the air, or another type of air gesture associated with a request for interaction with the computer system in the first mode). In some embodiments, the computer system enables the update to the displayed content on the display generation component in response to detecting that the first movement of the hand corresponds to the first air gesture recognized by the computer system. In some embodiments, in accordance with a determination that the first movement of the hand does not correspond to the first air gesture, the computer system determines that the presence of the person has not been detected in proximity to the computer system and does not update the displayed content on the display generation component in response to the first movement of the hand. For example, as described with reference to FIG. 15B, in some embodiments, detecting the presence of a person includes detecting a hand of the person performing a predefined gesture (e.g., an air tap, and air pinch, or another air gesture). Updating displayed content while remaining in a first mode, while the computer system is operating in a first mode that is active while first criteria are met, and in response to detecting first movement of a hand in proximity to the computer system that corresponds to a first air gesture recognized by the computer system, provides additional control options and/or functionality for the computer system (e.g., control options and/or functionality for updating displayed content, displaying content that was not previously displayed, and/or enabling human interaction with displayed content) without requiring physical contact with the computer system (e.g., enabling interactions from a distance, enabling interactions when the person's hands and/or other body parts are not available for physical interaction with the computer system, and/or enabling interactions when it would be inconvenient or undesirable for the person to physically interact with the computer system), and also provides additional functionality without needing to display additional controls (e.g., additional controls that a person touches and/or physically interacts with).

In some embodiments, in response to detecting the first movement of the hand in proximity to the computer system, and in accordance with determining that the first movement of the hand corresponds to the first air gesture, the computer system suppresses (16040) (e.g., reducing magnitude, silencing, pausing, turning off, and/or otherwise reducing the prominence of) a first alert that is being generated by the computer system (e.g., an audio output generated by an alarm that has been set off (e.g., based on time, and/or occurrence of other events or satisfaction of conditions), an alert generated by a running timer, media playback, and/or other audio and/or tactile outputs)). For example, in FIG. 15F, the computer system 100 displays the alarm user interface 9040 and generates audio, corresponding to an active alarm that triggers at the current time 9:00. In FIG. 15G, the computer system 100 detects the presence of the hand 15002 performing an air gesture, and in response, snoozes (e.g., temporarily suppresses) the alarm and ceases to display the alarm user interface 9040. Suppressing a first alert that is being generated by the computer system, while the computer system is operating in a first mode that is active while first criteria are met, and in response to detecting first movement of a hand in proximity to the computer system that corresponds to a first air gesture recognized by the computer system, provides additional control options and/or functionality for the computer system (e.g., functionality for suppressing and/or otherwise interacting with alerts generated by the computer system) without requiring physical contact with the computer system (e.g., enabling interactions from a distance, enabling interactions when the person's hands and/or other body parts are not available for physical interaction with the computer system, and/or enabling interactions when it would be inconvenient or undesirable for the person to physically interact with the computer system), and also provides additional functionality without needing to display additional controls (e.g., additional controls that a person touches and/or physically interacts with).

In some embodiments, in response to detecting the first movement of the hand in proximity to the computer system, and in accordance with determining that the first movement of the hand corresponds to the first air gesture, the computer system displays (16042), on the display generation component, additional information that was not displayed prior to detecting the first movement of the hand in proximity to the computer system (e.g., displaying weather information, more accurate time information, news, calendar events, and/or other information associated with the user interface that is selected for display in the first mode). For example, in FIG. 15B, the computer system 100 displays computer system 100 detects the presence of the hand 15002 performing an air gesture, and in response, displays the clock user interface 9002 that was not displayed prior to detecting the hand 15002 (e.g., in FIG. 15A). Displaying additional information that was not displayed prior to detecting first movement of a hand in proximity to the computer system, while the computer system is operating in a first mode that is active while first criteria are met, and in response to detecting the first movement of the hand in proximity to the computer system that corresponds to a first air gesture recognized by the computer system, provides additional control options and/or functionality for the computer system (e.g., control options and/or functionality for displaying content that was not previously displayed) without requiring physical contact with the computer system (e.g., enabling interactions from a distance, enabling interactions when the person's hands and/or other body parts are not available for physical interaction with the computer system, and/or enabling interactions when it would be inconvenient or undesirable for the person to physically interact with the computer system), and also provides additional functionality without needing to display additional controls (e.g., additional controls that a person touches and/or physically interacts with).

In some embodiments, determining (16044) that the first movement of the hand corresponds to the first air gesture is based on a determination that the hand has a first orientation (e.g., with a palm side of the hand facing the display generation component, with a back side of the hand facing the display generation component, with the fingers pointing toward the display generation component, with the fingers pointing in the upward direction relative to the display generation component, and/or with another orientation of the hand) relative to the display generation component during the first movement of the hand. For example, in FIG. 15B, the hand 15002 has a first orientation where a palm side of the hand facing the display generation component of the computer system 100, and in response to detecting the hand 15002 with the first orientation, the computer system 100 displays the clock user interface 9002 (e.g., that was not displayed prior to detecting the hand 15022, in FIG. 15A). Updating displayed content while remaining in a first mode, while the computer system is operating in a first mode that is active while first criteria are met, and in response to detecting first movement of a hand in proximity to the computer system, where the hand has a first orientation relative to the display generation component during the first movement of the hand, provides additional control options and/or functionality for the computer system (e.g., control options and/or functionality for updating displayed content, displaying content that was not previously displayed, and/or enabling human interaction with displayed content) without requiring physical contact with the computer system (e.g., enabling interactions from a distance, enabling interactions when the person's hands and/or other body parts are not available for physical interaction with the computer system, and/or enabling interactions when it would be inconvenient or undesirable for the person to physically interact with the computer system), and also provides additional functionality without needing to display additional controls (e.g., additional controls that a person touches and/or physically interacts with).

In some embodiments, the computer system detects (16046), via the one or more sensors, second movement of the hand in proximity to the computer system, including detecting that the second movement of the hand does not correspond to the first air gesture (e.g., the second movement of the hand corresponds to a second air gesture, or a precursor to a touch gesture on the computer system (e.g., movement of the hand toward the touch sensor with pointer extended toward the touch sensor, and/or another type of movement indicative of an intent to touch the computer system), and/or the second movement does not correspond to a recognized air gesture or the precursor of a touch gesture); and in response to detecting the second movement of the hand in proximity to the computer system, the computer system forgoes updating the displayed content on the display generation component (e.g., ignoring the second movement of the hand, optionally, until the hand makes contact with the computer system). For example, in FIG. 15M, the computer system 100 detects second movement of the and 15002 that does not correspond to an air gesture (e.g., the hand 15002 is pointing at the display generation component of the computer system 100, such that an index finger of the hand 15022 is extended towards the display generation component while one or more other fingers of the hand 15002 are not extended), and the computer system 100 does not respond to (e.g., perform any functions) the hand 15002 when the hand 15002 is pointing at the display generation component of the computer system 100. Forgoing updating the displayed content on the display generation component, in response to detecting second movement of the hand in proximity to the computer system that does not correspond to a first air gesture, and updating displayed content while remaining in a first mode, in response to detecting first movement of the hand in proximity to the computer system that corresponds to the first air gesture recognized by the computer system, provides additional control options and/or functionality for the computer system (e.g., control options and/or functionality for updating displayed content, displaying content that was not previously displayed, and/or enabling human interaction with displayed content) without requiring physical contact with the computer system (e.g., enabling interactions from a distance, enabling interactions when the person's hands and/or other body parts are not available for physical interaction with the computer system, and/or enabling interactions when it would be inconvenient or undesirable for the person to physically interact with the computer system), while reducing the risk of a person unintentionally triggering the updating of the displayed content (e.g., the second movement of the hand is a common movement (e.g. and/or the hand has a common orientation and/or posture of a hand during the second movement of the hand), and the first movement of the hand is an uncommon movement (e.g., and/or the hand has an uncommon or unnatural orientation and/or posture of the hand during the first movement of the hand), such that the first movement is difficult or unlikely to be performed unintentionally, while the second movement is easier and/or more likely to be performed unintentionally).

In some embodiments, the computer system detects (16048), via the one or more sensors (e.g., touch sensors, touch-sensitive surface, and/or touch-screen display of the computer system), a first contact between the hand and the computer system after detecting the second movement of the hand in proximity to the computer system; and in response to detecting the first contact between the hand and the computer system, in accordance with a determination that the first contact meets action criteria (e.g., includes a threshold amount of movement across the surface of the touch-screen display or touch-sensitive surface, meets first directional criteria, meets first intensity criteria, meets first duration criteria, and/or other criteria for triggering performance of an operation by the computer system), the computer system performs a first operation in accordance with an input provided by the first contact (e.g., an operation that is different from updating the displayed content on the display generation component in response to detecting the first air gesture). In some embodiments, performing the first operation includes activating a user interface object displayed on the display generation component, dismissing the currently displayed user interface on the display generation component, switching to another mode different from the first mode, and/or performing another operation corresponding to the touch input provided by the first contact. For example, in FIG. 15N, the computer system 100 detects a touch input (e.g., physical contact between the hand 15002 and the display generation component of the computer system 100), directed to the pause affordance 15004, and in response, pauses the active timer (e.g., and/or displays the visual indicator of the current time remaining for the active timer with the different appearance, and/or replaces the pause affordance 15004 with the start affordance 15008). Performing a first operation in accordance with an input provided by a first contact between the hand and the computer system, in response to detecting the first contact between the hand and the computer system that meets action criteria, forgoing updating the displayed content on the display generation component, in response to detecting second movement of the hand in proximity to the computer system that does not correspond to a first air gesture, and updating displayed content while remaining in a first mode, in response to detecting first movement of the hand in proximity to the computer system that corresponds to the first air gesture recognized by the computer system, provides additional control options and/or functionality for the computer system (e.g., control options and/or functionality for updating displayed content, displaying content that was not previously displayed, and/or enabling human interaction with displayed content) without requiring physical contact with the computer system (e.g., enabling interactions from a distance, enabling interactions when the person's hands and/or other body parts are not available for physical interaction with the computer system, and/or enabling interactions when it would be inconvenient or undesirable for the person to physically interact with the computer system), while reducing the risk of a person unintentionally triggering the updating of the displayed content (e.g., the second movement of the hand includes movement that is necessary to achieve the first contact between the hand and the computer system, and the computer system forgoes updating displayed content in response to detecting the second movement of the hand so that a person can achieve the first contact between the hand and the computer system without unintentionally updating displayed content during the second movement of the hand).

In some embodiments, determining (16050) that the first movement of the hand corresponds to the first air gesture recognized by the computer system is based on a determination that the hand has a first posture (e.g., with a threshold number of fingers (e.g., one, two, three, four, or five) outstretched, and/or with fingers relaxed and not in a fist, a closed posture, and/or a pointing posture) relative to the display generation component during the first movement of the hand. For example, in FIG. 15B, the computer system 100 detects the hand 15002 in a predefined configuration (e.g., first posture) with the palm of the hand 15002 facing the computer system 100, and with the fingers of the hand 15002 extended. Updating displayed content while remaining in a first mode, while the computer system is operating in a first mode that is active while first criteria are met, and in response to detecting first movement of a hand in proximity to the computer system, where the hand has a first posture relative to the display generation component during the first movement of the hand, provides additional control options and/or functionality for the computer system (e.g., control options and/or functionality for updating displayed content, displaying content that was not previously displayed, and/or enabling human interaction with displayed content) without requiring physical contact with the computer system (e.g., enabling interactions from a distance, enabling interactions when the person's hands and/or other body parts are not available for physical interaction with the computer system, and/or enabling interactions when it would be inconvenient or undesirable for the person to physically interact with the computer system), and also provides additional functionality without needing to display additional controls (e.g., additional controls that a person touches and/or physically interacts with).

In some embodiments, determining (16052) that the first movement of the hand corresponds to the first air gesture recognized by the computer system is based on a determination that the first movement of the hand includes back and forth movement of the hand (e.g., movement in the latitudinal direction, movement in the up and down direction, and/or movement in the depth direction) relative to the display generation component. For example, in FIG. 15C, the computer system 100 detects movement of the hand 15002 waving back and forth in front of (e.g., in proximity of) the computer system 100, and the computer system 100 displays the clock user interface 9008 in response to detecting the movement of the hand 15002. Updating displayed content while remaining in a first mode, while the computer system is operating in a first mode that is active while first criteria are met, and in response to detecting first movement of a hand, including back and forth movement of the hand relative to the display generation component, in proximity to the computer system, provides additional control options and/or functionality for the computer system (e.g., control options and/or functionality for updating displayed content, displaying content that was not previously displayed, and/or enabling human interaction with displayed interactions from a distance, enabling interactions when the person's hands and/or other body parts are not available for physical interaction with the computer system, and/or enabling interactions when it would be inconvenient or undesirable for the person to physically interact with the computer system), and also provides additional functionality without needing to display additional controls (e.g., additional controls that a person touches and/or physically interacts with).

In some embodiments, the computer system moves (16054) the display content on the display generation component in a first direction relative to the display generation component (e.g., pushing the displayed user interface backwards away from the surface of the display, or sliding the displayed user interface off to the side) in accordance with the first movement of the hand (e.g., with a direction, magnitude, speed, and/or other characteristics of movement based on the movement direction, movement magnitude, movement speed, and/or other characteristics of the first movement of the hand)). In some embodiments, the computer system moves the display content in a first direction, in accordance with the first movement of the hand in a first hand direction (e.g., which is optionally the same as, and/or corresponds to, the first direction), and moves the display content in a second direction (e.g., different from the first direction), in accordance with the first movement of the hand in a second hand direction (e.g., which is different than the first direction, and optionally, the same as the second direction). In some embodiments, the computer system moves the display content by a first distance in accordance with first movement of the hand that moves by a first amount, and the computer system moves the display content by a second distance (e.g., different than the first distance) in accordance with first movement of the hand that moves by a second amount (e.g., different than the first amount). In some embodiments, the computer system moves the display content at a first speed, in accordance with first movement of the hand at a first hand speed, and moves the display content at a second speed (e.g., different from the first speed), in accordance with first movement of the hand at a second hand speed (e.g., different from the first hand speed). For example, in FIGS. 151-15J and FIGS. 150-15P, the computer system 100 detects movement of the hand 15002 towards the display of the computer system 100, and in response, the computer system 100 updates displayed content (e.g., switches to displaying a different user interface, by pushing and/or sliding the previously displayed user interface off the display). Moving the display content on the display generation component in a first direction relative to the display generation component in accordance with first movement of a hand, while the computer system is operating in a first mode that is active while first criteria are met, and in response to detecting the first movement of a hand in proximity to the computer system, provides additional control options and/or functionality for the computer system (e.g., control options and/or functionality for updating displayed content, displaying content that was not previously displayed, and/or enabling human interaction with displayed content) without requiring physical contact with the computer system (e.g., enabling interactions from a distance, enabling interactions when the person's hands and/or other body parts are not available for physical interaction with the computer system, and/or enabling interactions when it would be inconvenient or undesirable for the person to physically interact with the computer system), provides additional functionality without needing to display additional controls (e.g., additional controls that a person touches and/or physically interacts with), and provides improved visual feedback to a person (e.g., a user of the computer system) (e.g., improved visual feedback that the computer system has detected the first movement of the hand, and/or improved visual feedback regarding a function being performed by the computer system in response to detecting the first movement of the hand).

In some embodiments, detecting, via the one or more sensors, the presence of the person in proximity to the computer system includes (16056) detecting vibration of a surface that is in contact with and/or that is within a threshold distance of the computer system (e.g., a vibration caused by a person coming into contact with the surface or bumping into the surface). In some embodiments, in response to detecting the vibration of the surface, and in accordance with a determination that the detected vibration meets a vibration threshold (e.g., a threshold amount of vibration of the computer system) and/or substantially matches a first vibration pattern (e.g., an irregular or non-repeating pattern, or a pattern that matches a particular movement profile requiring at least a minimum peak value of the detected vibration within a threshold amount of time), the computer system updates displayed content that is displayed via the display generation component of the computer system, while remaining in the first mode. In response to detecting the vibration of the surface, and in accordance with a determination that the detected vibration does not meet the vibration threshold or does not substantially match a first vibration pattern, the computer system forgoes updating displayed content. For example, as described with reference to FIG. 15B, in some embodiments, detecting the presence of the user includes detecting vibration of the computer system 100 (e.g., vibrations corresponding to an external impact on a supporting surface of the computer system 100, direct impact with the computer system 100 itself, and/or vibrations that exceed a threshold amount of vibration). Updating displayed content while remaining in a first mode, while the computer system is operating in a first mode that is active while first criteria are met, and in response to detecting vibration of a surface that is in contact with and/or that is within a threshold distance of the computer system, provides additional control options and/or functionality for the computer system (e.g., control options and/or functionality for updating displayed content, displaying content that was not previously displayed, and/or enabling human interaction with displayed content) without requiring physical contact with the computer system (e.g., enabling interactions from a distance, enabling interactions when the person cannot physical reach and/or interact with the computer system, and/or enabling interactions when it would be inconvenient or undesirable for the person to physically interact with the computer system), and also provides additional functionality without needing to display additional controls (e.g., additional controls that a person touches and/or physically interacts with).

In some embodiments, in accordance a determination that a first setting (e.g., a bump to wake option, or another option for waking the display through vibration of a surface in contact with the computer system) is enabled for the first mode, the computer system detects (16058), via the one or more sensors, the presence of the person in proximity to the computer system in accordance with detection of vibration of a surface that is in contact with and/or that is within a threshold distance of the computer system; and in accordance a determination that the first setting is disabled for the first mode, the computer system forgoes detecting, via the one or more sensors, the presence of the user in proximity to the computer system in accordance with detection of vibration of a surface that is in contact with and/or that is within the threshold distance of the computer system. For example, in FIG. 5AL, the settings user interface 5136 includes a “Bump to Wake” option 5146, for enabling or disabling waking of the computer system 100 (e.g., from a sleep or other low power state) in response to detecting vibration of the computer system 100 (e.g., vibrations that exceed a threshold amount of vibration) (e.g., vibrations corresponding to an external impact on a supporting surface of the computer system 100, or direct impact with the computer system 100 itself). And in some embodiments, as described with reference to FIG. 15B, the computer system 100 can be configured to detect the presence of a person at least in part based on vibration of the computer system 100, in addition to, or in place of, the other forms of “detecting the presence of the user” described above (e.g., through settings such as the “Bump to Wake” option 5146 described with reference to FIG. 5AL). Updating displayed content while remaining in a first mode, while the computer system is operating in a first mode that is active while first criteria are met, and in response to detecting vibration of a surface that is in contact with and/or that is within a threshold distance of the computer system and in accordance with a determination that a first setting is enabled for the first mode, provides additional control options and/or functionality for the computer system (e.g., control options and/or functionality for updating displayed content, displaying content that was not previously displayed, and/or enabling human interaction with displayed content) without requiring physical contact with the computer system (e.g., enabling interactions from a distance, enabling interactions when the person cannot physical reach and/or interact with the computer system, and/or enabling interactions when it would be inconvenient or undesirable for the person to physically interact with the computer system) in appropriate contexts. For example, the computer system can be configured to enable and/or disable detection of vibration of surfaces only in specific scenarios, such that unintentional vibrations such as accidental bumps or other contact with the surface that is in contact with and/or within a threshold distance of the computer system, do not cause the computer system to update displayed content (e.g., then requiring additional inputs in order to undo or reverse the updates to displayed content, and/or causing the device to waste power performing unnecessary functions).

In some embodiments, while in the first mode, the computer system detects (16060) that third criteria are met (e.g., criteria for going into the low power mode after prolonged period of inactivity and/or a user input to turn off the display generation component); in response to detecting that the third criteria are met, in accordance with a determination that a second setting (e.g., a dimmed always-on display mode, or another low power always-on display mode) is not enabled for the first mode (e.g., via a settings user interface such as the settings user interface 5136 and/or the settings user interface 5162, described above with reference to FIGS. 5AL-5AM), the computer system ceases to display content on the display generation component, while remaining in the first mode; after ceasing to display content on the display generation component and while remaining in the first mode, the computer system detects, via the one or more sensors, a presence of a person in proximity to the computer system without detecting contact of the person with the computer system; and in response to detecting the presence of the person in proximity to the computer system without detecting contact of the user with the computer system, in accordance with a determination that the second setting (e.g., a dimmed always-on display mode, or another low power always-on display mode) is not enabled for the first mode, the computer system forgoes displaying content on the display generation component, while remaining in the first mode; after ceasing to display content on the display generation component and while remaining in the first mode, the computer system detects, via the one or more sensors, contact of a person with the computer system; and in response to detecting contact of the user with the computer system, the computer system displays content on the display generation component, while remaining in the first mode. For example, in FIG. 5AL, the settings user interface 5136 includes an “Always On” option 5142, for enabling or displaying (e.g., via a user input 5154 on a toggle of the “Always On” option 5142) an “always-on state (e.g., a state in which at least some user interface elements are always displayed, but with reduced visual prominence, while the computer system 100 operates in a reduced power mode (e.g., a sleep mode)) for an ambient mode user interface (e.g., and where the at least some user interface elements are not displayed while the computer system 100 operates in the reduced power mode, if the “Always On” option 5142 is not enabled). Forgoing displaying content on the display generation content in response to detecting the presence of a person in proximity to the computer system without detecting contact of the user with the computer system, and in accordance with a determination that a second setting is not enabled, and displaying content on the display generation component in response to detecting contact of the user with the computer system, enables the computer system to display appropriate content only when necessary (e.g., the computer system does not display content in response to detecting presence of a person in proximity to the computer system, in some contexts, to prevent accidental display of the content, which can be intentionally and/or correctly displayed in response to detecting contact with the computer system).

It should be understood that the particular order in which the operations in FIGS. 16A-16F have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 10000, 11000, 12000, 13000, 14000, and 17000) are also applicable in an analogous manner to method 16000 described above with respect to FIGS. 16A-16F. For example, the contacts, gestures, user interface objects, and/or animations described above with reference to method 16000 optionally have one or more of the characteristics of the contacts, gestures, user interface objects, and/or animations described herein with reference to other methods described herein (e.g., methods 10000, 11000, 12000, 13000, 14000, and 17000). For brevity, these details are not repeated here.

FIGS. 17A-17C are flow diagrams illustrating method 17000 for displaying a customized user interface that is configured in accordance with customization parameters corresponding to a received identity of a charging source. Method 17000 is performed at a computer system (e.g., the portable multifunction device 100 in FIG. 1A and/or the computer system 100 in FIGS. 5A-9AA) in communication with a display generation component (e.g., the touch-sensitive display system 112 in FIG. 1A, the touch screen 112 in FIGS. 2 and 4A-4C2) and one or more sensors for detecting user inputs (e.g., the touch-sensitive display system 112 in FIG. 1A, the touch screen 112 in FIGS. 2 and 4A-4CS, the contact intensity sensor(s) 165 in FIG. 1A and FIG. 2, the keyboard/mouse 350 in FIG. 3, and/or the touchpad 355 in FIG. 3). In some embodiments, the computer system further includes a power system (e.g., power system 162 in FIG. 1A, wireless power transfer system 5101 in FIG. 5AN, and/or power receiver 5184 in FIGS. 5AN and 5AO) that includes charging components for charging a battery of the computer system (e.g., including power receiver 5184, power transfer coil 5186, rectifier 5188, controller and communication circuitry 5190, NFC 5192, and/or other charging components). In some embodiments, the display is a touch-screen display and the touch-sensitive surface is on or integrated with the display. In some embodiments, the display is separate from the touch-sensitive surface. Some operations in method 17000 are, optionally, combined and/or the order of some operations is, optionally, changed.

The computer system detects (17002) a first event (e.g., an event that corresponds to at least one of a change in an orientation (e.g., as shown in FIG. 5G) of the display generation component and/or a change in a charging state of the computer system (e.g., as shown in FIGS. 5I-5K), or other event(s) relevant to whether to activate a respective operating mode of the device (e.g., detecting a user's hand and/or a gaze of the user directed to the computer system, as in FIGS. 9B and 9C)). In some embodiments, the first event can be any of a number of events that trigger a determination of the identity of the charging source and/or subsequent displaying of the first customizable user interface based on the identifying data received in a power transfer signal from the charging source.

In accordance with detecting (17004) the first event (e.g., in response to detecting the first event, or in response to detecting another triggering event that is different from the first event) (e.g., in FIG. 5M, the computer system 100 has been rotated into the landscape orientation and is connected to the charging source 5056, the computer system is coupled to the charging source while in the landscape orientation, or the conditions for entering a low power mode or locked state are met while the computer system is coupled to the charging source and in the landscape orientation, or other events): in accordance with a determination that first criteria are met as a result of the first event (e.g., in FIG. 5M, the computer system 100 is both in the landscape orientation and connected to the charging source 5056), the computer system displays (17006) a respective customizable user interface (e.g., the clock user interface 5058 in FIG. 5M, or another customizable user interface described herein) that was not displayed prior to detecting the first event (e.g., the clock user interface 5058 was not displayed in FIGS. 5G-5L). In some embodiments, the respective customizable user interface includes a user interface with customizable content, appearance, and/or behavior, and includes but is not limited to the customizable user interfaces described herein. In some embodiments, the first criteria do not require that the computer system is being charged by the charging source in order to be met. In some embodiments, the first criteria do not require the computer system to be in a specific orientation in order to be met. In some embodiments, the first criteria require other conditions (e.g., conditions on authentication state, current time, current location, and/or other conditions) to be met in order to display the first customizable user interface.

Displaying the respective customizable user interface includes (17008), in accordance with a determination that one or more power transfer signals (e.g., a wireless power transfer signal or a wired power transfer signal) received from the charging source (e.g., by a power transfer coil of the computer system, or another charging component of the computer system) include first identifying data (e.g., the unique ID in FIGS. 5AQ and 5AR, or another unique identifier) representing a first identity of the charging source and that the first identity of the charging source is stored at the computer system in association with a first set of customization parameters, displaying a first customizable user interface that corresponds to the first identity of the charging source (e.g., a first customizable user interface that is configured in accordance with the first set of customization parameters corresponding to the first identity of the charging source) (e.g., as described in step S0014 of the method 50000 in FIG. 5AR) (e.g., a user interface with content, appearance, and/or behavior that are customized based on the first set of customization parameters corresponding to the first identity of the charging source that is obtained from power transfer signal received from the charging source). In some embodiments, the payload of the transmitter identification packet carried by the one or more power transfer signals includes an indicator that specifies that the respective identifier carried in the payload of the transmitter identification packet is unique to the charging source, and according to this indication, the computer system perform personalization and/or customization steps for the charging source, and displays a customized version of the respective customizable user interface based on the unique identifier of the charging source. In some embodiments, the payload of the transmitter identification packet carried by the one or more power transfer signals includes an indicator that specifies that the respective identifier carried in the payload of the transmitter identification packet is not unique to the charging source, and according to this indication, the computer system does not perform personalization and/or customization steps for the charging source, and displays a generic or default version of the respective customizable user interface and does not record the personalization and/or customization made by the user while this charging source is coupled to the computer system. In some embodiments, the computer system performs automatic personalization and/or customization steps (e.g., storing unique identifiers, comparing unique identifiers, storing personalized parameters in association with unique identifiers) that ensure the display of the next user interface is personalized and/or customized based on previous recorded states of the user interface in accordance with a determination that personalization criteria are met, where the personalization criteria includes a requirement that the transmitter identity packet received from the charging source (e.g., either through in-band power transfer signals, or out-of-band communication packets) includes an indicator that the identifier carried in the transmitter identity packet is unique to the charging source in order for the personalization criteria to be met.

In some embodiments, displaying the respective customizable user interface that was not displayed prior to detecting the first event, includes (17010): in accordance with a determination that one or more power transfer signals (e.g., a wireless power transfer signal or a wired power transfer signal) received from the charging source (e.g., by a power transfer coil of the computer system, or another charging component of the computer system) include second identifying data representing a second identity, different from the first identity, of the charging source (and, optionally, that the second identity of the charging source is stored at the computer system in association with a second set of customization parameters different from the first set of customization parameters), displaying a second customizable user interface that corresponds to the second identity of the charging source (e.g., a second customizable user interface that is configured in accordance with the second set of customization parameters corresponding to the second identity of the charging source) (e.g., a user interface with content, appearance, and/or behavior that are customized based on the second set of customization parameters corresponding to the second identity of the charging source that is obtained from power transfer signal received from the charging source). In some embodiments, the computer system can be charged by a plurality of different charging sources, and the computer system is able to distinguish between the different charging sources based identifying data that are embedded in the power transfer signals received from the different charging sources as the different charging sources are, respectively, coupled to the computer system, at a given time. For example, as described with reference to step S0006 in FIG. 5AR, in some embodiments, respective personalization information is specific to (e.g., tied to and/or otherwise corresponds to) a respective unique identifier (hereinafter, “unique ID”). This allows, for example, a PRx to identify a specific PTx that is in proximity, and display a customized user interface corresponding to the specific PTx (e.g., the PRx displays a first customized user interface when in proximity to a first PTx, and a second customized user interface that is different from the first customized user interface when in proximity to a second PTx that is different from the first PTx). In some embodiments, the payload of the transmitter identification packet carried by the one or more power transfer signals includes an indicator that specifies that the respective identifier carried in the payload of the transmitter identification packet is unique to the charging source, and according to this indication, the computer system perform personalization and/or customization steps for the charging source, and displays a customized version of the respective customizable user interface based on the unique identifier of the charging source. In some embodiments, the payload of the transmitter identification packet carried by the one or more power transfer signals includes an indicator that specifies that the respective identifier carried in the payload of the transmitter identification packet is not unique to the charging source, and according to this indication, the computer system does not perform personalization and/or customization steps for the charging source, and displays a generic or default version of the respective customizable user interface and does not record the personalization and/or customization made by the user while this charging source is coupled to the computer system. In some embodiments, the computer system performs automatic personalization and/or customization steps (e.g., storing unique identifiers, comparing unique identifiers, storing personalized parameters in association with unique identifiers) that ensure the display of the next user interface is personalized and/or customized based on previous recorded states of the user interface in accordance with a determination that personalization criteria are met, where the personalization criteria includes a requirement that the transmitter identity packet received from the charging source (e.g., either through in-band power transfer signals, or out-of-band communication packets) includes an indicator that the identifier carried in the transmitter identity packet is unique to the charging source in order for the personalization criteria to be met.

In some embodiments, displaying the respective customizable user interface that was not displayed prior to detecting the first event, includes (17012): in accordance with a determination that identifying data representing an identity of the charging source was not obtained from power transfer signals received from the charging source, forgoing displaying the first customizable user interface (and forgoing displaying the second customizable user interface), and displaying a third customizable user interface that is different from the first customizable user interface (and different from the second customizable user interface), wherein the third customizable user interface is configured in accordance with a default set of customization parameters (e.g., displaying a user interface with content, appearance, and/or behavior that are customized based on generic customization parameters corresponding to a generic identity of a charging source) that is different from the first set of customization parameters (and different from the second set of customization parameters). In some embodiments, the computer system is coupled to a charging source that does not embed its identity data in its power transfer signals, and the computer system is not able to obtain the identity data of the charging source from the power transfer signals of the charging source. In some embodiments, the computer system is coupled to a charging source that embeds its identity data in its power transfer signals in a different manner that is not decipherable for the computer system, and the computer system is not able to obtain the identity data of the charging source from the power transfer signals of the charging source. For example, as described with reference to step S0014 of FIG. 5AR, in some embodiments, if the PRx does not receive the unique ID from the PTx (e.g., the PTx does not have a unique ID and/or is not configured to transmit a unique ID to the PRx), the PRx forgoes displaying the first customizable user interface and instead displays a default user interface that optionally includes a default set of (e.g., customization) parameters, and is different from the first customizable user interface.

In some embodiments, displaying the respective customizable user interface that was not displayed prior to detecting the first event, includes (17013): in accordance with a determination that the one or more power transfer signals include a first indication (e.g., an indicator in FIG. 5AQ, such as a single leading bit in the payload that includes the respective identifier, or another portion of the payload that includes the respective identifier) that indicates that a respective identifier of the charging source embedded in the one or more power transfer signals is a unique identifier for the charging source, displaying the respective customizable user interface with customization based on the unique identifier (e.g., a fourth customizable user interface that is either the first or the second customizable user interface, depending on whether the unique identifier corresponds to the first identity or the second identity stored at the computer system); and in accordance with a determination that the one or more power transfer signals include a second indication (e.g., an indicator in FIG. 5AQ, such as a single leading bit in the payload that includes the respective identifier, or another portion of the payload that includes the respective identifier) that indicates that the respective identifier of the charging source embedded in the one or more power transfer signals is not unique to the charging source, displaying the respective customizable user interface without customization based on the respective identifier (e.g., the third customizable user interface that is configured in accordance with a set of default parameters, and different from the first, second, and fourth customizable user interface that have been customized based on unique identifiers). In some embodiments, the payload of the transmitter identification packet carried by the one or more power transfer signals includes an indicator that specifies that the respective identifier carried in the payload is not unique to the charging source, and according to this indication, the computer system does not perform personalization and/or customization steps for the charging source, and displays a generic or default version of the respective customizable user interface and does not record the personalization and/or customization made by the user while this charging source is coupled to the computer system. In some embodiments, the computer system performs automatic personalization and/or customization steps (e.g., storing unique identifiers, comparing unique identifiers, storing personalized parameters in association with unique identifiers) that ensure the display of the next user interface is personalized and/or customized based on previous recorded states of the user interface in accordance with a determination that personalization criteria are met, where the personalization criteria includes a requirement that the transmitter identity packet received from the charging source (e.g., either through in-band power transfer signals, or out-of-band communication packets) includes an indicator that the identifier carried in the transmitter identity packet is unique to the charging source in order for the personalization criteria to be met. For example, as described with reference to FIG. 5AQ, the data packet includes the payload portion includes an indicator (bit b₇ of byte B₅), which indicates whether the payload portion includes a unique ID (e.g., an identifier unique to the PTx 5174, as described above with reference to FIGS. 5AO-5AP). As described with respect to step S0014 in FIG. 5AR, in some embodiments, if the PRx does not receive the unique ID from the PTx (e.g., the PTx does not have an ID, the PTx has a only a non-unique ID, and/or is not configured to transmit a unique ID to the PRx), the PRx forgoes displaying the first customizable user interface.

In some embodiments, the first criteria require (17014) that the charging source is coupled to the computer system that enables a battery of the computer system to be charged by the charging source (e.g., through power transfer signals received from the charging source), and that the computer system is in a first orientation, in order for the first criteria to be met. In some embodiments, the respective customizable user interface is a user interface selected from all or a subset of the example user interfaces described herein (e.g., user interfaces in illustrated in FIGS. 5A-5AM, 6A-6AN, 7A-7V, 8A-8K, 9A-9AA, and 15A-15Q, and user interfaces described in FIGS. 10A-10L, 11A-11G, 12A-12D, 13A-13J, 14A-14G, and 16A-16F) that are displayed in response to detecting that the first criteria are met, where the selected user interface is configured in accordance with customization parameters stored in association with a stored identity of a charging source that matches the identity decoded from the power transfer signal received from the charging source that is currently coupled to the computer system. For example, as described with reference to step 50014 of FIG. 5AR, in some embodiments, the customized user interface is only displayed if the PRx and/or the PTx meet specific criteria (e.g., the first criteria). This is also shown in FIG. 5G (e.g., where the computer system is not being charged by the charging source but is in the first orientation) and FIG. 5I (e.g., where the computer system is charged by the charging source but is not in the first orientation), where the computer system 100 only partially meets the first criteria, and the first customizable user interface (e.g., the clock user interface 5058 in FIG. 5M, where the first criteria are met) is not displayed. This is also described above with reference to FIG. 101, reference number 10082.

In some embodiments, the computer system receives (17016) (e.g., using one or more power transfer coils of the computer system, and/or other charging components of the computer system) the one or more power transfer signals from the charging source (e.g., wirelessly, or through a wired connection). The computer system decodes the first identifying data representing the first identity of the charging source from at least one of the one or more power transfer signals received from the charging source (e.g., wherein the one or more power transfer signals are used (e.g., by a rectifier or another charging component of the computer system) to increase a charge level of a battery of the computer system). In some embodiments, when the charging source having the second identity different from the first identity is coupled to the computer system, the computer system receives (e.g., using one or more power transfer coils of the computer system, and/or other charging components of the computer system) the one or more power transfer signals from the charging source (e.g., wirelessly, or through a wired connection); and the computer system decoding the second identifying data representing the second identity of the charging source from at least one of the one or more power transfer signals received from the charging source (wherein the one or more power transfer signals are used (e.g., by a rectifier or another charging component of the computer system) to increase a charge level of a battery of the computer system). In some embodiments, the computer system includes communication circuitry that is adapted to obtain the identifying data embedded in the power transfer signals received from the charging source while the battery is being charging using the power transfer signals received from the charging source. For example, as described with reference to FIGS. 5AO and 5AP, in some embodiments, the power transfer step (5214) occurs after the PTx 5174 transmits the acknowledgement packet 5204 (e.g., power transfer occurs/begins before (and/or is ongoing while) the PTx 5174 transmits the unique ID and/or personalization information to the PRx 5184; and/or a wireless power signal is available for enabling in-band transmission of the “EXT ID” packet 5208 and/or the “UI Param” packet 5212 from the PTx 5174 to the PRx 5184).

In some embodiments, the computer system decodes (17018) the first identifying data representing the first identity of the charging source from a data signal other than the one or more power transfer signals received from the charging source, wherein the data signal is not used (e.g., by a rectifier or another charging component of the computer system) to power the computer system. In some embodiments, when the charging source having the second identity different from the first identity is coupled to the computer system, the computer system decodes the second identifying data representing the second identity of the charging source from a data signal other than the one or more power transfer signals received from the charging source, wherein the data signal is not used (e.g., by a rectifier or another charging component of the computer system) to power the computer system. In some embodiments, the computer system includes communication circuitry that is adapted to obtain the identifying data embedded in the data signals that are not used to charge the battery. In other words, the data signals that include the identity data of the charging source are out-of-band communications that is not used for charging the battery of the computer system. For example, in FIG. 5AP, the power transfer step 5218 occurs after transmission of the “EXT ID” packet 5208 and the “UI Param” packet 5212, and so the power transfer signals (e.g., of and/or associated with the power transfer step 5218) are not available for use for in-band communication (e.g., the transmission of the “EXT ID” packet 5208 and the “UI Param” packet 5212 must use a different signal than the signals sent during the power transfer step 5218). In some embodiments, various features described with respect to the data encoding, decoding, transmission, and usage of information carried by the one or more power transfer signals are also applicable to the out-of-band communication signals (e.g., Bluetooth signals, NFC signals, or signals of other types of communication protocols) that are not used to charge the battery of the computer system but carry the identifying data for the charging source. For example, the structure of the transmitter identification packet, the interaction sequence between the charging source and the computer system, and the usage of the information in the data packets, as described with respect to the power transfer signals that carry identifying data of the charging source are analogously applicable to the out-of-band signals that carry identifying data of the charging source, and are not repeated herein in the interest of brevity.

In some embodiments, the one or more power transfer signals that include (17020) the first identity data of the charging source are received from the charging source during a period of time in which a battery of the computer system is not charged by the charging source (e.g., the power transfer signals are not being used by the rectifier to charge the battery). In some embodiments, the one or more power transfer signals that include the second identity data of the charging source are received from the charging source during a period of time in which a battery of the computer system is not receiving power from the charging source (e.g., the power transfer signals are not being used by the rectifier to charge the battery). In some embodiments, the power transfer signals that include identity data of the charging source are received by the computer system during a break in the active power transfer from the charging source to the battery of the computer system (e.g., through the power transfer coil and rectifier, and/or other charging components of the computer system). For example, in FIGS. 5AO-5AP, the “EXT ID” packet 5208 and/or the “UI Param” packet 5212 are optionally sent and received during a break in wireless power transfer. For example, wireless power is transferred during the power transfer step S214. During a period of time (e.g., a break) in which the battery of the PRx is not receiving power from the PTx, the “EXT ID” packet 5208 and/or the “UI Param” packet 5212 are optionally sent and received, and the wireless power transfer optionally resumes (e.g., via the power transfer step 5218) afterwards.

In some embodiments, the computer system decodes (17022) the first identifying data from the one or more power transfer signals using a frequency shift keying decoder (e.g., because the charging source has encoded the first identifying data using frequency shift keying on the one or more power transfer signals, before transmitting the one or more power transfer signals to the power transfer coils of the computer system). In some embodiments, the computer system decodes the second identifying data from the one or more power transfer signals using a frequency shift keying decoder (e.g., because the charging source has encoded the second identifying data using frequency shift keying on the one or more power transfer signals, before transmitting the one or more power transfer signals to the power transfer coils of the computer system). For example, as described with reference to FIGS. 5AO and 5AP, in some embodiments, the PRx 5184 receives the “EXT ID” packet 5208 and/or the “UI Param” packet 5212 (e.g., via in-band communication enabled by a power transfer signal, e.g., from the power transfer step S214), and uses a frequency shift keying decoder to decode the power transfer signal to decode the “EXT ID” packet 5208 and/or the “UI Param” packet 5212.

In some embodiments, before receiving the one or more power transfer signals that includes the first identifying data from the charging source, the computer system transmits (17024) a request for identifying data to the charging source (e.g., using amplitude shift keying on received power transfer signals, or using other out-of-band communication means), wherein the first identifying data is transmitted to the computer system in the one or more power transfer signals by the charging source in response to receiving the request from the computer system (e.g., from the power transfer coil of the computer system). In some embodiments, before receiving the one or more power transfer signals that includes the second identifying data from the charging source, the computer system transmits a request for identifying data to the charging source (e.g., using amplitude shift keying on received power transfer signals, or using other out-of-band communication means), wherein the second identifying data is transmitted to the computer system in the one or more power transfer signals by the charging source in response to receiving the request from the computer system (e.g., from the power transfer coil of the computer system). In some embodiments, the charging source does not send identity data until it has received the request from the computer system. For example, in FIG. 5AP, the PRx 5184 (e.g., the computer system) sends a “GET” request 5206 to the PTx 5174 (e.g., the charging source), which then causes the PTx 5174 to send the “EXT ID” packet 5208 to the PRx 5184.

In some embodiments, the computer system encodes (17026), using an amplitude shift keying encoder, the request for identifying data in a respective power transfer signal (e.g., a power transfer signal that was between the charging source and the computer system, before receiving the one or more power transfer signals including the first identifying data). In some embodiments, the computer system encodes, using an amplitude shift keying encoder, the request for identifying data in a respective power transfer signal that was between the charging source and the computer system, before receiving the one or more power transfer signals including the second identifying data. In some embodiments, the charging source detects (e.g., using an ASK decoder) the request in the respective power transfer signal, and in response to the request, encodes (e.g., using an FSK encoder) identifying data in one or more subsequent power transfer signals when the one or more subsequent power transfer signals are transmitted to the computer system. In some embodiments, the computer system suspends the active charging of the battery of the computer system when sending the request and receiving subsequent power transfer signals to decode the identifying data in the subsequent power transfer signals. In some embodiments, once the decoding of the identifying data is completed, the computer system resumes charging using power transfer signals received from the charging source which may or may not include identifying data of the charging source. In some embodiments, the charging source does not require a request from the computer system before sending the respective identifier of the charging source to the computer system in the one or more power transfer signals. In some embodiments, the power transfer signals transmitted from the charging source and the computer system includes AC signals sent via wireless power coils (e.g., converting magnetic flux to and from voltage, and/or current seen by downstream electronics), and when the computer system decides to send a request and/or other types of communication data packets to the charging source, the computer system, optionally, perturbs the ongoing AC signals in a manner that encodes the request and/or other types of communication data packets, where the charging source detects such perturbance and decodes the request and/or communication data packets and responds accordingly. The computer system ceases to perturb the ongoing AC signals when the transmission of the request and/or other types of data packets are completed (e.g., while the AC signals persist between the computer system and the charging source, to charge the battery and provide a carrier for additional communication packets to be transmitted). In some embodiments, the charging source encodes the respective identifier of the charging source using frequency shift keying on the one or more power transfer signals before sending the one or more power transfer signals to the computer system. For example, as described with reference to FIGS. 5AO and 5AP, in some embodiments, the PRx 5184 encodes the packet 5408 and/or the packet 5210 using amplitude shift keying.

In some embodiments, the one or more power transfer signals carry (17028) a payload and wherein the payload encodes an identifier (e.g., a UUID, a serial number, or another type of identifying data) of the charging source. In some embodiments, the UUID is digitally encoded in a sequence of bits (e.g., 20 bits, 23 bits, 31 bits, 39 bits, or another finite number of bits) in the payload. In some embodiments, the computer system obtains the identifier of the charging source and compares it to one or more stored identifiers of previously encountered charging sources that have corresponding sets of customization parameters for the respective customizable user interface. In some embodiments, the identifier is a unique identifier. In some embodiments, the identifier is not necessarily a unique identifier, and the payload carries an indicator that indicates whether the identifier in the same payload is unique or not unique to the charging source. In some embodiments, the computer system determines, based on whether the indicator value corresponds to a unique ID or a non-unique ID, whether to decode the identifier and/or whether to carry out additional steps to personalize and/or customize the behavior of the computer system in accordance with the identifier of the charging source. For example, in FIG. 5AQ, the payload portion (e.g., bytes B₅-B₈) of the data packet includes an indicator in bit b₇ of the byte B₅ and a unique ID of the PTx. If the bit b₇ is set to a first value (e.g., TRUE, unique, customize, or 0) that indicates the identifier in B₅ is unique to the PTx, the computer system performs personalization and/or customization based on the identifier (e.g., displaying a version of the customizable user interface that is configured in accordance with configuration parameters stored in association with the identifier, or recording customization made during the time that the computer system is coupled to the charger). If the bit bris set to a different value (FALSE, non-unique, generic, or 1) that indicates the identifier in B₅ is not unique to the PTx, the computer system forgoes performing personalization and/or customization based on the identifier and performs generic or non-customized operations (e.g., displaying a generic version of the customizable user interface). As another example, in FIG. 5AS, the reserved portion B₆ b₂-B₈ can provide an indication of whether the ID portion of B₄-B₆ is intended as a unique ID.

In some embodiments, the payload includes (17030) a first portion that encodes an indicator that specifies whether a second portion of the payload following the first portion includes a respective identifier that uniquely corresponds to a respective charging source (e.g., the first identifying data that corresponds to a first identity of a charging source, the second identifying data that corresponds to a second identity of another charging source, or other identifying data that corresponds to a third identity of yet another different charging source). In some embodiments, different charging sources are represented by different identifying data that are carried in the power transfer signals in the different charging sources. In some embodiments, the first portion of the payload is a single bit or a sequence of bits that can be set to indicate whether or not the second portion of the payload includes identifying data for the charging source and should be decoded according to a standard format to obtain a unique identifier of the charging source. In some embodiments, the first portion of the payload optionally include additional space to accommodate additional information such as where the second portion of the payload is located in the payload, how long is the second portion of the payload is, and/or other properties of the second portion of the payload. In some embodiments, if the computer system determines that the identifier stored in the payload of the power transfer signals do not match any stored identifiers of previously encountered charging sources, the computer system optionally stores the identifier as the identifier of the currently coupled charging source, and records various customization that occur while the charging source is connected as customization parameters for the charging source. In some embodiments, the identifier is a unique identifier. In some embodiments, the identifier is not necessarily a unique identifier, and the payload carries an indicator that indicates whether the identifier in the same payload is unique or not unique to the charging source. In some embodiments, the computer system determines, based on whether the indicator value corresponds to a unique ID or a non-unique ID, whether to decode the identifier and/or whether to carry out additional steps to personalize and/or customize the behavior of the computer system in accordance with the identifier of the charging source. In various examples described herein, unless otherwise made clear, it is to be understood that an identifier carried in the payload of a transmitter identification data packet is not necessarily unique to the charging source, and that the computer system ascertains whether the identifier is unique or not unique based on an indicator that is carried in the payload. The computer system performs customization and/or forgoes customization based on the identifier depending on the indicator value and/or whether the identifier is determined to be unique or non-unique to the charging source. For example, in FIG. 5AQ, the payload portion (e.g., bytes B₅-B₈) of the data packet includes an indicator in bit b₇ of the byte B₅ (e.g., a first portion of the payload) and a unique ID (a second portion of the payload). If the bit b₇ is set to a first value (e.g., TRUE, unique, customize, or 0) that indicates the identifier in B₅ is unique to the PTx, the computer system performs personalization and/or customization based on the identifier (e.g., displaying a version of the customizable user interface that is configured in accordance with configuration parameters stored in association with the identifier, or recording customization made during the time that the computer system is coupled to the charger). If the bit bris set to a different value (FALSE, non-unique, generic, or 1) that indicates the identifier in B₅ is not unique to the PTx, the computer system forgoes performing personalization and/or customization based on the identifier and performs generic or non-customized operations (e.g., displaying a generic version of the customizable user interface).

In some embodiments, the first portion of the payload is (17032) a single bit in length and the second portion of the payload is 31 bits in length (e.g., the first portion of the payload combined with the second portion of the payload constitute a 4-byte block in the payload). In some embodiments, the second portion of the payload follows immediately after the first portion of the payload, in accordance with some embodiments. In some embodiments, the second portion of the payload does not immediately follow the first portion of the payload, and there may be other intermediate portions that encode other information or is empty, in accordance with some embodiments. In some embodiments, the first portion of the payload and the second portion of the payload are consecutive and the total length of the first portion and the second portion of the payload is an integer number of bytes. In some embodiments, the first portion of the payload and the second portion of the payload are respectively 2 bits and 30 bits, 3 bits and 29 bits, four bits and 28 bits, 5 bits and 27 bits, 6 bits and 26 bits, 7 bits and 27 bits, 8 bits and 24 bits, 1 bit and 39 bits, 2 bits and 38 bits, . . . , 1 bit and 47 bits, 2 bits and 46 bits, . . . , 1 bits and 55 bits, 2 bits and 54 bits, 1 bit and 63 bits, 2 bits and 62 bits, . . . , 8 bits and 56 bits, and other combinations that result in an integer number of bytes. For example, in FIG. 5AQ, the payload portion (e.g., bytes B₅-B₈) of the data packet includes an indicator in bit b₇ of the byte B₅ (e.g., the indicator is a first portion of the payload, and is 1 bit in length) and a unique ID (a second portion of the payload that is 31 bits in length). In various embodiments, the indicator can have other lengths (e.g., 2 bits, 3 bits, 4 bits, or other number of bits) and combined with the length of the identifier (unique or non-unique) result in an integer number of bytes (e.g., 4 bytes, 8 bytes, 12 bytes, or other number of bytes).

In some embodiments, the one or more power transfer signals carry (17034) a header before the payload, and the header indicates whether the one or more power transfer signals includes a wireless power transfer transmitter identification packet in accordance with the Wireless Power Consortium Qi charging protocol (e.g., the header specifies whether the payload carried by the power transfer signals includes any identifying data for the charging source, and/or whether the identifying data is unique to the charging source). For example, as described with reference to FIG. 5AQ, the data packet includes a preamble (“0 (selector)”) and/or reserved portions (e.g., as shown in B₀-B₄), which optionally include a header (e.g., that identifies the type of packet and/or protocol information for the data packet).

It should be understood that the particular order in which the operations in FIGS. 17A-17C have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 10000, 11000, 12000, 13000, 14000, and 16000) are also applicable in an analogous manner to method 16000 described above with respect to FIGS. 17A-17C. For example, the contacts, gestures, user interface objects, and/or animations described above with reference to method 17000 optionally have one or more of the characteristics of the contacts, gestures, user interface objects, and/or animations described herein with reference to other methods described herein (e.g., methods 10000, 11000, 12000, 13000, 14000, and 16000). For brevity, these details are not repeated here.

It should be understood that the particular order in which the operations described above have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 10000, 11000, 12000, 13000, 14000, 16000, and 17000) are also applicable in an analogous manner to the operation described above. For example, the contacts, gestures, user interface objects, and/or animations described above optionally have one or more of the characteristics of the contacts, gestures, user interface objects, and/or animations described herein with reference to other methods described herein (e.g., methods 10000, 11000, 12000, 13000, 14000, 16000, and 17000). For brevity, these details are not repeated here.

The operations described above with reference to FIGS. 10A-14G, 16A-16F, and 17A-17C are, optionally, implemented by components depicted in Figures IA-1B. For example, detection operation 10004, authentication operation 12038, and deactivating operation 14040 are, optionally, implemented by event sorter 170, event recognizer 180, and event handler 190. Event monitor 171 in event sorter 170 detects a contact on touch-sensitive display 112, and event dispatcher module 174 delivers the event information to application 136-1. A respective event recognizer 180 of application 136-1 compares the event information to respective event definitions 186, and determines whether a first contact at a first location on the touch-sensitive surface (or whether rotation of the device) corresponds to a predefined event or sub-event, such as selection of an object on a user interface, or rotation of the device from one orientation to another. When a respective predefined event or sub-event is detected, event recognizer 180 activates an event handler 190 associated with the detection of the event or sub-event. Event handler 190 optionally uses or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

1. A method, comprising:
at a computer system in communication with a display generation component and one or more sensors:
detecting a first event; and
in response to detecting the first event:
in accordance with a determination that first criteria are met as a result of the first event, wherein the first criteria require that the orientation of the display generation component is a first orientation, and that the computer system is charging, in order for the first criteria to be met, displaying a first customizable user interface that was not displayed prior to detecting the first event; and
in accordance with a determination that the first criteria are not met as a result of the first event, forgoing displaying the first customizable user interface.

2. The method of claim 1, wherein the first event includes an event that corresponds to at least one of a change in the orientation of the display generation component and/or a change in a charging state of the computer system, and wherein the determination that the first criteria are not met as a result of the first event includes one or more of:
a determination that the orientation of the display generation component is not the first orientation and that the computer system is charging;
a determination that the orientation of the display generation component is the first orientation and that the computer system is not charging; and/or
a determination that the orientation of the display generation component is not the first orientation and that the computer system is not charging.

3. The method of claim 1, wherein detecting the first event includes detecting that a respective set of conditions for the computer system to transition into a restricted mode has been met while the orientation of the display generation component is in the first orientation and the computer system is charging, and wherein the first criteria are met as a result of the first event.

4. The method of claim 3, wherein the restricted mode includes a low-power mode.

5. The method of claim 3, wherein the restricted mode includes a locked mode.

6. The method of claim 1, wherein detecting the first event includes detecting that the orientation of the display generation component is in the first orientation and the computer system is charging as a result of the first event, while the computer system is operating in a restricted mode.

7. The method of claim 1, wherein the determination that the first criteria are not met as a result of the first event includes a determination that the computer system was in a vehicle at a time that the first event occurred.

8. The method of claim 1, wherein the determination that the first criteria are not met as a result of the first event includes a determination that the computer system was moved by more than a threshold amount of movement within a unit of time at a time that the first event occurred.

9. The method of claim 1, wherein the determination that the first criteria are not met as a result of the first event includes a determination that the computer system is in communication with a vehicle.

10. The method of claim 1, wherein displaying the first customizable user interface includes:
in accordance with a determination that the first criteria are met as a result of the first event and that a first set of contextual conditions are met, displaying the first customizable user interface including first content; and
in accordance with a determination that the first criteria are met as a result of the first event and that a second set of contextual conditions, different from the first set of contextual conditions are met, displaying the first customizable user interface including second content, different from the first content.

11. The method of claim 10, wherein the first set of contextual conditions includes a first condition that the computer system is charging via a first charging source, and the second set of contextual conditions include a second condition that the computer system is charging via a second charging source, different from the first charging source.

12. The method of claim 11, including:
receiving one or more power transfer signals from a charging source comprising the first charging source or second charging source;
obtaining a respective identifier of the charging source from at least one of the one or more power transfer signals that were received from the charging source; and
determining whether the respective identifier of the charging source that is obtained from the one or more power transfer signals corresponds to a first identifier of the first charging source or a second identifier of the second charging source, before displaying the first customizable user interface.

13. The method of claim 12, wherein determining whether the respective identifier of the charging source that is obtained from the one or more power transfer signals corresponds to the first identifier of the first charging source or the second identifier of the second charging source includes:
determining whether the one or more power transfer signals include an indication of whether the respective identifier of the charging source obtained from the one or more power transfer signals is a unique identifier for the charging source, wherein the first customizable user interface is displayed in accordance with a determination that the indication specifies that the respective identifier is a unique identifier for the charging source and that the respective identifier corresponds to the first identifier of the first charging source.

14. The method of claim 12, wherein obtaining the respective identifier of the charging source from the one or more power transfer signals that were received from the charging source includes:
decoding the respective identifier of the charging source from one or more power transfer signals received from the charging source, wherein the one or more power transfer signals are used to charge a battery of the computer system.

15. The method of claim 12, including:
decoding the respective identifier of the charging source from one or more signals received from the charging source, wherein the one or more signals are not used to charge a battery of the computer system.

16. The method of claim 12, including:
while the computer system is coupled to the charging source, encoding a request for the respective identifier of the charging source in a first power transfer signal transmitted between the charging source and the computer system, wherein the charging source encodes the respective identifier in the one or more power transfer signals in response to detecting the request encoded in the first power transfer signal.

17. The method of claim 12, wherein at least one of the one or more power transfer signals received from the charging source encodes a header and a payload, and the header indicates that the payload includes the respective identifier of the charging source.

18. The method of claim 17, wherein obtaining the respective identifier of the charging source from the one or more power transfer signals that were received from the charging source includes obtaining the respective identifier of the charging source from a second portion of the payload that follows a first portion of the payload.

19. The method of claim 12, including:
while displaying the first customizable user interface that was not displayed prior to detecting the first event, detecting one or more user inputs that configure one or more aspects of the first customizable user interface; and
in response to detecting the one or more user inputs that configure the one or more aspects of the first customizable user interface, updating a first set of customization parameters that is stored in association with the respective identifier at the computer system, and/or establishing and storing a second set of second customization parameters for the first customizable user interface in association with the respective identifier.

20. The method of claim 19, including:
after updating the first set of customization parameters and/or establishing and storing the second set of customization parameters for the first customizable user interface in association with the respective identifier obtained from the one or more power transfer signals, detecting that the computer system is decoupled from the charging source and ceasing to display the first customizable user interface that were configured in accordance with the one or more user inputs;
after detecting that the computer system is decoupled from the charging source and ceasing to display the first customizable user interface that was configured in accordance with the one or more user inputs, detecting a subsequent event, where the first criteria are met as a result of the subsequent event; and
in response to detecting the subsequent event, in accordance with a determination that the computer system is coupled to a respective charging source and that an identifier encoded in one or more power transfer signals received from the respective charging source matches the respective identifier of the charging source, redisplaying the first customizable user interface in accordance with the first set of customization parameters and/or second set of customization parameters that are stored in association with the respective identifier of the charging source.

21. The method of claim 10, wherein the first set of contextual conditions includes a third condition that the computer system is located in a first location, and the second set of contextual conditions include a fourth condition that the computer system is located in a second location, different from the first location.

22. The method of claim 10, wherein the first set of contextual conditions includes a fifth condition that a current time is within a first time range, and the second set of contextual conditions includes a sixth condition that the current time is within a second time range, different from the first time range.

23. The method of claim 10, wherein the first content includes a first set of widgets, and the second content includes a second set of widgets different from the first set of widgets.

24. The method of claim 10, wherein the first content includes a first type of content and the second content includes a second type of content different from the first type of content.

25. The method of claim 10, wherein the first set of contextual conditions includes a seventh condition that the computer system is operating in a first mode in which alerts generation is moderated in a first manner at the computer system, and the second set of contextual conditions includes an eighth condition that the computer system is operating in a second mode in which alert generation is moderated in a second manner, different from the first manner, at the computer system.

26. The method of claim 1, including:
while displaying the first customizable user interface, detecting a first user input; and
in response to detecting the first user input, in accordance with a determination that the first user input meets dismissal criteria, ceasing to display the first customizable user interface.

27. The method of claim 26, wherein the dismissal criteria are met in accordance with a determination that the first user input is a tap input.

28. The method of claim 27, including:
in response to detecting the first user input:
in accordance with a determination that the first user input meets the dismissal criteria and that the first user input is directed to a first portion of the display generation component, replacing display of the first customizable user interface with a first replacement user interface; and
in accordance with a determination that the first user input meets the dismissal criteria and that the first user input is directed to a second portion, different from the first portion, of the display generation component, replacing display of the first customizable user interface with a second replacement user interface, different from the first replacement user interface.

29. The method of claim 27, including:
in response to detecting the first user input:
in accordance with a determination that the first user input does not meet the dismissal criteria and that the first user input is directed to a third portion of the display generation component, performing a first operation without ceasing display of the first customizable user interface.

30. The method of claim 26, wherein the dismissal criteria are met in accordance with a determination that the first user input changes the orientation of the computer system.

31. The method of claim 26, including:
in response to detecting the first user input, in accordance with the determination that the first user input meets the dismissal criteria:
in accordance with a determination that the first customizable user interface was displayed including a first type of content, replacing display of the first customizable user interface with a first replacement user interface; and
in accordance with a determination that the first customizable user interface was displayed including a second type of content, different from the first type of content, replacing display of the first customizable user interface with a second replacement user interface, different from the first replacement user interface.

32. The method of claim 26, including:
in response to detecting the first user input, in accordance with the determination that the first user input meets the dismissal criteria, displaying an animated transition from the first customizable user interface to a respective replacement user interface in accordance with the first user input.

33. The method of claim 32, wherein displaying the animated transition in accordance with the first user input includes controlling a progress of the animated transition in accordance with a progress of the first user input.

34. The method of claim 1, including:
while displaying the first customizable user interface, detecting, via one or more sensors of the computer system, a second user input; and
in response to detecting the second user input, in accordance with a determination that the second user input meets content switching criteria, switching content displayed in the first customizable user interface from a first type of content to a second type of content, different from the first type of content.

35. The method of claim 1, including:
while displaying the first customizable user interface, detecting occurrence of a second event;
in response to detecting the second event:
in accordance with a determination that the first criteria are no longer met, ceasing to display the first customizable user interface and redisplaying a previous user interface that was displayed when the first event was detected, irrespective of which content of multiple different contents of the first customizable user interface was displayed when the second event was detected.

36. The method of claim 1, including:
in accordance with a determination that the computer system is charging, displaying a battery indicator to indicate that the computer system is charging.

37. The method of claim 36, wherein displaying the battery indicator to indicate that the computer system is charging includes:
in accordance with a determination that the first criteria are met and that the first customizable user interface is displayed, displaying the battery indicator with a first appearance; and
in accordance with a determination that the first criteria are not met and that the first customizable user interface is not displayed, displaying the battery indicator with a second appearance that is different from the first appearance.

38. The method of claim 36, including:
while displaying the battery indicator to indicate that the computer system is charging, detecting a third user input that is directed to a location corresponding to the battery indicator; and
in response to detecting the third user input, expanding the battery indicator to display additional charging information that was not displayed in the battery indicator at a time when the third user input was detected.

39. The method of claim 1, including:
in response to detecting the first event:
in accordance with a determination that the first criteria are met as a result of the first event and that the computer system was displaying a respective user interface object of a first type at a time of detecting the first event, wherein the respective user interface object of the first type corresponds to a respective application and displays status information that is updated over time without requiring display of the respective application, displaying the respective user interface object of the first type with an updated appearance.

40. The method of claim 39, wherein the respective user interface object with the updated appearance is a full-screen user interface object.

41. The method of claim 1, including:
prior to detecting the first event, detecting a third event; and
in response to detecting the third event:
in accordance with a determination that the first criteria are met as a result of the third event and that the first customizable user interface was not previously displayed at the computer system, displaying a description of the first customizable user interface.

42. The method of claim 1, including:
displaying a first settings user interface for configuring the first customizable user interface;
while displaying the first settings user interface for configurating the first customizable user interface, detecting one or more user inputs that correspond to requests to change one or more configurable aspects of the first customizable user interface; and
in response to detecting the one or more user inputs that correspond to requests to change one or more configurable aspects of the first customizable user interface, updating the one or more configurable aspects of the first customizable user interface in accordance with the one or more user inputs.

43. The method of claim 42, wherein the first settings user interface for configuring the first customizable user interface includes a first option for enabling or disabling display of the first customizable user interface.

44. The method of claim 42, wherein the first settings user interface for configuring the first customizable user interface includes a second option for enabling or disabling a dimmed always-on mode for the first customizable user interface, wherein, in accordance with a determination that the dimmed always-on mode is enabled for the first customizable user interface, at least some user interface elements of the first customizable user interface remain displayed with reduced visual prominence while the computer system is in a reduced power mode.

45. The method of claim 42, wherein the first settings user interface for configuring the first customizable user interface includes a third option for enabling or disabling a night mode for the first customizable user interface, wherein, in accordance with a determination that the night mode is enabled for the first customizable user interface, at least some user interface elements of the first customizable user interface are displayed with a different appearance while the computer system is in the night mode, as compared to a default appearance of the first customizable user interface.

46. The method of claim 42, wherein the first settings user interface for configuring the first customizable user interface includes a fourth option for enabling or disabling display of notification alerts while the first customizable user interface is displayed, wherein, in accordance with a determination that display of notification alerts are enabled, respective notification indicators for one or more newly received notifications are displayed while the first customizable user interface is displayed.

47. The method of claim 42, wherein the first settings user interface for configuring the first customizable user interface includes a fifth option for enabling or disabling waking the computer system in response to detecting vibration of the computer system.

48. A computer system, in communication with a display generation component and one or more sensors, the computer system comprising:
one or more processors; and
memory storing one or more programs, wherein the one or more programs are configured to be executed by the one or more processors, the one or more programs including instructions for:
detecting a first event; and
in response to detecting the first event:
in accordance with a determination that first criteria are met as a result of the first event, wherein the first criteria require that the orientation of the display generation component is a first orientation, and that the computer system is charging, in order for the first criteria to be met, displaying a first customizable user interface that was not displayed prior to detecting the first event; and
in accordance with a determination that the first criteria are not met as a result of the first event, forgoing displaying the first customizable user interface.

49. A computer readable storage medium storing one or more programs, the one or more programs comprising instructions that, when executed by a computer system in communication with a display generation component and one or more sensors, cause the computer system to:
detect a first event; and
in response to detecting the first event:
in accordance with a determination that first criteria are met as a result of the first event, wherein the first criteria require that the orientation of the display generation component is a first orientation, and that the computer system is charging, in order for the first criteria to be met, display a first customizable user interface that was not displayed prior to detecting the first event; and
in accordance with a determination that the first criteria are not met as a result of the first event, forgo displaying the first customizable user interface.

50-244. (canceled)
